(19) United States
(12) Patent Application Publication
(10) Pub. No.: US 2026/0320635 A1
(43) Pub. Date: Oct. 15, 2026

(54) SYSTEMS, METHODS, KITS, AND APPARATUSES FOR DIGITAL PRODUCT NETWORKS IN VALUE CHAIN NETWORKS

(71) Applicant: Strong Force VCN Portfolo 2019, LLC, Fort Lauderdale, FL (US)

(72) Inventors: Charles H. Cella, Pembroke, MA (US); Teymour S. El-Tahry, Detroit, MI (US); Leon Fortin, JR., Providence, RI (US); Andrew Locke, Farmington, MI (US); Jenna Parenti, Broomfield, CO (US); David Stein, Fairfax, VA (US)

(21) Appl. No.: 19/383,156

(22) Filed: Nov. 7, 2025

Related U.S. Application Data
(63) Continuation of application No. PCT/US24/28385, filed on May 8, 2024.
(60) Provisional application No. 63/464,845, filed on May 8, 2023.
(60) Provisional application No. 63/535,748, filed on Aug. 31, 2023.
(60) Provisional application No. 63/610,894, filed on Dec. 15, 2023.
(60) Provisional application No. 63/621,549, filed on Jan. 16, 2024.
(60) Provisional application No. 63/625,597, filed on Jan. 26, 2024.
(60) Provisional application No. 63/638,590, filed on Apr. 25, 2024.

(51) Int. Cl. G06Q 30/0202; G06Q 10/087; G06Q 30/012; G06Q 30/0204; G06Q 30/0251; G06Q 30/0601

(52) U.S. Cl. CPC G06Q 30/0202; G06Q 10/08726; G06Q 30/012; G06Q 30/0205; G06Q 30/0261; G06Q 30/0631

(57) ABSTRACT

A system may include a product-to-product communication module configured to exchange inter-product communications for a plurality of digitally connected products. A system may include a product-to-user communication module configured to exchange product-to-user communications between the plurality of digitally connected products and their respective users. A system may include a product-to-business communication module configured to exchange product-to-user communications between the plurality of digitally connected products and their associated enterprises. A system may include a data processing module configured to process the inter-product communications, product-to-user communications, and the product-to-business communications to determine time-sensitive alerts related to corresponding one of the plurality of digitally connected products. A system may include a graphical user interface (GUI) module configured to generate one or more user interfaces for displaying a time-sensitive alerts.

### CROSS-REFERENCE TO RELATED APPLICATIONS

This application is a continuation of International Application No. PCT/US24/28385, filed 8 May 2024 which claims the benefit of: U.S. Provisional Application No. 63/464,845, filed on 8 May 2023, U.S. Provisional Application No. 63/535,748, filed on 31 Aug. 2023, U.S. Provisional Application No. 63/610,894, filed 15 Dec. 2023, U.S. Provisional Application No. 63/621,549, filed 16 Jan. 2024, U.S. Provisional Application No. 63/625,597, filed 26 Jan. 2024, and U.S. Provisional Application No. 63/638,590, filed 25 Apr. 2024.

All the foregoing applications are hereby incorporated by reference as if fully set forth herein in their entirety.

### BACKGROUND

Historically, many of the various categories of goods purchased and used by household consumers, by businesses and by other customers were been supplied mainly through a relatively linear fashion, in which manufacturers and other suppliers of finished goods, components, and other items handed off items to shipping companies, freight forwarders and the like, who delivered them to warehouses for temporary storage, to retailers, where customers purchased them, or directly to customer locations. Manufacturers and retailers undertook various sales and marketing activities to encourage and meet demand by customers, including designing products, positioning them on shelves and in advertising, setting prices, and the like.

### SUMMARY

In some aspects, the techniques described herein relate to a digital product network system including: a product-to-product communication module configured to exchange inter-product communications for a plurality of digitally connected products; a product-to-user communication module configured to exchange product-to-user communications between the plurality of digitally connected products and their respective users; a product-to-business communication module configured to exchange product-to-user communications between the plurality of digitally connected products and their associated enterprises; a data processing module configured to process the inter-product communications, product-to-user communications, and the product-to-business communications to determine time-sensitive alerts related to corresponding one of the plurality of digitally connected products; and a graphical user interface (GUI) module configured to generate one or more user interfaces for displaying a time-sensitive alerts.

In some aspects, the techniques described herein relate to a digital product network system, wherein the time-sensitive alerts include at least one of a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or device overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a health-related alert, a fitness-related alert, an energy-related alert, an inventory alert, a performance degradation alert, a compliance alert, a demand surge alert, a security breach alert, and a user-defined custom alert based on a specific conditions or threshold set by the user.

In some aspects, the techniques described herein relate to a digital product network system further including a smart contract creation module configured for creation of a smart contract providing terms and conditions that apply to at least one of: the plurality of digitally connected products, a user of at least one of the plurality of digitally connected products, a manufacturer of at least one of the plurality of digitally connected products, a distributer of at least one of the plurality of digitally connected products, an insurance provider for at least one of the plurality of digitally connected products, a retailer of at least one of the plurality of digitally connected products, and a service provider for at least one of the plurality of digitally connected products, wherein the smart contract relates to one or more of a purchase, a return, a lease, a warranty, an extended warranty, a service contract, a maintenance contract, a trade-in, a product add-on, a new product feature, a contract for access to data, a contract for access to one or more models, a software upgrade, a product upgrade, and a contract for access to a product feature.

In some aspects, the techniques described herein relate to a digital product network system, wherein the smart contract creation module is further configured to automatically create smart contracts based on predefined rules.

In some aspects, the techniques described herein relate to a digital product network system further including a smart contract template selection module configured to enable selection of a smart contract template, while restricting the selection to one or more smart contract templates that are associated with the at least one of the plurality of digitally connected products.

In some aspects, the techniques described herein relate to a digital product network system, wherein the smart contract template selection module is further configured to: receive input for parameterizing the selected smart contract template; generate a smart contract by parameterizing one or more variables in the smart contract with the input; and deploy the smart contract by broadcasting the smart contract to the at least one of the plurality of digitally connected products.

In some aspects, the techniques described herein relate to a digital product network system, wherein the smart contract template selection module is further configured to suggest smart contract templates to a user based on at least one of: a type of the digitally connected product to be subject to the smart contract, one or more past selections of the user.

In some aspects, the techniques described herein relate to a digital product network system further including a smart contract performance verification module configured to verify the performance of an obligation defined in the smart contract.

In some aspects, the techniques described herein relate to a digital product network system, wherein the smart contract performance verification module is further configured to automatically trigger an action upon successful verification of the performance of the obligation defined in the smart contract, and wherein the action includes one or more of providing a notification, updating a status of the smart contract, and initiating a new smart contract.

In some aspects, the techniques described herein relate to a digital product network system further including a record upload module configured for enabling a user to upload records, wherein the records include one or more of photos, videos, audio recordings, device information, usage data, user preferences, troubleshooting records, upgrade records, reviews of product, receipts for product-related costs, receipts for product-related purchases, environmental data, and customer feedback.

In some aspects, the techniques described herein relate to a digital product network system, wherein the record upload module is further configured to automatically categorize and store the uploaded records based on respective types of associated digitally connected products.

In some aspects, the techniques described herein relate to a digital product network system further including an application programming interface (API) management module configured to manage one or more APIs, so as to expose the APIs to one or more related applications or third-party systems used by the plurality of digitally connected products.

In some aspects, the techniques described herein relate to a digital product network system further including a regulatory interface module configured to interact with one or more regulatory systems.

In some aspects, the techniques described herein relate to a digital product network system further including a data integration module configured to integrate data from the plurality of digitally connected products to create a unified view of data associated with the digitally connected products, by performing one or more operations, wherein the one or more operations include collecting data, aggregating data, normalizing data, standardizing data, cleaning data, enriching data, analyzing data, visualizing data, and integrating with other systems, and wherein the data integrated by the data integration module includes one or more of product usage data, environmental data, product performance data, customer data, supply chain data, demand data, product location data, product customer feedback, product interaction data, product security data, product packaging data, product image data, product video data, product audio data, and product simulation data.

In some aspects, the techniques described herein relate to a digital product network system, wherein the GUI module is further configured to provide one or more user interfaces displaying related ones of the plurality of digitally connected products associated with a single user by at least one of brand, type, and capability.

In some aspects, the techniques described herein relate to a method for operating a digital product network system, the method including: exchanging inter-product communications for a plurality of digitally connected products; exchanging product-to-user communications between the plurality of digitally connected products and their respective users; exchanging product-to-business communications between the plurality of digitally connected products and their associated enterprises; processing the inter-product communications, the product-to-user communications, and the product-to-business communications to determine time-sensitive alerts related to corresponding one of the plurality of digitally connected products; and generating one or more user interfaces for displaying the time-sensitive alerts.

In some aspects, the techniques described herein relate to a method, wherein the time-sensitive alerts include at least one of a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or device overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a health-related alert, a fitness-related alert, an energy-related alert, an inventory alert, a performance degradation alert, a compliance alert, a demand surge alert, a security breach alert, and a user-defined custom alert based on a specific conditions or threshold set by the user.

In some aspects, the techniques described herein relate to a method further including creation of a smart contract, the smart contract providing terms and conditions that apply to at least one of: the plurality of digitally connected products, a user of at least one of the plurality of digitally connected products, a manufacturer of at least one of the plurality of digitally connected products, a distributer of at least one of the plurality of digitally connected products, an insurance provider for at least one of the plurality of digitally connected products, a retailer of at least one of the plurality of digitally connected products, and a service provider for at least one of the plurality of digitally connected products, wherein the terms and conditions include one or more of a purchase, a return, a lease, a warranty, an extended warranty, a service contract, a maintenance contract, a trade-in, a product add-on, a new product feature, a contract for access to data, a purchase for access to one or more models, a software upgrade, a product upgrade, and unlocking an existing product feature.

In some aspects, the techniques described herein relate to a method further including automatically creating smart contracts based on predefined rules.

In some aspects, the techniques described herein relate to a method further including enabling selection of a smart contract template, while restricting the selection to one or more smart contract templates that are associated with the at least one of the plurality of digitally connected products.

In some aspects, the techniques described herein relate to a method further including: receiving input for parameterizing the selected smart contract template; generating a smart contract by parameterizing one or more variables in the smart contract with the input; and deploying the smart contract by broadcasting the smart contract to the at least one of the plurality of digitally connected products.

In some aspects, the techniques described herein relate to a method further including suggesting smart contract templates to a user based on at least one of: a type of the digitally connected product to be subject to the smart contract, one or more past selections of the user.

In some aspects, the techniques described herein relate to a method further including verification of performance of an obligation defined in the smart contract.

In some aspects, the techniques described herein relate to a method further including automatically triggering an action upon successful verification of the performance of the obligation defined in the smart contract, wherein the action includes one or more of providing a notification, updating status of the smart contract, and initiating a new smart contract.

In some aspects, the techniques described herein relate to a method further including enabling a user to upload records, wherein the records include one or more of photos, videos, audio recordings, device information, usage data, user preferences, troubleshooting records, upgrade records, reviews of product, receipts for product-related costs or purchases, environmental data, and customer feedback.

In some aspects, the techniques described herein relate to a method further including automatically categorizing and storing the uploaded records based on respective types and associated digitally connected products.

In some aspects, the techniques described herein relate to a method further including managing one or more application programming interfaces (APIs), so as to expose the APIs to one or more related applications or third-party systems used by the plurality of digitally connected products.

In some aspects, the techniques described herein relate to a method further including interacting with one or more regulatory systems.

In some aspects, the techniques described herein relate to a method further including integrating data from the plurality of digitally connected products to create a unified view of digitally connected products, by performing one or more operations, wherein the one or more operations include collecting data, aggregating data, normalizing data, standardizing data, cleaning data, enriching data, analyzing data, visualizing data, and integrating with other systems, and wherein the data integrated includes one or more of product usage data, environmental data, product performance data, customer data, supply chain data, demand data, product location data, product customer feedback, product interaction data, product security data, product packaging data, product image data, product video data, product audio data, and product simulation data.

In some aspects, the techniques described herein relate to a method further including providing one or more user interfaces to display related ones of the plurality of digitally connected products associated with a single user by at least one of brand, type, and capability.

In some aspects, the techniques described herein relate to a digital product network system including: a user interface module configured to: display information associated with a set of digitally connected products; and receive and process user inputs for displaying a set of marketplaces associated with the information; display the set of marketplaces; and receive and process user inputs for selecting a marketplace from the set of marketplaces; and an embedded marketplace module integrated with the user interface module, the embedded marketplace configured to: display the selected marketplace; receive and process user inputs for selecting one or more offerings from a set of offerings from the selected marketplace; receive and process user inputs for completing a set of transactions associated with the one or more selected offerings; and execute the set of transactions.

In some aspects, the techniques described herein relate to a digital product network system, wherein the embedded marketplace module is configured to execute transactions for product data associated with at least one of the digitally connected products from the set of digitally connected products, wherein the product data includes one or more of product performance data, product pricing data, product usage data, product location data, product customer feedback data, product interaction data, product security data, product image data, product video data, product audio data, product packaging data, product maintenance data, environmental data, and product simulation data.

In some aspects, the techniques described herein relate to a digital product network system, wherein the embedded marketplace module is configured to execute transactions related to models and/or algorithms associated with at least one digitally connected product from the set of digitally connected products, wherein the models and/or algorithms include one or more of predictive models, machine learning models, artificial intelligence models, classification models, anomaly detection models, clustering algorithms, generative models, large language models, optimization models, recommendation models, neural networks, transformer models, convolutional neural networks, deep learning models, supervised models, semi-supervised models, unsupervised models, reinforcement models, and regression models.

In some aspects, the techniques described herein relate to a digital product network system, wherein the embedded marketplace module is configured to execute transactions related to one or more of product parts, product upgrades, product insurance, product enhancements, product add-ons, product software, product warranties, extended product warranties, product service contracts, product maintenance contracts, product trade-ins, and access to product features for at least one digitally connected product from the set of digitally connected products.

In some aspects, the techniques described herein relate to a digital product network system, wherein the embedded marketplace module is further configured to execute a peer-to-peer transaction associated with one or more of the digitally connected products.

In some aspects, the techniques described herein relate to a digital product network system, wherein the embedded marketplace module is configured to provide a recommendation for an offering associated with at least one digitally connected product using a set of Artificial Intelligence (AI)-based learning models, wherein at least one of the set of AI-based learning models is trained on a training data set of embedded marketplace transaction data.

In some aspects, the techniques described herein relate to a digital product network system, wherein the embedded marketplace module is configured to execute transactions between different entities including two or more of users, manufacturers, suppliers, service providers, software providers, data providers, data analytics providers, model providers, digital twin providers, and NFT providers.

In some aspects, the techniques described herein relate to a digital product network system, wherein the marketplaces provided by the embedded marketplace module are configured to be searchable.

In some aspects, the techniques described herein relate to a digital product network system, wherein at least one marketplace of the set of marketplaces provides digital twin offerings.

In some aspects, the techniques described herein relate to a method for executing transactions in a digital product network system, the method including: displaying information associated with a set of digitally connected products; receiving and processing user inputs for displaying a set of marketplaces associated with the information; displaying the set of marketplaces; receiving and processing user inputs for selecting a marketplace from the set of marketplaces; displaying the selected marketplace; receiving and processing user inputs for selecting one or more offerings from a set of offerings from the selected marketplace; receiving and processing user inputs for completing a set of transactions associated with the one or more selected offerings; and executing the set of transactions.

In some aspects, the techniques described herein relate to a method further including executing transactions related to product data associated with at least one of the digitally connected products from the set of digitally connected products, wherein the product data includes one or more of product performance data, product pricing data, product usage data, product location data, product customer feedback data, product interaction data, product security data, product image data, product video data, product audio data, product packaging data, product maintenance data, environmental data, and product simulation data.

In some aspects, the techniques described herein relate to a method further including executing transactions related to models and/or algorithms associated with at least one digitally connected product from the set of digitally connected products, wherein the models and/or algorithms include one or more of predictive models, machine learning models, artificial intelligence models, classification models, anomaly detection models, clustering algorithms, generative models, large language models, optimization models, recommendation models, neural networks, transformer models, convolutional neural networks, deep learning models, supervised models, semi-supervised models, unsupervised models, reinforcement models, and regression models.

In some aspects, the techniques described herein relate to a method further including executing transactions related to one or more of product parts, product upgrades, product insurance, product enhancements, product add-ons, product software, product warranties, extended product warranties, product service contracts, product maintenance contracts, product trade-ins, and access to new product features for at least one digitally connected product from the set of digitally connected products.

In some aspects, the techniques described herein relate to a method further including executing a peer-to-peer transaction associated with one or more of the digitally connected products.

In some aspects, the techniques described herein relate to a method further including providing a recommendation for an offering associated with at least one digitally connected product using a set of Artificial Intelligence (AI)-based learning models, wherein at least one of the set of AI-based learning models is trained on a training data set of embedded marketplace transaction data.

In some aspects, the techniques described herein relate to a method further including executing transactions between different entities including two or more of users, manufacturers, suppliers, service providers, data providers, data analytics providers, software application providers, model providers, digital twin providers, and NFT providers.

In some aspects, the techniques described herein relate to a method further including providing at least one searchable marketplace.

In some aspects, the techniques described herein relate to a method, further including providing at least one marketplace that provides digital twin offerings.

In some aspects, the techniques described herein relate to a digital product network system including one or more processors and one or more memories configured to perform operations including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to generate a recommendation associated with one or more of the set of digitally connected products; and outputting the recommendation.

In some aspects, the techniques described herein relate to a digital product network system, wherein the information is related to a date or time of packaging of the set of digitally connected products.

In some aspects, the techniques described herein relate to a digital product network system, wherein the information is related to a location of the set of digitally connected products.

In some aspects, the techniques described herein relate to a digital product network system, wherein the information is related to a location of manufacturing for the set of digitally connected products.

In some aspects, the techniques described herein relate to a digital product network system, wherein the information is related to a location of packaging for the set of digitally connected products.

In some aspects, the techniques described herein relate to a digital product network system, wherein the information is related to a location of purchase for the set of digitally connected products.

In some aspects, the techniques described herein relate to a digital product network system, wherein the information is related to a location of opening of packaging or the location of consumption of the set of digitally connected products.

In some aspects, the techniques described herein relate to a digital product network system, wherein the information is related to a time on a display shelf or time on other display for the set of digitally connected products.

In some aspects, the techniques described herein relate to a digital product network system, wherein the information is related to customer interaction with a set of displayed digitally connected products of the set of digitally connected products.

In some aspects, the techniques described herein relate to a digital product network system, wherein the information is related to customer interaction with purchased digitally connected products of the set of digitally connected products.

In some aspects, the techniques described herein relate to a digital product network system, wherein the wherein the set of AI-based learning models includes at least one of: a transformer model, a convolutional neural network, a deep learning model, a supervised model, a semi-supervised model, an unsupervised model, a generative model, a large language model, a recommendation model, or a reinforcement model.

In some aspects, the techniques described herein relate to a digital product network system, wherein the recommendation is associated with one or more of an operational parameter of one or more of the set of digitally connected products, a provisioning of customer support associated with the one or more of the set of digitally connected products, a price of one or more of the set of digitally connected products, a product design associated with one or more of the set of digitally connected products, product security associated with one or more of the set of digitally connected products, quality control associated with one or more of the set of digitally connected products, marketing or sales strategies associated with one or more of the set of digitally connected products, display strategies associated with one or more of the set of digitally connected products, packaging associated with one or more of the set of digitally connected products, software upgrades associated with one or more of the set of digitally connected products, inventory management associated with one or more of the set of digitally connected products, regulatory compliance associated with one or more of the set of digitally connected products, and customer behavior associated with one or more of the set of digitally connected products.

In some aspects, the techniques described herein relate to a method for generating a recommendation in a digital product network system, the method including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to generate a recommendation associated with one or more of the set of digitally connected products; and outputting the recommendation.

In some aspects, the techniques described herein relate to a method, wherein the information relates to a date or time of packaging the set of digitally connected products.

In some aspects, the techniques described herein relate to a method, wherein the information relates to a location of the set of digitally connected products.

In some aspects, the techniques described herein relate to a method, wherein the information relates to a location of manufacturing of the set of digitally connected products.

In some aspects, the techniques described herein relate to a method, wherein the information relates to a location of packaging of the set of digitally connected products.

In some aspects, the techniques described herein relate to a method, wherein the information relates to a location of purchase of the set of digitally connected products.

In some aspects, the techniques described herein relate to a method, wherein the information relates to a location of opening of packaging or the location of consumption of the set of digitally connected products.

In some aspects, the techniques described herein relate to a method, wherein the information relates to a time on a display shelf or time on other display for the set of digitally connected products.

In some aspects, the techniques described herein relate to a method, wherein the information relates to customer interaction with displayed digitally connected products of the set of digitally connected products.

In some aspects, the techniques described herein relate to a method, wherein the information relates to customer interaction with purchased digitally connected products of the set of digitally connected products.

In some aspects, the techniques described herein relate to a method, wherein the wherein the set of AI-based learning models includes at least one of: a transformer model, a convolutional neural network, a deep learning model, a supervised model, a semi-supervised model, an unsupervised model, a generative model, a large language model, a recommendation model, or a reinforcement model.

In some aspects, the techniques described herein relate to a method, wherein the recommendation is associated with one or more of an operational parameter of one or more of the set of digitally connected products, a provisioning of customer support associated with the one or more of the set of digitally connected products, a price of one or more of the set of digitally connected products, a product design associated with one or more of the set of digitally connected products, product security associated with one or more of the set of digitally connected products, quality control associated with one or more of the set of digitally connected products, marketing or sales strategies associated with one or more of the set of digitally connected products, display strategies associated with one or more of the set of digitally connected products, packaging associated with one or more of the set of digitally connected products, software upgrades associated with one or more of the set of digitally connected products, inventory management associated with one or more of the set of digitally connected products, regulatory compliance associated with one or more of the set of digitally connected products, and customer behavior associated with one or more of the set of digitally connected products.

In some aspects, the techniques described herein relate to a digital product network system including one or more processors and one or more memories configured to perform operations including: receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and providing the information to a digital twin system, wherein the digital twin system is configured to generate a digital twin representing one or more digitally connected products of the set of digitally connected products based on the information, wherein each digital twin provides a substantially real-time representation of the one or more digitally connected products of the set of digitally connected products.

In some aspects, the techniques described herein relate to a digital product network system, wherein the digital twin system is further configured to generate a digital twin representing one or more of an entity, an environment, and a workflow of the digital product network.

In some aspects, the techniques described herein relate to a digital product network system, wherein the entity includes one or more of an additional connected product, a physical object, a 3D printer, a manufacturer, a distributor, a consumer, a service provider, a retailer, a payment provider, and a regulator.

In some aspects, the techniques described herein relate to a digital product network system, wherein the environment includes one or more of a warehouse, a manufacturing facility, a 3D printing facility, a service provider facility, a smart container, a container, a shipping port, a truck, a transportation network, a physical retail store, a digital marketplace, a virtual reality environment, a storage facility, and a digital product network.

In some aspects, the techniques described herein relate to a digital product network system, wherein the workflow includes one or more of a product design workflow, a product component sourcing workflow, a product manufacturing workflow, a product packaging workflow, a product distribution workflow, a product marketing and sales workflow, a product display workflow, a product interaction workflow, a product usage workflow, a data collection workflow, a product repair workflow, a product recall workflow, a product lifecycle management workflow, a product maintenance workflow, a data processing workflow, a network integration workflow, and a feedback loop workflow.

In some aspects, the techniques described herein relate to a digital product network system, wherein the information relates to one or more of product design data, product status data, product usage data, product error data, product diagnostic data, product location data, product maintenance data, user interaction data, network data, event data, product performance data, and environmental data.

In some aspects, the techniques described herein relate to a digital product network system further including providing an embedded marketplace in the digital twin of the digitally connected product for enabling transactions related to of one or more of a model, data, a product update, a product upgrade, a product add-on, a product-related service offering, and a product part related to the one or more digitally connected products.

In some aspects, the techniques described herein relate to a digital product network system further including simulating at least one of a behavior, a performance, an environment, and an interaction of the digital twin using CAD-based models.

In some aspects, the techniques described herein relate to a digital product network system, further including generating an alert based on information represented in the digital twin.

In some aspects, the techniques described herein relate to a digital product network system, further including providing hierarchical digital twins, wherein each hierarchical digital twin represents a hierarchy of the at least one of an entity, an environment, or a workflow in the digital product network.

In some aspects, the techniques described herein relate to a digital product network system, further including providing context-adaptive digital twins, wherein the context-adaptive digital twin is configured for adapting the representation of the at least one of an entity, an environment, and a workflow based on changes in context.

In some aspects, the techniques described herein relate to a digital product network system, further including providing a role-based digital twin configured to represent information associated with a role associated with the one or more digitally connected products, wherein the role-based digital twin is configured for a consumer, a supplier, a manufacturer, a logistics manager, a retailer, a service provider, a product manager, a marketing and sales manager, an inventory manager, or a quality manager.

In some aspects, the techniques described herein relate to a method for providing a digital twin in a digital product network system, the method including: receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and providing the information to a digital twin system, wherein the digital twin system is configured to generate a digital twin of one or more digitally connected products of the set of digitally connected products based on the information, wherein each digital twin provides a substantially real-time representation of the one or more digitally connected products of the set of digitally connected products.

In some aspects, the techniques described herein relate to a method further including generating a digital twin representing one or more of an entity, an environment, and a workflow of the digital product network.

In some aspects, the techniques described herein relate to a method, wherein the entity includes one or more of an additional connected product, a physical object, a 3D printer, a manufacturer, a distributor, a consumer, a service provider, a payment provider, and a regulator.

In some aspects, the techniques described herein relate to a method, wherein the environment includes one or more of a warehouse, a manufacturing facility, a 3D printing facility, a service provider facility, a smart container, a container, a truck, a transportation network, a physical retail store, a digital marketplace, a virtual reality environment, a storage facility, and a connected product network.

In some aspects, the techniques described herein relate to a method, wherein the workflow includes one or more of a product design workflow, a product component sourcing workflow, a product manufacturing workflow, a product packaging workflow, a product distribution workflow, a product marketing and sales workflow, a product display workflow, a product interaction workflow, a product usage workflow, a data collection workflow, a product repair workflow, a product recall workflow, a product lifecycle management workflow, a product maintenance workflow, a data processing workflow, a network integration workflow, and a feedback loop workflow.

In some aspects, the techniques described herein relate to a method, wherein the information relates to one or more of product status data, product usage data, product error data, product diagnostic data, product location data, product maintenance data, user interaction data, network data, event data, product performance data, and environmental data.

In some aspects, the techniques described herein relate to a method further including providing an embedded marketplace in the digital twin of the digitally connected product for purchase, sale, and exchange of one or more of a model, data, a product update, a product upgrade, a product add-on, a product-related service offering, and a product part related to the one or more digitally connected products.

In some aspects, the techniques described herein relate to a method further including simulating at least one of a behavior, a performance, an environment, and an interaction of the digital twin utilizing CAD-based models.

In some aspects, the techniques described herein relate to a method further including generating an alert based on data represented in the digital twin.

In some aspects, the techniques described herein relate to a method further including providing hierarchical digital twins, wherein each hierarchical digital twin represents a hierarchy of the at least one of an entity, an environment, or a workflow in the digital product network.

In some aspects, the techniques described herein relate to a method further including providing context-adaptive digital twin, wherein each context-adaptive digital twin is configured for adapting the representation of the at least one of an entity, an environment, and a workflow based on changes in context.

In some aspects, the techniques described herein relate to a method further including providing a role-based digital twin configured to represent a role associated with the digital product network, and wherein the role-based digital twin is configured for a consumer, a supplier, a manufacturer, a logistics manager, a retailer, a service provider, a product manager, a marketing and sales manager, an inventory manager, and a quality manager.

In some aspects, the techniques described herein relate to a method for providing an Artificial Intelligence (AI)-based supply chain digital twin for digitally connected products, the method including: receiving, by a computing device, information associated with a set of digitally connected products of a digital product network system, the information generated by at least one of: a set of sensors of the set of digitally connected products, a set of IoT devices configured to collect data relating to the set of digitally connected products, or a set of APIs configured to publish data relating to the set of digitally connected products; and providing the information to a digital twin system, wherein the digital twin system is configured to update a digital twin representing a supply chain network for the set of digitally connected products based on the information, wherein the digital twin provides a substantially real-time representation of a set of supply chain entities of the supply chain network; providing the information to a set of Artificial Intelligence (AI)-based learning models, wherein at least one member of the set of AI-based learning models is trained on a training data set of a set of digital product network data to determine a classification of at least one of: an operating state, a fault condition, an operating flow, or a behavior of the supply chain network and at least one member of the set of AI-based learning models is trained on the training data set to determine, upon receiving the classification of the at least one of the: operating state, the fault condition, the operating flow, or the behavior, a task to be completed for the supply chain network; and providing at least one of an instruction for executing the task in the supply chain network digital twin and a recommendation for executing the task in the supply chain network digital twin.

In some aspects, the techniques described herein relate to a method, wherein the information includes real-time data about one of: inbound prepaid shipments from suppliers linked to orders; or inventory coming into a network associated with the supply chain network.

In some aspects, the techniques described herein relate to a method wherein receiving the information associated with the supply chain network includes receiving sensor data indicative of inbound and outbound shipment conditions.

In some aspects, the techniques described herein relate to a method further including generating simulations for the supply chain network digital twin, wherein the simulations for the supply chain network digital twin are generated with a graphical neural network (GNN).

In some aspects, the techniques described herein relate to a method, wherein a robotic operating system enables the supply chain network digital twin.

In some aspects, the techniques described herein relate to a method, wherein the supply chain network digital twin operates within a digital twin system having one or more sets of one or more digital twins, wherein each digital twin of the one or more sets includes an embedded marketplace for digital twin simulations.

In some aspects, the techniques described herein relate to a method, wherein the supply chain network digital twin operates within a digital twin system having one or more sets of one or more digital twins, wherein each digital twin of the one or more sets includes an embedded marketplace for one of artificial intelligence-based learning models or artificial intelligence-based algorithms.

In some aspects, the techniques described herein relate to a method, wherein the supply chain network digital twin operates within a digital twin system having one or more sets of one or more digital twins, wherein each digital twin of the one or more sets includes an embedded marketplace for data.

In some aspects, the techniques described herein relate to a method, wherein the set of the supply chain network entities includes at least one of: digitally connected products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

In some aspects, the techniques described herein relate to a method, wherein the set of AI-based learning models includes at least one of: a transformer model, a convolutional neural network, a deep learning model, a supervised model, a semi-supervised model, an unsupervised model, or a reinforcement model.

In some aspects, the techniques described herein relate to a computing system including one or more processors and one or more memories configured to perform operations including: receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and providing the information to a digital twin system, wherein the digital twin system is configured to update a digital twin representing a supply chain network for the set of digitally connected products based on the information, wherein the digital twin provides a substantially real-time representation of a set of supply chain entities of the supply chain network; providing the information to a set of Artificial Intelligence (AI)-based learning models, wherein at least one member of the set of AI-based learning models is trained on a training data set of a set of digital product network data to determine a classification of at least one of: an operating state, a fault condition, an operating flow, or a behavior of the supply chain network and at least one member of the set of AI-based learning models is trained on the training data set to determine, upon receiving the classification of the at least one of the: operating state, the fault condition, the operating flow, or the behavior, a task to be completed for the supply chain network; and providing at least one of an instruction for executing the task in the supply chain network digital twin and a recommendation for executing the task in the supply chain network digital twin.

In some aspects, the techniques described herein relate to a computing system, wherein the information includes real-time data about one of: inbound prepaid shipments from suppliers linked to orders; or inventory coming into a network associated with the supply chain network.

In some aspects, the techniques described herein relate to a computing system, wherein receiving the information associated with the supply chain network includes receiving sensor data indicative of inbound and outbound shipment conditions.

In some aspects, the techniques described herein relate to a computing system, wherein the operations further include generating simulations for the supply chain network digital twin, wherein the simulations for the supply chain network digital twin are generated with a graphical neural network (GNN).

In some aspects, the techniques described herein relate to a computing system, wherein a robotic operating system enables the supply chain network digital twin.

In some aspects, the techniques described herein relate to a computing system, wherein the supply chain network digital twin operates within a digital twin system having one or more sets of one or more digital twins, wherein each digital twin of the one or more sets includes an embedded marketplace for digital twin simulations.

In some aspects, the techniques described herein relate to a computing system, wherein the supply chain network digital twin operates within a digital twin system having one or more sets of one or more digital twins, wherein each digital twin of the one or more sets includes an embedded marketplace for one of artificial intelligence-based learning models or artificial intelligence-based algorithms.

In some aspects, the techniques described herein relate to a computing system, wherein the supply chain network digital twin operates within a digital twin system having one or more sets of one or more digital twins, wherein each digital twin of the one or more sets includes an embedded marketplace for data.

In some aspects, the techniques described herein relate to a computing system, wherein the set of the supply chain network entities includes at least one of: digitally connected products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

In some aspects, the techniques described herein relate to a computing system, wherein the set of AI-based learning models includes at least one of: a transformer model, a convolutional neural network, a deep learning model, a supervised model, a semi-supervised model, an unsupervised model, or a reinforcement model.

In some aspects, the techniques described herein relate to a digital product network system including one or more processors and one or more memories configured to perform operations including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to determine a set of demand planning actions providing a computer code instruction set to a machine to execute the set of demand planning actions.

In some aspects, the techniques described herein relate to a digital product network system, wherein the set of demand planning actions includes at least one of forecasting a measure of demand, inventory management, capacity planning, supply chain coordination, customer prioritization, order quantity limits, dynamic pricing, alternative product promotions, marketing campaigns, product improvements, market expansion, and customer engagement.

In some aspects, the techniques described herein relate to a digital product network system, wherein the information includes at least one of historical sales data, market data, social media data, customer data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, supplier data, component data, quality control data, inspection data, failure data, warranty data, service record data, regulatory data, entertainment data, event data, regulatory compliance data, incident data, weather data, and accident report data.

In some aspects, the techniques described herein relate to a digital product network system, wherein the set of AI-based learning models includes at least one of: a transformer model, a convolutional neural network, a deep learning model, a supervised model, a semi-supervised model, a generative model, a large language model, a recommendation model, an unsupervised model, a reinforcement model, and a regression model.

In some aspects, the techniques described herein relate to a digital product network system, wherein the set of demand planning action includes forecasting a measure of demand for each of a plurality of demographic groups at a future date and/or time.

In some aspects, the techniques described herein relate to a digital product network system, wherein the set of demand planning actions further include generating and distributing a marketing message associated with the set of digitally connected products for a specific demographic group based on the forecasted measure of demand.

In some aspects, the techniques described herein relate to a digital product network system, wherein the set of demand planning actions includes forecasting a measure of demand for each of a plurality of geographic regions at a future date and/or time.

In some aspects, the techniques described herein relate to a digital product network system, wherein the set of demand planning actions further include generating and distributing a marketing message associated with the set of digitally connected products for a specific geographic region based on the forecasted measure of demand.

In some aspects, the techniques described herein relate to a digital product network system, wherein the set of demand planning actions includes forecasting a measure of demand for each of a plurality of channel preference segments at a future date and/or time.

In some aspects, the techniques described herein relate to a method for demand planning in a digital product network system, the method including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to determine a set of demand planning actions for the set of digitally connected products; and providing a computer code instruction set to a machine to execute the set of demand planning actions.

In some aspects, the techniques described herein relate to a method, wherein the set of demand planning action relates to at least one of forecasting a measure of demand, inventory management, capacity planning, supply chain coordination, customer prioritization, order quantity limits, dynamic pricing, alternative product promotions, marketing campaigns, product improvements, market expansion, and customer engagement.

In some aspects, the techniques described herein relate to a method, wherein the information includes at least one of historical sales data, market data, social media data, customer data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, supplier data, component data, quality control data, inspection data, failure data, warranty data, service record data, regulatory data, entertainment data, event data, regulatory compliance data, incident data, weather data, and accident report data.

In some aspects, the techniques described herein relate to a method, wherein each set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, a recommendation model, and a regression model.

In some aspects, the techniques described herein relate to a method, wherein the set of demand planning action includes forecasting a measure of demand for each of a plurality of demographic groups at a future date and/or time.

In some aspects, the techniques described herein relate to a method, wherein the set of demand planning actions further include generating and distributing a marketing message associated with the set of digitally connected products for a specific demographic group based on the forecasted measure of demand.

In some aspects, the techniques described herein relate to a method, wherein the set of demand planning actions includes forecasting a measure of demand for each of a plurality of geographic regions at a future date and/or time.

In some aspects, the techniques described herein relate to a method, wherein the set of demand planning actions further include generating and distributing a marketing message associated with the set of digitally connected products for a specific geographic region based on the forecasted measure of demand.

In some aspects, the techniques described herein relate to a method, wherein the set of demand planning actions includes forecasting a measure of demand for each of a plurality of channel preference segments at a future date and/or time.

In some aspects, the techniques described herein relate to a digital product network system including one or more processors and one or more memories configured to perform operations including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to predict a future inventory level requirement for the set of digitally connected products based on the information and at least one member of the set of AI-based learning models is trained on the training data set to determine an action to meet the predicted inventory level requirement based on the prediction and the information; at least one of outputting the determined action and providing a computer code instruction set to a machine to execute the determined action.

In some aspects, the techniques described herein relate to a digital product network system, wherein the information includes at least one of historical sales data, market data, social media data, customer data, economic sentiment data, economic data, supply chain data, inventory data, lead time data, sensor data, market research data, competitive analysis data, economic indicator data, industry trends data, customer feedback data, historical product development data, project management data, resource availability data, supplier data, supplier performance data, supplier pricing data, manufacturing data, quality control and testing data, regulatory and compliance data, historical recall data, manufacturing data, supplier data, component data, quality control data, inspection data, failure data, warranty and service records, regulatory data, entertainment data, event data, regulatory compliance data, incident data, weather data, and accident report data.

In some aspects, the techniques described herein relate to a digital product network system, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a digital product network system, wherein the determined action relates to at least one of: engaging secondary manufacturers or contract manufacturers to supplement production capacity, implementing overtime shifts at manufacturing facilities to temporarily increase production, redistributing inventory, simplifying product designs, implementing strategic stockpiling, supplementing production capacity with 3D printers, increasing storage and/or warehouse capacity, implementing cross-docking, adjusting production settings, and improving return management.

In some aspects, the techniques described herein relate to a digital product network system, wherein at least one member of the set of AI-based learning models is trained on a training data set of digital product network data to generate a prediction of future inventory level requirement for each of a plurality of retail locations.

In some aspects, the techniques described herein relate to a digital product network system, wherein at least one member of the set of AI-based learning models is trained on a training data set of digital product network data to generate a prediction of future inventory level requirement for each of a plurality of geographic regions.

In some aspects, the techniques described herein relate to a digital product network system, wherein at least one member of the set of AI-based learning models is trained on a training data set of digital product network data to generate a prediction of future inventory level requirement for each of a plurality of sales channels.

In some aspects, the techniques described herein relate to a digital product network system, wherein the operations further include providing at least one of real-time updates on the inventory level and alerts when the inventory level reaches a certain threshold.

In some aspects, the techniques described herein relate to a digital product network system, wherein the determined action is output to a digital twin user interface.

In some aspects, the techniques described herein relate to a method for inventory optimization in a digital product network system, the method including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to predict a future inventory level requirement for a set of digitally connected products and at least one member of the set of AI-based learning models is trained on the training data set to determine an action to meet the predicted inventory level requirement; at least one of outputting the determined action and providing a computer code instruction set to a machine to execute the determined action.

In some aspects, the techniques described herein relate to a method, wherein the information includes at least one of historical sales data, market data, social media data, customer data, economic sentiment data, economic data, supply chain data, inventory data, lead time data, sensor data, market research data, competitive analysis data, economic indicator data, industry trends data, customer feedback data, historical product development data, project management data, resource availability data, supplier data, supplier performance data, supplier pricing data, manufacturing data, quality control and testing data, regulatory and compliance data, historical recall data, manufacturing data, supplier data, component data, quality control data, inspection data, failure data, warranty and service records, regulatory data, entertainment data, event data, regulatory compliance data, incident data, weather data, and accident report data.

In some aspects, the techniques described herein relate to a method, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a method, wherein the determined action relates to at least one of: engaging secondary manufacturers or contract manufacturers to supplement production capacity, implementing overtime shifts at manufacturing facilities to temporarily increase production, redistributing inventory, simplifying product designs, implementing strategic stockpiling, supplementing production capacity with 3D printers, increasing storage and/or warehouse capacity, implementing cross-docking, improving return management, adjusting production settings, and implementing dynamic pricing strategies.

In some aspects, the techniques described herein relate to a method, wherein at least one member of the set of AI-based learning models is trained on a training data set of digital product network data to generate a prediction of future inventory level requirement for each of a plurality of retail locations.

In some aspects, the techniques described herein relate to a method, wherein at least one member of the set of AI-based learning models is trained on a training data set of digital product network data to generate a prediction of future inventory level requirement for each of a plurality of geographic regions.

In some aspects, the techniques described herein relate to a method, wherein at least one member of the set of AI-based learning models is trained on a training data set of digital product network data to generate a prediction of future inventory level requirement for each of a plurality of sales channels.

In some aspects, the techniques described herein relate to a method further including providing at least one of real-time updates on the inventory level and alerts when the inventory level reaches a certain threshold.

In some aspects, the techniques described herein relate to a method, wherein the determined action is output to a digital twin user interface.

In some aspects, the techniques described herein relate to a digital product network system including one or more processors and one or more memories configured to perform operations including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a first set of Artificial Intelligence (AI)-based learning models, wherein at least one member of the first set of AI-based learning models is trained on a training data set of digital product network data to determine a classification of at least one of an operating state, a fault condition, an operating flow, and a behavior of at least one of the set of digitally connected products; providing the information to a second set of Artificial Intelligence (AI)-based learning models, wherein at least one member of the second set of AI-based learning models is trained on a training data set of digital product network data to recommend at least one design improvement for the set of digitally connected products based on the classification; at least one of outputting the design improvement recommendation and providing a computer code instruction set to a machine to implement the design improvement associated with the set of digitally connected products based on the output of the AI-based learning models.

In some aspects, the techniques described herein relate to a digital product network system, wherein the design improvement includes at least one of modifying an existing product features, adding a new product feature, removing a product feature, replacing a product material, modifying a size of a product, modifying a size of a product part, replacing a product part, modifying a product color, modifying a product style, and rearranging a set of components of the product.

In some aspects, the techniques described herein relate to a digital product network system, wherein the information includes at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, order data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

In some aspects, the techniques described herein relate to a digital product network system, wherein each set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a digital product network system, wherein at least one member of a third set of AI-based learning models is trained on a training data set of digital product network data to predict an impact of the at least one design improvement.

In some aspects, the techniques described herein relate to a digital product network system, wherein the operations further include generating a virtual prototype of the improved product design.

In some aspects, the techniques described herein relate to a digital product network system, wherein at least one member of a third set of AI-based learning models is trained on a training data set of digital product network data to identify potential risks associated with implementing the at least one design improvement.

In some aspects, the techniques described herein relate to a digital product network system, wherein at least one member of a third set of AI-based learning models is trained on a training data set of digital product network data to generate a plan for validating the improved product design, including one or more of defining testing parameters, identifying testing resources, and setting up testing environments.

In some aspects, the techniques described herein relate to a digital product network system, wherein at least one member of a third set of AI-based learning models is trained on a training data set of digital product network data to generate a plan for launching and marketing the improved product design, including one or more of identifying target markets, developing marketing strategies, and planning marketing campaigns.

In some aspects, the techniques described herein relate to a digital product network system, wherein the operations further include determining a per-unit cost for the at least one design improvement.

In some aspects, the techniques described herein relate to a method for improving product design in a digital product network system, the method including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a first set of Artificial Intelligence (AI)-based learning models, wherein at least one member of the first set of AI-based learning models is trained on a training data set of digital product network data to determine a classification of at least one of an operating state, a fault condition, an operating flow, and a behavior of at least one of the set of digitally connected products; providing the information to a second set of Artificial Intelligence (AI)-based learning models, wherein at least one member of the second set of AI-based learning models is trained on a training data set of digital product network data to determine at least one design improvement for the set of digitally connected products based on the classification; at least one of outputting the design improvement recommendation and providing a computer code instruction set to a machine to implement the design improvement associated with the digitally connected products based on the output of the AI-based learning models.

In some aspects, the techniques described herein relate to a method, wherein the design improvement includes one or more of modifying an existing product feature, adding a new product feature, removing a product feature, replacing a product material, modifying a size of a product, modifying a size of a product part, replacing a product part, modifying a product color, modifying a product style, and rearranging a set of components of the product.

In some aspects, the techniques described herein relate to a method, wherein the information includes at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, order data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

In some aspects, the techniques described herein relate to a method, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a method, wherein at least one member of a third set of AI-based learning models is trained on a training data set of digital product network data to predict an impact of the at least one design improvement.

In some aspects, the techniques described herein relate to a method, wherein the operations further include generating a virtual prototype of the improved product design.

In some aspects, the techniques described herein relate to a method, wherein at least one member of a third set of AI-based learning models is trained on a training data set of digital product network data to identify potential risks associated with implementing the at least one design improvement.

In some aspects, the techniques described herein relate to a method, wherein at least one member of a third set of AI-based learning models is trained on a training data set of digital product network data to generate a plan for validating the improved product design, including one or more of defining testing parameters, identifying testing resources, and setting up testing environments.

In some aspects, the techniques described herein relate to a method, wherein at least one member of a third set of AI-based learning models is trained on a training data set of digital product network data to generate a plan for launching and marketing the improved product design, including one or more of identifying target markets, developing marketing strategies, and planning marketing campaigns.

In some aspects, the techniques described herein relate to a method, wherein the operations further include determining a per-unit cost for the at least one design improvement.

In some aspects, the techniques described herein relate to a digital product network system including one or more processors and one or more memories configured to perform operations including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to determine at least one product feature preference for the set of digitally connected products for each location of a set of locations; and outputting the at least one product feature preference for the set of digitally connected products for each location of a set of locations.

In some aspects, the techniques described herein relate to a digital product network system, wherein the information includes at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, sales data, geographic data, demographic data, customer behavior data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

In some aspects, the techniques described herein relate to a digital product network system, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a digital product network system, wherein the at least one member of the set of AI-based learning models is trained on a training data set of digital product network data to determine at least one product feature preference for the set of digitally connected products for a plurality of geographic segments.

In some aspects, the techniques described herein relate to a digital product network system, wherein the operations further include determining a sales measure associated with each of the plurality of geographic segments.

In some aspects, the techniques described herein relate to a digital product network system, wherein the at least one member of the set of AI-based learning models is trained on a training data set of digital product network data to determine at least one product feature preference for a plurality of demographic segments for the set of digitally connected products.

In some aspects, the techniques described herein relate to a digital product network system, wherein the operations further include determining a sales measure associated with each of the plurality of demographic segments.

In some aspects, the techniques described herein relate to a digital product network system, wherein the at least one member of the set of AI-based learning models is trained on a training data set of digital product network data to determine at least one product feature preference for a plurality of consumer behavioral segments for the set of digitally connected products.

In some aspects, the techniques described herein relate to a digital product network system, wherein the operations further include determining a sales measure associated with each of the plurality of consumer behavioral segments.

In some aspects, the techniques described herein relate to a digital product network system, wherein the operations further include providing a recommendation for product development for the set of digitally connected products based on the determined at least one product feature preference, wherein the recommendation includes: modifying one or more of existing product features, adding a new product feature, removing a product feature, replacing a product material, modifying a size of a product, modifying a size of a product part, replacing a product part, modifying a product color, modifying a product style, or rearranging a set of components of the product.

In some aspects, the techniques described herein relate to a method for determining product feature preferences in a digital product network system, the method including: receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products; providing the information to a set of Artificial Intelligence (AI)-based learning models, wherein at least one member of the set of AI-based learning models is trained on a training data set of digital product network data to determine at least one product feature preference for the set of digitally connected products for each of a set of locations; and outputting the at least one product feature preference for the set of digitally connected products for each location of a set of locations.

In some aspects, the techniques described herein relate to a method, wherein the information includes at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, sales data, geographic data, demographic data, customer behavior data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

In some aspects, the techniques described herein relate to a method, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

In some aspects, the techniques described herein relate to a method, wherein the at least one member of the set of AI-based learning models is trained on a training data set of digital product network data to determine at least one product feature preference for a plurality of geographic segments for the set of digitally connected products.

In some aspects, the techniques described herein relate to the method of 186 further including determining a sales measure associated with each of the plurality of geographic segments.

In some aspects, the techniques described herein relate to a method, wherein the at least one member of the set of AI-based learning models is trained on a training data set of digital product network data to determine at least one product feature preference for a plurality of demographic segments for the set of digitally connected products.

In some aspects, the techniques described herein relate to a method further including determining a sales measure associated with each of the plurality of demographic segments.

In some aspects, the techniques described herein relate to a method, wherein the at least one member of the set of AI-based learning models is trained on a training data set of digital product network data to determine at least one product feature preference for a plurality of behavioral segments for the set of digitally connected products.

In some aspects, the techniques described herein relate to a method further including determining a sales measure associated with each of the plurality of behavioral segments.

In some aspects, the techniques described herein relate to a method further including providing a recommendation for product development for the set of digitally connected products based on the at least one product feature preference, wherein the recommendation includes: modifying one or more of existing product features, adding a new product feature, removing a product feature, replacing a product material, modifying a size of a product, modifying a size of a product part, replacing a product part, modifying a product color, modifying a product style, or rearranging a set of components of the product.

In some aspects, the techniques described herein relate to a generative artificial intelligence system for a digital product network, the system including one or more processors and one or more memories configured to perform operations including: executing, by the generative artificial intelligence system, generative artificial intelligence algorithms trained on digital product network data; receiving input data including at least one of images, video, audio, text, programmatic code, and data; processing the input data using the generative artificial intelligence algorithms to generate output content, wherein the output content includes at least one of structured prose, images, video, audio content, software source code, formatted data, algorithms, definitions, and context-specific structures; generating an internal state of the generative artificial intelligence system, including a set of weights and/or biases as a result of prior processing; and providing the generated output content to a user interface for presentation to a user.

In some aspects, the techniques described herein relate to a generative artificial intelligence system, wherein the input data further includes natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations.

In some aspects, the techniques described herein relate to a generative artificial intelligence system, wherein the generative artificial intelligence system is configured to maintain contextual awareness across interactions to facilitate continuity in dialogue with users.

In some aspects, the techniques described herein relate to a generative artificial intelligence system, wherein the generative artificial intelligence system is configured to support interpretability and explainability of its outputs by providing a description of a basis of the output.

In some aspects, the techniques described herein relate to a generative artificial intelligence system, wherein the output includes a recommendation to improve at least one of the digital product network and a digitally connected product within the digital product network.

In some aspects, the techniques described herein relate to a generative artificial intelligence system, further including a digital twin interface for a digital twin, wherein the digital twin interface is configured to enable access to the generative artificial intelligence system, and wherein the digital twin represents at least one of the digital product network and a digitally connected product within the digital product network.

In some aspects, the techniques described herein relate to a generative artificial intelligence system, further including a digital twin module configured to generate a digital twin representing at least one of a digital product network and a digitally connected product within the digital product network.

In some aspects, the techniques described herein relate to a generative artificial intelligence system, wherein the processor is further configured to communicate with robotic systems within the digital product network, and the memory stores instructions that enable the generative artificial intelligence system to translate human commands into robotic actions, thereby facilitating human-to-robot interaction.

In some aspects, the techniques described herein relate to a generative artificial intelligence system, wherein the output content is further tailored based on an executive role of the user.

In some aspects, the techniques described herein relate to a generative artificial intelligence system, wherein the generated output includes 3D printing instructions for a set of 3D printers.

In some aspects, the techniques described herein relate to a generative artificial intelligence system, wherein the system is part of a Dual Process Artificial Neural Network (DPANN) architecture.

In some aspects, the techniques described herein relate to a generative artificial intelligence system, further including an augmented reality (AR) interface configured to overlay the generated output content onto a user's real-world view.

In some aspects, the techniques described herein relate to a method for operating a generative artificial intelligence system within a value chain network, the method including: executing, by the generative artificial intelligence system, generative artificial intelligence algorithms trained on value chain network data; receiving input data including at least one of images, video, audio, text, programmatic code, and data; processing the input data using the generative artificial intelligence system to generate output content, wherein the output content includes at least one of structured prose, images, video, audio content, software source code, formatted data, algorithms, definitions, and context-specific structures; generating an internal state of the generative artificial intelligence system, including a set of weights and/or biases as a result of prior processing; and providing the generated output content to a user interface for presentation to a user.

In some aspects, the techniques described herein relate to a method, further including receiving additional input data including natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations.

In some aspects, the techniques described herein relate to a method, further including maintaining contextual awareness across interactions to facilitate continuity in dialogue with users.

In some aspects, the techniques described herein relate to a method, further including supporting interpretability and explainability of its outputs by providing a description of a basis of the output.

In some aspects, the techniques described herein relate to a method, wherein the generated output includes a recommendation to improve one or more of a digital product network and a digitally connected product within the digital product network.

In some aspects, the techniques described herein relate to a method, wherein the method further includes: interfacing with a digital twin via a digital twin interface, wherein the digital twin interface is configured to facilitate access to the generative artificial intelligence system; and representing, by the digital twin, one or more of a digital product network and a digitally connected product within the digital product network.

In some aspects, the techniques described herein relate to a method, wherein the method further includes: generating, through a digital twin module, a digital twin that represents at least one or more of a digital product network and a digitally connected product within the digital product network.

In some aspects, the techniques described herein relate to a method, wherein the method further includes: communicating with one or more robotic systems within the value chain network; translating human commands into robotic actions; and facilitating human-to-robot interaction within the value chain network, thereby enabling the robotic systems to perform tasks in response to the human commands derived from the generated output content.

In some aspects, the techniques described herein relate to a method, wherein the method further includes: tailoring the output content based on an executive role of the user within an organization.

In some aspects, the techniques described herein relate to a method, wherein the generated output includes 3D printing instructions for a set of 3D printers.

In some aspects, the techniques described herein relate to a method, wherein the generative artificial intelligence system operates as part of a Dual Process Artificial Neural Network (DPANN) architecture.

In some aspects, the techniques described herein relate to a method, wherein the method further includes: interfacing with an augmented reality (AR) interface; and overlaying, by the AR interface, the generated output content onto a user's real-world view.

### BRIEF DESCRIPTION OF THE DRAWINGS

The accompanying drawings, which are included to provide a better understanding of the disclosure, illustrate embodiments of the disclosure and together with the description serve to explain the many aspects of the disclosure. In the drawings:

FIG. 1 is a block diagram showing prior art relationships of various entities and facilities in a supply chain.

FIG. 2 is a block diagram showing components and interrelationships of systems and processes of a value chain network in accordance with the present disclosure.

FIG. 3 is another block diagram showing components and interrelationships of systems and processes of a value chain network in accordance with the present disclosure.

FIG. 4 is a block diagram showing components and interrelationships of systems and processes of a digital products network of FIGS. 2 and 3 in accordance with the present disclosure.

FIG. 5 is a block diagram showing components and interrelationships of systems and processes of a value chain network technology stack in accordance with the present disclosure.

FIG. 6 is a block diagram showing a platform and relationships for orchestrating controls of various entities in a value chain network in accordance with the present disclosure.

FIG. 7 is a block diagram showing components and relationships in embodiments of a value chain network management platform in accordance with the present disclosure.

FIG. 8 is a block diagram showing components and relationships of value chain entities managed by embodiments of a value chain network management platform in accordance with the present disclosure.

FIG. 9 is a block diagram showing network relationships of entities in a value chain network in accordance with the present disclosure.

FIG. 10 is a block diagram showing a set of applications supported by unified data handling layers in a value chain network management platform in accordance with the present disclosure.

FIG. 11 is a block diagram showing components and relationships in embodiments of a value chain network management platform in accordance with the present disclosure.

FIG. 12 is a block diagram showing components and relationships of a data storage layer in embodiments of a value chain network management platform in accordance with the present disclosure.

FIG. 13 is a block diagram showing components and relationships of an adaptive intelligent systems layer in embodiments of a value chain network management platform in accordance with the present disclosure.

FIG. 14 is a block diagram that depicts providing adaptive intelligence systems for coordinated intelligence for sets of demand and supply applications for a category of goods in accordance with the present disclosure.

FIG. 15 is a block diagram that depicts providing hybrid adaptive intelligence systems for coordinated intelligence for sets of demand and supply applications or a category of goods in accordance with the present disclosure.

FIG. 16 is a block diagram that depicts providing adaptive intelligence systems for predictive intelligence for sets of demand and supply applications for a category of goods in accordance with the present disclosure.

FIG. 17 is a block diagram that depicts providing adaptive intelligence systems for classification intelligence for sets of demand and supply applications for a category of goods in accordance with the present disclosure.

FIG. 18 is a block diagram that depicts providing adaptive intelligence systems to produce automated control signals for sets of demand and supply applications for a category of goods in accordance with the present disclosure.

FIG. 19 is a block diagram that depicts training artificial intelligence/machine learning systems to produce information routing recommendations for a selected value chain network in accordance with the present disclosure.

FIG. 20 is a block diagram that depicts a semi-sentient problem recognition system for recognition of pain points/problem states in a value chain network in accordance with the present disclosure.

FIG. 21 is a block diagram that depicts a set of artificial intelligence systems operating on value chain information to enable automated coordination of value chain activities for an enterprise in accordance with the present disclosure.

FIG. 22 is a block diagram showing components and relationships involved in integrating a set of digital twins in an embodiment of a value chain network management platform in accordance with the present disclosure.

FIG. 23 is a block diagram showing a set of digital twins involved in embodiments of a value chain network management platform in accordance with the present disclosure.

FIG. 24 is a block diagram showing components and relationships of entity discovery and management systems in embodiments of a value chain network management platform in accordance with the present disclosure.

FIG. 25 is a block diagram showing components and relationships of a robotic process automation system in embodiments of a value chain network management platform in accordance with the present disclosure.

FIG. 26 is a block diagram showing components and relationships of a set of opportunity miners in an embodiment of a value chain network management platform in accordance with the present disclosure.

FIG. 27 is a block diagram showing components and relationships of a set of edge intelligence systems in embodiments of a value chain network management platform in accordance with the present disclosure.

FIG. 28 is a block diagram showing components and relationships in an embodiment of a value chain network management platform in accordance with the present disclosure.

FIG. 29 is a block diagram showing additional details of components and relationships in embodiments of a value chain network management platform in accordance with the present disclosure.

FIG. 30 is a block diagram showing components and relationships in an embodiment of a value chain network management platform that enables centralized orchestration of value chain network entities in accordance with the present disclosure.

FIG. 31 is a block diagram showing components and relationships of a unified database in an embodiment of a value chain network management platform in accordance with the present disclosure.

FIG. 32 is a block diagram showing components and relationships of a set of unified data collection systems in embodiments of a value chain network management platform in accordance with the present disclosure.

FIG. 33 is a block diagram showing components and relationships of a set of Internet of Things monitoring systems in embodiments of a value chain network management platform in accordance with the present disclosure.

FIG. 34 is a block diagram showing components and relationships of a machine vision system and a digital twin in embodiments of a value chain network management platform in accordance with the present disclosure.

FIG. 35 is a block diagram showing components and relationships of a set of adaptive edge intelligence systems in embodiments of a value chain network management platform in accordance with the present disclosure.

FIG. 36 is a block diagram showing additional details of components and relationships of a set of adaptive edge intelligence systems in embodiments of a value chain network management platform in accordance with the present disclosure.

FIG. 37 is a block diagram showing components and relationships of a set of unified adaptive intelligence systems in embodiments of a value chain network management platform in accordance with the present disclosure.

FIG. 38 is a schematic of a system configured to train an artificial system that is leveraged by a value chain system using real world outcome data and a digital twin system according to some embodiments of the present disclosure.

FIG. 39 is a schematic of a system configured to train an artificial system that is leveraged by a container fleet management system using real world outcome data and a digital twin system according to some embodiments of the present disclosure.

FIG. 40 is a schematic of a system configured to train an artificial system that is leveraged by a logistics design system using real world outcome data and a digital twin system according to some embodiments of the present disclosure.

FIG. 41 is a schematic of a system configured to train an artificial system that is leveraged by a packaging design system using real world outcome data and a digital twin system according to some embodiments of the present disclosure.

FIG. 42 is a schematic of a system configured to train an artificial system that is leveraged by a waste mitigation system using real world outcome data and a digital twin system according to some embodiments of the present disclosure.

FIG. 43 is a schematic illustrating an example of a portion of an information technology system for value chain artificial intelligence leveraging digital twins according to some embodiments of the present disclosure.

FIG. 44 is a block diagram showing components and relationships of a set of intelligent project management facilities in embodiments of a value chain network management platform in accordance with the present disclosure.

FIG. 45 is a block diagram showing components and relationships of an intelligent task recommendation system in embodiments of a value chain network management platform in accordance with the present disclosure.

FIG. 46 is a block diagram showing components and relationships of a routing system among nodes of a value chain network in embodiments of a value chain network management platform in accordance with the present disclosure.

FIG. 47 is a block diagram showing components and relationships of a dashboard for managing a set of digital twins in embodiments of a value chain network management platform.

FIG. 48 is a block diagram showing components and relationships in embodiments of a value chain network management platform that uses a microservices architecture.

FIG. 49 is a block diagram showing components and relationships of an Internet of Things data collection architecture and sensor recommendation system in embodiments of a value chain network management platform.

FIG. 50 is a block diagram showing components and relationships of a social data collection architecture in embodiments of a value chain network management platform.

FIG. 51 is a block diagram showing components and relationships of a crowdsourcing data collection architecture in embodiments of a value chain network management platform.

FIG. 52 is a diagrammatic view that depicts embodiments of a set of value chain network digital twins representing virtual models of a set of value chain network entities in accordance with the present disclosure.

FIG. 53 is a diagrammatic view that depicts embodiments of a warehouse digital twin kit system in accordance with the present disclosure.

FIG. 54 is a diagrammatic view that depicts embodiments of a stress test performed on a value chain network in accordance with the present disclosure.

FIG. 55 is a diagrammatic view that depicts embodiments of methods used by a machine for detecting faults and predicting any future failures of the machine in accordance with the present disclosure.

FIG. 56 is a diagrammatic view that depicts embodiments of deployment of machine twins to perform predictive maintenance on a set of machines in accordance with the present disclosure.

FIG. 57 is a schematic illustrating an example of a portion of a system for value chain customer digital twins and customer profile digital twins according to some embodiments of the present disclosure.

FIG. 58 is a schematic illustrating an example of an advertising application that interfaces with the adaptive intelligent systems layer in accordance with the present disclosure.

FIG. 59 is a schematic illustrating an example of an e-commerce application integrated with the adaptive intelligent systems layer in accordance with the present disclosure.

FIG. 60 is a schematic illustrating an example of a demand management application integrated with the adaptive intelligent systems layer in accordance with the present disclosure.

FIG. 61 is a schematic illustrating an example of a portion of a system for value chain smart supply component digital twins according to some embodiments of the present disclosure.

FIG. 62 is a schematic illustrating an example of a risk management application that interfaces with the adaptive intelligent systems layer in accordance with the present disclosure.

FIG. 63 is a diagrammatic view of maritime assets associated with a value chain network management platform including components of a port infrastructure in accordance with the present disclosure.

FIGS. 64 and 65 are diagrammatic views of maritime assets associated with a value chain network management platform including components of a ship in accordance with the present disclosure.

FIG. 66 is a diagrammatic view of maritime assets associated with a value chain network management platform including components of a barge in accordance with the present disclosure.

FIG. 67 is a diagrammatic view of maritime assets associated with a value chain network management platform including those involved in maritime events, legal proceedings and making use of geofenced parameters in accordance with the present disclosure.

FIG. 68 is a schematic illustrating an example environment of the enterprise and executive control tower and management platform, including data sources in communication therewith, according to some embodiments of the present disclosure.

FIG. 69 is a schematic illustrating an example set of components of the enterprise control tower and management platform according to some embodiments of the present disclosure.

FIG. 70 is a schematic illustrating and example of an enterprise data model according to some embodiments of the disclosure.

FIG. 71 is a schematic illustrating examples of different types of enterprise digital twins, including executive digital twins, in relation to the data layer, processing layer, and application layer of the enterprise digital twin framework according to some embodiments of the present disclosure.

FIG. 72 is a schematic illustrating an example implementation of the enterprise and executive control tower and management platform according to some embodiments of the present disclosure.

FIG. 73 is a flow chart illustrating an example set of operations for configuring and serving an enterprise digital twin.

FIG. 74 illustrates an example set of operations of a method for configuring an organizational digital twin.

FIG. 75 illustrates an example set of operations of a method for generating an executive digital twin.

FIG. 76 is a schematic illustrating an example intelligence services system according to some embodiments of the present disclosure.

FIG. 77 is a schematic illustrating an example neural network with multiple layers according to some embodiments of the present disclosure.

FIG. 78 is a schematic illustrating an example convolutional neural network (CNN) according to some embodiments of the present disclosure.

FIG. 79 is a schematic illustrating an example neural network for implementing natural language processing according to some embodiments of the present disclosure.

FIG. 80 is a schematic illustrating an example reinforcement learning-based approach for executing one or more tasks by a mobile system according to some embodiments of the present disclosure.

FIG. 81 is a schematic illustrating an example environment of a digital product network according to some embodiments of the present disclosure.

FIG. 82 is a schematic illustrating an example environment of a connected product according to some embodiments of the present disclosure.

FIG. 83 is a schematic illustrating an example environment of a digital product network according to some embodiments of the present disclosure.

FIG. 84 is a schematic illustrating an example environment of a digital product network according to some embodiments of the present disclosure.

FIG. 85 is a flow diagram illustrating a method of using product level data according to some embodiments of the disclosure.

FIG. 86 is a schematic illustrating an example environment of a digital product network according to some embodiments of the present disclosure.

FIG. 87 is a block diagram showing a schematic of a dual-process artificial neural network system according to some embodiments of the present disclosure.

FIG. 88 is a schematic view of an example control tower dashboard for one or more VCN processes that may be used with one or more example implementations of the disclosure.

FIG. 89 is an example flowchart of one or more VCN processes that may be used with one or more example implementations of the disclosure.

FIG. 90A is a schematic view of an example control architecture for system facilitation and/or management.

FIG. 90B is a schematic view of another example control architecture for system facilitation and/or management.

FIG. 90C is a schematic view of an example control architecture for system facilitation and/or management.

FIG. 90D is a schematic view of another example control architecture for system facilitation and/or management.

FIG. 91A is a schematic view of an example management stack that includes a control architecture.

FIG. 91B is a schematic view of an example management stack capable of implementing a control architecture.

FIG. 91C is a schematic view of an example management stack that includes a control architecture.

FIG. 91D is a schematic view of an example management stack capable of implementing a control architecture.

FIG. 92A is a flow diagram of an example arrangement for a control architecture.

FIG. 92B is a flow diagram of an example arrangement for a control architecture.

FIG. 93-FIG. 100 are example flowcharts of one or more VCN processes that may be used with one or more example implementations of the disclosure.

FIG. 101 is a schematic view of an example generative AI system.

FIG. 102 is a schematic view of an example of a determination of attention by a machine learning model.

FIG. 103 is a schematic view of an example of a transformer model.

FIG. 104 is a schematic view of a value chain network (VCN) converging technology stack.

FIG. 105 is a block diagram representation of the communication system of the digital product network system, according to some embodiments of the present disclosure.

FIG. 106 is a block diagram representation of the embedded marketplace of the digital product network system, according to some embodiments of the present disclosure.

FIG. 107 is an example flowchart of one or more DPNX processes that may be used with one or more example implementations of the disclosure.

FIG. 108 is an example flowchart of one or more DPNX processes that may be used with one or more example implementations of the disclosure.

FIG. 109 is an example flowchart of one or more DPNX processes that may be used with one or more example implementations of the disclosure.

FIG. 110 is an example flowchart of one or more DPNX processes that may be used with one or more example implementations of the disclosure.

FIG. 111 is an example flowchart of one or more DPNX processes that may be used with one or more example implementations of the disclosure.

FIG. 112 is an example flowchart of one or more DPNX processes that may be used with one or more example implementations of the disclosure.

FIG. 113 is an example flowchart of one or more DPNX processes that may be used with one or more example implementations of the disclosure.

Like reference symbols in the various drawings indicate like elements.

### DETAILED DESCRIPTION

In example embodiments, systems and processes of this disclosure may include information technology processes and systems for management of value chain network entities, including supply chain and demand management entities. In example embodiments, enterprise management platforms, more particularly involving an edge-distributed database and query language for storing and retrieving value chain data may also be used.

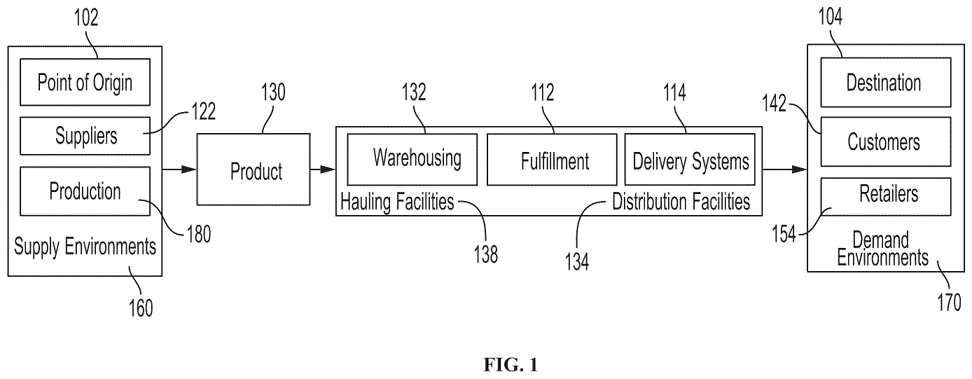

Orders for products were fulfilled by manufacturers through a supply chain, such as depicted in FIG. 1, where suppliers 122 in various supply environments 160, operating production facilities 134 or acting as resellers or distributors for others, made a product 130 available at a point of origin 102 in response to an order. The product 130 was passed through the supply chain, being conveyed and stored via various hauling facilities 138 and distribution facilities 134, such as warehouses 132, fulfillment centers 112 and delivery systems 114, such as trucks and other vehicles, trains, and the like. In many cases, maritime facilities and infrastructure, such as ships, barges, docks and ports provided transport over waterways between the points of origin 102 and one or more destinations 104.

Organizations have access to an almost unlimited amount of data. With the advent of smart connected devices, wearable technologies, the Internet of Things (IoT), and the like, the amount of data available to an organization that is planning, overseeing, managing and operating a value chain network has increased dramatically and will likely continue to do so. For example, in a manufacturing facility, warehouse, campus, or other operating environment, there may be hundreds to thousands of IoT sensors that provide metrics such as vibration data that measure the vibration signatures of important machinery, temperatures throughout the facility, motion sensors that can track throughput, asset tracking sensors and beacons to locate items, cameras and optical sensors, chemical and biological sensors, and many others. Additionally, as wearable technologies become more prevalent, wearables may provide insight into the movement, health indicators, physiological states, activity states, movements, and other characteristics of workers. Furthermore, as organizations implement CRM systems, ERP systems, operations systems, information technology systems, advanced analytics and other systems that leverage information and information technology, organizations have access to an increasingly wide array of other large data sets, such as marketing data, sales data, operational data, information technology data, performance data, customer data, financial data, market data, pricing data, supply chain data, and the like, including data sets generated by or for the organization and third-party data sets.

The presence of more data and data of new types offers many opportunities for organizations to achieve competitive advantages; however, it also presents problems, such as of complexity and volume, such that users can be overwhelmed, missing opportunities for insight. A need exists for methods and systems that allow enterprises not only to obtain data, but to convert the data into insights and to translate the insights into well-informed decisions and timely execution of efficient operations.

Acquiring large data sets from thousands, or potentially millions of devices (containing large numbers of sensors) distributed across multiple organizations in a value chain network has become more typical. For example, there is a proliferation of Radio Frequency Identification (RFID) Tags to individual goods in retail stores. In this situation and other similar situations, a vast number of data streams can overwhelm the ability to transmit the data across networks and/or the ability to create effective automated centralized decisions.

The proliferation of data generators (e.g., sensors) has created an opportunity to manage networks such as value chain networks with input from massive numbers of distributed points of semi-intelligent control. However, current approaches often rely on limited centralized data collection due to bandwidth, storage, processing, and/or other limitations.

Over time, companies have increasingly used technology solutions to improve outcomes related to a traditional supply chain like the one depicted in FIG. 1, such as software systems for predicting and managing customer demand, RFID and asset tracking systems for tracking goods as they move through the supply chain, navigation and routing systems to improve the efficiency of route selection, and the like. However, some large trends have placed manufacturers, retailers and other businesses under increasing pressure to improve supply chain performance. First, online and ecommerce operators, in particular Amazon™ have become the largest retail channels for many categories of goods and have introduced distribution and fulfillment centers 112 throughout some geographies like the United States that house hundreds of thousands, and sometimes more, product categories (SKUs), so that customers can receive items the day after they are ordered, and in some cases on the same day (and in some cases delivered to the door by a drone, robot, and/or autonomous vehicle. For retailers that do not have extensive geographic distribution of fulfillment centers or warehouses, customer expectations for speed of delivery place increased pressure on supply chain efficiency and optimization. Accordingly, a need still exists for improved supply chain methods and systems.

Second, agile manufacturing capabilities (such as using 3D printing and robotic assembly techniques, among others), customer profiling technologies, and online ratings and reviews have led to increased customer expectations for customization and personalization of products. Accordingly, in order to compete, manufacturers and retailers need improved methods and systems for understanding, predicting, and satisfying customer demand.

Historically, supply chain management and demand planning and management have been largely separate activities, unified primarily when demand is converted to an order, which is passed to the supply side for fulfillment in a supply chain. As expectations for speed and personalization increase, a need exists for methods and systems that can provide unified orchestration of supply and demand.

In parallel with these other large trends has been the emergence of the Internet of Things, in which some categories of products, particularly smart home products like thermostats, lighting systems, and speakers, are increasingly enabled with onboard network connectivity and processing capability, often including a voice controlled intelligent agent like Alexa™ or Siri™ that allows device control and triggering of certain application features, such as playing music, or even ordering a product. In some cases, smart products 650 even initiate orders, such as printers that order refill cartridges. Intelligent products 650 are in some cases involved in a coordinated system, such as where an Amazon™ Echo™ product controls a television, or where a sensor-enabled thermostat or security camera connects to a mobile device, but most intelligent products are still involved in sets of largely isolated, application-specific interactions. As artificial intelligence capabilities increase, and as more and more computing and networking power is moved to network-enabled edge devices and systems that reside in supply environments 670, in demand environments 672, and in all of the locations, systems, and facilities that populate the path of a product 1510 from the loading dock of a manufacturer to the point of destination 612 of a customer 662 or retailers 664, a need and opportunity exists for dramatically improved intelligence, control, and automation of all of the factors involved in demand and supply. VALUE CHAIN NETWORKS

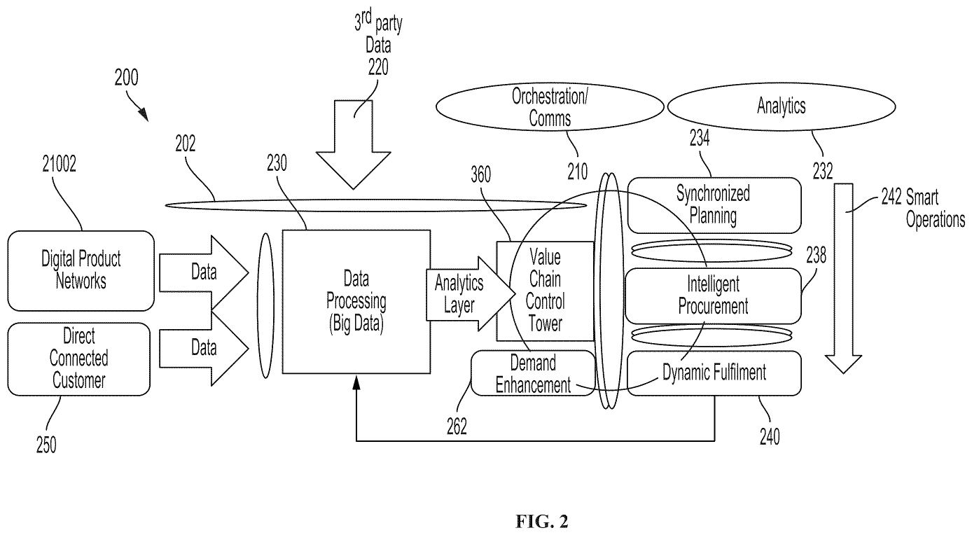

Referring to FIG. 2, a block diagram is presented at 200 showing components and interrelationships of systems and processes of a value chain network. In example embodiments, “value chain network,” as used herein, refers to elements and interconnections of historically segregated demand management systems and processes and supply chain management systems and processes, enabled by the development and convergence of numerous diverse technologies. In example embodiments a value chain control tower 260 (e.g., referred to herein in some cases as a “value chain network management platform”, a “VCNP”, or simply as “the system”, or “the platform”) may be connected to, in communication with, or otherwise operatively coupled with data processing facilities including, but not limited to, big data centers (e.g., big data processing 230) and related processing functionalities that receive data flow, data pools, data streams and/or other data configurations and transmission modalities received from, for example, digital product networks 21002, directly from customers (e.g., direct connected customer 250), or some other third party 220. Communications related to market orchestration activities and communications 210, analytics 232, or some other type of input may also be utilized by the value chain control tower for demand enhancement 262, synchronized planning 234, intelligent procurement 238, dynamic fulfillment 240 or some other smart operation informed by coordinated and adaptive intelligence, as described herein.

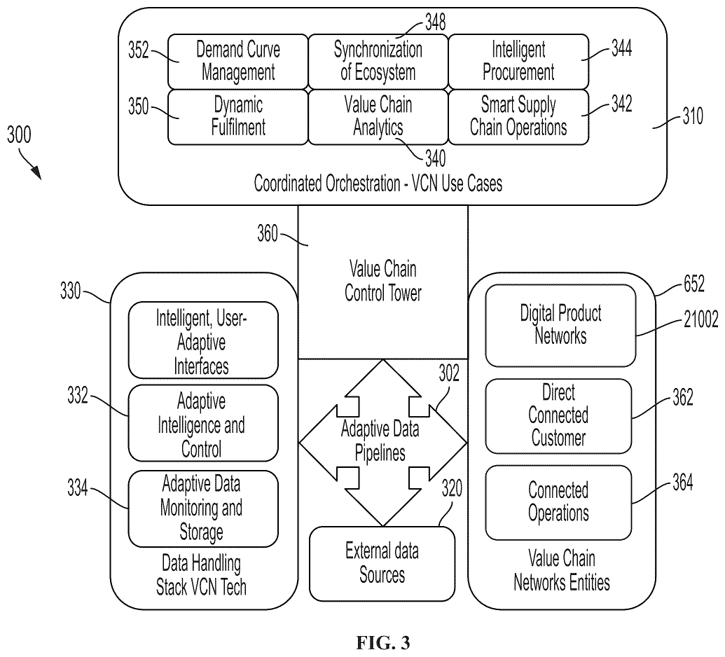

Referring to FIG. 3, another block diagram is presented showing components and interrelationships of systems and processes of a value chain network and related uses cases, data handling, and associated entities. In example embodiments, the value chain control tower 360 may coordinate market orchestration activities 310 including, but not limited to, demand curve management 352, synchronization of an ecosystem 348, intelligent procurement 344, dynamic fulfillment 350, value chain analytics 340, and/or smart supply chain operations 342. In example embodiments, the value chain control tower 360 may be connected to, in communication with, or otherwise operatively coupled with adaptive data pipelines 302 and processing facilities that may be further connected to, in communication with, or otherwise operationally coupled with external data sources 320 and a data handling stack 330 (e.g., value chain network technology) that may include intelligent, user-adaptive interfaces, adaptive intelligence and control 332, and/or adaptive data monitoring and storage 334, as described herein. The value chain control tower 302 may also be further connected to, in communication with, or otherwise operatively coupled with additional value chain entities including, but not limited to, digital product networks 21002, customers (e.g., directed connected customers 362), and/or other connected operations 364 and entities of a value chain network.

### Digital Product Networks (“DPN”)

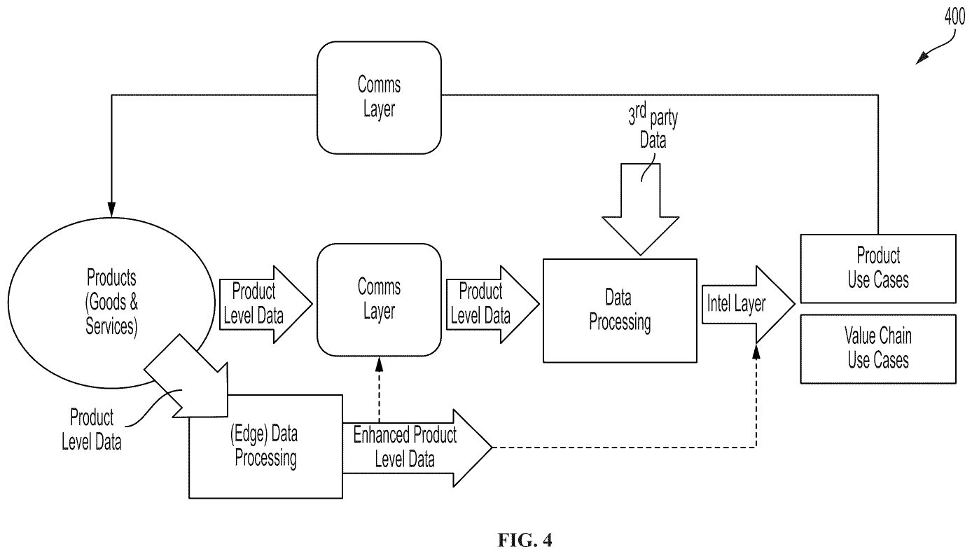

Referring to FIG. 4, a block diagram is presented showing components and interrelationships of systems and processes of the digital products networks at 400. In example embodiments, products (including goods and services) may create and transmit data, such as product level data, to a communication layer within the value chain network technology stack and/or to an edge data processing facility. This data may produce enhanced product level data and may be combined with third party data for further processing, modeling or other adaptive or coordinated intelligence activity, as described herein. This may include, but is not limited to, producing and/or simulating product and value chain use cases, the data for which may be utilized by products, product development processes, product design, and the like.

### Stack View Examples

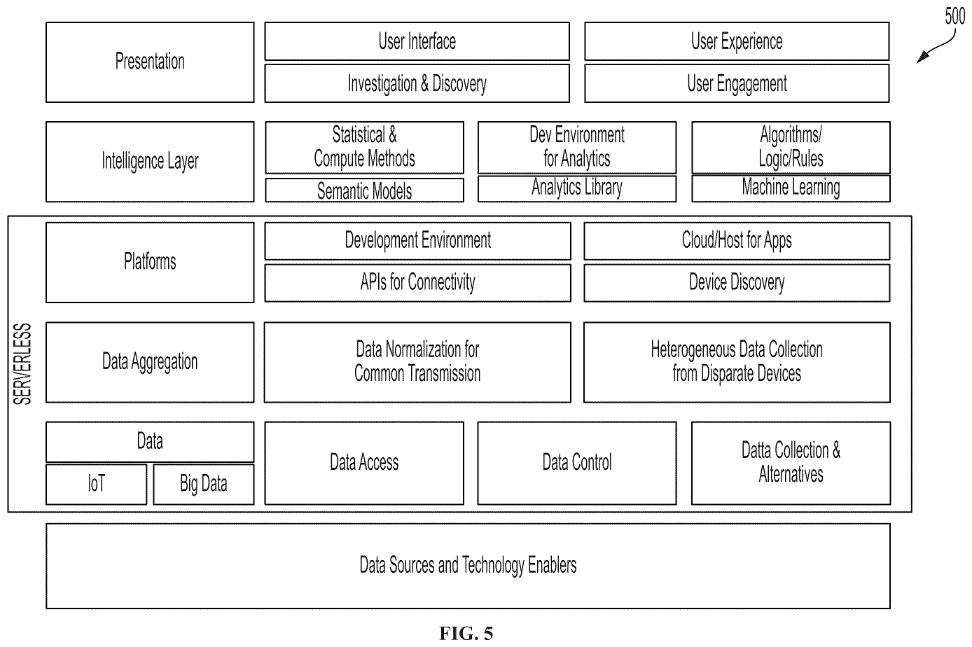

Referring to FIG. 5, a block diagram is presented at 500 showing components and interrelationships of systems and processes of a value chain network technology stack, which may include, but is not limited to a presentation layer, an intelligence layer, and serverless functionalities such as platforms (e.g., development and hosting platforms), data facilities (e.g., relating to data with IoT and Big Data), and data aggregation facilities. In example embodiments, the presentation layer may include, but is not limited to, a user interface, and modules for investigation and discovery and tracking users' experience and engagements. In example embodiments, the intelligence layer may include, but is not limited to, a statistical and computation methods, semantic models, an analytics library, a development environment for analytics, algorithms, logic and rules, and machine learning. In example embodiments, the platforms or the value chain network technology stack may include a development environment, APIs for connectivity, cloud and/or hosting applications, and device discovery. In example embodiments, the data aggregation facilities or layer may include, but is not limited to, modules for data normalization for common transmission and heterogeneous data collection from disparate devices. In example embodiments, the data facilities or layer may include, but is not limited to, IoT and big data access, control, and collection and alternatives. In example embodiments, the value chain network technology stack may be further associated with additional data sources and/or technology enablers.

Value Chain Orchestration from a Command Platform

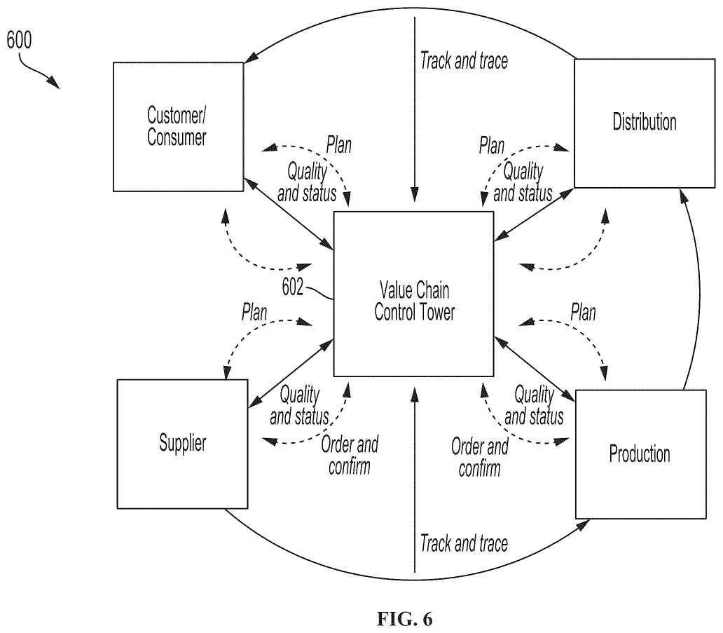

FIG. 6 illustrates a connected value chain network 668 in which a value chain network management platform 604 (referred to herein in some cases as a “value chain control tower,” the “VCNP,” or simply as “the system,” or “the platform”) orchestrates a variety of factors involved in planning, monitoring, controlling, and optimizing various entities and activities involved in the value chain network 668, such as supply and production factors, demand factors, logistics and distribution factors, and the like. By virtue of a unified platform 604 for monitoring and managing supply factors and demand factors as well as status information (e.g., quality and status, plan, order and confirm, and/or track and trace) can be shared about and between various entities (e.g., including customers/consumers, suppliers, distribution such as distributors, suppliers, and production such as producers or production facilities) as demand factors are understood and accounted for, as orders are generated and fulfilled, and as products are created and moved through a supply chain. The value chain network 668 may include not only an intelligent product 1510, but all of the equipment, infrastructure, personnel and other entities involved in planning and satisfying demand for it.

### Value Chain Network and Value Chain Network Management Platform

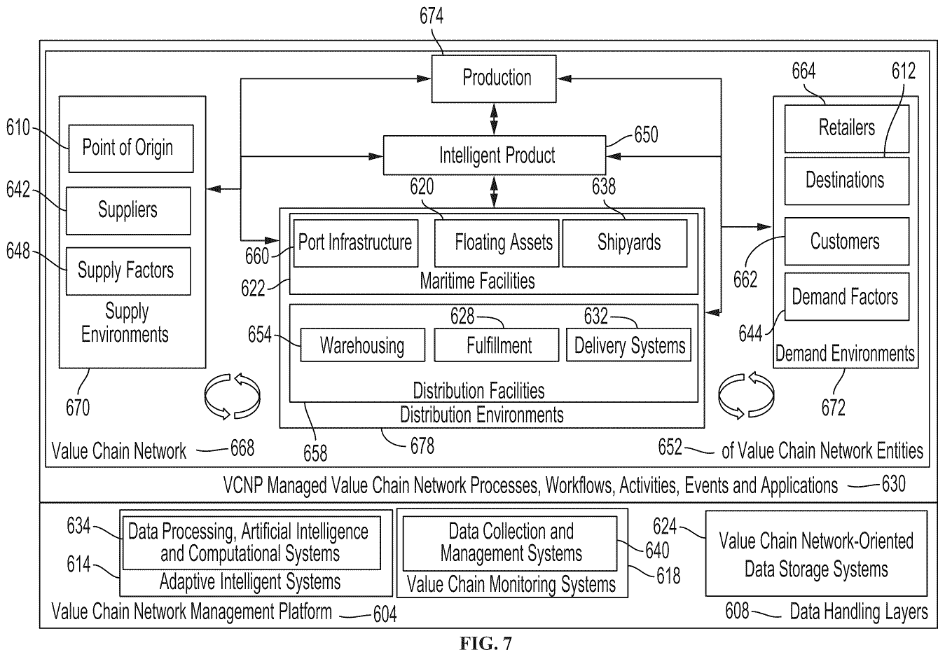

Referring to FIG. 7, the value chain network 668 managed by a value chain management platform 604 may include a set of value chain network entities 652, such as, without limitation: a product 1510, which may be an intelligent product 1510; a set of production facilities 674 involved in producing finished goods, components, systems, sub-systems, materials used in goods, or the like; various entities, activities and other supply factors 648 involved in supply environments 670, such as suppliers 642, points of origin 610, and the like; various entities, activities and other demand factors 644 involved in demand environments 672, such as customers 662 (including consumers, businesses, and intermediate customers such as value added resellers and distributors), retailers 664 (including online retailers, mobile retailers, conventional bricks and mortar retailers, pop-up shops and the like) and the like located and/or operating at various destinations 612; various distribution environments 678 and distribution facilities 658, such as warehousing facilities 654, fulfillment facilities 628, and delivery systems 632, and the like, as well as maritime facilities 622, such as port infrastructure facilities 660, floating assets 620, and shipyards 638, among others. In embodiments, the value chain network management platform 604 monitors, controls, and otherwise enables management (and in some cases autonomous or semi-autonomous behavior) of a wide range of value chain network 668 processes, workflows, activities, events and applications 630 (collectively referred to in some cases simply as “applications 630”).

Referring still to FIG. 7, a high-level schematic of the value chain network management platform 604 is illustrated. The value chain network management platform 604 may include a set of systems, applications, processes, modules, services, layers, devices, components, machines, products, sub-systems, interfaces, connections, and other elements working in coordination to enable intelligent management of a set of value chain entities 652 that may occur, operate, transact or the like within, or own, operate, support or enable, one or more value chain network processes, workflows, activities, events and/or applications 630 or that may otherwise be part of, integrated with, linked to, or operated on by the VCNP 604 in connection with a product 1510 (which may be any category of product, such as a finished good, software product, hardware product, component product, material, item of equipment, item of consumer packaged goods, consumer product, food product, beverage product, home product, business supply product, consumable product, pharmaceutical product, medical device product, technology product, entertainment product, or any other type of product and/or set of related services, and which may, in embodiments, encompass an intelligent product 1510 that is enabled with a set of capabilities such as, without limitation data processing, networking, sensing, autonomous operation, intelligent agent, natural language processing, speech recognition, voice recognition, touch interfaces, remote control, self-organization, self-healing, process automation, computation, artificial intelligence, analog or digital sensors, cameras, sound processing systems, data storage, data integration, and/or various Internet of Things capabilities, among others.

In embodiments, the management platform 604 may include a set of data handling layers 608 each of which is configured to provide a set of capabilities that facilitate development and deployment of intelligence, such as for facilitating automation, machine learning, applications of artificial intelligence, intelligent transactions, state management, event management, process management, and many others, for a wide variety of value chain network applications and end uses. In embodiments, the data handling layers 608 are configured in a topology that facilitates shared data collection and distribution across multiple applications and uses within the platform 604 by a value chain monitoring systems layer 614. The value chain monitoring systems layer 614 may include, integrate with, and/or cooperate with various data collection and management systems 640, referred to for convenience in some cases as data collection systems 640, for collecting and organizing data collected from or about value chain entities 652, as well as data collected from or about the various data layers 624 or services or components thereof. In embodiments, the data handling layers 608 are configured in a topology that facilitates shared or common data storage across multiple applications and uses of the platform 604 by a value chain network-oriented data storage systems layer 624, referred to herein for convenience in some cases simply as a data storage layer 624 or storage layer 624. As shown in FIG. 7, the data handling layers 608 may also include an adaptive intelligent systems layer 614. The adaptive intelligence systems layer 614 may include a set of data processing, artificial intelligence and computational systems 634 that are described in more detail elsewhere throughout this disclosure. The data processing, artificial intelligence and computational systems 634 may relate to artificial intelligence (e.g., expert systems, artificial intelligence, neural, supervised, machine learning, deep learning, model-based systems, and the like). Specifically, the data processing, artificial intelligence and computational systems 634 may relate to various examples, in some embodiments, such as use of a recurrent network as adaptive intelligence system operating on a blockchain of transactions in a supply chain to determine a pattern, use with biological systems, opportunity mining (e.g., where artificial intelligence system may be used to monitor for new data sources as opportunities for automatically deploying intelligence), robotic process automation (e.g., automation of intelligent agents for various workflows), edge and network intelligence (e.g., implicated on monitoring systems such as adaptively using available RF spectrum, adaptively using available fixed network spectrum, adaptively storing data based on available storage conditions, adaptively sensing based on a kind of contextual sensing), and the like.

In embodiments, the data handling layers 608 may be depicted in vertical stacks or ribbons in the figures and may represent many functionalities available to the platform 604 including storage, monitoring, and processing applications and resources and combinations thereof. In embodiments, the set of capabilities of the data handling layers 608 may include a shared microservices architecture. By way of these examples, the set of capabilities may be deployed to provide multiple distinct services or applications, which can be configured as one or more services, workflows, or combinations thereof. In some examples, the set of capabilities may be deployed within or be resident to certain applications or processes. In some examples, the set of capabilities can include one or more activities marshaled for the benefit of the platform. In some examples, the set of capabilities may include one or more events organized for the benefit of the platform. In embodiments, one of the sets of capabilities of the platform may be deployed within at least a portion of a common architecture such as common architecture that supports a common data schema. In embodiments, one of the sets of capabilities of the platform may be deployed within at least a portion of a common architecture that can support a common storage. In embodiments, one of the sets of capabilities of the platform may be deployed within at least a portion of a common architecture that can support common monitoring systems. In embodiments, one or more sets of capabilities of the platform may be deployed within at least a portion of a common architecture that can support one or more common processing frameworks. In embodiments, the set of capabilities of the data handling layers 608 can include examples where the storage functionality supports scalable processing capabilities, scalable monitoring systems, digital twin systems, payments interface systems, and the like. By way of these examples, one or more software development kits can be provided by the platform along with deployment interfaces to facilitate connections and use of the capabilities of the data handling layers 608. In further examples, adaptive intelligence systems may analyze, learn, configure, and reconfigure one or more of the capabilities of the data handling layers 608. In embodiments, the platform 604 may, for example, include a common data storage schema serving a shipyard entity related service and a warehousing entity service. There are many other applicable examples and combinations applicable to the foregoing example including the many value chain entities disclosed herein. By way of these examples, the platform 604 may be shown to create connectivity (e.g., supply of capabilities and information) across many value chain entities. In many examples, there are pairings (doubles, triples, quadruplets, etc.) of similar kinds of value chain entities using one or more smaller sets of capabilities of the data handling layers 608 to deploy (interact with, rely on, etc.) a common data schema, a common architecture, a common interface, and the like. While services and capabilities can be provided to single value chain entities, the platform can be shown to provide myriad benefits to value chains and consumers by supporting connectivity across value chain entities and applications used by the entities.

### Value Chain Network Entities Managed by the Platform

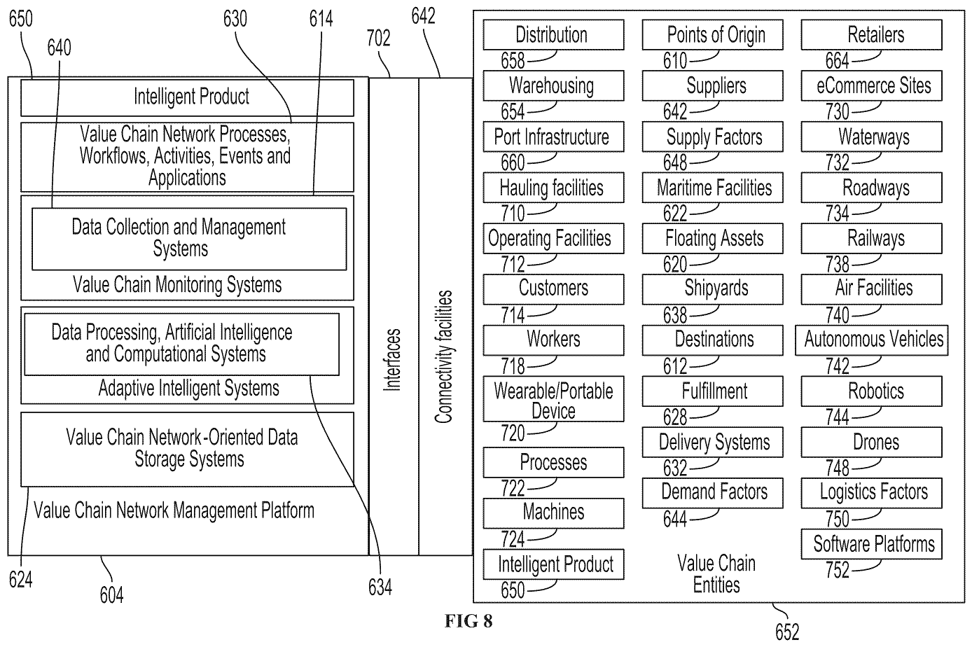

Referring to FIG. 8, the value chain network management platform 604 is illustrated in connection with a set of value chain entities 652 that may be subject to management by the platform 604, may integrate with or into the platform 604, and/or may supply inputs to and/or take outputs from the platform 604, such as ones involved in or for a wide range of value chain activities (such as supply chain activities, logistics activities, demand management and planning activities, delivery activities, shipping activities, warehousing activities, distribution and fulfillment activities, inventory aggregation, storage and management activities, marketing activities, and many others, as involved in various value chain network processes, workflows, activities, events and applications 630 (collectively “applications 630” or simply “activities”)). Connections with the value chain entities 652 may be facilitated by a set of connectivity facilities 642 and interfaces 702, including a wide range of components and systems described throughout this disclosure and in greater detail below. This may include connectivity and interface capabilities for individual services of the platform, for the data handling layers, for the platform as a whole, and/or among value chain entities 652, among others.

These value chain entities 652 may include any of the wide variety of assets, systems, devices, machines, components, equipment, facilities, individuals or other entities mentioned throughout this disclosure or in the documents incorporated herein by reference, such as, without limitation: machines 724 and their components (e.g., delivery vehicles, forklifts, conveyors, loading machines, cranes, lifts, haulers, trucks, loading machines, unloading machines, packing machines, picking machines, and many others, including robotic systems, e.g., physical robots, collaborative robots (e.g., “cobots”), drones, autonomous vehicles, software bots and many others); products 650 (which may be any category of products, such as a finished goods, software products, hardware products, component products, material, items of equipment, items of consumer packaged goods, consumer products, food products, beverage products, home products, business supply products, consumable products, pharmaceutical products, medical device products, technology products, entertainment products, or any other type of products and/or set of related services); value chain processes 722 (such as shipping processes, hauling processes, maritime processes, inspection processes, hauling processes, loading/unloading processes, packing/unpacking processes, configuration processes, assembly processes, installation processes, quality control processes, environmental control processes (e.g., temperature control, humidity control, pressure control, vibration control, and others), border control processes, port-related processes, software processes (including applications, programs, services, and others), packing and loading processes, financial processes (e.g., insurance processes, reporting processes, transactional processes, and many others), testing and diagnostic processes, security processes, safety processes, reporting processes, asset tracking processes, and many others); wearable and portable devices 720 (such as mobile phones, tablets, dedicated portable devices for value chain applications and processes, data collectors (including mobile data collectors), sensor-based devices, watches, glasses, hearables, head-worn devices, clothing-integrated devices, arm bands, bracelets, neck-worn devices, AR/VR devices, headphones, and many others); workers 718 (such as delivery workers, shipping workers, barge workers, port workers, dock workers, train workers, ship workers, distribution of fulfillment center workers, warehouse workers, vehicle drivers, business managers, engineers, floor managers, demand managers, marketing managers, inventory managers, supply chain managers, cargo handling workers, inspectors, delivery personnel, environmental control managers, financial asset managers, process supervisors and workers (for any of the processes mentioned herein), security personnel, safety personnel and many others); suppliers 642 (such as suppliers of goods and related services of all types, component suppliers, ingredient suppliers, materials suppliers, manufacturers, and many others); customers 662 (including consumers, licensees, businesses, enterprises, value added and other resellers, retailers, end users, distributors, and others who may purchase, license, or otherwise use a category of goods and/or related services); a wide range of operating facilities 712 (such as loading and unloading docks, storage and warehousing facilities 654, vaults, distribution facilities 658 and fulfillment centers 628, air travel facilities 740 (including aircraft, airports, hangars, runways, refueling depots, and the like), maritime facilities 622 (such as port infrastructure facilities 622 (such as docks, yards, cranes, roll-on/roll-off facilities, ramps, containers, container handling systems, waterways 732, locks, and many others), shipyard facilities 638, floating assets 620 (such as ships, barges, boats and others), facilities and other items at points of origin 610 and/or points of destination 628, hauling facilities 710 (such as container ships, barges, and other floating assets 620, as well as land-based vehicles and other delivery systems 632 used for conveying goods, such as trucks, trains, and the like); items or elements factoring in demand (i.e., demand factors 644) (including market factors, events, and many others); items or elements factoring in supply (i.e., supply factors 648) (including market factors, weather, availability of components and materials, and many others); logistics factors 750 (such as availability of travel routes, weather, fuel prices, regulatory factors, availability of space (such as on a vehicle, in a container, in a package, in a warehouse, in a fulfillment center, on a shelf, or the like), and many others); retailers 664 (including online retailers 730 and others such as in the form of eCommerce sites 730); pathways for conveyance (such as waterways 732, roadways 734, air travel routes, railways 738 and the like); robotic systems 744 (including mobile robots, cobots, robotic systems for assisting human workers, robotic delivery systems, and others); drones 748 (including for package delivery, site mapping, monitoring or inspection, and the like); autonomous vehicles 742 (such as for package delivery); software platforms 752 (such as enterprise resource planning platforms, customer relationship management platforms, sales and marketing platforms, asset management platforms, Internet of Things platforms, supply chain management platforms, platform as a service platforms, infrastructure as a service platforms, software-based data storage platforms, analytic platforms, artificial intelligence platforms, and others); and many others. In some example embodiments, the product 1510 may be encompassed as an intelligent product 1510 or the VCNP 604 may include the intelligent product 1510. The intelligent product 1510 may be enabled with a set of capabilities such as, without limitation data processing, networking, sensing, autonomous operation, intelligent agent, natural language processing, speech recognition, voice recognition, touch interfaces, remote control, self-organization, self-healing, process automation, computation, artificial intelligence, analog or digital sensors, cameras, sound processing systems, data storage, data integration, and/or various Internet of Things capabilities, among others. The intelligent product 1510 may include a form of information technology. The intelligent product 1510 may have a processor, computer random access memory, and a communication module. The intelligent product 1510 may be a passive intelligent product that is similar to a RFID type of data structure where the intelligent product may be pinged or read. The product 1510 may be considered a value chain network entity (e.g., under control of platform) and may be rendered intelligent by surrounding infrastructure and adding an RFID such that data may be read from the intelligent product 1510. The intelligent product 1510 may fit in a value chain network in a connected way such that connectivity was built around the intelligent product 1510 through a sensor, an IoT device, a tag, or another component.

In embodiments, the monitoring systems layer 614 may monitor any or all of the value chain entities 652 in a value chain network 668, may exchange data with the value chain entities 652, may provide control instructions to or take instructions from any of the value chain entities 652, or the like, such as through the various capabilities of the data handling layers 608 described throughout this disclosure.

### Network Characteristics of the Value Chain Network Entities

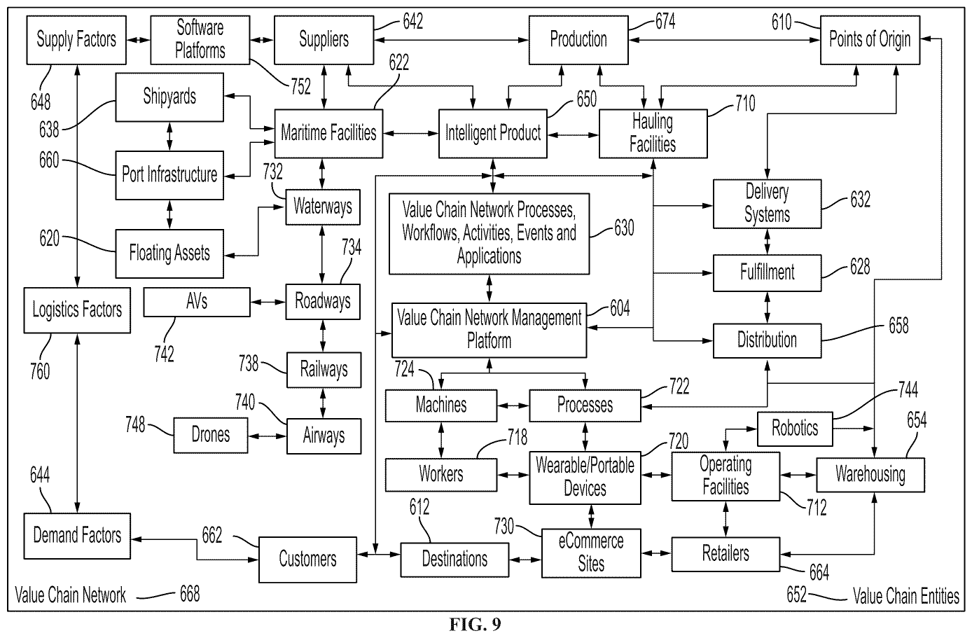

Referring to FIG. 9, orchestration of a set of deeply interconnected value chain network entities 652 in a value chain network 668 by the value chain network management platform 604 is illustrated. Each of the value chain network entities 652 may have a connection to the VCNP 604, to a set of other value chain network entities 652 (which may be a local network connection, a peer-to-peer connection, a mobile network connection, a connection via a cloud, or other connection), and/or through the VCNP 604 to other value chain network entities 652. The value chain network management platform 604 may manage the connections, configure or provision resources to enable connectivity, and/or manage applications 630 that take advantage of the connections, such as by using information from one set of entities 652 to inform applications 630 involving another set of entities 652, by coordinating activities of a set of entities 652, by providing input to an artificial intelligence system of the VCNP 604 or of or about a set of entities 652, by interacting with edge computation systems deployed on or in entities 652 and their environments, and the like.

The entities 652 may be external such that the VCNP 604 may interact with these entities 652. When the VCNP 604 functions as the control tower to establish monitoring (e.g., establish monitoring such as common monitoring across several entities 652). In one unified platform, there may be an interface where a user may view various items such as user's destinations, ports, air and rail assets, as well as orders, etc. Then, the next step may be to establish a common data schema that enables services that work on or in any one of these applications. This may involve taking any of the data that is flowing through or about any of these entities 652 and pull the data into a framework where other applications across supply and demand may interact with the entities 652. This may be a shared data pipeline coming from an IoT system and other external data sources, feeding into the monitoring layer, being stored in a common data schema in the storage layer, and then various intelligence may be trained to identify implications across these entities 652. In an example embodiment, a supplier may be bankrupt, or a determination is made that the supplier is bankrupt, and then the VCNP 604 may automatically trigger a substitute smart contract to be sent to a secondary supplier with altered terms. There may be management of different aspects of the supply chain. For example, changing pricing instantly and automatically on the demand side in response to one more supplier's being identified as bankrupt (e.g., from bankruptcy announcement). Other similar examples may be used based on what occurs in that automation layer which may be enabled by the VCNP 604. Then, at the interface layer of this VCNP 604, a digital twin may be used by user to view all these entities 652 that are not typically shown together and monitor what is going on with each of these entities 652 including identification of problem states. For example, after viewing three quarters of bad financial reports on a supplier, a report may be flagged to watch it closely for potential future bankruptcy, etc.

For example, an IoT system deployed in a fulfillment center 628 may coordinate with an intelligent product 1510 that takes customer feedback about the product 1510, and an application 630 for the fulfillment center 628 may, upon receiving customer feedback via a connection path to the intelligent product 1510 about a problem with the product 1510, initiate a workflow to perform corrective actions on similar products 650 before the products 650 are sent out from the fulfillment center 628. Similarly, a port infrastructure facility 660, such as a yard for holding shipping containers, may inform a fleet of floating assets 620 via connections to the floating assets 620 (such as ships, barges, or the like) that the port is near capacity, thereby kicking off a negotiation process (which may include an automated negotiation based on a set of rules and governed by a smart contract) for the remaining capacity and enabling some assets 620 to be redirected to alternative ports or holding facilities. These and many other connections among value chain network entities 652, whether one-to-one connections, one-to-many connections, many-to-many connections, or connections among defined groups of entities 652 (such as ones controlled by the same owner or operator), are encompassed herein as applications 630 managed by the VCNP 604.

### Value Chain Network Activities and Applications Managed by the Platform

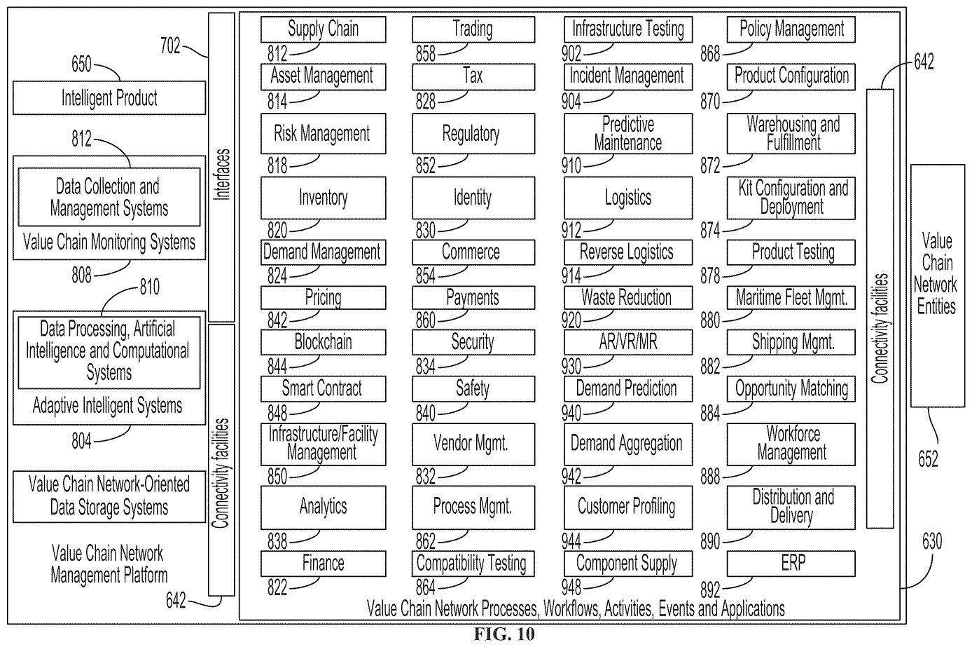

Referring to FIG. 10, the set of applications 614 provided on the VCNP 604, integrated with the VCNP 604 and/or managed by or for the VCNP 604 and/or involving a set of value chain network entities 652 may include, without limitation, one or more of any of a wide range of types of applications, such as: a supply chain management applications 21004 (such as, without limitation, for management of timing, quantities, logistics, shipping, delivery, and other details of orders for goods, components, and other items); an asset management application 814 (such as, without limitation, for managing value chain assets, such as floating assets (such as ships, boats, barges, and floating platforms), real property (such as used for location of warehouses, ports, shipyards, distribution centers and other buildings), equipment, machines and fixtures (such as used for handling containers, cargo, packages, goods, and other items), vehicles (such as forklifts, delivery trucks, autonomous vehicles, and other systems used to move items), human resources (such as workers), software, information technology resources, data processing resources, data storage resources, power generation and/or storage resources, computational resources and other assets); a finance application 822 (such as, without limitation, for handling finance matters relating to value chain entities and assets, such as involving payments, security, collateral, bonds, customs, duties, imposts, taxes and others); a 6 (such as, without limitation, for managing risk or liability with respect to a shipment, goods, a product, an asset, a person, a floating asset, a vehicle, an item of equipment, a component, an information technology system, a security system, a security event, a cybersecurity system, an item of property, a health condition, mortality, fire, flood, weather, disability, negligence, business interruption, injury, damage to property, damage to a business, breach of a contract, and others); a demand management application 824 (such as, without limitation, an application for analyzing, planning, or promoting interest by customers of a category of goods that can be supplied by or with facilities of a value chain product or service, such as a demand planning application, a demand prediction application, a sales application, a future demand aggregation application, a marketing application, an advertising application, an e-commerce application, a marketing analytics application, a customer relationship management application, a search engine optimization application, a sales management application, an advertising network application, a behavioral tracking application, a marketing analytics application, a location-based product or service-targeting application, a collaborative filtering application, a recommendation engine for a product or service, and others, including ones that use or are enabled by one or more features of an intelligent product 1510 or that are executed using intelligence capabilities on an intelligent product 1510); a trading application 858 (such as, without limitation, a buying application, a selling application, a bidding application, an auction application, a reverse auction application, a bid/ask matching application, an analytic application for analyzing value chain performance, yield, return on investment, or other metrics, or others); a tax application 850 (such as, without limitation, for managing, calculating, reporting, optimizing, or otherwise handling data, events, workflows, or other factors relating to a tax, a tariff, an impost, a levy, a tariff, a duty, a credit, a fee or other government-imposed charge, such as, without limitation, customs duties, value added tax, sales tax, income tax, property tax, municipal fees, pollution tax, renewal energy credit, pollution abatement credit, import duties, export duties, and others); an identity management application 830 (such as for managing one or more identities of entities 652 involved in a value chain, such as, without limitation, one or more of an identity verification application, a biometric identify validation application, a pattern-based identity verification application, a location-based identity verification application, a user behavior-based application, a fraud detection application, a network address-based fraud detection application, a black list application, a white list application, a content inspection-based fraud detection application, or other fraud detection application; an inventory management application 820 (such as, without limitation, for managing inventory in a fulfillment center, distribution center, warehouse, storage facility, store, port, ship or other floating asset, or other location); a security application, solution or service 834 (referred to herein as a security application, such as, without limitation, any of the identity management applications 830 noted above, as well as a physical security system (such as for an access control system (such as using biometric access controls, fingerprinting, retinal scanning, passwords, and other access controls), a safe, a vault, a cage, a safe room, a secure storage facility, or the like), a monitoring system (such as using cameras, motion sensors, infrared sensors and other sensors), a perimeter security system, a floating security system for a floating asset, a cyber security system (such as for virus detection and remediation, intrusion detection and remediation, spam detection and remediation, phishing detection and remediation, social engineering detection and remediation, cyber-attack detection and remediation, packet inspection, traffic inspection, DNS attack remediation and detection, and others) or other security application); a safety application 840 (such as, without limitation, for improving safety of workers, for reducing the likelihood of damage to property, for reducing accident risk, for reducing the likelihood of damage to goods (such as cargo), for risk management with respected to insured items, collateral for loans, or the like, including any application for detecting, characterizing or predicting the likelihood and/or scope of an accident or other damaging event, including safety management based on any of the data sources, events or entities noted throughout this disclosure or the documents incorporated herein by reference); a blockchain application 844 (such as, without limitation, a distributed ledger capturing a series of transactions, such as debits or credits, purchases or sales, exchanges of in kind consideration, smart contract events, or the like, or other blockchain-based application); a facility management application 850 (such as, without limitation, for managing infrastructure, buildings, systems, real property, personal property, and other property involved in supporting a value chain, such as a shipyard, a port, a distribution center, a warehouse, a dock, a store, a fulfillment center, a storage facility, or others, as well as for design, management or control of systems and facilities in or around a property, such as an information technology system, a robotic/autonomous vehicle system, a packaging system, a packing system, a picking system, an inventory tracking system, an inspection system, a routing system for mobile robots, a workflow system for human assets, or the like); a regulatory application 852 (such as, without limitation, an application for regulating any of the applications, services, transactions, activities, workflows, events, entities, or other items noted herein and in the documents incorporated by reference herein, such as regulation of permitted routes, permitted cargo and goods, permitted parties to transactions, required disclosures, privacy, pricing, marketing, offering of goods and services, use of data (including data privacy regulations, regulations relating to storage of data and others), banking, marketing, sales, financial planning, and many others); a commerce application, solution or service 854 (such as, without limitation an e-commerce site marketplace, an online site, an auction site or marketplace, a physical goods marketplace, an advertising marketplace, a reverse-auction marketplace, an advertising network, or other marketplace); a vendor management application 832 (such as, without limitation, an application for managing a set of vendors or prospective vendors and/or for managing procurement of a set of goods, components or materials that may be supplied in a value chain, such as involving features such as vendor qualification, vendor rating, requests for proposal, requests for information, bonds or other assurances of performance, contract management, and others); an analytics application 838 (such as, without limitation, an analytic application with respect to any of the data types, applications, events, workflows, or entities mentioned throughout this disclosure or the documents incorporated by reference herein, such as a big data application, a user behavior application, a prediction application, a classification application, a dashboard, a pattern recognition application, an econometric application, a financial yield application, a return on investment application, a scenario planning application, a decision support application, a demand prediction application, a demand planning application, a route planning application, a weather prediction application, and many others); a pricing application 842 (such as, without limitation, for pricing of goods, services (including any mentioned throughout this disclosure and the documents incorporated by reference herein; and a smart contract application, solution, or service (referred to collectively herein as a smart contract application 848, such as, without limitation, any of the smart contract types referred to in this disclosure or in the documents incorporated herein by reference, such as a smart contract for sale of goods, a smart contract for an order for goods, a smart contract for a shipping resource, a smart contract for a worker, a smart contract for delivery of goods, a smart contract for installation of goods, a smart contract using a token or cryptocurrency for consideration, a smart contract that vests a right, an option, a future, or an interest based on a future condition, a smart contract for a security, commodity, future, option, derivative, or the like, a smart contract for current or future resources, a smart contract that is configured to account for or accommodate a tax, regulatory or compliance parameter, a smart contract that is configured to execute an arbitrage transaction, or many others). Thus, the value chain management platform 604 may host an enable interaction among a wide range of disparate applications 630 (such term including the above-referenced and other value chain applications, services, solutions, and the like), such that by virtue of shared microservices, shared data infrastructure, and shared intelligence, any pair or larger combination or permutation of such services may be improved relative to an isolated application of the same type.

Referring still to FIG. 10, the set of applications 614 provided on the VCNP 604, integrated with the VCNP 604 and/or managed by or for the VCNP 604 and/or involving a set of value chain network entities 652 may further include, without limitation: a payments application 860 (such as for calculating payments (including based on situational factors such as applicable taxes, duties and the like for the geography of an entity 652), transferring funds, resolving payments to parties, and the like, for any of the applications 630 noted herein); a process management application 862 (such as for managing any of the processes or workflows described throughout this disclosure, including supply processes, demand processes, logistics processes, delivery processes, fulfillment processes, distribution processes, ordering processes, navigation processes, and many others); a compatibility testing application 864, such as for assessing compatibility among value chain network entities 652 or activities involved in any of the processes, workflows, activities, or other applications 630 described herein (such as for determining compatibility of a container or package with a product 1510, the compatibility of a product 1510 with a set of customer requirements, the compatibility of a product 1510 with another product 1510 (such as where one is a refill, resupply, replacement part, or the like for the other), the compatibility of a infrastructure and equipment entities 652 (such as between a container ship or barge and a port or waterway, between a container and a storage facility, between a truck and a roadway, between a drone or robot and a package, between a drone, AV or robot and a delivery destination, and many others); an infrastructure testing application 802 (such as for testing the capabilities of infrastructure elements to support a product 1510 or an application 630 (such as, without limitation, storage capabilities, lifting capabilities, moving capabilities, storage capacity, network capabilities, environmental control capabilities, software capabilities, security capabilities, and many others)); and/or an incident management application 910 (such as for managing events, accidents, and other incidents that may occur in one or more environments involving value chain network entities 652, such as, without limitation, vehicle accidents, worker injuries, shutdown incidents, property damage incidents, product damage incidents, product liability incidents, regulatory non-compliance incidents, health and/or safety incidents, traffic congestion and/or delay incidents (including network traffic, data traffic, vehicle traffic, maritime traffic, human worker traffic, and others, as well as combinations among them), product failure incidents, system failure incidents, system performance incidents, fraud incidents, misuse incidents, unauthorized use incidents, and many others).

Referring still to FIG. 10, the set of applications 614 provided on the VCNP 604, integrated with the VCNP 604 and/or managed by or for the VCNP 604 and/or involving a set of value chain network entities 652 may further include, without limitation: a predictive maintenance application 910 (such as for anticipating, predicting, and undertaking actions to manage faults, failures, shutdowns, damage, required maintenance, required repairs, required service, required support, or the like for a set of value chain network entities 652, such as products 650, equipment, infrastructure, buildings, vehicles, and others); a logistics application 912 (such as for managing logistics for pickups, deliveries, transfer of goods onto hauling facilities, loading, unloading, packing, picking, shipping, driving, and other activities involving in the scheduling and management of the movement of products 650 and other items between points of origin and points of destination through various intermediate locations; a reverse logistic application 914 (such as for handling logistics for returned products 650, waste products, damaged goods, or other items that can be transferred on a return logistics path); a waste reduction application 920 (such as for reducing packaging waste, solid waste, waste of energy, liquid waste, pollution, contaminants, waste of computing resources, waste of human resources, or other waste involving a value chain network entity 652 or activity); an augmented reality, mixed reality and/or virtual reality application 930 (such as for visualizing one or more value chain network entities 652 or activities involved in one or more of the applications 630, such as, without limitation, movement of a product 1510, the interior of a facility, the status or condition of an item of goods, one or more environmental conditions, a weather condition, a packing configuration for a container or a set of containers, or many others); a demand prediction application 940 (such as for predicting demand for a product 1510, a category of products, a potential product, and/or a factor involved in demand, such as a market factor, a wealth factor, a demographic factor, a weather factor, an economic factor, or the like); a demand aggregation application 942 (such as for aggregating information, orders and/or commitments (optionally embodied in one or more contracts, which may be smart contracts) for one or more products 650, categories, or the like, including current demand for existing products and future demand for products that are not yet available); a customer profiling application 944 (such as for profiling one or more demographic, psychographic, behavioral, economic, geographic, or other attributes of a set of customers, including based on historical purchasing data, loyalty program data, behavioral tracking data (including data captured in interactions by a customer with a smart product 1510), online clickstream data, interactions with intelligent agents, and other data sources); and/or a component supply application 948 (such as for managing a supply chain of components for a set of products 650).

Referring still to FIG. 10, the set of applications 614 provided on the VCNP 604, integrated with the VCNP 604 and/or managed by or for the VCNP 604 and/or involving a set of value chain network entities 652 may further include, without limitation: a policy management application 868 (such as for deploying one or more policies, rules, or the like for governance of one or more value chain network entities 652 or applications 630, such as to govern execution of one or more workflows (which may involve configuring polices in the platform 604 on a per-workflow basis), to govern compliance with regulations (including maritime, food and drug, medical, environmental, health, safety, tax, financial reporting, commercial, and other regulations as described throughout this disclosure or as would be understood in the art), to govern provisioning of resources (such as connectivity, computing, human, energy, and other resources), to govern compliance with corporate policies, to govern compliance with contracts (including smart contracts, wherein the platform 604 may automatically deploy governance features to relevant entities 652 and applications 630, such as via connectivity facilities 642), to govern interactions with other entities (such as involving policies for sharing of information and access to resources), to govern data access (including privacy data, operational data, status data, and many other data types), to govern security access to infrastructure, products, equipment, locations, or the like, and many others; a product configuration application 870 (such as for allowing a product manager and/or automated product configuration process (optionally using robotic process automation) to determine a configuration for a product 1510, including configuration on-the-fly, such as during agile manufacturing, or involving configuration or customization in route (such as by 3D printing one or more features or elements), or involving configuration or customization remotely, such as by downloading firmware, configuring field programmable gate arrays, installing software, or the like; a warehousing and fulfillment application 872 (such as for managing a warehouse, distribution center, fulfillment center, or the like, such as involving selection of products, configuring storage locations for products, determining routes by which personnel, mobile robots, and the like move products around a facility, determining picking and packing schedules, routes and workflows, managing operations of robots, drones, conveyors, and other facilities, determining schedules for moving products out to loading docks or the like, and many other functions); a kit configuration and deployment application 874 (such as for enabling a user of the VCNP to configure a kit, box, or otherwise pre-integrated, pre-provisioned, and/or pre-configured system to allow a customer or worker to rapidly deploy a subset of capabilities of the VCNP 604 for a specific value chain network entity 652 and/or application 630); and/or a product testing application 878 for testing a product 1510 (including testing for performance, activation of capabilities and features, safety, compliance with policy or regulations, quality, quality of service, likelihood of failure, and many other factors).

Referring still to FIG. 10, the set of applications 614 provided on the VCNP 604, integrated with the VCNP 604 and/or managed by or for the VCNP 604 and/or involving a set of value chain network entities 652 may further include, without limitation a maritime fleet management application 880 (for managing a set of maritime assets, such as container ships, barges, boats, and the like, as well as related infrastructure facilities such as docks, cranes, ports, and others, such as to determine optimal routes for fleet assets based on weather, market, traffic, and other conditions, to ensure compliance with policies and regulations, to ensure safety, to improve environmental factors, to improve financial metrics, and many others); a shipping management application 882 (such as for managing a set of shipping assets, such as trucks, trains, airplanes, and the like, such as to optimize financial yield, to improve safety, to reduce energy consumption, to reduce delays, to mitigate environmental impact, and for many other purposes); an opportunity matching application 884 (such as for matching one or more demand factors with one or more supply factors, for matching needs and capabilities of value chain network entities 652, for identifying reverse logistics opportunities, for identifying opportunities for inputs to enrich analytics, artificial intelligence and/or automation, for identifying cost-saving opportunities, for identifying profit and/or arbitrage opportunities, and many others); a workforce management application 888 (such as for managing workers in various work forces, including work forces in, on or for fulfillment centers, ships, ports, warehouses, distribution centers, enterprise management locations, retail stores, online/ecommerce site management facilities, ports, ships, boats, barges, trains, depots, and other facilities mentioned throughout this disclosure); a distribution and delivery application 890 (such as for planning, scheduling, routing, and otherwise managing distribution and delivery of products 650 and other items); and/or an enterprise resource planning (ERP) application 892 (such as for planning utilization of enterprise resources, including workforce resources, financial resources, energy resources, physical assets, digital assets, and other resources).

### Core Capabilities and Interactions of the Data Handling Layers (Adaptive Intelligence, Monitoring, Data Storage and Applications)

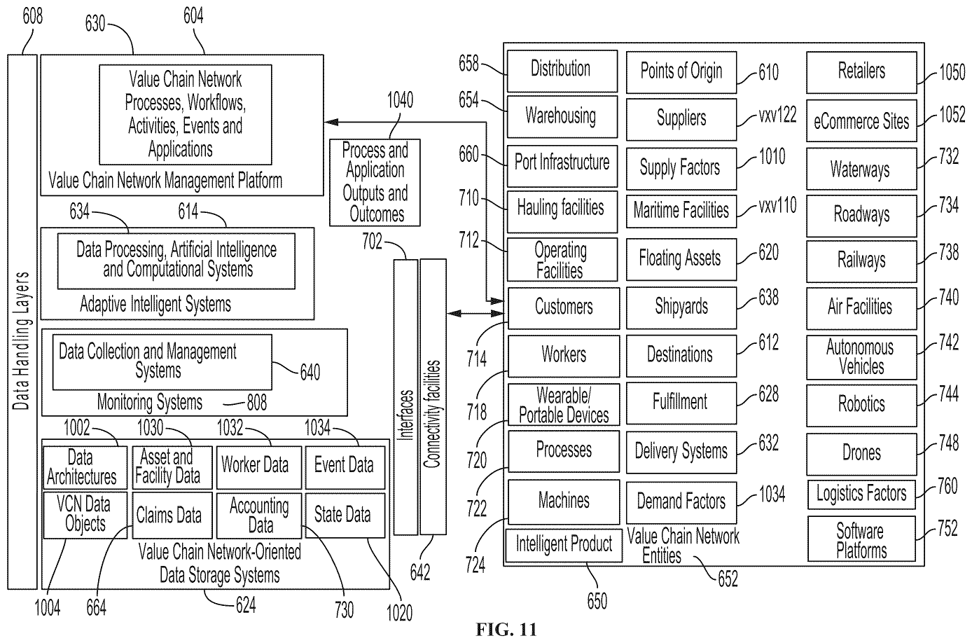

Referring to FIG. 11, a high-level schematic of an embodiment of the value chain network management platform 604 is illustrated, including a set of systems, applications, processes, modules, services, layers, devices, components, machines, products, sub-systems, interfaces, connections, and other elements working in coordination to enable intelligent management of sets of the value chain entities 652 that may occur, operate, transact or the like within, or own, operate, support or enable, one or more value chain network processes, workflows, activities, events and/or applications 630 or that may otherwise be part of, integrated with, linked to, or operated on by the platform 604 in connection with a product 1510 (which may be a finished good, software product, hardware product, component product, material, item of equipment, consumer packaged good, consumer product, food product, beverage product, home product, business supply product, consumable product, pharmaceutical product, medical device product, technology product, entertainment product, or any other type of product or related service, which may, in embodiments, encompass an intelligent product that is enabled with processing, networking, sensing, computation, and/or other Internet of Things capabilities). Value chain entities 652, such as involved in or for a wide range of value chain activities (such as supply chain activities, logistics activities, demand management and planning activities, delivery activities, shipping activities, warehousing activities, distribution and fulfillment activities, inventory aggregation, storage and management activities, marketing activities, and many others, as involved in various value chain network processes, workflows, activities, events and applications 630 may include any of the wide variety of assets, systems, devices, machines, components, equipment, facilities, individuals or other entities mentioned throughout this disclosure or in the documents incorporated herein by reference.

In embodiments, the value chain network management platform 604 may include the set of data handling layers 608, each of which is configured to provide a set of capabilities that facilitate development and deployment of intelligence, such as for facilitating automation, machine learning, applications of artificial intelligence, intelligent transactions, intelligent operations, remote control, analytics, monitoring, reporting, state management, event management, process management, and many others, for a wide variety of value chain network applications and end uses. In embodiments, the data handling layers 608 may include a value chain network monitoring systems layer 614, a value chain network entity-oriented data storage systems layer 624 (referred to in some cases herein for convenience simply as a data storage layer 624), an adaptive intelligent systems layer 614 and a value chain network management platform 604. The value chain network management platform 604 may include the data handling layers 608 such that the value chain network management platform 604 may provide management of the value chain network management platform 604 and/or management of the other layers such as the value chain network monitoring systems layer 614, the value chain network entity-oriented data storage systems layer 624 (e.g., data storage layer 624), and the adaptive intelligent systems layer 614. Each of the data handling layers 608 may include a variety of services, programs, applications, workflows, systems, components and modules, as further described herein and in the documents incorporated herein by reference. In embodiments, each of the data handling layers 608 (and optionally the platform 604 as a whole) is configured such that one or more of its elements can be accessed as a service by other layers 624 or by other systems (e.g., being configured as a platform-as-a-service deployed on a set of cloud infrastructure components in a microservices architecture). For example, the platform 604 may have (or may configure and/or provision), and a data handling layer 608 may use, a set of connectivity facilities 642, such as network connections (including various configurations, types and protocols), interfaces, ports, application programming interfaces (APIs), brokers, services, connectors, wired or wireless communication links, human-accessible interfaces, software interfaces, micro-services, SaaS interfaces, PaaS interfaces, IaaS interfaces, cloud capabilities, or the like by which data or information may be exchanged between a data handling layer 608 and other layers, systems or sub-systems of the platform 604, as well as with other systems, such as value chain entities 652 or external systems, such as cloud-based or on-premises enterprise systems (e.g., accounting systems, resource management systems, CRM systems, supply chain management systems and many others). Each of the data handling layers 608 may include a set of services (e.g., microservices), for data handling, including facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations) and others.

In embodiments, each data handling layer 608 has a set of application programming connectivity facilities 642 for automating data exchange with each of the other data handling layers 608. These may include data integration capabilities, such as for extracting, transforming, loading, normalizing, compression, decompressing, encoding, decoding, and otherwise processing data packets, signals, and other information as it exchanged among the layers and/or the applications 630, such as transforming data from one format or protocol to another as needed in order for one layer to consume output from another. In embodiments, the data handling layers 608 are configured in a topology that facilitates shared data collection and distribution across multiple applications and uses within the platform 604 by the value chain monitoring systems layer 614. The value chain monitoring systems layer 614 may include, integrate with, and/or cooperate with various data collection and management systems 640, referred to for convenience in some cases as data collection systems 640, for collecting and organizing data collected from or about value chain entities 652, as well as data collected from or about the various data layers 624 or services or components thereof. For example, a stream of physiological data from a wearable device worn by a worker undertaking a task or a consumer engaged in an activity can be distributed via the monitoring systems layer 614 to multiple distinct applications in the value chain management platform 604, such as one that facilitates monitoring the physiological, psychological, performance level, attention, or other state of a worker and another that facilitates operational efficiency and/or effectiveness. In embodiments, the monitoring systems layer 614 facilitates alignment, such as time-synchronization, normalization, or the like of data that is collected with respect to one or more value chain network entities 652. For example, one or more video streams or other sensor data collected of or with respect to a worker 718 or other entity in a value chain network facility or environment, such as from a set of camera-enabled IoT devices, may be aligned with a common clock, so that the relative timing of a set of videos or other data can be understood by systems that may process the videos, such as machine learning systems that operate on images in the videos, on changes between images in different frames of the video, or the like. In such an example, the monitoring systems layer 614 may further align a set of videos, camera images, sensor data, or the like, with other data, such as a stream of data from wearable devices, a stream of data produced by value chain network systems (such as ships, lifts, vehicles, containers, cargo handling systems, packing systems, delivery systems, drones/robots, and the like), a stream of data collected by mobile data collectors, and the like. Configuration of the monitoring systems layer 614 as a common platform, or set of microservices, that are accessed across many applications, may dramatically reduce the number of interconnections required by an owner or other operator within a value chain network in order to have a growing set of applications monitoring a growing set of IoT devices and other systems and devices that are under its control.

In embodiments, the data handling layers 608 are configured in a topology that facilitates shared or common data storage across multiple applications and uses of the platform 604 by the value chain network-oriented data storage systems layer 624, referred to herein for convenience in some cases simply as the data storage layer 624 or storage layer 624. For example, various data collected about the value chain entities 652, as well as data produced by the other data handling layers 608, may be stored in the data storage layer 624, such that any of the services, applications, programs, or the like of the various data handling layers 608 can access a common data source (which may comprise a single logical data source that is distributed across disparate physical and/or virtual storage locations). This may facilitate a dramatic reduction in the amount of data storage required to handle the enormous amount of data produced by or about value chain network entities 652 as applications 630 and uses of value chain networks grow and proliferate. For example, a supply chain or inventory management application in the value chain management platform 604, such as one for ordering replacement parts for a machine or item of equipment, may access the same data set about what parts have been replaced for a set of machines as a predictive maintenance application that is used to predict whether a component of a ship, or facility of a port is likely to require replacement parts. Similarly, prediction may be used with respect to the resupply of items.

In embodiments, value chain network data objects 1004 may be provided according to an object-oriented data model that defines classes, objects, attributes, parameters and other features of the set of data objects (such as associated with value chain network entities 652 and applications 630) that are handled by the platform 604.

In embodiments, the data storage systems layer 624 may provide an extremely rich environment for collection of data that can be used for extraction of features or inputs for intelligence systems, such as expert systems, analytic systems, artificial intelligence systems, robotic process automation systems, machine learning systems, deep learning systems, supervised learning systems, or other intelligent systems as disclosed throughout this disclosure and the documents incorporated herein by reference. As a result, each application 630 in the platform 604 and each adaptive intelligent system in the adaptive intelligent systems layer 614 can benefit from the data collected or produced by or for each of the others. In embodiments, the data storage systems layer 624 may facilitate collection of data that can be used for extraction of features or inputs for intelligence systems such as a development framework from artificial intelligence. In examples, the collections of data may pull in and/or house event logs (naturally stored or ad-hoc, as needed), perform periodic checks on onboard diagnostic data, or the like. In examples, pre calculation of features may be deployed using AWS Lambda, for example, or various other cloud-based on-demand compute capabilities, such as pre-calculations, multiplexing signals. In many examples, there are pairings (doubles, triples, quadruplets, etc.) of similar kinds of value chain entities that may use one or more sets of capabilities of the data handling layers 608 to deploy connectivity and services across value chain entities and across applications used by the entities even when amassing hundreds and hundreds of data types from relatively disparate entities. In these examples, various pairings of similar types of value chain entities using, at least in part, the connectivity and services across value chain entities and applications, may direct the information from the pairings of connected data to artificial intelligence services including the various neural networks disclosed herein and hybrid combinations thereof. In these examples, genetic programming techniques may be deployed to prune some of the input features in the information from the pairings of connected data. In these examples, genetic programming techniques may also be deployed to add to and augment the input features in the information from the pairings. These genetic programming techniques may be shown to increase the efficacy of the determinations established by the artificial intelligence services. In these examples, the information from the pairings of connected data may be migrated to other layers on the platform including to support or deploy robotic process automation, prediction, forecasting, and other resources such that the shared data schema may facilitate as capabilities and resources for the platform 604.

A wide range of data types may be stored in the storage layer 624 using various storage media and data storage types, data architectures 1002, and formats, including, without limitation: asset and facility data 1030, state data 1140 (such as indicating a state, condition status, or other indicator with respect to any of the value chain network entities 652, any of the applications 630 or components or workflows thereof, or any of the components or elements of the platform 604, among others), worker data 1032 (including identity data, role data, task data, workflow data, health data, attention data, mood data, stress data, physiological data, performance data, quality data and many other types); event data 1034 ((such as with respect to any of a wide range of events, including operational data, transactional data, workflow data, maintenance data, and many other types of data that includes or relates to events that occur within a value chain network 668 or with respect to one or more applications 630, including process events, financial events, transaction events, output events, input events, state-change events, operating events, workflow events, repair events, maintenance events, service events, damage events, injury events, replacement events, refueling events, recharging events, shipping events, warehousing events, transfers of goods, crossing of borders, moving of cargo, inspection events, supply events, and many others); claims data 664 (such as relating to insurance claims, such as for business interruption insurance, product liability insurance, insurance on goods, facilities, or equipment, flood insurance, insurance for contract-related risks, and many others, as well as claims data relating to product liability, general liability, workers compensation, injury and other liability claims and claims data relating to contracts, such as supply contract performance claims, product delivery requirements, warranty claims, indemnification claims, delivery requirements, timing requirements, milestones, key performance indicators and others); accounting data 730 (such as data relating to completion of contract requirements, satisfaction of bonds, payment of duties and tariffs, and others); and risk management data 732 (such as relating to items supplied, amounts, pricing, delivery, sources, routes, customs information and many others), among many other data types associated with value chain network entities 652 and applications 630.

In embodiments, the data handling layers 608 are configured in a topology that facilitates shared adaptation capabilities, which may be provided, managed, mediated and the like by one or more of a set of services, components, programs, systems, or capabilities of the adaptive intelligent systems layer 614, referred to in some cases herein for convenience as the adaptive intelligence layer 614. The adaptive intelligence systems layer 614 may include a set of data processing, artificial intelligence and computational systems 634 that are described in more detail elsewhere throughout this disclosure. Thus, use of various resources, such as computing resources (such as available processing cores, available servers, available edge computing resources, available on-device resources (for single devices or peered networks), and available cloud infrastructure, among others), data storage resources (including local storage on devices, storage resources in or on value chain entities or environments (including on-device storage, storage on asset tags, local area network storage and the like), network storage resources, cloud-based storage resources, database resources and others), networking resources (including cellular network spectrum, wireless network resources, fixed network resources and others), energy resources (such as available battery power, available renewable energy, fuel, grid-based power, and many others) and others may be optimized in a coordinated or shared way on behalf of an operator, enterprise, or the like, such as for the benefit of multiple applications, programs, workflows, or the like. For example, the adaptive intelligence layer 614 may manage and provision available network resources for both a supply chain management application and for a demand planning application (among many other possibilities), such that low latency resources are used for supply chain management application (where rapid decisions may be important) and longer latency resources are used for the demand planning application. As described in more detail throughout this disclosure and the documents incorporated herein by reference, a wide variety of adaptations may be provided on behalf of the various services and capabilities across the various layers 624, including ones based on application requirements, quality of service, on-time delivery, service objectives, budgets, costs, pricing, risk factors, operational objectives, efficiency objectives, optimization parameters, returns on investment, profitability, uptime/downtime, worker utilization, and many others.

The value chain management platform 604, referred to in some cases herein for convenience as the platform 604, may include, integrate with, and enable the various value chain network processes, workflows, activities, events and applications 630 described throughout this disclosure that enable an operator to manage more than one aspect of a value chain network environment or entity 652 in a common application environment (e.g., shared, pooled, similarly licenses whether shared data for one person, multiple people, or anonymized), such as one that takes advantage of common data storage in the data storage layer 624, common data collection or monitoring in the monitoring systems layer 614 and/or common adaptive intelligence of the adaptive intelligence layer 614. Outputs from the applications 630 in the platform 604 may be provided to the other data handing layers 624. These may include, without limitation, state and status information for various objects, entities, processes, flows and the like; object information, such as identity, attribute and parameter information for various classes of objects of various data types; event and change information, such as for workflows, dynamic systems, processes, procedures, protocols, algorithms, and other flows, including timing information; outcome information, such as indications of success and failure, indications of process or milestone completion, indications of correct or incorrect predictions, indications of correct or incorrect labeling or classification, and success metrics (including relating to yield, engagement, return on investment, profitability, efficiency, timeliness, quality of service, quality of product, customer satisfaction, and others) among others. Outputs from each application 630 can be stored in the data storage layer 624, distributed for processing by the data collection layer 614, and used by the adaptive intelligence layer 614. The cross-application nature of the platform 604 thus facilitates convenient organization of all of the necessary infrastructure elements for adding intelligence to any given application, such as by supplying machine learning on outcomes across applications, providing enrichment of automation of a given application via machine learning based on outcomes from other applications or other elements of the platform 604, and allowing application developers to focus on application-native processes while benefiting from other capabilities of the platform 604. In examples, there may be systems, components, services and other capabilities that optimize control, automation, or one or more performance characteristics of one or more value chain network entities 652; or ones that may generally improve any of process and application outputs and outcomes 1040 pursued by use of the platform 604. In some examples, outputs and outcomes 1040 from various applications 630 may be used to facilitate automated learning and improvement of classification, prediction, or the like that is involved in a step of a process that is intended to be automated.

### Some Data Storage Layer Details—Alternative Data Architectures

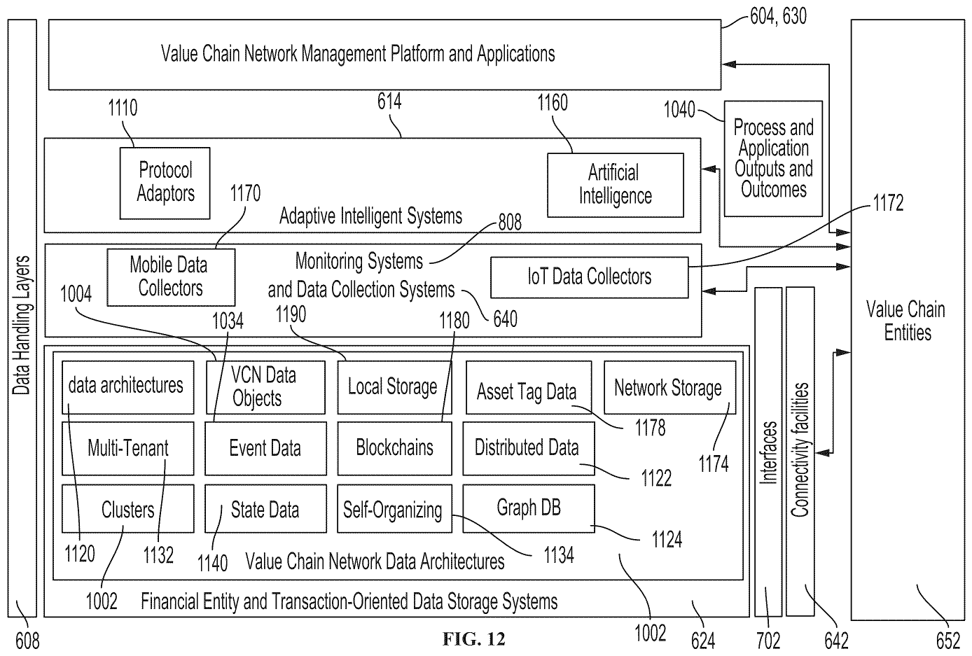

Referring to FIG. 12, additional details, components, sub-systems, and other elements of an optional embodiment of the data storage layer 624 of the platform 604 are illustrated. Various data architectures may be used, including conventional relational and object-oriented data architectures, blockchain architectures 1180, asset tag data storage architectures 1178, local storage architectures 1190, network storage architectures 1174, multi-tenant architectures 1132, distributed data architectures 1002, value chain network (VCN) data object architectures 1004, cluster-based architectures 1128, event data-based architectures 1034, state data-based architectures 1140, graph database architectures 1124, self-organizing architectures 1134, and other data architectures 1002.

The adaptive intelligent systems layer 614 of the platform 604 may include one or more protocol adaptors 1110 for facilitating data storage, retrieval access, query management, loading, extraction, normalization, and/or transformation to enable use of the various other data storage architectures 1002, such as allowing extraction from one form of database and loading to a data system that uses a different protocol or data structure.

In embodiments, the value chain network-oriented data storage systems layer 624 may include, without limitation, physical storage systems, virtual storage systems, local storage systems (e.g., part of the local storage architectures 1190), distributed storage systems, databases, memory, network-based storage, network-attached storage systems (e.g., part of the network storage architectures 1174 such as using NVME, storage attached networks, and other network storage systems), and many others.

In embodiments, the storage layer 624 may store data in one or more knowledge graphs (such as a directed acyclic graph, a data map, a data hierarchy, a data cluster including links and nodes, a self-organizing map, or the like) in the graph database architectures 1124. In example embodiments, the knowledge graph may be a prevalent example of when a graph database and graph database architecture may be used. In some examples, the knowledge graph may be used to graph a workflow. For a linear workflow, a directed acyclic graph may be used. For a contingent workflow, a cyclic graph may be used. The graph database (e.g., graph database architectures 1124) may include the knowledge graph or the knowledge graph may be an example of the graph database. In example embodiments, the knowledge graph may include ontology and connections (e.g., relationships) between the ontology of the knowledge graph. In an example, the knowledge graph may be used to capture an articulation of knowledge domains of a human expert such that there may be an identification of opportunities to design and build robotic process automation or other intelligence that may replicate this knowledge set. The platform may be used to recognize that a type of expert is using this factual knowledge base (from the knowledge graph) coupled with competencies that may be replicable by artificial intelligence that may be different depending on type of expertise involved. For example, artificial intelligence such as a convolutional neural network may be used with spatiotemporal aspects that may be used to diagnose issues or packing up a box in a warehouse. Whereas the platform may use a different type of knowledge graph for a self-organizing map of an expert whose main job is to segment customers into customer segmentation groups. In some examples, the knowledge graph may be built from various data such as job credentials, job listings, parsing output deliverables. In embodiments, the data storage layer 624 may store data in a digital thread, ledger, or the like, such as for maintaining a serial or other records of an entities 652 over time, including any of the entities described herein. In embodiments, the data storage layer 624 may use and enable an asset tag 1178, which may include a data structure that is associated with an asset and accessible and managed, such as by use of access controls, so that storage and retrieval of data is optionally linked to local processes, but also optionally open to remote retrieval and storage options. In embodiments, the storage layer 624 may include one or more blockchains 1180, such as ones that store identity data, transaction data, historical interaction data, and the like, such as with access control that may be role-based or may be based on credentials associated with a value chain entity 652, a service, or one or more applications 630. Data stored by the data storage systems 624 may include accounting and other financial data 730, access data 734, asset and facility data 1030 (such as for any of the value chain assets and facilities described herein), asset tag data 1178, worker data 1032, event data 1034, risk management data 732, pricing data 738, safety data 664 and many other types of data that may be associated with, produced by, or produced about any of the value chain entities and activities described herein and in the documents incorporated by reference.

### Adaptive Intelligent Systems and Monitoring Layers

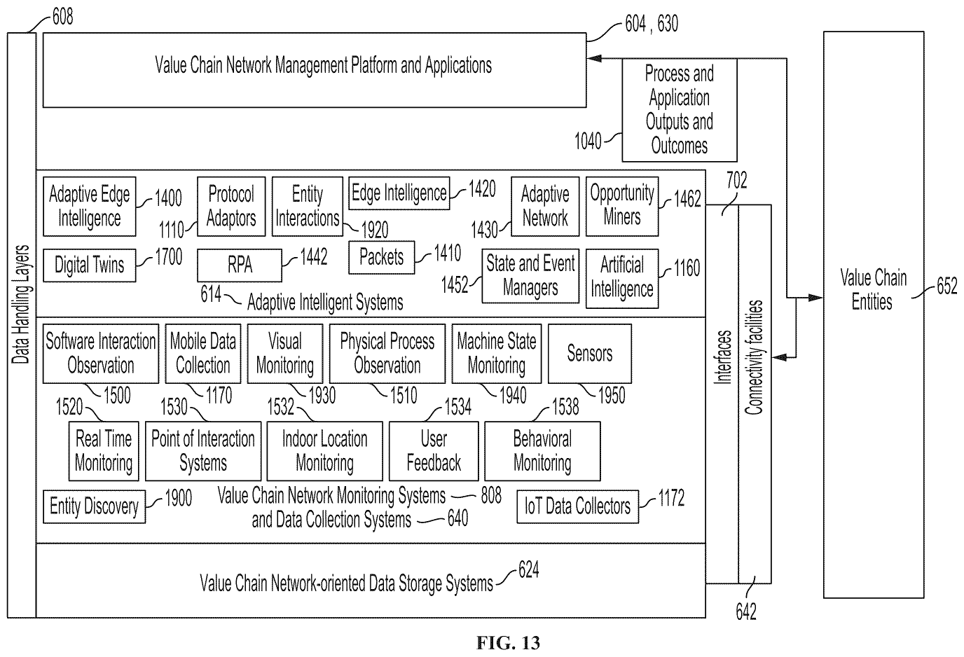

Referring to FIG. 13, additional details, components, sub-systems, and other elements of an optional embodiment of the platform 604 are illustrated. The management platform 604 may, in various optional embodiments, include the set of applications 614, by which an operator or owner of a value chain network entity, or other users, may manage, monitor, control, analyze, or otherwise interact with one or more elements of a value chain network entity 652, such as any of the elements noted in connection above and throughout this disclosure.

In embodiments, the adaptive intelligent systems layer 614 may include a set of systems, components, services and other capabilities that collectively facilitate the coordinated development and deployment of intelligent systems, such as ones that can enhance one or more of the applications 630 at the application platform 604; ones that can improve the performance of one or more of the components, or the overall performance (e.g., speed/latency, reliability, quality of service, cost reduction, or other factors) of the connectivity facilities 642; ones that can improve other capabilities within the adaptive intelligent systems layer 614; ones that improve the performance (e.g., speed/latency, energy utilization, storage capacity, storage efficiency, reliability, security, or the like) of one or more of the components, or the overall performance, of the value chain network-oriented data storage systems 624; ones that optimize control, automation, or one or more performance characteristics of one or more value chain network entities 652; or ones that generally improve any of the process and application outputs and outcomes 1040 pursued by use of the platform 604.

These adaptive intelligent systems 614 may include a robotic process automation system 1442, a set of protocol adaptors 1110, a packet acceleration system 1410, an edge intelligence system 1420 (which may be a self-adaptive system), an adaptive networking system 1430, a set of state and event managers 1450, a set of opportunity miners 1460, a set of artificial intelligence systems 1160, a set of digital twin systems 1700, a set of entity interaction systems 1920 (such as for setting up, provisioning, configuring and otherwise managing sets of interactions between and among sets of value chain network entities 652 in the value chain network 668), and other systems.

In embodiments, the value chain monitoring systems layer 614 and its data collection systems 640 may include a wide range of systems for the collection of data. This layer may include, without limitation, real time monitoring systems 1520 (such as onboard monitoring systems like event and status reporting systems on ships and other floating assets, on delivery vehicles, on trucks and other hauling assets, and in shipyards, ports, warehouses, distribution centers and other locations; on-board diagnostic (OBD) and telematics systems on floating assets, vehicles and equipment; systems providing diagnostic codes and events via an event bus, communication port, or other communication system; monitoring infrastructure (such as cameras, motion sensors, beacons, RFID systems, smart lighting systems, asset tracking systems, person tracking systems, and ambient sensing systems located in various environments where value chain activities and other events take place), as well as removable and replaceable monitoring systems, such as portable and mobile data collectors, RFID and other tag readers, smart phones, tablets and other mobile devices that are capable of data collection and the like); software interaction observation systems 1500 (such as for logging and tracking events involved in interactions of users with software user interfaces, such as mouse movements, touchpad interactions, mouse clicks, cursor movements, keyboard interactions, navigation actions, eye movements, finger movements, gestures, menu selections, and many others, as well as software interactions that occur as a result of other programs, such as over APIs, among many others); mobile data collectors 1170 (such as described extensively herein and in documents incorporated by reference), visual monitoring systems 1930 (such as using video and still imaging systems, LIDAR, IR and other systems that allow visualization of items, people, materials, components, machines, equipment, personnel, gestures, expressions, positions, locations, configurations, and other factors or parameters of entities 652, as well as inspection systems that monitor processes, activities of workers and the like); point of interaction systems 1530 (such as dashboards, user interfaces, and control systems for value chain entities); physical process observation systems 1510 (such as for tracking physical activities of operators, workers, customers, or the like, physical activities of individuals (such as shippers, delivery workers, packers, pickers, assembly personnel, customers, merchants, vendors, distributors and others), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems 1940 (including onboard monitors and external monitors of conditions, states, operating parameters, or other measures of the condition of any value chain entity, such as a machine or component thereof, such as a machine, such as a client, a server, a cloud resource, a control system, a display screen, a sensor, a camera, a vehicle, a robot, or other machine); sensors and cameras 1950 and other IoT data collection systems 1172 (including onboard sensors, sensors or other data collectors (including click tracking sensors) in or about a value chain environment (such as, without limitation, a point of origin, a loading or unloading dock, a vehicle or floating asset used to convey goods, a container, a port, a distribution center, a storage facility, a warehouse, a delivery vehicle, and a point of destination), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems 1532 (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems 1534 (including survey systems, touch pads, voice-based feedback systems, rating systems, expression monitoring systems, affect monitoring systems, gesture monitoring systems, and others); behavioral monitoring systems 1538 (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collectors 1172, such as those described throughout this disclosure and in the documents incorporated by reference herein.

In embodiments, the value chain monitoring systems layer 614 and its data collection systems 640 may include an entity discovery system 1900 for discovering one or more value chain network entities 652, such as any of the entities described throughout this disclosure. This may include components or sub-systems for searching for entities within the value chain network 668, such as by device identifier, by network location, by geolocation (such as by geofence), by indoor location (such as by proximity to known resources, such as IoT-enabled devices and infrastructure, Wifi routers, switches, or the like), by cellular location (such as by proximity to cellular towers), by identity management systems (such as where an entity 652 is associated with another entity 652, such as an owner, operator, user, or enterprise by an identifier that is assigned by and/or managed by the platform 604), and the like. Entity discovery 1900 may initiate a handshake among a set of devices, such as to initiate interactions that serve various applications 630 or other capabilities of the platform 604.

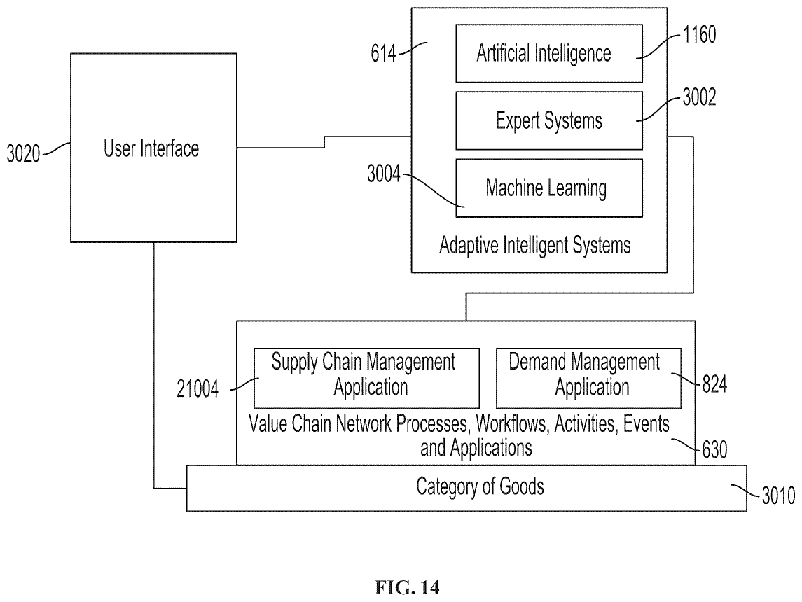

Referring to FIG. 14, a management platform of an information technology system, such as a management platform for a value chain of goods and/or services is depicted as a block diagram of functional elements and representative interconnections. The management platform includes a user interface 3020 that provides, among other things, a set of adaptive intelligence systems 614. The adaptive intelligence systems 614 provide coordinated intelligence (including artificial intelligence 1160, expert systems 3002, machine learning 3004, and the like) for a set of demand management applications 824 and for a set of supply chain applications 812 for a category of goods 3010, which may be produced and sold through the value chain. The adaptive intelligence systems 614 may deliver artificial intelligence 1160 through a set of data processing, artificial intelligence and computational systems 634. In embodiments, the adaptive intelligence systems 614 are selectable and/or configurable through the user interface 3020 so that one or more of the adaptive intelligence systems 614 can operate on or in cooperation with the sets of value chain applications (e.g., demand management applications 824 and supply chain applications 812). The adaptive intelligence systems 614 may include artificial intelligence, including any of the various expert systems, artificial intelligence systems, neural networks, supervised learning systems, machine learning systems, deep learning systems, and other systems described throughout this disclosure and in the documents incorporated by reference.

In embodiments, user interface may include interfaces for configuring an artificial intelligence system 1160 to take inputs from selected data sources of the value chain (such as data sources used by the set of demand management applications 824 and/or the set of supply chain applications 812) and supply them, such as to a neural network, artificial intelligence system 1160 or any of the other adaptive intelligence systems 614 described throughout this disclosure and in the documents incorporated herein by reference to enhance, control, improve, optimize, configure, adapt or have another impact on a value chain for the category of goods 3010. In embodiments, the selected data sources of the value chain may be applied either as inputs for classification or prediction, or as outcomes relating to the value chain, the category of goods 3010 and the like.

In embodiments, providing coordinated intelligence may include providing artificial intelligence capabilities, such as artificial intelligence systems 1160 and the like. Artificial intelligence systems may facilitate coordinated intelligence for the set of demand management applications 824 or the set of supply chain applications 812 or both, such as for a category of goods, such as by processing data that is available in any of the data sources of the value chain, such as value chain processes, bills of materials, manifests, delivery schedules, weather data, traffic data, goods design specifications, customer complaint logs, customer reviews, Enterprise Resource Planning (ERP) System, Customer Relationship Management (CRM) System, Customer Experience Management (CEM) System, Service Lifecycle Management (SLM) System, Product Lifecycle Management (PLM) System, and the like.

In embodiments, the user interface 3020 may provide access to, among other things artificial intelligence capabilities, applications, systems and the like for coordinating intelligence for applications of the value chain and particularly for value chain applications for the category of goods 3010. The user interface 3020 may be adapted to receive information descriptive of the category of goods 3010 and configure user access to the artificial intelligence capabilities responsive thereto, so that the user, through the user interface is guided to artificial intelligence capabilities that are suitable for use with value chain applications (e.g., the set of demand management applications 824 and supply chain applications 812) that contribute to goods/services in the category of goods 3010. The user interface 3020 may facilitate providing coordinated intelligence that comprises artificial intelligence capabilities that provide coordinated intelligence for a specific operator and/or enterprise that participates in the supply chain for the category of goods.

In embodiments, the user interface 3020 may be configured to facilitate the user selecting and/or configuring multiple artificial intelligence systems 1160 for use with the value chain. The user interface may present the set of demand management applications 824 and supply chain applications 812 as connected entities that receive, process, and produce outputs each of which may be shared among the applications. Types of artificial intelligence systems 1160 may be indicated in the user interface 3020 responsive to sets of connected applications or their data elements being indicated in the user interface, such as by the user placing a pointer proximal to a connected set of applications and the like. In embodiments, the user interface 3020 may facilitate access to the set of adaptive intelligence systems provides a set of capabilities that facilitate development and deployment of intelligence for at least one function selected from a list of functions consisting of supply chain application automation, demand management application automation, machine learning, artificial intelligence, intelligent transactions, intelligent operations, remote control, analytics, monitoring, reporting, state management, event management, and process management.

The adaptive intelligence systems 614 may be configured with data processing, artificial intelligence and computational systems 634 that may operate cooperatively to provide coordinated intelligence, such as when an artificial intelligence system 1160 operates on or responds to data collected by or produced by other systems of the adaptive intelligence systems 614, such as a data processing system and the like. In embodiments, providing coordinated intelligence may include operating a portion of a set of artificial intelligence systems 1160 that employs one or more types of neural network that is described herein and in the documents incorporated herein by reference and that processes any of the demand management application outputs and supply chain application outputs to provide the coordinated intelligence.

In embodiments, providing coordinated intelligence for the set of demand management applications 824 may include configuring at least one of the adaptive intelligence systems 614 (e.g., through the user interface 3020 and the like) for at least one or more demand management applications selected from a list of demand management applications including a demand planning application, a demand prediction application, a sales application, a future demand aggregation application, a marketing application, an advertising application, an e-commerce application, a marketing analytics application, a customer relationship management application, a search engine optimization application, a sales management application, an advertising network application, a behavioral tracking application, a marketing analytics application, a location-based product or service-targeting application, a collaborative filtering application, a recommendation engine for a product or service, and the like.

Similarly, providing coordinated intelligence for the set of supply chain applications 812 may include configuring at least one of the adaptive intelligence systems 614 for at least one or more supply chain applications selected from a list of supply chain applications including a goods timing management application, a goods quantity management application, a logistics management application, a shipping application, a delivery application, an order for goods management application, an order for components management application, and the like.

In embodiments, the management platform 102 may, such as through the user interface 3020 facilitate access to the set of adaptive intelligence systems 614 that provide coordinated intelligence for a set of demand management applications 824 and supply chain applications 812 through the application of artificial intelligence. In such embodiments, the user may seek to align supply with demand while ensuring profitability and the like of a value chain for a category of goods 3010. By providing access to artificial intelligence capabilities 1160, the management platform allows the user to focus on the applications of demand and supply while gaining advantages of techniques such as expert systems, artificial intelligence systems, neural networks, supervised learning systems, machine learning systems, deep learning systems, and the like.

In embodiments, the management platform 102 may, through the user interface 3020 and the like provide a set of adaptive intelligence systems 614 that provide coordinated artificial intelligence 1160 for the sets of demand management applications 824 and supply chain applications 812 for the category of goods 3020 by, for example, determining (automatically) relationships among demand management and supply chain applications based on inputs used by the applications, results produced by the applications, and value chain outcomes. The artificial intelligence 1160 may be coordinated by, for example, the set of data processing, artificial intelligence and computational systems 634 available through the adaptive intelligence systems 614.

In embodiments, the management platform 102 may be configured with a set of artificial intelligence systems 1160 as part of a set of adaptive intelligence systems 614 that provide the coordinated intelligence for the sets of demand management applications 824 and supply chain applications 812 for a category of goods 3010. The set of artificial intelligence systems 1160 may provide the coordinated intelligence so that at least one supply chain application of the set of supply chain applications 812 produces results that address at least one aspect of supply for at least one of the goods in the category of goods as determined by at least one demand management application of the set of demand management applications 824. In examples, a behavioral tracking demand management application may generate results for behavior of uses of a good in the category of goods 3010. The artificial intelligence systems 1160 may process the behavior data and conclude that there is a perceived need for greater consumer access to a second product in the category of goods 3010. This coordinated intelligence may be, optionally automatically, applied to the set of supply chain applications 812 so that, for example, production resources or other resources in the value chain for the category of goods are allocated to the second product. In examples, a distributor who handles stocking retailer shelves may receive a new stocking plan that allocates more retail shelf space for the second product, such as by taking away space from a lower margin product and the like.

In embodiments, the set of artificial intelligence systems 1160 and the like may provide coordinated intelligence for the sets of supply chain and demand management applications by, for example, determining an optionally temporal prioritization of demand management application outputs that impact control of supply chain applications so that an optionally temporal demand for at least one of the goods in the category of goods 3010 can be met. Seasonal adjustments in prioritization of demand application results are one example of a temporal change. Adjustments in prioritization may also be localized, such as when a large college football team is playing at their home stadium and local supply of tailgating supplies may temporally be adjusted even though demand management application results suggest that small propane stoves are not currently in demand in a wider region.

A set of adaptive intelligence systems 614 that provide coordinated intelligence, such as by providing artificial intelligence capabilities 1160 and the like may also facilitate development and deployment of intelligence for at least one function selected from a list of functions consisting of supply chain application automation, demand management application automation, machine learning, artificial intelligence, intelligent transactions, intelligent operations, remote control, analytics, monitoring, reporting, state management, event management, and process management. The set of adaptive intelligence systems 614 may be configured as a layer in the platform and an artificial intelligence system therein may operate on or be responsive to data collected by and/or produced by other systems (e.g., data processing systems, expert systems, machine learning systems and the like) of the adaptive intelligence systems layer.

In addition to providing coordinated intelligence configured for specific categories of goods, the coordinated intelligence may be provided for a specific value chain entity 652, such as a supply chain operator, business, enterprise, and the like that participates in the supply chain for the category of goods.

Providing coordinated intelligence may include employing a neural network to process at least one of the inputs and outputs of the sets of demand management and supply chain applications. Neural networks may be used with demand applications, such as a demand planning application, a demand prediction application, a sales application, a future demand aggregation application, a marketing application, an advertising application, an e-commerce application, a marketing analytics application, a customer relationship management application, a search engine optimization application, a sales management application, an advertising network application, a behavioral tracking application, a marketing analytics application, a location-based product or service-targeting application, a collaborative filtering application, a recommendation engine for a product or service, and the like. Neural networks may also be used with supply chain applications such as a goods timing management application, a goods quantity management application, a logistics management application, a shipping application, a delivery application, an order for goods management application, an order for components management application, and the like. Neural networks may provide coordinated intelligence by processing data that is available in any of a plurality of value chain data sources for the category of goods including without limitation processes, bill of materials, weather, traffic, design specification, customer complaint logs, customer reviews, Enterprise Resource Planning (ERP) System, Customer Relationship Management (CRM) System, Customer Experience Management (CEM) System, Service Lifecycle Management (SLM) System, Product Lifecycle Management (PLM) System, and the like. Neural networks configured for providing coordinated intelligence may share adaptation capabilities with other adaptive intelligence systems 614, such as when these systems are configured in a topology that facilitates such shared adaptation. In embodiments, neural networks may facilitate provisioning available value chain/supply chain network resources for both the set of demand management applications and for the set of supply chain applications. In embodiments, neural networks may provide coordinated intelligence to improve at least one of the list of outputs consisting of a process output, an application output, a process outcome, an application outcome, and the like.

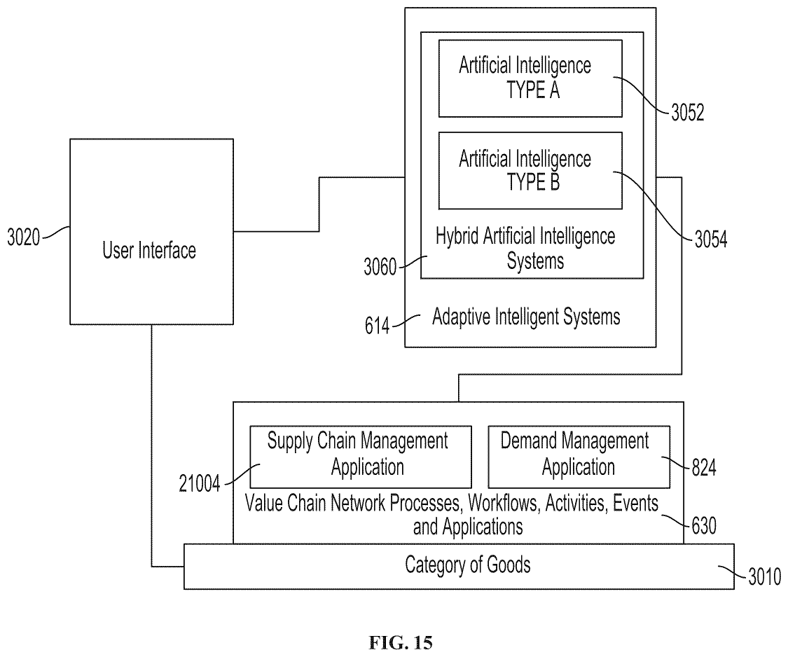

Referring to FIG. 15, a management platform of an information technology system, such as a management platform for a value chain of goods and/or services is depicted as a block diagram of functional elements and representative interconnections. The management platform includes a user interface 3020 that provides, among other things, a hybrid set of adaptive intelligence systems 614. The hybrid set of adaptive intelligence systems 614 provide coordinated intelligence through the application of artificial intelligence, such as through application of a hybrid artificial intelligence system 3060, and optionally through one or more expert systems, machine learning systems, and the like for use with a set of demand management applications 824 and for a set of supply chain applications 812 for a category of goods 3010, which may be produced and sold through the value chain. The hybrid adaptive intelligence systems 614 may deliver two types of artificial intelligence systems, type A 3052 and type B 3054 through a set of data processing, artificial intelligence and computational systems 634. In embodiments, the hybrid adaptive intelligence systems 614 are selectable and/or configurable through the user interface 3020 so that one or more of the hybrid adaptive intelligence systems 614 can operate on or in cooperation with the sets of supply chain applications (e.g., demand management applications 824 and supply chain applications 812). The hybrid adaptive intelligence systems 614 may include a hybrid artificial intelligence system 3060 that may include at least two types of artificial intelligence capabilities including any of the various expert systems, artificial intelligence systems, neural networks, supervised learning systems, machine learning systems, deep learning systems, and other systems described throughout this disclosure and in the documents incorporated by reference. The hybrid adaptive intelligence systems 614 may facilitate applying a first type of artificial intelligence system 1160 to the set of demand management applications 824 and a second type of artificial intelligence system 1160 to the set of supply chain applications 812, wherein each of the first type and second type of artificial intelligence system 1160 can operate independently, cooperatively, and optionally coordinate operation to provide coordinated intelligence for operation of the value chain that produces at least one of the goods in the category of goods 3010.

In embodiments, the user interface 3020 may include interfaces for configuring a hybrid artificial intelligence system 3060 to take inputs from selected data sources of the value chain (such as data sources used by the set of demand management applications 824 and/or the set of supply chain applications 812) and supply them, such as to at least one of the two types of artificial intelligence systems in the hybrid artificial intelligence system 3060, types of which are described throughout this disclosure and in the documents incorporated herein by reference to enhance, control, improve, optimize, configure, adapt or have another impact on a value chain for the category of goods 3010. In embodiments, the selected data sources of the value chain may be applied either as inputs for classification or prediction, or as outcomes relating to the value chain, the category of goods 3010 and the like.

In embodiments, the hybrid adaptive intelligence systems 614 provides a plurality of distinct artificial intelligence systems 1160, a hybrid artificial intelligence system 3060, and combinations thereof. In embodiments, any of the plurality of distinct artificial intelligence systems 1160 and the hybrid artificial intelligence system 3060 may be configured as a plurality of neural network-based systems, such as a classification-adapted neural network, a prediction-adapted neural network and the like. As an example of hybrid adaptive intelligence systems 614, a machine learning-based artificial intelligence system may be provided for the set of demand management applications 824 and a neural network-based artificial intelligence system may be provided for the set of supply chain applications 812. As an example of a hybrid artificial intelligence system 3060, the hybrid adaptive intelligence systems 614 may provide the hybrid artificial intelligence system 3060 that may include a first type of artificial intelligence that is applied to the demand management applications 824 and which is distinct from a second type of artificial intelligence that is applied to the supply chain applications 812. A hybrid artificial intelligence system 3060 may include any combination of types of artificial intelligence systems including a plurality of a first type of artificial intelligence (e.g., neural networks) and at least one second type of artificial intelligence (e.g., an expert system) and the like. In embodiments, a hybrid artificial intelligence system may comprise a hybrid neural network that applies a first type of neural network with respect to the demand management applications 824 and a second type of neural network with respect to the supply chain applications 812. Yet further, a hybrid artificial intelligence system 3060 may provide two types of artificial intelligence to different applications, such as different demand management applications 824 (e.g., a sales management application and a demand prediction application) or different supply chain applications 812 (e.g., a logistics control application and a production quality control application).

In embodiments, hybrid adaptive intelligence systems 614 may be applied as distinct artificial intelligence capabilities to distinct demand management applications 824. As examples, coordinated intelligence through a hybrid artificial intelligence capabilities may be provided to a demand planning application by a feed-forward neural network, to a demand prediction application by a machine learning system, to a sales application by a self-organizing neural network, to a future demand aggregation application by a radial basis function neural network, to a marketing application by a convolutional neural network, to an advertising application by a recurrent neural network, to an e-commerce application by a hierarchical neural network, to a marketing analytics application by a stochastic neural network, to a customer relationship management application by an associative neural network and the like.

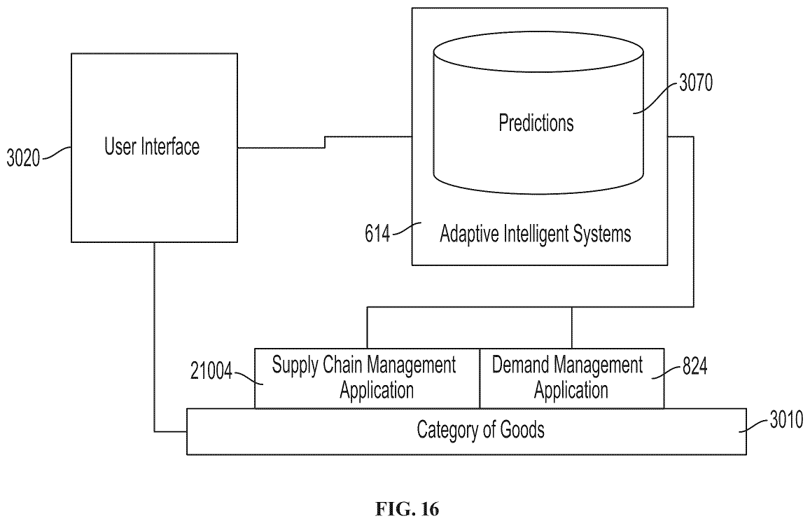

Referring to FIG. 16, a management platform of an information technology system, such as a management platform for a value chain of goods and/or services is depicted as a block diagram of functional elements and representative interconnections for providing a set of predictions 3070. The management platform includes a user interface 3020 that provides, among other things, a set of adaptive intelligence systems 614. The adaptive intelligence systems 614 provide a set of predictions 3070 through the application of artificial intelligence, such as through application of an artificial intelligence system 1160, and optionally through one or more expert systems, machine learning systems, and the like for use with a coordinated set of demand management applications 824 and supply chain applications 812 for a category of goods 3010, which may be produced and sold through the value chain. The adaptive intelligence systems 614 may deliver the set of prediction 3070 through a set of data processing, artificial intelligence and computational systems 634. In embodiments, the adaptive intelligence systems 614 are selectable and/or configurable through the user interface 3020 so that one or more of the adaptive intelligence systems 614 can operate on or in cooperation with the coordinated sets of value chain applications. The adaptive intelligence systems 614 may include an artificial intelligence system that provides artificial intelligence capabilities known to be associated with artificial intelligence including any of the various expert systems, artificial intelligence systems, neural networks, supervised learning systems, machine learning systems, deep learning systems, and other systems described throughout this disclosure and in the documents incorporated by reference. The adaptive intelligence systems 614 may facilitate applying adapted intelligence capabilities to the coordinated set of demand management applications 824 and supply chain applications 812 such as by producing a set of predictions 3070 that may facilitate coordinating the two sets of value chain applications, or at least facilitate coordinating at least one demand management application and at least one supply chain application from their respective sets.

In embodiments, the set of predictions 3070 includes a least one prediction of an impact on a supply chain application based on a current state of a coordinated demand management application, such as a prediction that a demand for a good will decrease earlier than previously anticipated. The converse may also be true in that the set of predictions 3070 includes at least one prediction of an impact on a demand management application based on a current state of a coordinated supply chain application, such as a prediction that a lack of supply of a good will likely impact a measure of demand of related goods. In embodiments, the set of predictions 3070 is a set of predictions of adjustments in supply required to meet demand. Other predictions include at least one prediction of change in demand that impacts supply. Yet other predictions in the set of predictions predict a change in supply that impacts at least one of the set of demand management applications, such as a promotion application for at least one good in the category of goods. A prediction in the set of predictions may be as simple as setting a likelihood that a supply of a good in the category of goods will not meet demand set by a demand setting application.

In embodiments, the adaptive intelligence systems 614 may provide a set of artificial intelligence capabilities to facilitate providing the set of predictions for the coordinated set of demand management applications and supply chain applications. In one non-limiting example, the set of artificial intelligence capabilities may include a probabilistic neural network that may be used to predict a fault condition or a problem state of a demand management application such as a lack of sufficient validated feedback. The probabilistic neural network may be used to predict a problem state with a machine performing a value chain operation (e.g., a production machine, an automated handling machine, a packaging machine, a shipping machine and the like) based on a collection of machine operating information and preventive maintenance information for the machine.

In embodiments, the set of predictions 3070 may be provided by the management platform 102 directly through a set of adaptive artificial intelligence systems.

In embodiments, the set of predictions 3070 may be provided for the coordinated set of demand management applications and supply chain applications for a category of goods by applying artificial intelligence capabilities for coordinating the set of demand management applications and supply chain applications.

In embodiments, the set of predictions 3070 may be predictions of outcomes for operating a value chain with the coordinated set demand management applications and supply chain applications for the category of goods, so that a user may conduct test cases of coordinated sets of demand management applications and supply chain applications to determine which sets may produce desirable outcomes (viable candidates for a coordinated set of applications) and which may produce undesirable outcomes.

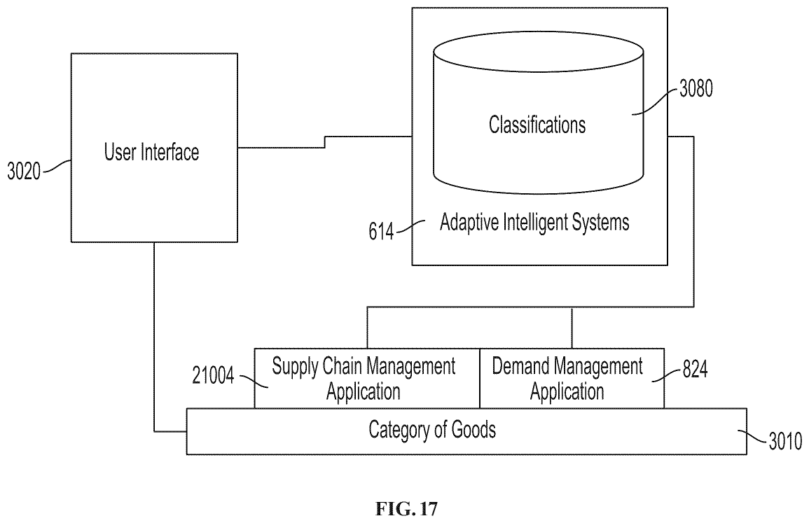

Referring to FIG. 17, a management platform of an information technology system, such as a management platform for a value chain of goods and/or services is depicted as a block diagram of functional elements and representative interconnections for providing a set of classifications 3080. The management platform includes a user interface 3020 that provides, among other things, a set of adaptive intelligence systems 614. The adaptive intelligence systems 614 provide a set of classifications 3080 through, for example, the application of artificial intelligence, such as through application of an artificial intelligence system 1160, and optionally through one or more expert systems, machine learning systems, and the like for use with a coordinated set of demand management applications 824 and supply chain applications 812 for a category of goods 3010, which may be produced, marketed, sold, resold, rented, leased, given away, serviced, recycled, renewed, enhanced, and the like through the value chain. The adaptive intelligence systems 614 may deliver the set of classifications 3080 through a set of data processing, artificial intelligence and computational systems 634. In embodiments, the adaptive intelligence systems 614 are selectable and/or configurable through the user interface 3020 so that one or more of the adaptive intelligence systems 614 can operate on or in cooperation with the coordinated sets of value chain applications. The adaptive intelligence systems 614 may include an artificial intelligence system that provides, among other things classification capabilities through any of the various expert systems, artificial intelligence systems, neural networks, supervised learning systems, machine learning systems, deep learning systems, and other systems described throughout this disclosure and in the documents incorporated by reference. The adaptive intelligence systems 614 may facilitate applying adapted intelligence capabilities to the coordinated set of demand management applications 824 and supply chain applications 812 such as by producing a set of classifications 3080 that may facilitate coordinating the two sets of value chain applications, or at least facilitate coordinating at least one demand management application and at least one supply chain application from their respective sets.

In embodiments, the set of classifications 3080 includes at least one classification of a current state of a supply chain application for use by a coordinated demand management application, such as a classification of a problem state that may impact operation of a demand management application, such as a marketing application and the like. Such a classification may be useful in determining how to adjust a market expectation for a good that is going to have a lower yield than previously anticipated. The converse may also be true in that the set of classifications 3080 includes at least one classification of a current state of a demand management application and its relationship to a coordinated supply chain application. In embodiments, the set of classifications 3080 is a set of classifications of adjustments in supply required to meet demand, such as adjustments to production worker needs would be classified differently that adjustments in third-party logistics providers. Other classifications may include at least one classification of perceived changes in demand and a resulting potential impact on supply management. Yet other classifications in the set of classifications may include a supply chain application impact on at least one of the set of demand management applications, such as a promotion application for at least one good in the category of goods. A classification in the set of classifications may be as simple as classifying a likelihood that a supply of a good in the category of goods will not meet demand set by a demand setting application.

In embodiments, the adaptive intelligence systems 614 may provide a set of artificial intelligence capabilities to facilitate providing the set of classifications 3080 for the coordinated set of demand management applications and supply chain applications. In one non-limiting example, the set of artificial intelligence capabilities may include a probabilistic neural network that may be used to classify fault conditions or problem states of a demand management application, such as a classification of a lack of sufficient validated feedback. The probabilistic neural network may be used to classify a problem state of a machine performing a value chain operation (e.g., a production machine, an automated handling machine, a packaging machine, a shipping machine and the like) as pertaining to at least one of machine operating information and preventive maintenance information for the machine.

In embodiments, the set of classifications 3080 may be provided by the management platform 102 directly through a set of adaptive artificial intelligence systems. Further, the set of classifications 3080 may be provided for the coordinated set of demand management applications and supply chain applications for a category of goods by applying artificial intelligence capabilities for coordinating the set of demand management applications and supply chain applications.

In embodiments, the set of classifications 3080 may be classifications of outcomes for operating a value chain with the coordinated set demand management applications and supply chain applications for the category of goods, so that a user may conduct test cases of coordinated sets of demand management applications and supply chain applications to determine which sets may produce outcomes that are classified as desirable (e.g., viable candidates for a coordinated set of applications) and outcomes that are classified as undesirable.

In embodiments, the set of classifications may comprise a set of adaptive intelligence functions, such as a neural network that may be adapted to classify information associated with the category of goods. In an example, the neural network may be a multilayered feed forward neural network.

In embodiments, performing classifications may include classifying discovered value chain entities as one of demand centric and supply centric.

In embodiments, the set of classifications 3080 may be achieved through use of artificial intelligence systems 1160 for coordinating the set of coordinated demand management and supply chain applications. Artificial intelligence systems may configure and generate sets of classifications 3080 as a means by which demand management applications and supply chain applications can be coordinated. In an example, classification of information flow throughout a value chain may be classified as being relevant to both a demand management application and a supply chain application; this common relevance may be a point of coordination among the applications. In embodiments, the set of classifications may be artificial intelligence generated classifications of outcomes of operating a supply chain that is dependent on the coordinated demand management applications 824 and supply chain applications 812.

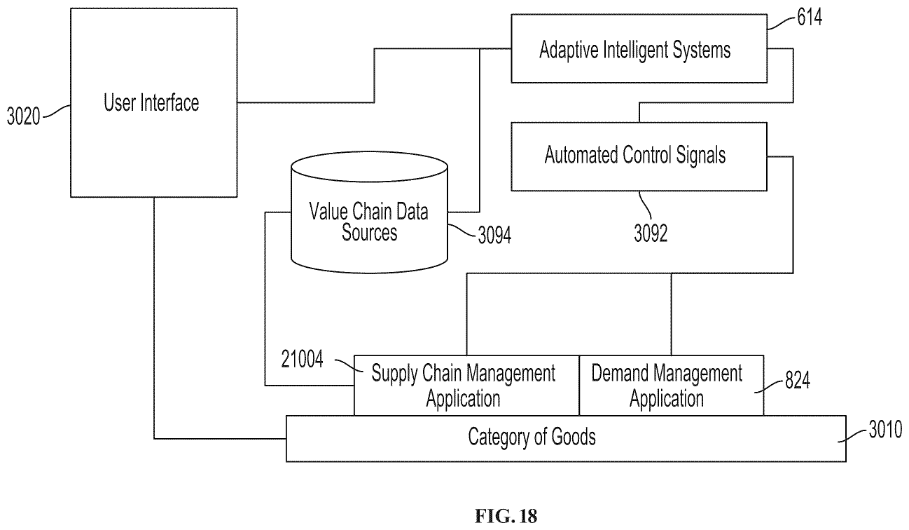

Referring to FIG. 18, a management platform of an information technology system, such as a management platform for a value chain of goods and/or services is depicted as a block diagram of functional elements and representative interconnections for achieving automated control intelligence. The management platform includes a user interface 3020 that provides, among other things, a set of adaptive intelligence systems 614. The adaptive intelligence systems 614 provide automated control signaling 3092 for a coordinated set of demand management applications 824 and supply chain applications 812 for a category of goods 3010, which may be produced and sold through the value chain. The adaptive intelligence systems 614 may deliver the automated control signals 3092 through a set of data processing, artificial intelligence and computational systems 634. In embodiments, the adaptive intelligence systems 614 are selectable and/or configurable through the user interface 3020 so that one or more of the adaptive intelligence systems 614 can automatically control the sets of supply chain applications (e.g., demand management applications 824 and supply chain applications 812). The adaptive intelligence systems 614 may include artificial intelligence including any of the various expert systems, artificial intelligence systems, neural networks, supervised learning systems, machine learning systems, deep learning systems, and other systems described throughout this disclosure and in the documents incorporated by reference.

In embodiments, the user interface 3020 may include interfaces for configuring an adaptive intelligence systems 614 to take inputs from selected data sources of the value chain 3094 (such as data sources used by the coordinated set of demand management applications 824 and/or the set of supply chain applications 812) and supply them, such as to a neural network, artificial intelligence system 1160 or any of the other adaptive intelligence systems 614 described throughout this disclosure and in the documents incorporated herein by reference for producing automated control signals 3092, such as to enhance, control, improve, optimize, configure, adapt or have another impact on a value chain for the category of goods 3010. In embodiments, the selected data sources of the value chain may be used for determining aspects of the automated control signals, such as for temporal adjustments to control outcomes relating to the value chain at least for the category of goods 3010 and the like.

In an example, the set of automated control signals may include at least one control signal for automating execution of a supply chain application, such as a production start, an automated material order, an inventory check, a billing application and the like in the coordinated set of demand management applications and supply chain applications. In yet another example of automated control signal generation, the set of automated control signals may include at least one control signal for automating execution of a demand management application, such as a product recall application, an email distribution application and the like in the coordinated set of demand management applications and supply chain applications. In yet other examples, the automate control signals may control timing of demand management applications based on goods supply status.

In embodiments, the adaptive intelligence systems 614 may apply machine learning to outcomes of supply to automatically adapt a set of demand management application control signals. Similarly, the adaptive intelligence systems 614 may apply machine learning to outcomes of demand management to automatically adapt a set of supply chain application control signals. The adaptive intelligence systems 614 may provide further processing for automated control signal generation, such as by applying artificial intelligence to determine aspects of a value chain that impact automated control of the coordinated set of demand management applications and supply chain applications for a category of goods. The determined aspects could be used in the generation and operation of automated control intelligence/signals, such as by filtering out value chain information for aspects that do not impact the targeted demand management and supply chain applications.

Automated control of, for example, supply chain applications may be restricted, such as by policy, operational limits, safety constraints and the like. The set of adaptive intelligence systems may determine a range of supply chain application control values within which control can be automated. In embodiments, the range may be associated with a supply rate, a supply timing rate, a mix of goods in a category of goods, and the like.

Embodiments are described herein for using artificial intelligence systems or capabilities to identify, configure and regulate automated control signals. Such embodiments may further include a closed loop of feedback from the coordinated set of demand management and supply chain applications (e.g., state information, output information, outcomes and the like) that is optionally processed with machine learning and used to adapt the automated control signals for at least one of the goods in the category of goods. An automated control signal may be adapted based on, for example, an indication of feedback from a supply chain application that yield of a good suggests a production problem. In this example, the automated control signal may impact production rate and the feedback may cause the signal to automatically self-adjust to a slower production rate until the production problem is resolved.

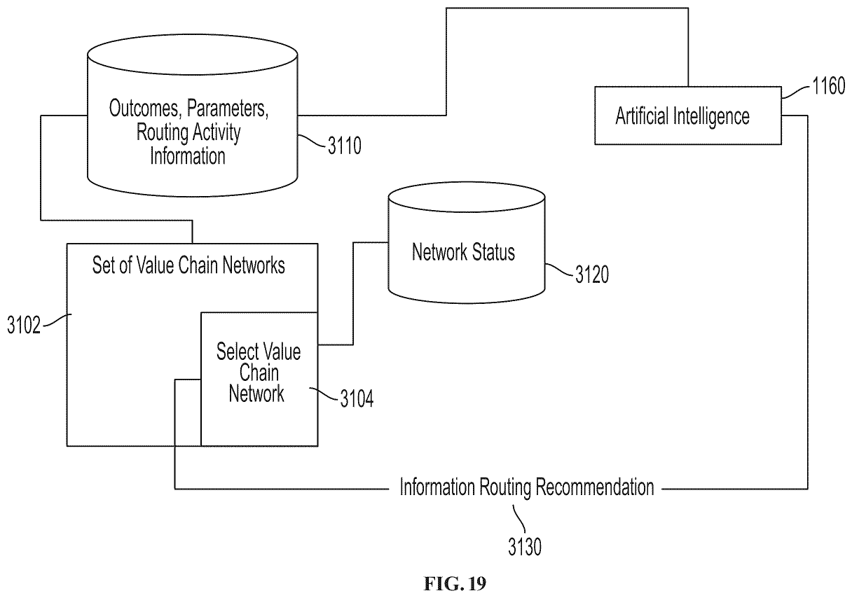

Referring to FIG. 19, a management platform of an information technology system, such as a management platform for a value chain of goods and/or services is depicted as a block diagram of functional elements and representative interconnections for providing information routing recommendations. The management platform includes a set of value chain networks 3102 from which network data 3110 is collected from a set of information routing activities, the information including outcomes, parameters, routing activity information and the like. Within the set of value chain networks 3102 is selected a select value chain network 3104 for which at least one information routing recommendation 3130 is provided. An artificial intelligence system 1160 may include a machine learning system and may be trained using a training set derived from the network data 3110 outcomes, parameters and routing activity information for the set of value chain networks 3102. The artificial intelligence system 1160 may further provide an information routing recommendation 3130 based on a current status 3120 of the select value chain network 3104. The artificial intelligence system may use machine learning to train on information transaction types within the set of value chain networks 3102, thereby learning pertinent factors regarding different transaction types (e.g., real-time inventory updates, buyer credit checks, engineering signoff, and the like) and contributing to the information routing recommendation accordingly. The artificial intelligence system may also use machine learning to train on information value for different types and/or classes of information routed in and throughout the set of value chain networks 3102. Information may be valued on a wide range of factors, including timing of information availability and timing of information consumption as well as information content-based value, such as information without which a value chain network element (e.g., a production provider) cannot perform a desired action (e.g., starting volume production without a work order). Therefore information routing recommendations may be based on training on transaction type, information value, and a combination thereof. These are merely exemplary information routing recommendation training and recommendation basis factors and are presented here without limitation on other elements for training and recommendation basis.

In embodiments, the artificial intelligence system 1160 may provide an information routing recommendation 3130 based on transaction type, transaction type and information type, network type and the like. An information routing recommendation may be based on combinations of factors, such as information type and network type, such as when an information type (streaming) is not compatible with a network type (small transactions).

In embodiments, the artificial intelligence system 1160 may use machine learning to develop an understanding of networks within the selected value chain network 3104, such as network topology, network loading, network reliability, network latency and the like. This understanding may be combined with, for example, detected or anticipated network conditions to form an information routing recommendation. Aspects such as existence of edge intelligence in a value chain network 3104 can influence one or more information routing recommendations. In an example, a type of information may be incompatible with a network type; however the network may be configured with edge intelligence that can be leveraged by the artificial intelligence system 1160 to adapt the form of the information being routed so that it is compatible with a targeted network type. This is also an example of more general consideration for information routing recommendation-network resources (e.g., presence, availability, and capability), such as edge computing, server access, network-based storage resources and the like. Likewise, value chain network entities may impact information routing recommendations. In embodiments, an information routing recommendation may avoid routing information that is confidential to a first supplier in the value chain through network nodes controlled by competitors of the supplier. In embodiments, an information routing recommendation may include routing information to a first node where it is partially consumed and partially processed for further routing, such as by splitting up the portion partially processed for further routing into destination-specific information sets.

In embodiments, an artificial intelligence system 1160 may provide an information routing recommendation based on goals, such as goals of a value chain network, goals of information routing, and the like. Goal-based information routing recommendations may include routing goals, such as Quality of Service routing goals, routing reliability goals (which may be measured based on a transmission failure rate and the like). Other goals may include a measure of latency associated with one or more candidate routes. An information routing recommendation may be based on the availability of information in a selected value chain network, such as when information is available and when it needs to be delivered. For information that is available well ahead of when it is needed (e.g., a nightly production report that is available for routing at 2 AM is first needed by 7 AM), routing recommendations may include using resources that are lower cost, may involve short delays in routing and the like. For information that is available just before it is needed (e.g., a result of product testing is needed within a few hundred milliseconds of when the test is finished to maintain a production operation rate, and the like).

An information routing recommendation may be formed by the artificial intelligence system 1160 based on information persistence factors, such as how long information is available for immediate routing within the value chain network. An information routing recommendation that factors information persistence may select network resources based on availability, cost and the like during a time of information persistence.

Information value and an impact on information value may factor into an information routing recommendation. As an example, information that is valid for a single shipment (e.g., a production run of a good) may substantively lose value once the shipment has been satisfactorily received. In such an example, an information routing recommendation may indicate routing the relevant information to all of the highest priority consumers of the information while it is still valid. Likewise, routing of information that is consumed by more than one value chain entity may need to be coordinated so that each value chain entity receives the information at a desired time/moment, such as during the same production shift, at their start of day, which may be different if the entities are in different time zones, and the like.

In embodiments, information routing recommendations may be based on a topology of a value chain, based on location and availability of network storage resources, and the like.

In embodiments, one or more information routing recommendations may be adapted while the information is routed based on, for example, changes in network resource availability, network resource discovery, network dynamic loading, priority of recommendations that are generated after information for a first recommendation is in-route, and the like.

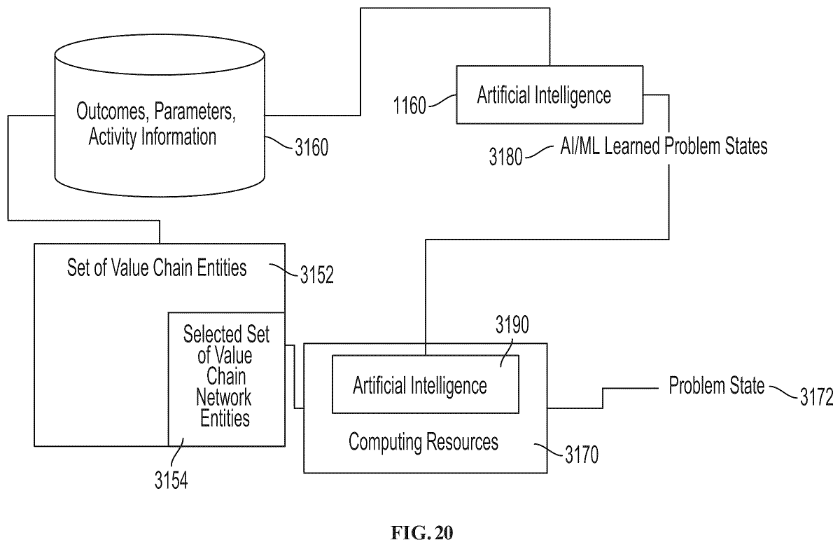

Referring to FIG. 20, a management platform of an information technology system, such as a management platform for a value chain of goods and/or services is depicted as a block diagram of functional elements and representative interconnections for semi-sentient problem recognitions of pain points in a value chain network. The management platform includes a set of value chain network entities 3152 from which entity-related data 3160 is collected and includes outcomes, parameters, activity information and the like associated with the entities. Within the set of value chain network entities 3152 is selected a set of select value chain network entities 3154 for which at least one pain point problem state 3172 is detected. An artificial intelligence system 1160 may be training on a training set derived from the entity-related data 3160 including training on outcomes associated with value chain entities, parameters associated with, for example, operation of the value chain, value chain activity information and the like. The artificial intelligence system may further employ machine learning to facilitate learning problem state factors 3180 that may characterize problem states input as training data. These factors 3180 may further be used by an instance of artificial intelligence 1160′ that operates on computing resources 3170 that are local to value chain network entities that are experiencing the problem/result of a pain point. A goal of such a configuration of artificial intelligence systems, data sets, and value chain networks is to recognize a problem state in a portion of the selected value chain.

In embodiments, recognizing problem states may be based on variance analysis, such as variances that occur in value chain measures (e.g., loading, latency, delivery time, cost, and the like), particularly in a specific measure over time. Variances that exceed a variance threshold (e.g., an optionally dynamic range of results of a value chain operation, such as production, shipping, clearing customs, and the like) may be indicative of a pain point.

In addition to detecting problem states, the platform 102, such as through the methods of semi-sentient problem recognition, predict a pain point based at least in part on a correlation with a detected problem state. The correlation may be derived from the value chain, such as a shipper cannot deliver international goods until they are processed through customs, or a sales forecast cannot be provided with a high degree of confidence without high quality field data and the like. In embodiments, a predicted pain point may be a point of value chain activity further along a supply chain, an activity that occurs in a related activity (e.g., tax planning is related to tax laws), and the like. A predicted pain point may be assigned a risk value based on aspects of the detected problem state and correlations between the predicted pain point activity and the problem state activity. If a production operation can receive materials from two suppliers, a problem state with one of the suppliers may indicate a low risk of a pain point of use of the material. Likewise, if a demand management application indicates high demand for a good and a problem is detected with information on which the demand is based, a risk of excess inventory (pain point) may be high depending on, for example how far along in the value chain the good has progressed.

In embodiments, semi-sentient problem recognition may involve more than mere linkages of data and operational states of entities engaged in a value chain. Problem recognition may also be based on human factors, such as perceived stress of production supervisors, shippers, and the like. Human factors for use in semi-sentient problem recognition may be collected from sensors that facilitate detection of human stress level and the like (e.g., wearable physiological sensors, and the like).

In embodiments, semi-sentient problem recognition may also be based on unstructured information, such as digital communication, voice messaging, and the like that may be shared among, originate with, or be received by humans involved in the value chain operations. As an example, natural language processing of email communications among workers in an enterprise may indicate a degree of discomfort with, for example, a supplier to a value chain. While data associated with the supplier (e.g., on-time production, quality, and the like) may be within a variance range deemed acceptable, information within this unstructured content may indicate a potential pain point, such as a personal issue with a key participant at the supplier and the like. By employing natural language processing, artificial intelligence, and optionally machine learning, problem state recognition may be enhanced.

In embodiments, semi-sentient problem recognition may be based on analysis of variances of measures of a value chain operation/entity/application including variance of a given measure over time, variance of two related measures, and the like. In embodiments, variance in outcomes over time may indicate a problem state and/or suggest a pain point. In embodiments, an artificial intelligence-based system may determine an acceptable range of outcome variance and apply that range to measures of a select set of value chain network entities, such as entities that share one or more similarities, to facilitate detection of a problem state. In embodiments, an acceptable range of outcome variance may indicate a problem state trigger threshold that may be used by a local instance of artificial intelligence to signal a problem state. In such a scenario, a problem state may be detected when at least one measure of the value chain activity/entity and the like is greater than the artificial intelligence-determined problem state threshold. Variance analysis for problem state detection may include detecting variances in start/end times of scheduled value chain network entity activities, variances in at least one of production time, production quality, production rate, production start time, production resource availability or trends thereof, variances in a measure of shipping supply chain entity, variances in a duration of time for transfer from one mode of transport to another (e.g., when the variance is greater than a transport mode problem state threshold), variances in quality testing, and the like.

In embodiments, a semi-sentient problem recognition system may include a machine learning/artificial intelligence prediction of a correlated pain point further along a supply chain due to a detected pain point, such as a risk and/or need for overtime, expedited shipping, discounting goods prices, and the like.

In embodiments, a machine learning/artificial intelligence system may process outcomes, parameters, and data collected from a set of data sources relating to a set of value chain entities and activities to detect at least one pain point selected from the list of pain points consisting of late shipment, damaged container, damaged goods, wrong goods, customs delay, unpaid duties, weather event, damaged infrastructure, blocked waterway, incompatible infrastructure, congested port, congested handling infrastructure, congested roadway, congested distribution center, rejected goods, returned goods, waste material, wasted energy, wasted labor force, untrained workforce, poor customer service, empty transport vehicle on return route, excessive fuel prices, excessive tariffs, and the like.

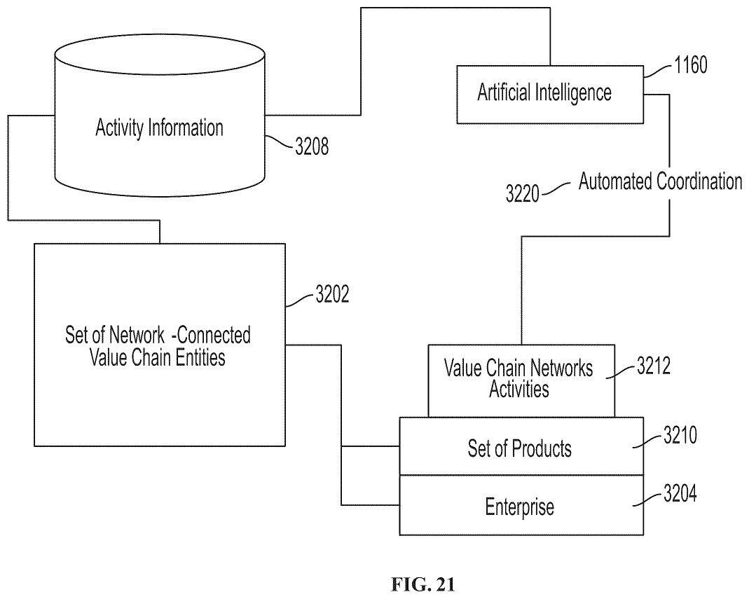

Referring to FIG. 21, a management platform of an information technology system, such as a management platform for a value chain of goods and/or services is depicted as a block diagram of functional elements and representative interconnections automated coordination of a set of value chain network activities for a set of products of an enterprise. The management platform includes a set of network-connected value chain network entities 3202 that produce activity information 3208 that is used by an artificial intelligence system 1160 to provide automate coordination 3220 of value chain network activities 3212 for a set of products 3210 for an enterprise 3204. In embodiments, value chain monitoring systems 614 may monitor activities of the set of network-connected value chain entities 3202 and work cooperatively with data collection and management systems 640 to gather and store value chain entity monitored information, such as activity information, configuration information, and the like. This gathered information may be configured as activity information 3208 for a set of activities associated with a set of products 3210 of an enterprise 3204. In embodiments, the artificial intelligence systems 1160 may use application programming connectivity facilities 642 for automating access to the monitored activity information 3208.

A value chain may include a plurality of interconnected entities that each perform several activities for completing the value chain. While humans play a critical role in some activities within a value chain network, greater automated coordination and unified orchestration of supply and demand may be achieved using artificial intelligence-type systems (e.g., machine learning, expert systems, self-organizing systems, and the like including such systems describe herein and in the documents incorporated herein by reference) for coordinating supply chain activities. Use of artificial intelligence may further enrich the emerging nature of self-adapting systems, including Internet of Things (IoT) devices and intelligent products and the like that not only provide greater capabilities to end users, but can play a critical role in automated coordination of supply chain activities.

For example, an IoT system deployed in a fulfillment center 628 may coordinate with an intelligent product 1510 that takes customer feedback about the product 1510, and an application 630 for the fulfillment center 628 may, upon receiving customer feedback via a connection path to the intelligent product 1510 about a problem with the product 1510, initiate a workflow to perform corrective actions on similar products 650 before the products 650 are sent out from the fulfillment center 628. The workflow may be configured by an artificial intelligence system 1160 that analyzes the problem with the product 1510, develops an understanding of value chain network activities that produce the product, determines resources required for the workflow, coordinates with inventory and production systems to adapt any existing workflows and the like. Artificial intelligence systems 1160 may further coordinate with demand management applications to address any temporary impact on product availability and the like.

In embodiments, automated coordination of a set of value chain network activities for a set of products for an enterprise may rely on the methods and systems of coordinated intelligence described herein, such as to facilitate coordinating demand management activities, supply chain activities and the like, optionally using artificial intelligence for providing the coordinated intelligence, coordinating the activities and the like. As an example, artificial intelligence may facilitate determining relationships among value change network activities based on inputs used by the activities and results produced by the activities. Artificial intelligence may be integrated with and/or work cooperatively with activities of the platform, such as value chain network entity activities to continuously monitor activities, identify temporal aspects needing coordination (e.g., when changes in supply temporally impact demand activities), and automate such coordination. Automated coordination of value chain network activities within and across value chain network entity activities may benefit from advanced artificial intelligence systems that may enable use of differing artificial intelligence capabilities for any given value chain set of entities, applications, or conditions. Use of hybrid artificial intelligence systems may provide benefits by applying more than one type of intelligence to a set of conditions to facilitate human and/or computer automated selection thereof. Artificial intelligence can further enhance automated coordination of value chain network entity activities through intelligent operations such as generating sets of predictions, sets of classifications, generation of automate control signals (that may be communicated across value chain network entities and the like). Other exemplary artificial intelligence-based influences on automated coordination of value chain network entity activities include machine learning-based information routing and recommendations thereto, semi-sentient problem recognition based on both structured (e.g., production data) and unstructured (e.g., human emotions) sources, and the like. Artificial intelligence systems may facilitate automated coordination of value chain network entity activities for a set of products or an enterprise based on adaptive intelligence provided by the platform for a category of goods under which the set of products of an enterprise may be grouped. In an example, adaptive intelligence may be provided by the platform for a drapery hanging category of goods and a set of products for an enterprise may include a line of adaptable drapery hangers. Through understanding developed for the overall drapery hanging category, artificial intelligence capabilities may be applied to value chain network activities of the enterprise for automating aspects of the value chain, such as information exchange among activities and the like.

### Digital Twin System in Value Chain Entity Management Platform

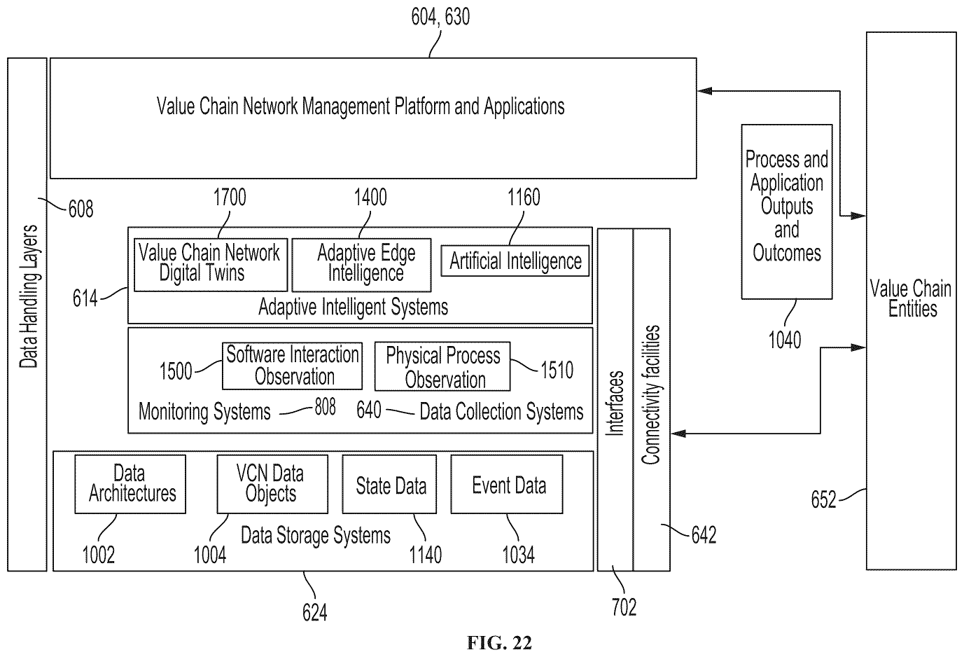

Referring to FIG. 22, the adaptive intelligence layer 614 may include a value chain network digital twin system 1700, which may include a set of components, processes, services, interfaces and other elements for development and deployment of digital twin capabilities for visualization of various value chain entities 652, environments, and applications 630, as well as for coordinated intelligence (including artificial intelligence 1160, edge intelligence 1400, analytics and other capabilities) and other value-added services and capabilities that are enabled or facilitated with a digital twin 1700. Without limitation, a digital twin 1700 may be used for and/or applied to each of the processes that are managed, controlled, or mediated by each of the set of applications 614 of the platform application layer.

In embodiments, the digital twin 1700 may take advantage of the presence of multiple applications 630 within the value chain management platform 604, such that a pair of applications may share data sources (such as in the data storage layer 624) and other inputs (such as from the monitoring layer 614) that are collected with respect to value chain entities 652, as well as sharing outputs, events, state information and outputs, which collectively may provide a much richer environment for enriching content in a digital twin 1700, including through use of artificial intelligence 1160 (including any of the various expert systems, artificial intelligence systems, neural networks, supervised learning systems, machine learning systems, deep learning systems, and other systems described throughout this disclosure and in the documents incorporated by reference) and through use of content collected by the monitoring layer 614 and data collection systems 640.

In embodiments, a digital twin 1700 may be used in connection with shared or converged processes among the various pairs of the applications 630 of the application 604, such as, without limitation, of a converged process involving a security application 834 and an inventory management application 820, integrated automation of blockchain-based applications 844 with facility management applications 850, and many others. In embodiments, converged processes may include shared data structures for multiple applications 630 (including ones that track the same transactions on a blockchain but may consume different subsets of available attributes of the data objects maintained in the blockchain or ones that use a set of nodes and links in a common knowledge graph) that may be connected to with the digital twin 1700 such that the digital twin 1700 is updated accordingly. For example, a transaction indicating a change of ownership of an entity 652 may be stored in a blockchain and used by multiple applications 630, such as to enable role-based access control, role-based permissions for remote control, identity-based event reporting, and the like that may be connected to and shared with the digital twin 1700 such that the digital twin 1700 may be updated accordingly. In embodiments, converged processes may include shared process flows across applications 630, including subsets of larger flows that are involved in one or more of a set of applications 614 that may be connected to and shared with the digital twin 1700 such that the digital twin 1700 may be updated accordingly. For example, an inspection flow about a value chain network entity 652 may serve an analytics solution 838, an asset management solution 814, and others.

In embodiments, a digital twin 1700 may be provided for the wide range of value chain network applications 630 mentioned throughout this disclosure and the documents incorporated herein by reference. An environment for development of a digital twin 1700 may include a set of interfaces for developers in which a developer may configure an artificial intelligence system 1160 to take inputs from selected data sources of the data storage layer 624 and events or other data from the monitoring systems layer 614 and supply them for inclusion in a digital twin 1700. A digital twin 1700 development environment may be configured to take outputs and outcomes from various applications 630.

### Value Chain Network Digital Twins

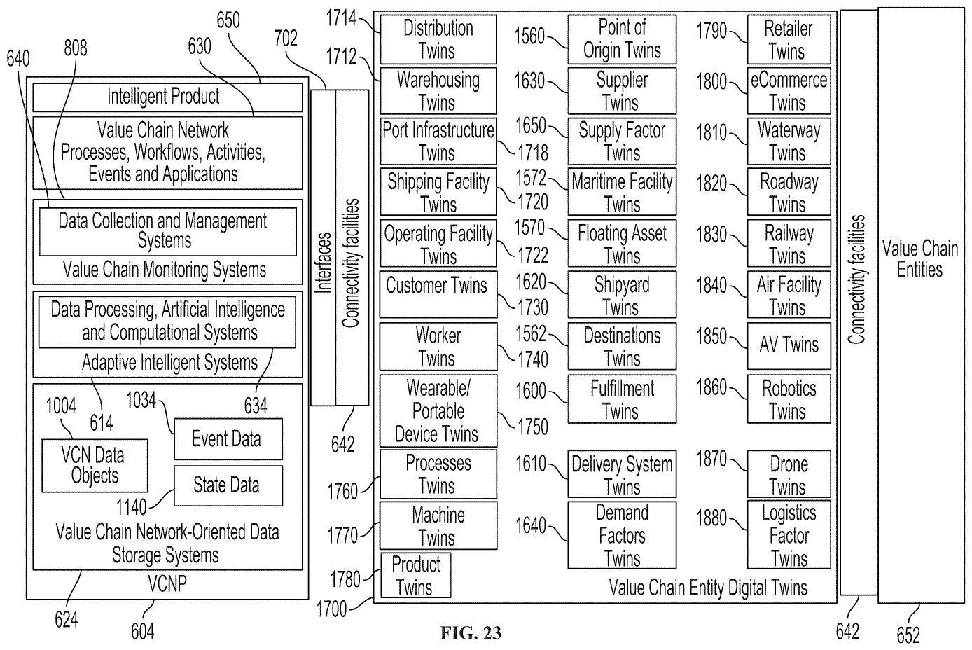

Referring to FIG. 23, any of the value chain network entities 652 can be depicted in a set of one or more digital twins 1700, such as by populating the digital twin 1700 with value chain network data object 1004, such as event data 1034, state data 1140, or other data with respect to value chain network entities 652, applications 630, or components or elements of the platform 604 as described throughout this disclosure.

Thus, the platform 604 may include, integrate, integrate with, manage, control, coordinate with, or otherwise handle any of a wide variety of digital twins 1700, such as distribution twins 1714 (such as representing distribution facilities, assets, objects, workers, or the like); warehousing twins 1712 (such as representing warehouse facilities, assets, objects, workers and the like); port infrastructure twins 1714 (such as representing a seaport, an airport, or other facility, as well as assets, objects, workers and the like); shipping facility twins 1720; operating facility twins 1722; customer twins 1730 (such as representing physical, behavioral, demographic, psychographic, financial, historical, affinity, interest, and other characteristics of groups of customers or individual customers); worker twins 1740 (such as representing physical attributes, physiologic data, status data, psychographic information, emotional states, states of fatigue/energy, states of attention, skills, training, competencies, roles, authority, responsibilities, work status, activities, and other attributes of or involving workers); wearable/portable device twins 1750; process twins 1760; machine twins 21010 (such as for various machines used to support a value chain network 668); product twins 1780; point of origin twins 1560; supplier twins 1630; supply factor twins 1650; maritime facility twins 1572; floating asset twins 1570; shipyard twins 1620; destination twins 1562; fulfillment twins 1600; delivery system twins 1610; demand factor twins 1640; retailer twins 1790; ecommerce and online site and operator twins 1800; waterway twins 1810; roadway twins 1820; railway twins 1830; air facility twins 1840 (such as twins of aircraft, runways, airports, hangars, warehouses, air travel routes, refueling facilities and other assets, objects, workers and the like used in connection with air transport of products 650); autonomous vehicle twins 1850; robotics twins 1860; drone twins 1870; and logistics factor twins 1880; among others. Each of these may have characteristics of digital twins described throughout this disclosure and the documents incorporated by reference herein, such as mirroring or reflecting changes in states of associated physical objects or other entities, providing capabilities for modeling behavior or interactions of associated physical objects or other entities, enabling simulations, providing indications of status, and many others.

In example embodiments, a digital twin system may be configured to generate a variety of enterprise digital twins 1700 in connection with a value chain (e.g., specifically value chain network entities 652). For example, an enterprise that produces goods internationally (or at multiple facilities) may configure a set of digital twins 1700, such as supplier twins that depict the enterprise's supply chain, factory twins of the various production facilities, product twins that represent the products made by the enterprise, distribution twins that represent the enterprise's distribution chains, and other suitable twins. In doing so, the enterprise may define the structural elements of each respective digital twin as well as any system data that corresponds to the structural elements of the digital twin. For instance, in generating a production facility twin, the enterprise may the layout and spatial definitions of the facility and any processes that are performed in the facility. The enterprise may also define data sources corresponding to the value chain network entities 652, such as sensor systems, smart manufacturing equipment, inventory systems, logistics systems, and the like that provide data relevant to the facility. The enterprise may associate the data sources with elements of the production facility and/or the processes occurring the facility. Similarly, the enterprise may define the structural, process, and layout definitions of its supply chain and its distribution chain and may connect relevant data sources, such as supplier databases, logistics platforms, to generate respective distribution chain and supply chain twins. The enterprise may further associate these digital twins to have a view of its value chain. In embodiments, the digital twin system may perform simulations of the enterprise's value chain that incorporate real-time data obtained from the various value chain network entities 652 of the enterprise. In some of these embodiments, the digital twin system may recommend decisions to a user interacting with the enterprise digital twins 1700, such as when to order certain parts for manufacturing a certain product given a predicted demand for the manufactured product, when to schedule maintenance on machinery and/or replace machinery (e.g., when digital simulations on the digital twin indicates the demand for certain products may be the lowest or when it would have the least effect on the enterprise's profits and losses statement), what time of day to ship items, or the like. The foregoing example is a non-limiting example of the manner by which a digital twin may ingest system data and perform simulations in order to further one or more goals.

### Entity Discovery and Interaction Management

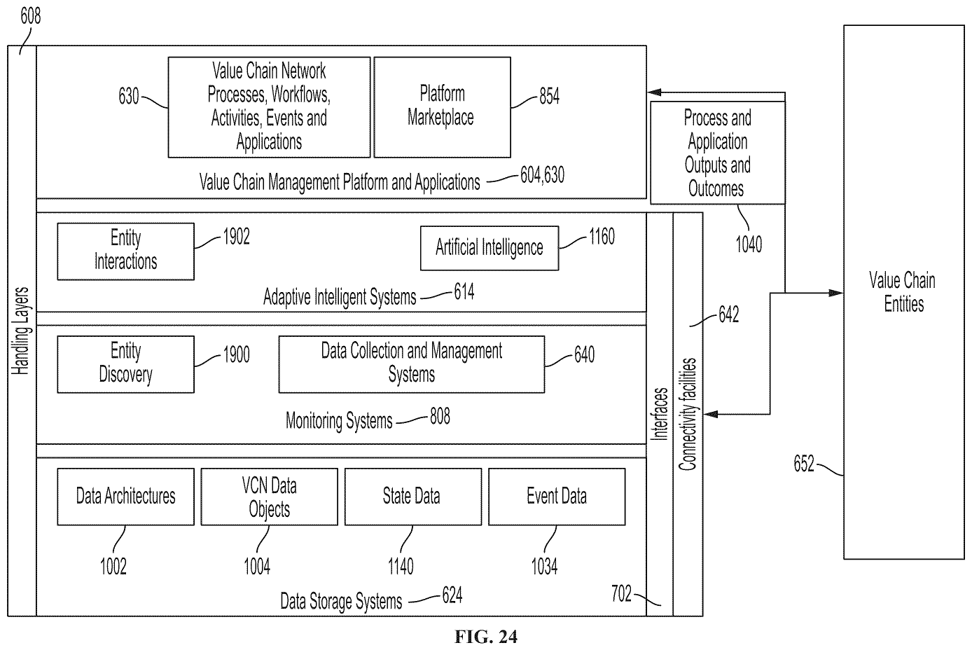

Referring to FIG. 24, the monitoring systems layer 614, including various data collection systems 640 (such as IoT data collection systems, data collection systems that search social networks, websites, and other online resources, crowdsourcing systems, and others) may include a set of entity discovery systems 1900, such as for identifying sets of value chain network entities 652, identifying types of value chain network entities 652, identifying specific value chain network entities 652 and the like, as well as for managing identities of the value chain network entities 652, including for resolving ambiguities (such as where a single entity is identified differently in different systems, where different entities are identified similarly, and the like), for entity identity deduplication, for entity identity resolution, for entity identity enhancement (such as by enriching data objects with additional data that is collected about an entity within the platform), and the like. Entity discovery 1900 may also include discovery of interactions among entities, such as how entities are connected (e.g., by what network connections, data integration systems, and/or interfaces), what data is exchanged among entities (including what types of data objects are exchanged, what common workflows involve entities, what inputs and outputs are exchanged between entities, and the like), what rules or policies govern the entities, and the like. The platform 604 may include a set of entity interaction management systems 1902, which may comprise one or more artificial intelligence systems (including any of the types described throughout this disclosure) for managing a set of interactions among entities that are discovered through entity discovery 1900, including ones that learn on a training set of data to manage interactions among entities based on how entities have been managed by human supervisors or by other systems.

As an illustrative example among many possible ones, the entity discovery system 1900 may be used to discover a network-connected camera that shows the loading dock of facility that produces a product for an enterprise, as well as to identify what interfaces or protocols are needed to access a feed of video content from the camera. The entity interaction management system 1902 may then be used to interact with the interfaces or protocols to set up access to the feed and to provide the feed to another system for further processing, such as to have an artificial intelligence system 1160 process the feed to discovery content that is relevant to an activity of the enterprise. For example, the artificial intelligence system 1160 may process image frames of the video feed to find markings (such as produce labels, SKUs, images, logos, or the like), shapes (such as packages of a particular size or shape), activities (such as loading or unloading activities) or the like that may indicate that a product has moved through the loading dock. This information may substitute for, augment, or be used to validate other information, such as RFID tracking information or the like. Similar discovery and interaction management activities may be undertaken with any of the types of value chain network entities 652 described throughout this disclosure.

### Robotic Process Automation in Value Chain Network

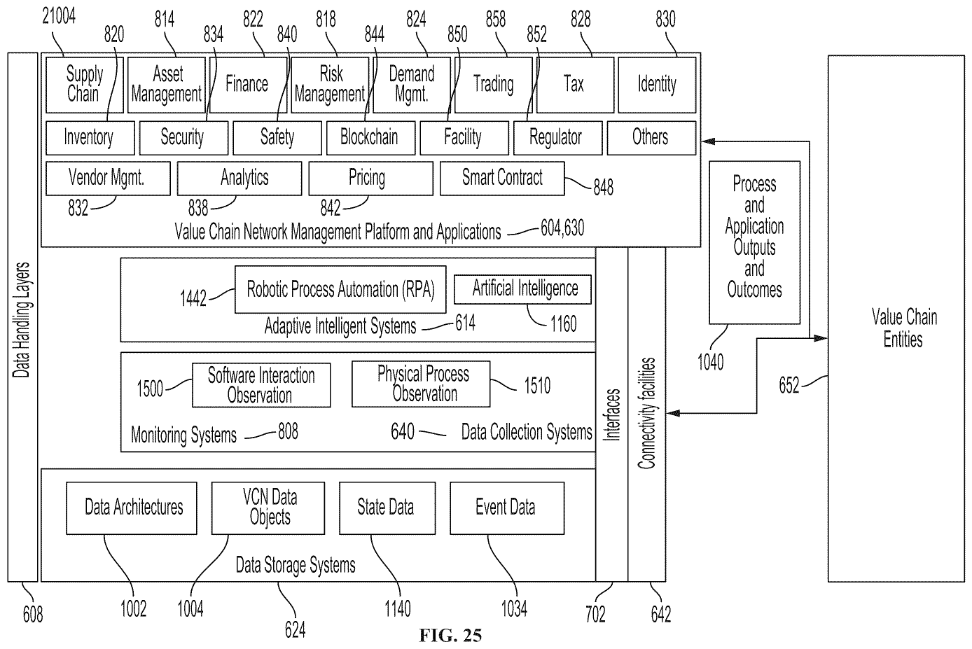

Referring to FIG. 25, the adaptive intelligence layer 614 may include a robotic process automation (RPA) system 1442, which may include a set of components, processes, services, interfaces and other elements for development and deployment of automation capabilities for various value chain entities 652, environments, and applications 630. Without limitation, robotic process automation 1442 may be applied to each of the processes that are managed, controlled, or mediated by each of the set of applications 614 of the platform application layer, to functions, components, workflows, processes of the VCNP 604 itself, to processes involving value chain network entities 652 and other processes.

In embodiments, robotic process automation 1442 may take advantage of the presence of multiple applications 630 within the value chain management platform 604, such that a pair of applications may share data sources (such as in the data storage layer 624) and other inputs (such as from the monitoring layer 614) that are collected with respect to value chain entities 652, as well as sharing outputs, events, state information and outputs, which collectively may provide a much richer environment for process automation, including through use of artificial intelligence 1160 (including any of the various expert systems, artificial intelligence systems, neural networks, supervised learning systems, machine learning systems, deep learning systems, and other systems described throughout this disclosure and in the documents incorporated by reference). For example, an asset management application 814 may use robotic process automation 1442 for automation of an asset inspection process that is normally performed or supervised by a human (such as by automating a process involving visual inspection using video or still images from a camera or other that displays images of an entity 652, such as where the robotic process automation 1442 system is trained to automate the inspection by observing interactions of a set of human inspectors or supervisors with an interface that is used to identify, diagnose, measure, parameterize, or otherwise characterize possible defects or favorable characteristics of a facility or other asset. In embodiments, interactions of the human inspectors or supervisors may include a labeled data set where labels or tags indicate types of defects, favorable properties, or other characteristics, such that a machine learning system can learn, using the training data set, to identify the same characteristics, which in turn can be used to automate the inspection process such that defects or favorable properties are automatically classified and detected in a set of video or still images, which in turn can be used within the value chain network asset management application 814 to flag items that require further inspection, that should be rejected, that should be disclosed to a prospective buyer, that should be remediated, or the like. In embodiments, robotic process automation 1442 may involve multi-application or cross-application sharing of inputs, data structures, data sources, events, states, outputs or outcomes. For example, the asset management application 814 may receive information from a marketplace application 854 that may enrich the robotic process automation 1442 of the asset management application 814, such as information about the current characteristics of an item from a particular vendor in the supply chain for an asset, which may assist in populating the characteristics about the asset for purposes of facilitating an inspection process, a negotiation process, a delivery process, or the like. These and many other examples of multi-application or cross-application sharing for robotic process automation 1442 across the applications 630 are encompassed by the present disclosure. Robotic process automation 1442 may be used with various functionality of the VCNP 604. For example, in some embodiments, robotic process automation 1442 may be described as training a robot to operate and automate a task that was, to at least a large extent, governed by a human. One of these tasks may be used to train a robot that may train other robots. The robotic process automation 1442 may be trained (e.g., through machine learning) to mimic interactions on a training set, and then have this trained robotic process automation 1442 (e.g., trained agent or trained robotic process automation system) execute these tasks that were previously performed by people. For example, the robotic process automation 1442 may utilize software that may provide software interaction observations (such as mouse movements, mouse clicks, cursor movements, navigation actions, menu selections, keyboard typing, and many others), such as logged and/or tracked by software interaction observation system 1500, purchase of the product by a customer 714, and the like. This may include monitoring of a user's mouse clicks, mouse movements, and/or keyboard typing to learn to do the same clicks and/or typing. In another example, the robotic process automation 1442 may utilize software to learn physical interactions with robots and other systems to train a robotic system to sequence or undertake the same physical interactions. For example, the robot may be trained to rebuild a set of bearings by having the robot watch a video of someone doing this task. This may include tracking physical interactions and tracking interactions at a software level. The robotic process automation 1442 may understand what the underlying competencies are that are being deployed such that the VCNP 604 preconfigure combinations of neural networks that may be used to replicate performance of human capabilities.

In embodiments, robotic process automation may be applied to shared or converged processes among the various pairs of the applications 630 of the application 604, such as, without limitation, of a converged process involving a security application 834 and an inventory application 820, integrated automation of blockchain-based applications 844 with vendor management applications 832, and many others. In embodiments, converged processes may include shared data structures for multiple applications 630 (including ones that track the same transactions on a blockchain but may consume different subsets of available attributes of the data objects maintained in the blockchain or ones that use a set of nodes and links in a common knowledge graph). For example, a transaction indicating a change of ownership of an entity 652 may be stored in a blockchain and used by multiple applications 630, such as to enable role-based access control, role-based permissions for remote control, identity-based event reporting, and the like. In embodiments, converged processes may include shared process flows across applications 630, including subsets of larger flows that are involved in one or more of a set of applications 614. For example, a risk management or inspection flow about an entity 652 may serve an inventory management application 832, an asset management application 814, a demand management application 824, and a supply chain application 812, among others.

In embodiments, robotic process automation 1442 may be provided for the wide range of value chain network processes mentioned throughout this disclosure and the documents incorporated herein by reference, including without limitation all of the applications 630. An environment for development of robotic process automation for value chain networks may include a set of interfaces for developers in which a developer may configure an artificial intelligence system 1160 to take inputs from selected data sources of the VCN data storage layer 624 and event data 1034, state data 1140 or other value chain network data objects 1004 from the monitoring systems layer 614 and supply them, such as to a neural network, either as inputs for classification or prediction, or as outcomes relating to the platform 102, value chain network entities 652, applications 630, or the like. The RPA development environment 1442 may be configured to take outputs and outcomes 1040 from various applications 630, again to facilitate automated learning and improvement of classification, prediction, or the like that is involved in a step of a process that is intended to be automated. In embodiments, the development environment, and the resulting robotic process automation 1442 may involve monitoring a combination of both software program interaction observations 1500 (e.g., by workers interacting with various software interfaces of applications 630 involving value chain network entities 652) and physical process interaction observations 1510 (e.g., by watching workers interacting with or using machines, equipment, tools or the like in a value chain network 668). In embodiments, observation of software interactions 1500 may include interactions among software components with other software components, such as how one application 630 interacts via APIs with another application 630. In embodiments, observation of physical process interactions 1510 may include observation (such as by video cameras, motion detectors, or other sensors, as well as detection of positions, movements, or the like of hardware, such as robotic hardware) of how human workers interact with value chain entities 652 (such as locations of workers (including routes taken through a location, where workers of a given type are located during a given set of events, processes or the like, how workers manipulate pieces of equipment, cargo, containers, packages, products 650 or other items using various tools, equipment, and physical interfaces, the timing of worker responses with respect to various events (such as responses to alerts and warnings), procedures by which workers undertake scheduled deliveries, movements, maintenance, updates, repairs and service processes; procedures by which workers tune or adjust items involved in workflows, and many others). Physical process observation 1510 may include tracking positions, angles, forces, velocities, acceleration, pressures, torque, and the like of a worker as the worker operates on hardware, such as on a container or package, or on a piece of equipment involved in handling products, with a tool. Such observations may be obtained by any combination of video data, data detected within a machine (such as of positions of elements of the machine detected and reported by position detectors), data collected by a wearable device (such as an exoskeleton that contains position detectors, force detectors, torque detectors and the like that is configured to detect the physical characteristics of interactions of a human worker with a hardware item for purposes of developing a training data set). By collecting both software interaction observations 1500 and physical process interaction observations 1510 the RPA system 1442 can more comprehensively automate processes involving value chain entities 652, such as by using software automation in combination with physical robots.

In embodiments, robotic process automation 1442 is configured to train a set of physical robots that have hardware elements that facilitate undertaking tasks that are conventionally performed by humans. These may include robots that walk (including walking up and down stairs to deliver a package), climb (such as climbing ladders in a warehouse to reach shelves where products 650 are stored), move about a facility, attach to items, grip items (such as using robotic arms, hands, pincers, or the like), lift items, carry items, remove and replace items, use tools and many others.

### Value Chain Management Platform—Unified Robotic Process Automation for Demand Management and Supply Chain

In embodiments, provided herein are methods, systems, components and other elements for an information technology system that may include a cloud-based management VCNP 604 with a micro-services architecture, a set of interfaces 702, a set of network connectivity facilities 642, adaptive intelligence facilities 614, data storage facilities 624, data collection systems 640, and monitoring facilities 614 that are coordinated for monitoring and management of a set of value chain network entities 652; a set of applications for enabling an enterprise to manage a set of value chain network entities from a point of origin to a point of customer use; and a unified set of robotic process automation systems 1442 that provide coordinated automation among various applications 630, including demand management applications, supply chain applications, intelligent product applications and enterprise resource management applications for a category of goods.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a unified set of robotic process automation systems that provide coordinated automation among at least two types of applications from among a set of demand management applications, a set of supply chain applications, a set of intelligent product applications and a set of enterprise resource management applications for a category of goods.

### Value Chain Management Platform—Robotic Process Automation Services in Microservices Architecture for Value Chain Network

In embodiments, provided herein are methods, systems, components and other elements for an information technology system that may include a cloud-based management VCNP 102 with a micro-services architecture, a set of interfaces 702, a set of network connectivity facilities 642, adaptive intelligence facilities 614, data storage facilities 624, data collection systems 640, and monitoring facilities 614 that are coordinated for monitoring and management of a set of value chain network entities 652; a set of applications for enabling an enterprise to manage a set of value chain network entities from a point of origin to a point of customer use; and a set of microservices layers including an application layer supporting at least one supply chain application and at least one demand management application, wherein the microservice layers include a robotic process automation layer 1442 that uses information collected by a data collection layer 640 and a set of outcomes and activities 1040 involving the applications of the application layer 630 to automate a set of actions for at least a subset of the applications 630.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of microservices layers including an application layer supporting at least one supply chain application and at least one demand management application, wherein the microservice layers include a robotic process automation layer that uses information collected by a data collection layer and a set of outcomes and activities involving the applications of the application layer to automate a set of actions for at least a subset of the applications.

### Value Chain Management Platform—Robotic Process Automation for Value Chain Network Processes

In embodiments, provided herein are methods, systems, components and other elements for an information technology system that may include a cloud-based management VCNP 102 with a micro-services architecture, a set of interfaces 702, a set of network connectivity facilities 642, adaptive intelligence facilities 614, data storage facilities 624, data collection systems 640, and monitoring facilities 614 that are coordinated for monitoring and management of a set of value chain network entities 652; a set of applications for enabling an enterprise to manage a set of value chain network entities from a point of origin to a point of customer use; and a set of robotic process automation systems 1442 for automating a set of processes in a value chain network, wherein the robotic process automation systems 1442 learn on a training set of data involving a set of user interactions with a set of interfaces 702 of a set of software systems that are used to monitor and manage the value chain network entities 652, as well as from various process and application outputs and outcomes 1040 that may occur with or within the VCNP 102.

In embodiments, the value chain network entities 652 may include, for example, products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, port infrastructure facilities, or many others.

In embodiments, the robotic process automation layer automates a process that may include, for example, without limitation, selection of a quantity of product for an order, selection of a carrier for a shipment, selection of a vendor for a component, selection of a vendor for a finished goods order, selection of a variation of a product for marketing, selection of an assortment of goods for a shelf, determination of a price for a finished good, configuration of a service offer related to a product, configuration of product bundle, configuration of a product kit, configuration of a product package, configuration of a product display, configuration of a product image, configuration of a product description, configuration of a website navigation path related to a product, determination of an inventory level for a product, selection of a logistics type, configuration of a schedule for product delivery, configuration of a logistics schedule, configuration of a set of inputs for machine learning, preparation of product documentation, preparation of required disclosures about a product, configuration of a product for a set of local requirements, configuration of a set of products for compatibility, configuration of a request for proposals, ordering of equipment for a warehouse, ordering of equipment for a fulfillment center, classification of a product defect in an image, inspection of a product in an image, inspection of product quality data from a set of sensors, inspection of data from a set of onboard diagnostics on a product, inspection of diagnostic data from an Internet of Things system, review of sensor data from environmental sensors in a set of supply chain environments, selection of inputs for a digital twin, selection of outputs from a digital twin, selection of visual elements for presentation in a digital twin, diagnosis of sources of delay in a supply chain, diagnosis of sources of scarcity in a supply chain, diagnosis of sources of congestion in a supply chain, diagnosis of sources of cost overruns in a supply chain, diagnosis of sources of product defects in a supply chain, prediction of maintenance requirements in supply chain infrastructure, or others.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; and a set of robotic process automation systems for automating a set of processes in a value chain network, wherein the robotic process automation systems learn on a training set of data involving a set of user interactions with a set of interfaces of a set of software systems that are used to monitor and manage the value chain network entities.

In embodiments, one of the processes automated by robotic process automation as described in any of the embodiments disclosed herein may involve the following. In embodiments, RPA involves selection of a quantity of product for an order. In embodiments, one of the processes automated by robotic process automation involves selection of a carrier for a shipment. In embodiments, one of the processes automated by robotic process automation involves selection of a vendor for a component. In embodiments, one of the processes automated by robotic process automation involves selection of a vendor for a finished goods order. In embodiments, one of the processes automated by robotic process automation involves selection of a variation of a product for marketing. In embodiments, one of the processes automated by robotic process automation involves selection of an assortment of goods for a shelf. In embodiments, one of the processes automated by robotic process automation involves determination of a price for a finished good. In embodiments, one of the processes automated by robotic process automation involves configuration of a service offer related to a product. In embodiments, one of the processes automated by robotic process automation involves configuration of product bundle. In embodiments, one of the processes automated by robotic process automation involves configuration of a product kit. In embodiments, one of the processes automated by robotic process automation involves configuration of a product package. In embodiments, one of the processes automated by robotic process automation involves configuration of a product display. In embodiments, one of the processes automated by robotic process automation involves configuration of a product image. In embodiments, one of the processes automated by robotic process automation involves configuration of a product description. In embodiments, one of the processes automated by robotic process automation involves configuration of a website navigation path related to a product. In embodiments, one of the processes automated by robotic process automation involves determination of an inventory level for a product. In embodiments, one of the processes automated by robotic process automation involves selection of a logistics type. In embodiments, one of the processes automated by robotic process automation involves configuration of a schedule for product delivery. In embodiments, one of the processes automated by robotic process automation involves configuration of a logistics schedule. In embodiments, one of the processes automated by robotic process automation involves configuration of a set of inputs for machine learning. In embodiments, one of the processes automated by robotic process automation involves preparation of product documentation. In embodiments, one of the processes automated by robotic process automation involves preparation of required disclosures about a product. In embodiments, one of the processes automated by robotic process automation involves configuration of a product for a set of local requirements. In embodiments, one of the processes automated by robotic process automation involves configuration of a set of products for compatibility. In embodiments, one of the processes automated by robotic process automation involves configuration of a request for proposals.

In embodiments, one of the processes automated by robotic process automation involves ordering of equipment for a warehouse. In embodiments, one of the processes automated by robotic process automation involves ordering of equipment for a fulfillment center. In embodiments, one of the processes automated by robotic process automation involves classification of a product defect in an image. In embodiments, one of the processes automated by robotic process automation involves inspection of a product in an image.

In embodiments, one of the processes automated by robotic process automation involves inspection of product quality data from a set of sensors. In embodiments, one of the processes automated by robotic process automation involves inspection of data from a set of onboard diagnostics on a product. In embodiments, one of the processes automated by robotic process automation involves inspection of diagnostic data from an Internet of Things system. In embodiments, one of the processes automated by robotic process automation involves review of sensor data from environmental sensors in a set of supply chain environments.

In embodiments, one of the processes automated by robotic process automation involves selection of inputs for a digital twin. In embodiments, one of the processes automated by robotic process automation involves selection of outputs from a digital twin. In embodiments, one of the processes automated by robotic process automation involves selection of visual elements for presentation in a digital twin. In embodiments, one of the processes automated by robotic process automation involves diagnosis of sources of delay in a supply chain. In embodiments, one of the processes automated by robotic process automation involves diagnosis of sources of scarcity in a supply chain. In embodiments, one of the processes automated by robotic process automation involves diagnosis of sources of congestion in a supply chain.

In embodiments, one of the processes automated by robotic process automation involves diagnosis of sources of cost overruns in a supply chain. In embodiments, one of the processes automated by robotic process automation involves diagnosis of sources of product defects in a supply chain. In embodiments, one of the processes automated by robotic process automation involves prediction of maintenance requirements in supply chain infrastructure.

In embodiments, the set of demand management applications, supply chain applications, intelligent product applications and enterprise resource management applications may include, for example, ones involving supply chain, asset management, risk management, inventory management, demand management, demand prediction, demand aggregation, pricing, positioning, placement, promotion, blockchain, smart contract, infrastructure management, facility management, analytics, finance, trading, tax, regulatory, identity management, commerce, ecommerce, payments, security, safety, vendor management, process management, compatibility testing, compatibility management, infrastructure testing, incident management, predictive maintenance, logistics, monitoring, remote control, automation, self-configuration, self-healing, self-organization, logistics, reverse logistics, waste reduction, augmented reality, virtual reality, mixed reality, demand customer profiling, entity profiling, enterprise profiling, worker profiling, workforce profiling, component supply policy management, product design, product configuration, product updating, product maintenance, product support, product testing, warehousing, distribution, fulfillment, kit configuration, kit deployment, kit support, kit updating, kit maintenance, kit modification, kit management, shipping fleet management, vehicle fleet management, workforce management, maritime fleet management, navigation, routing, shipping management, opportunity matching, search, advertisement, entity discovery, entity search, distribution, delivery, enterprise resource planning, and many others.

### Opportunity Miners for Automated Improvement of Adaptive Intelligence

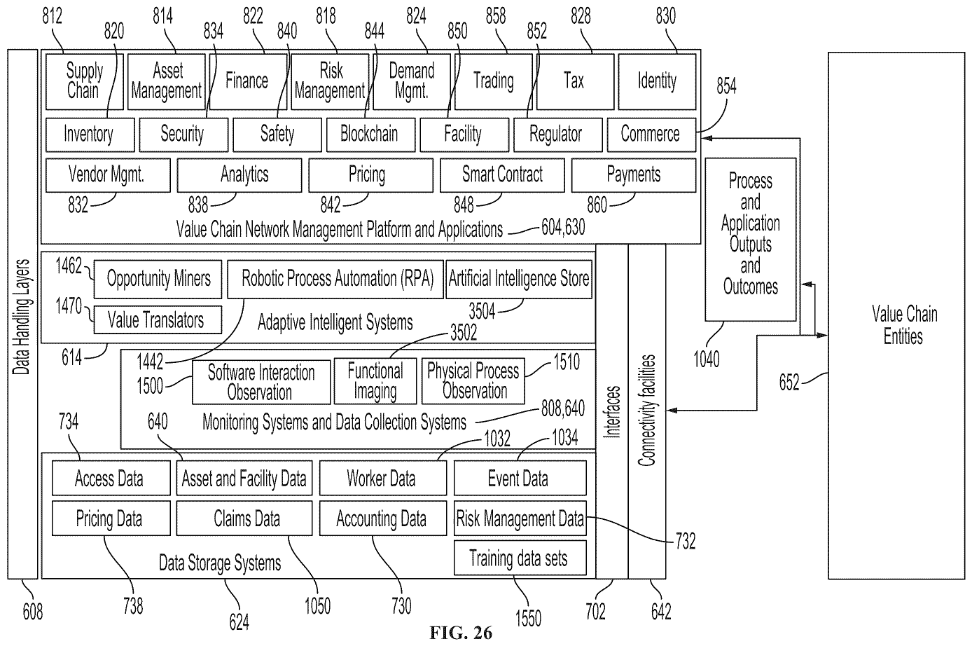

Referring to FIG. 26, a set of opportunity miners 1460 may be provided as part of the adaptive intelligence layer 614, which may be configured to seek and recommend opportunities to improve one or more of the elements of the platform 604, such as via addition of artificial intelligence 1160, automation (including robotic process automation 1442), or the like to one or more of the systems, sub-systems, components, applications or the like of the VCNP 102 or with which the VCNP 102 interacts. In embodiments, the opportunity miners 1460 may be configured or used by developers of AI or RPA solutions to find opportunities for better solutions and to optimize existing solutions in a value chain network 668. In embodiments, the opportunity miners 1460 may include a set of systems that collect information within the VCNP 102 and collect information within, about and for a set of value chain network entities 652 and environments, where the collected information has the potential to help identify and prioritize opportunities for increased automation and/or intelligence about the value chain network 668, about applications 630, about value chain network entities 652, or about the VCNP 102 itself. For example, the opportunity miners 1460 may include systems that observe clusters of value chain network workers by time, by type, and by location, such as using cameras, wearables, or other sensors, such as to identify labor-intensive areas and processes in a set of value chain network 668 environments. These may be presented, such as in a ranked or prioritized list, or in a visualization (such as a heat map showing dwell times of customers, workers or other individuals on a map of an environment or a heat map showing routes traveled by customers or workers within an environment) to show places with high labor activity. In embodiments, analytics 838 may be used to identify which environments or activities would most benefit from automation for purposes of improved delivery times, mitigation of congestion, and other performance improvements.

In embodiments, opportunity mining may include facilities for solicitation of appropriate training data sets that may be used to facilitate process automation. For example, certain kinds of inputs, if available, would provide very high value for automation, such as video data sets that capture very experienced and/or highly expert workers performing complex tasks. Opportunity miners 1460 may search for such video data sets as described herein; however, in the absence of success (or to supplement available data), the platform may include systems by which a user, such as a developer, may specify a desired type of data, such as software interaction data (such as of an expert working with a program to perform a particular task), video data (such as video showing a set of experts performing a certain kind of delivery process, packing process, picking process, a container movement process, or the like), and/or physical process observation data (such as video, sensor data, or the like). The resulting library of interactions captured in response to specification may be captured as a data set in the data storage layer 624, such as for consumption by various applications 630, adaptive intelligence systems 614, and other processes and systems. In embodiments, the library may include videos that are specifically developed as instructional videos, such as to facilitate developing an automation map that can follow instructions in the video, such as providing a sequence of steps according to a procedure or protocol, breaking down the procedure or protocol into sub-steps that are candidates for automation, and the like. In embodiments, such videos may be processed by natural language processing, such as to automatically develop a sequence of labeled instructions that can be used by a developer to facilitate a map, a graph, or other models of a process that assists with development of automation for the process. In embodiments, a specified set of training data sets may be configured to operate as inputs to learning. In such cases the training data may be time-synchronized with other data within the platform 604, such as outputs and outcomes from applications 630, outputs and outcomes of value chain entities 652, or the like, so that a given video of a process can be associated with those outputs and outcomes, thereby enabling feedback on learning that is sensitive to the outcomes that occurred when a given process that was captured (such as on video, or through observation of software interactions or physical process interactions). For example, this may relate to an instruction video such as a video of a person who may be building or rebuilding (e.g., rebuilding a bearing set). This instruction video may include individual steps for rebuild that may allow a staging of the training to provide instructions such as parsing the video into stages that mimic the experts staging in the video. For example, this may include tagging of the video to include references to each stage and status (e.g., stage one complete, stage two, etc.) This type of example may utilize artificial intelligence that may understand that there may be a series of sub-functions that add up to a final function.

In embodiments, opportunity miners 1460 may include methods, systems, processes, components, services and other elements for mining for opportunities for smart contract definition, formation, configuration and execution. Data collected within the platform 604, such as any data handled by the data handling layers 608, stored by the data storage layer 624, collected by the monitoring layer 614 and collection systems 640, collected about or from entities 652 or obtained from external sources may be used to recognize beneficial opportunities for application or configuration of smart contracts. For example, pricing information about an entity 652, handled by a pricing application 842, or otherwise collected, may be used to recognize situations in which the same item or items is disparately priced (in a spot market, futures market, or the like), and the opportunity miner 1460 may provide an alert indicating an opportunity for smart contract formation, such as a contract to buy in one environment at a price below a given threshold and sell in another environment at a price above a given threshold, or vice versa.

In some examples, as shown in FIG. 26, the adaptive intelligent systems 614 may include value translators 1470. The value translators 1470 may relate to demand side of transactions. Specifically, for example, the value translators 1470 may understand negative currencies of two marketplaces and may be able to translate value currencies into other currencies (e.g., not only fiat currencies that already have clear translation functions). In some examples, value translators 1470 may be associated with points of a point-based system (e.g., in a cost-based routing system). In an example embodiment, value translators 1470 may be loyalty points offered that may be convertible into airline seats and/or may translate to refund policies for staying in a hotel room. In some examples, different types of entities may be connected as having native pricing or cost functions that do not always use the same currency or any currency. In another example, value translators 1470 may be used with network prioritization or cost-based routing that happens in networks off of priorities where the point system in these cost-based routing systems is not monetary-based.

### Broad Management Platform

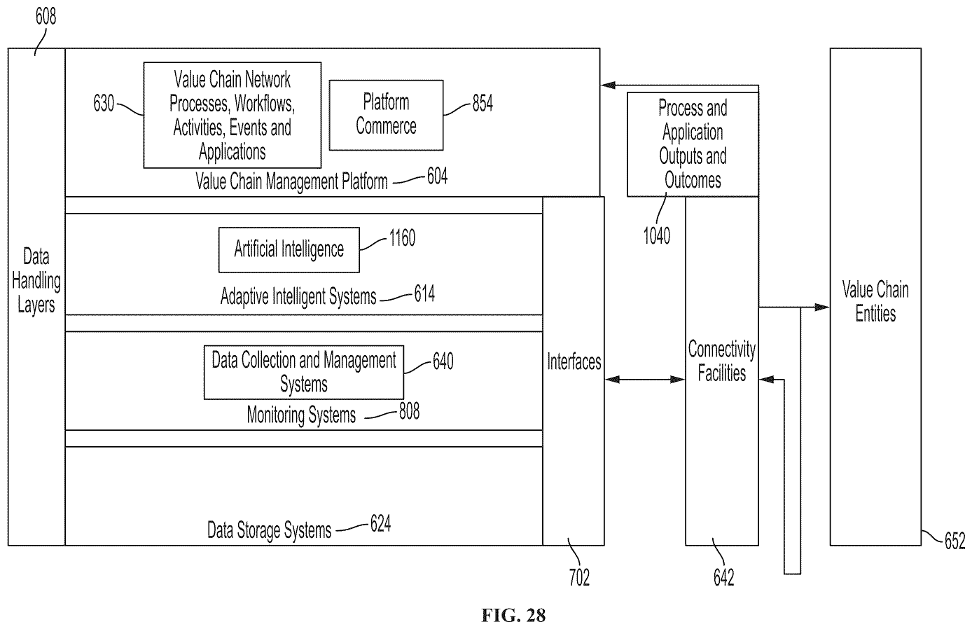

Referring to FIG. 28, additional details of an embodiment of the platform 604 are provided, in particular relating to an overall architecture for the platform 604. These may include, for the cloud-based management platform 604, employing a micro-services architecture, a set of network connectivity facilities 642 (which may include or connect to a set of interfaces 702 of various layers of the platform 604), a set of adaptive intelligence facilities or adaptive intelligent systems 614, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture; a set of interfaces, network connectivity facilities, adaptive intelligence facilities, data storage facilities, and monitoring facilities; and a set of applications for enabling an enterprise to manage a set of value chain network entities from a point of origin to a point of customer use.

Also provided herein are methods, systems, components and other elements for an information technology system that may include: a cloud-based management platform with a micro-services architecture, the platform having: a set of interfaces for accessing and configuring features of the platform; a set of network connectivity facilities for enabling a set of value chain network entities to connect to the platform; a set of adaptive intelligence facilities for automating a set of capabilities of the platform; a set of data storage facilities for storing data collected and handled by the platform; and a set of monitoring facilities for monitoring the value chain network entities; wherein the platform hosts a set of applications for enabling an enterprise to manage a set of value chain network entities from a point of origin of a product of the enterprise to a point of customer use.

### Broad Management Platform—Details

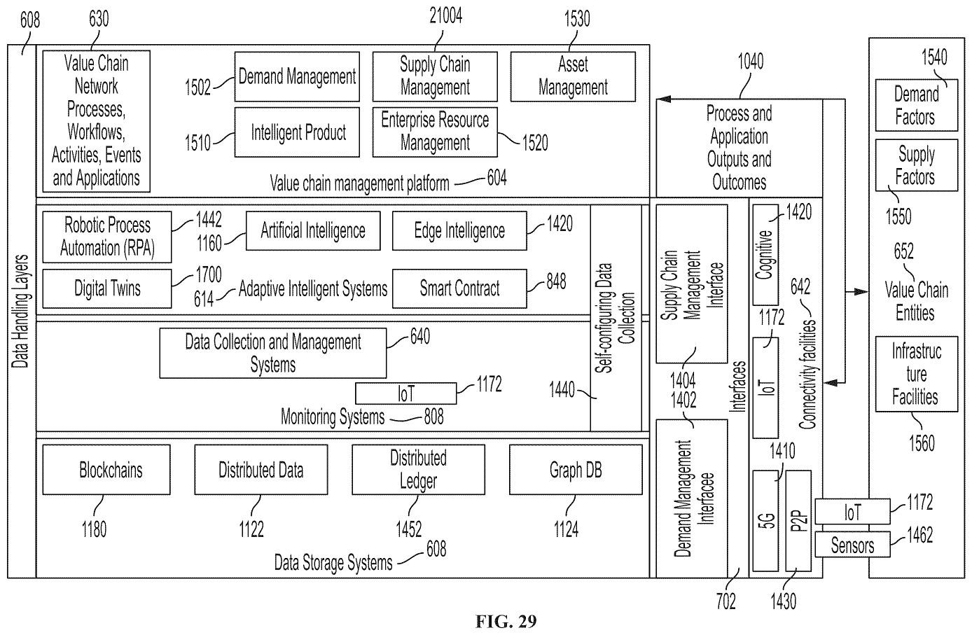

Referring to FIG. 29, additional details of an embodiment of the platform 604 are provided, in particular relating to an overall architecture for the platform 604. These may include, for the cloud-based management platform 604, employing a micro-services architecture, a set of network connectivity facilities 642 (which may include or connect to a set of interfaces 702 of various layers of the platform 604), a set of adaptive intelligence facilities or adaptive intelligent systems 614, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the set of interfaces 702 may include a demand management interface 1402 and a supply chain management interface 1404.

In embodiments, the set of network connectivity facilities 642 for enabling a set of value chain network entities 652 to connect to the platform 604 may include a 5G network system 1410, such as one that is deployed in a supply chain infrastructure facility operated by the enterprise.

In embodiments, the set of network connectivity facilities 642 for enabling a set of value chain network entities 652 to connect to the platform 604 may include an Internet of Things system 1172, such as one that is deployed in a supply chain infrastructure facility operated by the enterprise, in, on or near a value chain network entity 652, in a network system, and/or in a cloud computing environment (such as where data collection systems 640 are configured to collect and organize IoT data).

In embodiments, the set of network connectivity facilities 642 for enabling a set of value chain network entities 652 to connect to the VCNP 102 may include a cognitive networking system 1420 deployed in a supply chain infrastructure facility operated by the enterprise.

In embodiments, the set of network connectivity facilities 642 for enabling a set of value chain network entities 652 to connect to the VCNP 102 may include a peer-to-peer network system 1430, such as one that is deployed in a supply chain infrastructure facility operated by the enterprise.

In embodiments, the set of adaptive intelligence facilities or adaptive intelligent systems 614 for automating a set of capabilities of the platform 604 may include an edge intelligence system 1420, such as one that is deployed in a supply chain infrastructure facility operated by the enterprise.

In embodiments, the set of adaptive intelligence facilities or adaptive intelligent systems 614 for automating a set of capabilities of the platform 604 may include a robotic process automation system 1442.

In embodiments, the set of adaptive intelligence facilities or adaptive intelligent systems 614 for automating a set of capabilities of the platform 604 may include or may integrate with a self-configuring data collection system 1440, such as one that deployed in a supply chain infrastructure facility operated by the enterprise, one that is deployed in a network, and/or one that is deployed in a cloud computing environment. This may include elements of the data collection systems 640 of the data handling layers 608 that interact with or integrate with elements of the adaptive intelligent systems 614.

In embodiments, the set of adaptive intelligence facilities or adaptive intelligent systems 614 for automating a set of capabilities of the platform 604 may include a digital twin system 1700, such as one representing attributes of a set of value chain network entities, such as the ones controlled by an enterprise.

In embodiments, the set of adaptive intelligence facilities or adaptive intelligent systems 614 for automating a set of capabilities of the platform 604 may include a smart contract system 848, such as one for automating a set of interactions or transactions among a set of value chain network entities 652 based on status data, event data, or other data handled by the data handling layers 608.

In embodiments, the set of data storage facilities or data storage systems 624 for storing data collected and handled by the platform 604 uses a distributed data architecture 1122.

In embodiments, the set of data storage facilities for storing data collected and handled by the platform uses a blockchain 844.

In embodiments, the set of data storage facilities for storing data collected and handled by the platform uses a distributed ledger 1452.

In embodiments, the set of data storage facilities for storing data collected and handled by the platform uses graph database 1124 representing a set of hierarchical relationships of value chain network entities.

In embodiments, the set of monitoring facilities 614 for monitoring the value chain network entities 652 includes an Internet of Things monitoring system 1172, such as for collecting data from IoT systems and devices deployed throughout a value chain network.

In embodiments, the set of monitoring facilities 614 for monitoring the value chain network entities 652 includes a set of sensor systems 1462, such as ones deployed in a value chain environment or in, one or near a value chain network entity 652, such as in or on a product 1510.

In embodiments, the set of applications 614 includes a set of applications, which may include a variety of types from among, for example, a set of supply chain management applications 21004, demand management applications 1502, intelligent product applications 1510 and enterprise resource management applications 1520.

In embodiments, the set of applications includes an asset management application 1530.

In embodiments, the value chain network entities 652 as mentioned throughout this disclosure may include, for example, without limitation, products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, port infrastructure facilities, or others.

In embodiments, the platform 604 manages a set of demand factors 1540, a set of supply factors 1550 and a set of value chain infrastructure facilities 1560.

In embodiments, the supply factors 1550 as mentioned throughout this disclosure may include, for example and without limitation, ones involving component availability, material availability, component location, material location, component pricing, material pricing, taxation, tariff, impost, duty, import regulation, export regulation, border control, trade regulation, customs, navigation, traffic, congestion, vehicle capacity, ship capacity, container capacity, package capacity, vehicle availability, ship availability, container availability, package availability, vehicle location, ship location, container location, port location, port availability, port capacity, storage availability, storage capacity, warehouse availability, warehouse capacity, fulfillment center location, fulfillment center availability, fulfillment center capacity, asset owner identity, system compatibility, worker availability, worker competency, worker location, goods pricing, fuel pricing, energy pricing, route availability, route distance, route cost, route safety, and many others.

In embodiments, the demand factors 1540 as mentioned throughout this disclosure may include, for example and without limitation, ones involving product availability, product pricing, delivery timing, need for refill, need for replacement, manufacturer recall, need for upgrade, need for maintenance, need for update, need for repair, need for consumable, taste, preference, inferred need, inferred want, group demand, individual demand, family demand, business demand, need for workflow, need for process, need for procedure, need for treatment, need for improvement, need for diagnosis, compatibility to system, compatibility to product, compatibility to style, compatibility to brand, demographic, psychographic, geolocation, indoor location, destination, route, home location, visit location, workplace location, business location, personality, mood, emotion, customer behavior, business type, business activity, personal activity, wealth, income, purchasing history, shopping history, search history, engagement history, clickstream history, website history, online navigation history, group behavior, family behavior, family membership, customer identity, group identity, business identity, customer profile, business profile, group profile, family profile, declared interest, inferred interest, and many others.

In embodiments, the supply chain infrastructure facilities 1560 as mentioned throughout this disclosure may include, for example and without limitation, ship, container ship, boat, barge, maritime port, crane, container, container handling, shipyard, maritime dock, warehouse, distribution, fulfillment, fueling, refueling, nuclear refueling, waste removal, food supply, beverage supply, drone, robot, autonomous vehicle, aircraft, automotive, truck, train, lift, forklift, hauling facilities, conveyor, loading dock, waterway, bridge, tunnel, airport, depot, vehicle station, train station, weigh station, inspection, roadway, railway, highway, customs house, border control, and other facilities.

In embodiments, the set of applications 614 as mentioned throughout this disclosure may include, for example and without limitation, supply chain, asset management, risk management, inventory management, demand management, demand prediction, demand aggregation, pricing, positioning, placement, promotion, blockchain, smart contract, infrastructure management, facility management, analytics, finance, trading, tax, regulatory, identity management, commerce, ecommerce, payments, security, safety, vendor management, process management, compatibility testing, compatibility management, infrastructure testing, incident management, predictive maintenance, logistics, monitoring, remote control, automation, self-configuration, self-healing, self-organization, logistics, reverse logistics, waste reduction, augmented reality, virtual reality, mixed reality, demand customer profiling, entity profiling, enterprise profiling, worker profiling, workforce profiling, component supply policy management, product design, product configuration, product updating, product maintenance, product support, product testing, warehousing, distribution, fulfillment, kit configuration, kit deployment, kit support, kit updating, kit maintenance, kit modification, kit management, shipping fleet management, vehicle fleet management, workforce management, maritime fleet management, navigation, routing, shipping management, opportunity matching, search, advertisement, entity discovery, entity search, distribution, delivery, enterprise resource planning and other applications.

### Control Tower

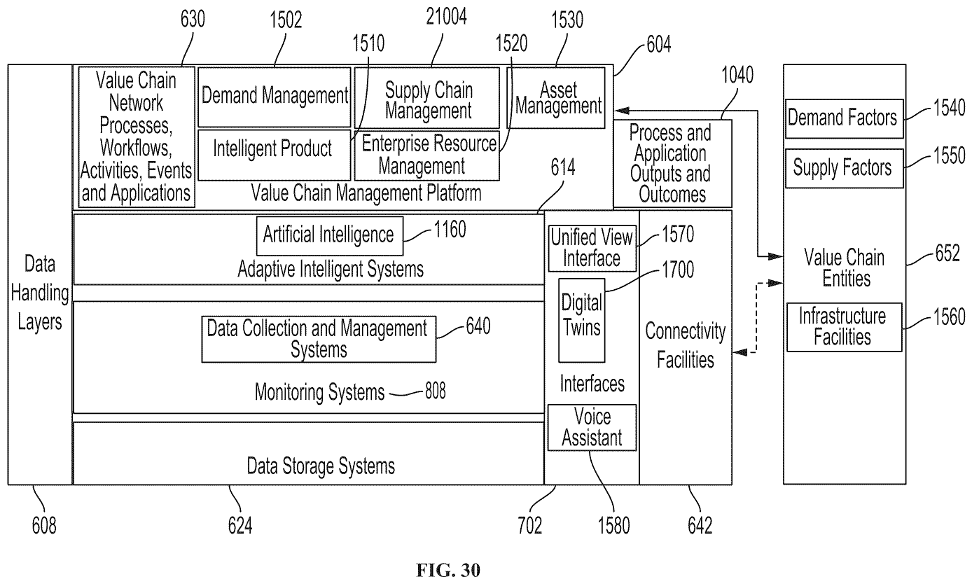

Referring to FIG. 30, an embodiment of the platform 604 is provided. The platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a user interface 1570 that provides a set of unified views for a set of demand management information and supply chain information for a category of goods, such as one that displays status information, event information, activity information, analytics, reporting, or other elements of, relating to, or produced by a set of supply chain management applications 21004, demand management applications 1502, intelligent product applications 1510 and enterprise resource management applications 1520 that monitor and/or manage a value chain network and a set of value chain network entities 652. The unified view interface 1570 may thus provide, in embodiments, a control tower for an enterprise over a range of assets, such as supply chain infrastructure facilities 1560 and other value chain network entities 652 that are involved as a product 1510 travels from a point of origin through distribution and retail channels to an environment where it is used by a customer. These may include views of demand factors 1540 and supply factors 1550, so that a user may develop insights about connections among the factors and control one or both of them with coordinated intelligence. Population of a set of unified views may be adapted over time, such as by learning on outcomes 1040 or other operations of the adaptive intelligent systems 614, such as to determine which views of the interface 1570 provide the most impactful insights, control features, or the like.

In embodiments, the user interface includes a voice operated assistant 1580.

In embodiments, the user interface includes a set of digital twins 1700 for presenting a visual representation of a set of attributes of a set of value chain network entities 652.

In embodiments, the user interface 1570 may include capabilities for configuring the adaptive intelligent systems 614 or adaptive intelligence facilities, such as to allow user selection of attributes, parameters, data sources, inputs to learning, feedback to learning, views, formats, arrangements, or other elements.

### Value Chain Management Platform—Control Tower UI for Demand Management and Supply Chain

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a user interface that provides a set of unified views for a set of demand management information and supply chain information for a category of goods.

### Unified Database

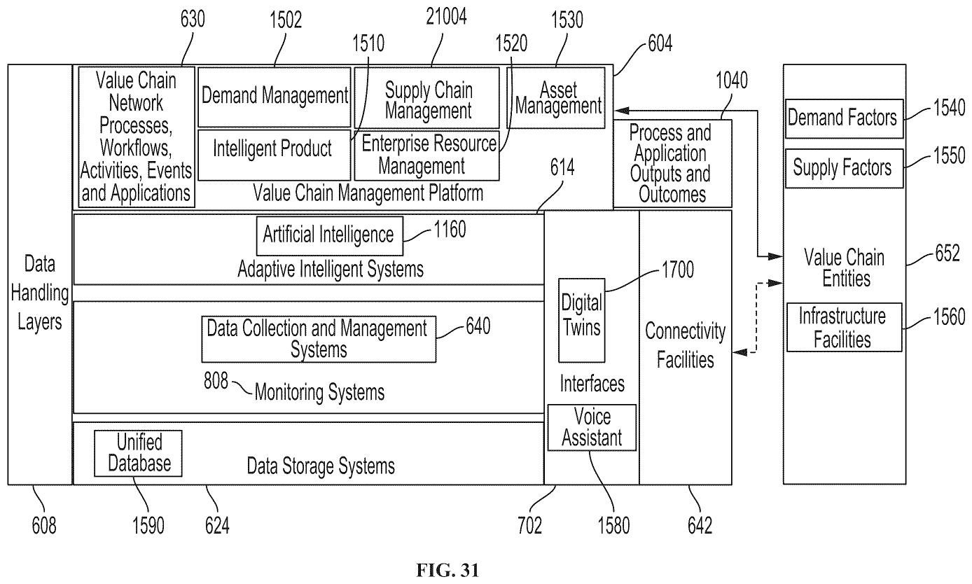

Referring to FIG. 31, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a unified database 1590 that supports a set of applications of multiple types, such as ones among a set of supply chain management applications 21004, demand management applications 1502, intelligent product applications 1510 and enterprise resource management applications 1520 that monitor and/or manage a value chain network and a set of value chain network entities 652. The unified database 1590 may thus provide, in embodiments, unification of data storage, access and handling for an enterprise over a range of assets, such as supply chain infrastructure facilities 1560 and other value chain network entities 652 that are involved as a product 1510 travels from a point of origin through distribution and retail channels to an environment where it is used by a customer. This unification may provide a number of advantages, including reduced need for data entry, consistency across applications 630, reduced latency (and better real-time reporting), reduced need for data transformation and integration, and others. These may include data relating to demand factors 1540 and supply factors 1550, so that an application 630 may benefit from information collected by, processed, or produced by other applications 630 of the platform 604 and a user can develop insights about connections among the factors and control one or both of them with coordinated intelligence. Population of the unified database 1590 may be adapted over time, such as by learning on outcomes 1040 or other operations of the adaptive intelligent systems 614, such as to determine which elements of the database 1590 should be made available to which applications, what data structures provide the most benefit, what data should be stored or cached for immediate retrieval, what data can be discarded versus saved, what data is most beneficial to support adaptive intelligent systems 614, and for other uses.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a unified database that supports a set of applications of at least two types from among a set of demand management applications, a set of supply chain applications, a set of intelligent product applications and a set of enterprise resource management applications for a category of goods.

In embodiments, the unified database that supports a set of demand management applications, a set of supply chain applications, a set of intelligent product applications and a set of enterprise resource management applications for a category of goods is a distributed database.

In embodiments, the unified database that supports a set of demand management applications, a set of supply chain applications, a set of intelligent product applications and a set of enterprise resource management applications for a category of goods uses a graph database architecture. In embodiments, the set of demand management applications includes a demand prediction application. In embodiments, the set of demand management applications includes a demand aggregation application. In embodiments, the set of demand management applications includes a demand activation application.

In embodiments, the set of supply chain management applications includes a vendor search application. In embodiments, the set of supply chain management applications includes a route configuration application. In embodiments, the set of supply chain management applications includes a logistics scheduling application.

### Unified Data Collection Systems

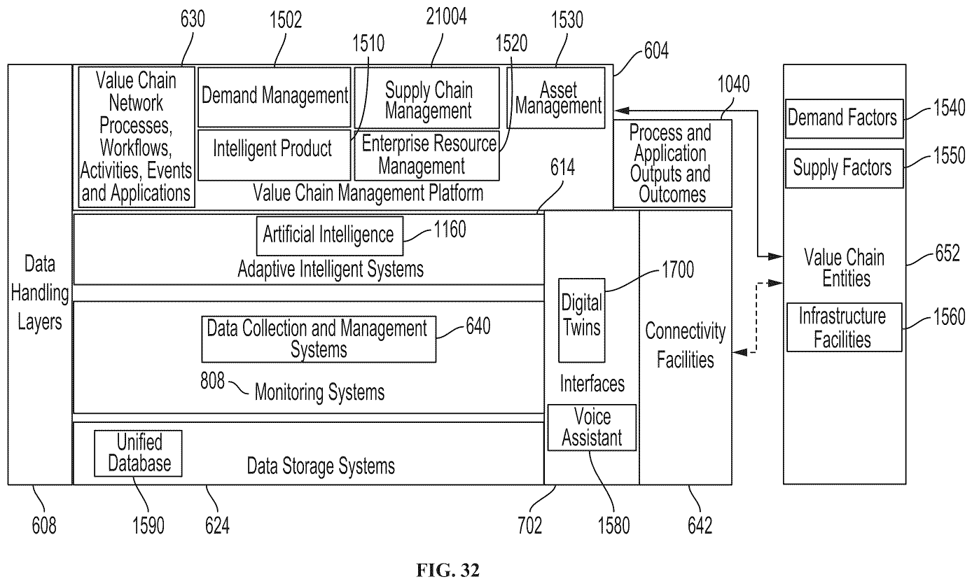

Referring to FIG. 32, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a set of unified set of data collection and management systems 640 of the set of monitoring facilities or systems 808 that support a set of applications 614 of various types, including a set of supply chain management applications 21004, demand management applications 1502, intelligent product applications 1510 and enterprise resource management applications 1520 that monitor and/or manage a value chain network and a set of value chain network entities 652. The unified data collection and management systems 640 may thus provide, in embodiments, unification of data monitoring, search, discovery, collection, access and handling for an enterprise or other user over a range of assets, such as supply chain infrastructure facilities 1560 and other value chain network entities 652 that are involved as a product 1510 travels from a point of origin through distribution and retail channels to an environment where it is used by a customer. This unification may provide a number of advantages, including reduced need for data entry, consistency across applications 630, reduced latency (and better real-time reporting), reduced need for data transformation and integration, and others. These may include collection of data relating to demand factors 1540 and supply factors 1550, so that an application 630 may benefit from information collected by, processed, or produced by other applications 630 of the platform 604 and a user can develop insights about connections among the factors and control one or both of them with coordinated intelligence. The unified data collection and management systems 640 may be adapted over time, such as by learning on outcomes 1040 or other operations of the adaptive intelligent systems 614, such as to determine which elements of the data collection and management systems 640 should be made available to which applications 630, what data types or sources provide the most benefit, what data should be stored or cached for immediate retrieval, what data can be discarded versus saved, what data is most beneficial to support adaptive intelligent systems 614, and for other uses. In example embodiments, the unified data collection and management systems 640 may use a unified data schema which relates data collection and management for various applications. This may be a single point of truth database at the most tightly bound or a set of distributed data systems that may follow a schema that may be sufficiently common enough that a wide variety of applications may consume the same data as received. For example, sensor data may be pulled from a smart product that may be consumed by a logistics application, a financial application, a demand prediction application, or a genetic programming artificial intelligence (AI) application to change the product, and the like. All of these applications may consume data from a data framework. In an example, this may occur from blockchains that may contain a distributed ledger or transactional data for purchase and sales or blockchains where there may be an indication of whether or not events had occurred. In some example embodiments, as data moves through a supply chain, this data flow may occur through distributed databases, relational databases, graph databases of all types, and the like that may be part of the unified data collection and management systems 640. In other examples, the unified data collection and management systems 640 may utilize memory that may be dedicated memory on an asset, in a tag or part of a memory structure of the device itself that may come from a robust pipeline tied to the value chain network entities. In other examples, the unified data collection and management systems 640 may use classic data integration capabilities that may include adapting protocols such that they can ultimately get to the unified system or schema.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a unified set of data collection systems that support a set of applications of at least two types from among a set of demand management applications, a set of supply chain applications, a set of intelligent product applications and a set of enterprise resource management applications for a category of goods.

In embodiments, the unified set of data collection systems includes a set of crowdsourcing data collection systems. In embodiments, the unified set of data collection systems includes a set of Internet of Things data collection systems. In embodiments, the unified set of data collection systems includes a set of self-configuring sensor systems. In embodiments, the unified set of data collection systems includes a set of data collection systems that interact with a network-connected product.

In embodiments, the unified set of data collection systems includes a set of mobile data collectors deployed in a set of value chain network environments operated by an enterprise. In embodiments, the unified set of data collection systems includes a set of edge intelligence systems deployed in set of value chain network environments operated by an enterprise. In embodiments, the unified set of data collection systems includes a set of crowdsourcing data collection systems. In embodiments, the unified set of data collection systems includes a set of Internet of Things data collection systems. In embodiments, the unified set of data collection systems includes a set of self-configuring sensor systems. In embodiments, the unified set of data collection systems includes a set of data collection systems that interact with a network-connected product. In embodiments, the unified set of data collection systems includes a set of mobile data collectors deployed in a set of value chain network environments operated by an enterprise. In embodiments, the unified set of data collection systems includes a set of edge intelligence systems deployed in a set of value chain network environments operated by an enterprise.

### Unified IoT Monitoring Systems

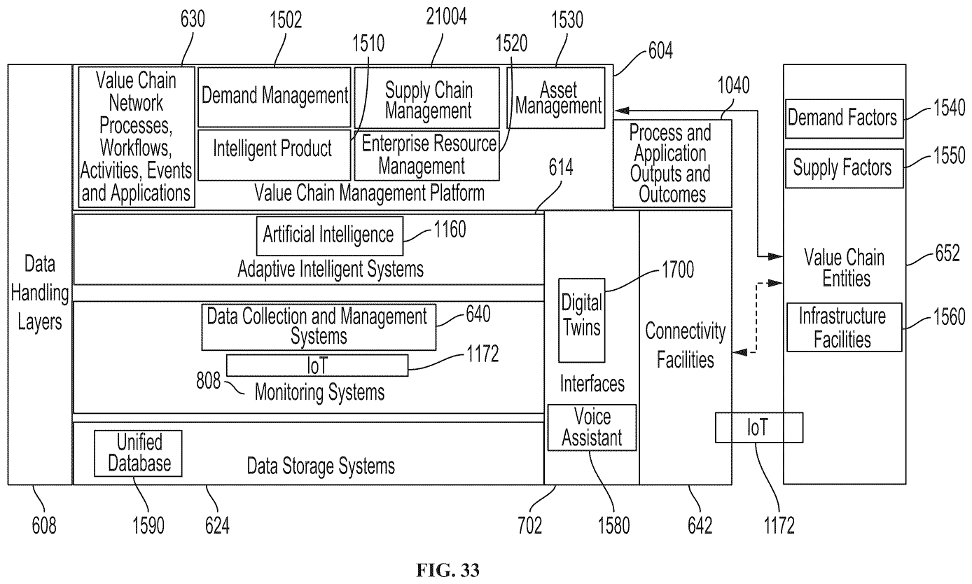

Referring to FIG. 33, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a unified set of Internet of Things systems 1172 that provide coordinated monitoring of various value chain entities 652 in service of a set of multiple applications 630 of various types, such as a set of supply chain management applications 21004, demand management applications 1502, intelligent product applications 1510 and enterprise resource management applications 1520 that monitor and/or manage a value chain network and a set of value chain network entities 652.

The unified set of Internet of Things systems 1172 may thus provide, in embodiments, unification of monitoring of, and communication with, a wide range of facilities, devices, systems, environments, and assets, such as supply chain infrastructure facilities 1560 and other value chain network entities 652 that are involved as a product 1510 travels from a point of origin through distribution and retail channels to an environment where it is used by a customer. This unification may provide a number of advantages, including reduced need for data entry, consistency across applications 630, reduced latency, real-time reporting and awareness, reduced need for data transformation and integration, and others. These may include Internet of Things systems 1172 that are used in connection with demand factors 1540 and supply factors 1550, so that an application 630 may benefit from information collected by, processed, or produced by the unified set of Internet of Things systems 1172 for other applications 630 of the platform 604, and a user can develop insights about connections among the factors and control one or both of them with coordinated intelligence. The unified set of Internet of Things systems 1172 may be adapted over time, such as by learning on outcomes 1040 or other operations of the adaptive intelligent systems 614, such as to determine which elements of the unified set of Internet of Things systems 1172 should be made available to which applications 630, what IoT systems 1172 provide the most benefit, what data should be stored or cached for immediate retrieval, what data can be discarded versus saved, what data is most beneficial to support adaptive intelligent systems 614, and for other uses. In some examples, the unified set of Internet of Things (IoT) systems 1172 may be IoT devices that may be installed in various environments. One goal of the unified set of Internet of Things systems 1172 may be coordination across a city or town involving citywide deployments where collectively a set of IoT devices may be connected by wide area network protocols (e.g., longer range protocols). In another example, the unified set of Internet of Things systems 1172 may involve connecting a mesh of devices across several different distribution facilities. The IoT devices may identify collection for each warehouse and the warehouses may use the IoT devices to communicate with each other. The IoT devices may be configured to process data without using the cloud.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications integrated with the platform for enabling an enterprise user of the platform to manage a set of value chain network entities from a point of origin to a point of customer use; and a unified set of Internet of Things systems that provide coordinated monitoring of a set of applications of at least two types from among a set of demand management applications, a set of supply chain applications, a set of intelligent product applications and a set of enterprise resource management applications for a category of goods.

In embodiments, the unified set of Internet of Things systems includes a set of smart home Internet of Things devices to enable monitoring of a set of demand factors and a set of Internet of Things devices deployed in proximity to a set of supply chain infrastructure facilities to enable monitoring of a set of supply factors.

In embodiments, the unified set of Internet of Things systems includes a set of workplace Internet of Things devices to enable monitoring of a set of demand factors for a set of business customers and a set of Internet of Things devices deployed in proximity to a set of supply chain infrastructure facilities to enable monitoring of a set of supply factors.

In embodiments, the unified set of Internet of Things systems includes a set of Internet of Things devices to monitor a set of consumer goods stores to enable monitoring of a set of demand factors for a set of consumers and a set of Internet of Things devices deployed in proximity to a set of supply chain infrastructure facilities to enable monitoring of a set of supply factors.

In embodiments, the Internet of Things systems as mentioned throughout this disclosure may include, for example and without limitations, camera systems, lighting systems, motion sensing systems, weighing systems, inspection systems, machine vision systems, environmental sensor systems, onboard sensor systems, onboard diagnostic systems, environmental control systems, sensor-enabled network switching and routing systems, RF sensing systems, magnetic sensing systems, pressure monitoring systems, vibration monitoring systems, temperature monitoring systems, heat flow monitoring systems, biological measurement systems, chemical measurement systems, ultrasonic monitoring systems, radiography systems, LIDAR-based monitoring systems, access control systems, penetrating wave sensing systems, SONAR-based monitoring systems, radar-based monitoring systems, computed tomography systems, magnetic resonance imaging systems, network monitoring systems, and many others.

### Machine Vision Feeding Digital Twin

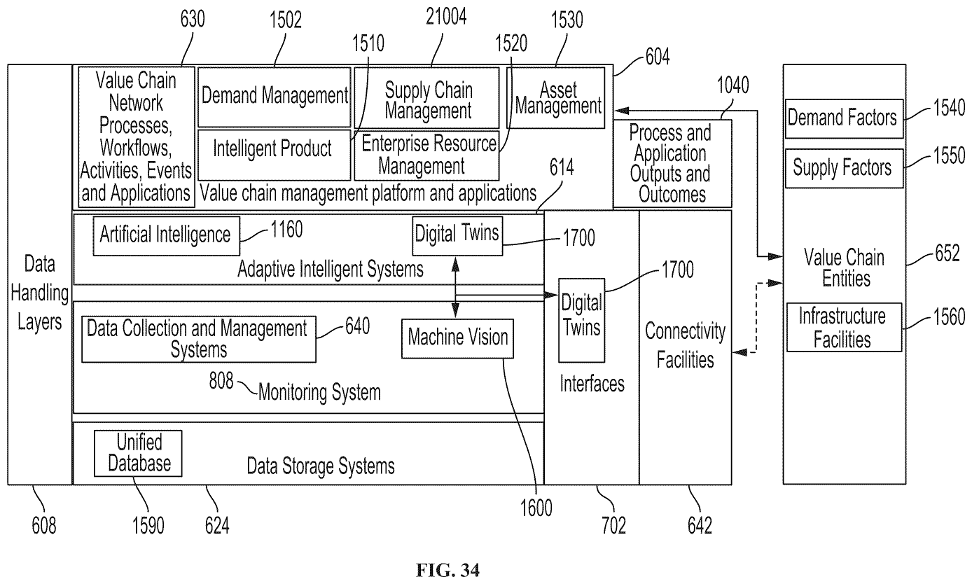

Referring to FIG. 34, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a machine vision system 1600 and a digital twin system 1700, wherein the machine vision system 1600 feeds data to the digital twin system 1700 (which may be enabled by a set of adaptive intelligent systems 614, including artificial intelligence 1160, and may be used as interfaces or components of interfaces 702, such as ones by which an operator may monitor twins 1700 of various value chain network entities 652). The machine vision system 1600 and digital twin system 1700 may operate in coordination for a set of multiple applications 630 of various types, such as a set of supply chain management applications 21004, demand management applications 1502, intelligent product applications 1510 and enterprise resource management applications 1520 that monitor and/or manage a value chain network and a set of value chain network entities 652.

The machine vision system 1600 and digital twin system 1700 may thus provide, in embodiments, image-based monitoring (with automated processing of image data) a wide range of facilities, devices, systems, environments, and assets, such as supply chain infrastructure facilities 1560 and other value chain network entities 652 that are involved as a product 1510 travels from a point of origin through distribution and retail channels to an environment where it is used by a customer, as well as representation of images, as well as extracted data from images, in a digital twin 1700. This unification may provide a number of advantages, including improved monitoring, improved visualization and insight, improved visibility, and others. These may include machine vision systems 1600 and digital twin systems 1700 that are used in connection with demand factors 1540 and supply factors 1550, so that an application 630 may benefit from information collected by, processed, or produced by the machine vision system 1600 and digital twin system 1700 for other applications 630 of the platform 604, and a user can develop insights about connections among the factors and control one or both of them with coordinated intelligence. The machine vision system 1600 and/or digital twin system 1700 may be adapted over time, such as by learning on outcomes 1040 or other operations of the adaptive intelligent systems 614, such as to determine which elements collected and/or processed by the machine vision system 1600 and/or digital twin system 1700 should be made available to which applications 630, what elements and/or content provide the most benefit, what data should be stored or cached for immediate retrieval, what data can be discarded versus saved, what data is most beneficial to support adaptive intelligent systems 614, and for other uses.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and for a set of applications of at least two types from among a set of supply chain applications, a set of demand management applications, a set of intelligent product applications and a set of enterprise resource management applications and having a machine vision system and a digital twin system, wherein the machine vision system feeds data to the digital twin system.

In embodiments, the set of supply chain applications and demand management applications is among any described throughout this disclosure or in the documents incorporated by reference herein.

In embodiments, the set of supply chain applications and demand management applications includes, for example and without limitation one or more involving inventory management, demand prediction, demand aggregation, pricing, blockchain, smart contract, positioning, placement, promotion, analytics, finance, trading, arbitrage, customer identity management, store planning, shelf-planning, customer route planning, customer route analytics, commerce, ecommerce, payments, customer relationship management, sales, marketing, advertising, bidding, customer monitoring, customer process monitoring, customer relationship monitoring, collaborative filtering, customer profiling, customer feedback, similarity analytics, customer clustering, product clustering, seasonality factor analytics, customer behavior tracking, customer behavior analytics, product design, product configuration, A/B testing, product variation analytics, augmented reality, virtual reality, mixed reality, customer demand profiling, customer mood, emotion or affect detection, customer mood, emotion of affect analytics, business entity profiling, customer enterprise profiling, demand matching, location-based targeting, location-based offering, point of sale interface, point of use interface, search, advertisement, entity discovery, entity search, enterprise resource planning, workforce management, customer digital twin, product pricing, product bundling, product and service bundling, product assortment, upsell offer configuration, customer feedback engagement, customer survey, or others.

In embodiments, the set of supply chain applications and demand management applications may include, without limitation, one or more of supply chain, asset management, risk management, inventory management, blockchain, smart contract, infrastructure management, facility management, analytics, finance, trading, tax, regulatory, identity management, commerce, ecommerce, payments, security, safety, vendor management, process management, compatibility testing, compatibility management, infrastructure testing, incident management, predictive maintenance, logistics, monitoring, remote control, automation, self-configuration, self-healing, self-organization, logistics, reverse logistics, waste reduction, augmented reality, virtual reality, mixed reality, supply chain digital twin, vendor profiling, supplier profiling, manufacturer profiling, logistics entity profiling, enterprise profiling, worker profiling, workforce profiling, component supply policy management, warehousing, distribution, fulfillment, shipping fleet management, vehicle fleet management, workforce management, maritime fleet management, navigation, routing, shipping management, opportunity matching, search, entity discovery, entity search, distribution, delivery, enterprise resource planning or other applications.

In embodiments, the set of supply chain applications and demand management applications may include, without limitation, one or more of asset management, risk management, inventory management, blockchain, smart contract, analytics, finance, trading, tax, regulatory, identity management, commerce, ecommerce, payments, security, safety, compatibility testing, compatibility management, incident management, predictive maintenance, monitoring, remote control, automation, self-configuration, self-healing, self-organization, waste reduction, augmented reality, virtual reality, mixed reality, product design, product configuration, product updating, product maintenance, product support, product testing, kit configuration, kit deployment, kit support, kit updating, kit maintenance, kit modification, kit management, product digital twin, opportunity matching, search, advertisement, entity discovery, entity search, variation, simulation, user interface, application programming interface, connectivity management, natural language interface, voice/speech interface, robotic interface, touch interface, haptic interface, vision system interface, enterprise resource planning, or other applications.

In embodiments, the set of supply chain applications and demand management applications may include, without limitation, one or more of operations, finance, asset management, supply chain management, demand management, human resource management, product management, risk management, regulatory and compliance management, inventory management, infrastructure management, facilities management, analytics, trading, tax, identity management, vendor management, process management, project management, operations management, customer relationship management, workforce management, incident management, research and development, sales management, marketing management, fleet management, opportunity analytics, decision support, strategic planning, forecasting, resource management, property management, or other applications.

In embodiments, the machine vision system includes an artificial intelligence system that is trained to recognize a type of value chain asset based on a labeled data set of images of such type of value chain assets.

In embodiments, the digital twin presents an indicator of the type of asset based on the output of the artificial intelligence system.

In embodiments, the machine vision system includes an artificial intelligence system that is trained to recognize a type of activity involving a set of value chain entities based on a labeled data set of images of such type of activity.

In embodiments, the digital twin presents an indicator of the type of activity based on the output of the artificial intelligence system.

In embodiments, the machine vision system includes an artificial intelligence system that is trained to recognize a safety hazard involving a value chain entity based on a training data set that includes a set of images of value chain network activities and a set of value chain network safety outcomes.

In embodiments, the digital twin presents an indicator of the hazard based on the output of the artificial intelligence system.

In embodiments, the machine vision system includes an artificial intelligence system that is trained to predict a delay based on a training data set that includes a set of images of value chain network activities and a set of value chain network timing outcomes.

In embodiments, the digital twin presents an indicator of a likelihood of delay based on the output of the artificial intelligence system.

As noted elsewhere herein and in documents incorporated by reference, artificial intelligence (such as any of the techniques or systems described throughout this disclosure) in connection with value chain network entities 652 and related processes and applications may be used to facilitate, among other things: (a) the optimization, automation and/or control of various functions, workflows, applications, features, resource utilization and other factors, (b) recognition or diagnosis of various states, entities, patterns, events, contexts, behaviors, or other elements; and/or (c) the forecasting of various states, events, contexts or other factors. As artificial intelligence improves, a large array of domain-specific and/or general artificial intelligence systems have become available and are likely to continue to proliferate. As developers seek solutions to domain-specific problems, such as ones relevant to value chain entities 652 and applications 630 described throughout this disclosure they face challenges in selecting artificial intelligence models (such as what set of neural networks, machine learning systems, expert systems, or the like to select) and in discovering and selecting what inputs may enable effective and efficient use of artificial intelligence for a given problem. As noted above, opportunity miners 1460 may assist with the discovery of opportunities for increased automation and intelligence; however, once opportunities are discovered, selection and configuration of an artificial intelligence solution still presents a significant challenge, one that is likely to continue to grow as artificial intelligence solutions proliferate.

One set of solutions to these challenges is an artificial intelligence store 3504 that is configured to enable collection, organization, recommendation and presentation of relevant sets of artificial intelligence systems based on one or more attributes of a domain and/or a domain-related problem. In embodiments, an artificial intelligence store 3504 may include a set of interfaces to artificial intelligence systems, such as enabling the download of relevant artificial intelligence applications, establishment of links or other connections to artificial intelligence systems (such as links to cloud-deployed artificial intelligence systems via APIs, ports, connectors, or other interfaces) and the like. The artificial intelligence store 3504 may include descriptive content with respect to each of a variety of artificial intelligence systems, such as metadata or other descriptive material indicating suitability of a system for solving particular types of problems (e.g., forecasting, NLP, image recognition, pattern recognition, motion detection, route optimization, or many others) and/or for operating on domain-specific inputs, data or other entities. In embodiments, the artificial intelligence store 3504 may be organized by category, such as domain, input types, processing types, output types, computational requirements and capabilities, cost, energy usage, and other factors. In embodiments, an interface to the application store 3504 may take input from a developer and/or from the platform (such as from an opportunity miner 1460) that indicates one or more attributes of a problem that may be addressed through artificial intelligence and may provide a set of recommendations, such as via an artificial intelligence attribute search engine, for a subset of artificial intelligence solutions that may represent favorable candidates based on the developer's domain-specific problem. Search results or recommendations may, in embodiments, be based at least in part on collaborative filtering, such as by asking developers to indicate or select elements of favorable models, as well as by clustering, such as by using similarity matrices, k-means clustering, or other clustering techniques that associate similar developers, similar domain-specific problems, and/or similar artificial intelligence solutions. The artificial intelligence store 3504 may include e-commerce features, such as ratings, reviews, links to relevant content, and mechanisms for provisioning, licensing, delivery and payment (including allocation of payments to affiliates and or contributors), including ones that operate using smart contract and/or blockchain features to automate purchasing, licensing, payment tracking, settlement of transactions, or other features.

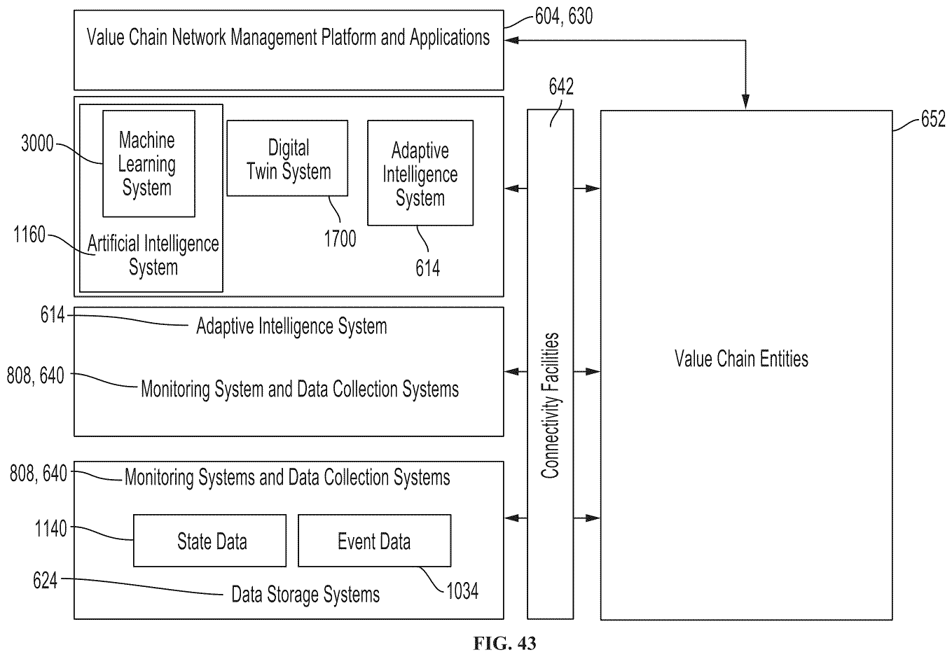

Referring to FIG. 43, the artificial intelligence system 1160 may define a machine learning model 3000 for performing analytics, simulation, decision making, and prediction making related to data processing, data analysis, simulation creation, and simulation analysis of one or more of the value chain entities 652. The machine learning model 3000 is an algorithm and/or statistical model that performs specific tasks without using explicit instructions, relying instead on patterns and inference. The machine learning model 3000 builds one or more mathematical models based on training data to make predictions and/or decisions without being explicitly programmed to perform the specific tasks. The machine learning model 3000 may receive inputs of sensor data as training data, including event data 1034 and state data 1140 related to one or more of the value chain entities 652. The sensor data input to the machine learning model 3000 may be used to train the machine learning model 3000 to perform the analytics, simulation, decision making, and prediction making relating to the data processing, data analysis, simulation creation, and simulation analysis of the one or more of the value chain entities 652. The machine learning model 3000 may also use input data from a user or users of the information technology system. The machine learning model 3000 may include an artificial neural network, a decision tree, a support vector machine, a Bayesian network, a genetic algorithm, any other suitable form of machine learning model, or a combination thereof. The machine learning model 3000 may be configured to learn through supervised learning, unsupervised learning, reinforcement learning, self-learning, feature learning, sparse dictionary learning, anomaly detection, association rules, a combination thereof, or any other suitable algorithm for learning.

The artificial intelligence system 1160 may also define the digital twin system 1700 to create a digital replica of one or more of the value chain entities 652. The digital replica of the one or more of the value chain entities 652 may use substantially real-time sensor data to provide for substantially real-time virtual representation of the value chain entity 652 and provides for simulation of one or more possible future states of the one or more value chain entities 652. The digital replica exists simultaneously with the one or more value chain entities 652 being replicated. The digital replica provides one or more simulations of both physical elements and properties of the one or more value chain entities 652 being replicated and the dynamics thereof, in embodiments, throughout the lifestyle of the one or more value chain entities 652 being replicated. The digital replica may provide a hypothetical simulation of the one or more value chain entities 652, for example during a design phase before the one or more value chain entities are constructed or fabricated, or during or after construction or fabrication of the one or more value chain entities by allowing for hypothetical extrapolation of sensor data to simulate a state of the one or more value chain entities 652, such as during high stress, after a period of time has passed during which component wear may be an issue, during maximum throughput operation, after one or more hypothetical or planned improvements have been made to the one or more value chain entities 652, or any other suitable hypothetical situation. In some embodiments, the machine learning model 3000 may automatically predict hypothetical situations for simulation with the digital replica, such as by predicting possible improvements to the one or more value chain entities 652, predicting when one or more components of the one or more value chain entities 652 may fail, and/or suggesting possible improvements to the one or more value chain entities 652, such as changes to timing settings, arrangement, components, or any other suitable change to the value chain entities 652. The digital replica allows for simulation of the one or more value chain entities 652 during both design and operation phases of the one or more value chain entities 652, as well as simulation of hypothetical operation conditions and configurations of the one or more value chain entities 652. The digital replica allows for invaluable analysis and simulation of the one or more value chain entities, by facilitating observation and measurement of nearly any type of metric, including temperature, wear, light, vibration, etc. not only in, on, and around each component of the one or more value chain entities 652, but in some embodiments within the one or more value chain entities 652. In some embodiments, the machine learning model 3000 may process the sensor data including the event data 1034 and the state data 1140 to define simulation data for use by the digital twin system 1700. The machine learning model 3000 may, for example, receive state data 1140 and event data 1034 related to a particular value chain entity 652 of the plurality of value chain entities 652 and perform a series of operations on the state data 1140 and the event data 1034 to format the state data 1140 and the event data 1034 into a format suitable for use by the digital twin system 1700 in creation of a digital replica of the value chain entity 652. For example, one or more value chain entities 652 may include a robot configured to augment products on an adjacent assembly line. The machine learning model 3000 may collect data from one or more sensors positioned on, near, in, and/or around the robot. The machine learning model 3000 may perform operations on the sensor data to process the sensor data into simulation data and output the simulation data to the digital twin system 1700. The digital twin simulation 1700 may use the simulation data to create one or more digital replicas of the robot, the simulation including for example metrics including temperature, wear, speed, rotation, and vibration of the robot and components thereof. The simulation may be a substantially real-time simulation, allowing for a human user of the information technology to view the simulation of the robot, metrics related thereto, and metrics related to components thereof, in substantially real time. The simulation may be a predictive or hypothetical situation, allowing for a human user of the information technology to view a predictive or hypothetical simulation of the robot, metrics related thereto, and metrics related to components thereof.

In some embodiments, the machine learning model 3000 and the digital twin system 1700 may process sensor data and create a digital replica of a set of value chain entities of the plurality of value chain entities 652 to facilitate design, real-time simulation, predictive simulation, and/or hypothetical simulation of a related group of value chain entities. The digital replica of the set of value chain entities may use substantially real-time sensor data to provide for substantially real-time virtual representation of the set of value chain entities and provide for simulation of one or more possible future states of the set of value chain entities. The digital replica exists simultaneously with the set of value chain entities being replicated. The digital replica provides one or more simulations of both physical elements and properties of the set of value chain entities being replicated and the dynamics thereof, in embodiments throughout the lifestyle of the set of value chain entities being replicated. The one or more simulations may include a visual simulation, such as a wire-frame virtual representation of the one or more value chain entities 652 that may be viewable on a monitor, using an augmented reality (AR) apparatus, or using a virtual reality (VR) apparatus. The visual simulation may be able to be manipulated by a human user of the information technology system, such as zooming or highlighting components of the simulation and/or providing an exploded view of the one or more value chain entities 652. The digital replica may provide a hypothetical simulation of the set of value chain entities, for example during a design phase before the one or more value chain entities are constructed or fabricated, or during or after construction or fabrication of the one or more value chain entities by allowing for hypothetical extrapolation of sensor data to simulate a state of the set of value chain entities, such as during high stress, after a period of time has passed during which component wear may be an issue, during maximum throughput operation, after one or more hypothetical or planned improvements have been made to the set of value chain entities, or any other suitable hypothetical situation. In some embodiments, the machine learning model 3000 may automatically predict hypothetical situations for simulation with the digital replica, such as by predicting possible improvements to the set of value chain entities, predicting when one or more components of the set of value chain entities may fail, and/or suggesting possible improvements to the set of value chain entities, such as changes to timing settings, arrangement, components, or any other suitable change to the value chain entities 652. The digital replica allows for simulation of the set of value chain entities during both design and operation phases of the set of value chain entities, as well as simulation of hypothetical operation conditions and configurations of the set of value chain entities. The digital replica allows for invaluable analysis and simulation of the one or more value chain entities, by facilitating observation and measurement of nearly any type of metric, including temperature, wear, light, vibration, etc. not only in, on, and around each component of the set of value chain entities, but in some embodiments within the set of value chain entities. In some embodiments, the machine learning model 3000 may process the sensor data including the event data 1034 and the state data 1140 to define simulation data for use by the digital twin system 1700. The machine learning model 3000 may, for example, receive state data 1140 and event data 1034 related to a particular value chain entity 652 of the plurality of value chain entities 652 and perform a series of operations on the state data 1140 and the event data 1034 to format the state data 1140 and the event data 1034 into a format suitable for use by the digital twin system 1700 in the creation of a digital replica of the set of value chain entities. For example, a set of value chain entities may include a die machine configured to place products on a conveyor belt, the conveyor belt on which the die machine is configured to place the products, and a plurality of robots configured to add parts to the products as they move along the assembly line. The machine learning model 3000 may collect data from one or more sensors positioned on, near, in, and/or around each of the die machines, the conveyor belt, and the plurality of robots. The machine learning model 3000 may perform operations on the sensor data to process the sensor data into simulation data and output the simulation data to the digital twin system 1700. The digital twin simulation 1700 may use the simulation data to create one or more digital replicas of the die machine, the conveyor belt, and the plurality of robots, the simulation including for example metrics including temperature, wear, speed, rotation, and vibration of the die machine, the conveyor belt, and the plurality of robots and components thereof. The simulation may be a substantially real-time simulation, allowing for a human user of the information technology to view the simulation of the die machine, the conveyor belt, and the plurality of robots, metrics related thereto, and metrics related to components thereof, in substantially real time. The simulation may be a predictive or hypothetical situation, allowing for a human user of the information technology to view a predictive or hypothetical simulation of the die machine, the conveyor belt, and the plurality of robots, metrics related thereto, and metrics related to components thereof.

In some embodiments, the machine learning model 3000 may prioritize collection of sensor data for use in digital replica simulations of one or more of the value chain entities 652. The machine learning model 3000 may use sensor data and user inputs to train, thereby learning which types of sensor data are most effective for creation of digital replicate simulations of one or more of the value chain entities 652. For example, the machine learning model 3000 may find that a particular value chain entity 652 has dynamic properties such as component wear and throughput affected by temperature, humidity, and load. The machine learning model 3000 may, through machine learning, prioritize collection of sensor data related to temperature, humidity, and load, and may prioritize processing sensor data of the prioritized type into simulation data for output to the digital twin system 1700. In some embodiments, the machine learning model 3000 may suggest to a user of the information technology system that more and/or different sensors of the prioritized type be implemented in the information technology and value chain system near and around the value chain entity 652 being simulation such that more and/or better data of the prioritized type may be used in simulation of the value chain entity 652 via the digital replica thereof.

In some embodiments, the machine learning model 3000 may be configured to learn to determine which types of sensor data are to be processed into simulation data for transmission to the digital twin system 1700 based on one or both of a modeling goal and a quality or type of sensor data. A modeling goal may be an objective set by a user of the information technology system or may be predicted or learned by the machine learning model 3000. Examples of modeling goals include creating a digital replica capable of showing dynamics of throughput on an assembly line, which may include collection, simulation, and modeling of, e.g., thermal, electrical power, component wear, and other metrics of a conveyor belt, an assembly machine, one or more products, and other components of the value chain. The machine learning model 3000 may be configured to learn to determine which types of sensor data are necessary to be processed into simulation data for transmission to the digital twin system 1700 to achieve such a model. In some embodiments, the machine learning model 3000 may analyze which types of sensor data are being collected, the quality and quantity of the sensor data being collected, and what the sensor data being collected represents, and may make decisions, predictions, analyses, and/or determinations related to which types of sensor data are and/or are not relevant to achieving the modeling goal and may make decisions, predictions, analyses, and/or determinations to prioritize, improve, and/or achieve the quality and quantity of sensor data being processed into simulation data for use by the digital twin system 1700 in achieving the modeling goal.

In some embodiments, a user of the information technology system may input a modeling goal into the machine learning model 3000. The machine learning model 3000 may learn to analyze training data to output suggestions to the user of the information technology system regarding which types of sensor data are most relevant to achieving the modeling goal, such as one or more types of sensors positioned in, on, or near a value chain entity or a plurality of value chain entities that is relevant to the achievement of the modeling goal is and/or are not sufficient for achieving the modeling goal, and how a different configuration of the types of sensors, such as by adding, removing, or repositioning sensors, may better facilitate achievement of the modeling goal by the machine learning model 3000 and the digital twin system 1700. In some embodiments, the machine learning model 3000 may automatically increase or decrease collection rates, processing, storage, sampling rates, bandwidth allocation, bitrates, and other attributes of sensor data collection to achieve or better achieve the modeling goal. In some embodiments, the machine learning model 3000 may make suggestions or predictions to a user of the information technology system related to increasing or decreasing collection rates, processing, storage, sampling rates, bandwidth allocation, bitrates, and other attributes of sensor data collection to achieve or better achieve the modeling goal. In some embodiments, the machine learning model 3000 may use sensor data, simulation data, previous, current, and/or future digital replica simulations of one or more value chain entities 652 of the plurality of value chain entities 652 to automatically create and/or propose modeling goals. In some embodiments, modeling goals automatically created by the machine learning model 3000 may be automatically implemented by the machine learning model 3000. In some embodiments, modeling goals automatically created by the machine learning model 3000 may be proposed to a user of the information technology system, and implemented only after acceptance and/or partial acceptance by the user, such as after modifications are made to the proposed modeling goal by the user.

In some embodiments, the user may input the one or more modeling goals, for example, by inputting one or more modeling commands to the information technology system. The one or more modeling commands may include, for example, a command for the machine learning model 3000 and the digital twin system 1700 to create a digital replica simulation of one value chain entity 652 or a set of value chain entities of the plurality of 652, may include a command for the digital replica simulation to be one or more of a real-time simulation, and a hypothetical simulation. The modeling command may also include, for example, parameters for what types of sensor data should be used, sampling rates for the sensor data, and other parameters for the sensor data used in the one or more digital replica simulations. In some embodiments, the machine learning model 3000 may be configured to predict modeling commands, such as by using previous modeling commands as training data. The machine learning model 3000 may propose predicted modeling commands to a user of the information technology system, for example, to facilitate simulation of one or more of the value chain entities 652 that may be useful for the management of the value chain entities 652 and/or to allow the user to easily identify potential issues with or possible improvements to the value chain entities 652.

In some embodiments, the machine learning model 3000 may be configured to evaluate a set of hypothetical simulations of one or more of the value chain entities 652. The set of hypothetical simulations may be created by the machine learning model 3000 and the digital twin system 1700 as a result of one or more modeling commands, as a result of one or more modeling goals, one or more modeling commands, by prediction by the machine learning model 3000, or a combination thereof. The machine learning model 3000 may evaluate the set of hypothetical simulations based on one or more metrics defined by the user, one or more metrics defined by the machine learning model 3000, or a combination thereof. In some embodiments, the machine learning model 3000 may evaluate each of the hypothetical simulations of the set of hypothetical simulations independently of one another. In some embodiments, the machine learning model 3000 may evaluate one or more of the hypothetical simulations of the set of hypothetical simulations in relation to one another, for example by ranking the hypothetical simulations or creating tiers of the hypothetical simulations based on one or more metrics.

In some embodiments, the machine learning model 3000 may include one or more model interpretability systems to facilitate human understanding of outputs of the machine learning model 3000, as well as information and insight related to cognition and processes of the machine learning model 3000, i.e., the one or more model interpretability systems allow for human understanding of not only “what” the machine learning model 3000 is outputting, but also “why” the machine learning model 3000 is outputting the outputs thereof, and what process led to the 3000 formulating the outputs. The one or more model interpretability systems may also be used by a human user to improve and guide training of the machine learning model 3000, to help debug the machine learning model 3000, to help recognize bias in the machine learning model 3000. The one or more model interpretability systems may include one or more of linear regression, logistic regression, a generalized linear model (GLM), a generalized additive model (GAM), a decision tree, a decision rule, RuleFit, Naïve Bayes Classifier, a K-nearest neighbors algorithm, a partial dependence plot, individual conditional expectation (ICE), an accumulated local effects (ALE) plot, feature interaction, permutation feature importance, a global surrogate model, a local surrogate (LIME) model, scoped rules, i.e., anchors, Shapley values, Shapley additive explanations (SHAP), feature visualization, network dissection, or any other suitable machine learning interpretability implementation. In some embodiments, the one or more model interpretability systems may include a model dataset visualization system. The model dataset visualization system is configured to automatically provide to a human user of the information technology system visual analysis related to distribution of values of the sensor data, the simulation data, and data nodes of the machine learning model 3000.

In some embodiments, the machine learning model 3000 may include and/or implement an embedded model interpretability system, such as a Bayesian case model (BCM) or glass box. The Bayesian case model uses Bayesian case-based reasoning, prototype classification, and clustering to facilitate human understanding of data such as the sensor data, the simulation data, and data nodes of the machine learning model 3000. In some embodiments, the model interpretability system may include and/or implement a glass box interpretability method, such as a Gaussian process, to facilitate human understanding of data such as the sensor data, the simulation data, and data nodes of the machine learning model 3000.

In some embodiments, the machine learning model 3000 may include and/or implement testing with concept activation vectors (TCAV). The TCAV allows the machine learning model 3000 to learn human-interpretable concepts, such as “running,” “not running,” “powered,” “not powered,” “robot,” “human,” “truck,” or “ship” from examples by a process including defining the concept, determining concept activation vectors, and calculating directional derivatives. By learning human-interpretable concepts, objects, states, etc., TCAV may allow the machine learning model 3000 to output useful information related to the value chain entities 652 and data collected therefrom in a format that is readily understood by a human user of the information technology system.

In some embodiments, the machine learning model 3000 may be and/or include an artificial neural network, e.g., a connectionist system configured to “learn” to perform tasks by considering examples and without being explicitly programmed with task-specific rules. The machine learning model 3000 may be based on a collection of connected units and/or nodes that may act like artificial neurons that may in some ways emulate neurons in a biological brain. The units and/or nodes may each have one or more connections to other units and/or nodes. The units and/or nodes may be configured to transmit information, e.g., one or more signals, to other units and/or nodes, process signals received from other units and/or nodes, and forward processed signals to other units and/or nodes. One or more of the units and/or nodes and connections therebetween may have one or more numerical “weights” assigned. The assigned weights may be configured to facilitate learning, i.e., training, of the machine learning model 3000. The weights assigned weights may increase and/or decrease one or more signals between one or more units and/or nodes, and in some embodiments may have one or more thresholds associated with one or more of the weights. The one or more thresholds may be configured such that a signal is only sent between one or more units and/or nodes, if a signal and/or aggregate signal crosses the threshold. In some embodiments, the units and/or nodes may be assigned to a plurality of layers, each of the layers having one or both of inputs and outputs. A first layer may be configured to receive training data, transform at least a portion of the training data, and transmit signals related to the training data and transformation thereof to a second layer. A final layer may be configured to output an estimate, conclusion, product, or other consequence of processing of one or more inputs by the machine learning model 3000. Each of the layers may perform one or more types of transformations, and one or more signals may pass through one or more of the layers one or more times. In some embodiments, the machine learning model 3000 may employ deep learning and being at least partially modeled and/or configured as a deep neural network, a deep belief network, a recurrent neural network, and/or a convolutional neural network, such as by being configured to include one or more hidden layers.

In some embodiments, the machine learning model 3000 may be and/or include a decision tree, e.g., a tree-based predictive model configured to identify one or more observations and determine one or more conclusions based on an input. The observations may be modeled as one or more “branches” of the decision tree, and the conclusions may be modeled as one or more “leaves” of the decision tree. In some embodiments, the decision tree may be a classification tree, the classification tree may include one or more leaves representing one or more class labels, and one or more branches representing one or more conjunctions of features configured to lead to the class labels. In some embodiments, the decision tree may be a regression tree. The regression tree may be configured such that one or more target variables may take continuous values.

In some embodiments, the machine learning model 3000 may be and/or include a support vector machine, e.g., a set of related supervised learning methods configured for use in one or both of classification and regression-based modeling of data. The support vector machine may be configured to predict whether a new example falls into one or more categories, the one or more categories being configured during training of the support vector machine.

In some embodiments, the machine learning model 3000 may be configured to perform regression analysis to determine and/or estimate a relationship between one or more inputs and one or more features of the one or more inputs. Regression analysis may include linear regression, wherein the machine learning model 3000 may calculate a single line to best fit input data according to one or more mathematical criteria.

In embodiments, inputs to the machine learning model 3000 (such as a regression model, Bayesian network, supervised model, or other type of model) may be tested, such as by using a set of testing data that is independent from the data set used for the creation and/or training of the machine learning model, such as to test the impact of various inputs to the accuracy of the model 3000. For example, inputs to the regression model may be removed, including single inputs, pairs of inputs, triplets, and the like, to determine whether the absence of inputs creates a material degradation of the success of the model 3000. This may assist with recognition of inputs that are in fact correlated (e.g., are linear combinations of the same underlying data), that are overlapping, or the like. Comparison of model success may help select among alternative input data sets that provide similar information, such as to identify the inputs (among several similar ones) that generate the least “noise” in the model, that provide the most impact on model effectiveness for the lowest cost, or the like. Thus, input variation and testing of the impact of input variation on model effectiveness may be used to prune or enhance model performance for any of the machine learning systems described throughout this disclosure.

In some embodiments, the machine learning model 3000 may be and/or include a Bayesian network. The Bayesian network may be a probabilistic graphical model configured to represent a set of random variables and conditional independence of the set of random variables. The Bayesian network may be configured to represent the random variables and conditional independence via a directed acyclic graph. The Bayesian network may include one or both of a dynamic Bayesian network and an influence diagram.

In some embodiments, the machine learning model 3000 may be defined via supervised learning, i.e., one or more algorithms configured to build a mathematical model of a set of training data containing one or more inputs and desired outputs. The training data may consist of a set of training examples, each of the training examples having one or more inputs and desired outputs, i.e., a supervisory signal. Each of the training examples may be represented in the machine learning model 3000 by an array and/or a vector, i.e., a feature vector. The training data may be represented in the machine learning model 3000 by a matrix. The machine learning model 3000 may learn one or more functions via iterative optimization of an objective function, thereby learning to predict an output associated with new inputs.

Once optimized, the objective function may provide the machine learning model 3000 with the ability to accurately determine an output for inputs other than inputs included in the training data. In some embodiments, the machine learning model 3000 may be defined via one or more supervised learning algorithms such as active learning, statistical classification, regression analysis, and similarity learning. Active learning may include interactively querying, by the machine learning model AILD102T, a user and/or an information source to label new data points with desired outputs. Statistical classification may include identifying, by the machine learning model 3000, to which a set of subcategories, i.e., subpopulations, a new observation belongs based on a training set of data containing observations having known categories. Regression analysis may include estimating, by the machine learning model 3000 relationships between a dependent variable, i.e., an outcome variable, and one or more independent variables, i.e., predictors, covariates, and/or features. Similarity learning may include learning, by the machine learning model 3000, from examples using a similarity function, the similarity function being designed to measure how similar or related two objects are.

In some embodiments, the machine learning model 3000 may be defined via unsupervised learning, i.e., one or more algorithms configured to build a mathematical model of a set of data containing only inputs by finding structure in the data such as grouping or clustering of data points. In some embodiments, the machine learning model 3000 may learn from test data, i.e., training data, that has not been labeled, classified, or categorized. The unsupervised learning algorithm may include identifying, by the machine learning model 3000, commonalities in the training data and learning by reacting based on the presence or absence of the identified commonalities in new pieces of data. In some embodiments, the machine learning model 3000 may generate one or more probability density functions. In some embodiments, the machine learning model 3000 may learn by performing cluster analysis, such as by assigning a set of observations into subsets, i.e., clusters, according to one or more predesignated criteria, such as according to a similarity metric of which internal compactness, separation, estimated density, and/or graph connectivity are factors.

In some embodiments, the machine learning model 3000 may be defined via semi-supervised learning, i.e., one or more algorithms using training data wherein some training examples may be missing training labels. The semi-supervised learning may be weakly supervised learning, wherein the training labels may be noisy, limited, and/or imprecise. The noisy, limited, and/or imprecise training labels may be cheaper and/or less labor intensive to produce, thus allowing the machine learning model 3000 to train on a larger set of training data for less cost and/or labor.

In some embodiments, the machine learning model 3000 may be defined via reinforcement learning, such as one or more algorithms using dynamic programming techniques such that the machine learning model 3000 may train by taking actions in an environment in order to maximize a cumulative reward. In some embodiments, the training data is represented as a Markov Decision Process.

In some embodiments, the machine learning model 3000 may be defined via self-learning, wherein the machine learning model 3000 is configured to train using training data with no external rewards and no external teaching, such as by employing a Crossbar Adaptive Array (CAA). The CAA may compute decisions about actions and/or emotions about consequence situations in a crossbar fashion, thereby driving teaching of the machine learning model 3000 by interactions between cognition and emotion.

In some embodiments, the machine learning model 3000 may be defined via feature learning, i.e., one or more algorithms designed to discover increasingly accurate and/or apt representations of one or more inputs provided during training, e.g., training data. Feature learning may include training via principal component analysis and/or cluster analysis. Feature learning algorithms may include attempting, by the machine learning model 3000, to preserve input training data while also transforming the input training data such that the transformed input training data is useful. In some embodiments, the machine learning model 3000 may be configured to transform the input training data prior to performing one or more classifications and/or predictions of the input training data. Thus, the machine learning model 3000 may be configured to reconstruct input training data from one or more unknown data-generating distributions without necessarily conforming to implausible configurations of the input training data according to the distributions. In some embodiments, the feature learning algorithm may be performed by the machine learning model 3000 in a supervised, unsupervised, or semi-supervised manner.

In some embodiments, the machine learning model 3000 may be defined via anomaly detection, i.e., by identifying rare and/or outlier instances of one or more items, events and/or observations. The rare and/or outlier instances may be identified by the instances differing significantly from patterns and/or properties of a majority of the training data. Unsupervised anomaly detection may include detecting of anomalies, by the machine learning model 3000, in an unlabeled training data set under an assumption that a majority of the training data is “normal.” Supervised anomaly detection may include training on a data set wherein at least a portion of the training data has been labeled as “normal” and/or “abnormal.”

In some embodiments, the machine learning model 3000 may be defined via robot learning. Robot learning may include generation, by the machine learning model 3000, of one or more curricula, the curricula being sequences of learning experiences, and cumulatively acquiring new skills via exploration guided by the machine learning model 3000 and social interaction with humans by the machine learning model 3000. Acquisition of new skills may be facilitated by one or more guidance mechanisms such as active learning, maturation, motor synergies, and/or imitation.

In some embodiments, the machine learning model 3000 can be defined via association rule learning. Association rule learning may include discovering relationships, by the machine learning model 3000, between variables in databases, in order to identify strong rules using some measure of “interestingness.” Association rule learning may include identifying, learning, and/or evolving rules to store, manipulate and/or apply knowledge. The machine learning model 3000 may be configured to learn by identifying and/or utilizing a set of relational rules, the relational rules collectively representing knowledge captured by the machine learning model 3000. Association rule learning may include one or more of learning classifier systems, inductive logic programming, and artificial immune systems. Learning classifier systems are algorithms that may combine a discovery component, such as one or more genetic algorithms, with a learning component, such as one or more algorithms for supervised learning, reinforcement learning, or unsupervised learning. Inductive logic programming may include rule-learning, by the machine learning model 3000, using logic programming to represent one or more of input examples, background knowledge, and hypothesis determined by the machine learning model 3000 during training. The machine learning model 3000 may be configured to derive a hypothesized logic program entailing all positive examples given an encoding of known background knowledge and a set of examples represented as a logical database of facts.

In embodiments, another set of solutions, which may be deployed alone or in connection with other elements of the platform, including the artificial intelligence store 3504, may include a set of functional imaging capabilities 3502, which may comprise monitoring systems 640 and in some cases physical process observation systems 1510 and/or software interaction observation systems 1500, such as for monitoring various value chain entities 652. Functional imaging systems 3502 may, in embodiments, provide considerable insight into the types of artificial intelligence that are likely to be most effective in solving particular types of problems most effectively. As noted elsewhere in this disclosure and in the documents incorporated by reference herein, computational and networking systems, as they grow in scale, complexity and interconnections, manifest problems of information overload, noise, network congestion, energy waste, and many others. As the Internet of Things grows to hundreds of billions of devices, and virtually countless potential interconnections, optimization becomes exceedingly difficult. One source for insight is the human brain, which faces similar challenges and has evolved, over millennia, reasonable solutions to a wide range of very difficult optimization problems. The human brain operates with a massive neural network organized into interconnected modular systems, each of which has a degree of adaptation to solve particular problems, from regulation of biological systems and maintenance of homeostasis, to detection of a wide range of static and dynamic patterns, to recognition of threats and opportunities, among many others. Functional imaging 3502, such as functional magnetic resonance imaging (fMRI), electroencephalogram (EEG), computed tomography (CT) and other brain imaging systems have improved to the point that patterns of brain activity can be recognized in real time and temporally associated with other information, such behaviors, stimulus information, environmental condition data, gestures, eye movements, and other information, such that via functional imaging, either alone or in combination with other information collected by monitoring systems 808, the platform may determine and classify what brain modules, operations, systems, and/or functions are employed during the undertaking of a set of tasks or activities, such as ones involving software interaction 1500, physical process observations 1510, or a combination thereof. This classification may assist in selection and/or configuration of a set of artificial intelligence solutions, such as from an artificial intelligence store 3504, that includes a similar set of capabilities and/or functions to the set of modules and functions of the human brain when undertaking an activity, such as for the initial configuration of a robotic process automation (RPA) system 1442 that automates a task performed by an expert human. Thus, the platform may include a system that takes input from a functional imaging system to configure, optionally automatically based on matching of attributes between one or more biological systems, such as brain systems, and one or more artificial intelligence systems, a set of artificial intelligence capabilities for a robotic process automation system. Selection and configuration may further comprise selection of inputs to robotic process automation and/or artificial intelligence that are configured at least in part based on functional imaging of the brain while workers undertake tasks, such as selection of visual inputs (such as images from cameras) where vision systems of the brain are highly activated, selection of acoustic inputs where auditory systems of the brain are highly activated, selection of chemical inputs (such as chemical sensors) where olfactory systems of the brain are highly activated, or the like. Thus, a biologically aware robotic process automation system may be improved by having initial configuration, or iterative improvement, be guided, either automatically or under developer control, by imaging-derived information collected as workers perform expert tasks that may benefit from automation.

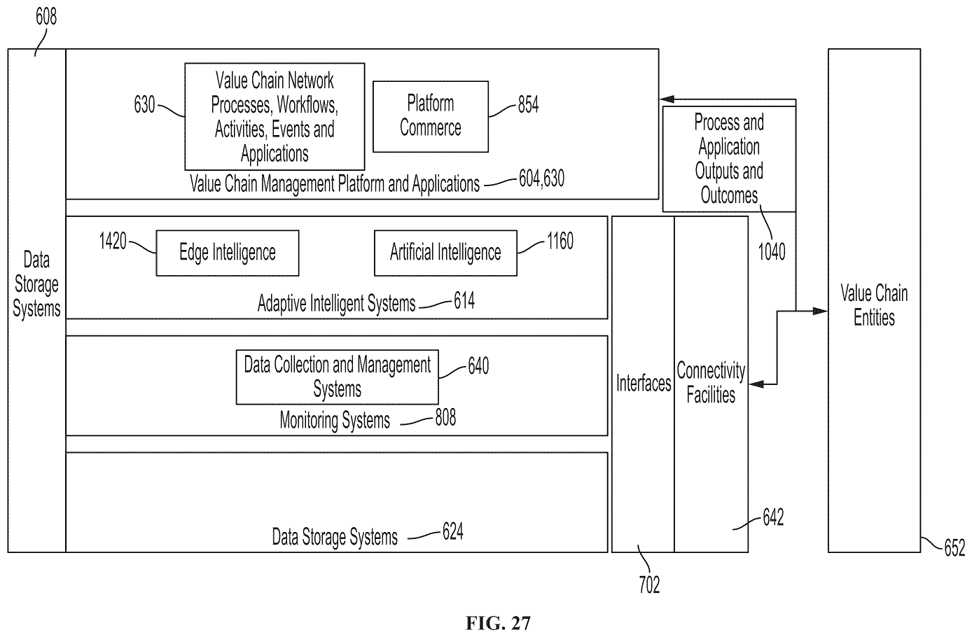

Referring to FIG. 27, additional details of an embodiment of the platform 604 are provided, in particular relating to elements of the adaptive intelligence layer 614 that facilitate improved edge intelligence, including the adaptive edge compute management system 1400 and the edge intelligence system 1420. These elements provide a set of systems that adaptively manage “edge” computation, storage and processing, such as by varying storage locations for data and processing locations (e.g., optimized by AI) between on-device storage, local systems, in the network and in the cloud. These elements enable facilitation of a dynamic definition by a user, such as a developer, operator, or host of the platform 102, of what constitutes the “edge” for purposes of a given application. For example, for environments where data connections are slow or unreliable (such as where a facility does not have good access to cellular networks (such as due to remoteness of some environments (such as in geographies with poor cellular network infrastructure), shielding or interference (such as where density of network-using systems, thick metals hulls of container ships, thick metal container walls, underwater or underground location, or presence of large metal objects (such as vaults, hulls, containers and the like) interferes with networking performance), and/or congestion (such as where there are many devices seeking access to limited networking facilities), edge computing capabilities can be defined and deployed to operate on the local area network of an environment, in peer-to-peer networks of devices, or on computing capabilities of local value chain entities 652. For example, in an environment with a limited set of computational and/or networking resources, tasks may be intelligently load balanced based on a current context (e.g., network availability, latency, congestion, and the like) and, in an example, one type of data may be prioritized for processing, or one workflow prioritized over another workflow, and the like. Where strong data connections are available (such as where good backhaul facilities exist), edge computing capabilities can be disposed in the network, such as for caching frequently used data at locations that improve input/output performance, reduce latency, or the like. Thus, adaptive definition and specification of where edge computing operations are enabled, under control of a developer or operator, or optionally determined automatically, such as by an expert system or automation system, such as based on detected network conditions for an environment, for a financial entity 652, or for a network as a whole.

In embodiments, edge intelligence 1420 enables adaptation of edge computation (including where computation occurs within various available networking resources, how networking occurs (such as by protocol selection), where data storage occurs, and the like) that is multi-application aware, such as accounting for QoS, latency requirements, congestion, and cost as understood and prioritized based on awareness of the requirements, the prioritization, and the value (including ROI, yield, and cost information, such as costs of failure) of edge computation capabilities across more than one application, including any combinations and subsets of the applications 630 described herein or in the documents incorporated herein by reference.

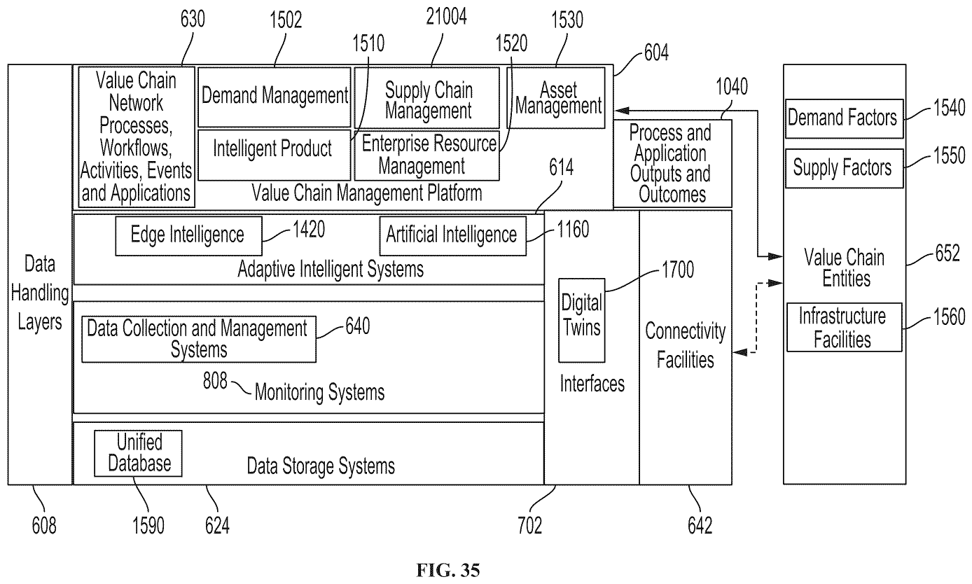

Referring to FIG. 35, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the platform 604 may include a unified set of adaptive edge computing and other edge intelligence systems 1420 that provide coordinated edge computation and other edge intelligence 1420 capabilities for a set of multiple applications 630 of various types, such as a set of supply chain management applications 21004, demand management applications 1502, intelligent product applications 1510 and enterprise resource management applications 1520 that monitor and/or manage a value chain network and a set of value chain network entities 652. In embodiments, edge intelligence capabilities of the systems and methods described herein may include, but are not limited to, on-premise edge devices and resources, such as local area network resources, and network edge devices, such as those deployed at the edge of a cellular network or within a peripheral data center, both of which may deploy edge intelligence, as described herein, to, for example, carry out intelligent processing tasks at these edge locations before transferring data or other matter, to the primary or core cellular network command or central data center.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a unified set of adaptive edge computing systems that provide coordinated edge computation for a set of applications of at least two types from among a set of demand management applications, a set of supply chain applications, a set of intelligent product applications and a set of enterprise resource management applications for a category of goods.

The adaptive edge computing and other edge intelligence systems 1420 may thus provide, in embodiments, intelligence for monitoring, managing, controlling, or otherwise handling a wide range of facilities, devices, systems, environments, and assets, such as supply chain infrastructure facilities 1560 and other value chain network entities 652 that are involved as a product 1510 travels from a point of origin through distribution and retail channels to an environment where it is used by a customer. This unification may provide a number of advantages, including improved monitoring, improved remote control, improved autonomy, improved prediction, improved classification, improved visualization and insight, improved visibility, and others. These may include adaptive edge computing and other edge intelligence systems 1420 that are used in connection with demand factors 1540 and supply factors 1550, so that an application 630 may benefit from information collected by, processed by, or produced by the adaptive edge computing and other edge intelligence systems 1420 for other applications 630 of the platform 604, and a user can develop insights about connections among the factors and control one or both of them with coordinated intelligence. For example, coordinated intelligence may include, but is not limited to, analytics and processing for monitoring data streams, as described herein, for the purposes of classification, prediction or some other type of analytic modeling. Such coordinated intelligence methods and systems may be applied in an automated manner in which differing combinations of intelligence assets are applied. As an example, within an industrial environment the coordinated intelligence system may monitor signals coming from machinery deployed in the environment. The coordinated intelligence system may classify, predict or perform some other intelligent analytics, in combination, for the purpose of, for example, determining a state of a machine, such as a machine in a deteriorated state, in an at-risk state, or some other state. The determination of a state may cause a control system to alter a control regime, for example, slowing or shutting down a machine that is in a deteriorating state. In embodiments, the coordinated intelligence system may coordinate across multiple entities of a value chain, supply chain and the like. For example, the monitoring of the deteriorating machine in the industrial environment may simultaneously occur with analytics related to parts suppliers and availability, product supply and inventory predictions, or some other coordinated intelligence operation. The adaptive edge computing and other edge intelligence systems 1420 may be adapted over time, such as by learning on outcomes 1040 or other operations of the other adaptive intelligent systems 614, such as to determine which elements collected and/or processed by the adaptive edge computing and other edge intelligence systems 1420 should be made available to which applications 630, what elements and/or content provide the most benefit, what data should be stored or cached for immediate retrieval, what data can be discarded versus saved, what data is most beneficial to support adaptive intelligent systems 614, and for other uses.

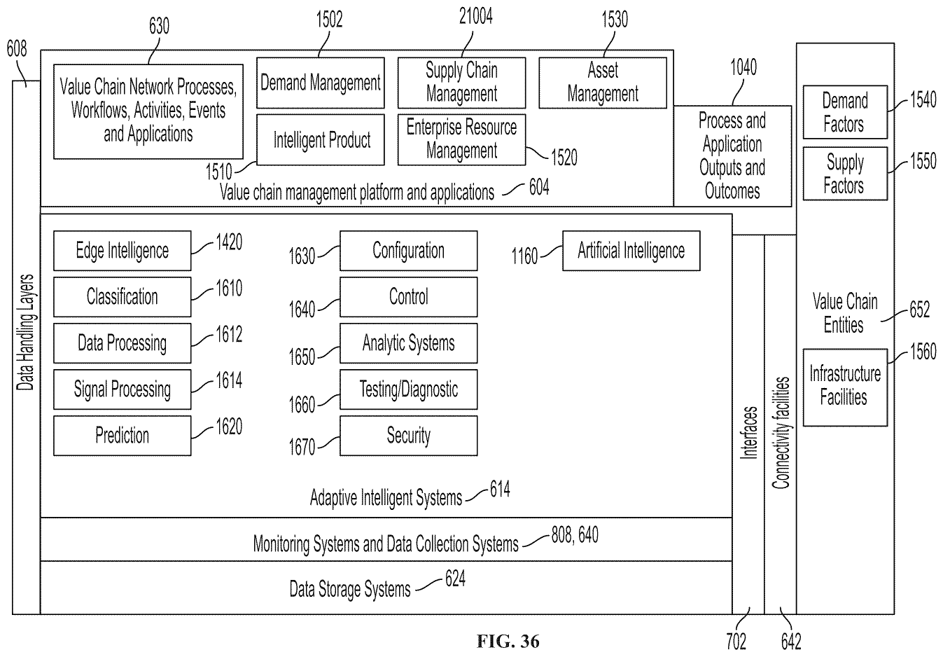

Referring to FIG. 36, in embodiments, the unified set of adaptive edge computing systems that provide coordinated edge computation include a wide range of systems, such as classification systems 1610 (such as image classification systems, object type recognition systems, and others), video processing systems 1612 (such as video compression systems), signal processing systems 1614 (such as analog-to-digital transformation systems, digital-to-analog transformation systems, RF filtering systems, analog signal processing systems, multiplexing systems, statistical signal processing systems, signal filtering systems, natural language processing systems, sound processing systems, ultrasound processing systems, and many others), data processing systems 1630 (such as data filtering systems, data integration systems, data extraction systems, data loading systems, data transformation systems, point cloud processing systems, data normalization systems, data cleansing system, data deduplication systems, graph-based data storage systems, object-oriented data storage systems, and others), predictive systems 1620 (such as motion prediction systems, output prediction systems, activity prediction systems, fault prediction systems, failure prediction systems, accident prediction systems, event predictions systems, event prediction systems, and many others), configuration systems 1630 (such as protocol selection systems, storage configuration systems, peer-to-peer network configuration systems, power management systems, self-configuration systems, self-healing systems, handshake negotiation systems, and others), artificial intelligence systems 1160 (such as clustering systems, variation systems, machine learning systems, expert systems, rule-based systems, deep learning systems, and many others), system management and control systems 1640 (such as autonomous control systems, robotic control systems, RF spectrum management systems, network resource management systems, storage management systems, data management systems, and others), robotic process automation systems, analytic and modeling systems 1650 (such as data visualization systems, clustering systems, similarity analysis systems, random forest systems, physical modeling systems, interaction modeling systems, simulation systems, and many others), entity discovery systems, security systems 1670 (such as cybersecurity systems, biometric systems, intrusion detection systems, firewall systems, and others), rules engine systems, workflow automation systems, opportunity discovery systems, testing and diagnostic systems 1660, software image propagation systems, virtualization systems, digital twin systems, Internet of Things monitoring systems, routing systems, switching systems, indoor location systems, geolocation systems, and others.

In embodiments, the interface is a user interface for a command center dashboard by which an enterprise orchestrates a set of value chain entities related to a type of product.

In embodiments, the interface is a user interface of a local management system located in an environment that hosts a set of value chain entities.

In embodiments, the local management system user interface facilitates configuration of a set of network connections for the adaptive edge computing systems.

In embodiments, the local management system user interface facilitates configuration of a set of data storage resources for the adaptive edge computing systems.

In embodiments, the local management system user interface facilitates configuration of a set of data integration capabilities for the adaptive edge computing systems.

In embodiments, the local management system user interface facilitates configuration of a set of machine learning input resources for the adaptive edge computing systems.

In embodiments, the local management system user interface facilitates configuration of a set of power resources that support the adaptive edge computing systems.

In embodiments, the local management system user interface facilitates configuration of a set of workflows that are managed by the adaptive edge computing systems.

In embodiments, the interface is a user interface of a mobile computing device that has a network connection to the adaptive edge computing systems.

In embodiments, the interface is an application programming interface.

In embodiments, the application programming interface facilitates exchange of data between the adaptive edge computing systems and a cloud-based artificial intelligence system.

In embodiments, the application programming interface facilitates exchange of data between the adaptive edge computing systems and a real-time operating system of a cloud data management platform.

In embodiments, the application programming interface facilitates exchange of data between the adaptive edge computing systems and a computational facility of a cloud data management platform.

In embodiments, the application programming interface facilitates exchange of data between the adaptive edge computing systems and a set of environmental sensors that collect data about an environment that hosts a set of value chain network entities.

In embodiments, the application programming interface facilitates exchange of data between the adaptive edge computing systems and a set of sensors that collect data about a product.

In embodiments, the application programming interface facilitates exchange of data between the adaptive edge computing systems and a set of sensors that collect data published by an intelligent product.

In embodiments, the application programming interface facilitates exchange of data between the adaptive edge computing systems and a set of sensors that collect data published by a set of Internet of Things systems that are disposed in an environment that hosts a set of value chain network entities.

In embodiments, the set of demand management applications, supply chain applications, intelligent product applications and enterprise resource management applications may include, for example, any of the applications mentioned throughout this disclosure or in the documents incorporated by reference herein.

### Unified Adaptive Intelligence

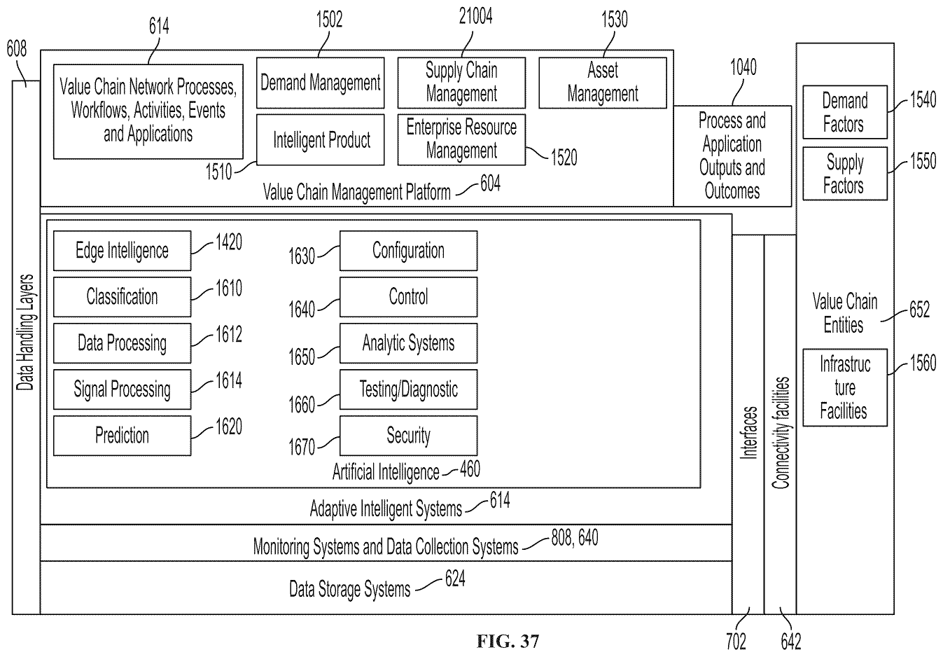

Referring to FIG. 37, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the VCNP 102 may include a unified set of adaptive intelligent systems 614 that provide coordinated intelligence for a set of various applications, such as demand management applications 1502, a set of supply chain applications 1500, a set of intelligent product applications 1510, a set of enterprise resource management applications 1520 and a set of asset management applications 1530 for a category of goods.

In embodiments, the unified set of adaptive intelligence systems include a wide variety of systems described throughout this disclosure and in the documents incorporated herein by reference, such as, without limitation, the edge intelligence systems 1420, classification systems 1610, data processing systems 1612, signal processing systems 1614, artificial intelligence systems 1160, prediction systems 1620, configuration systems 1630, control systems 1640, analytic systems 1650, testing/diagnostic systems 1660, security systems 1670 and other systems, whether used for edge intelligence or for intelligence within a network, within an application, or in the cloud, as well as to serve various layers of the platform 604. These include neural networks, deep learning systems, model-based systems, expert systems, machine learning systems, rule-based systems, opportunity miners, robotic process automation systems, data transformation systems, data extraction systems, data loading systems, genetic programming systems, image classification systems, video compression systems, analog-to-digital transformation systems, digital-to-analog transformation systems, signal analysis systems, RF filtering systems, motion prediction systems, object type recognition systems, point cloud processing systems, analog signal processing systems, signal multiplexing systems, data fusion systems, sensor fusion systems, data filtering systems, statistical signal processing systems, signal filtering systems, signal processing systems, protocol selection systems, storage configuration systems, power management systems, clustering systems, variation systems, machine learning systems, event prediction systems, autonomous control systems, robotic control systems, robotic process automation systems, data visualization systems, data normalization systems, data cleansing systems, data deduplication systems, graph-based data storage systems, intelligent agent systems, object-oriented data storage systems, self-configuration systems, self-healing systems, self-organizing systems, self-organizing map systems, cost-based routing systems, handshake negotiation systems, entity discovery systems, cybersecurity systems, biometric systems, natural language processing systems, speech processing systems, voice recognition systems, sound processing systems, ultrasound processing systems, artificial intelligence systems, rules engine systems, workflow automation systems, opportunity discovery systems, physical modeling systems, testing systems, diagnostic systems, software image propagation systems, peer-to-peer network configuration systems, RF spectrum management systems, network resource management systems, storage management systems, data management systems, intrusion detection systems, firewall systems, virtualization systems, digital twin systems, Internet of Things monitoring systems, routing systems, switching systems, indoor location systems, geolocation systems, parsing systems, semantic filtering systems, machine vision systems, fuzzy logic systems, recommendation systems, dialog management systems, and others.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a unified set of adaptive intelligence systems that provide coordinated intelligence for a set of demand management applications, a set of supply chain applications, a set of intelligent product applications and a set of enterprise resource management applications for a category of goods.

In embodiments, the unified set of adaptive intelligent systems includes a set of artificial intelligence systems. In embodiments, the unified set of adaptive intelligent systems includes a set of neural networks. In embodiments, the unified set of adaptive intelligent systems includes a set of deep learning systems. In embodiments, the unified set of adaptive intelligent systems includes a set of model-based systems.

In embodiments, the unified set of adaptive intelligent systems includes a set of expert systems. In embodiments, the unified set of adaptive intelligent systems includes a set of machine learning systems. In embodiments, the unified set of adaptive intelligent systems includes a set of rule-based systems. In embodiments, the unified set of adaptive intelligent systems includes a set of opportunity miners.

In embodiments, the unified set of adaptive intelligent systems includes a set of robotic process automation systems. In embodiments, the unified set of adaptive intelligent systems includes a set of data transformation systems. In embodiments, the unified set of adaptive intelligent systems includes a set of data extraction systems. In embodiments, the unified set of adaptive intelligent systems includes a set of data loading systems. In embodiments, the unified set of adaptive intelligent systems includes a set of genetic programming systems.

In embodiments, the unified set of adaptive intelligent systems includes a set of image classification systems. In embodiments, the unified set of adaptive intelligent systems includes a set of video compression systems. In embodiments, the unified set of adaptive intelligent systems includes a set of analog-to-digital transformation systems. In embodiments, the unified set of adaptive intelligent systems includes a set of digital-to-analog transformation systems. In embodiments, the unified set of adaptive intelligent systems includes a set of signal analysis systems.

In embodiments, the unified set of adaptive intelligent systems includes a set of RF filtering systems. In embodiments, the unified set of adaptive intelligent systems includes a set of motion prediction systems. In embodiments, the unified set of adaptive intelligent systems includes a set of object type recognition systems. In embodiments, the unified set of adaptive intelligent systems includes a set of point cloud processing systems. In embodiments, the unified set of adaptive intelligent systems includes a set of analog signal processing systems.

In embodiments, the unified set of adaptive intelligent systems includes a set of signal multiplexing systems. In embodiments, the unified set of adaptive intelligent systems includes a set of data fusion systems. In embodiments, the unified set of adaptive intelligent systems includes a set of sensor fusion systems. In embodiments, the unified set of adaptive intelligent systems includes a set of data filtering systems. In embodiments, the unified set of adaptive intelligent systems includes a set of statistical signal processing systems.

In embodiments, the unified set of adaptive intelligent systems includes a set of signal filtering systems. In embodiments, the unified set of adaptive intelligent systems includes a set of signal processing systems. In embodiments, the unified set of adaptive intelligent systems includes a set of protocol selection systems. In embodiments, the unified set of adaptive intelligent systems includes a set of storage configuration systems. In embodiments, the unified set of adaptive intelligent systems includes a set of power management systems.

In embodiments, the unified set of adaptive intelligent systems includes a set of clustering systems. In embodiments, the unified set of adaptive intelligent systems includes a set of variation systems. In embodiments, the unified set of adaptive intelligent systems includes a set of machine learning systems. In embodiments, the unified set of adaptive intelligent systems includes a set of event prediction systems. In embodiments, the unified set of adaptive intelligent systems includes a set of autonomous control systems.

In embodiments, the unified set of adaptive intelligent systems includes a set of robotic control systems. In embodiments, the unified set of adaptive intelligent systems includes a set of robotic process automation systems. In embodiments, the unified set of adaptive intelligent systems includes a set of data visualization systems. In embodiments, the unified set of adaptive intelligent systems includes a set of data normalization systems. In embodiments, the unified set of adaptive intelligent systems includes a set of data cleansing systems.

In embodiments, the unified set of adaptive intelligent systems includes a set of data deduplication systems. In embodiments, the unified set of adaptive intelligent systems includes a set of graph-based data storage systems. In embodiments, the unified set of adaptive intelligent systems includes a set of intelligent agent systems. In embodiments, the unified set of adaptive intelligent systems includes a set of object-oriented data storage systems.

In embodiments, the unified set of adaptive intelligent systems includes a set of self-configuration systems. In embodiments, the unified set of adaptive intelligent systems includes a set of self-healing systems. In embodiments, the unified set of adaptive intelligent systems includes a set of self-organizing systems. In embodiments, the unified set of adaptive intelligent systems includes a set of self-organizing map systems.

In embodiments, the unified set of adaptive intelligent systems includes a set of cost-based routing systems. In embodiments, the unified set of adaptive intelligent systems includes a set of handshake negotiation systems. In embodiments, the unified set of adaptive intelligent systems includes a set of entity discovery systems. In embodiments, the unified set of adaptive intelligent systems includes a set of cybersecurity systems.

In embodiments, the unified set of adaptive intelligent systems includes a set of biometric systems. In embodiments, the unified set of adaptive intelligent systems includes a set of natural language processing systems. In embodiments, the unified set of adaptive intelligent systems includes a set of speech processing systems. In embodiments, the unified set of adaptive intelligent systems includes a set of voice recognition systems.

In embodiments, the unified set of adaptive intelligent systems includes a set of sound processing systems. In embodiments, the unified set of adaptive intelligent systems includes a set of ultrasound processing systems. In embodiments, the unified set of adaptive intelligent systems includes a set of artificial intelligence systems. In embodiments, the unified set of adaptive intelligent systems includes a set of rules engine systems.

In embodiments, the unified set of adaptive intelligent systems includes a set of workflow automation systems. In embodiments, the unified set of adaptive intelligent systems includes a set of opportunity discovery systems. In embodiments, the unified set of adaptive intelligent systems includes a set of physical modeling systems. In embodiments, the unified set of adaptive intelligent systems includes a set of testing systems.

In embodiments, the unified set of adaptive intelligent systems includes a set of diagnostic systems. In embodiments, the unified set of adaptive intelligent systems includes a set of software image propagation systems. In embodiments, the unified set of adaptive intelligent systems includes a set of peer-to-peer network configuration systems. In embodiments, the unified set of adaptive intelligent systems includes a set of RF spectrum management systems.

In embodiments, the unified set of adaptive intelligent systems includes a set of network resource management systems. In embodiments, the unified set of adaptive intelligent systems includes a set of storage management systems. In embodiments, the unified set of adaptive intelligent systems includes a set of data management systems. In embodiments, the unified set of adaptive intelligent systems includes a set of intrusion detection systems.

In embodiments, the unified set of adaptive intelligent systems includes a set of firewall systems. In embodiments, the unified set of adaptive intelligent systems includes a set of virtualization systems. In embodiments, the unified set of adaptive intelligent systems includes a set of digital twin systems. In embodiments, the unified set of adaptive intelligent systems includes a set of Internet of Things monitoring systems.

In embodiments, the unified set of adaptive intelligent systems includes a set of routing systems. In embodiments, the unified set of adaptive intelligent systems includes a set of switching systems. In embodiments, the unified set of adaptive intelligent systems includes a set of indoor location systems. In embodiments, the unified set of adaptive intelligent systems includes a set of geolocation systems.

In embodiments, the unified set of adaptive intelligent systems includes a set of parsing systems. In embodiments, the unified set of adaptive intelligent systems includes a set of semantic filtering systems. In embodiments, the unified set of adaptive intelligent systems includes a set of machine vision systems. In embodiments, the unified set of adaptive intelligent systems includes a set of fuzzy logic systems.

In embodiments, the unified set of adaptive intelligent systems includes a set of recommendation systems. In embodiments, the unified set of adaptive intelligent systems includes a set of dialog management systems. In embodiments, the set of interfaces includes a demand management interface and a supply chain management interface. In embodiments, the interface is a user interface for a command center dashboard by which an enterprise orchestrates a set of value chain entities related to a type of product.

In embodiments, the interface is a user interface of a local management system located in an environment that hosts a set of value chain entities. In embodiments, the local management system user interface facilitates configuration of a set of network connections for the adaptive intelligence systems. In embodiments, the local management system user interface facilitates configuration of a set of data storage resources for the adaptive intelligence systems. In embodiments, the local management system user interface facilitates configuration of a set of data integration capabilities for the adaptive intelligence systems.

In embodiments, the local management system user interface facilitates configuration of a set of machine learning input resources for the adaptive intelligence systems. In embodiments, the local management system user interface facilitates configuration of a set of power resources that support the adaptive intelligence systems. In embodiments, the local management system user interface facilitates configuration of a set of workflows that are managed by the adaptive intelligence systems.

In embodiments, the interface is a user interface of a mobile computing device that has a network connection to the adaptive intelligence systems.

In embodiments, the interface is an application programming interface. In embodiments, the application programming interface facilitates exchange of data between the adaptive intelligence systems and a cloud-based artificial intelligence system. In embodiments, the application programming interface facilitates exchange of data between the adaptive intelligence systems and a real-time operating system of a cloud data management platform.

In embodiments, the application programming interface facilitates exchange of data between the adaptive intelligence systems and a computational facility of a cloud data management platform.

In embodiments, the application programming interface facilitates exchange of data between the adaptive intelligence systems and a set of environmental sensors that collect data about an environment that hosts a set of value chain network entities. In embodiments, the application programming interface facilitates exchange of data between the adaptive intelligence systems and a set of sensors that collect data about a product.

In embodiments, the application programming interface facilitates exchange of data between the adaptive intelligence systems and a set of sensors that collect data published by an intelligent product.

In embodiments, the application programming interface facilitates exchange of data between the adaptive intelligence systems and a set of sensors that collect data published by a set of Internet of Things systems that are disposed in an environment that hosts a set of value chain network entities.

In embodiments, the set of demand management applications, supply chain applications, intelligent product applications and enterprise resource management applications may include, any of the applications mentioned throughout this disclosure or the documents incorporated herein by reference.

In embodiments, the adaptive intelligent systems layer 614 is configured to train and deploy artificial intelligence systems to perform value-chain related tasks. For example, the adaptive intelligent systems layer 614 may be leveraged to manage a container fleet, design a logistics system, control one or more aspects of a logistics system, select packaging attributes of packages in the value chain, design a process to meet regulatory requirements, automate processes to mitigate waste production (e.g., solid waste or waste water), and/or other suitable tasks related to the value-chain.

In some of these embodiments, one or more digital twins may be leveraged by the adaptive intelligent systems layer 614. A digital twin may refer to a digital representation of a physical object (e.g., an asset, a device, a product, a package, a container, a vehicle, a ship, or the like), an environment (e.g., a facility), an individual (e.g., a customer or worker), or other entity (including any of the value chain network entities 652 described herein), or combination thereof. Further examples of physical assets include containers (e.g., boxes, shipping containers, boxes, palates, barrels, and the like), goods/products (e.g., widgets, food, household products, toys, clothing, water, gas, oil, equipment, and the like), components (e.g., chips, boards, screens, chipsets, wires, cables, cards, memory, software components, firmware, parts, connectors, housings, and the like), furniture (e.g., tables, counters, workstations, shelving, etc.), and the like. Examples of devices include computers, sensors, vehicles (e.g., cars, trucks, tankers, trains, forklifts, cranes, and the like), equipment, conveyer belts, and the like. Examples of environments may include facilities (e.g., factories, refineries, warehouses, retail locations, storage buildings, parking lots, airports, commercial buildings, residential buildings, and the like), roads, water ways, cities, countries, land masses, and the like. Examples of different types of physical assets, devices, and environments are referenced throughout the disclosure.

In embodiments, a digital twin may be comprised of (e.g., via reference, or by partial or complete integration) other digital twins. For example, a digital twin of a package may include a digital twin of a container and one or more digital twins of one or more respective goods enclosed within the container. Taking this example one step further, one or more digital twins of the packages may be contained in a digital twin of a vehicle traversing a digital twin of a road or may be positioned on a digital twin of a shelf within a digital twin of a warehouse, which would include digital twins of other physical assets and devices.

In embodiments, the digital representation for a digital twin may include a set of data structures (e.g., classes of objects) that collectively define a set of properties, attributes, and/or parameters of a represented physical asset, device, or environment, possible behaviors or activities thereof and/or possible states or conditions thereof, among other things. For example, a set of properties of a physical asset may include a type of the physical asset, the shape and/or dimensions of the asset, the mass of the asset, the density of the asset, the material(s) of the asset, the physical properties of the material(s), the chemical properties of the asset, the expected lifetime of the asset, the surface of the physical asset, a price of the physical asset, the status of the physical asset, a location of the physical asset, and/or other properties, as well as identifiers of other digital twins contained within or linked to the digital twin and/or other relevant data sources that may be used to populate the digital twin (such as data sources within the management platform described herein or external data sources, such as environmental data sources that may impact properties represented in the digital twin (e.g., where ambient air pressure or temperature affects the physical dimensions of an asset that inflates or deflates). Examples of a behavior of a physical asset may include a state of matter of the physical asset (e.g., a solid, liquid, plasma or gas), a melting point of the physical asset, a density of the physical asset when in a liquid state, a viscosity of the physical asset when in a liquid state, a freezing point of the physical asset, a density of the physical asset when in a solid state, a hardness of the physical asset when in a solid state, the malleability of the physical asset, the buoyancy of the physical asset, the conductivity of the physical asset, electromagnetic properties of the physical asset, radiation properties, optical properties (e.g., reflectivity, transparency, opacity, albedo, and the like), wave interaction properties (e.g., transparency or opacity to radio waves, reflection properties, shielding properties, or the like), a burning point of the physical asset, the manner by which humidity affects the physical asset, the manner by which water or other liquids affect the physical asset, and the like. In another example, the set of properties of a device may include a type of the device, the dimensions of the device, the mass of the device, the density of the density of the device, the material(s) of the device, the physical properties of the material(s), the surface of the device, the output of the device, the status of the device, a location of the device, a trajectory of the device, identifiers of other digital twins that the device is connected to and/or contains, and the like. Examples of the behaviors of a device may include a maximum acceleration of a device, a maximum speed of a device, possible motions of a device, possible configurations of the device, operating modes of the device, a heating profile of a device, a cooling profile of a device, processes that are performed by the device, operations that are performed by the device, and the like. Example properties of an environment may include the dimensions of the environment, environmental air pressure, the temperature of the environment, the humidity of the environment, the airflow of the environment, the physical objects in the environment, currents of the environment (if a body of water), and the like. Examples of behaviors of an environment may include scientific laws that govern the environment, processes that are performed in the environment, rules or regulations that must be adhered to in the environment, and the like.

In embodiments, the properties of a digital twin may be adjusted. For example, the temperature of a digital twin, a humidity of a digital twin, the shape of a digital twin, the material of a digital twin, the dimensions of a digital twin, or any other suitable parameters may be adjusted to conform to current status data and/or to a predicted status of a corresponding entity.

In embodiments, a digital twin may be rendered by a computing device, such that a human user can view a digital representation of a set of physical assets, devices, or other entities, and/or an environment thereof. For example, the digital twin may be rendered and provided as an output, or may provide an output, to a display device. In some embodiments, the digital twin may be rendered and output in an augmented reality and/or virtual reality display. For example, a user may view a 3D rendering of an environment (e.g., using monitor or a virtual reality headset). While doing so, the user may inspect digital twins of physical assets or devices in the environment. In embodiments, a user may view processes being performed with respect to one or more digital twins (e.g., inventorying, loading, packing, shipping, and the like). In embodiments, a user may provide input that controls one or more properties of a digital twin via a graphical user interface.

In some embodiments, the adaptive intelligent systems layer 614 is configured to execute simulations using the digital twin. For example, the adaptive intelligent systems layer 614 may iteratively adjust one or more parameters of a digital twin and/or one or more embedded digital twins. In embodiments, the adaptive intelligent systems layer 614 may, for each set of parameters, execute a simulation based on the set of parameters and may collect the simulation outcome data resulting from the simulation. Put another way, the adaptive intelligent systems layer 614 may collect the properties of the digital twin and the digital twins within or containing the digital twin used during the simulation as well as any outcomes stemming from the simulation. For example, in running a simulation on a digital twin of a shipping container, the adaptive intelligent systems layer 614 can vary the materials of the shipping container and can execute simulations that outcomes resulting from different combinations. In this example, an outcome can be whether the goods contained in the shipping container arrive to a destination undamaged. During the simulation, the adaptive intelligent systems layer 614 may vary the external temperatures of the container (e.g., a temperature property of the digital twin of an environment of the container may be adjusted between simulations or during a simulation), the dimensions of the container, the products inside (represented by digital twins of the products) the container, the motion of the container, the humidity inside the container, and/or any other properties of the container, the environment, and/or the contents in the container. For each simulation instance, the adaptive intelligent systems layer 614 may record the parameters used to perform the simulation instance and the outcome of the simulation instance. In embodiments, each digital twin may include, reference, or be linked to a set of physical limitations that define the boundary conditions for a simulation. For example, the physical limitations of a digital twin of an outdoor environment may include a gravity constant (e.g., 9.8 m/s²), a maximum temperature (e.g., 60 degrees celsius), a minimum temperature (e.g., −80 degrees Celsius), a maximum humidity (e.g., 110% humidity), friction coefficients of surfaces, maximum velocities of objects, maximum salinity of water, maximum acidity of water, minimum acidity of water. Additionally or alternatively, the simulations may adhere to scientific formulas, such as ones reflecting principles or laws of physics, chemistry, materials science, biology, geometry, or the like. For example, a simulation of the physical behavior of an object may adhere to the laws of thermodynamics, laws of motion, laws of fluid dynamics, laws of buoyancy, laws of heat transfer, laws of cooling, and the like. Thus, when the adaptive intelligent systems layer 614 performs a simulation, the simulation may conform to the physical limitations and scientific laws, such that the outcomes of the simulations mimic real world outcomes. The outcome from a simulation can be presented to a human user, compared against real world data (e.g., measured properties of a container, the environment of the container, the contents of the container, and resultant outcomes) to ensure convergence of the digital twin with the real world, and/or used to train machine learning models.

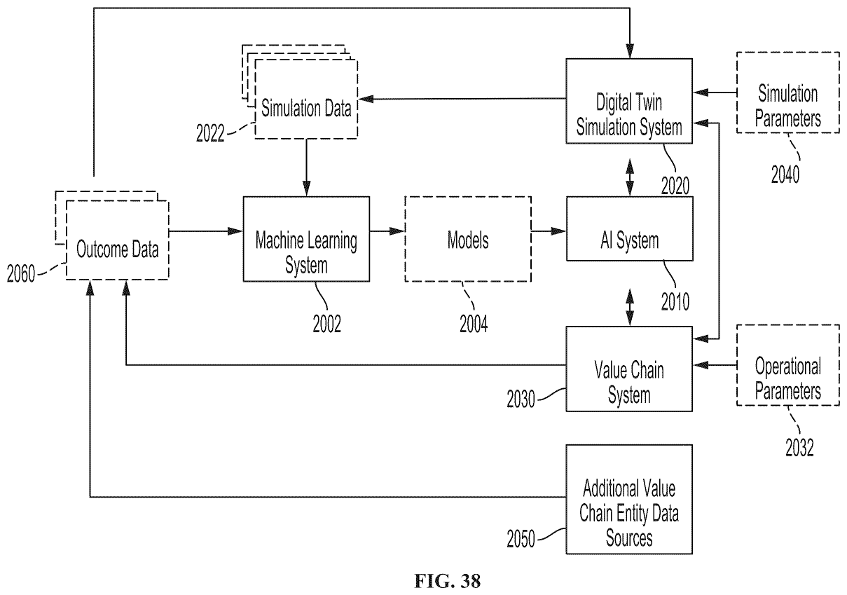

FIG. 38 illustrates example embodiments of a system for controlling and/or making decisions, predictions, and/or classification on behalf of a value chain system 2030. In embodiments, an artificial intelligence system 2010 leverages one or more machine-learned models 2004 to perform value chain-related tasks on behalf of the value chain system 2030 and/or to make decisions, classifications, and/or predictions on behalf of the value chain system 2030. In some embodiments, a machine learning system 2002 trains the machine learned models 2004 based on training data 2062, outcome data 2060, and/or simulation data 2022. As used herein, the term machine-learned model may refer to any suitable type of model that is learned in a supervised, unsupervised, or hybrid manner. Examples of machine-learned models include neural networks (e.g., deep neural networks, convolution neural networks, and many others), regression based models, decision trees, hidden forests, Hidden Markov models, Bayesian models, and the like. In embodiments, the artificial intelligence system 2010 and/or the value chain system 2030 may provide outcome data 2060 to the machine-learning system 2002 that relates to a determination (e.g., decision, classification, prediction) made by the artificial intelligence system 2010 based in part on the one or more machine-learned models and the input to those models. The machine learning system may in-turn reinforce/retrain the machine-learned models 2004 based on the feedback. Furthermore, in embodiments, the machine-learning system 2002 may train the machine-learning models based on simulation data 2022 generated by the digital twin simulation system 2020. In these embodiments, the digital twin simulation system 2020 may be instructed to run specific simulations using one or more digital twins that represent objects and/or environments that are managed, maintained, and/or monitored by the value chain system. In this way, the digital twin simulation system 2020 may provide richer data sets that the machine-learning system 2002 may use to train/reinforce the machine-learned models. Additionally or alternatively, the digital twin simulation system 2020 may be leveraged by the artificial intelligence system 2010 to test a decision made by the artificial intelligence system 2010 before providing the decision to the value chain entity.

In the illustrated example, a machine learning system 2002 may receive training data 2062, outcome data 2060, and/or simulation data 2022. In embodiments, the training data may be data that is used to initially train a model. The training data may be provided by a domain expert, collected from various data sources, and/or obtained from historical records and/or scientific experimentation. The training data 2062 may include quantified properties of an item or environment and outcomes relating from the quantified properties. In some embodiments, the training data may be structured in n-tuples, whereby each tuple includes an outcome and a respective set of properties relating to the outcome. In embodiments, the outcome data 2060 includes real world data (e.g., data measured or captured from one or more of IoT sensors, value chain entities, and/or other sources). The outcome data may include an outcome and properties relating to the outcome. Outcome data may be provided by the value chain system 2030 leveraging the artificial intelligence system 2010 and/or other data sources during operation of the value chain entity system 2010. Each time an outcome is realized (whether negative or positive), the value chain entity system 2010, the artificial intelligence system 2010, as well as any other data source 2050, may output data relating to the outcome to the machine learning system 2002. In embodiments, this data may be provided to the machine-learning system via an API of the adaptive intelligent systems layer 614. Furthermore, in embodiments, the adaptive intelligent systems layer 614 may obtain data from other types of external data sources that are not necessarily a value chain entity but may provide insightful data. For example, weather data, stock market data, news events, and the like may be collected, crawled, subscribed to, or the like to supplement the outcome data (and/or training data and/or simulation data).

In some embodiments, the machine learning system 2002 may receive simulation data 2022 from the digital twin simulation system 2020. Simulation data 2022 may be any data relating to a simulation using a digital twin. Simulation data 2022 may be similar to outcome data 2060, but the results are simulated results from an executed simulation rather than real-world data. In embodiments, simulation data 2022 may include the properties of the digital twin and any other digital twins that were used to perform the simulation and the outcomes stemming therefrom. In embodiments, the digital twin simulation system 2020 may iteratively adjust the properties of a digital twin, as well as other digital twins that are contained or contain the digital twin. During each iteration, the digital twin simulation system 2020 may provide the properties of the simulation (e.g., the properties of all the digital twins involved in the simulation) to the artificial intelligence system 2010, which then outputs predictions, classifications, or any other decisions to the digital twin simulation system 2020. The digital twin simulation system 2020 may use the decisions from the artificial intelligence system 2010 to execute the simulation (which may result in a series of decisions stemming from a state change in the simulation). At each iteration, the digital twin simulation system 2020 may output the properties used to run the simulation to the machine learning system 2002, any decisions from the artificial intelligence system 2010 used by the digital twin simulation system 2020, and outcomes from the simulation to the machine learning system 2002, such that the properties, decisions, and outcomes of the simulation are used to further train the model(s) used by the artificial intelligence system during the simulation.

In some embodiments, training data, outcome data 2060, and/or simulation data 2022 may be fed into a data lake (e.g., a Hadoop data lake). The machine learning system 2002 may structure the data from the data lake. In embodiments, the machine learning system 2002 may train/reinforce the models using the collected data to improve the accuracy of the models (e.g., minimize the error value of the model). The machine learning system may execute machine-learning algorithms on the collected data (e.g., training data, outcome data, and/or simulation data) to obtain the model. Depending on the type of model, the machine-learning algorithm will vary. Examples of learning algorithms/models include (e.g., deep neural networks, convolution neural networks, and many others as described throughout this disclosure), statistical models (e.g., regression-based models and many others), decision trees and other decision models, random/hidden forests, Hidden Markov models, Bayesian models, and the like. In collecting data from the digital twin simulation system 2020, the machine-learning system 2002 may train the model on scenarios not yet encountered by the value chain system 2030. In this way, the resultant models will have less “unexplored” feature spaces, which may lead to improved decisions by the artificial intelligence system 2010. Furthermore, as digital twins are based partly on assumptions, the properties of a digital twin may be updated/corrected when a real-world behavior differs from that of the digital twin. Examples are provided below.

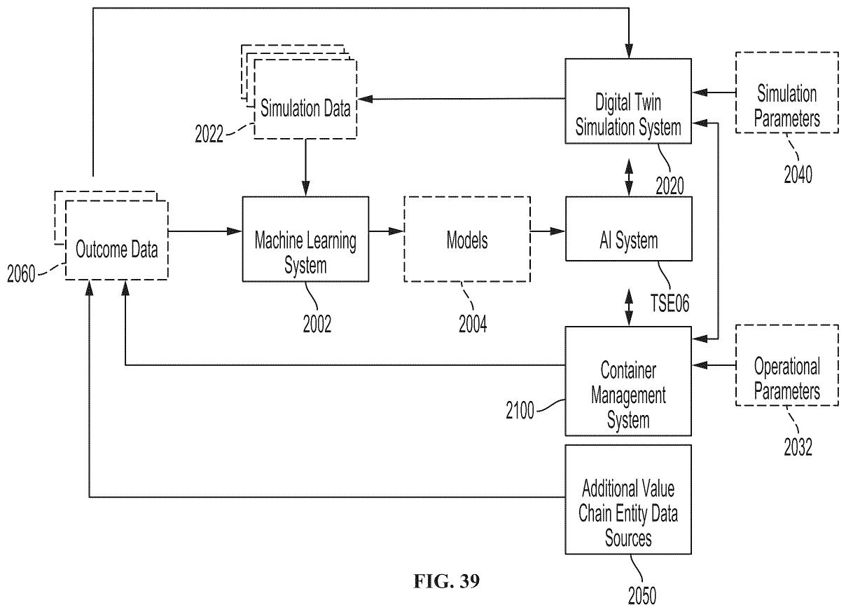

FIG. 39 illustrates an example of a container fleet management system 2070 that interfaces with the adaptive intelligent systems layer 614. In example embodiments, a container fleet management system 2070 may be configured to automate one or more aspects of the value chain as it applies to containers and shipping. In embodiments, the container fleet management system 2070 may be include one or more software modules that are executed by one or more server devices. These software modules may be configured to select containers to use (e.g., a size of container, the type of the container, the provider of the container, etc.) for a set of one or more shipments, schedule delivery/pickup of container, selection of shipping routes, determining the type of storage for a container (e.g., outdoor or indoor), select a location of each container while awaiting shipping, manage bills of lading and/or other suitable container fleet management tasks. In embodiments, the machine-learning system 2002 trains one or more models that are leveraged by the artificial intelligence system 2010 to make classifications, predictions, and/or other decisions relating to container fleet management. In example embodiments, a model 2004 is trained to select types of containers given one or more task-related features to maximize the likelihood of a desired outcome (e.g., that the contents of the container arrive in a timely manner with minimal loss at the lowest possible cost). As such, the machine-learning system 2002 may train the models using n-tuples that include the task-related features pertaining to a particular event and one or more outcomes associated with the particular event. In this example, task-related features for a particular event (e.g., a shipment) may include, but are not limited to, the type of container used, the contents of the container, properties of the container contents (e.g., cost, perishability, temperature restrictions, and the like), the source and destination of the container, whether the container is being shipped via truck, rail, or ship, the time of year, the cost of each container, and/or other relevant features. In this example, outcomes relating to the particular event may include whether the contents arrived safely, replacement costs (if any) associated with any damage or loss, total shipping time, and/or total cost of shipment (e.g., how much it cost to ship container). Furthermore, as international and/or interstate logistics may include many different sources, destinations, contents, weather conditions, and the like, simulations that simulate different shipping events may be run to richen the data used to train the model. For instance, simulations may be run for different combinations of ports and/or train depots for different combinations of sources, destinations, products, and times of year. In this example, different digital twins may be generated to represent the different combinations (e.g., digital twins of products, containers, and shipping-related environments), whereby one or more properties of the digital twins are varied for different simulations and the outcomes of each simulation may be recorded in a tuple with the proprieties. In this way, the model may be trained on certain combinations of routes, contents, time of year, container type, and/or cost that may not have been previously encountered in the real-world outcome data. Other examples of training a container fleet management model may include a model that is trained to determine where a container should be stored in a storage facility (e.g., where in a stack, indoors or outdoors, and/or the like) given the contents of the container, when the container needs to be moved, the type of container, the location, the time of year, and the like.

In operation, the artificial intelligence system 2010 may use the above-discussed models 2004 to make container fleet management decisions on behalf of a container fleet management system 2070 given one or more features relating to a task or event. For example, the artificial intelligence system 2010 may select a type of container (e.g., materials of the container, the dimensions of the container, the brand of the container, and the like) to use for a particular shipment. In this example, the container fleet management system 2070 may provide the features of an upcoming shipment to the artificial intelligence system 2010. These features may include what is being shipped (e.g., the type(s) of goods in the shipment), the size of the shipment, the source and destination, the date when the shipment is to be sent off, and/or the desired date or range of dates for delivery. In embodiments, the artificial intelligence system 2010 may feed these features into one or more of the models discussed above to obtain one or more decisions. These decisions may include which type of container to use and/or which shipping routes to use, whereby the decisions may be selected to minimize overall shipping costs (e.g., costs for container and transit+any replacement costs). The container fleet management system 2070 may then initiate the shipping event using the decision(s) made by the artificial intelligence system 2010. Furthermore, after the shipping event, the outcomes of the event (e.g., total shipping time, any reported damages or loss, replacement costs, total costs) may be reported to the machine-learning system 2002 to reinforce the models used to make the decisions. Furthermore, in some embodiments, the output of the container fleet management system 2070 and/or the other value chain entity data sources 2050 may be used to update one or more properties of one or more digital twins via the digital twin system 2020.

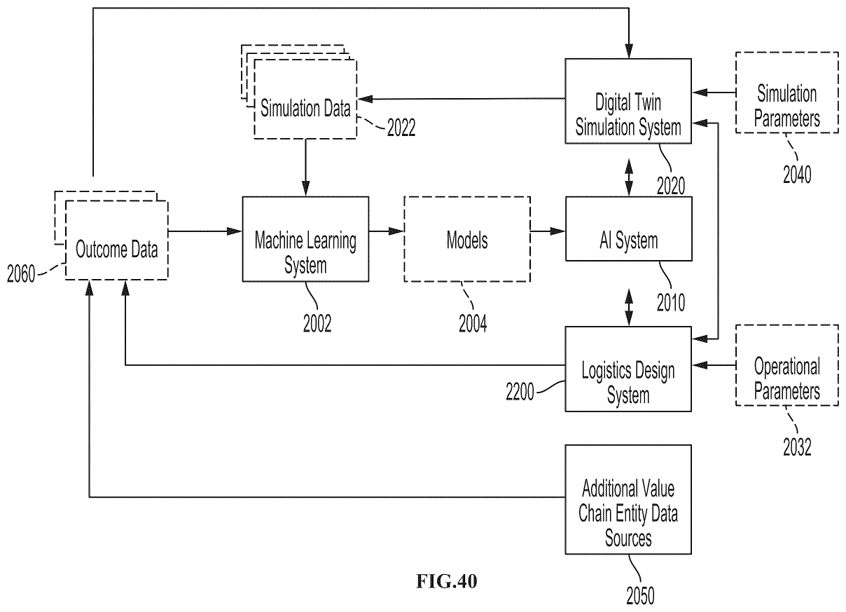

FIG. 40 illustrates an example of a logistics design system that interfaces with the adaptive intelligent systems layer 614. In embodiments, a logistics design system may be configured to design one or more aspects of a logistics solution. For example, the logistics design system may be configured to receive one or more logistics factors (e.g., from a user via a GUI). In embodiments, logistics factors may include one or more present conditions, historical conditions, or future conditions of an organization (or potential organization) that are relevant to forming a logistics solution. Examples of logistics factors may include, but are not limited to the type(s) of products being produced/farmed/shipped, features of those products (e.g., dimensions, weights, shipping requirements, shelf life, etc.), locations of manufacturing sites, locations of distribution facilities, locations of warehouses, locations of customer bases, market penetration in certain areas, expansion locations, supply chain features (e.g., required parts/supplies/resources, suppliers, supplier locations, buyers, buyer locations), and/or the like) and may determine one or more design recommendations based on the factors. Examples of design recommendations may include supply chain recommendations (e.g., proposed suppliers (e.g., resource or parts suppliers), implementations of a smart inventory systems that order on-demand parts from available suppliers, and the like), storage and transport recommendations (e.g., proposed shipping routes, proposed shipping types (e.g., air, freight, truck, ship), proposed storage development (e.g., locations and/or dimensions of new warehouses), infrastructure recommendations (e.g., updates to machinery, adding cooled storage, adding heated storage, or the like), and combinations thereof. In embodiments, the logistics design system determines the recommendations to optimize an outcome. Examples of outcomes can include manufacturing times, manufacturing costs, shipping times, shipping costs, loss rate, environmental impact, compliance to a set of rules/regulations, and the like. Examples of optimizations include increased production throughput, reduced production costs, reduced shipping costs, decreased shipping times, reduced carbon footprint, and combinations thereof.

In embodiments, the logistics design system may interface with the artificial intelligence system 2010 to provide the logistics factors and to receive design recommendations that are based thereon. In embodiments, the artificial intelligence system 2010 may leverage one or more machine-learned models 2004 (e.g., logistics design recommendations models) to determine a recommendation. As will be discussed, a logistics design recommendation model may be trained to optimize one or more outcomes given a set of logistics factors. For example, a logistics design recommendation model trained to design supply chains may identify a set of suppliers that can supply a given manufacturer, the location of the manufacturer, the supplies needed, and/or other factors. The set of suppliers may then be used to implement an on-demand supply side inventory. In another example, the logistics design recommendation may take the same features of another manufacturer and recommend the purchase and use of one or more 3D printers.

In embodiments, the artificial intelligence system 2010 may leverage the digital twin system 2020 to generate a digital twin of a logistics system that implements the logistics design recommendation (and, in some embodiments, alternative systems that implement other design recommendations). In these embodiments, the digital twin system 1700 may receive the design recommendations and may generate a digital twin of a logistics environment that mirrors the recommendations. In embodiments, the artificial intelligence system 2010 may leverage the digital twin of the logistics environment to run simulations on the proposed solution. In embodiments, the digital twin system 1700 may display the digital twin of the logistics environment to a user via a display device (e.g., a monitor or a VR headset). In embodiments, the user may view the simulations in the digital twin. Furthermore, in embodiments, the digital twin system 1700 may provide a graphical user interface that the user may interact with to adjust the design of the logistics environment to adjust the design. The design provided (at least in part) by a user may also be represented in a digital twin of a logistics environment, whereby the digital twin system 2020 may perform simulations using the digital twin.

In some embodiments, the simulations run by the digital twin system 1700 may be used to train the recommendation models. Furthermore, when the design recommendations are implemented by an organization, the logistics system of the organization may be configured to report (e.g., via sensors, computing devices, manual human input) outcome data corresponding to the design recommendations to the machine learning system 2002, which may use the outcome data to reinforce the logistics design recommendation models.

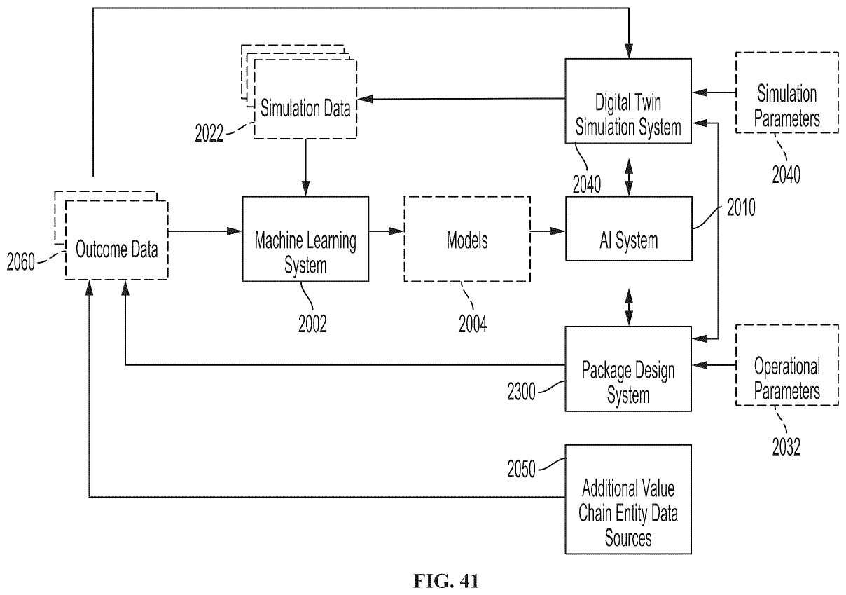

FIG. 41 illustrates an example of a packaging design system that interfaces with the adaptive intelligent systems layer 614. In embodiments, the packaging design system may be configured to design one or more aspects of packaging for a physical object being conveyed in the value chain network. In some embodiments, the packaging design system may select one or more packaging attributes (e.g., size, material, padding, etc.) of the packaging to optimize one or more outcomes associated with the transport of the physical object. For example, the packaging attributes may be selected to reduce costs, decrease loss/damage, decrease weight, decrease plastic or other non-biodegradable waste, or the like. In embodiments, the packaging design system leverages the artificial intelligence system 2010 to obtain packaging attribute recommendations. In embodiments, the packaging design system may provide one or more features of the physical object. In embodiments, the features of the physical object may include the dimensions of the physical object, the mass of the physical object, the source of the physical object, one or more potential destinations of the physical object, the manner by which the physical object is shipped, and the like. In embodiments, the packaging design system may further provide one or more optimization goals for the package design (e.g., reduce cost, reduce damage, reduce environmental impact). In response, the artificial intelligence system 2010 may determine one or more recommended packaging attributes based on the physical asset features and the given objective. In embodiments, the packaging design system receives the packaging attributes and generates a package design based thereon. The package design may include a material to be used, the external dimensions of the packaging, the internal dimensions of the packaging, the shape of the packaging, the padding/stuffing for the packaging, and the like.

In some embodiments, the packaging design system may provide a packaging design to the digital twin system 2020, which generates a digital twin of the packaging and physical asset based on the packaging design. The digital twin of the packaging and physical asset may be used to run simulations that test the packaging (e.g., whether the packaging holds up in shipping, whether the packaging provides adequate insulation/padding, and the like). In embodiments, the results of the simulation may be returned to the packaging design system, which may output the results to a user. In embodiments, the user may accept the packaging design, may adjust the packaging design, or may reject the design. In some embodiments, the digital twin system may run simulations on one or more digital twins to test different conditions that the package may be subjected to (e.g., outside in the snow, rocking in a boat, being moved by a forklift, or the like). In some embodiments, the digital twin system may output the results of a simulation to the machine-learning system 2002, which can train/reinforce the packaging design models based on the properties used to run the simulation and the outcomes stemming therefrom.

In embodiments, the machine-learning system 2002 may receive outcome data from the packaging design system and/or other value chain entity data sources (e.g., smart warehouses, user feedback, and the like). The machine-learning system 2002 may use this outcome data to train/reinforce the packaging design models. Furthermore, in some embodiments, the outcome data may be used by the digital twin system 2020 to update/correct any incorrect assumptions used by the digital twin system (e.g., the flexibility of a packaging material, the water resistance of a packaging material, and the like).

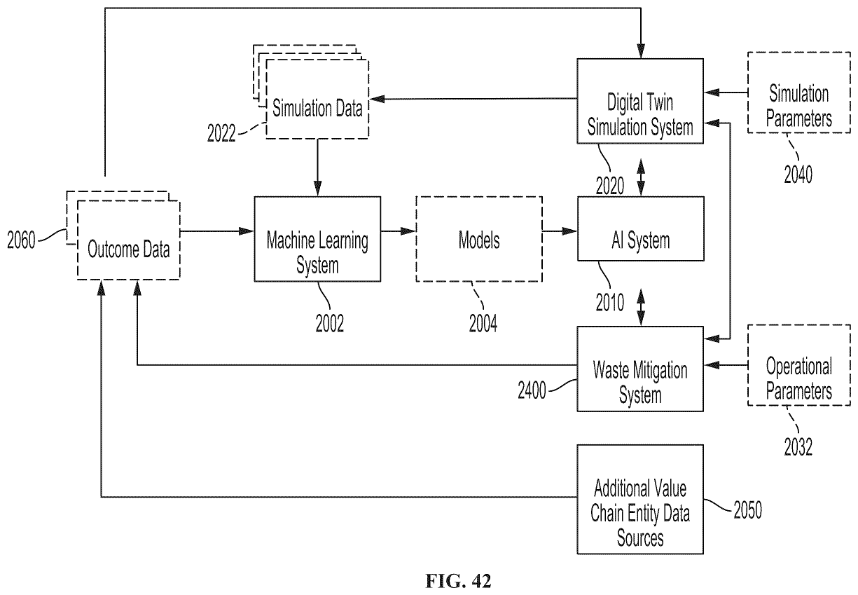

FIG. 42 illustrates examples of a waste mitigation system that interfaces with the adaptive intelligent systems layer 614. In embodiments, the waste mitigation system is configured to analyze a process within the value chain (e.g., manufacturing of a product, oil refining, fertilization, water treatment, or the like) to mitigate waste (e.g., solid waste, wastewater, discarded packaging, wasted energy, wasted time, wasted resources, or other waste). In embodiments, the waste mitigation system may interface with the artificial intelligence system 2010 to automate one or more processes to mitigate waste.

In embodiments, the artificial intelligence system 2010 may provide control decisions to the waste mitigation system to mitigate solid waste production. Examples of waste production may include excess plastic or other non-biodegradable waste, hazardous or toxic waste (e.g., nuclear waste, petroleum coke, or the like), and the like. In some of these embodiments, the artificial intelligence system 2010 may receive one or more features of the process (or “process features”). Examples of process features may include, but are not limited to, the steps in the process, the materials being used, the properties of the materials being used, and the like. The artificial intelligence system 2010 may leverage one or more machine-learned models to control the process. In embodiments, the machine-learned models may be trained to classify a waste condition and/or the cause of the waste condition. In some of these embodiments, the artificial intelligence system 2010 may determine or select a waste mitigation solution based on the classified waste condition. For example, in some embodiments, the artificial intelligence system 2010 may apply rules-based logic to determine an adjustment to make to the process to reduce or resolve the waste condition. Additionally, or alternatively, the artificial intelligence may leverage a model that recommends an adjustment to make to the process to reduce or resolve the waste condition.

In embodiments, the artificial intelligence system 2010 may leverage the digital twin system 2020 to mitigate the waste produced by a process. In embodiments, the digital twin system 2020 may execute iterative simulations of the process in a digital twin of the environment in which the process is performed. When the simulation is executed, the artificial intelligence system 2010 may monitor the results of the simulation to determine a waste condition and/or the cause of the waste condition. During the simulations, the artificial intelligence system 2010 may adjust one or more aspects of the process to determine whether the adjustments mitigated the waste condition, worsened the waste condition, or had no effect. When an adjustment is found to mitigate the waste condition, the artificial intelligence system 2010 may adjust other aspects of the process to determine if an improvement can be realized. In embodiments, the artificial intelligence system 2010 may perform a genetic algorithm when iteratively adjusting the aspects of the process in the digital twin simulations. In these embodiments, the artificial intelligence system 2010 may identify aspects of the process that can be adjusted to mitigate the waste production.

### Smart Project Management Facilities

Referring to FIG. 43, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614 (including artificial intelligence 1160), a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

In embodiments, the adaptive intelligence systems layer 614 may further include a set of automated project management facilities 21006 that provide automated recommendations for a set of value chain project management tasks based on processing current status information, a set of application outputs and/or a set of outcomes 1040 for a set of demand management applications 1502, a set of supply chain applications 1500, a set of intelligent product applications 1510, a set of asset management applications 1530 and a set of enterprise resource management applications 1520 for a category of goods.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of project management facilities that provide automated recommendations for a set of value chain project management tasks based on processing current status information and a set of outcomes for a set of demand management applications, a set of supply chain applications, a set of intelligent product applications and a set of enterprise resource management applications for a category of goods.

In embodiments, the set of project management facilities are configured to manage a wide variety of types of projects, such as procurement projects, logistics projects, reverse logistics projects, fulfillment projects, distribution projects, warehousing projects, inventory management projects, product design projects, product management projects, shipping projects, maritime projects, loading or unloading projects, packing projects, purchasing projects, marketing projects, sales projects, analytics projects, demand management projects, demand planning projects, resource planning projects and many others.

In embodiments, the project management facilities are configured to manage a set of procurement projects. In embodiments, the project management facilities are configured to manage a set of logistics projects. In embodiments, the project management facilities are configured to manage a set of reverse logistics projects. In embodiments, the project management facilities are configured to manage a set of fulfillment projects.

In embodiments, the project management facilities are configured to manage a set of distribution projects. In embodiments, the project management facilities are configured to manage a set of warehousing projects. In embodiments, the project management facilities are configured to manage a set of inventory management projects. In embodiments, the project management facilities are configured to manage a set of product design projects.

In embodiments, the project management facilities are configured to manage a set of product management projects. In embodiments, the project management facilities are configured to manage a set of shipping projects. In embodiments, the project management facilities are configured to manage a set of maritime projects. In embodiments, the project management facilities are configured to manage a set of loading or unloading projects.

In embodiments, the project management facilities are configured to manage a set of packing projects. In embodiments, the project management facilities are configured to manage a set of purchasing projects. In embodiments, the project management facilities are configured to manage a set of marketing projects. In embodiments, the project management facilities are configured to manage a set of sales projects.

In embodiments, the project management facilities are configured to manage a set of analytics projects. In embodiments, the project management facilities are configured to manage a set of demand management projects. In embodiments, the project management facilities are configured to manage a set of demand planning projects. In embodiments, the project management facilities are configured to manage a set of resource planning projects.

### Smart Task Recommendations

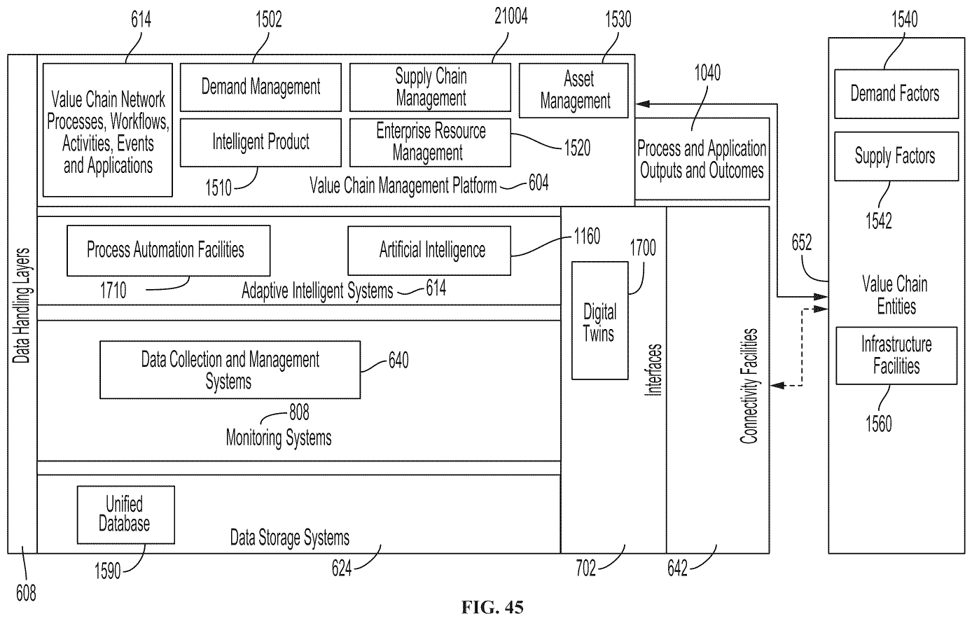

Referring to FIG. 45, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614 (including artificial intelligence 1160), a set of data storage facilities or systems 624, and a set of monitoring facilities or systems 808.

The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of project management facilities that provide automated recommendations for a set of value chain project management tasks based on processing current status information and a set of outcomes for a set of demand management applications, a set of supply chain applications, a set of intelligent product applications and a set of enterprise resource management applications for a category of goods.

In embodiments, the adaptive intelligent systems layer 614 may further include a set of process automation facilities 1710 that provide automated recommendations for a set of value chain process tasks 1710 that provide automated recommendations for a set of value chain processes based on processing current status information, a set of application outputs and/or a set of outcomes 1040 for a set of demand management applications 1502, a set of supply chain applications 1500, a set of intelligent product applications 1510, a set of asset management applications 1530 and a set of enterprise resource management applications 1520 for a category of goods. In some examples, the process automation facilities 1710 may be used with basic rule-based training and recommendations. This may relate to following a set of rules that an expert has articulated such as when a trigger occurs, undertake a task. In another example, the process automation facilities 1710 may utilize deep learning to observe interactions such as deep learning on outcomes to learn to recommend decisions or tasks that produce a highest return on investment (ROI) or other outcome-based yield. The process automation facilities 1710 may be used to provide collaborative filtering such as look at a set of experts that are most similar in terms of work done and tasks completed being most similar. For example, the underlying software may be used to find customers similar to another set of customers to sell to, make a different offering to, or change price accordingly. In general, given a set of underlying pattern data, contextually, about a customer segment, purchasing patterns may be determined for that customer segment such as knowledge of cost and pricing patterns for that customer. This information may be used to learn to focus a next set of activities around pricing, promotion, demand management towards an ideal that may be based on deep learning or rules or collaborative filtering type work trying to leverage off of similar decisions made by similarly situated people (e.g., recommending movies to a similar cohort of people).

In embodiments, the set of facilities that provide automated recommendations for a set of value chain process tasks provide recommendations involving a wide range of types of activities, such as, without limitation, product configuration activities, product selection activities for a customer, supplier selection activities, shipper selection activities, route selection activities, factory selection activities, product assortment activities, product management activities, logistics activities, reverse logistics activities, artificial intelligence configuration activities, maintenance activities, product support activities, product recommendation activities and many others.

In embodiments, the automated recommendations relate to a set of product configuration activities. In embodiments, the automated recommendations relate to a set of product selection activities for a customer. In embodiments, the automated recommendations relate to a set of supplier selection activities. In embodiments, the automated recommendations relate to a set of shipper selection activities.

In embodiments, the automated recommendations relate to a set of route selection activities. In embodiments, the automated recommendations relate to a set of factory selection activities. In embodiments, the automated recommendations relate to a set of product assortment activities. In embodiments, the automated recommendations relate to a set of product management activities. In embodiments, the automated recommendations relate to a set of logistics activities.

In embodiments, the automated recommendations relate to a set of reverse logistics activities. In embodiments, the automated recommendations relate to a set of artificial intelligence configuration activities. In embodiments, the automated recommendations relate to a set of maintenance activities. In embodiments, the automated recommendations relate to a set of product support activities. In embodiments, the automated recommendations relate to a set of product recommendation activities.

### Optimized Routing Among Nodes

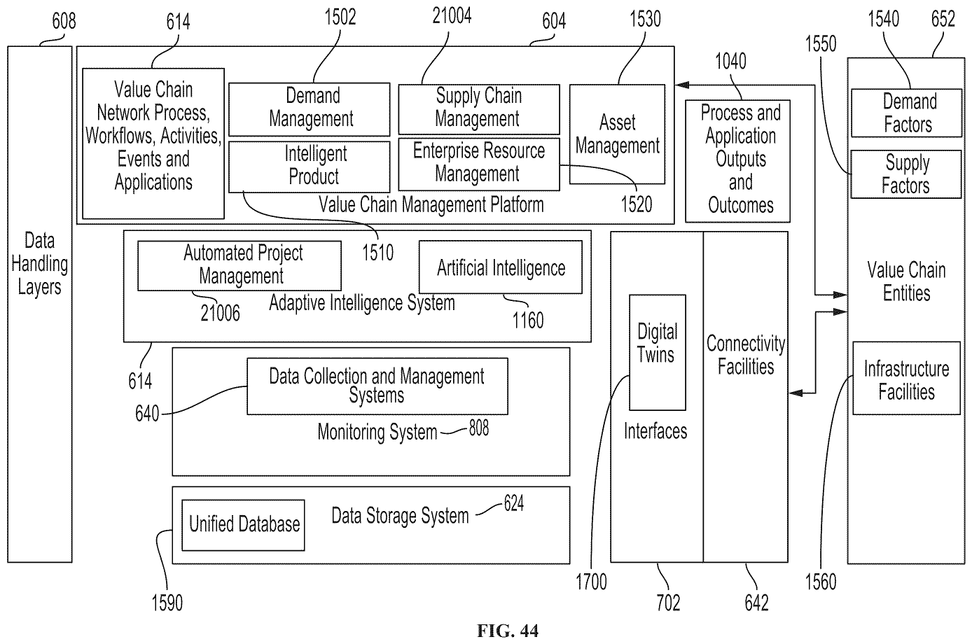

Referring to FIG. 44, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614 (including artificial intelligence 1160), a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform for a value chain network with a micro-services architecture, a set of interfaces, network connectivity facilities, adaptive intelligence facilities, data storage facilities, and monitoring facilities that are coordinated for monitoring and management of a set of value chain network entities; and a set of applications for enabling an enterprise to manage a set of value chain network entities from a point of origin to a point of customer use; wherein a set of routing facilities generate a set of routing instructions for routing information among a set of nodes in the value chain network based on current status information for the value chain network.

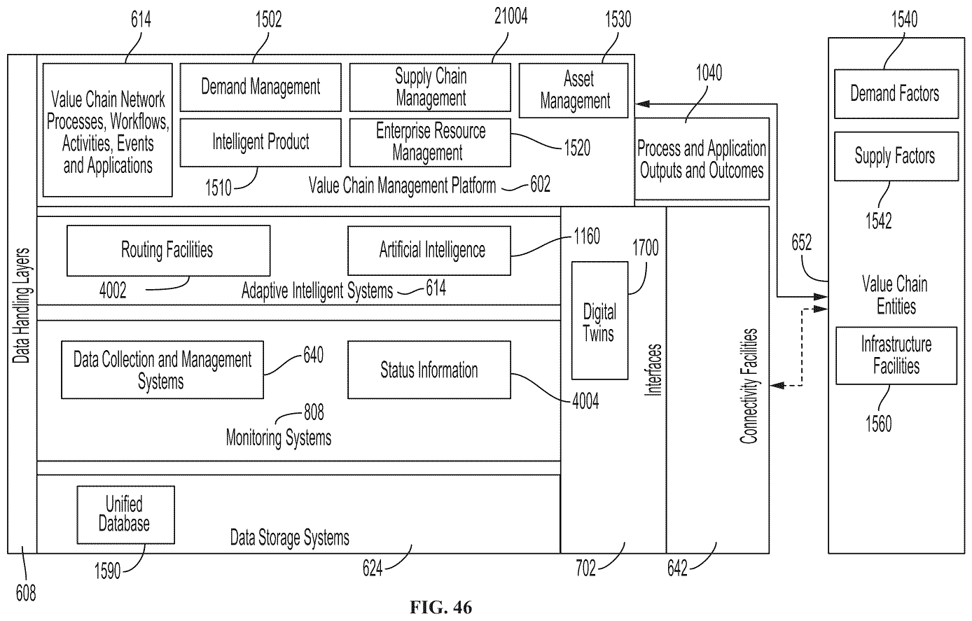

In embodiments, the adaptive intelligent systems layer 614 (also shown in FIG. 46) may further include a set of routing facilities 1720 that generate a set of routing instructions for routing information among a set of nodes in the value chain network, such as based on processing current status information 1730, a set of application outputs and/or a set of outcomes 1040, or other information collected by or used in the VCNP 102. Routing may include routing for the benefit of a set of demand management applications 1502, a set of supply chain applications 1500, a set of intelligent product applications 1510, a set of asset management applications 1530 and a set of enterprise resource management applications 1520 for a category of goods.

In embodiments, the set of routing facilities that generate a set of routing instructions for routing information among a set of nodes in the value chain network use a wide variety of routing systems or configurations, such as involving, without limitation, priority-based routing, master controller routing, least cost routing, rule-based routing, genetically programmed routing, random linear network coding routing, traffic-based routing, spectrum-based routing, RF condition-based routing, energy-based routing, latency-sensitive routing, protocol compatibility based routing, dynamic spectrum access routing, peer-to-peer negotiated routing, queue-based routing, and others.

In embodiments, the routing includes priority-based routing. In embodiments, the routing includes master controller routing. In embodiments, the routing includes least cost routing. In embodiments, the routing includes rule-based routing. In embodiments, the routing includes genetically programmed routing.

In embodiments, the routing includes random linear network coding routing. In embodiments, the routing includes traffic-based routing. In embodiments, the routing includes spectrum-based routing.

In embodiments, the routing includes RF condition-based routing. In embodiments, the routing includes energy-based routing. In embodiments, the routing includes latency-sensitive routing.

In embodiments, the routing includes protocol compatibility-based routing.

In embodiments, the routing includes dynamic spectrum access routing. In embodiments, the routing includes peer-to-peer negotiated routing. In embodiments, the routing includes queue-based routing.

In embodiments, the status information for the value chain network involves a wide range of states, events, workflows, activities, occurrences, or the like, such as, without limitation, traffic status, congestion status, bandwidth status, operating status, workflow progress status, incident status, damage status, safety status, power availability status, worker status, data availability status, predicted system status, shipment location status, shipment timing status, delivery status, anticipated delivery status, environmental condition status, system diagnostic status, system fault status, cybersecurity status, compliance status, demand status, supply status, price status, volatility status, need status, interest status, aggregate status for a group or population, individual status, and many others.

In embodiments, the status information involves traffic status. In embodiments, the status information involves congestion status. In embodiments, the status information involves bandwidth status. In embodiments, the status information involves operating status. In embodiments, the status information involves workflow progress status.

In embodiments, the status information involves incident status. In embodiments, the status information involves damage status. In embodiments, the status information involves safety status.

In embodiments, the status information involves power availability status. In embodiments, the status information involves worker status. In embodiments, the status information involves data availability status.

In embodiments, the status information involves predicted system status. In embodiments, the status information involves shipment location status. In embodiments, the status information involves shipment timing status. In embodiments, the status information involves delivery status.

In embodiments, the status information involves anticipated delivery status. In embodiments, the status information involves environmental condition status.

In embodiments, the status information involves system diagnostic status. In embodiments, the status information involves system fault status. In embodiments, the status information involves cybersecurity status. In embodiments, the status information involves compliance status.

### Dashboard for Managing Digital Twins

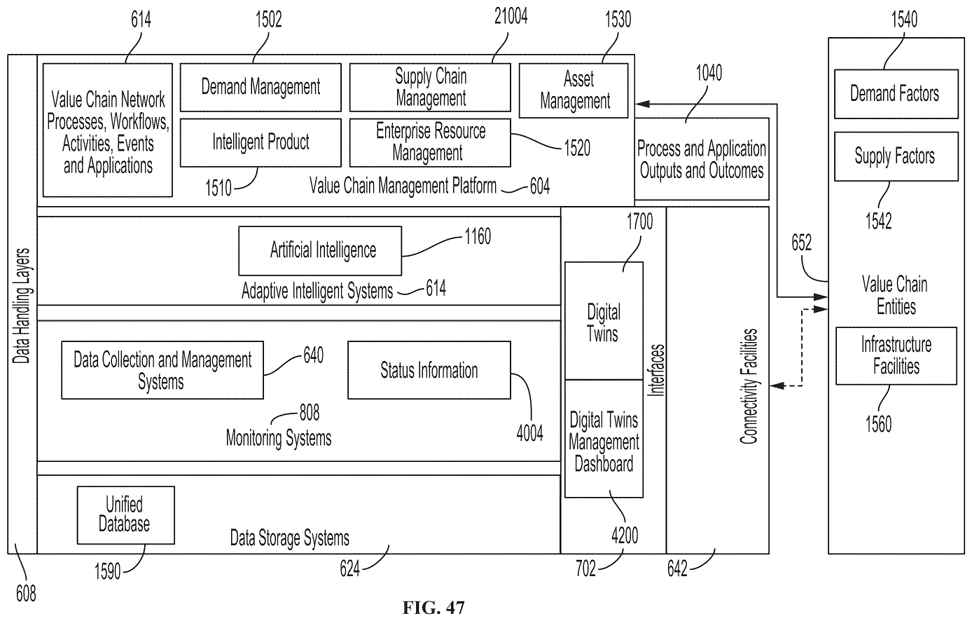

Referring to FIG. 47, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614 (including artificial intelligence 1160), a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a dashboard for managing a set of digital twins, wherein at least one digital twin represents a set of supply chain entities, workflows and assets and at least one other digital twin represents a set of demand management entities and workflows.

In embodiments, the VCNP 604 may further include a dashboard 4200 for managing a set of digital twins 1700. In embodiments, this may include different twins, such as where one digital twin 1700 represents a set of supply chain entities, workflows and assets and another digital twin 1700 represents a set of demand management entities and workflows. In some example embodiments, managing a set of digital twins 1700 may refer to configuration (e.g., via the dashboard 4200) as described in the disclosure. For example, the digital twin 1700 may be configured through use of a digital twin configuration system to set up and manage the enterprise digital twins and associated metadata of an enterprise, to configure the data structures and data listening threads that power the enterprise digital twins, and to configure features of the enterprise digital twins, including access features, processing features, automation features, reporting features, and the like, each of which may be affected by the type of enterprise digital twin (e.g., based on the role(s) that it serves, the entities it depicts, the workflows that it supports or enables and the like). In example embodiments, the digital twin configuration system may receive the types of digital twins that may be supported for the enterprise, as well as the different objects, entities, and/or states that are to be depicted in each type of digital twin. For each type of digital twin, the digital twin configuration system may determine one or more data sources and types of data that feed or otherwise support each object, entity, or state that is depicted in the respective type of digital twin and may determine any internal or external software requests (e.g., API calls) that obtain the identified data types or other suitable data acquisitions mechanisms, such as webhooks, that may configured to automatically receive data from an internal or external data source In some embodiments, the digital twin configuration system may determine internal and/or external software requests that support the identified data types by analyzing the relationships between the different types of data that correspond to a particular state/entity/object and the granularity thereof. Additionally or alternatively, a user may define (e.g., via a GUI) the data sources and/or software requests and/or other data acquisition mechanisms that support the respective data types that are depicted in a respective digital twin. In these example embodiments, the user may indicate the data source that may be accessed and the types of data to be obtained from the respective data source.

The dashboard may be used to configure the digital twins 1700 for use in collection, processing, and/or representation of information collected in the platform 604, such as status information 1730, such as for the benefit of a set of demand management applications 1502, a set of supply chain applications 1500, a set of intelligent product applications 1510, a set of asset management applications 1530 and a set of enterprise resource management applications 1520 for a category of goods.

In embodiments, the dashboard for managing a set of digital twins, wherein at least one digital twin represents a set of supply chain entities and workflows and at least one other digital twin represents a set of demand management entities and workflows.

In embodiments, the entities and workflows relate to a set of products of an enterprise. In embodiments, the entities and workflows relate to a set of suppliers of an enterprise. In embodiments, the entities and workflows relate to a set of producers of a set of products. In embodiments, the entities and workflows relate to a set of manufacturers of a set of products.

In embodiments, the entities and workflows relate to a set of retailers of a line of products. In embodiments, the entities and workflows relate to a set of businesses involved in an ecosystem for a category of products. In embodiments, the entities and workflows relate to a set of owners of a set of assets involved in a value chain for a set of products. In embodiments, the entities and workflows relate to a set of operators of a set of assets involved in a value chain for a set of products.

In embodiments, the entities and workflows relate to a set of operating facilities. In embodiments, the entities and workflows relate to a set of customers. In embodiments, the entities and workflows relate to a set of consumers. In embodiments, the entities and workflows relate to a set of workers.

In embodiments, the entities and workflows relate to a set of mobile devices. In embodiments, the entities and workflows relate to a set of wearable devices. In embodiments, the entities and workflows relate to a set of distributors. In embodiments, the entities and workflows relate to a set of resellers.

In embodiments, the entities and workflows relate to a set of supply chain infrastructure facilities. In embodiments, the entities and workflows relate to a set of supply chain processes. In embodiments, the entities and workflows relate to a set of logistics processes. In embodiments, the entities and workflows relate to a set of reverse logistics processes.

In embodiments, the entities and workflows relate to a set of demand prediction processes. In embodiments, the entities and workflows relate to a set of demand management processes. In embodiments, the entities and workflows relate to a set of demand aggregation processes. In embodiments, the entities and workflows relate to a set of machines.

In embodiments, the entities and workflows relate to a set of ships. In embodiments, the entities and workflows relate to a set of barges. In embodiments, the entities and workflows relate to a set of warehouses. In embodiments, the entities and workflows relate to a set of maritime ports.

In embodiments, the entities and workflows relate to a set of airports. In embodiments, the entities and workflows relate to a set of airways. In embodiments, the entities and workflows relate to a set of waterways. In embodiments, the entities and workflows relate to a set of roadways.

In embodiments, the entities and workflows relate to a set of railways. In embodiments, the entities and workflows relate to a set of bridges. In embodiments, the entities and workflows relate to a set of tunnels. In embodiments, the entities and workflows relate to a set of online retailers.

In embodiments, the entities and workflows relate to a set of ecommerce sites. In embodiments, the entities and workflows relate to a set of demand factors. In embodiments, the entities and workflows relate to a set of supply factors. In embodiments, the entities and workflows relate to a set of delivery systems.

In embodiments, the entities and workflows relate to a set of floating assets. In embodiments, the entities and workflows relate to a set of points of origin. In embodiments, the entities and workflows relate to a set of points of destination. In embodiments, the entities and workflows relate to a set of points of storage.

In embodiments, the entities and workflows relate to a set of points of product usage. In embodiments, the entities and workflows relate to a set of networks. In embodiments, the entities and workflows relate to a set of information technology systems. In embodiments, the entities and workflows relate to a set of software platforms.

In embodiments, the entities and workflows relate to a set of distribution centers. In embodiments, the entities and workflows relate to a set of fulfillment centers. In embodiments, the entities and workflows relate to a set of containers. In embodiments, the entities and workflows relate to a set of container handling facilities.

In embodiments, the entities and workflows relate to a set of customs. In embodiments, the entities and workflows relate to a set of export control. In embodiments, the entities and workflows relate to a set of border control. In embodiments, the entities and workflows relate to a set of drones.

In embodiments, the entities and workflows relate to a set of robots. In embodiments, the entities and workflows relate to a set of autonomous vehicles. In embodiments, the entities and workflows relate to a set of hauling facilities. In embodiments, the entities and workflows relate to a set of drones, robots and autonomous vehicles. In embodiments, the entities and workflows relate to a set of waterways. In embodiments, the entities and workflows relate to a set of port infrastructure facilities.

In embodiments, the set of digital twins may include, for example and without limitation, distribution twins, warehousing twins, port infrastructure twins, shipping facility twins, operating facility twins, customer twins, worker twins, wearable device twins, portable device twins, mobile device twins, process twins, machine twins, asset twins, product twins, point of origin twins, point of destination twins, supply factor twins, maritime facility twins, floating asset twins, shipyard twins, fulfillment twins, delivery system twins, demand factors twins, retailer twins, ecommerce twins, online twins, waterway twins, roadway twins, roadway twins, railway twins, air facility twins, aircraft twins, ship twins, vehicle twins, train twins, autonomous vehicle twins, robotic system twins, drone twins, logistics factor twins and many others.

### Microservices Architecture

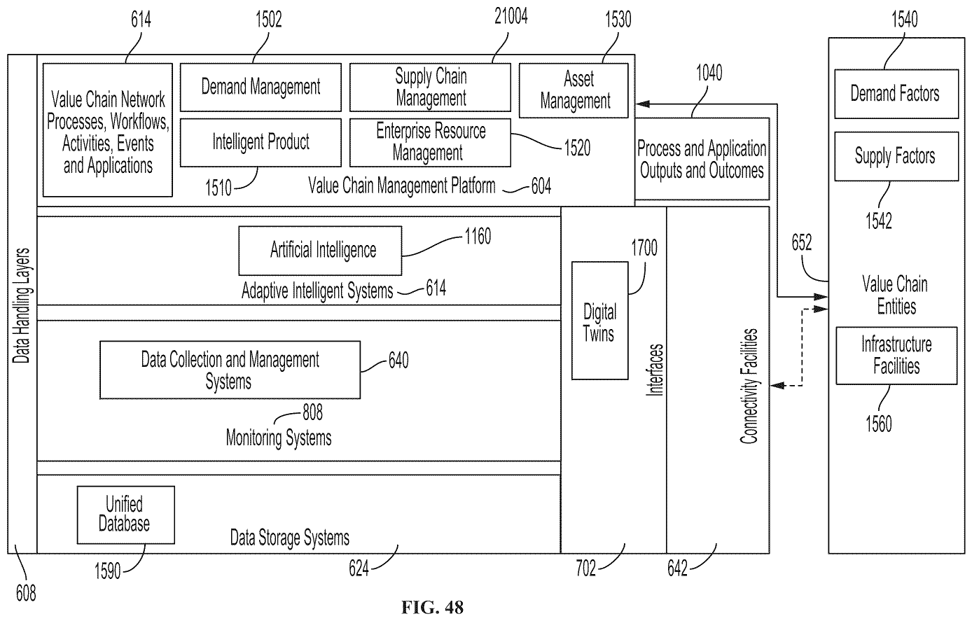

Referring to FIG. 48, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 614, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of microservices layers including an application layer supporting at least one supply chain application and at least one demand management application, wherein the applications of the application layer use a common set of services among a set of data processing services, data collection services, and data storage services.

In embodiments, the VCNP 604 may further include a set of microservices layers including an application layer supporting at least two applications among a set of demand management applications 1502, a set of supply chain applications 1500, a set of intelligent product applications 1510, a set of asset management applications 1530 and a set of enterprise resource management applications 1520 for a category of goods.

A microservices architecture provides several advantages to the platform 604. For example, one advantage may be the ability to leverage creation of improved microservices created by others such that developer may only need to define inputs and outputs such that the platform may use readily adapted services created by others. Also, use of the microservices architecture may provide ability to modularize microservices into collections that may be used to achieve tasks. For example, a goal to determine what is happening in a warehouse may be achieved with a variety of microservices with minimal cost such as vision-based service, series of regular prompts that may ask and receive, reading off of event logs or feeds, and the like. Each one of these microservices may be a distinct microservice that may be easily plugged in and used. If a particular microservice does not work effectively, the microservice may be replaced easily with another service with minimal impact to other components in the platform. Other microservices that may be used include recommendation service, collaborative filtering service, deep learning with semi-supervised learning service, etc. The microservice architecture may provide modularity at each stage in building a full workflow. In an example embodiment, a microservice may be built for multiple applications that may be consumed including shared data steam and anything else enabled by the microservices architecture.

### IoT Data Collection Architecture Recommendation of Other Sensors and Cameras

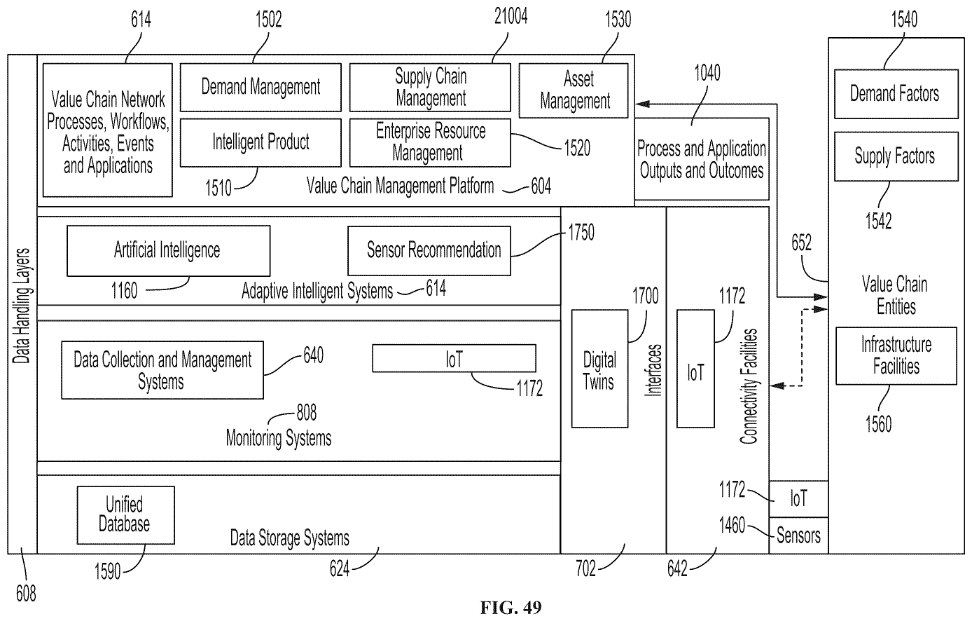

Referring to FIG. 49, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of microservices layers including an application layer supporting at least one supply chain application and at least one demand management application, wherein the microservice layers include a data collection layer that collects information from a set of Internet of Things resources that collect information with respect to supply chain entities and demand management entities.

Also provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a machine learning/artificial intelligence system configured to generate recommendations for placing an additional sensor/and or camera on and/or in proximity to a value chain entity and wherein data from the additional sensor and/or camera feeds into a digital twin that represents a set of value chain entities.

In embodiments, the VCNP 604 may further include a set of microservices, wherein the microservice layers include a monitoring systems and data collections systems layer 614 having data collection and management systems 640 that collect information from a set of Internet of Things resources 1172 that collect information with respect to supply chain entities and demand management entities 652. The microservices may support various applications among a set of demand management applications 1502, a set of supply chain applications 1500, a set of intelligent product applications 1510, a set of asset management applications 1530 and a set of enterprise resource management applications 1520 for a category of goods.

In embodiments, the platform 604 may further include a machine learning/artificial intelligence system 1160 that includes a sensor recommendation system 1750 that is configured to generate recommendations for placing an additional sensor 1462 and/or camera on and/or in proximity to a value chain network entity 652. For example, in some embodiments, the sensor recommendation system 1750 may generate recommendations by using load, array of signals, emergent situations, frequency response, maintenance, diagnosis, etc. Data from the additional sensor 1462 and/or camera may feed into a digital twin 1700 that represents a set of value chain entities 652. In embodiments, the set of Internet of Things resources that collect information with respect to supply chain entities and demand management entities collects information from entities of any of the types described throughout this disclosure and in the documents incorporated by reference herein.

In embodiments, the set of Internet of Things resources may be of a wide variety of types such as, without limitation, camera systems, lighting systems, motion sensing systems, weighing systems, inspection systems, machine vision systems, environmental sensor systems, onboard sensor systems, onboard diagnostic systems, environmental control systems, sensor-enabled network switching and routing systems, RF sensing systems, magnetic sensing systems, pressure monitoring systems, vibration monitoring systems, temperature monitoring systems, heat flow monitoring systems, biological measurement systems, chemical measurement systems, ultrasonic monitoring systems, radiography systems, LIDAR-based monitoring systems, access control systems, penetrating wave sensing systems, SONAR-based monitoring systems, radar-based monitoring systems, computed tomography systems, magnetic resonance imaging systems, network monitoring systems, or others.

In embodiments, the set of Internet of Things resources includes a set of camera systems. In embodiments, the set of Internet of Things resources includes a set of lighting systems. In embodiments, the set of Internet of Things resources includes a set of machine vision systems. In embodiments, the set of Internet of Things resources includes a set of motion sensing systems.

In embodiments, the set of Internet of Things resources includes a set of weighing systems. In embodiments, the set of Internet of Things resources includes a set of inspection systems. In embodiments, the set of Internet of Things resources includes a set of environmental sensor systems. In embodiments, the set of Internet of Things resources includes a set of onboard sensor systems.

In embodiments, the set of Internet of Things resources includes a set of onboard diagnostic systems. In embodiments, the set of Internet of Things resources includes a set of environmental control systems. In embodiments, the set of Internet of Things resources includes a set of sensor-enabled network switching and routing systems. In embodiments, the set of Internet of Things resources includes a set of RF sensing systems. In embodiments, the set of Internet of Things resources includes a set of magnetic sensing systems.

In embodiments, the set of Internet of Things resources includes a set of pressure monitoring systems. In embodiments, the set of Internet of Things resources includes a set of vibration monitoring systems. In embodiments, the set of Internet of Things resources includes a set of temperature monitoring systems. In embodiments, the set of Internet of Things resources includes a set of heat flow monitoring systems. In embodiments, the set of Internet of Things resources includes a set of biological measurement systems.

In embodiments, the set of Internet of Things resources includes a set of chemical measurement systems. In embodiments, the set of Internet of Things resources includes a set of ultrasonic monitoring systems. In embodiments, the set of Internet of Things resources includes a set of radiography systems. In embodiments, the set of Internet of Things resources includes a set of LIDAR-based monitoring systems. In embodiments, the set of Internet of Things resources includes a set of access control systems.

In embodiments, the set of Internet of Things resources includes a set of penetrating wave sensing systems. In embodiments, the set of Internet of Things resources includes a set of SONAR-based monitoring systems. In embodiments, the set of Internet of Things resources includes a set of radar-based monitoring systems. In embodiments, the set of Internet of Things resources includes a set of computed tomography systems. In embodiments, the set of Internet of Things resources includes a set of magnetic resonance imaging systems. In embodiments, the set of Internet of Things resources includes a set of network monitoring systems.

### Social Data Collection Architecture

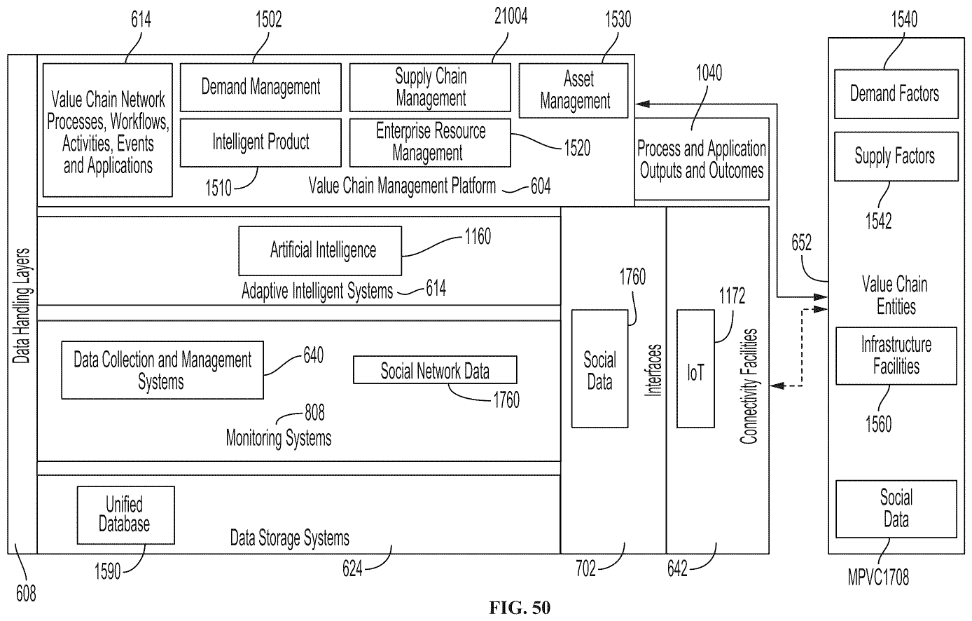

Referring to FIG. 50, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of microservices layers including an application layer supporting at least one supply chain application and at least one demand management application, wherein the microservice layers include a data collection layer that collects information from a set of social network sources that provide information with respect to supply chain entities and demand management entities.

In embodiments, the VCNP 604 may further include a set of microservices layers that include a data collection layer (e.g., monitoring systems and data collection systems layer 614) with a social data collection facility 1760 that collects information from a set of social network resources MPVC1708 that provide information with respect to supply chain entities and demand management entities. The social network data collection facilities 1760 may support various applications among a set of demand management applications 1502, a set of supply chain applications 1500, a set of intelligent product applications 1510, a set of asset management applications 1530 and a set of enterprise resource management applications 1520 for a category of goods. Social network data collection (using social network data collection facilities 1760) may be facilitated by a social data collection configuration interface, such as for configuring queries, identifying social data sources of relevance, configuring APIs for data collection, routing data to appropriate applications 630, and the like.

### Crowdsourcing Data Collection Architecture

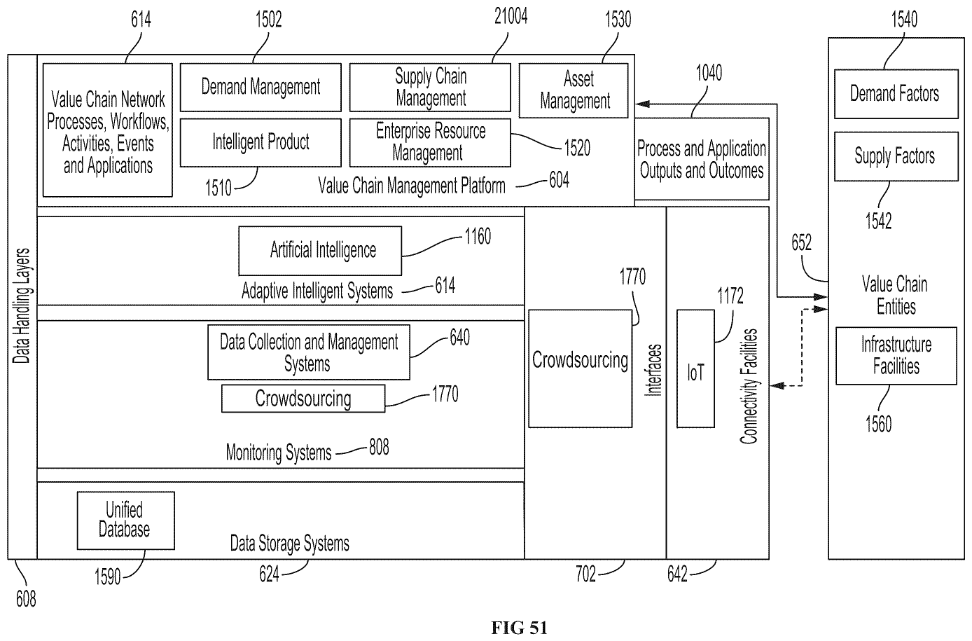

Referring to FIG. 51, an embodiment of the platform 604 is provided. As with other embodiments, the platform 604 may employ a micro-services architecture with the various data handling layers 608, a set of network connectivity facilities 642 (which may include or connect to a set of interfaces 702 of various layers of the platform 604), a set of adaptive intelligence facilities or adaptive intelligent systems 1160, a set of data storage facilities or systems 624, and a set of monitoring facilities or systems 808. The platform 604 may support a set of applications 614 (including processes, workflows, activities, events, use cases and applications) for enabling an enterprise to manage a set of value chain network entities 652, such as from a point of origin to a point of customer use of a product 1510, which may be an intelligent product.

Thus, provided herein are methods, systems, components and other elements for an information technology system that may include: a cloud-based management platform with a micro-services architecture, a set of interfaces, network connectivity facilities, adaptive intelligence facilities, data storage facilities, and monitoring facilities that are coordinated for monitoring and management of a set of value chain network entities; a set of applications for enabling an enterprise to manage a set of value chain network entities from a point of origin to a point of customer use; and a set of microservices layers including an application layer supporting at least one supply chain application and at least one demand management application, wherein the microservice layers include a data collection layer that collects information from a set of crowdsourcing resources that provide information with respect to supply chain entities and demand management entities.

In embodiments, the VCNP 604 may further include a set of microservices layers that include a monitoring systems and data collection systems layer 614 with a crowdsourcing facility 1770 that collects information from a set of crowdsourcing resources that provide information with respect to supply chain entities and demand management entities. The crowdsourcing facilities 1770 may support various applications among a set of demand management applications 1502, a set of supply chain applications 1500, a set of intelligent product applications 1510, a set of asset management applications 1530 and a set of enterprise resource management applications 1520 for a category of goods. Crowdsourcing may be facilitated by a crowdsourcing interface, such as for configuring queries, setting rewards for information, configuring workflows, determining eligibility for participation, and other elements of crowdsourcing.

### Value Chain Digital Twin Processing (DTPT)

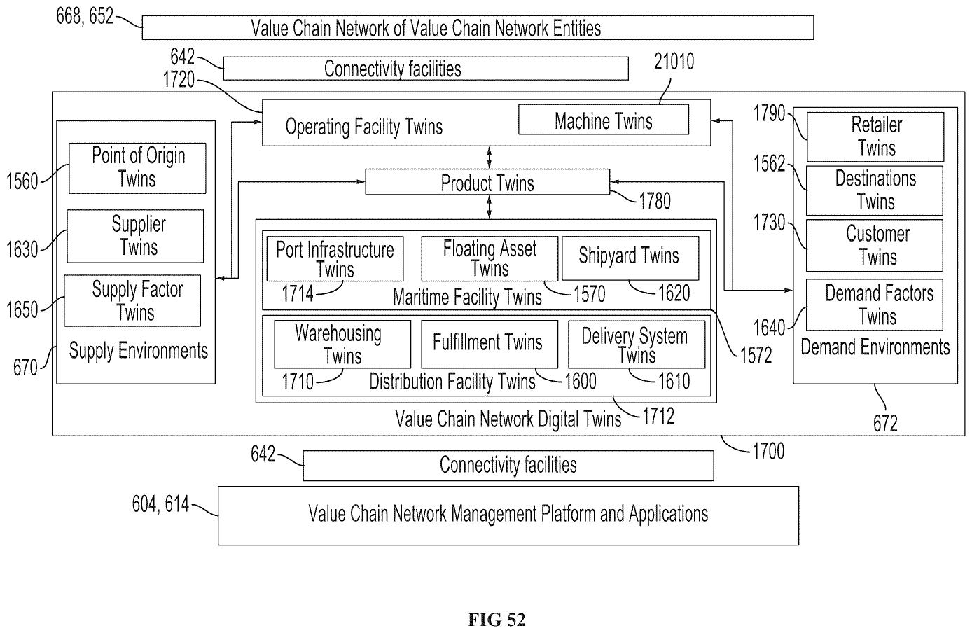

Referring now to FIG. 52 a set of value chain network digital twins 1700 representing a set of value chain network entities 652 is depicted. The digital twins 1700 are configured to simulate properties, states, operations, behaviors and other aspects of the value chain network entities 652. The digital twins 1700 may have a visual user interface, e.g., in the form of 3D models, or may consist of system specifications or ontologies describing the architecture, including components and their interfaces, of the value chain network entities 652. The digital twins 1700 may include configuration or condition of the value chain network entities 652, including data records of the past and current state of the value chain network entities 652, such as captured through sensors, through user input, and/or determined by outputs of behavioral models that describe the behavior of the value chain network entities 652. The digital twins 1700 may be updated continuously to reflect the current condition of the value chain network entities 652, based on sensor data, test and inspection results, conducted maintenance, modifications, etc. The digital twins 1700 may also be configured to communicate with a user via multiple communication channels, such as speech, text, gestures, and the like. For example, a digital twin 1700 may receive queries from a user about the value chain network entities 652, generate responses for the queries, and communicate such responses to the user. Additionally or alternatively, digital twins 1700 may communicate with one another to learn from and identify similar operating patterns and issues in other value chain network entities 652, as well as steps taken to resolve those issues. The digital twins 1700 may be used for monitoring, diagnostics, simulation, management, remote control, and prognostics, such as to optimize the individual and collective performance and utilization of value chain network entities 652.

For example, machine twins 21010 may continuously capture the key operational metrics of the machines 724 and may be used to monitor and optimize machine performance in real time. Machine twins 21010 may combine sensor, performance, and environmental data, including insights from similar machines 724, enabling prediction of life span of various machine components and informed maintenance decisions. In embodiments, machine twins 21010 may generate an alert or other warning based on a change in operating characteristics of the machine 724. The alert may be due to an issue with a component of the machine 724. Additionally, machine twins 21010 may determine similar issues that have previously occurred with the machine or similar machines, provide a description of what caused the issues, what was done to address the issues, and explain differences between the present issue and the previous issues and what actions to take to resolve the issue, etc.

Similarly, warehousing twins 1712 may combine a 3D model of the warehouse with inventory and operational data including the size, quantity, location, and demand characteristics of different products. The warehousing twins 1712 may also collect sensor data in a connected warehouse, as well as data on the movement of inventory and personnel within the warehouse. Warehousing twins 1712 may help in optimizing space utilization and aid in identification and elimination of waste in warehouse operations. The simulation using warehousing twins 1712 of the movement of products, personnel, and material handling equipment may enable warehouse managers to test and evaluate the potential impact of layout changes or the introduction of new equipment and new processes.

In embodiments, multiple digital twins of the value chain network entities 652 may be integrated, thereby aggregating data across the value chain network to drive not only entity-level insights but also system-level insights. For example, consider a simple value chain network with an operating facility 712 comprising different machines 724 including conveyors, robots, and inspection devices. The operating facility digital twin 1172 may need to integrate the data from digital twins 1770 of different machines to get a holistic picture of the complete conveyor line in the operating facility 712 (e.g., a warehouse, distribution center, or fulfillment center where packages are moved along a conveyor and inspected before being sent out for delivery. While the digital twin of conveyor line may provide insights about only its performance, the composite digital twin may aggregate data across the different machines in the operating facility 712. Thus, it may provide an integrated view of individual machines and their interactions with environmental factors in the operating facility leading to insights about the overall health of the conveyor line within the operating facility 712. As another example, the supply factor twins 1650 and demand factor twins 1640 may be integrated to create a holistic picture of demand-supply equilibrium for a product 1510. The integration of digital twins also enables the querying of multiple value chain network entities 652 and create a 360-degree view of the value chain network 668 and its various systems and subsystems.

It will be apparent that the ability to integrate digital twins of the value chain network entities 652 may be used to generate a value chain network digital twin system from a plurality of digital twin subsystems representing entities selected from among supply chain entities, demand management entities and value chain network entities. For example, a machine digital twin 1770 is comprised of multiple digital twins of sub-systems and individual components constituting the machine 724. The machine's digital twin may integrate all such component twins and their inputs and outputs to build the model of the machine. Also, for example, a distribution facility twins system 1714 may be comprised of subsystems, such as warehousing twins 1712, fulfilment twins 1600 and delivery system twins 1610.

Similarly, the process digital twin may be seen as comprised of digital twins of multiple sub-processes representing entities selected from among supply chain entities, demand management entities and value chain network entities. For example, the digital twin of a packaging process is comprised of digital twins of sub-processes for picking, moving, inspecting and packing the product. As another example, the digital twin of warehousing process may be seen as comprised of digital twins of multiple sub-processes including receiving, storing, picking and shipping of stored inventories.

It will be apparent that a value chain network digital twin system may be generated from a plurality of digital twin subsystems or conversely a digital twin subsystem may be generated from a digital twin system, wherein at least one of the digital twin subsystem and the digital twin system represents entities selected from among supply chain entities, demand management entities and value chain network entities.

Similarly, a value chain network digital twin process may be generated from a plurality of digital twin sub-processes or conversely digital twin sub-process generated from a digital twin process wherein at least one of the digital twin sub-process and the digital twin process represents entities selected from among supply chain entities, demand management entities and value chain network entities.

The analytics obtained from digital twins 1700 of the value chain network entities 652 and their interactions with one another provide a systemic view of the value chain network as well as its systems, sub-systems, processes and sub-processes. This may help in generating new insights into ways the various systems and processes may be evolved to improve their performance and efficiency.

In embodiments, the platform 604 and applications 630 may have a system for generating and updating a self-expanding digital twin that represents a set of value chain entities. The self-expanding digital twin continuously keeps learning and expanding in scope, with more and more data it collects and scenarios it encounters. As a result, the self-expanding twin can evolve with time and take on more complex tasks and answer more complex questions posed by a user of the self-expanding digital twin.

In embodiments, the platform 604 and applications 630 may have a system for scheduling the synchronization of a physical value chain entity's changing condition to a digital twin that represents a set of value chain entities. In embodiments, the synchronization between the physical value chain entity and its digital twin is on a near real-time basis.

In embodiments, the platform 604 and applications 630 may have an application programming interface for extracting, sharing, and/or harmonizing data from information technology systems associated with multiple value chain network entities that contribute to a single digital twin representing a set of value chain entities.

In embodiments, value chain network management platform 604 may include various subsystems that may be implemented as micro services, such that other subsystems of the system access the functionality of a subsystem providing a micro service via application programming interface API. In some embodiments, the various services that are provided by the subsystems may be deployed in bundles that are integrated, such as by a set of APIs.

In embodiments, value chain network management platform 604 may include a set of microservices for managing a set of value chain network entities for an enterprise and having a set of processing capabilities for at least one of creating, modifying, and managing the parameters of a digital twin that is used in the platform to represent a set of value chain network entities.

### Value Chain Digital Twin Kit (DTIB)

The value chain network management platform may provide a digital twin sub-system in the form of an out-of-the-box kit system with self-configuring capabilities. The kit may provide a data-rich and interactive overview of a set of value chain network entities constituting the sub-system. For example, a supply chain out-of-the-box digital twin kit system may represent a set of supply chain entities that are linked to the identity of an owner or operator of the supply chain entities. The owner or operator of the supply chain entity may then use the kit to get a holistic picture of its complete portfolio. The owner may investigate for information related to various supply chain entities and ask interactive questions from the digital twin kit system.

In embodiments, a demand management out-of-the-box digital twin kit system may represent a set of demand management entities that are linked to the identity of an owner or operator of the demand management entities.

In embodiments, a value chain network digital twin kit system for providing out-of-the-box, self-configuring capabilities may represent a set of demand management entities and a set of supply chain entities that are linked to the identity of an owner or operator of the demand management entities and the supply chain entities.

In embodiments, a warehouse digital twin kit system for providing out-of-the-box, self-configuring capabilities may represent a set of warehouse entities that are linked to the identity of an owner or operator of the warehouse.

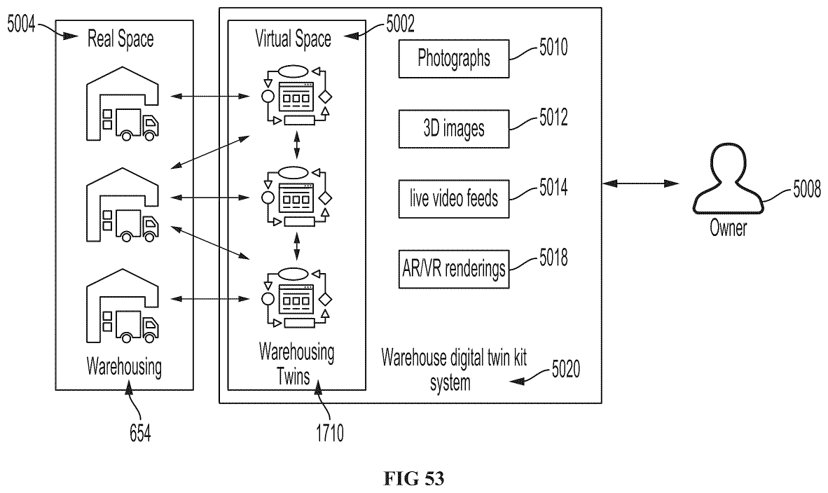

Referring now to FIG. 53, an example warehouse digital twin kit system 5000 is depicted. The warehouse digital twin kit system 5000 includes warehousing twins in the virtual space 5002 representing models of warehouses 654 in the real space 5004.

The warehouse digital twin kit system 5000 allows an owner or operator 5008 of the one or more warehouse entities 654 to get complete portfolio overview of all these entities-existing or in design or construction. The owner 5008 may navigate a wealth of information including warehouse photographs 5010, 3D images 5012, live video feeds 5014 of real-time construction progress and AR or VR renderings 5018 of the warehousing entities 654. The owner 5008 may investigate about the health of one or more entities 654 and ask interactive questions and search for detailed information about one or more warehouse entities 654. The warehouse digital twin kit system 5000 has access to real time dynamic data captured by IoT devices and sensors at warehouse entities 654 and may be supported with natural language capabilities enabling it to interact with the owner 5008 and answer any questions about the condition of the warehouse entities 654.

In embodiments, warehouse digital twin kit system 5000 may provide the portfolio overview of warehouse entities 654 to owner 5008 in the form of a 3D information map containing all the warehouse entities 654. Owner 5008 may select a specific entity on the map and get information about inventory, operational and health data from the warehousing twin 1710. Alternatively, the owner 5008 may ask for information about the overall portfolio of warehouse entities 654 owned. The warehouse digital twin kit system 5000 consolidates information from the multiple warehousing twins 1710 and provides a holistic view. The consolidated view may help owner 5008 to optimize operations across warehouse entities 654 by adjusting stock locations and staffing levels to match current or forecasted demand. The owner 5008 may also display the information from warehouse digital twin kit system 5000 on a website or marketing material to be accessed by any customers, suppliers, vendors and other partners.

In embodiments, a container ship digital twin kit system for providing out-of-the-box, self-configuring capabilities may represent a set of container ship entities that are linked to the identity of an owner or operator of the container ship.

In embodiments, a port infrastructure digital twin kit system for providing out-of-the-box, self-configuring capabilities may represent a set of port infrastructure entities that are linked to the identity of an owner or operator of the port infrastructure.

### Value Chain Compatibility Testing (VCCT)

The platform 604 may deploy digital twins 1700 of value chain network entities 652 for testing the compatibility between different value chain network entities 652 interacting with one another and forming various systems and subsystems of the value chain network.

This brings visibility to the compatibility and performance of various systems and subsystems within the value chain network before there are any physical impacts. Any incompatibilities or performance deficiencies of different value chain network entities 652 may be highlighted through digital models and simulations rather than having to rely on physical systems to perform such tests which is both expensive and impractical.

The digital twin 1700 may make use of artificial intelligence systems 1160 (including any of the various expert systems, artificial intelligence systems, neural networks, supervised learning systems, machine learning systems, deep learning systems, and other systems described throughout this disclosure and in the documents incorporated by reference) for carrying out the compatibility testing in the value chain network.

In embodiments, the platform may provide a system for testing compatibility or configuration of a set of vendor components for a container ship using a set of digital twins representing the container ship and the vendor components.

In embodiments, the platform may provide a system for testing compatibility or configuration of a set of vendor components for a warehouse using a set of digital twins representing the warehouse and the vendor components.

In embodiments, the platform may provide a system for testing compatibility or configuration of a set of vendor components for a port infrastructure facility using a set of digital twins representing the port infrastructure facility and the vendor components.

In embodiments, the platform may provide a system for testing compatibility or configuration of a set of vendor components for a shipyard facility using a set of digital twins representing the shipyard facility and the vendor components.

In embodiments, the platform may provide a system for testing compatibility or configuration of a container ship and a set of port infrastructure facilities using a set of digital twins representing the container ship and the port infrastructure facility.

In embodiments, the platform may provide a system for testing compatibility or configuration of a barge and a set of waterways for a navigation route using a set of digital twins representing the barge and the set of waterways.

In embodiments, the platform may provide a system for testing compatibility or configuration of a container ship and a set of cargo for an identified shipment using a set of digital twins representing the container ship and the cargo.

In embodiments, the platform may provide a system for testing compatibility or configuration of a barge and a set of cargo for an identified shipment using a set of digital twins representing the barge and the cargo.

In embodiments, the platform may provide a system for testing compatibility or configuration of a set of cargo handling infrastructure facilities and a set of cargo for an identified shipment using a set of digital twins representing the cargo handling infrastructure facilities and the cargo.

### Value Chain Infrastructure Testing (VCIT)

The platform 604 may deploy digital twins 1700 of value chain network entities 652 to perform stress tests on a set of value chain network entities. The digital twins may help simulate behavior of value chain network systems and sub-systems in a wide variety of environments. The stress tests may help run any “what-if” scenarios to understand the impact of change in relevant parameters beyond normal operating values and evaluate the resilience of the infrastructure of value chain network.

The platform 604 may include a system for learning on a training set of outcomes, parameters, and data collected from data sources relating to a set of value chain network activities to train artificial intelligence systems 1160 (including any of the various expert systems, artificial intelligence systems, neural networks, supervised learning systems, machine learning systems, deep learning systems, and other systems described throughout this disclosure and in the documents incorporated) for performing such stress tests on the value chain network.

In embodiments, the platform may include a system for learning on a training set of machine outcomes, parameters, and data collected from data sources relating to a set of value chain network activities to train an artificial intelligence/machine learning system to perform stress tests on the machine using a digital twin that represents a set of value chain entities.

As described, the value chain network comprises a plurality of interrelated sub-systems and sub-processes that manage and control all aspects associated with the production and delivery of a finished product to an end-user—from the acquisition and distribution of raw materials between a supplier and a manufacturer, through the delivery, distribution, and storage of materials for a retailer or wholesaler, and, finally, to the sale of the product to an end-user. The complex interconnected nature of the value chain network means that an adverse event within one subsystem or one or more value chain entities reflect through the entire value chain network.

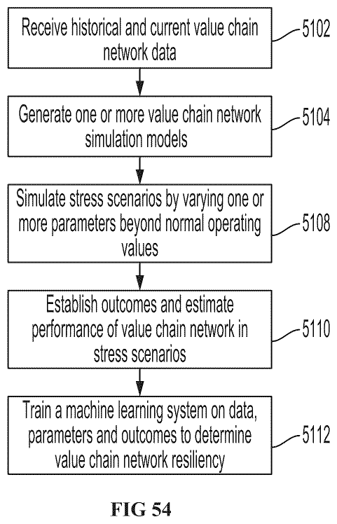

FIG. 54 is an example method for performing a stress test on the value chain network. The stress test may comprise a simulation exercise to test the resilience of the value chain network (including its subsystems) and determine its ability to deal with an adverse scenario, say a natural calamity, a congested route, a change in law, or a deep economic recession. Such adverse or stress scenarios may affect one or more entities or subsystems within the value chain network depending on the nature of the scenario. Hence, any stress tests would require simulating scenarios and analyzing the impact of different scenarios across different subsystems and on the overall value chain network.

At 5102, all historical and current data related to the value chain network are received. The data may include information related to various operating parameters of the value chain network over a particular historical time period, say last 12 months. The data may also provide information on the typical values of various operating parameters under normal conditions. Some examples of operating parameters include: product demand, procurement lead time, productivity, inventory level at one or more warehouses, inventory turnover rates, warehousing costs, average time to transport product from warehouse to shipping terminals, overall cost of product delivery, service levels, etc. At 5104, one or more simulation models of value chain network are created based on the data. The simulation models help in visualizing the value chain network as a whole and in predicting how changes in operating parameters affect the operation and performance of the value chain network. In embodiments, the simulation model may be a sum of multiple models of different subsystems of the value chain network.

At 5106, one or more stress scenarios may be simulated by changing one or more parameters beyond the normal operating values. The simulating of stress scenarios overcome the limitation of any analysis based only on historical data and helps analyze the network performance across a range of hypothetical yet plausible stress conditions. The simulation involves varying (shocking) one or more parameters while keeping the other parameters as fixed to analyze the impact of such variations on value chain network. In embodiments, a single parameter may be varied while keeping remaining parameters as fixed. In other embodiments, multiple parameters may be varied simultaneously. At 5108, the outcomes of stress scenario simulations are determined, and the performance of value chain network and its different subsystems is estimated across various scenarios. At 5110, the data, parameters and outcomes are fed into a machine learning process in the artificial intelligence system 1160 for further analysis.

An advantage of generating data through simulations and then training machine learning algorithms on this data is the control this approach provides on the features in the data as well as volume and frequency of data.

In embodiments, the platform may include a system for learning on a training set of outcomes, parameters, and data collected from data sources relating to a set of value chain network activities to train an artificial intelligence/machine learning system to perform stress tests on a physical object using a digital twin that represents a set of value chain entities.

In embodiments, the platform may include a system for learning on a training set of outcomes, parameters, and data collected from data sources relating to a set of value chain network activities to train an artificial intelligence/machine learning system to perform stress tests on a telecommunications network using a digital twin that represents a set of value chain entities in a connected network of entities and the telecommunications network.

For example, the telecommunications network may be stress tested for resiliency by deliberately increasing network traffic by generating and sending data packets to a specific target node within the telecommunications network. Further, the amount of traffic may be varied to create varying load conditions on the target node by manipulating the number, rate or amount of data in the data packets. The response from the target node may be determined to evaluate how the node performed in the stress test. The target node may be selected at different parts of the telecommunications network for stress testing so as to test robustness of any portion of the network in any topology. The simulated stress tests on the telecommunications network may be utilized to identify vulnerabilities in any portion of a network so that the vulnerability can be rectified before users experience network outages in a deployed network.

In embodiments, the platform may include a system for using a digital twin that represents a set of value chain entities in a demand management environment to perform a set of stress tests on a set of workflows in the demand management environment using the digital twin, wherein the stress tests represent impacts in the digital twin of varying a set of demand-relevant parameters to levels that exceed normal operating levels. For example, the demand of a product in the value chain network may be affected by factors like changes in consumer confidence, recessions, excessive inventory levels, substitute product pricing, overall market indices, currency exchange changes, etc. The demand factors twin 1640 may simulate such scenarios by varying supply parameters and evaluate the impact of such stresses on the demand environments 672. The stress tests performed using the digital twins may help in testing and evaluating the resiliency of the value chain network both in cases of over-demand and under-demand.

In embodiments, the platform may include a system for using a digital twin that represents a set of value chain entities in the supply chain to perform a set of stress tests on a set of workflows in the supply chain using the digital twin, wherein the stress tests represent impacts in the digital twin of varying a set of supply chain-relevant parameters to levels that exceed normal operating levels. For example, the supply of a product in the value chain network may be affected by factors like weather, natural calamities, traffic congestion, regulatory changes including taxes and subsidies and border restrictions, etc. The supply factors twin 1650 may simulate such scenarios by varying supply parameters and evaluate the impact of such stresses on the supply environments 670. The stress tests performed using the digital twins may help in testing and evaluating the resiliency of the value chain network both in cases of over-supply and under-supply.

### Value Chain Incident Management (VCIM)

The platform 604 may deploy digital twins 1700 of value chain network entities 652 for automatically managing a set of incidents relating to a set of value chain network entities and activities. The incidents may include any events causing disruption to the value chain network like accidents, fires, explosions, labor strikes, increases in tariffs, changes in law, changes in market prices (e.g., of fuel, components, materials, or end products), changes in demand, activities of cartels, closures of borders or routes, and/or natural events and/or disasters (including storms, heat waves, winds, earthquakes, floods, hurricanes, tsunamis, etc.), among many others.

Also, the platform 604 may provide real-time visualization and analysis of mobility flows in the value chain network. This may help in quantifying risks, improving visibility and reacting to the disruptions in the value chain network. For example, real-time visualization of a utility flow for shipping activities using a digital twin may help in detecting the occurrence and location of an emergency involving a shipping system and deploying emergency services to the detected location.

In embodiments, the platform may deploy digital twins 1700 of value chain network entities 652 for more accurate determination of accident fault. The platform may learn on a training set of accident outcomes, parameters, and data collected from the monitoring layer 614 and data sources of the data storage layer 624 to train artificial intelligence system 1160 using a set of digital twins 1700 of involved value chain network entities 652 to determine accident fault. For example, data from digital twins of two colliding vehicles may be compared with each other in addition to data from the drivers, witnesses and police reports to determine accident fault.

In embodiments, the platform may include a system for learning on a training set of vehicular event outcomes, parameters, and data collected from data sources related to a set of value chain network entities 652 to train artificial intelligence system 1160 to use a digital twins 1700 of a selected set of value chain network entities 652 to detect an incidence of fraud. For example, comparing vehicular event data from digital twins of vehicles to any insurance claims, contract claims, maritime claims on such vehicles may help in detecting any mismatch in the two.

In embodiments, the platform may include a system for learning on a training set of vehicle outcomes, parameters, and data collected from data sources related to a set of value chain network entities 652 to train artificial intelligence system 1160 to use a digital twin 1700 of a selected set of value chain network entities 652 to detect unreported abnormal events with respect to selected set of value chain network entities 652. Consider an example where the digital twin of a vehicle shows an abnormal event like an accident but this event has not been reported by the driver of the vehicle. The unreported event may be added to the record of the vehicle and the driver by a lessor of the vehicle. Also, the lessor of the vehicle may charge the lessee for repairs or diminished value of the vehicle at lease-end and adjust residual value forecast for the same. Similarly, an insurer may add the unreported event to the record of the vehicle and the driver. The reporting may be as detailed as the exact nature, timing, location, fault, etc. of the accident or just the fact there was unreported accident. This information may then be used for calculating the insurance premium.

Finally, in case there are multiple entities involved in the accident, the data may be triangulated with the digital twin of another entity for validation.

### Value Chain Predictive Maintenance (PMVC)

The platform 604 may deploy digital twins 1700 of value chain network entities 652 to predict when a set of value chain network entities should receive maintenance.

The digital twin may predict the anticipated wear and failure of components of a system by reviewing historical and current operational data thereby reducing the risk of unplanned downtime and the need for scheduled maintenance. Instead of over-servicing or over-maintaining products to avoid costly downtime, repairs or replacement, any product performance issues predicted by the digital twin may be addressed in a proactive or just-in-time manner.

The digital twins 1700 may collect events or state data about value chain entities 652 from the monitoring layer 614 and historical or other data from selected data sources of the data storage layer 624. Predictive analytics powered by the artificial intelligence system 1160 dissect the data, search for correlations, and formulate predictions about maintenance need and remaining useful life of a set of value chain entities 652.

The platform 604 may include a system for learning on a training set of outcomes, parameters, and data collected from data sources relating to a set of value chain network activities to train artificial intelligence systems 1160 (including any of the various expert systems, artificial intelligence systems, neural networks, supervised learning systems, machine learning systems, deep learning systems, and other systems described throughout this disclosure and in the documents incorporated) for performing condition monitoring, anomaly detection, failure forecasting and predictive maintenance of a set of value chain entities 652.

In embodiments, the platform may include a system for learning on a training set of machine maintenance outcomes, parameters, and data collected from data sources relating to a set of machine activities to train an artificial intelligence/machine learning system to perform predictive maintenance on a machine using a digital twin of the machine.

In embodiments, artificial intelligence system 1160 may train models, such as predictive models (e.g., various types of neural networks, classification-based models, regression based models, and other machine-learned models). In embodiments, training can be supervised, semi-supervised, or unsupervised. In embodiments, training can be done using training data, which may be collected or generated for training purposes.

An example artificial intelligence system 1160 trains a machine predictive maintenance model. A predictive maintenance model may be a model that receives machine related data and outputs one or more predictions or answers regarding the remaining life of the machine. The training data can be gathered from multiple sources including machine specifications, environmental data, sensor data, run information, outcome data and notes maintained by machine operators. The artificial intelligence system 1160 takes in the raw data, pre-processes it and applies machine learning algorithms to generate the predictive maintenance model. In embodiments, the artificial intelligence system 1160 may store the predictive model in a model datastore within data storage layer 624.

Some examples of questions that the predictive model may answer are: when will the machine fail, what type of failure it will be, what is the probability that a failure will occur within the next X hours, what is the remaining useful life of the machine, is the machine behaving in an uncharacteristic manner, which machine requires maintenance most urgently and the like.

The artificial intelligence system 1160 may train multiple predictive models to answer different questions. For example, a classification model may be trained to predict failure within a given time window, while a regression model may be trained to predict the remaining useful life of the machine.

In embodiments, training may be done based on feedback received by the system, which is also referred to as “reinforcement learning.” In embodiments, the artificial intelligence system 1160 may receive a set of circumstances that led to a prediction (e.g., attributes of a machine, attributes of a model, and the like) and an outcome related to the machine and may update the model according to the feedback.

In embodiments, artificial intelligence system 1160 may use a clustering algorithm to identify the failure pattern hidden in the failure data to train a model for detecting uncharacteristic or anomalous behavior. The failure data across multiple machines and their historical records may be clustered to understand how different patterns correlate to certain wear-down behavior and develop a maintenance plan resonant with the failure.

In embodiments, artificial intelligence system 1160 may output scores for each possible prediction, where each prediction corresponds to a possible outcome. For example, in using a predictive model used to determine a likelihood that a machine will fail in the next one week, the predictive model may output a score for a “will fail” outcome and a score for a “will not fail” outcome. The artificial intelligence system 1160 may then select the outcome with the greater score as the prediction. Alternatively, the system 1160 may output the respective scores to a requesting system. In embodiments, the output from system 1160 includes a probability of the prediction's accuracy.

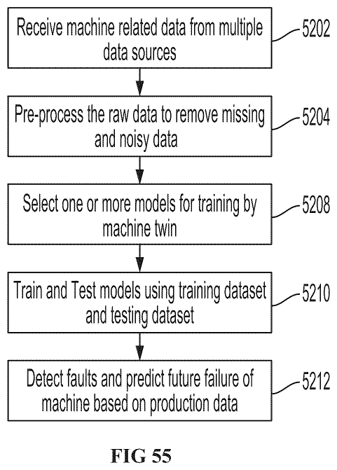

FIG. 55 is an example method used by machine twin 1770 for detecting faults and predicting any future failures of machine 724.

At 5202, a plurality of streams of machine related data from multiple data sources are received at the machine twin 1770. This includes machine specifications like mechanical properties, data from maintenance records, operating data collected from the sensors, historical data including failure data from multiple machines running at different times and under different operating conditions and so on. At 5205, the raw data is cleaned by removing any missing or noisy data, which may occur due to any technical problems in the machine at the time of collection of data. At 5208, one or more models are selected for training by machine twin 1770. The selection of model is based on the kind of data available at the machine twin 1770 and the desired outcome of the model. For example, there may be cases where failure data from machines is not available, or only a limited number of failure datasets exist because of regular maintenance being performed. Classification or regression models may not work well for such cases and clustering models may be most suitable. As another example, if the desired outcome of the model is determining current condition of the machine and detecting any faults, then fault detection models may be selected, whereas if the desired outcome is predicting future failures then remaining useful life prediction model may be selected. At 5210, the one or more models are trained using training dataset and tested for performance using testing dataset. At 5212, the trained model is used for detecting faults and predicting future failure of the machine on production data.

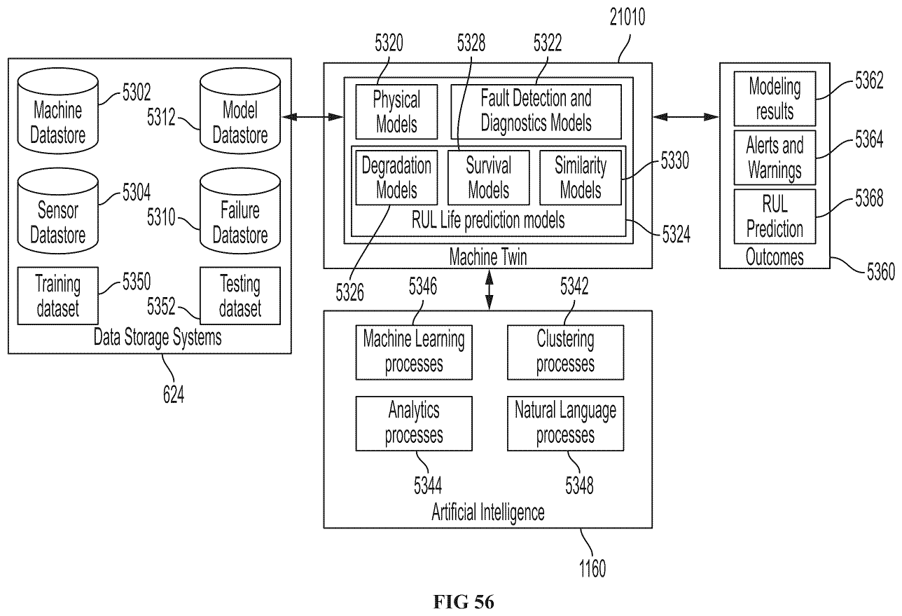

FIG. 56 is an example embodiment depicting the deployment of machine twins 21010 perform predictive maintenance on machines 724. Machine twin 1770 receives data from data storage systems 624 on a real-time or near real-time basis. The data storage systems 624 may store different types of data in different datastores. For example, machine datastore 5202 may store data related to machine identification and attributes, machine state and event data, data from maintenance records, historical operating data, notes from machine operator, etc. Sensor datastore 5204 may store sensor data from operation such as temperature, pressure, and vibration that may be stored as signal or time series data. Failure datastore 5310 may store failure data from machine 724 or similar machines running at different times and under different operating conditions. Model datastore 5312 may store data related to different predictive models including fault detection and remaining life prediction models.

Machine twin 1770 then coordinates with artificial intelligence system to select one or more of models based on the kind and quality of available data and the desired answers or outcomes. For example, physical models 5320 may be selected if the intended use of machine twin 1770 is to simulate what-if scenarios and predict how the machine will behave under such scenarios. Fault Detection and Diagnostics Models 5322 may be selected to determine the current health of the machine and any fault conditions. A simple fault detection model may use one or more condition indicators to distinguish between regular and faulty behaviors and may have a threshold value for the condition indicator that is indicative of a fault condition when exceeded. A more complex model may train a classifier to compare the value of one or more condition indicators to values associated with fault states and returns the probability of presence of one or more fault states.

Remaining Useful Life (RUL) Prediction models 5324 are used for predicting future failures and may include degradation models 5326, survival models 5328 and similarity models 5330. An example RUL prediction model may fit the time evolution of a condition indicator and predicts how long it will be before the condition indicator crosses some threshold value indicative of a failure. Another model may compare the time evolution of the condition indicator to measured or simulated time series from similar systems that ran to failure.

In embodiments, a combination of one or more of these models may be selected by the machine twin 1770.

Artificial Intelligence system 1160 may include machine learning processes 5340, clustering processes 5342, analytics processes 5344 and natural language processes 5348. Machine learning processes 5340 work with machine twin 1770 to train one or more models as identified above. An example of such machine learned model is the RUL prediction model 5324. The model 5324 may be trained using training dataset 5350 from the Data Storage Systems 624. The performance of the model 5324 and classifier may then be tested using testing dataset 5350.

Clustering processes 5342 may be implemented to identify the failure pattern hidden in the failure data to train a model for detecting uncharacteristic or anomalous behavior. The failure data across multiple machines and their historical records may be clustered to understand how different patterns correlate to certain wear-down behavior. Analytics processes 5344 perform data analytics on various data to identify insights and predict outcomes. Natural language processes 4348 coordinate with machine twin 1770 to communicate the outcomes and results to the user of machine twin 1770.

The outcomes 5360 may be in the form of modeling results 5362, alerts and warnings 5364 or remaining useful life (RUL) predictions 5368. Machine twin 1770 may communicate with a user via multiple communication channels such as speech, text, gestures to convey outcomes 5360.

In embodiments, models may then be updated or reinforced based on the model outcomes 5360. For example, the artificial intelligence system may receive a set of circumstances that led to a prediction of failure and the outcome and may update the model based on the feedback.

In embodiments, the platform may include a system for learning on a training set of ship maintenance outcomes, parameters, and data collected from data sources relating to a set of ship activities to train an artificial intelligence/machine learning system to perform predictive maintenance on a ship using a digital twin of the ship.

In embodiments, the platform may include a system for learning on a training set of barge maintenance outcomes, parameters, and data collected from data sources relating to a set of barge activities to train an artificial intelligence/machine learning system to perform predictive maintenance on a barge using a digital twin of the barge.

In embodiments, the platform may include a system for learning on a training set of port maintenance outcomes, parameters, and data collected from data sources relating to a set of port activities to train an artificial intelligence/machine learning system to perform predictive maintenance on a port infrastructure facility using a digital twin of the port infrastructure facility.

In embodiments, the platform may include a system for learning on a training set of repair outcomes, parameters, and data collected from data sources related to a set of value chain entities to train an artificial intelligence/machine learning system to use a digital twin of a selected set of value chain entities to estimate the cost of repair of a damaged object.

In embodiments, the platform may include a system for learning on a training set of infrastructure outcomes, parameters, and data collected from data sources to train an artificial intelligence/machine learning system to predict deterioration of infrastructure using a digital twin of the infrastructure.

In embodiments, the platform may include a system for learning on a training set of natural hazard outcomes, parameters, and data collected from data sources relating to a set of shipping activities to train an artificial intelligence/machine learning system to model natural hazard risks for a set of shipping infrastructure facilities using a digital twin of a city.

In embodiments, the platform may include a system for learning on a training set of maintenance outcomes, parameters, and data collected from data sources relating to a set of shipping activities to train an artificial intelligence/machine learning system to monitor shipping infrastructure maintenance activities for a set of shipping infrastructure facilities using a digital twin of the set of facilities

In embodiments, the platform may include a system for learning on a training set of maintenance outcomes, parameters, and data collected from data sources relating to a set of shipping activities to train an artificial intelligence/machine learning system to detect the occurrence and location of a maintenance issue using a digital twin of a set of shipping infrastructure facilities and having a system for automatically deploying maintenance services to the detected location.

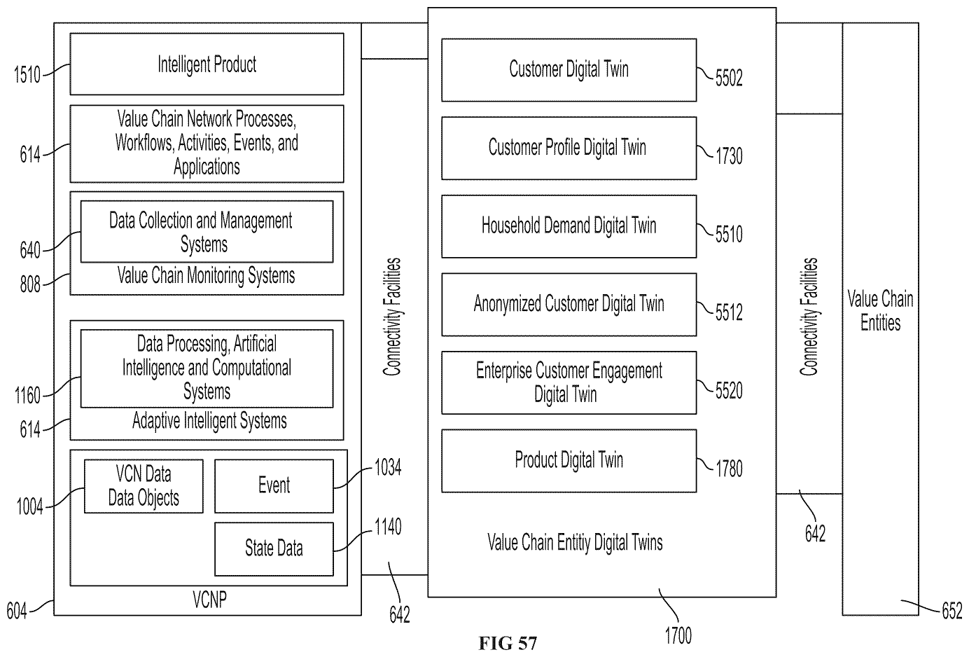

Referring to FIG. 57, the platform 604 may include, integrate, integrate with, manage, control, coordinate with, or otherwise handle customer digital twins 5502 and/or customer profile digital twins 1730.

Customer digital twins 5502 may represent evolving, continuously updated digital representations of value chain network customers 662. In embodiments, value chain network customers 662 include consumers, licensees, businesses, enterprises, value-added resellers and other resellers, distributors, retailers (including online retailers, mobile retailers, conventional brick and mortar retailers, pop-up shops and the like), end users, and others who may purchase, license, or otherwise use a category of goods and/or related services.

Customer profile digital twins 1730, on the other hand, may represent one or more demographic (age, gender, race, marital status, number of children, occupation, annual income, education level, living status (homeowner, renter, and the like) psychographic, behavioral, economic, geographic, physical (e.g., size, weight, health status, physiological state or condition, or the like) or other attributes of a set of customers. In embodiments, customer profile digital twins 1730 may be enterprise customer profile digital twins that represent attributes of a set of enterprise customers. In embodiments, a customer profiling application may be used to manage customer profiles 5504 based on historical purchasing data, loyalty program data, behavioral tracking data (including data captured in interactions by a customer with an intelligent product 1510), online clickstream data, interactions with intelligent agents, and other data sources.

Customers 662 can be depicted in a set of one or more customer digital twins 5502, such as by populating the customer digital twin 1730 with value chain network data objects 1004, such as event data 1034, state data 1140, or other data with respect to value chain network customers 662. Likewise, customer profiles 5504 can be depicted in a set of one or more customer profile digital twins 1730, such as by populating the customer profile digital twins 1730 with value chain network data objects 1004, such as described throughout this disclosure.

Customer digital twins 5502 and customer profile digital twins 1730 may allow for modeling, simulation, prediction, decision-making, classification, and the like.

Where customers 662 are consumers, for example, the respective customer digital twins 1730 may be populated with identity data, account data, payment data, contact data, age data, gender data, race data, location data, demographic data, living status data, mood data, stress data, behavior data, personality data, interest data, preference data, style data, medical data, physiological data, phycological data, physical attribute data, education data, employment data, salary data, net worth data, family data, household data, relationship data, pet data, contact/connection data (such as mobile phone contacts, social media connections, and the like), transaction history data, political data, travel data, product interaction data, product feedback data, customer service interaction data (such as a communication with a chatbot, or a telephone communication with a customer service agent at a call center), fitness data, sleep data, nutrition data, software program interaction observation data 1500 (e.g., by customers interacting with various software interfaces of applications 630 involving value chain entities 652) and physical process interaction observation data 1510 (e.g., by watching customers interacting with products or other value chain entities 652), and the like.

In another example, where customers 662 are enterprises or businesses, the customer digital twin 1730 may be populated with identity data, account data, payment data, transaction data, product feedback data, location data, revenue data, enterprise type data, product and/or service offering data, worker data (such as identity data, role data, and the like), and other enterprise-related attributes.

Customer digital twins and customer profile digital twins 1730 may include a set of components, processes, services, interfaces, and other elements for development and deployment of digital twin capabilities for visualization of value chain network customers 662 and customer profiles 5504 as well as for coordinated intelligence (including artificial intelligence system 1160, edge intelligence, analytics and other capabilities) and other value-added services and capabilities that are enabled or facilitated with digital twins.

In embodiments, the customer digital twins 5502 and customer profile digital twins 1730 may take advantage of the presence of multiple applications 630 within the value chain management platform 604, such that a pair of applications may share data sources (such as in the data storage layer 624) and other inputs (such as from the monitoring layer 614) that are collected with respect to value chain entities 652, as well as sharing events, state information and outputs, which collectively may provide a much richer environment for enriching content in the digital twins, including through use of artificial intelligence system 1160 (including any of the various expert systems, artificial intelligence systems, neural networks, supervised learning systems, machine learning systems, deep learning systems, and other systems described throughout this disclosure and in the documents incorporated by reference) and through use of content collected by the monitoring layer 614 and data collection systems 640.

An environment for development of a customer digital twin 5502 may include a set of interfaces for developers in which a developer may configure an artificial intelligence system 1160 to take inputs from selected data sources of the data storage layer 624 and events or other data from the monitoring systems layer 614 and supply them for inclusion in a customer digital twin 5502. A customer digital twin development environment may be configured to take outputs and outcomes from various applications 630. In embodiments, a customer digital twin 1730 may be provided for the wide range of value chain network applications 630 mentioned throughout this disclosure and the documents incorporated herein by reference.

In embodiments, the customer digital twin 5502 may be rendered by a computing device, such that a user can view a digital representation of the customer 714. For example, a customer digital twin 5502 may be rendered and output to a display device. In another example, a 5502 may be rendered in a three-dimensional environment and viewed using a virtual reality headset.

An environment for development of the customer profile digital twin 1730 may include a set of interfaces for developers in which a developer may configure an artificial intelligence system 1160 to take inputs from selected data sources of the data storage layer 624 and events or other data from the monitoring systems layer 614 and supply them for inclusion in the customer profile digital twin 1730. A customer profile digital twin development environment may be configured to take outputs and outcomes from various applications 630. In embodiments, the customer profile digital twin 1730 may be provided for the wide range of value chain network applications 630 mentioned throughout this disclosure and the documents incorporated herein by reference.

In embodiments, the adaptive intelligent systems layer 614 is configured to train and implement artificial intelligence systems to perform tasks related to the value chain network 668 and/or value chain network entities 652. For example, the adaptive intelligent systems layer 614 may be leveraged to recommend products, enhance customer experience, select advertising attributes for advertisements relating to value chain products and/or services, and/or other appropriate value-chain tasks.

In embodiments, the customer profile digital twin 1730 or other customer digital twin may be created interactively and cooperatively with a customer, such as by allowing a customer to request, select, modify, delete, or otherwise influence a set of properties, states, behaviors, or other aspects represented in the digital twin 1730. For example, a customer could refine sizes (e.g., shoe size, dress size, shirt size, pant size, and the like), indicate interests and needs (e.g., what the customer is interested in buying), indicate behaviors (e.g., projects planned by an enterprise), update current states (e.g., to reflect changes), and the like. A version of the digital twin 1730 may thus be made available to a customer, such as in a graphical user interface, where the customer may manipulate one or more aspects of the digital twin 1730, request changes, and the like. In embodiments, multiple versions of a digital twin 1730 may be maintained for a given customer, such as a version for customer review, an internal version for an enterprise or host, a version for each of a specific set of brands (e.g., where a customer's appropriate clothing sizes vary by brand), a public version (such as one shared with a customer's social network for feedback, such as from friends), a private version (such as one where a customer is provided complete control over features and properties), a simulation version, a real-time version, and the like. In embodiments, the adaptive intelligent systems layer 614 is configured to leverage the customer digital twins 5502, customer profile digital twins 1730, and/or other digital twins 1700 of other value chain network entities 652. In embodiments, the adaptive intelligent systems layer 614 is configured to perform simulations using the customer digital twins 5502, customer profile digital twins 1730, and/or digital twins of other value chain network entities 652. For example, the adaptive intelligent systems layer 614 may vary one or more features of a product digital twin 1780 as its use is simulated by a customer digital twin 1730.

In embodiments, a simulation management system 5704 may set up, provision, configure, and otherwise manage interactions and simulations between and among digital twins 1700 representing value chain entities 652.

In embodiments, the adaptive intelligent systems layer 614 may, for each set of features, execute a simulation based on the set of features and may collect the simulation outcome data resulting from the simulation. For example, in executing a simulation involving the interactions of an intelligent product digital twin 1780 representing an intelligent product 1510 and a customer digital twin 1730, the adaptive intelligent systems layer 614 can vary the dimensions of the intelligent product digital twin 1780 and can execute simulations that generate outcomes in a simulation management system 5704. In this example, an outcome can be an amount of time taken by a customer digital twin 5502 to complete a task using the intelligent product digital twin 1780. During the simulations, the adaptive intelligent systems layer 614 may vary the intelligent product digital twin 1780 display screen size, available capabilities (processing, speech recognition, voice recognition, touch interfaces, remote control, self-organization, self-healing, process automation, computation, artificial intelligence, data storage, and the like), materials, and/or any other properties of the intelligent product digital twin 1780. Simulation data 5710 may be created for each simulation and may include feature data used to perform the simulations, as well as outcome data. In the example described above, the simulation data 5710 may be the properties of the customer digital twin 5502 and the intelligent product digital twin 1780 that were used to perform the simulation and the outcomes resulting therefrom. In embodiments, a machine learning system 5720 may receive training data 5730, outcome data 5740, simulation data 5710, and/or data from other types of external data sources 5702 (weather data, stock market data, sports event data, news event data, and the like). In embodiments, this data may be provided to the machine-learning system 5720 via an API of the adaptive intelligent systems layer 614. The machine learning system 5720 may train, retrain, or reinforce machine leaning models 5750 using the received data (training data, outcome data, simulation data, and the like).

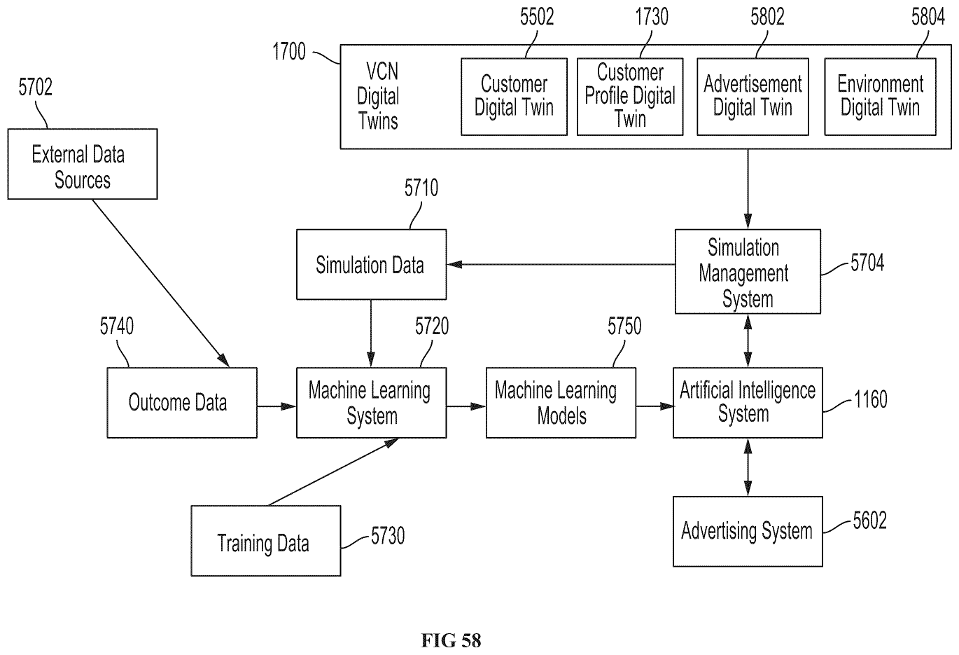

FIG. 58 illustrates an example of an advertising application that interfaces with the adaptive intelligent systems layer 614. In example embodiments, the advertising application may be configured automate advertising-related tasks for a value chain product or service.

In embodiments, the machine-learning system 5720 trains one or more models 5750 that are leveraged by the artificial intelligence system 1160 to make classifications, predictions, and/or other decisions relating to advertisements for a set of value chain products and/or services.

In example embodiments, a model 5750 is trained to select advertisement features to optimize one or more outcomes (e.g., maximize product sales for a product 1510 in the value chain network 668). The machine-learning system 5720 may train the models 5750 using n-tuples that include the features pertaining to advertisements and one or more outcomes associated with the advertisements. In this example, features for an advertisement may include, but are not limited to, product and/or service category advertised, advertised product features (price, product vendor, and the like), advertised service features, advertisement type (television, radio, podcast, social media, e-mail or the like), advertisement length (10 seconds, 30 seconds, or the like), advertisement timing (in the morning, before a holiday, and the like), advertisement tone (comedic, informational, emotional, or the like), and/or other relevant advertisement features. In this example, outcomes relating to the advertisement may include product sales, total cost of the advertisement, advertisement interaction measures, and the like. In this example, one or more digital twins 1700 may be used to simulate the different arrangements (e.g., digital twins of advertisements, customers, customer profiles, and environments), whereby one or more properties of the digital twins are varied for different simulations and the outcomes of each simulation may be recorded in a tuple with the proprieties. Other examples of training advertising models may include a model that is trained to generate advertisements for value chain products 650, a model that is trained to manage an advertising campaign for value chain products 650, and the like. In operation, the artificial intelligence system 1160 may use such models 5750 to make advertisement decisions on behalf of an advertising application 5602 given one or more features relating to an advertising-related task or event. For example, the artificial intelligence system 1160 may select a type of advertisement (e.g., social media, podcast, and the like) to use for a value chain product 1510. In this example, the advertising application 5602 may provide the features of the product to artificial intelligence system 1160. These features may include product vendor, the price of the product, and the like. In embodiments, the artificial intelligence system 1160 may insert these features into one or more of the models 5750 to obtain one or more decisions, which may include which type of advertisement to use. In embodiments, the artificial intelligence system 1160 may leverage the customer digital twins 5502 and/or customer profile digital twins 1730 to run simulations on the one or more decisions and generate simulation data 5710. The machine learning system 5720 may receive the simulation data 5710 and other data as described throughout this disclosure to retrain or reinforce machine leaning models. In embodiments, the customer digital twins 5502, customer profile digital twins 1730, and other digital twins 1700 may be leveraged by the artificial intelligence system 1160 to simulate a decision made by the artificial intelligence system 1160 before providing the decision to the value chain entity 652. In the present example, the customer profile digital twins 1730 may be leveraged by the artificial intelligence system 1160 to simulate decisions made by the artificial intelligence system 1160 before providing the decision to the advertising application 5602. In embodiments, where simulation outcomes are unacceptable, simulation data 5710 may be reported to the machine learning system 5720, which may use the received data to re-train machine learning models 5750, which may then be leveraged by the artificial intelligence system 1160 to make a new decision. The advertising application 824 may initiate an advertising event using the decision(s) made by the artificial intelligence system 1160. In embodiments, after the advertising event, the outcomes of the event (e.g., product sales) may be reported to the machine-learning system 5720 to reinforce the models 5750 used to make the decisions. Furthermore, in some embodiments, the output of the advertising application and/or the other value chain entity data sources may be used to update one or more properties of customer digital twins 5502, customer profile digital twins 1730 and/or other digital twins 1700.

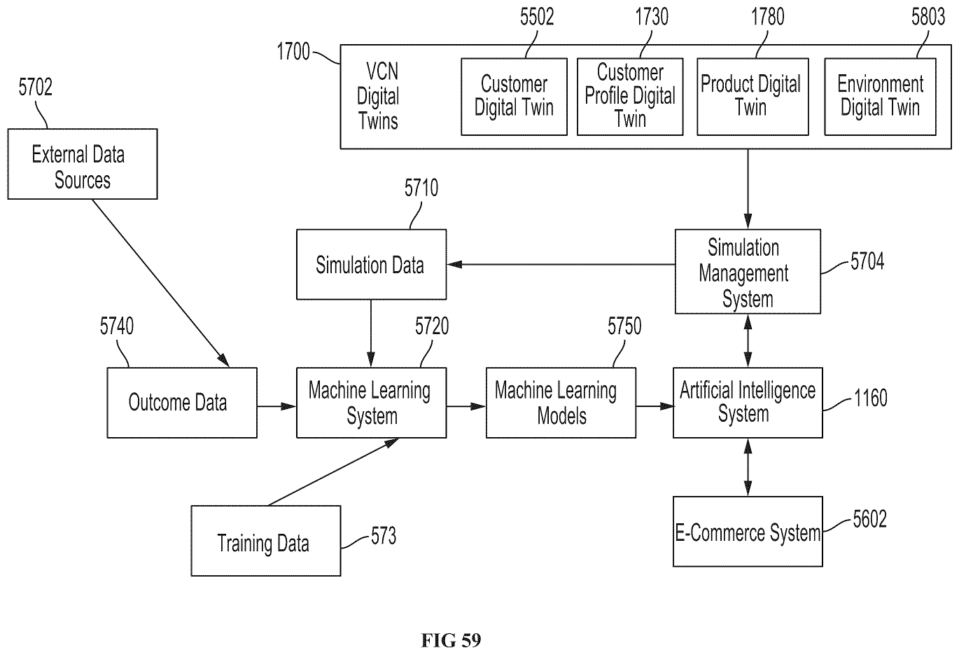

FIG. 59 illustrates an example of an e-commerce application 5604 integrated with the adaptive intelligent systems layer 614. In embodiments, an e-commerce application 5604 may be configured to generate product recommendations for value chain customers 662. For example, the ecommerce application 5604 may be configured to receive one or more product features for a value chain network product 1510. Examples of product features may include, but are not limited to product types, product capabilities, product price, product materials, product vendor, and the like. In embodiments, the e-commerce application 5604 determines recommendations to optimize an outcome. Examples of outcomes can include software interaction observations (such as mouse movements, mouse clicks, cursor movements, navigation actions, menu selections, and many others), such as logged and/or tracked by software interaction observation system 1500, purchase of the product by a customer 714, and the like. In embodiments, the e-commerce application 5604 may interface with the artificial intelligence system 1160 to provide product features and to receive product recommendations that are based thereon. In embodiments, the artificial intelligence system 1160 may utilize one or more machine-learned models 5750 to determine a recommendation. In some embodiments, the simulations run by the customer digital twin 1730 may be used to train the product recommendation machine-learning models.

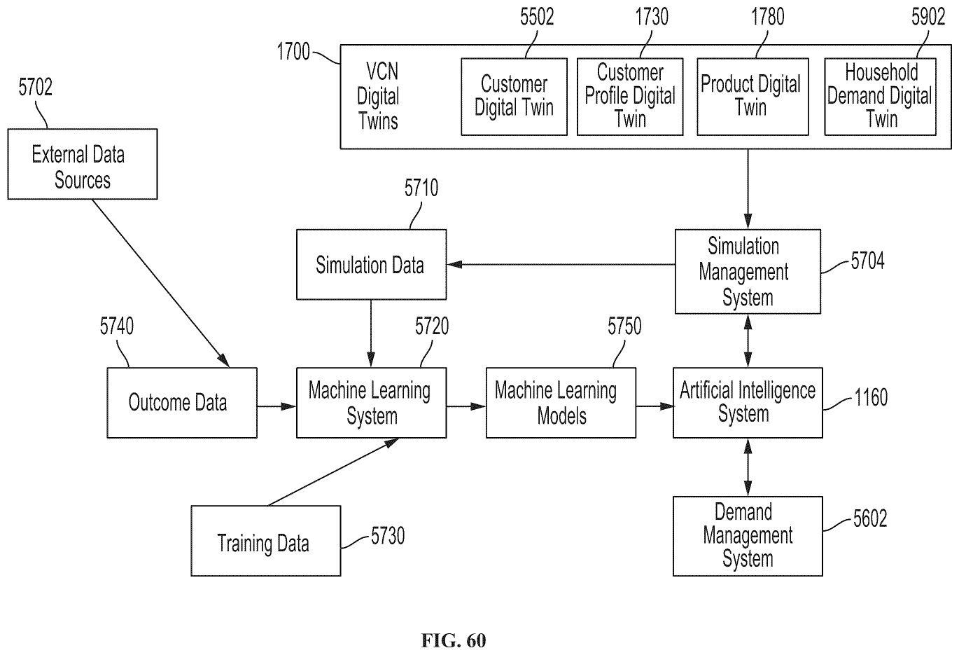

FIG. 60 is a schematic illustrating an example of demand management application 824 integrated with the adaptive intelligent systems layer 614. In embodiments, the artificial intelligence system 1160 may use machine-learning models 5750 trained to make demand management decisions for a demand environment 672 on behalf of a demand management application 824 given one or more demand factors 644. Demand factors 644 may include product type, product capabilities, product price, product materials, time of year, location, and the like. In embodiments, the artificial intelligence system 1160 may determine a demand management decision for a value chain product 1510. For example, the artificial intelligence system 1160 may generate a demand management decision relating to how many printer ink cartridges should be supplied to a particular region for an upcoming month. In this example, the demand management system 824 may provide the demand factors 644 to artificial intelligence system 1160. In embodiments, the artificial intelligence system 1160 may insert these factors 644 into one or more machine-learning models 5750 to obtain one or more demand management decisions. These decisions may include the volume of ink cartridges should be sent to the select region during the select month.

In embodiments, the artificial intelligence system 1160 may leverage the customer profile digital twins 1730 to run simulations on the proposed decisions related to the demand management. The demand management application 824 may then initiate an ink resupply event using the decision(s) made by the artificial intelligence system 1160. Furthermore, after the ink resupply event, the outcomes of the event (e.g., ink cartridge sales) may be reported to the machine-learning system 5720 to reinforce the models used to make the decisions. Furthermore, in some embodiments, the output of the demand management system 824 and/or the other value chain entity data sources may be used to update one or more properties of customer profile digital twins 1730 and/or other digital twins 1700.

In embodiments, an API enables users to access the customer digital twins 5502 and/or customer profile digital twins 1730. In embodiments, an API enables users to receive one or more reports related to the digital twins.

The platform 604 may include, integrate, integrate with, manage, control, coordinate with, or otherwise handle household demand digital twins 5902. Household demand digital twins 5902 may be a digital representation of a household demand for a product category or for a set of product categories.

An environment for development of a household demand digital twin 5902 may include a set of interfaces for developers in which a developer may configure an artificial intelligence system 1160 to take inputs from selected data sources of the data storage layer 624 and events or other data from the monitoring systems layer 614 and supply them for inclusion in a household demand digital twin 5902. A household demand digital twin development environment may be configured to take outputs and outcomes from various applications 630. In embodiments, a household demand digital twin 5902 may be provided for the wide range of value chain network applications 630 mentioned throughout this disclosure and the documents incorporated herein by reference.

In embodiments, a digital twin 1700 may be generated from other digital twins. For example, a customer digital twin 5502 may be used to generate an anonymized customer digital twin 5902. The platform may include, integrate, integrate with, manage, control, coordinate with, or otherwise handle anonymized customer digital twins 5902. Anonymized customer digital twins 5902 may be an anonymized digital representation of a customer 714. In embodiments, anonymized customer digital twins 5902 are not populated with personally identifiable information but may otherwise be populated using the same data sources as its corresponding customer digital twin 5502.

In embodiments, an environment for development of an anonymized customer digital twin 1730 may include a set of interfaces for developers in which a developer may configure an artificial intelligence system 1160 to take inputs from selected data sources of the data storage layer 624 and events or other data from the monitoring systems layer 614 and supply them for inclusion in an anonymized customer digital twin 5902. An anonymized digital twin development environment may be configured to take outputs and outcomes from various applications 630. In embodiments, an anonymized customer digital twin 5902 may be provided for the wide range of value chain network applications 630 mentioned throughout this disclosure and the documents incorporated herein by reference.

In embodiments, the anonymized customer digital twin 5902 comprises an API that can receive an access request to the anonymized customer digital twin 5902. A requesting entity can use the API of the anonymized customer digital twin 5902 to issue an access request. The access request may be routed from the API to an access logic of the anonymized customer twin 5902, which can determine if the requesting entity is entitled to access. In embodiments, users may monetize access to anonymized customer digital twins 5902, such as by subscription or any other suitable monetization method.

The platform 604 may include, integrate, integrate with, manage, control, coordinate with, or otherwise handle enterprise customer engagement digital twins. Enterprise customer engagement digital twins may be a digital representation of a set of attributes of the enterprise customer that are relevant to engagement by the customer with a set of offerings of an enterprise.

An environment for development of an enterprise customer engagement digital twin may include a set of interfaces for developers in which a developer may configure an artificial intelligence system 1160 to take inputs from selected data sources of the data storage layer 624 and events or other data from the monitoring systems layer 614 and supply them for inclusion in an enterprise customer engagement digital twin. An enterprise customer engagement digital twin development environment may be configured to take outputs and outcomes from various applications 630. In embodiments, an enterprise customer engagement digital twin may be provided for the wide range of value chain network applications 630 mentioned throughout this disclosure and the documents incorporated herein by reference.

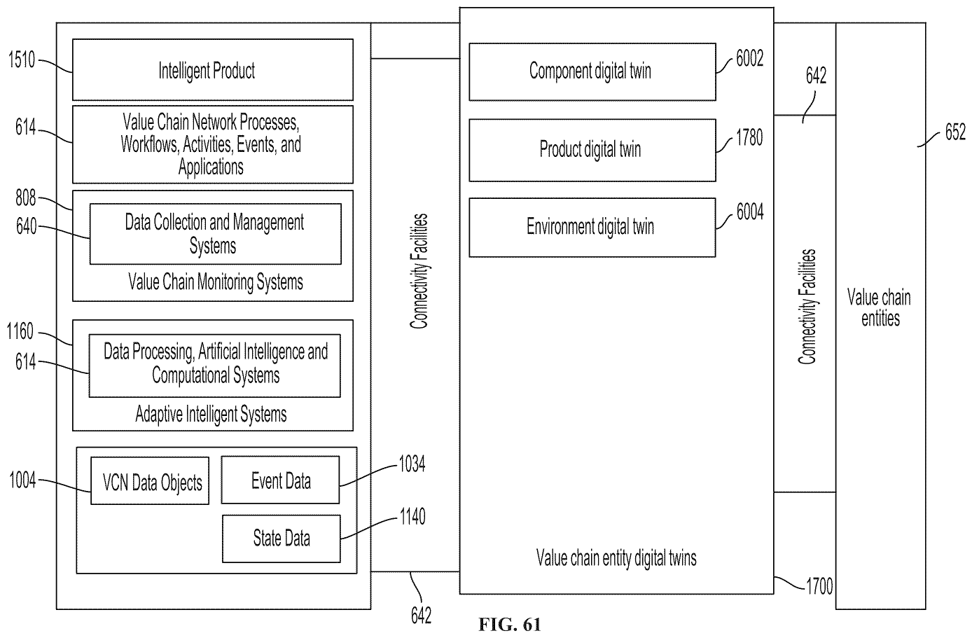

Referring to FIG. 61, the platform 604 may include, integrate, integrate with, manage, control, coordinate with, or otherwise handle component digital twins 6002. Component digital twins 6002 may represent evolving, continuously updated digital profiles of components 6002 of value chain products 650. Component digital twins 6002 may allow for modeling, simulation, prediction, decision-making, classification, and the like.

Product components can be depicted in a set of one or component digital twins 6002, such as by populating the component digital twins 6002 with value chain network data objects 1004, such as event data 1034, state data 1140, or other data with respect to value chain network product components.

A product 1510 may be any category of product, such as a finished good, software product, hardware product, component product, material, item of equipment, consumer packaged good, consumer product, food product, beverage product, home product, business supply product, consumable product, pharmaceutical product, medical device product, technology product, entertainment product, or any other type of product and/or set of related services, and which may, in embodiments, encompass an intelligent product 1510 that is enabled with a set of capabilities such as, without limitation data processing, networking, sensing, autonomous operation, intelligent agent, natural language processing, speech recognition, voice recognition, touch interfaces, remote control, self-organization, self-healing, process automation, computation, artificial intelligence, analog or digital sensors, cameras, sound processing systems, data storage, data integration, and/or various Internet of Things capabilities, among others. A component 6002 may be any category of product component.

As an example, a component digital twin 6002 may be populated with supplier data, dimension data, material data, thermal data, price data, and the like.

A component digital twin 6002 may include a set of components, processes, services, interfaces, and other elements for development and deployment of digital twin capabilities for visualization of value chain network components 714 as well as for coordinated intelligence (including artificial intelligence system 1160, edge intelligence, analytics and other capabilities) and other value-added services and capabilities that are enabled or facilitated with a component digital twin 6002.

In embodiments, the component digital twin 6002 may take advantage of the presence of multiple applications 630 within the value chain management platform 604, such that a pair of applications may share data sources (such as in the data storage layer 624) and other inputs (such as from the monitoring layer 614) that are collected with respect to value chain entities 652, as well sharing outputs, events, state information and outputs, which collectively may provide a much richer environment for enriching content in a component digital twin 6002, including through use of artificial intelligence system 1160 (including any of the various expert systems, artificial intelligence systems, neural networks, supervised learning systems, machine learning systems, deep learning systems, and other systems described throughout this disclosure and in the documents incorporated by reference) and through use of content collected by the monitoring layer 614 and data collection systems 640.

An environment for development of a component digital twin 6002 may include a set of interfaces for developers in which a developer may configure an artificial intelligence system 1160 to take inputs from selected data sources of the data storage layer 624 and events or other data from the monitoring systems layer 614 and supply them for inclusion in a component digital twin 6002. A component digital twin development environment may be configured to take outputs and outcomes from various applications 630. In embodiments, a component digital twin 6002 may be provided for the wide range of value chain network applications 630 mentioned throughout this disclosure and the documents incorporated herein by reference. In embodiments, a digital twin 650 may be generated from other digital twins 1700. For example, a product digital twin 1780 may be used to generate component digital twins 6002. In another example, component digital twins 6002 may be used to generate product digital twins 1780. In embodiments, a digital twin 1700 may be embedded in another digital twin 1700. For example, a component digital twin 6002 may be embedded in a product digital twin 1780 which may be embedded in an environment digital twin 6004.

In embodiments, a simulation management system 6110 may set up, provision, configure, and otherwise manage interactions and simulations between and among digital twins 1700 representing value chain entities 652.

In embodiments, the adaptive intelligent systems layer 614 is configured to execute simulations in a simulation management system 6110 using the component digital twins 6002 and/or digital twins 1700 of other value chain network entities 652. For example, the adaptive intelligent systems layer 614 may adjust one or more features of an environment digital twin 6004 as a set of component digital twins 6002 are subjected to an environment. In embodiments, the adaptive intelligent systems layer 614 may, for each set of features, execute a simulation based on the set of features and may collect the simulation outcome data resulting from the simulation.

For example, in executing a simulation on a set of component digital twins 6002 representing components of value chain product 1510 in an environment digital twin 6004, the adaptive intelligent systems layer 614 can vary the properties of the environment digital twin 6110 and can execute simulations that generate outcomes. During the simulation, the adaptive intelligent systems layer 614 may vary the environment digital twin temperature, pressure, lighting, and/or any other properties of the environment digital twin 6004. In this example, an outcome can be a condition of the component digital twin 6002 after being subjected to a high temperature. The outcomes from simulations can be used to train machine learning models 6120.

In embodiments, a machine learning system 6150 may receive training data 6170, outcome data 6160, simulation data 6140, and/or data from other types of external data sources 6150 (weather data, stock market data, sports event data, news event data, and the like). In embodiments, this data may be provided to the machine-learning system 6150 via an API of the adaptive intelligent systems layer 614. In embodiments, the machine learning system 6150 may receive simulation data 6140 relating to a component digital twin 6002 simulation. In this example, the simulation data 6140 may be the properties of the component digital twins 6002 that were used to perform the simulation and the outcomes resulting therefrom.

In embodiments, the machine learning system 6150 may train/reinforce machine leaning models 6120 using the received data to improve the models.

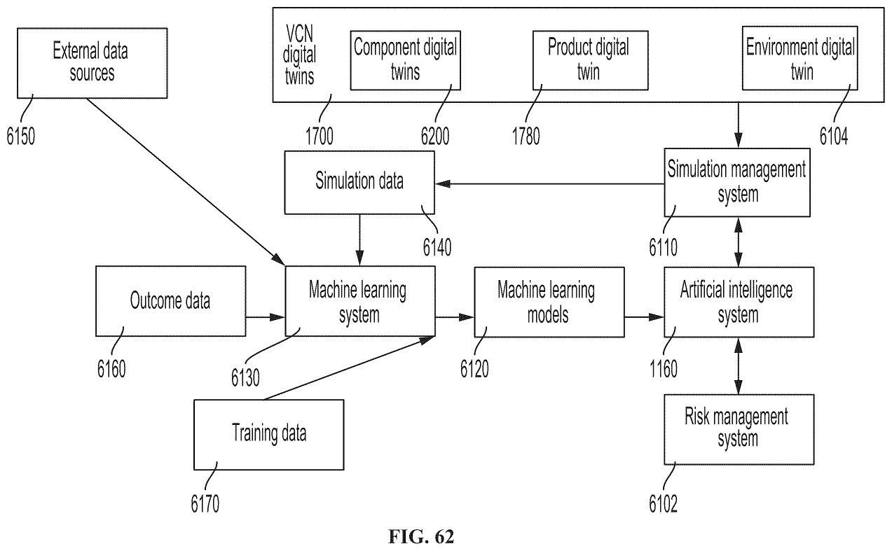

FIG. 62 illustrates an example of a risk management system 6102 that interfaces with the adaptive intelligent systems layer 614. In example embodiments, the risk management system 6102 may be configured to manage risk or liability with respect to a good or good component.

In embodiments, the machine-learning system 6150 trains one or more models 6120 that are utilized by the artificial intelligence system 1160 to make classifications, predictions, and/or other decisions relating to risk management, including for products 650 and product components. In embodiments, may be equipment components. In example embodiments, a model 6120 is trained to mitigate risk and liability by detecting the condition of a set of components. The machine-learning system 6150 may train the models using n-tuples that include the features pertaining to components and one or more outcomes associated with the component condition. In this example, features for a component may include, but are not limited to, component material (plastic, glass, metal, or the like), component history (manufacturing dates, usage history, repair history), component properties, component dimensions, component thermal properties, component price, component supplier, and/or other relevant features. In this example, outcomes may include whether the digital twin of the component 6002 is in operating condition. In this example, one or more properties of the digital twins are varied for different simulations and the outcomes of each simulation may be recorded in a tuple with the proprieties. Other examples of training risk management models may include a model 6120 that is trained to optimize product safety, a model that is trained to identify components with a high likelihood of causing an undesired event, and the like.

In operation, the artificial intelligence system 1160 may use the above-discussed models 6120 to make risk management decisions on behalf of a risk management system 6102 given one or more features relating to a task or event. For example, the artificial intelligence system 1160 may determine the condition of a component. In this example, the risk management system 6102 may provide the features of the component to the artificial intelligence system 1160. These features may include component material, component history, component dimensions, component cost, component thermal properties, component supplier, and the like. In embodiments, the artificial intelligence system 1160 may feed these features into one or more of the models discussed above to obtain one or more decisions. These decisions may include whether the component is in operating condition.

In embodiments, the artificial intelligence system 1160 may leverage the component digital twins 6002 to run simulations on the proposed decisions.

The risk management system 6102 may then initiate a component resupply event using the decision(s) made by the artificial intelligence system 1160. Furthermore, after the component resupply event, the outcomes of the event (e.g., improved product performance) may be reported to the machine-learning system 6150 to reinforce the models used to make the decisions.

The platform 604 may include, integrate, integrate with, manage, control, coordinate with, or otherwise handle component attribute digital twins 6140. Component attribute digital twins 6140 may be a digital representation of a set of attributes of a set of supply chain components in a supply for a set of products of an enterprise.

An environment for development of a component attribute digital twin 6140 may include a set of interfaces for developers in which a developer may configure an artificial intelligence system 1160 to take inputs from selected data sources of the data storage layer 624 and events or other data from the monitoring systems layer 614 and supply them for inclusion in a component attribute digital twin 6140. A component attribute digital twin development environment may be configured to take outputs and outcomes from various applications 630. In embodiments, a component attribute digital twin 6140 may be provided for the wide range of value chain network applications 630 mentioned throughout this disclosure and the documents incorporated herein by reference.

In embodiments, the methods, systems and apparatuses include an information technology system having a value chain network management platform with an asset management application associated with maritime assets and a data handling layer of the management platform including data sources containing information used to populate a training set based on a set of maritime activities of one or more of the maritime assets and one of design outcomes, parameters, and data associated with the one or more maritime assets. The information technology system also has an artificial intelligence system that is configured to learn on the training set collected from the data sources, that simulates one or more attributes of one or more of the maritime assets, and that generates one or more sets of recommendations for a change in the one or more attributes based on the training set collected from the data sources. The information technology system also has a digital twin system included in the value chain network management platform that provides for visualization of a digital twin of one or more of the maritime assets including detail generated by the artificial intelligence system of one or more of the attributes in combination with the one or more sets of recommendations.

Referring to FIG. 6, the value chain network management platform 604 orchestrates a variety of factors involved in planning, monitoring, controlling, and optimizing various entities and activities involved in the value chain network 668 as it is applied to maritime assets, activities, logistics, and planning including supply and production factors, demand factors, logistics and distribution factors, and the like. The management platform 604 can facilitate the monitoring and managing of supply factors and demand factors, the sharing of status information about and between various entities as demand factors are understood and accounted for, as orders are generated and fulfilled, and as products are created and moved through a supply chain. Referring to FIG. 7, the management platform 604 may include a set of value chain network entities 652 including various delivery systems 632 that can include and connect to maritime facilities 622. The maritime facilities 622 can include port infrastructure facilities 660, floating assets 620, and shipyards 638, and the like. In embodiments, the value chain network management platform 604 monitors, controls, and otherwise enables management (and in some cases autonomous or semi-autonomous behavior) of a wide range of value chain network 668 processes, workflows, activities, events and applications 630 applicable in the maritime environment.

Referring to FIGS. 6 and 11, the management platform 604 deployed in the maritime environment may include a set of data handling layers 608 each of which is configured to provide a set of capabilities that facilitate development and deployment of intelligence, such as for facilitating automation, machine learning, applications of artificial intelligence, intelligent transactions, state management, event management, process management, and many others, for a wide variety of value chain network applications and end uses in the maritime environment. In embodiments, the data handling layers 608 are configured in a topology that facilitates shared data collection and distribution across multiple applications and uses within the management platform 604 by the value chain monitoring systems layer 614. The value chain monitoring systems layer 614 may include, integrate with, and/or cooperate with various data collection and management systems 640, referred to for convenience in some cases as data collection systems 640, for collecting and organizing data collected from or about value chain entities 652, as well as data collected from or about the various data layers 624 or services or components thereof.

In embodiments, the data handling layers 608 are configured in a topology that facilitates shared or common data storage across multiple applications and uses of the platform 604 by the value chain network-oriented data storage systems layer 624, referred to herein for convenience in some cases simply as the data storage layer 624 or storage layer 624. For example, various data collected about the value chain entities 652, as well as data produced by the other data handling layers 608, may be stored in the data storage layer 624, such that any of the services, applications, programs, or the like of the various data handling layers 608 can access a common data source, which may comprise a single logical data source that is distributed across disparate physical and/or virtual storage locations. This may facilitate a dramatic reduction in the amount of data storage required to handle the enormous amount of data produced by or about value chain network entities 652 as applications 630 and uses of value chain networks grow and proliferate. For example, a supply chain or inventory management application in the value chain management platform 604, such as one for ordering replacement parts for a machine or item of equipment, may access the same data set about what parts have been replaced for a set of machines as a predictive maintenance application that is used to predict whether a component of a ship, or facility of a port is likely to require replacement parts. Similarly, prediction may be used with respect to resupply of items.

Referring to FIGS. 6 and 12, the value chain network-oriented data storage systems layer 624 may include, without limitation, physical storage systems, virtual storage systems, local storage systems 1190, distributed storage systems, databases, memory, network-based storage, network-attached storage systems. In embodiments, the storage layer 624 may store data in one or more knowledge graphs in the graph database architectures 1124, such as a directed acyclic graph, a data map, a data hierarchy, a data cluster including links and nodes, a self-organizing map, or the like. In embodiments, the data storage layer 624 may store data in a digital thread, ledger, distributed ledger or the like, such as for maintaining a serial or other records of an entity 652 over time, including any of the entities described herein. In embodiments, the storage layer 624 may include one or more blockchains 1180, such as ones that store identity data, transaction data, historical interaction data, and the like, such as with access control that may be role-based or may be based on credentials associated with a value chain entity 652, a service, or one or more applications 630. Data stored by the data storage systems 624 may include accounting and other financial data 730, access data 734, asset and facility data 1032, asset tag data 1178, worker data 1032, event data 1034, risk management data 732, pricing data 738, safety data 664 and the like.

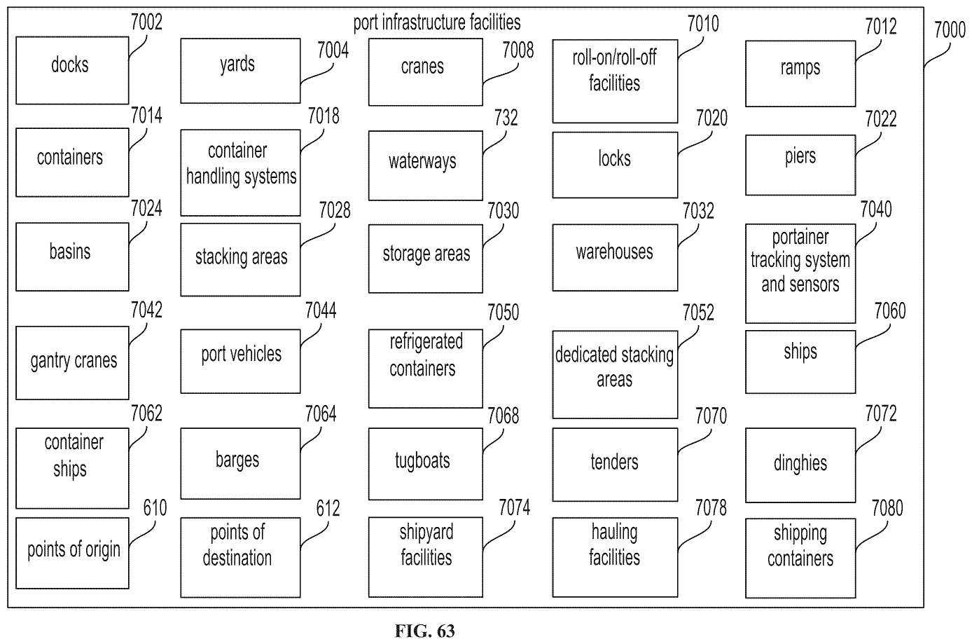

Referring to FIG. 8, the value chain network management platform 604 includes one or more sets of value chain entities 652 that may be subject to management by the management platform 604, may integrate with or into the management platform 604, and/or may supply inputs to and/or take outputs from the management platform 604, such as ones involved in or for a wide range of value chain activities. These value chain entities 652 may include any of the wide variety of assets, systems, devices, machines, components, equipment, facilities, and individuals that can support a wide range of operating facilities 712 including maritime facilities 622. Referring to FIGS. 63, the maritime facilities can include port infrastructure facilities 7000. In embodiments, the port infrastructure facilities 7000 can include docks 7002, yards 7004, cranes 7008, roll-on/roll-off facilities 7010, ramps 7012, containers 7014, container handling systems 7018, waterways 732, and locks 7020, as applicable. In embodiments, the docks 7002 and their adjacent areas may include piers 7022, basins 7024, stacking areas 7028, storage areas 7030, and warehouses 7032. In embodiments, the container handling systems 7018 can include portainer tracking system and sensors 7040, such as for monitoring, reporting on, or managing one or more portainers or other systems for moving shipping containers, such as cranes (e.g., Gottwald cranes, gantry cranes, and others), straddle carriers, multitrailers, reach stackers, and the like. In embodiments, the port infrastructure facilities 7000 can further include gantry cranes 7042 and the port vehicles 7044 that can be used to move containers 7014, such as straddle carriers. In embodiments, the port infrastructure facilities 7000 also include refrigerated containers 7050 with dedicated stacking areas 7052 and cooling infrastructure to maintain the controlled environments in the refrigerated containers 7050.

The port infrastructure facilities 7000 further include shipyard facilities 638 and floating assets 620. The floating assets 620 can include ships 7060 and boats, container ships 7062, barges 7064, tugboats 7068, 7070, and dinghies 7072, as well as partially floating assets, such as submarines, underwater drones, and the like. By way of these examples, the floating assets 620 can operate among facilities and other items at points of origin 610 and/or points of destination 628. The shipyard facilities 638 can include the hauling facilities 710 such as many of the floating assets 620 as well as land-based vehicles and other delivery systems 632 used for conveying goods, such as trucks, trains, and the like

Referring to FIGS. 63, orchestration of a set of deeply interconnected value chain network entities 652 by the management platform 604 can include providing interconnectivity for the value chain network entities 652 using local network connections, a peer-to-peer connections, connections through one or more mobile networks, and connections via a cloud network facility, satellite uplinks, microwave communications or other connections. The management platform 604 may manage the connections, configure or provision resources to enable connectivity, and/or manage applications 630 that take advantage of the connections knowing that are many maritime environments where connectivity may be poor or non-existent relative to when the floating assets 620 are closer to port or other land-based communication systems. In many examples, a port infrastructure facility 660, such as a yard for holding shipping containers 7080, may inform a fleet of floating assets 620 via connections to the floating assets 620 that the port is near capacity. With this knowledge, the floating assets 620 movement can be varied to extend times including reducing approach speeds to delay arrival, direction to other ports, and the like. In further examples, the news of the port reaching capacity can result in starting a negotiation process with the floating assets 620 looking to arrive at port. In embodiments, the negotiation process with the floating assets 620 can include an automated negotiation based on a set of rules and governed by a smart contract for the remaining capacity and enabling some floating assets 620 to be redirected to alternative ports or holding facilities.

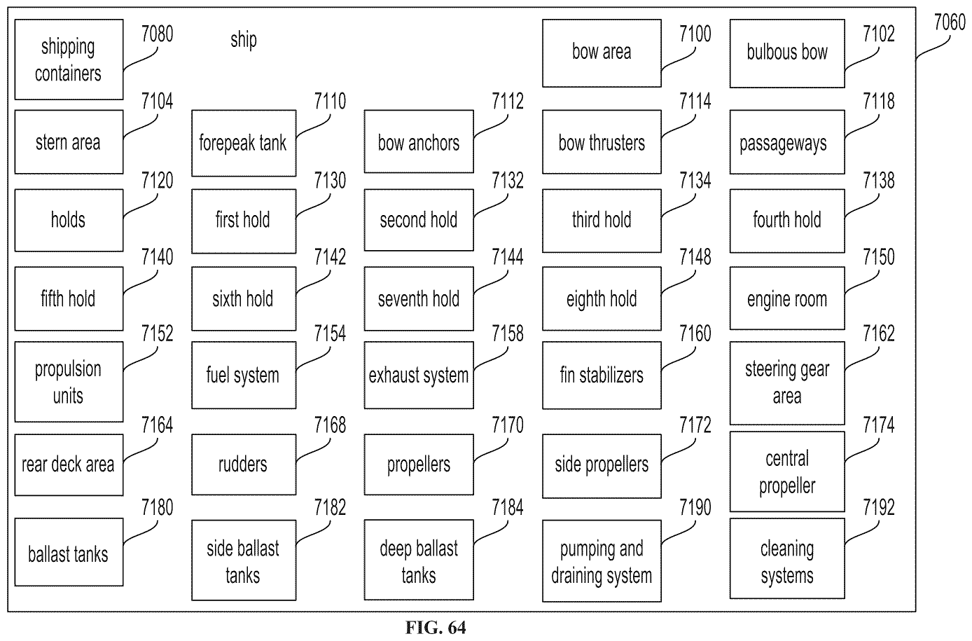

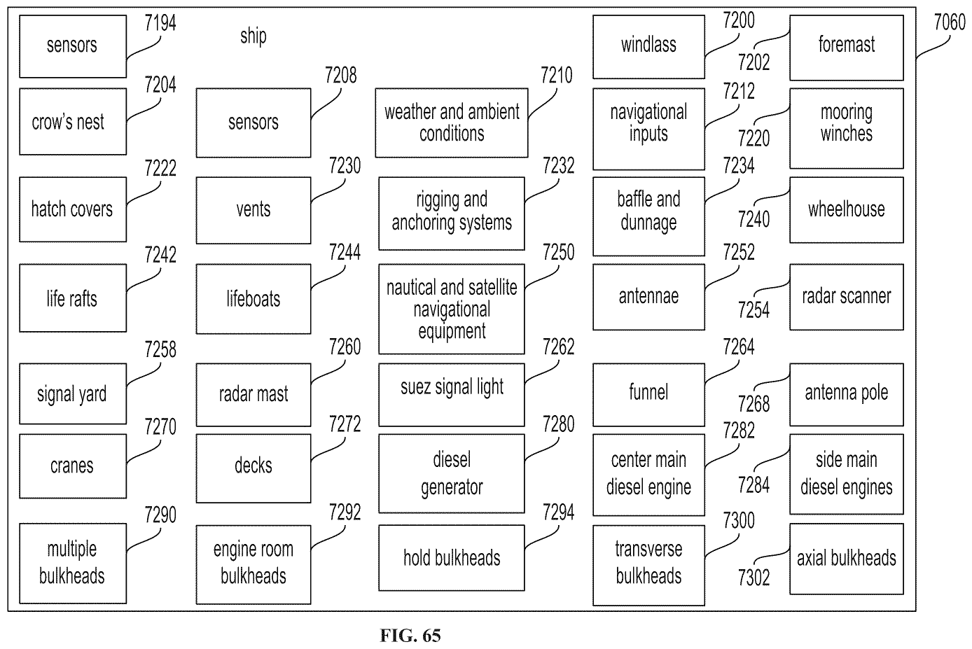

In embodiments, the maritime facilities 622 can include floating assets 620 including many different ships 7060. Referring to FIGS. 64 and 65, the ship 7060 can be one or more container ships 7062 that can haul many shipping containers 7080. In other examples, the ship 7060 can be one or more container ships 7062 that can haul raw materials, processed goods in bulk, gaseous cargo and many other forms of cargo not otherwise transported in shipping containers 7080. In many examples, the ship 7060 can include a bow area 7100. The bow area 7100 can include a bulbous bow 7102. In some examples, the bulbous bow 7102 can be configured in-situ in response to control from the management platform 604. Inboard from the bow area 7100 and traveling toward the stern area 7104 of the ship 7060, the ship 7060 can include a forepeak tank 7110. In this same area, the ship 7060 can include one or more bow anchors 7112 and bow thrusters 7114. Various passageways 7118 connect these areas in the bow area 7100. Depending on the configuration of the ship 7060, the hold 7120 can be configured and re-configured to accommodate various products such as product 1510, raw materials, material in process, and combinations thereof. In some examples, the ship 7060 can include multiple holds 7120. In examples, the container ship 7062 can be configured with eight holds: container hold 7130, 7132, 7134, 7138, 7140, 7142, 7144, and 7148. Toward the stern area 7104, the ship 7060 includes an engine room 7150 including one or more propulsion units 7152. Each of the one or more propulsion units 7152 is fed by a fuel system 7154 and its emissions are controlled by an exhaust system 7158. In various locations on the ship 7060, one or more fin stabilizers 7160 may be deployed. In the stern area 7104, the ship 7060 includes a steering gear area 7160 below a rear deck area 7162. One or more rudders 7164 can extend from the steering gear area 7160.

One or more propellers 7170 can extend from the stern area 7104 with a rotating power connection to the propulsion units. In embodiments, one or more propellers 7170 can extend from the ship 7060 with an electrical connection to the propulsion units but no physical rotating power connection. In embodiments, one or more propellers 7170 can extend from the ship 7060 with a hydraulic connection to the propulsion units but no physical rotating power connection. In further examples, steam or other working fluids may be employed to drive the propulsion of the ship 7060. In further examples, mechanical rotating power, electrical drive, hydraulic drive, steam and various combinations thereof can be used for propulsion. In various examples, the one or more propellers 7170 can include side propellers 7172 and a central propeller 7174. In other examples, two propellers 7170 can be deployed. In embodiments, the propellers 7170 can be fixed such that the plane in which the propeller rotates is fixed relative to the ship 7060. By way of these examples, the propellers 7170 can be fixed and can be driven by mechanical linkage to propulsion units of the ship 7060. In other examples, the propellers 7170 can be fixed and can be driven by electrical motors adjacent each of the propellers 7170. In embodiments, the position of the propellers 7170 can be variable such that the plane in which the propeller rotates is movable relative to the ship 7060. By way of these examples, the propellers 7170 can be driven by electrical motors adjacent to each of the propellers 7170. In one or more locations on the ship 7060, the propellers 7170 can be deployed in pods that can include an independently controlled and movable electrical drivetrain and propeller so that the entire pod can be moved into various positions to facilitate forward propulsion, steering, maneuvering, docking, evasive maneuvers, and the like.

In further examples, the ship 7060 is configured with one or more ballast tanks 7180. In various examples, the ship 7060 can include side ballast tanks 7182 and deep ballast tanks 7184. The ballast tanks 7180 can each include pumping and draining systems 7190, cleaning systems 7192, sensors 7194 to determine characteristics of the ballast water such as salinity, foreign particles, organic material, garbage, restricted content relative to geofenced areas, regulated zones, ad-hoc demarcated areas, and the like. The sensors 7194 can also determine tank characteristics including wear from fatigue, corrosion, physical damage, or the like. In the bow area 7100, the ship 7060 can include a windlass 7200, a foremast 7202, and a crow's-nest 7204 on which various sensors 7208 can be located to observe characteristics of the ship 7060, the weather and ambient conditions 7210, and navigational inputs 7212. In various locations on the ship 7060, one of more mooring winches 7220 can be deployed to assist in docking, in connection to suitable mooring connections points, connection other vessels in transit such as tenders, and the like. In various locations on the ship 7060, one or more hatch covers 7222 can be deployed to permit access to various areas and passageways on the ship 7060.

In further examples, the ship 7060 is configured as a container ship 7062 that can be configured with eight holds: container hold 7130, 7132, 7134, 7138, 7140, 7142, 7144, and 7148. In further examples, the ship 7060 is configured as a container ship 7062 with various numbers of holds 7120. In further examples, the ship 7060 is configured as a container ship 7062 with in-situ configurable holds. In further examples, the ship 7060 is configured as a container ship 7062 with various numbers of holds some of which are in-situ configurable. In embodiments, the holds 7120 can include one or more vents 7240 deployed to facilitate an atmosphere in the hold suitable for transit and for the care of the cargo. In embodiments, the holds 7120 can include one or more rigging and anchoring systems 7242 to secure one or more loads within holds 7120 configured or reconfigured for such cargo. In embodiments, the holds 7120 can include one or more movable baffle and dunnage 7244 to secure one or more loads within holds 7120 configured or reconfigured for such cargo.

In further examples, the ship 7060 includes a wheelhouse 7250 and one or more life rafts 7252 and lifeboats 7254. In further examples, the ship 7060 includes nautical and satellite navigational equipment 7260. By way of these examples, the ship can include direction finder antennae 7262, radar scanner 7264, a signal yard 7268. In these examples, the ship 7060 includes a radar mast 7270 and a Suez signal light 7272, a funnel 7274 and an antenna pole 7278.

In further examples, the ship 7060 includes one or more cranes 7280 that can be used to move things in and about the decks 7282 and in and out of the holds 7120 of the ship 7060. In these examples, the ship 7060 can contain or carry on top many containers of various sizes including twenty-foot and forty-foot containers. In these examples, the ship 7060 can contain or carry on top many containers of various sizes including twenty-foot dry freight containers, twenty-foot open-top containers, twenty-foot collapsible flat rack containers, twenty-foot refrigerated containers, and the like. In these examples, the ship 7060 can contain or carry on top many containers of various sizes including forty-foot high cube containers, forty-foot open-top containers, forty-foot collapsible flat rack containers, forty-foot high cube refrigerated containers, and the like. In these examples, the ship 7060 can contain or carry on top many containers of various sizes including forty-five-foot high cube dry containers, and the like.

In embodiments, the ship 7060 can contain engine units that include a diesel generator 7280 that can supply electrical power throughout the ship 7060. The ship 7060 can also contain engine units that include a center main diesel engine 7282 and one or more side main diesel engines 7284. In embodiments, the ship 7060 can contain engine units that are configured to combust natural gas, propane, gasoline, methanol, and the like. In embodiments, the ship 7060 can contain engine units that are configured to be powered by nuclear units that can be used to heat water to steam-driven electrical systems. In embodiments, the ship 7060 can contain engine units that are configured to be powered by nuclear units and internal combustion engines in a hybrid arrangement. In embodiments, the ship 7060 can contain engine units that are configured to be powered by nuclear units and internal combustion engines, and other renewables in a hybrid arrangement such as solar and wind where each of these can feed an electrical and battery system to power propulsion and ship operations.

In embodiments, the ship 7060 can contain multiple bulkheads 7290. By way of these examples, the engine room can be framed in engine room bulkheads 7292 to contain the various powerplant units. In embodiments, the cargo and hold region of the ship 7060 can contain hold bulkheads 7294 to contain the various powerplant units. In embodiments, the ship 7060 can contain structural transverse bulkheads 7300 and axial bulkheads 7302.

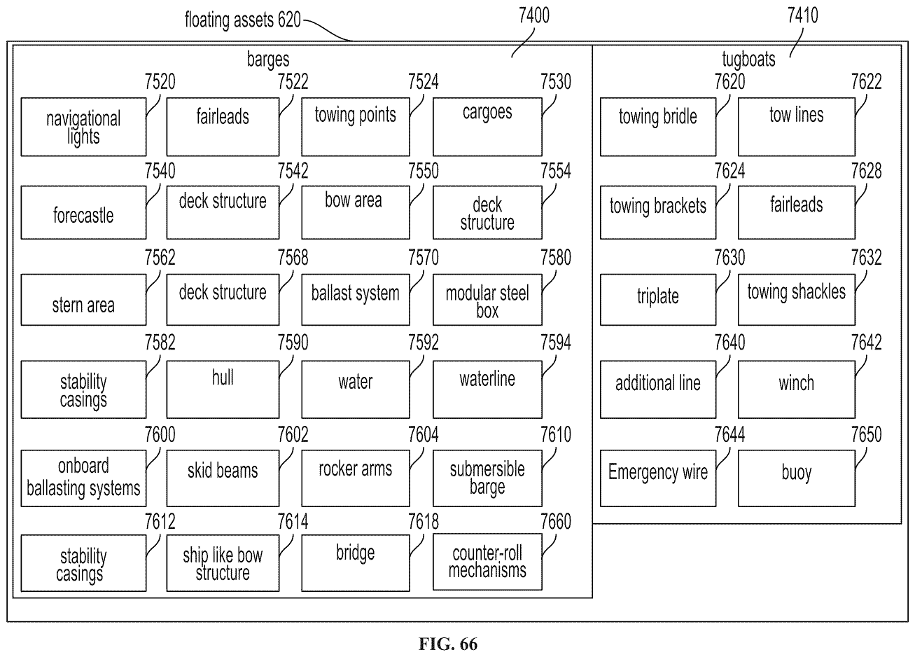

In embodiments, the maritime facilities 622 can include floating assets 620 including many different barges 7500. Referring to FIG. 66, one or more of the barges 7500 can be transport barges, cargo barges, submersible barges, and the like that can in size and capacity. In many examples, barges are available in many varieties of towed barges and self-propelled ships including submersible heavy lift vessels. In many examples, the barges 7500 can be towed or pushed by tug boats 7510 to transport from one location to another. In many examples, the barges 7500 can be flat top and bottom and can be equipped with navigational lights 7520, fairleads 7522 and towing points 7524.

In some examples, the barges 7500 can be designed to be submerged so as to pick up cargoes 7530 such as floating cargoes. By way of these examples, the barges 7500 can be equipped with a forecastle 7540 and a deck structure 7542 at a bow area 7550 opposite a deck structure 7544 at a stern area 7552. There can be additional deck structure 7548 between the bow area 7550 and the stern area 7552 that can be configured and re-configured to hold the cargoes 7530. In these examples, the barges 7500 can be equipped with their own ballast system 7560. In embodiments, the barges 7500 can include a modular steel box 7570 and stability casings 7572 that may be added at the stern area 7552 to some predetermined degree to effectively provide additional portions of a hull 7580 in the water 7582 that can be shown to enhance the stability of the barge 7500 and its cargoes 7530 as the deck structures 7542, 7544, 7548 go through a waterline 7584. In these examples, the modular steel box 7570 and stability casings 7572 can be removable and can be stowed away on one of the deck structures 7542, 7544, 7548 of the barge 7500 or stored onshore when not required. In doing so, the barge 7500 can be relatively more efficient when lighter loads warrant the relatively smaller hull structure.

In many examples, barges 7500 can be classified not only by their length and width but also how they are used, launched and the like. In some examples, one or more of the barges 7500 can be less than 200 feet in length and 50 feet wide. By way of these examples, the barge 7500 can include small pontoons can be used for carrying small structures in sheltered inshore waters. In some examples, one or more of the barges 7500 can be about 250 feet by 70 feet and can include small pontoons to support the barge 7500 that is otherwise configured without an onboard ballast system. By way of these examples, barges in these configurations can be used to transport small offshore loads, do work in and near port infrastructures, perform maintenance in a shipyard, etc. In some examples, one or more of the barges 7500 can be about 300 feet and can be 90 or 100 feet wide. By way of these examples, one or more barges in these configurations can be used as standard cargo barges but may not be equipped with an onboard ballast system. In some examples, one or more barges 7500 can be about 400 feet by 100 feet and these barges can be equipped with an onboard ballast system.

In some examples, one or more of the barges 7500 can be about 450 feet and longer and can be deployed with an onboard ballasting systems 7590. By way of these examples, one or more of the barges 7500 can also be deployed with skid beams 7592. One or more of the barges 7500 can also be deployed with rocker arms 7594 at the stern area 7552 to enable, for example, the launching of jackets or other loads that may be too heavy to lift. In examples, the Heerema H851 brand barge is nominally 850 feet long by 200 feet wide and can be a suitable example of one of the largest commercially available barges.

In embodiments, one or more of the barges 7500 can also be configured as a submersible barge 7600, which can be a towed barge that can be equipped with stability casings 7602 in the stern area 7552. In examples, the submersible barge 7600 can be configured with a ship-like bow structure 7604. In these examples, the ship like bow structure 7604 can be configured with a bridge 7608 sufficiently tall to enable the submerging of the barge above at least a portion of its deck structures. In examples, the Boa brand barges have nominal dimensions of 400 feet by 100 feet, the AMT brand barges have nominal dimensions 470 feet by 120 feet and Hyundai brand barges having nominal dimensions 460 feet by 120 feet can be suitable examples of commercially available submersible barges. By way of these examples, these barges can submerge up to 18 to 24 feet above their decks.

It will be appreciated in light of the disclosure that barges are rated and paired with jobs in terms of deadweight which provides a broad indication of the barges' carrying capacity. The barges, however, have additional requirements such as their global strength, local deck and frame strengths and height of the cargo's center of gravity. With regard to center of gravity, one exemplary barge may be able to transport a 20,000-ton structure with its center of gravity very close to the deck sufficiently tied and supported on the deck. The same exemplary barge may only be able to transport a half of the weight if the cargo has a relatively high center of gravity. With that in mind, many attributes of one or more of the barges are the placement, orientation, center of gravity and weight of the cargoes on their decks.

In embodiments, one of the barges can be towed by one of the ships, tugboats 7510, or the like with a towing bridle 7610. In many examples, two lines 7612 can run from tow brackets 7614 through fairleads 7618 on one of the barges and connect to a triplate 7620 on the barge through towing shackles 7622. By way of this example, a third line 7630 can connect the triplate 7620 to a winch 7640 on one of the tugboats 7510. In further examples, an emergency wire 7642 can be installed along the length of the barge. The emergency wire 7642 can be attached to a connector 7644 that can terminate with a buoy 7650. The buoy 7650 can trail behind the barge 7650 during tow and can form part of the towing arrangement.

In some examples, roll accelerations of the barge can be directly proportional to the transverse stiffness of the barge, which can be measured by its metacentric height. In some arrangements, a barge can have a large metacentric height and as a result, roll accelerations can be severe. In further examples with relatively tall cargo, the metacentric height can be low resulting in the period and amplitude of roll and the static force resulting from the load being greater but the dynamic component may be less. In many examples, attributes of the barge 7500 include positioning of cargoes 7530 on its deck structures and its effective metacentric height. In further examples, counter-roll mechanisms 7660 can be installed on the barge 7500. By way of these examples, the adaptive intelligence layer 614 can update the program of the counter-roll mechanisms 7660 and can be shown to increase its efficacy to changing cargo load and water and weather conditions. In embodiments, the adaptive intelligence layer 614 can update the speed and angles of the of the counter-roll mechanisms 7660 and can be shown to increase its efficacy to changing cargo load and water and weather conditions.

In embodiments, the management platform 604 may include a set of value chain network entities 652 including various delivery systems 632 that can include and connect to the maritime facilities 622. The maritime facilities 622 can include port infrastructure facilities 660, floating assets 620, and shipyards 638, and the like. In embodiments, the value chain network management platform 604 monitors, controls, and otherwise enables management (and in some cases autonomous or semi-autonomous behavior) of a wide range of value chain network 668 processes, workflows, activities, events and applications 630 applicable in the maritime environment.

The maritime facilities 622 can include one or more ships 7060 of various sizes to service the facilities. The maritime facilities 622 can include one or more fixed or moored navigation aids within the water or on land to facilitate the movement ships of various sizes and vehicles on land. In embodiments, the maritime facilities 622 can be configured as a seaport in that it can be configured to accept deep-draft ships with a draft of 20 feet or more. In embodiments, some of the larger maritime facilities 622 can include areas outside the boundaries of the seaports, shipyard, maritime ports, and the like that are related to port operations or to an intermodal connection to the seaports, shipyard, maritime ports, and the like.

In embodiments, the management platform 604 can manage port gate-in and gate-out improvements to the logistics of the flow of assets and cargoes around the maritime facilities 622. In embodiments, the management platform 604 can manage road improvements both within and connecting to the maritime facilities 622. In embodiments, the management platform 604 can manage rail improvements both within and connecting to the maritime facilities 622. In embodiments, the management platform 604 can manage berth improvements in the maritime facilities 622 including to docks, wharves, piers and the like. In embodiments, the management platform 604 can manage berth improvements including dredging at the berths, approach and departure areas adjacent to the berth, and in areas around maritime facilities. In embodiments, the management platform 604 can manage cargo moving equipment used on land. In embodiments, the management platform 604 can manage facilities necessary to improve cargo transport including silos, elevators, conveyors, container terminals, roll-on/roll-off facilities including parking garages necessary for intermodal freight transfer, warehouses including refrigerated facilities, bunkering facilities for oil or gas products, lay-down areas, transit sheds, and the like. In embodiments, the management platform 604 can manage utilities necessary for standard operations including lighting, stormwater, and the like that can be incidental to a larger set of maritime facilities. In embodiments, the management platform 604 can manage port-related intelligent transportation system hardware and software including all technologies used to promote efficient port movements including routing and communications for vessels, trucks, and rail cargo movements as well as flow-through processing for import/export requirements, storage and tracking, and asset/equipment management. In embodiments, the management platform 604 can manage phytosanitary treatment facilities to support phytosanitary treatment requirements. In embodiments, the management platform 604 can manage, configure and re-configure fully automated cargo-handling equipment.

In embodiments, the adaptive intelligent systems layer 614 may include a set of systems, components, services and other capabilities that collectively facilitate the coordinated development and deployment of intelligent systems, such as ones that can enhance one or more of the applications 630 at the application platform 604; ones that can improve the performance of one or more of the components, or the overall performance (e.g., speed/latency, reliability, quality of service, cost reduction, or other factors) of the connectivity facilities 642; ones that can improve other capabilities within the adaptive intelligent systems layer 614; ones that improve the performance (e.g., speed/latency, energy utilization, storage capacity, storage efficiency, reliability, security, or the like) of one or more of the components, or the overall performance, of the value chain network-oriented data storage systems 624; ones that optimize control, automation, or one or more performance characteristics of one or more value chain network entities 652; or ones that generally improve any of the process and application outputs and outcomes 1040 pursued by use of the platform 604.

These adaptive intelligent systems 614 may be deployed in and among the maritime facilities 622 and floating assets 620. These adaptive intelligent systems 614 may include a robotic process automation system 1442, a set of protocol adaptors 1110, a packet acceleration system 1410, an edge intelligence system 1430 (which may be a self-adaptive system), an adaptive networking system 1430, a set of state and event managers 1450, a set of opportunity miners 1460, a set of artificial intelligence systems 1160, a set of digital twin systems 1700, a set of entity interaction management systems 1902 (such as for setting up, provisioning, configuring and otherwise managing sets of interactions between and among sets of value chain network entities 652 in the value chain network 668), and other systems.

In embodiments, a set of digital twin systems 1700 may be deployed for each of the maritime facilities 622 and each of the floating assets 620. Referring to FIG. 6, the connected value chain network 668 benefits from digital twin systems deployed throughout the value chain network management platform 604 to facilitate the management, visualization, and modeling of the orchestration of a variety of factors involved in planning, monitoring, controlling, and optimizing various entities and activities involved in the value chain network 668, such as supply and production factors, demand factors, logistics and distribution factors, and the like. By virtue of the unified platform 604 for monitoring and managing supply factors and demand factors, digital twins for status information can be shared about and between various entities to facilitate modeling and analytics and to provide for visualization of changing demand factors becomes operational realities, as orders are generated and fulfilled, and as products are created and moved through a supply chain.

In embodiments, the value chain monitoring systems layer 614 and its data collection systems 640 may include a wide range of systems for the collection of data from the maritime facilities 622 and the floating assets 620. This layer may include, without limitation, real time monitoring systems 1520 (such as onboard monitoring systems like event and status reporting systems on ships and other floating assets, on delivery vehicles, on trucks and other hauling assets, and in shipyards, ports, warehouses, distribution centers and other locations; on-board diagnostic (OBD) and telematics systems on floating assets, vehicles and equipment; systems providing diagnostic codes and events via an event bus, communication port, or other communication system; monitoring infrastructure (such as cameras, motion sensors, beacons, RFID systems, smart lighting systems, satellite connections, asset tracking systems, person tracking systems, and ambient sensing systems located in various environments where value chain activities and other events take place), as well as removable and replaceable monitoring systems on maritime assets and cargo or other assets contained therein or in transit thereon, such as portable and mobile data collectors, RFID and other tag readers, smart phones, tablets and other mobile devices that are capable of data collection and the like); software interaction observation systems 1500 that can be deployed into portable and onboard systems of the maritime facilities 622 and floating assets 620; visual monitoring systems 1930 such as using video and still imaging systems, LIDAR, IR and other systems that allow visualization of items, people, materials, components, machines, equipment, personnel, and the like to detail cargo in the hold of floating assets 620, to detail activity of personal and gear deployed at the maritime facilities 622 and on the floating assets 620; point of interaction systems (such as dashboards, user interfaces, and control systems for value chain entities); physical process observation systems 1510 (such as for tracking physical activities of operators, workers, customers, or the like, physical activities of individuals (such as shippers, delivery workers, packers, pickers, assembly personnel, customers, merchants, vendors, distributors and others), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems 1940 (including onboard monitors and external monitors of conditions, states, operating parameters, or other measures of the condition of any value chain entity, such as a machine or component thereof, such as a machine, such as a client, a server, a cloud resource, a control system, a display screen, a sensor, a camera, a vehicle, a robot, or other machine); sensors and cameras 1950 and other IoT data collection systems 1172 (including onboard sensors, sensors or other data collectors (including click tracking sensors) in or about a value chain environment (such as, without limitation, a point of origin, a loading or unloading dock, a vehicle or floating asset used to convey goods, a container, a port, a distribution center, a storage facility, a warehouse, a delivery vehicle, and a point of destination), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems 1532 (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems 1534 (including survey systems, touch pads, voice-based feedback systems, rating systems, expression monitoring systems, affect monitoring systems, gesture monitoring systems, and others); behavioral monitoring systems 1538 (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collectors 1172, such as those described throughout this disclosure and in the documents incorporated by reference herein.

Referring to FIG. 26, a set of opportunity miners 1460 may be provided as part of the adaptive intelligence layer 614, which may be configured to seek and recommend opportunities to improve one or more of the elements of the platform 604, such as via addition of artificial intelligence 1160, automation (including robotic process automation 1402), or the like to one or more of the maritime facilities 622 and for each of floating assets 620 including their systems, sub-systems, components, applications with which the platform 100 interacts. In embodiments, the opportunity miners 1460 may be configured or used by developers of AI or RPA solutions to find opportunities for better solutions and to optimize existing solutions in a value chain network 668. In embodiments, the opportunity miners 1460 may include a set of systems that collect information within the management platform 604 and collect information within, about and for a set of maritime facilities 622 and for each of floating assets 620, where the collected information has the potential to help identify and prioritize opportunities for increased automation and/or intelligence about the value chain network 668, about applications 630, one or more of the maritime facilities 622 and the floating assets 620. For example, the opportunity miners 1460 may include systems that observe clusters of value chain network workers by time, by type, and by location (whether on the water or land), such as using cameras, wearables, or other sensors, such as to identify labor-intensive areas and processes in set of value chain network 668 environments. These may be presented, such as in a ranked or prioritized list, or in a visualization (such as a heat map showing dwell times of customers, workers or other individuals on a map of an environment or a heat map showing routes traveled by customers or workers within an environment) to show places with high labor activity. In embodiments, analytics 838 may be used to identify which environments or activities would most benefit from automation for purposes of improved delivery times, mitigation of congestion, and other performance improvements.

In embodiments, opportunity mining may include facilities for solicitation of appropriate training data sets that may be used to facilitate process automation. For example, certain kinds of inputs, if available, would provide very high value for automation, such as video data sets that capture very experienced and/or highly expert workers performing complex tasks. This information becomes even more valuable when collected in close proximity to other maritime facilities 622 and with deployed floating assets 620. Opportunity miners 1460 may search for such video data sets as described herein; however, in the absence of success (or to supplement available data), the management platform 604 may include systems by which a user at a maritime facility or deployed on a maritime asset may specify a desired type of data, such as software interaction data (such as of an expert working with a program to perform a particular task), video data (such as video showing a set of experts performing a certain kind of delivery process, unloading process, securing and logistics process, cleaning and maintenance process, a container movement process, or the like), and/or physical process observation data (such as video, sensor data, or the like). The resulting library of interactions captured in response to the specification may be captured as a data set in the data storage layer 624, such as for consumption by various applications 630, adaptive intelligence systems 614, and other processes and systems. In embodiments, the library may include videos that are specifically developed as instructional videos, such as to facilitate developing an automation map that can follow instructions in the video, such as providing a sequence of steps according to a procedure or protocol, breaking down the procedure or protocol into sub-steps that are candidates for automation, and the like. In embodiments, such videos may be processed by natural language processing, such as to automatically develop a sequence of labeled instructions that can be used by a developer to facilitate a map, a graph, or other models of a process that assists with development of automation for the process.

In embodiments, the value chain monitoring systems layer 614 and its data collection systems 640 may include an entity discovery system 1900 for discovering one or more value chain network entities 652, such as any of the entities described throughout this disclosure and especially those that can be loaded and offloaded as control passes from various maritime facilities 622 and floating assets 620. This may include components or sub-systems for searching for entities at maritime facilities 622 and floating assets 620 within the value chain network 668, such as by device identifier, by network location, by geolocation (such as by geofence), by indoor location (such as by proximity to known resources, such as IoT-enabled devices and infrastructure, Wifi routers, switches, or the like), by cellular location (such as by proximity to cellular towers), by maritime navigation aids and vessel identity beacons, by identity management systems (such as where an entity 652 is associated with another entity 652, such as an owner, operator, user, or enterprise by an identifier that is assigned by and/or managed by the platform 604), and the like. In these examples, an entity discovery system 1900 may interact with established maritime asset logistic systems used to track traffic and location. In these examples, an entity discovery system 1900 may interact with established maritime asset autopilot and auto-navigation systems obtaining information relevant to intended navigation destinations and from there, the error and magnitude of corrective action need to arrive at the navigation destination.

Referring to FIG. 22, the adaptive intelligence layer 614 may include a value chain network digital twin system 1700, which may include a set of components, processes, services, interfaces and other elements for development and deployment of digital twin capabilities for visualization of various value chain entities 652 in environments, and applications 630, as well as for coordinated intelligence (including artificial intelligence 1160, edge intelligence 1420, analytics and other capabilities) and other value-added services and capabilities that are enabled or facilitated with a digital twin 1700. In embodiments, a digital twin system 1700 may be deployed with each facility (or groups thereof) among the maritime facilities 622 and may be deployed for each of floating assets 620. In many instances, each floating asset 620 and physical assets in the maritime facilities 622 can be coordinated and managed with its digital twin supported by the digital twin system 1700. Without limitation, a digital twin system 1700 may be used for and/or applied to each of the processes that is managed, controlled, or mediated by each of the set of applications 614 of the platform application layer that may be deployed in various systems, networks, and infrastructures (or across groups thereof) of the floating assets 620 and in and among the maritime facilities 622.

In embodiments, the digital twin 1700 may take advantage of the presence of multiple applications 630 within the value chain management platform 604, such that a pair of applications may share data sources (such as in the data storage layer 624) and other inputs (such as from the monitoring layer 614) that are collected (to support fusion of collected signals and the like) with respect to value chain entities 652, as well sharing outputs, events, state information and outputs, which collectively may provide a much richer environment for enriching content in a digital twin 1700, including through use of artificial intelligence 1160 including any of the various expert systems, artificial intelligence systems, neural networks, supervised learning systems, machine learning systems, deep learning systems, and other systems described throughout this disclosure and in the documents incorporated by reference and through use of content collected by the monitoring layer 614 and data collection systems 640.

Referring to FIG. 23, any of the value chain network entities 652 can be depicted in a set of one or more digital twins 1700, such as by populating the digital twin 1700 with value chain network data object 1004, such as event data 1034, state data 1140, or other data with respect to value chain network entities 652, applications 630, or components or elements of the platform 604 as described throughout this disclosure.

Thus, the platform 604 may include, integrate, integrate with, manage, control, coordinate with, or otherwise handle any of a wide variety of digital twins 1700, such as distribution twins 1714 (such as representing distribution facilities, assets, objects, workers, or the like); warehousing twins 1712 (such as representing warehouse facilities, assets, objects, workers and the like); port infrastructure twins 1714 (such as representing a seaport, an airport, or other facility, as well as assets, objects, workers and the like); shipping facility twins 1720; operating facility twins 1172; customer twins 1730; worker twins 1740; wearable/portable device twins 1750; process twins 1760; machine twins 21010 (such as for various machines used to support a value chain network 668); product twins 1780; point of origin twins 1502; supplier twins 1630; supply factor twins 1650; maritime facility twins 1572; floating asset twins 1570; shipyard twins 1620; destination twins 1562; fulfillment twins 1600; delivery system twins 1610; demand factor twins 1640; retailer twins 1790; ecommerce and online site and operator twins 1800; waterway twins 1810; roadway twins 1820; railway twins 1830; air facility twins 1840 (such as twins of aircraft, runways, airports, hangars, warehouses, air travel routes, refueling facilities and other assets, objects, workers and the like used in connection with air transport of products 650); autonomous vehicle twins 1850; robotics twins 1860; drone twins 1870; and logistics factor twins 1880; among others.

Referring to FIG. 27, additional details of an embodiment of the platform 604 are provided, in particular relating to elements of the adaptive intelligence layer 614 that facilitate improved edge intelligence, including the adaptive edge compute management system 1400 and the edge intelligence system 1420. These elements provide a set of systems that adaptively manage “edge” computation, storage and processing, such as by varying storage locations for data and processing locations (e.g., optimized by AI) between on-device storage, local systems, peer-to-peer, in the network and in the cloud. These elements can enable facilitation of a dynamic definition by a user, such as a developer, operator, or host of the platform 102, of what constitutes the “edge” for purposes of a given application anywhere in the world and especially in regions of the oceans where connectivity can be constrained. For example, for environments where data connections are slow or unreliable (such as where a facility does not have good access to cellular networks (such as due to remoteness on the globe), shielding or interference (such as where density of network-using systems, thick metals hulls of container ships, thick metal container walls, underwater or underground location, or presence of large metal objects (such as vaults, hulls, containers, cranes, stacked raw materials, and the like,) interferes with networking performance), and/or congestion (such as where there are many devices seeking access to limited networking facilities), edge computing capabilities can be defined and deployed to operate on the local area network of an environment, in peer-to-peer networks of devices, or on computing capabilities of local value chain entities 652. Where strong data connections are available (such as where good backhaul facilities exist), edge computing capabilities can be disposed in the network, such as for caching frequently used data at locations that improve input/output performance, reduce latency, or the like. Thus, adaptive definition and specification of where edge computing operations are enabled, under control of a developer or operator, or optionally determined automatically among a fleet or deployed in a geographic region, such as by an expert system or automation system that may be based on detected network conditions for an environment. In embodiments, edge intelligence 1420 enables adaptation of edge computation (including where computation occurs within various available networking resources, how networking occurs (such as by protocol selection), where data storage occurs, and the like) that is multi-application aware, such as accounting for QoS, latency requirements, congestion, and cost as understood and prioritized based on awareness of the requirements, the prioritization, and the value of edge computation capabilities across more than one application.

In embodiments, the digital twin system 1700 may host floating asset twins 1570 that can be associated with one or more of the floating assets 620. By way of these examples, one or more of the floating asset twins 1570 can simulate how one or more of the floating assets 620 will perform without needing to test the one or more of the floating assets 620 in the real world. Further examples include visualization of all systems of the ship, its navigation course, and functional needs including various details all forms of information on a ship, from engine performance to hull integrity, available at a glance throughout the full lifetime of the vessel through its floating asset twins 1570.

In embodiments, use of the floating asset twins 1570 during operation can be shown to provide beneficial visualization of any and all important components of the one or more the floating assets 620. The use of the floating asset twins 1570 during operation can be shown to be beneficial to carry out analyses and improve the operation on the structural and functional components of the floating assets 620. In further examples, use of the floating asset twins 1570 during operation of the one or more of the floating assets 620 can be used to model in-situ hydrodynamic and aerodynamic changes to the structures and hull surfaces of the floating assets 620. In embodiments, the floating assets 620 can deploy systems to alter the configuration of the cross-sections of certain portions of the hull, alter the configuration of hydrodynamic control surfaces below the water line, alter the configuration of aerodynamic control surfaces above the waterline, extended additional buoyant members from the hull to improve hull stability during certain maneuvers, and the like. In these examples, artificial intelligence systems 1160 can study simulated hull configurations deployed on the floating asset twins 1570 to determine a schedule of hull configuration changes to improve fuel efficiency using known routes of travel and historical weather patterns.

In embodiments, use of the floating asset twins 1570 during operation can be shown to benefit operators as they can plan for more efficient inspections and maintenance of one or more floating assets 620. In embodiments, use of the port infrastructure twins 1714 during operation can be shown to benefit operators that can plan for more efficient inspections and maintenance of one or more physical assets in the maritime facilities 622. This can also lead to an extension of the physical assets' lifetimes, as preventive measures will be taken to avoid damages.

In embodiments, use of the floating asset twins 1570 during operation can be shown to provide operators with an ability to create visual models of the ship and its underlying systems, such as engine spaces and pumps, and continuously record its fuel consumption, distributed on sources of energy, such as engines, boilers and batteries. By way of these examples, operators can plan for more efficient operations, inspections and maintenance of one or more floating assets 620. In embodiments, use of the port infrastructure twins 1714 during operation can be shown to provide operators with ability to create visual models of the maritime assets at a port, on land, moored in location and placed as navigation aids including their underlying systems, such as systems powerplants, and continuously record their energy consumption, distributed on sources of energy, such as engines, boilers and batteries. By way of these examples, operators can plan for more efficient operations, inspections and maintenance of one or more physical assets in the maritime facilities 622. In embodiments, the digital twin systems can include simulation and analytical models that can be developed to acquire the optimum fuel consumption for a particular voyage with a specific cargo, by including external factors such as wind, current and weather conditions. In embodiments, the digital twin systems can include simulation and analytical models that can be developed to acquire the optimum energy consumption for a particular port activity such as unloading with a specific cargo, by including external factors such as weather conditions and other assets monitored by the adaptive intelligence layer 614.

In embodiments, use of the floating asset twins 1570 and the port infrastructure twins 1714 during operation can be shown to provide operators with ability to visualize control and adapt the operation of machinery systems in one or more floating assets 620 or deployed in the physical assets in the maritime facilities 622, especially when the supply chain is across the one or more floating assets 620 and the physical assets in the maritime facilities 622 and processes can be held, increased, decreased based on the progress of other processed on land or on the water.

In embodiments, use of the floating asset twins 1570 and the port infrastructure twins 1714 during operation can be shown to provide optimal points during the voyage or during service life on land to retrofit batteries and replace other switchgear. In embodiments, use of the floating asset twins 1570 during operation can be shown to provide a basis for changing to more powerful, more efficient, or more versatile engines, thrusters or other propulsion systems upon the usual maintenance cycles or at opportune times for retrofit of components.

In embodiments, use of the floating asset twins 1570 during operation can be shown to provide a basis for tuning a schedule to adjust the front bulbous bow of the floating assets 620 to improve efficient flow around the bow of the vessel in various combinations of vessel speed, water activity and weather. In these examples, the front bulbous bow can adjust its shape based on the predetermined schedule or the revised schedule adjust by the adaptive intelligence layer 614 for a shape of the bow for most efficient running.

In embodiments, use of the floating asset twins 1570 during operation can be shown to provide optimal points during the voyage to perform hull cleaning, maintenance or painting or perform propeller cleaning, maintenance or replacement. In embodiments, use of the floating asset twins 1570 during operation can be shown to provide basis for scheduling when hull or propeller cleaning is needed, where in the journey contributes to greatest need to clean systems and determining with simulation using the floating asset twins 1570 whether such maintenance justified or routing of the floating assets 620 to different passages may inflict less of a maintenance burden.

In embodiments, use of the floating asset twins 1570 during operation can be shown to provide detailed simulation and visualization of optimal points during the voyage to perform hull cleaning, maintenance or painting or perform propeller cleaning, maintenance or replacement. In embodiments, use of the floating asset twins 1570 during operation can be shown to provide basis for scheduling when hull or propeller cleaning is needed, where in the journey contributes to greatest need to clean systems and determining with simulation using the floating asset twins 1570 whether such maintenance justified or routing of the floating assets 620 to different passages may inflict less of a maintenance burden.

In embodiments, use of the floating asset twins 1570 during operation can be shown to provide detailed simulation and visualization the performance of one or more ships or floating assets 620 on a detailed level so users can see the effects of design choices and changes on the one or more ships or floating assets 620 as they simulate historical voyages, predicted voyages, and previous voyages modified to further simulate activity encountered to enhance training and safety. In embodiments, use of the floating asset twins 1570 during operation can be shown to provide detailed simulation and visualization the performance of multiple ships or floating assets 620 on a detailed level so users can make use of the digital twins for benchmarking performance towards the other ships or maritime assets and these comparisons can be used to simulate historical voyages, predicted voyages, and previous voyages modified to further simulate activity encountered to enhance training and safety.

In embodiments, use of the floating asset twins 1570 can be shown to provide ship owners a tool for visualization of ships and their subsystems (and various other maritime assets), qualification and analytics of operational data, optimization of ship performance, improved internal and external communication, safe handling of increased levels of autonomy and safe decommissioning.

In embodiments, use of the floating asset twins 1570 can be shown to provide equipment manufacturers a tool to facilitate system integration, demonstrate technology performance, perform system quality assurance and promote additional services for monitoring and maintenance.

In embodiments, use of the floating asset twins 1570 and the port infrastructure twins 1714 can be shown to provide authorities a systematic framework that can be set up with applications to feed live information and generate required reports from each maritime asset whether ships, barges, other floating assets, and port infrastructure including moored navigation aids, cargo in unloaded and loaded conditions and even personnel that move throughout the port infrastructure to ensure its operation. In many examples, use of the floating asset twins 1570 and the port infrastructure twins 1714 can be shown to ensure higher quality reporting on critical issues without putting additional burdens or cognitive load on crew already ensuring operations of the various maritime assets. In many examples, use of the floating asset twins 1570 and the port infrastructure twins 1714 can be shown to ensure higher quality reporting on legal and regulatory issues by providing time-stamped ledgers of activity paired with agreements and contracts underlying the commerce supporting the maritime activity without putting additional burdens or cognitive load on crew already ensuring operations of the various maritime assets.

In embodiments, use of the floating asset twins 1570 and the port infrastructure twins 1714 can be shown to provide universities, colleges, and municipalities with platforms on which to increase system understanding and facilitate knowledge exchange enhancing research and development and education in a range of technological disciplines. By way of these examples, use of the floating asset twins 1570 and the port infrastructure twins 1714 can be shown to provide maritime academies platforms for training that can increase the candidates' understanding of the whole ship or specific maritime asset and train them in systems understanding to see the integrated consequences of actions taken as it affects that asset, all (or some) of the assets including floating and infrastructure assets. In these examples, systems understanding can be shown to be improved because the integrated consequences of actions taken can be seen at the asset level, the fleet of asset level, the infrastructure level, and the business level showing how activity in fleet can affect the profitability of the fleet with combinations of improving revenues and reducing expense where it makes sense all of which can be visualized and interpreted from the floating asset twins 1570 and the port infrastructure twins 1714 including suggestions from the adaptive intelligence layer 614.

In embodiments, an information technology system including a value chain network management platform 604 can have an asset management application 814 such as a maritime fleet management application 880 associated with one or more maritime assets such as one or more floating assets 620 or assets in the maritime facilities 622. In embodiments, a data handling layer 608 of the management platform 604 including data sources such as in the data storage layer 624 and from other inputs such as from the monitoring layer 614 that are collected with respect to any of the value chain entities 652 including one more maritime assets. In embodiments, the data sources contain information used to populate a training set based on a set of maritime activities of one or more of the maritime assets and one of design outcomes, parameters, and data from one or more of the data handling layers 608 is associated with the one or more maritime assets. In embodiments, an artificial intelligence system such as the adaptive intelligence layer 614 can be configured to learn on one or more of the training sets obtained from the data sources from the one or more data handling layers 608. In doing so, the artificial intelligence system can simulate one or more design attributes of one or more of the maritime assets. The artificial intelligence system can also generate one or more sets of design recommendations based on the training sets collected from the data sources. In embodiments, a digital twin system 1700 in the value chain network management platform 604 can provides for visualization of one or more digital twins of one or more of the maritime assets including detail generated by the artificial intelligence system of one or more of the design attributes in combination with the one or more sets of design recommendations.

In embodiments, the maritime assets can include one or more container ships. In embodiments, the maritime assets include one or more barges. In embodiments, the maritime assets include one or more components of the port infrastructure installed on or adjacent to land. In embodiments, the maritime assets include one or more moored navigation units deployed on water. In embodiments, the maritime assets include a ship and the maritime activities include the forward speed of the ship relative to water and weather conditions based on the parameters associated with energy consumption of the propulsion units on the ship.

In embodiments, an information technology system includes a set of intelligent systems for automatically populating a digital twin of a maritime value chain network entity based on data collected by the value chain network management platform 604. In embodiments, the maritime value chain network entity is associated with one or more of the real-world shipyards and the digital twin can be configured to represent one or more of the real-world shipyards. In embodiments, the maritime value chain network entity is associated with a real-world maritime port and the digital twin can be configured to represent one or more of the real-world maritime ports. In embodiments, the maritime value chain network entity is associated with one or more of the container ships and the digital twin can be configured to represent one or more of the container ships. In embodiments, the maritime value chain network entity is associated with one or more of the barges and the digital twin can be configured to represent one or more of the barges.

In embodiments, the maritime value chain network entity is associated with one or more event investigations 7700 and the digital twin can be configured to at least partially represent the maritime value chain network entity as it can act and interact with other assets during a timeline associated with one or more of the event investigations 7700. In embodiments, the maritime value chain network entity is associated with one or more legal proceedings 7702 and the digital twin can be configured to at least partially represent the maritime value chain network entity as it can act and interact with other assets during a timeline associated with the one or more of the legal proceedings 7702. In embodiments, the data collected by a value chain network management platform relates to a casualty report 7704 and the digital twin of the maritime value chain network entity is configured to simulate possibilities of a loss 7708 relevant to the casualty report 7704 based on the data collected by a value chain network management platform.

In embodiments, the maritime value chain network entity is a port infrastructure facility, wherein the data collected by a value chain network management platform facilitates identifying theft or misuse of the port infrastructure facility by correlating data between a set of data collectors for one or more physical items 7710 in the port infrastructure facility and the digital twin can be configured to detail the one or more physical items 7710 of the port infrastructure facility for the at least one of the port infrastructure facility and the set of operators 7720.

In embodiments, the maritime value chain network entity is a container ship that is moored to port infrastructure installed on or adjacent to land.

In embodiments, data collected by a value chain network management platform is based on at least a container ship having a forward speed relative to water and weather conditions and parameters associated with energy consumption of propulsion units on the container ship.

In embodiments, the value chain network management platform 604 includes an asset management application 814 associated with the value chain network management platform and one or more maritime facilities connected to a container ship.

In embodiments, the asset management application is associated with one or more ships connected to barges.

In embodiments, the maritime value chain network entity is one or more ships and the digital twin can provide for visualization of a navigation course of one or more of the ships. In embodiments, the maritime value chain network entity is one or more ships and the digital twin can provide for visualization of an engine performance of one or more of the ships. In embodiments, the maritime value chain network entity is one or more ships and the digital twin can provide for visualization of a hull integrity of one or more of the ships.

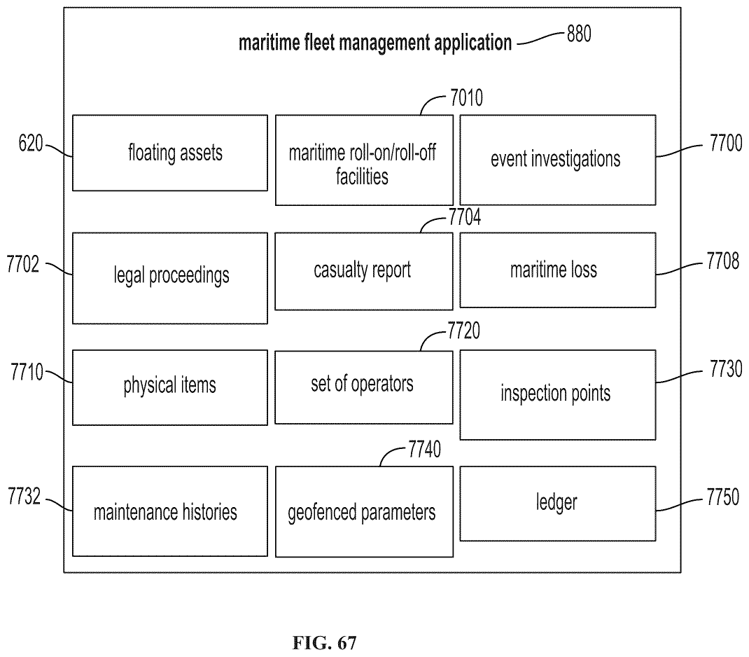

In embodiments, including the example shown in FIG. 67, the digital twin can provide for visualization of a plurality of inspection points 7730 on the maritime value chain network entity and maintenance histories 7732 associated with those inspection points. In embodiments, the digital twin can further provide for the visualization of the plurality of the inspection points 7730 on the maritime value chain network entity within geofenced parameters 7740 and maintenance histories 7732 associated with those inspection points 7730.

In embodiments, the digital twin can further provide for details of a ledger 7750 of activity associated with the visualization of the plurality of inspection points 7730 on the maritime value chain network entity within geofenced parameters 7740 and maintenance histories mardst 832 associated with those inspection points 7730.

### Control Tower and Enterprise Management Platform for Value Chain Network

In embodiments, the control tower may include or interface with an enterprise management platform (or “EMP”). In embodiments, an EMP may be configured to generate, integrate with, support, and/or or operate on one or more digital twins. In general, digital twins merge data from multiple data sources into a model and representation of the salient characteristics of things, assets, systems, devices, machines, components, equipment, facilities, individuals or other entities mentioned throughout this disclosure or in the documents incorporated herein by reference, such as, without limitation: machines and their components (e.g., delivery vehicles, forklifts, conveyors, loading machines, cranes, lifts, haulers, trucks, loading machines, unloading machines, packing machines, picking machines, and many others, including robotic systems (e.g., physical robots, collaborative robots, “cobots”), drones, autonomous vehicles, software bots and many others); value chain processes, such as shipping processes, hauling processes, maritime processes, inspection processes, hauling processes, loading/unloading processes, packing/unpacking processes, configuration processes, assembly processes, installation processes, quality control processes, environmental control processes (e.g., temperature control, humidity control, pressure control, vibration control, and others), border control processes, port-related processes, software processes (including applications, programs, services, and others), packing and loading processes, financial processes (e.g., insurance processes, reporting processes, transactional processes, and many others), testing and diagnostic processes, security processes, safety processes, reporting processes, asset tracking processes, and many others; wearable and portable devices, such as mobile phones, tablets, dedicated portable devices for value chain applications and processes, data collectors (including mobile data collectors), sensor-based devices, watches, glasses, wearables, head-worn devices, clothing-integrated devices, bands, bracelets, neck-worn devices, AR/VR devices, headphones, and many others; workers, such as delivery workers, shipping workers, barge workers, port workers, dock workers, train workers, ship workers, distribution of fulfillment center workers, warehouse workers, vehicle drivers, business managers, engineers, floor managers, demand managers, marketing managers, inventory managers, supply chain managers, cargo handling workers, inspectors, delivery personnel, environmental control managers, financial asset managers, process supervisors and workers (for any of the processes mentioned herein), security personnel, safety personnel and many others); suppliers, such as suppliers of goods and related services of all types, component suppliers, ingredient suppliers, materials suppliers, manufacturers, and many others; customers, including consumers, licensees, businesses, enterprises, value added and other resellers, retailers, end users, distributors, and others who may purchase, license, or otherwise use a category of goods and/or related services; a wide range of operating facilities, such as loading and unloading docks, storage and warehousing facilities, vaults, distribution facilities and fulfillment centers, air travel facilities, including aircraft, airports, hangars, runways, refueling depots, and the like, maritime facilities, such as port infrastructure facilities, such as docks, yards, cranes, roll-on/roll-off facilities, ramps, containers, container handling systems, waterways, locks, and many others), shipyard facilities, floating assets, such as ships, barges, boats and others), facilities and other items at points of origin and/or points of destination, hauling facilities, such as container ships, barges, and other floating assets, as well as land-based vehicles and other delivery systems used for conveying goods, such as trucks, trains, and the like; items or elements factoring in demand (i.e., demand factors), including market factors, events, and many others; items or elements factoring in supply (i.e., supply factors), including market factors, weather, availability of components and materials, and many others; logistics factors, such as availability of travel routes, weather, fuel prices, regulatory factors, availability of space, such as on a vehicle, in a container, in a package, in a warehouse, in a fulfillment center, on a shelf, or the like, and many others; retailers, including online retailers and others; pathways for conveyance, such as waterways, roadways, air travel routes, railways and the like; robotic systems, including mobile robots, cobots, robotic systems for assisting human workers, robotic delivery systems, and others; drones, including for package delivery, site mapping, monitoring or inspection, and the like; autonomous vehicles, such as for package delivery; software platforms, such as enterprise resource planning platforms, customer relationship management platforms, sales and marketing platforms, asset management platforms, Internet of Things platforms, supply chain management platforms, platform-as-a-service platforms, infrastructure-as-a-service platforms, software-based data storage platforms, analytic platforms, artificial intelligence platforms, and others; and many others.

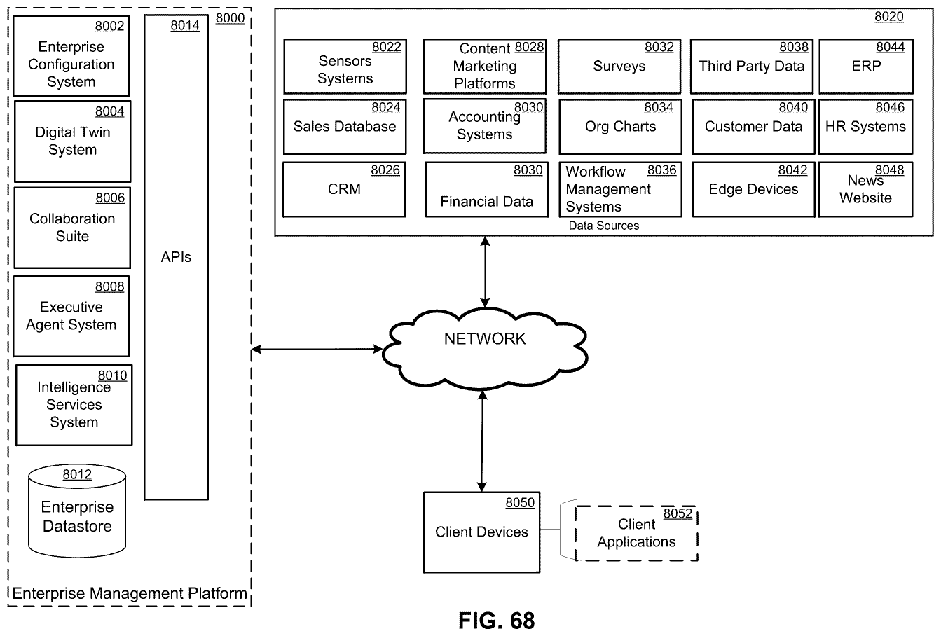

FIG. 68 is a schematic of an example environment of an enterprise management platform 8000. In embodiments, the EMP 8000 may be integrated with or accessible to a control tower via an application programming interface (API). In some of these embodiments, the EMP 8000 may be a series of microservices that are accessible to the control tower.

In embodiments, the EMP 8000 includes an enterprise configuration system 8002, a digital twin system 8004, a collaboration suite 8006, an expert agent system 8008, and an intelligence service system 8010. In embodiments, the EMP 8000 includes an API system 8014 that facilitates the transfer of data between one or more external systems and the EMP 8000. In some embodiments, the intelligence service system 8010 includes an enterprise data store 8012 that stores data relating to enterprises, whereby the enterprise data is used by the digital twin system 8004, the collaboration suite 8006, and/or the expert agent system 8008. The enterprise data store 8012 may store any of a wide variety of data, such as any data involved in the data pipeline described above and throughout this disclosure and the documents incorporated herein by reference. In embodiments, the enterprise data store 8012 may store data that is being used to update digital twins in real-time or substantially real time. In embodiments, the enterprise data store 8012 may store databases, file systems, folders, files, documents, transient data (e.g., real-time data or substantially real-time data), sensor data, and the like.

In embodiments, the enterprise configuration system 8002 provides an interface (e.g., a graphical user interface (GUI)) by which a user (e.g., an “on-boarding” user) may upload or otherwise provide data relating to an enterprise. As used herein, an enterprise may refer to a for-profit or non-profit organization, company, governmental agency, non-governing organization, or the like. While described as an on-boarding user, the configuration of the enterprise management platform 8000 for a particular enterprise may be performed by any number of users, including individuals associated with the enterprise, individuals associated with the EMP, and/or individuals associated with a third-party, such as a third host of a hosted EMP for an enterprise (which may be deployed on cloud resources, platform-as-a-service, software-as-a-service, multi-tenant data resources and/or similar resources) and/or a service provider.

In embodiments, the on-boarding user may define the types of enterprise digital twins that may be generated by the digital twin system 8004 on behalf of the enterprise being on-boarded. In embodiments, the on-boarding user may select different types of digital twins that will be supported for the enterprise by the EMP 8000 via a GUI presented by the enterprise configuration system 8002. For example, the user may select different types role-based digital twins from a menu of digital twin types, where the different types of role-based digital twins include executive digital twins. As another example, the user may select a type of organizational digital twin that is suitable for the user's organization, such as from a library of industry-specific or domain-specific organizational templates. In some embodiments, each type of executive digital twin has a predefined set of states (such term as referenced herein encompassing states, entities, relationships, parameters, and other characteristics) that are depicted in the respective executive digital twin and predefined granularity levels and/or other features for each state of the set. In some embodiments, the set of states that are depicted in the executive digital twin, the granularity of each, and/or other features may be customized (e.g., by the on-boarding user). In these embodiments, a user may define the different states that are represented in each type of executive digital twin and/or the granularity for each of the states depicted in the digital twin. For example, if the CEO of an enterprise has a financial background, the CEO may wish to have more financial data depicted in the CEO digital twin, such that the financial data is displayed at a higher granularity, or the CEO may wish to have access to underlying information on financial models that are available to the digital twin, such as models used for determination of state information (e.g., financial predictions or forecasts) or models used for augmentation of states (such as highlighting important deviations from expectations). By contrast, if the CEO has less financial experience or training, the CEO digital twin may be configured with summary financial data and may include prompts (which may be generated by an intelligent agent trained on a set of enterprise and/or industry outcomes) to obtain CFO input when states deviate from normal operating conditions. In this example, the CEO digital twin may be configured to depict the desired financial data fields at a granularity level set defined by a user (e.g., the financial data may include various revenue streams, cost streams, and the like). In another example, the CEO may have a technical background. In this example, the CEO digital twin may be configured to depict one or more states related to the enterprise's product and R&D efforts, patent development, and product roadmaps at higher granularity levels. In yet another example, a COO may be tasked with overseeing a product team, a marketing team, and an HR department of the enterprise. In this example, the COO may wish to view marketing-related states, product development-related states, and HR-related states at a lower granularity level. In this example, the COO digital twin may be configured to show visual indicators that indicate whether any of the states are at a critical condition, an exceptional condition, or a satisfactory condition. For instance, if employee turnover is very high and employee satisfaction is low, the COO digital twin may depict that the HR-state is at a critical level. In this configuration, the COO may select to drill down into the HR-state, where she may view the employee turnover rate, hiring rate, and employee satisfaction survey results.

In another example, a COO or CTO digital twin may be configured to represent and assist with discovery and management of interconnections, relationships and dependencies between enterprise operations and information technology. For example, a COO digital twin or a CFO digital twin may be configured to depict a set of operations entities and workflows (e.g., flow diagrams that represent a production process, an assembly process, a logistics process, or the like), where entities (including human workers, robots, processing equipment, and other assets) are depicted to operate on a set of inputs such as materials, components, products, containers and information) in order produce and hand off a set of outputs (of similar varied types) to the next set of entities in the workflow for further processing. These may be represented, for example, in a flow diagram that depicts each entity and its relationship in the flow to other entity. In embodiments, a role-based digital twin (such as a CIO digital twin) may also represent an information technology system, such as representing sensors, IoT devices, data collection and monitoring systems, data storage systems, edge and other computational systems, wired and wireless networking systems, and the like, including any of the types described throughout this disclosure. Each information technology component or system may be depicted in the role-based digital twin, along with related data, such as specifications, configuration parameters and settings, processing capabilities, along with its relationship to other components, such as representing data and networking connectivity to other components or systems. In embodiments, a role-based digital twin may provide a converged view that depicts operations technology entities and information technology entities in relation to each other, such as indicating which information technology entities are located with wired or proximal wireless connectivity to which operational entities, indicating which informational technology entities are logically associated to which operational entities (such as where cloud resources, computational resources, artificial intelligence resources, database resources, application resources, or other resources are provisioned to support or interact with operational entities, such as in virtual machine, container or other logical relationships). In embodiments, the converged view presented in the role-based digital twin may thus depict location-based and/or logical interconnections between operations and information technologies. In embodiments, alerts, such as indicating failure modes, congestion, delays, interruptions in service, poor latency, diminished quality of service, bandwidth constraints, poor performance on key performance indicators, downtime, or other issues may be provided as augmentations or overlays of the converged information technology and operations digital twin, so that the COO, CTO, CIO or other user may see interconnections between information technology entities and operational entities that may be contributing to problems. Other types of issues that may be provided as augmentations or overlays may include alerts as to existing conditions and/or forecasts or predictions of such conditions, such as by analytic systems or forecasting artificial intelligence systems, such as expert agents trained to make such forecasts. In an example, if high latency in a control system for a warehouse is slowing down the process of picking and packing goods due to a related edge computational node experiencing congestion on an input data path, the user of the role-based digital twin may be alerted to the fact that operations are being adversely impacted by the congestion, and a recommendation may be presented to augment, update, upgrade, or replace either the system providing connectivity to the edge node or the edge node itself. Thus, a converged digital twin of operations technology entities and information technology entities may provide for insight into how an executive may adjust operations and/or information technology to improve results and/or avoid anticipated problems before they become catastrophic failures.

In embodiments, a user (e.g., an on-boarding user) may connect one or more data sources 8020 to the EMP 8000. Examples of data sources 8020 that may be connected to the EMP may include, but are not limited to, a sensor system 8022 (e.g., a set of IoT sensors), a sales database 8024 that is updated with sales figures in real time, a customer relationship management (CRM) system 8026, a content marketing platform 8028, news websites 8048, a financial database 8030 that tracks costs of the business, surveys 8032 (e.g., customer satisfaction and/or employee satisfaction surveys), an org chart 8034, a workflow management system 8036, customer databases 1S40 that store customer data, external data feeds (such as news feeds, public relations feeds, weather feeds, trade data, pricing data, market data, and the like), data obtained by spidering, webscraping, or otherwise parsing website and social media sites, data obtained by crowdsourcing, and/or data from many and various third-party data sources 8038 that store third-party data. The data sources 8020 may include additional or alternative data sources without departing from the scope of the disclosure. Once the user has defined the configuration of each respective executive digital twin, where the configuration includes the selected states to be depicted (which may include entities, relationships, and characteristics), the features that are to be enabled, and/or the desired granularity of each state, the user may then define the data sources 8020 that are fed into the respective executive digital twin, including any of the data sources in the data pipeline described above. In some embodiments, data from one or more of the data sources may be fused and/or analyzed before being fed into a respective digital twin.

In some embodiments, the on-boarding user may select among various types of enterprise digital twins that are supported for the enterprise, including environment digital twins, information technology digital twins, operations digital twins, organizational digital twins, supply chain digital twins, product digital twins, facility digital twins, customer digital twins, cohort digital twins and/or process digital twins, among others. In some of these embodiments, the user may define the data sources used to generate these digital twins and to update the enterprise digital twins. In embodiments, the user may define any physical locations that will be represented as an environment digital twin (which may be a digital twin of a facility or other suitable environments). For example, the user may define manufacturing facilities (e.g., factories), shipping facilities, warehouses, office buildings, and the like. Each facility may be given a location (which may include a logical and/or virtual location and/or a geo-location) and an identifier, such as a name and type description. In embodiments, the enterprise configuration system 8002 may assign an identifier to each facility and may associate the location of the facility with the identifier. In embodiments, the user may define the types of objects that are included in the environment and/or may be found within an environment. For example, the user may define the types of enterprise resources (e.g., factory, warehouse, or distribution center equipment and machines, assembly lines, conveyors, vehicles, robots, high-lows, and the like, IT systems, workers, and many others) that are in the environment, the types of products, materials and components that are made in, stored in, moved around, assembled, used as inputs within, produced in, sold from, and/or received in the environment, the types of sensors/sensor kits and/or data collection, storage and/or processing devices that are used in the environment, the workers and workflows involved, and the like. Examples of how environment and process digital twins are generated and updated may be found in the U.S. Provisional Application No. 62/931,193, filed Nov. 5, 2019, entitled Methods and Systems of Value Chain Network Management Platform and U.S. Provisional Application No. 62/969,153, filed Feb. 3, 2020, entitled Methods and Systems of Value Chain Network Management Platform, the contents of which are herein incorporated by reference.

In embodiments, the enterprise configuration system 8002 (in combination with the digital twin system 8004) is configured to generate organizational digital twins that represent an organizational structure of an enterprise. In some embodiments, the organizational digital twin may depict individuals/roles occupying the management and expert levels of an enterprise. Alternatively, the organizational digital twin may include a workforce digital twin that represents the entire workforce of an enterprise, including all the employees and/or contractors of the enterprise, or a defined part thereof. For example, in an enterprise setting, workforces may include a logistics workforce, a warehouse workforce, a distribution workforce, a reverse logistics workforce, a delivery workforce, a factory operations workforce, a plant operations workforce, a resource extraction operations workforce, a network operations workforce (e.g., for operating internal networks of an industrial enterprise), a sales workforce, a marketing workforce, an advertising workforce, a retail workforce, an R&D workforce, a technology workforce, an engineering workforce, and/or the like. In another example, with respect to a value chain network, workforces may include a supply chain management workforce, a logistics planning workforce, a vendor management workforce, and the like. In another example, in the context of a marketplace setting, workforces may include a brokering workforce for a marketplace, a trading workforce for a marketplace, a trade reconciliation workforce for a marketplace, a transactional execution workforce for a marketplace, and/or the like. Enterprises may include additional or alternative workforces. In some embodiments, an organizational digital twin may include management-level roles within a workforce. Examples of management-level roles of an enterprise include a CEO role, a COO role, a CFO role, a counsel role, a board member role, a CTO role, an information technology manager role, a chief information officer role, a chief data officer role, an investor role, an engineering manager role, a project manager role, an operations manager role, a business development role. Furthermore, the management-level roles of a workforce may include a factory manager role, a factory operations role, a factory worker role, a power plant manager role, a power plant operations role, a power plant worker role, an equipment service role, and an equipment maintenance operator role. In a value chain context, the management-level roles of a workforce may include a chief marketing officer role, a product development role, a supply chain manager role, a customer role, a supplier role, a vendor role, a demand management role, a marketing manager role, a sales manager role, a service manager role, a demand forecasting role, a retail manager role, a warehouse manager role, a salesperson role, and a distribution center manager role. In the context of marketplaces, the management-level roles of a workforce may include a market maker role, an exchange manager role, a broker-dealer role, a trading role, a reconciliation role, a contract counterparty role, an exchange rate setting role, a market orchestration role, a market configuration role, and a contract configuration role. It is appreciated that not all of the roles defined above apply to a particular workforce type. Furthermore, some roles may be associated with different types of workforces.

In some embodiments, an organizational digital twin may further incorporate data access rules for different divisions and/or roles within the organization. For example, the CEO may be granted access to most or all of the organization's data, the CFO may be granted access to financial-related data and restricted from viewing R&D data, the CTO may be granted access to R&D-related data and restricted from viewing financial data, members of the engineering team may be restricted in accessing financial related data, or the like. Similar rules may be applied to access to features, such as analytic models, artificial intelligence systems, intelligent agents, and the like, including role-based or identity-based control of the ability to view results, to configure inputs, to configure or adjust models (e.g., weights, inputs, or processing functions), to undertake control actions, or the like. In some embodiments, the EMP may utilize the organizational digital twin when determining the level of access a particular individual may be granted and/or whether to deny certain types of access to the individual. In some embodiments, the access rights may limit the types of data that particular users can access, such as information about each individual listed in the organizational digital twin (e.g., salary, start date, availability, work status, and the like). For example, lower level employees may not be granted access to sensitive information, such as financial data, product strategies, marketing strategies, trade secrets, or the like. In some embodiments, certain users may be granted permission to change the access rights of other employees, which may be reflected in the organizational digital twin. For example, certain executives and managers may be granted permission to grant access rights to members of their respective teams when working on certain projects.

In embodiments, the enterprise configuration system 8002 receives an organization chart (“org chart”) definition of an enterprise and generates an organizational digital twin based on the org chart definition. In embodiments, the org chart definition may define the business units/departments of the enterprise, the reporting structure of the enterprise, various roles of the enterprise/within each business unit, and the individuals in the respective roles. In some embodiments, the user can upload the enterprise's org chart to the EMP 8000 via the enterprise configuration system 8002. Additionally or alternatively, the user can define the structure of the org chart (e.g., roles, business units, reporting structure) and may populate the various roles with names and/or other identifiers of the individuals filling the respective roles defined in the org chart. In some embodiments, the enterprise configuration system 8002 may access an enterprise resource planning system 8044 and/or an HR system 8046 of the enterprise to obtain organizational data of the enterprise, such as the roles of the enterprise, the individuals that fill the roles, the salaries of the individuals that fill the roles, the reporting structure of the enterprise, and the like. In these embodiments, the digital twin system 8004 (discussed below) may continue to communicate with the ERP system 8044 and/or HR system 8046 to receive the data needed to maintain the organizational digital twin in a real-time or near-real-time manner.

In embodiments, the enterprise configuration system 8002 (in cooperation with the digital twin system 8004, discussed below) may generate an organizational digital twin of the enterprise based on the org chart definition and the individuals that populate the roles within the org chart definition. In embodiments, a user may define one or more restrictions, permissions, and/or access rights of the individuals indicated in the organizational digital twin via the enterprise configuration system 8002. In embodiments, a restriction may define one or more types of data or features that a particular user or group of users is not allowed to access (either directly or in a digital twin). In embodiments, an access right may define one or more types of data or features that a particular user or group of users may access and the type of access that a user or group of users can access. In embodiments, a permission may define operations that a user or a group of users may perform with respect to the EMP 8000. In embodiments, one or more of the access rights, permissions, and restrictions may be defined geographically and/or temporally limited. For example, some types of data or features may only be viewed or otherwise accessed in certain areas (e.g., sensitive data may only be viewed in the corporate offices) or at certain times (e.g., during Board meetings). In embodiments, the restrictions, permissions, and/or access rights may be set with respect to roles or the users themselves. As such, defining access rights, permissions, and/or restrictions for a user or a group of users may also include defining access rights, permissions, and/or restrictions to a role and/or business unit within the enterprise. In embodiments, the organizational digital twin may be deployed to manage the rights, permissions, and/or restrictions for the users of an enterprise. Furthermore, in embodiments, the organizational digital twin may define the types of role-based digital twins (and other enterprise digital twins) that various users may have access to. In some embodiments, the organizational digital twin may depict additional or alternative information.

In embodiments, the digital twin system 8004 is configured to generate, update, and serve enterprise digital twins of an enterprise. In some embodiments, the digital twin system 8004 is configured to generate and serve role-based digital twins on behalf of an enterprise and may serve the role-based digital twins to a client device 8050 (e.g., a mobile device, a tablet, a personal computer, a laptop, AR/VR-enabled device, workflow-specific device or equipment, or the like). As discussed, during the configuration phase, a user may define the different types of data and the corresponding data sources, data sets, and features that are used to generate and maintain each respective type of the different types of enterprise digital twins. Initially, the digital twin system 8004 configures the data structures that support each type of enterprise digital twin, including any underlying data sources/databases (e.g., SQL databases, graph databases, relational databases, distributed databases, blockchains, distributed ledgers, data feeds, data streams, and the like) that store or produce data that is ingested by the respective enterprise digital twins. Once the data structures that support a digital twin are configured, the digital twin system 8004 receives data from one or more data sources 8020. In embodiments, the digital twin system 8004 may structure and/or store the received data in one or more databases. When a specific digital twin is requested (e.g., by a user via a client application 8052 or by a software component of the EMP 8000), the digital twin system may determine the views that are represented in the requested digital twin and may generate the requested digital twin based on data from the configured databases and/or real-time data received via an API. The digital twin system 8004 may serve the requested digital twin to the requestor (e.g., the client application or a backend software component of the EMP 8000). After an enterprise digital twin is served, some enterprise digital twins may be subsequently updated with real-time data received via the API system 8014. In embodiments, an API may provide information to the data pipeline as to the type of data required for the digital twin, such that the data pipeline may be configured (by a user, or by an automated/intelligence systems) to handle the data effectively. For example, the data pipeline may be configured to deliver data over a data path that uses an appropriate protocol for efficient delivery, delivering the data over a cost-appropriate path (e.g., an inexpensive path for data that does not require low latency or real-time updating), or the like. Thus, in some embodiments, configuration of a digital twin may include providing inputs as to the requirements of the digital twin for low-latency, high quality-of-service, high accuracy, high granularity, high reliability, or the like, based on, for example, the priority of the mission served by the data type. In embodiments, an intelligent expert agent (or “intelligent agent” or “expert agent”) may be trained on a training set of configurations of inputs to one or more data pipelines that were previously configured by experts, such that the intelligent agent may learn to automatically configure APIs for digital twins to provide appropriate inputs to data pipelines for subsequent digital twins involving similar or analogous workflows for similar or analogous roles, identities, industries and/or domains. In embodiments, such training of an intelligent agent may include learning as to specific user interactions, such as learning which users within a role use which types of data at what times and for what purposes, such that data resources are appropriately allocated to support actual user requirements. For example, an automated intelligent agent managing the configuration of a data pipeline for a COO digital twin may learn that an operations executive (e.g., a COO user) checks production data for each facility at the end of each eight-hour shift (e.g., after 5:00 μm), such that mid-shift data updates are delivered over lower-cost data resources, but end-of-shift data is delivered over low-latency data paths that have high reliability and quality-of-service. Continuing this example, the intelligent agent may determine the frequency at which the production data is updated with respect to the COO digital twin, such that the COO digital twin is updated less frequently in the mornings and mid-afternoons, but is updated more frequently at the end of business hours. In embodiments, the intelligent agent may be configured with business logic that defines overall strategies (e.g., when to use low-latency networks v. higher-latency networks and/or how often to update a certain type of data within a particular digital twin) and customized based on the preferences and use by the end user of the digital twin, whereby the overall strategies may be learned from training data sets obtained from experts and/or may be hard-coded by a developer, and the customization piece may be learned from monitoring the use of the digital twin by the end intended user (e.g., when she typically checks the production data of each facility). Additional or alternative examples of such data prioritization strategies and/or other configuration strategies should be understood to be encompassed herein. For example, upon receipt of inputs as to performance requirements, artificial intelligence capabilities of the data pipeline that is integrated with, linked to, or supporting of the EMP 100 may automatically or under user control employ techniques to provide appropriate resources at the right time and place, including, but not limited to: adaptive coding of data path transmissions between networked data communication nodes; adaptive filtering, repeating and amplification of RF/wireless signals (including software-implemented bandpass filtering); dynamic allocation of use of cellular and other wireless spectrum, adaptive, ad-hoc, cognitive management of wireless mesh network nodes; adaptive data storage; cost-based routing of wireless and wired signals; priority-based routing; channel- and performance-aware protocol selection for communications; context-aware allocation of computational resources, serverless computational systems, adaptive edge computational systems, channel-aware error correction, smart-contract-implemented network resource allocation; and/or other suitable techniques.

In embodiments, the digital twin system 8004 may be further configured to perform simulations and modeling with respect to the enterprise digital twins. In embodiments, the digital twin system 8004 is configured to run data simulations and/or environment simulations using a digital twin. For example, a user may, via a client device, instruct the digital twin system 8004 to perform a simulation with respect to one or more states and/or workflows depicted in a digital twin. The digital twin system 8004 may run the simulation on the digital twin and may depict the results of the simulation in the digital twin. In this example, the digital twin may need to simulate at least some of the data used to run the simulation of the environment, so that there is reliable data when performing the requested environment simulation. The digital twin system 8004 is discussed in greater detail throughout the disclosure.

In embodiments, the collaboration suite 8006 provides a set of various collaboration tools that may be leveraged by various users of an enterprise. The collaboration tools may include video conferencing tools, “in-twin” collaboration tools, whiteboard tools, presentation tools, word processing tools, spreadsheet tools, and the like. In embodiments, an “in-twin” collaboration tool allows multiple users to view and collaborate within a digital twin. For example, in embodiments, the collaboration tools may include an in-twin collaboration tool that that enables a digital twin experience and a collaboration experience within the same interface (e.g., within a AR/VR-enabled user interface, a standard GUI, or the like), such as where collaboration entities and events (such as version-controlled objects, comment streams, editing events and other changes) are represented within the digital twin interface and linked to digital twin entities. For example, multiple users may be granted access to view an environment digital twin of a facility, such as a warehouse or factory, via an in-twin collaboration tool. Once viewing the environment digital twin, the users may then change one or more features of the environment depicted in the environment digital twin and may instruct the digital twin system to perform a simulation. In this example, the results of the simulation may be presented to the users in the digital twin and may be automatically populated into a shared document (e.g., a spreadsheet or presentation document). Users may collaborate in additional manners with respect to a digital twin, as will be discussed throughout the disclosure. For example, in some embodiments, the collaboration suite 8006 may allow a user to call a video conference with another user, where the users see each other and see aspects of a specific digital twin that relates to the topics of discussion for the conference. In this example, users may, for example, see a representation of workpiece under discussion and see each other, so that a user can see gestures or indications from another user about how the workpiece should be acted upon. In another example, a conferencing feature of the twin may show participants in a view of a set of environments of facilities by their locations, so that users can recognize which participants may have closest proximity to relevant assets that are the subject of collaboration. In some embodiments, the collaboration suite 8006 interfaces with third-party applications, whereby data may be imported to and/or from the third-party application. For example, in collaborating on a Board presentation, different executives may export data from their respective executive digital twin into a shared presentation file (e.g., PowerPoint™ file or Google™ slide presentation). In another example, a first user (e.g., the CEO of an enterprise) may request certain information (e.g., financial projections for the enterprise) from a second user (e.g., the CTO of the enterprise) via a first executive digital twin configured for the first user (e.g., a CEO digital twin of the enterprise). In response, the second user may upload/export the requested data from a second executive digital twin that was configured for the second user (e.g., the CTO) to the EMP 8000 (e.g., to the collaboration suite 8006 and/or the digital twin system 8004, which may then update the executive digital twin configured for the first user. Additional examples and descriptions of the collaboration suite 8006 and underlying collaboration tools are discussed throughout the disclosure.

In embodiments, the collaboration suite 8006 may be configured to interface with the digital twin system 8004 (e.g., independent of or under control of the digital twin system 8004) to provide role-specific views and other features within a collaboration environment and/or workflow of a collaboration tool, such that different participants in the same collaboration environment and/or workflow experience different views or features of the same digital twin entities and/or workflows. For example, a CFO may collaborate with a COO and a CTO about the possible replacement of an internal system or a piece of machinery or equipment, where the current system, machinery or equipment and/or the potential replacement system, machinery, or equipment is/are represented in the digital twin by visual and other elements. During collaboration, the collaboration suite 8006 may recognize the identities/roles of the CFO, COO and CTO and may automatically configure their respective collaboration views into the example digital twin based on those roles. For example, the CFO may be presented with a view that is augmented with financial data, such as the cost of the item and various possible replacements, terms and conditions of leasing agreements, depreciation information, information on the financial impacts on productivity, or the like. Meanwhile, the collaboration suite 8006 may present the COO with information depicting the relationship of the item to operational processes, such as linkages to other systems involved in a production line, timing information (such as scheduled downtimes for a facility) and the like. In this example, the CTO may be presented with performance specifications and capability information for an item and various possible replacements, including, for example, compatibility information that indicates the extent to which various possible replacements are compatible with other items represented in the digital twin (including physical/mechanical compatibility, data compatibility, software compatibility, and many other forms of technology compatibility), reviews and ratings, and other technical information. Each executive user may be presented with respective information that is in the respective user's “native language” (e.g., information that is tailored to each executive's respective expertise and needs) and with respective views and/or features that are comfortable for that user, while the group can collaborate (in live or asynchronous modes) to raise issues, engage in commentary and dialog, perform analysis (including simulations as described herein) to arrive at a decision (e.g., about selection and timing of a replacement, or an alternative like a repair) that is financially prudent, operationally effective, and technologically sound. Thus, a role-sensitive collaboration environment integrated with respect to a shared enterprise digital twin enables collaboration around digital twin entities and workflows while allowing users to engage with role-sensitive views and features. In embodiments, the collaboration suite 8006 and or other systems of the EMP 8000 (e.g., the digital twin system 8004) may access a semantic model of an enterprise taxonomy to automatically generate and/or provide information that is presented in a shared digital twin (such as role-specific augmentation of entities with text or symbols that is derived from data or metadata based on state information or other data). In embodiments, the enterprise taxonomy may be learned by the EMP 8000 via an analysis of data provided by the enterprise or may be manually uploaded by a user (e.g., a configurating user associated with the enterprise). The information in the digital twin may be presented with a role-specific understanding of the taxonomy, such as where the same entity (e.g., a piece of equipment) is given a different name by different groups in the enterprise (e.g., referred to as an “asset” by the finance department and a “machine” by the operations team) and/or where attributes of the entity or related workflows use different terminology, codes, symbols, or the like that are role-specific or group-specific. In embodiments, the collaboration suite 8006 may automatically enable translation of terminology between roles, such as translating commentary that uses the name of an entity or that describes attributes of the entity from one role-specific form to another role-specific form. Automatic translation may present alternative terms together (e.g., as the “asset/machine” or “code red/urgent”). In embodiments, automated translation may be performed by translation models (e.g., enterprise-specific translation models) that are trained by machine learning or similar techniques, whereby the translation models may be leveraged to provide automated translation for role-sensitive entity, workflow and attribute presentation. In embodiments, the translation models may be trained using a training data set of translations generated by human experts and/or by unsupervised learning techniques that operate on the data of the enterprise to identify associations between different terms used by different roles and/or groups to describe the same thing. In embodiments, translation models may be seeded by an explicit translation model or may be accomplished by deep learning or similar techniques known to those of skill in the art.

In embodiments, the expert agent system 8008 trains expert agents that perform/recommend actions on behalf of an expert. An expert agent may be a software module that implements and/or leverages artificial intelligence services to perform/recommend actions on behalf of or in lieu of an expert. In embodiments, an expert agent may include one or more machine-learned models (e.g., neural networks, prediction models, classification models, Bayesian models, Gaussian models, decision trees, random forests, and the like, including any of the artificial intelligence systems, expert systems, or the like described throughout this disclosure and/or the documents incorporated herein by reference) that perform machine-learning tasks, including robotic process automation, in connection with a defined role. Additionally or alternatively, an expert agent may be configured with artificial intelligence rules that determine actions in connection with a defined role. The artificial intelligence rules may be programmed by a user or may be generated by the expert agent system 8008. An expert agent may be executed at a client device 8050 and/or may be executed by or by a system that is linked to or integrated with the EMP 8000. In embodiments, the expert agent may be accessed as a service (e.g., via an API), such as in a service-oriented architecture, which in embodiments may be integrated with the EMP as service that is part of a microservices architecture. In embodiments, where an expert agent is at least partially executed at a client device, the EMP 8000 may train an executive agent and may serve the trained executive agent to a client application 8052. In embodiments, an expert agent may be implemented as a container (e.g., a Docker container), virtual machine, virtualized application, or the like that may execute at the client device 8050 or at the EMP 8000. In embodiments, the expert agent is further configured to collect and report data to the expert agent system 8008, which the expert agent system 8008 uses to train/reinforce/reconfigure the expert agent. Many examples of such training are described throughout this disclosure and many others are intended to be encompassed by the disclosure.

In some embodiments, the expert agent system 8008 (working in connection with the artificial intelligence services system 8010) may train expert agents (e.g., executive agents and other expert agents), such as using robotic process automation techniques, machine learning techniques, or other artificial intelligence or expert systems as described throughout this disclosure and/or the documents incorporated by reference herein to perform one or more executive actions on behalf of respective users, such as executives or other users who are responsible for undertaking activities that are automated by the robotic process automation or other techniques. In some of these embodiments, a client application 8052 may execute on a client device 8050 (e.g., a user device, such as a tablet, an AR and/or VR headset, a mobile device, or a laptop, an embedded device, an enterprise server, or the like) associated with a user (e.g., an executive, an administrative assistant of the executive, a board member, a role-based expert, a manager, a worker, or any other suitable employee or affiliate). In embodiments, the client application 8052 may record the interactions of a user with the client application 8052 and may report the interactions to the expert agent system 8008. In these embodiments, the client application 8052 may further record and report features relating to the interaction, such as any stimuli or inputs that were presented to the user, what the user was viewing at the time of the interaction, the type of interaction, the role of the user, whether the interaction was requested by someone else, the role of the individual that requested the interaction, contextual information, state information, workflow information, event information, and the like. The expert agent system 8008 may receive the interaction data and related features and may generate, train, configure, and/or update an executive agent based thereon. In embodiments, the interactions may be interactions by the user with an enterprise digital twin (e.g., an environment digital twin, a role-based digital twin, a process digital twin, and the like). In embodiments, the interactions may be interactions by the user with data, such as sensor data (e.g., vibration data, temperature data, pressure data, humidity data, radiation data, electromagnetic radiation data, motion data, and/or the like) and/or data streams collected form physical entities of the enterprise (e.g., machinery, a building, a shipping container, or the like), data from various enterprise and/or third-party data sources (as described throughout this disclosure and incorporated documents), entity data (such as characteristics, features, parameters, settings, configurations, attributes and the like), workflow data (such as timing, decision steps, events, tasks activities, dependencies, resources, or the like), and many other types of data. For example, a user may be presented with sensor data from a particular piece of machinery or equipment and, in response, may determine that a corrective action to be taken with respect to the piece of machinery or equipment. In this example, the expert agent may be trained on the conditions that cause the user to take a corrective action as well as instances where the user did not take corrective actions. In this example, the expert agent may learn the circumstances in which corrective action is taken.

In embodiments, the expert agent system 8008 may train expert agents based on user interactions with network entities and/or computation entities. For example, the expert agent system 8008 may train an expert agent to learn the manner by which an IT expert diagnoses and handles a security breach. In this example, the expert agent may be trained to learn the steps undertaken by the expert to diagnose a security breach, the individuals within the enterprise that the security breach is reported to, and any actions undertaken by the expert to resolve the security breach.

In embodiments, the types of actions that an expert agent may be trained to perform/recommend include: selection of a tool, selection of a task, selection of a dimension, setting of a parameter, configuration of settings, flagging an item for review, providing an alert, providing a summary report of data, selection of an object, selection of a workflow, triggering of a workflow, ordering of a process, ordering of a workflow, cessation of a workflow, selection of a data set, selection of a design choice, creation of a set of design choices, identification of a failure mode, identification of a fault, identification of an operating mode, identification of a problem, selection of a human resource, selection of a workforce resource, providing an instruction to a human resource, and providing an instruction to a workforce resource, amongst other possible types of actions. In embodiments, an expert agent may be trained to perform other types of tasks, such as: determining an architecture for a system, reporting on a status, reporting on an event, reporting on a context, reporting on a condition, determining a model, configuring a model, populating a model, designing a system, designing a process, designing an apparatus, engineering a system, engineering a device, engineering a process, engineering a product, maintaining a system, maintaining a device, maintaining a process, maintaining a network, maintaining a computational resource, maintaining equipment, maintaining hardware, repairing a system, repairing a device, repairing a process, repairing a network, repairing a computational resource, repairing equipment, repairing hardware, assembling a system, assembling a device, assembling a process, assembling a network, assembling a computational resource, assembling equipment, assembling hardware, setting a price, physically securing a system, physically securing a device, physically securing a process, physically securing a network, physically securing a computational resource, physically securing equipment, physically securing hardware, cyber-securing a system, cyber-securing a device, cyber-securing a process, cyber-securing a network, cyber-securing a computational resource, cyber-securing equipment, cyber-securing hardware, detecting a threat, detecting a fault, tuning a system, tuning a device, tuning a process, tuning a network, tuning a computational resource, tuning equipment, tuning hardware, optimizing a system, optimizing a device, optimizing a process, optimizing a network, optimizing a computational resource, optimizing equipment, optimizing hardware, monitoring a system, monitoring a device, monitoring a process, monitoring a network, monitoring a computational resource, monitoring equipment, monitoring hardware, configuring a system, configuring a device, configuring a process, configuring a network, configuring a computational resource, configuring equipment, and configuring hardware. As discussed, an expert agent is configured to determine an action and may output the action to a client application 8052. Examples of an output of an expert agent may include a recommendation, a classification, a prediction, a control instruction, an input selection, a protocol selection, a communication, an alert, a target selection for a communication, a data storage selection, a computational selection, a configuration, an event detection, a forecast, and the like. Furthermore, in some embodiments, the expert agent system 8008 may train expert agents to provide training and/or guidance rather in addition to or in lieu of outputting an action. In these embodiments, the training and/or guidance may be specific for a particular individual or role or may be used for other individuals.

In embodiments, the expert agent system 8008 is configured to provide benefits to experts that participate in the training of expert agents. In some embodiments, the benefit is a reward that is provided based on the outcomes stemming from the user of an expert agent that is trained at least in part based on actions by the expert user. In some embodiments, the benefit is a reward that is provided based on the productivity of the expert agent. For example, if an expert agent trained by an individual is leveraged in connection with a set of users in the enterprise (or outside the enterprise), an account with the individual may be credited with a benefit such as a cash rewards, stock rewards, gift card rewards, or the like. As the expert agent is used more, the benefit to the individual may be increased. In some embodiments, the benefit is a reward that is provided based on a measure of expertise of the expert agent. For example, individuals having a more sought after/valuable skill may be awarded greater benefits than individuals having a less sought after/valuable skill. In some embodiments, the benefit is a share of the revenue or profit generated by, or cost savings resulting from, the work produced by the expert agent. In some embodiments, the benefit is tracked using a distributed ledger (e.g., a blockchain) that captures information associated with a set of actions and events involving the expert agent. In some of these embodiments, a smart contract may govern the administration of the reward to the expert user.

In some embodiments, a set of expert agents trained by the expert agent system 8008 may be deployed as a double of at least a portion of a workforce of an enterprise, where the expert agents perform tasks of different roles within the enterprise. In some of these embodiments, the expert agents may be trained upon a training set of data that includes a set of interactions by members of a defined workforce of the enterprise during performance of the defined set of roles of the defined workforce (e.g., interactions with physical entities, digital twins, sensor data, data streams, computational entities, and/or network entities, among many others). In some embodiments, the interactions may be parsed to identify a chain of operations performed by the workforce and/or a chain of reasoning, whereby the chain of operations and/or chain of reasoning are used to train the expert agents. In some embodiments, the interactions may be parsed to identify types of processing performed by the workforce upon a set of information, whereby the type of processing is embodied in the configuration of the respective expert agents. Examples of workforces may include, factory operations, plant operations, resource extraction operations, network operations (e.g., responsible for operating a network for an industrial enterprise), a supply chain workforce, a logistics planning workforce, a vendor management workforce, a brokering workforce for a marketplace, a trading workforce for a marketplace, a trade reconciliation workforce for a marketplace, a transactional execution workforce for a marketplace, and the like.

In some embodiments, the expert agent system 8008 and/or a client application 8052 can monitor outcomes related to the user's interactions and may reinforce the training of the expert agent based on the outcomes. For example, each time the user takes a corrective action, the expert agent system 8008 may determine the outcome (e.g., whether a particular condition or issue was resolved) and whether the outcome is a positive outcome or a negative outcome. The expert agent system 8008 may then retrain the expert agent based on the outcome. Examples of outcomes may include data relating to at least one of a financial outcome, an operational outcome, a fault outcome, a success outcome, a performance indicator outcome, an output outcome, a consumption outcome, an energy utilization outcome, a resource utilization outcome, a cost outcome, a profit outcome, a revenue outcome, a sales outcome, and a production outcome. In these embodiments, the expert agent system 8008 may monitor data obtained from the various data sources after an action is taken to determine an outcome (e.g., sales increased/decreased and by how much, energy utilization decreased/increased and by how much, costs decreased/increased and by how much, revenue increased/decreased and by how much, whether consumption decreased/increased and by how much, whether a fault condition was resolved, and the like). The expert agent system 8008 may include the outcome in the training data set associated with the action undertaken by the expert that resulted in the outcome.

In some embodiments, the expert agent system 8008 receives feedback from users regarding respective executive agents. For example, in some embodiments, a client application 8052 that leverages an expert agent may provide an interface by which a user can provide feedback regarding an action output by an expert agent. In embodiments, the user provides the feedback that identifies and characterizes any errors by the expert agent. In some of these embodiments, a report may be generated (e.g., by the client application or the EMP 8000) that indicates the set of errors encountered by the expert. The report may be used to reconfigure/retrain the executive agent. In embodiments, the reconfiguring/retraining an executive agent may include removing an input that is the source of the error, reconfiguring a set of nodes of the artificial intelligence system, reconfiguring a set of weights of the artificial intelligence system, reconfiguring a set of outputs of the artificial intelligence system, reconfiguring a processing flow within the artificial intelligence system, and/or augmenting the set of inputs to the artificial intelligence system.

In embodiments, the expert agent may be configured to, at least partially, operate as a double of the expert for a defined role within an enterprise. In these embodiments, the expert agent system 8008 trains an expert agent based on a training data set that includes a set of interactions by a specific expert worker during the performance of their respective role. For example, the set of interactions that may be used to train the executive agent may include interactions of the expert with the physical entities of an enterprise, interactions of the expert with an enterprise digital twin, interactions of the expert with sensor data obtained from a sensor system of the enterprise, interactions of the expert with data streams generated by the physical entities of the enterprise, interactions of the expert with the computational entities of the enterprise, interactions of the expert with the network entities, and the like. In some embodiments, the expert agent system 8008 parses the training data set of interactions to identify a chain of reasoning of the expert upon a set of interactions. In some of these embodiments, the chain of reasoning may be parsed to identify a type of reasoning of the worker, which may be used as a basis for configuring/training the expert agent. For example, the chain of reasoning may be a deductive chain of reasoning, an inductive chain of reasoning, a predictive chain of reasoning, a classification chain of reasoning, an iterative chain of reasoning, a trial-and-error chain of reasoning, a Bayesian chain of reasoning, a scientific method chain of reasoning, and the like. In some embodiments, the expert agent system parses the training data set of interactions to identify a type of processing undertaking by the expert in analyzing the set of interactions. For example, types of processing may include audio processing in analyzing audible information, tactile or “touch” processing in analyzing physical sensor information, olfactory processing in analyzing chemical sensing information, textual information processing in analyzing text, motion processing in analyzing motion information, taste processing in analyzing chemical information, mathematical processing in mathematically operating on numerical data, executive manager processing in making executive decisions, creative processing when deriving alternative options, analytic processing when selecting from a set of options, and the like.

In embodiments, the expert agents include executive agents that are trained to output actions on behalf of executive and/or an administrator of an executive. In these embodiments, an expert agent may be trained for executive roles, such that a user in an executive role can train the executive agent by performing their respective role. For example, an executive agent may be trained for performing actions on behalf of or recommending actions to a user in an executive role. In some of these embodiments, the client application 8052 may provide the functionality of the enterprise management platform 8000. For example, in some embodiments, users may view executive digital twins and/or may use the collaboration tools via the client application 8052. During the use of the client application 8052, an executive may either escalate issues identified in the respective executive digital twin to another member of the enterprise. Each time the user interacts with the client application 8052, the client application 8052 may monitor the user's actions and may report the actions back to the expert agent system 8008. Over time, the expert agent system 8008 may learn how the particular user responds to certain situations. For instance, if the user is the CFO and each time a critical state with revenue or costs is identified in the CFO digital, the CFO escalates the critical state to the CEO, the expert agent system 8008 may learn to automatically escalate critical revenue states and critical cost states to the CEO. Further implementations of the expert agent system 8008 are discussed further in the disclosure.

In embodiments, the artificial intelligence services system 8010 performs machine learning, artificial intelligence, and analytics tasks on behalf of the EMP 8000. In embodiments, the artificial intelligence services system 8010 includes a machine learning system that trains machine learned models that are used by the various systems of the EMP 8000 to perform some intelligence tasks, including robotic process automation, predictions, classifications, natural language processing, and the like. In embodiments, the EMP 8000 includes an artificial intelligence system that performs various AI tasks, such as automated decision making, robotic process automation, and the like. In embodiments, the EMP 8000 includes an analytics system that performs different analytics across enterprise data to identify insights to various states of an enterprise. For example, in embodiments, the analytics system may analyze the financial data of an enterprise to determine whether the enterprise is financially stable, in a critical condition, or a desirable condition. In embodiments, the analytics system may perform the analytics in real-time as data is ingested from the various data sources to update one or more states of an enterprise digital twin. In embodiments, the intelligence system includes a robotic process automation system that learns behaviors of respective users and automates one or more tasks on behalf of the users based on the learned behaviors. In some of these embodiments, the robotic process automation system may configure expert agents on behalf of an enterprise. The robotic process automation system may configure machine-learned models and/or AI logic that operate to output actions given stimulus. In embodiments, the robotic process automation system receives training data sets of interactions by experts and configures the machine-learned models and/or AI logic based on the training data sets. In embodiments, the artificial intelligence services system 8010 includes a natural language processing system that receives text/speech and determines a context of the text and/or generates text in response to a request to generate text. The intelligence services are discussed in greater detail throughout the disclosure.

In embodiments, the EMP 8000 includes an enterprise data store 8012 that stores data on behalf of customer enterprises. In embodiments, each customer enterprise may have an associated data lake that receives data from various data sources 8020. In some embodiments, the EMP 8000 receives the data via one or more APIs 8014. For example, in embodiments, the API may be configured to obtain real-time sensor data from one or more sensor systems 8022 of an enterprise. The sensor data may be collected in a data lake associated with the enterprise. The digital twin system 8004 and the artificial intelligence services system 8010 may structure the data in the data lake and may populate one or more respective enterprise digital twins based on the collected data. In some embodiments, the data sources 8020 may include a set of edge devices 8042 that collect, receive and process data from the sensor system 8022, from suitable IoT devices, from local networking devices (e.g., wireless and fixed network resources, including repeaters, switches, mesh network nodes, routers, access points, gateways, and others), from general purpose networking devices (e.g., computers, laptops, tablets, smartphones and the like), from smart products, from telemetry systems of machinery, equipment, systems and components (e.g., onboard diagnostic systems, reporting systems, streaming systems, syndication systems, event logs and the like), data collected by data collectors (including drones, mobile robots, RFID and other readers, and human-portable collectors) and/or other suitable data sources. In some of these embodiments, the edge devices 8042 may be configured to process sensor data (or other suitable data) collected at a “network edge” of the enterprise. Edge processing of enterprise data may include sensor fusion, data compression, computation, filtering, aggregation, multiplexing, selective switching, batching, packetization, streaming, summarization, fusion, fragmentation, encoding, decoding, transcoding, copying, storage, decompression, syndication, augmentation (e.g., by metadata), content inspection, classification, extraction, transformation, normalization, loading, formatting, error correction, data structuring, and/or many other processing actions. In some embodiments, the edge device 8042 may be configured to operate on the collected data and to adjust an output data stream or feed based on the contents of the collected data and/or based on contextual information, such as network conditions, operational conditions, environmental conditions, workflow conditions, entity state information, data characteristics, or many others. For example, an edge device 8042 may stream granular sensor data that is identified to be anomalous without compression, while the edge device 8042 may compress, summarize, or otherwise pass on a less granular data that is considered to be within a tolerance range of normal conditions or that reflects characteristics (e.g., statistical or signal characteristics) that suggest a lower likelihood that the data is likely to be of high interest. In this way, the edge device 8042 may provide semi-sentient data streams. Semi-sentience at the edge device 8042 may be improved by machine learning and training on a set of outcomes or feedback from users using process automation, machine learning, deep learning, or other artificial intelligence techniques as described herein. In embodiments, the EMP 8000 may store the data streams in the data lake and/or may update one or more enterprise digital twins with some or all of the received data.

In embodiments, the client devices 8050 may execute one or more client applications 8052 that interface with the EMP 8000. In embodiments, a client application 8052 may request and display one or more enterprise digital twins. In some of these embodiments, a client application 8052 may depict an executive digital twin corresponding to the role of the user. For example, if the user is designated as the Chief Marketing Officer, the EMP 8000 may provide a CMO digital twin of the enterprise of the user. In some of these embodiments, the user data stored at the EMP 8000 and/or the client device 8050 may indicate the role of the user and/or the types of enterprise digital twins (and features thereof) to which the user has access.

In embodiments, the client application 8052 may display the requested executive digital twin and may provide one or more options to perform one or more respective actions/operations corresponding to the executive digital twin and the states depicted therein. In embodiments, the actions/operations may include one or more of “drilling down” into a particular state, escalating or otherwise notifying another user of a state or set of states, exporting a state or set of states into a collaborative environment (e.g., into a word processor document, a spreadsheet, a presentation document, a slide show, a model (e.g., a CAD model, a 3D model, or the like), a report (e.g., an annual report, a quarterly report, or the like), a website, a Wiki, a dashboard, a collaboration environment location (e.g., a Slack™ location), a workflow application, or the like), sending a request for action with respect to one or more states from another user, performing a simulation, adjusting interface elements (such as changing sizes, colors, locations, brightness, presence/absence of display, etc.), or the like. For example, a COO or other operations executive may view an operations or COO digital twin. The states that may be depicted in the COO digital twin may include notifications of potential issues with one or more pieces of machinery or equipment (e.g., among many others, as observed from analyzing a stream of data from one or more sensors on a piece of robotic equipment). In viewing the COO digital twin, the user may wish to escalate the issue, such as to the CEO, request input from another executive and/or to instruct an operations manager, such as a warehouse or plant manager, to handle the issue. In this example, the client application depicting the COO digital twin may allow the user to select an option to escalate the issue. In response to the user selecting the “escalate” option, the client application 8052 transmits the escalate request to the EMP 8000. The EMP 8000 may then determine the appropriate user or users to which the issue is escalated. In some embodiments, the EMP 8000 may determine the reporting structure of the enterprise from an organizational digital twin of the enterprise to which the users belong. In this example, if the operations executive elects to have the operations manager handle the issue, the user may select an option to share the state with another user. The user may then enter an identifier of the intended recipient (e.g., an email address, phone number, text address, user name, role description, or other identifier of the recipient (such as identifiers for the recipient in various workflow environments, collaboration environments and the like (including other digital twins), and the like) and may input a message indicating instructions to the intended recipient. In response, the EMP 8000 may communicate the identified state to the intended recipient.

In another example, the client application 8052 may depict a CFO digital twin to a user (e.g., the CFO of an enterprise). In this example, the CFO may be tasked with preparing a quarterly report at the request of the CEO. In this example, the CFO may view a set of different financial states, including a P&L data, historical sales data (e.g., quarterly sales data and/or annual sales data), real-times sales data, projected sales data, historical cost data (e.g., quarterly costs and/or annual costs), projected costs, and the like. In this example, the CFO may select the states to include in the annual report, including the P&L data, quarterly sales data, and quarterly cost data. In response to the user selection, the client application 8052 may transmit a request to export the selected states into the annual report. In this example, the EMP 8000 may receive the request, identify the document (e.g., the annual report), and may include the selected states into the identified document.

In embodiments, the client application 8052 may include a monitoring agent that monitors the manner by which a user responds to specific requests (e.g., a request from the CEO to populate a report) or notifications (e.g., a notification that a piece of machinery requires maintenance). The monitoring agent may report the user's response to such prompts to the EMP 8000. In response, the EMP 8000 may train an executive agent (which may include one or more machine-learned models) to handle such notifications when they next arrive. In some embodiments, the monitoring agent may be incorporated in an executive agent that is incorporated in the client application 8052.

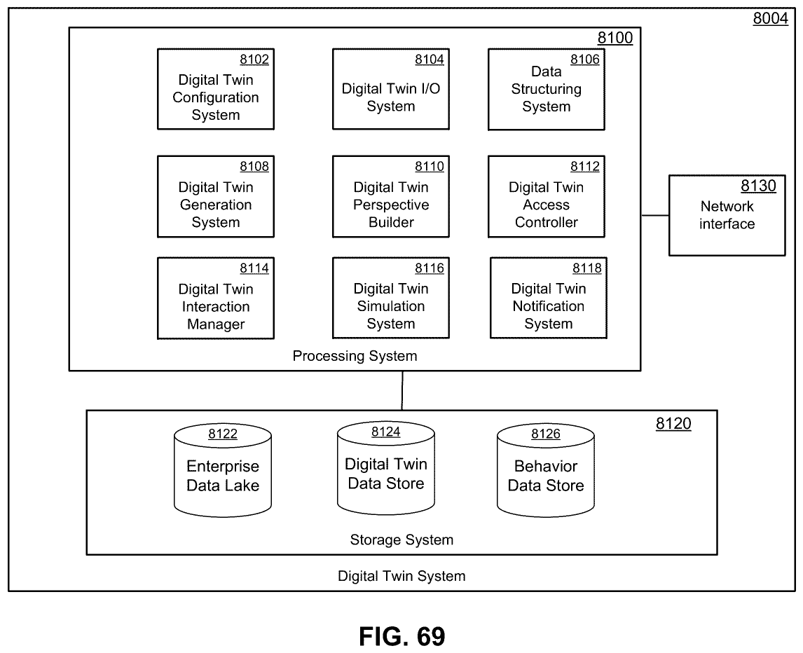

FIG. 69 illustrates an example set of components of a digital twin system 8004. As discussed, a digital twin system 8004 is configured to generate visual and/or data-based digital twins, including enterprise digital twins, and to serve the digital twins to a client (e.g., a user device, a server, and/or internal and/or external applications that leverage digital twins). In embodiments, the digital twin system 8004 is an infrastructure component of the EMP 8000. In embodiments, the digital twin system 8004 is a microservice that is accessible by the EMP 8000 and/or other components of a value chain control tower.

In embodiments, the digital twin system 8004 is executed by a computing system (e.g., one or more servers) that may include a processing system 8100 that includes one or more processors, a storage system 8120 that includes one or more computer-readable mediums, and a network interface 8130 that includes one or more communication units that communicate with a network (e.g., the Internet, a private network, and the like). In the illustrated example embodiments, the processing system 8100 may execute one or more of a digital twin configuration system 8102, digital twin I/O system 8104, a data structuring system 8106, a digital twin generation system 8108, a digital twin perspective builder 8110, a digital twin access controller 8112, a digital twin interaction manager 8114, an digital twin simulation system 8116, and a digital twin notification system 8118. The processing system 8100 may execute additional or alternative components without departing from the scope of the disclosure. In embodiments, the storage system 8120 may store enterprise data, such as an enterprise data lake 8122, a digital twin data store 8124, a behavior datastore 8126 and/or other datastore, such as a distributed datastore, such as a set of blockchains or distributed data storage resources. The storage system 8120 may store additional or alternative data stores without departing from the scope of the disclosure. In embodiments, the digital twin system 8004 may interface with the other components of the EMP 8000, such as the enterprise configuration system 8002, the collaboration suite 8006, the expert agent system 8008, and/or the artificial intelligence services system 8010.

In embodiments, the digital twin configuration system 8102 is configured to set up and manage the enterprise digital twins and associated metadata of an enterprise, to configure the data structures and data listening threads that power the enterprise digital twins, and to configure features of the enterprise digital twins, including access features, processing features, automation features, reporting features, and the like, each of which may be affected by the type of enterprise digital twin (e.g., based on the role(s) that it serves, the entities it depicts, the workflows that it supports or enables and the like). In embodiments, the digital twin configuration system 8102 receives the types of digital twins that will be supported for the enterprise, as well as the different objects, entities, and/or states that are to be depicted in each type of digital twin. For each type of digital twin, the digital twin configuration system 8102 determines one or more data sources and types of data that feed or otherwise support each object, entity, or state that is depicted in the respective type of digital twin and may determine any internal or external software requests (e.g., API calls) that obtain the identified data types or other suitable data acquisitions mechanisms, such as webhooks, that are configured to automatically receive data from an internal or external data source In some embodiments, the digital twin configuration system 8102 determines internal and/or external software requests that support the identified data types by analyzing the relationships between the different types of data that correspond to a particular state/entity/object and the granularity thereof. Additionally or alternatively, a user may define (e.g., via a GUI) the data sources and/or software requests and/or other data acquisition mechanisms that support the respective data types that are depicted in a respective digital twin. In these embodiments, the user may indicate the data source that are to be accessed and the types of data to be obtained from the respective data source. For example, if a user is configuring an enterprise digital twin of a supply chain process, the user may identify an inventory management system to obtain inventory levels, various supplier systems to obtain pricing data of particular items, sensor systems to obtain sensor data from various points within the enterprise's supply chain (e.g., manufacturing facilities, warehouse facilities, and the like), and other suitable systems for other suitable data types. In this data definition process a user may associate specific data types and/or data sources to corresponding structural elements of a digital twin (e.g., layouts, spatial elements, processes, or components thereof). For example, the user can match a specific cost of a good (e.g., the cost of a bearing on a compressor, a headlight that goes into an automobile, an automobile, or any other suitable good) that is obtained via an API request to a seller of the good with a digital twin element representing the good (e.g., a 3D model of the good). In this example, the digital twin of the good may depict the cost of the good, and as the price of the good changes, so too may the depiction of the good.

In embodiments, the configuration system 8102 generates one or more foreign keys for each digital twin that collectively associate different data types with the structural elements of the digital twin. Thus, when a digital twin is generated, the foreign key may be leveraged to connect data obtained from the data sources to the structural elements of the digital twin. In some embodiments, a configuring user may define the associations that are used to generate the set of foreign keys.

In embodiments, the digital twin configuration system 8102 determines, defines, and manages the data structures needed to support each type of digital twin, such as data lakes, relational databases, SQL databases, NOSQL databases, graph databases, and the like. For example, for an environment digital twin, the digital twin configuration system 8102 may instantiate a database (e.g., a graph database that defines the ontology of the environment and the objects existing (or potentially existing) within the environment and the relationships therebetween), whereby the instantiated database contains and/or references the underlying data that powers the environmental digital twin (e.g., sensor data and analytics relating thereto, 3D maps, physical asset twins within the environment, and the like). In some embodiments, a user may define an ontology of a respective digital twin, such that the ontology defines the types of data depicted in the digital twin and the relationships between those data types. Additionally or alternatively, the digital twin configuration system 8102 may derive the ontology based on the types of digital twins that are to be configured.

In some embodiments, the different types of enterprise digital twins may be configured in accordance with a set of preference settings, granularity settings, alert settings, taxonomy settings, topology settings, and the like. In some embodiments, the configuration system 8102 may utilize pre-defined preferences (e.g., default preference templates for different types of enterprise digital twins, including ones that are domain-specific, role-specific, industry-specific, workflow-specific and the like), taxonomies (e.g., default taxonomies for different types of enterprise digital twins), and/or topologies (e.g., default topologies for different types of twins, such as graph-based topologies, tree-based topologies, serial topologies, flow-based topologies, loop-based topologies, network-based topologies, mesh topologies, and others)). Additionally or alternatively, the configuration system 8102 may receive custom preference settings and taxonomies from a configuring user. Non-limiting examples of role-specific templates that are used to configure a role-based digital twin may include may include CEO template, a COO template, a CFO template, a counsel template, a board member template, a CTO template, a chief marketing officer template, an information technology manager template, a chief information officer template, a chief data officer template, an investor template, a customer template, a vendor template, a supplier template, an engineering manager template, a project manager template, an operations manager template, a sales manager template, a salesperson template, a service manager template, a maintenance operator template, and/or a business development template. Similarly, examples of taxonomies that are used to configure different types of role-based digital twins may include CEO taxonomy, a COO taxonomy, a CFO taxonomy, a counsel taxonomy, a board member taxonomy, a CTO taxonomy, a chief marketing officer taxonomy, an information technology manager taxonomy, a chief information officer taxonomy, a chief data officer taxonomy, an investor taxonomy, a customer taxonomy, a vendor taxonomy, a supplier taxonomy, an engineering manager taxonomy, a project manager taxonomy, an operations manager taxonomy, a sales manager taxonomy, a salesperson taxonomy, a service manager taxonomy, a maintenance operator taxonomy, and/or a business development taxonomy. Each of the role-specific templates may include data types that are specific to the kinds of interactions the role might have and the specific responses to interactions, which may be role-based. For example, a CEO template may include data type definitions for supplier information and labor cost information across the entire organization, and may include responses to interactions with a CEO digital twin, such as drilling down to specific suppliers and/or labor groups within the enterprise.

In embodiments, the digital twin configuration system 8102 may be configured to configure and instantiate the databases that support each respective enterprise digital twin of an enterprise (e.g., role-based digital twins, environment digital twins, organizational digital twins, process digital twins, and the like), which may be stored on the digital twin data store 8124. In embodiments, for each database configuration, the digital twin configuration system 8102 may identify and connect any external resources needed to collect data for each respective data type. For each identified external resource, the digital twin configuration system 8102 may configure one or more data collection threads to access an API, SDK, port, webhook, search facility, database access facility, and/or other connection facility For example, certain executive digital twins (e.g., CEO digital twin, CFO digital twin, COO digital twin, and CMO digital twin) may each require data derived and/or obtained from the CRM 8026 of the enterprise. In this example, the digital twin configuration system 8102 may configure one or more data collection threads to access an API, SDK, port, webhook, search facility, database access facility, and/or other connection facility of the CRM 8026 of the enterprise on behalf of the enterprise and may obtain any necessary security credentials to access the API. In another example, in order to collect data from one or more edge devices 8042 of the enterprise, the configuration system 8102 may initiate a process of granting access to the edge devices 8042 of the enterprise to the APIs of the EMP 8000, such that the edge devices 8042 may provide digital twin data to the EMP 8000.

In embodiments, the digital twin I/O system 8104 is configured to obtain data from a set of data sources (e.g., users, sensor systems, internal and/or external databases, software platforms (e.g., CRMs, ERPs, CRMs, workflow management system), surveys, customers, and the like). In some embodiments, the digital twin I/O system 8104 (or other suitable component) may provide a graphical user interface that allows a user affiliated with an enterprise to upload various types of data that may be leveraged to generate the enterprise digital twins of the enterprise. For example, in providing data to support an environment digital twin, a user may upload 3D scans, still and video images, LIDAR scans, structured light scans, blueprints, 3D floor plans, object types (e.g., products, sensors, machinery, furniture, and the like), object properties (e.g., materials, physical properties, descriptions, price, and the like), output type (e.g., sensor units), architectural drawings, CAD documents, equipment specifications, and many others via the digital twin I/O system 8104. In embodiments, the digital twin I/O system 8104 may subscribe to or otherwise automatically receive data streams (e.g., publicly available data streams, such as RSS feeds, news streams, event streams, log streams, sensor system streams, and the like) on behalf of an enterprise. Additionally or alternatively, the digital twin system I/O system 8104 may periodically query and/or receive data from a connected data source 8020, such as the sensor system 8022 having sensors that sensor data from facilities (e.g., manufacturing facilities, shipping facilities, warehouse facilities, logistics facilities, retail facilities, distribution facilities, agricultural facilities, resource extraction facilities, computing facilities, transportation facilities, infrastructure facilities, networking facilities, data center facilities, and many others) and/or other physical entities of the enterprise, the sales database 8024 that is updated with sales figures in real time, the CRM system 8026, the content marketing platform 8028, financial databases 8030, surveys 8032, org charts 8034, workflow management systems 8036, third-party data sources 8038, customer databases 8040 that store customer data, and/or third-party data sources 8038 that store third-party data, edge devices 8042 that report data relating to physical assets (e.g., smart machinery/manufacturing equipment, sensor kits, autonomous vehicles, of the enterprise, wearable devices, and the like), enterprise resource management systems 8044, HR systems 8046, content management systems 8026, and the like). In embodiments, the digital twin I/O system 8104 may employ a set of web crawlers to obtain data. In embodiments, the digital twin I/O system 8104 may include listening threads that listen for new data from a respective data source. In embodiments, the digital twin I/O system 8104 may be configured with a set of webhooks that receive data from a respective set of data sources. In these embodiments, the digital twin I/O system 8104 may receive data that is pushed from an external data source, such as real-time data.

In some embodiments, the digital twin I/O system 8104 is configured to serve the obtained data to instances of enterprise digital twins (which is used to populate digital twins) that are executed by the client device 8050 or the EMP 8000. In embodiments, the digital twin I/O system 8104 receives data stream feeds received data streams received and/or collected on behalf on an enterprise and stores at least a portion of the streams into a data lake 8122 associated with the enterprise. In embodiments, the data that is streamed into the data lake 8122 may be structured and stored in one or more databases stored in the digital twin data stores 8124.

In embodiments, the data structuring system 8106 is configured to process and structure data into a format that can be consumed by an enterprise digital twin. In embodiments, processing by the data structuring system 8106 may include compression, computation, filtering, aggregation, multiplexing, selective switching, batching, packetization, streaming, summarization, fusion, fragmentation, encoding, decoding, transcoding, encryption, decryption, duplication, deduplication, normalization, cleansing, identification, copying, storage, decompression, syndication, augmentation (e.g., by metadata), content inspection, classification, extraction, transformation, loading, formatting, error correction, data structuring, and/or many other processing actions. In embodiments, the data structuring system 8106 may leverage ETL (extract, transform, load) tools, data streaming, and other data integration tooling to structure the various types of digital twin data. In embodiments, the data structuring system 8106 structures the data according to a digital twin data model that may be defined by the digital twin configuration system 8102 and/or a user. In embodiments, a digital twin data model may refer to an abstract model that organizes elements of enterprise-related data and standardizes the manner by which those elements relate to one another and to the properties of digital twin entities. For instance, a digital twin data model of an environment that includes vehicles (e.g., a vehicle assembly facility or an environment where vehicles operate) may specify that the data element representing a vehicle be composed of a number of other elements which represent sub-elements or attributes of the vehicle (the color of the vehicle, the dimensions of the vehicle, the engine of the vehicle, the engine parts of the vehicle, the owner of the vehicle, the performance specifications of the vehicle, and the like). In this example, the digital twin model components may define how the physical attributes are tied to respective physical locations on the vehicle. In embodiments, digital twin data models may define a formalization of the objects and relationships found in a particular application domain. For example, a digital twin data model may represent the customers, products, and orders found in a manufacturing enterprise and how they relate to each other within the various digital twins. In another example, a digital twin data model may define a set of concepts (e.g., entities, attributes, relations, tables, and/or the like) used in defining such formalizations of data or metadata within the environment. For example, a digital twin data model used in connection with a banking application may be defined using the entity-relationship data model and how the entity-relationship data model is then related to the various executive digital twin views.

In embodiments, the digital twin generation system 8108 serves enterprise digital twins on behalf of an enterprise. In some instances, the digital twin generation system 8108 receives a request for a specific type of digital twin from a client application 8052 being executed by the client device 8050 (e.g., via an API). Additionally or alternatively, the digital twin generation system 8108 receives a request for a specific type of digital twin from a component of EMP 8000 (e.g., the digital twin simulation system 8116). The request may indicate the enterprise, the type of digital twin, the user (whose access rights may be verified or determined by the digital access controller 8112), and/or a role of the user. In some embodiments, the digital twin generation system 8108 may determine and provide the client device 8050 (or requesting component) with the data structures, definition of grain of data the, response patterns to specific inputs, animation sequences for illustrating behaviors, display aggregation methods for smaller displays (such as mobile phone), immersive data interaction systems, security constraints on the data viewing, viewing interaction speed (frame rate), nature of light sources (simulate actual or continuous), multiple user engagement protocols, network bandwidth constraints, metadata, ontology and information on hooks to data feeds as well as the digital twin constructs. This information may be used by the client to generate the digital twin in the end user device (e.g., an immersive device, such as AR devices or VR devices, tablet, personal computer, mobile, or the like). In embodiments, the digital twin generation system 8108 may determine the appropriate perspective for the requested digital twin (e.g., via the digital twin perspective builder 8110, which may include device-sensitive perspectives, such as delivering in appropriate formats based on the type of end user device) and any data restrictions, interaction restrictions, depth of data restrictions, usage restrictions, length of visibility restrictions, that the user may have (e.g., via the access controller 8112). In response to determining the perspective and data restrictions, the digital twin generation system 8108 may generate the requested digital twin. In some embodiments, generating the requested digital twin may include identifying the appropriate data structure given the perspective and obtaining the data that parameterizes the digital twin, as well as any additional metadata that is served with the enterprise digital twin.

In embodiments, the digital twin generation system 8108 may deliver the enterprise digital twin to the requesting client application 8052 (or requesting component). In embodiments, the digital twin generation system 8108 (or another suitable component) may continue to update a served digital twin with real-time data (or data that is derived from real-time data) as the real-time data is received and potentially analyzed, extrapolated, derived, predicted, and/or simulated by the EMP 8000.

In some embodiments, the digital twin generation system 8108 (in combination with the digital twin I/O system 8104) may obtain data streams from traditional data sources, such as relational databases, API interfaces, direct sensor input, human generated input, Hadoop file stores, graph databases that underlie operational and reporting tooling in the environment, telemetry data sources, onboard diagnostic systems, blockchains, distributed ledgers, distributed data sources, feed, streams, and many other sources. In embodiments, the digital twin generation system 8108 may obtain data streams that are associated with the structural aspects of the data, such as the layout and 3D object properties of entities within facilities, geospatial information systems, the hierarchical design of a system of accounts, and/or the logical relationships of entities and actions in a workflow. In embodiments, the data streams may include metadata streams that are associated with the nature of the data and data streams containing primary data (e.g., sensor data, sales data, survey data, and the like). For example, the metadata associated with a physical facility or other entity may include the types and layers of data that are being managed, while the primary data may include the instances of objects that fall within each layer. Layers for which metadata may be tracked and/or created may include, for example, metadata with respect to attributes, parameters or representations of a whole facility, component systems and assets within the facility (equipment, network entities, workforce entities, assets, and the like), sub-components and sub-systems, and further sub-components and sub-systems down to arbitrarily lower levels of granularity (e.g., a ball bearing of a rotating axle assembly of a fan that is part of a motor assembly driving an assembly line in a location of a warehouse). In embodiments, layers may include, in another example, logical or operational layers, such as a reporting structure, such as from a COO to a VP of operations to a distribution manager to a warehouse manager to a shift manager to a warehouse worker. In embodiments, layers may include workflow or process flow layers, such as from an overall process to its sub-components and decision points, such as an overall assembly process having sublayers of gathering of input materials and components, positioning of workers, a series of assembly steps, inspection of outputs, and delivery to a post-assembly location.

In embodiments, the digital twin perspective builder 8110 leverages metadata, artificial intelligence, heuristic methods, 3D rendering algorithms and/or other data processing techniques to produce a definition of information required for generation of the digital twin in the digital twin generation system 8108. In some embodiments, different relevant datasets are hooked to a digital twin (e.g., an executive digital twin, an environment digital twin, or the like) at the appropriate level of granularity, thereby allowing for the structural aspects of the data (e.g., system of accounts, sensor readings, sales data, or the like) to be a part of the data analytics process. One aspect of making a perspective function is that the user can change the structural view or the granularity of data while potentially forecasting future events or changes to the structure to guide control of the area of the business at question. In embodiments, the term “grain of data” may refer to the base unit of a type of data, such as a single line of data, a single aggregated line of data, a single byte of data, a single file, a single instance, or the like. Examples of “grains of data” may include a detailed record on a single sale, a single block in a blockchain in a distributed ledger, a single event in an event log, a single vibration reading from a vibration sensor, or similar singular or atomic data units, and the like. Grain or atomicity may impose a constraint in how the data can be combined or processed to form different outputs. For example if some element of data is captured only at the level of once-per-day, then it can only be broken down to single days (or aggregation of days) and cannot be broken down to hours or minutes, unless derived from the day representation (e.g., using inference techniques and/or statistical models). Similarly, if data is provided only at the aggregate business unit level, it can be broken down to the level of an individual employee only by, for example, averaging, modeling, or inductive functions. Generally, role-based and other enterprise digital twins may often benefit from finer levels of data, as aggregations and other processing steps may produce outputs that are dynamic in nature and/or that relate to dynamic processes and/or real-time decision-making. It is noted that different types of digital twins may have different “sized” grains of data. For example, the grains of data that feed a CEO digital twin may be at a higher granularity level than the grains of data that feed a COO digital twin. In some embodiments, however, a CEO may drill down into a state of the CEO digital twin and the granularity for the selected state may be increased.

In embodiments, the perspective builder 8110 adds relevant perspective to the data underlying the digital twin, which is provided to the digital twin generation system 8108. In embodiments, “perspective” may refer to the adjustments to, aggregations of, simplifications of, and/or detail additions to the ontology of a particular digital twin (e.g., a role-based digital twin) that provide the appropriate ontological view of the underlying data with the correct types at the appropriate granularity level. For example, a CEO digital twin may link in fuzzy data with markets data and depict the potential impacts of market forces on a simulated digital twin environment for different scenarios. In another example, in a CFO level digital twin, the internal financial system of accounts may be allocated across the physical structure of the digital twin providing an ability to understand the relationship between revenue generation, cost allocation, and the structural aspects of the business (e.g., the layout of a factory floor, a warehouse, a distribution center, a logistics facility, an office building, a retail location, a container ship, or the like). Continuing this example, the CTO digital twin may include data overlays with current market information on new technologies and linkages therebetween. In this example, the CTO digital twin builds in linkages between an impact of changing technology platforms and outside information that may be used for enhancement of the facility. These different perspectives generated by the perspective builder 8110 combine with the digital twin simulation system 8116 to provide relevant simulations of how scenario-based future states might be handled by the facility, the digital twin simulation system 8116 provides for, recommendations on how to enhance the digitally twin represented facility structurally to meet the needs of the future states, responses to specific changes in the digital twin environment or alterations in the information relating to digital twin simulate elements. In embodiments, the perspective builder 8110 may build perspectives that depict intersections or overlays of operational states and entities with information technology states and entities, which may facilitate recognition of opportunities and/or problems involving the interplay and convergence of information technology and operations technology within the operations of a wide range of industries and domains. In further embodiments, the perspective builder 8110 may build perspectives that allow for different roles to interact with the same digital twin while maintaining different perspectives on the operational states and entities, which allows for these different roles to have a meaningful interaction while maintaining their role-specific perspective. In embodiments, the perspective builder 8110 builds a perspective for a digital twin by providing each different user/role with a respective diagrammatic view expressed as in the digital twin where that diagram includes information and structure at a level relevant to the specific user's role. This user-specific diagram is then connected to the underlying data to provide for the role-based digital twin experience.

In embodiments, the digital twin access controller 8112 informs the generation system 8108 of specific constraints around the roles of users able to view the digital twin as well as providing for dynamically adjustable digital twins that can adapt to constrain or release views of the data or other features specific to each user role. For example sensitive salary data might be obfuscated from most administrative employees when viewing an organizational digital twin, but the CEO may be granted access to view the salary information directly. In embodiments, the digital twin access controller 8112 may receive a user identifier and one or more data types. In response, the digital twin access controller 8112 may determine whether the user indicated by the user identifier has access to the one more data types or other features. In some of these embodiments, the digital twin access controller may look up the user in the organizational digital twin of the enterprise of the user and may determine the user's permissions and restrictions based thereon. Alternatively, the user's permissions and restrictions may be indicated in a user database. In embodiments, the organizational digital twin may, as noted above, be generated automatically, such as by parsing available data sources to automatically construct a representation of the organization, such as a hierarchical organizational chart, a graph of the organization with nodes representing organizational entities (e.g., workgroups, roles, assets and personnel), links or connections indicating relationships (e.g., reporting relationships, lines of authority, group affiliations, and the like), and data or metadata indicating other attributes of the entities and relationship, and the like.

In embodiments, the digital twin interaction manager 8114 manages the relationship between the structural view of the data in an enterprise digital twin (e.g., as depicted/represented by the client application 8052) and the underlying data streams and data sources. In embodiments, this interaction layer makes the digital twin into a window into the underlying data streams through the lens of the structure of the data. In embodiments, the digital twin interaction manager 8114 determines the types of data, or the nature of the human interface for building these interactions, that are being fed to an instance of an enterprise digital twin (e.g., an environment digital twin or an executive digital twin) while the instance is being executed by a client application 8052. Put another way, the digital twin interaction manager 8114 determines and serves data for an in-use digital twin. In embodiments, the digital twin interaction manager 8114 has specific user interactions and controls that govern the relationship between a user interface and the role based digital twin. Furthermore, in embodiments, these role-based digital twin interactions can be with a shared digital twin with different roles interacting seamlessly. In embodiments, the digital twin interaction manager 8114 feeds raw data received from a data source to the digital twin or from the digital twin I/O system 8104, or a combination of the digital twin I/O system 8104 and role-based human interactions For example, sensor readings of temperatures throughout an environment may be fed directly to the executing environment digital twin of the environment through the digital twin I/O system 8104 and in response to a human interaction with the environment digital twin to adjust a temperature setting of the environment, the digital twin interaction manager 8114 may issue a control signal to a temperature controller within the environment to increase or decrease the temperature.

In embodiments, the digital twin interaction manager 8114 obtains data and/or instructions that are derived by another component of the EMP 8000. For example, a CEO digital twin may depict analytical data obtained from the artificial intelligence services system 8010 that is derived from incoming financial data, marketing data, operational data, and sensor data. In this example, the digital twin interaction manager 8114 may receive a request to drill down into the analytical data from the user and in response, the digital twin interaction manager 8114 may obtain the financial data, marketing data, and/or the sensor data from which the analytical data was derived. In another example, the digital twin interaction manager 8114 may receive simulated cost data from the digital twin simulation system 8116 to convey revenue/costs with respect to different asset maintenance schedules, whereby the simulated data is derived using historical maintenance data of the enterprise, historical sensor data collected by sensors in a facility of the enterprise. In this example, the digital twin interaction manager 8114 may receive requests for different maintenance schedules from a client device depicting an executive digital twin (e.g., a CFO digital twin, a CTO digital twin, or a CEO digital twin) and may initiate the simulations for each of the different maintenance schedules. The digital twin interaction manager 8114 may then serve the results of the simulation to the requesting client application.

In embodiments, the digital twin interaction manager 8114 may manage one or more workflows that are performed via an executive digital twin. For example, the EMP 8000 may store a set of executive workflows, where each executive workflow corresponds to a role within an enterprise and includes one or more stages. In embodiments, the digital twin interaction manager 8114 may receive a request to execute a workflow. The request may indicate the workflow and a user identifier. In response, the digital twin interaction manager 8114 may retrieve the requested workflow and may provide specific instructions, including role-based interactions, and/or data to the client device 8052

In embodiments, the digital twin simulation system 8116 receives requests to run simulations using one or more digital twins. In embodiments, the request may indicate a set of parameters that are to be varied and/or one or more simulation outcomes to output. In embodiments, the digital twin simulation system 8116 may request one or more digital twins from the digital twin generation system 8108 and may varying a set of different parameters for the simulation. In embodiments, the digital twin simulation system 8116 may construct new digital twins and new data streams within existing digital twins. In embodiments, the digital twin simulation system 8116 may perform environment simulations and/or data simulations. The environment simulation is focused on simulation of the digital twin ontology rather than the underlying data streams. In embodiments, the digital twin simulation system 8116 generates simulated data streams appropriate for respective digital twin environments. This simulation allows for real world simulations of how a digital twin will respond to specific events such as changes in the cost of good supplied, or changes in the demand on the output of the facility.

In embodiments, the digital twin simulation system 8116 implements a set of models, in some instances including role-specific response patterns, (e.g., physical mathematical forecasts, logical representations, or process diagrams) that develop the framework where data and the response of the digital twin can be simulated in response to different situational or contextual inputs/stimuli. In embodiments, the digital twin simulation system 8116 may include or leverage a computerized model builder that constructs a predicted future state of either the data and/or the response of the digital twin to the input data. In some embodiments, the computerized model library may be obtained from a behavior model data store 8126 that stores one or more models that defines one or more behaviors of entities, such as based on scientific, economic, statistical, psychological, sociological, econometric, engineering, mathematical, physical, chemical, biological, architectural, computational, or other models, formulas, functions, processes, algorithms, or the like of the various types described herein or in the documents incorporated by reference herein (collectively referred to herein as “behavior models” or “models” except where context indicates otherwise). In embodiments, value chain network data objects may be provided according to an object-oriented data model that defines classes, objects, attributes, parameters and other features of the set of data objects (such as associated with value chain network entities and applications) that are handled by the platform. The computerized digital twin model calculates the results of the model based on available inputs to build an interactive environment where users can watch and manipulate salient features of the simulated environment seeing how the entire system responds to specific changes in the environment. For example, the digital twin simulation may display how a set of objects that are stacked in a container will respond to tilting the container, where the behavior of the objects is based on a mechanical engineering model and/or an architectural model of the stacked objects, including structural features, weight distributions, and the like. This may assist in assessing the probability and/or impact of various fault modes, such as breaking, spilling, or the like, in response to seismic events, road conditions, weather conditions, wave action, or the like, as well as in simulating the response of other objects in the simulated environment, including in a chain of events. This may, for example, allow a user to identify events and consequences that occur as a result of multiple simultaneous or related faults or other events.

In embodiments, digital twin behavior models may be updated and improved using results of actual experiments and real-world events. The use of such digital twin mathematical models and their simulations avoids actual experimentation, which can be costly and time-consuming. Instead, acquired knowledge about behavior of entities and computational power are used to diagnose and solve real-world problems cheaply and/or in a time-efficient manner. As such, the digital twin simulation system 8116 can facilitate understanding a system's behavior without actually testing the system in the real world. For example, to determine which type of wheel configuration would improve traction the most while designing a tractor, a digital twin model simulation of the tractor could be used to estimate the effect of different wheel configurations on towing capacity. Useful insights about different decisions in the design may be gleaned without actually building the tractor. In addition, the digital twin simulation can support experimentation that occurs totally in software, or in human-in-the-loop environments where the digital twin represents systems or generates data needed to meet experiment objectives. Furthermore, digital twin simulations can be used to train persons using a perspective-appropriate virtual environment that would otherwise be difficult or expensive to produce.

In embodiments, simulation environments may be constructed using models configured to predict a set of future states. These models may include deep learning, regression models, quantum prediction engines, inference engines, pattern recognition engines, and many other forms of modelling engines that use historical outcomes, current state information, and other inputs to build a future state prediction. In some embodiments, a consideration in making the digital twin models' function is the ability to also show the response of the perspective-based digital twin structural elements (e.g., defining the deformation of the axle of a vehicle in response to different size loads). For example, the resultant digital twin representation can then be presented to the user in a virtual reality or augmented reality environment where specific perspectives are shown in their digital twin form.

In embodiments, digital twins, as described herein, may operate in coordination with an adaptive edge computing system and/or a set of adaptive edge computing systems that provide coordinated edge computation include a wide range of systems, such as classification systems (such as image classification systems, object type recognition systems, and others), video processing systems (such as video compression systems), signal processing systems (such as analog-to-digital transformation systems, digital-to-analog transformation systems, RF filtering systems, analog signal processing systems, multiplexing systems, statistical signal processing systems, signal filtering systems, natural language processing systems, sound processing systems, ultrasound processing systems, and many others), data processing systems (such as data filtering systems, data integration systems, data extraction systems, data loading systems, data transformation systems, point cloud processing systems, data normalization systems, data cleansing system, data deduplication systems, graph-based data storage systems, object-oriented data storage systems, and others), predictive systems (such as motion prediction systems, output prediction systems, activity prediction systems, fault prediction systems, failure prediction systems, accident prediction systems, event predictions systems, event prediction systems, and many others), configuration systems (such as protocol selection systems, storage configuration systems, peer-to-peer network configuration systems, power management systems, self—configuration systems, self-healing systems, handshake negotiation systems, and others), artificial intelligence systems (such as clustering systems, variation systems, machine learning systems, expert systems, rule-based systems, deep learning systems, and many others), system management and control systems (such as autonomous control systems, robotic control systems, RF spectrum management systems, network resource management systems, storage management systems, data management systems, and others), robotic process automation systems, analytic and modeling systems (such as data visualization systems, clustering systems, similarity analysis systems, random forest systems, physical modeling systems, interaction modeling systems, simulation systems, and many others), entity discovery systems, security systems (such as cybersecurity systems, biometric systems, intrusion detection systems, firewall systems, and others), rules engine systems, workflow automation systems, opportunity discovery systems, testing and diagnostic systems, software image propagation systems, virtualization systems, digital twin systems, IoT monitoring systems, routing systems, switching systems, indoor location systems, geolocation systems, and others.

In embodiments, the digital twin notification system 8118 provides notifications to users via enterprise digital twins associated with the respective users. In some embodiments, digital twin notifications are an important part of the overall interaction. Digital twin notification system 8118 may provide the digital twin notifications within the context of the digital twin setting so that the perspective view of the notification is set up specifically to enable enlightenment of how the notification fits into the general digital twin represented ontology, taxonomy, topology or the like.

As discussed, a digital twin model is based on a combination of data and the data's relationship to the digital twin environments and/or processes. As such, different digital twins may share the same data and different digital twin perspectives can be the results of a set of metadata built on top of a digital twin data model or data environment. In embodiments, the digital twin data model provides the details of the information to be stored and it is used to build a layered system where the final computer software code is able to represent the information in the lower levels in a form that is appropriate for the digital twin perspective being used. One aspect of the digital twin model is that one digital can be shared across multiple perspectives, each perspective viewer can then interact with the same underlying digital twin model. In this way the multiple perspectives are like translations allowing each type of user to interact in an appropriate way for their skill sets or their level of knowledge.

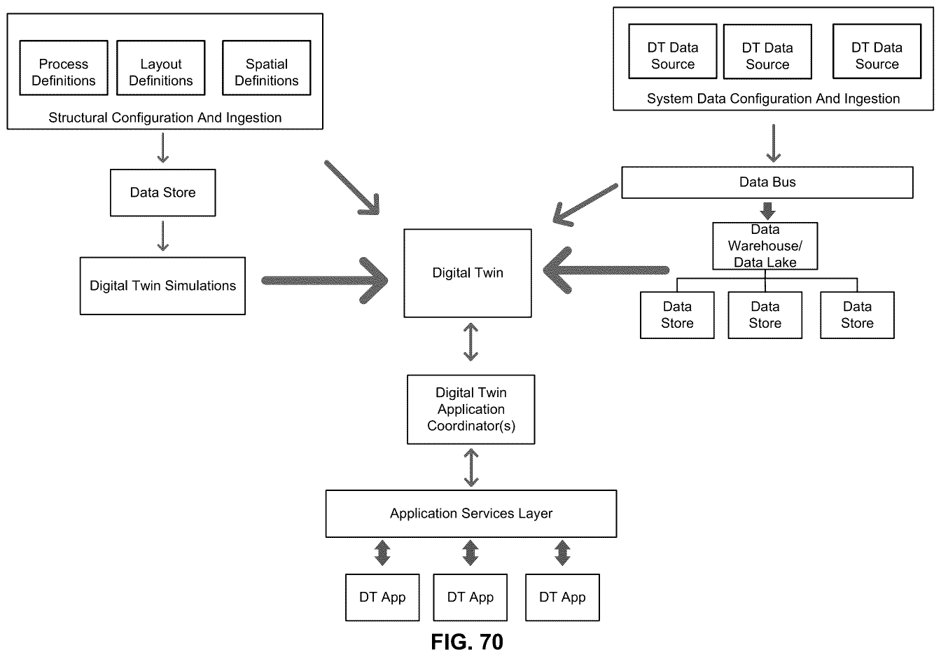

FIG. 70 illustrates an example of a digital twin data model and the manner by which a digital twin is generated, executed, and served to a requesting digital twin application, wherein the digital twin data model defines the physical implementation of the underlying data streams from existing systems and digital twin structures to achieve a digital twin representation. In embodiments, the digital twin data model 81B00 defines the manner by which traditional data streams are tied together with the digital twin structures to achieve the digital twin representation. In embodiments, digital twins are a combination of processes/structures and system data streams. Put another way, process and structure definitions define the real-world “things” (for example a factory, a robot, a cargo container, a ship, a road, or the like) or logical “things” (for example an organizational chart, a hiring process, a marketing campaign, a tax reporting workflow, or the like) that are representable by a digital twin, while the system data stream definitions define the manner by which real-world data may be ingested into digital twin representations of the real-world and/or logical “things”. Thus, configuring a digital twin includes structural configuration and ingestion and data configuration and ingestion.

During structural configuration and ingestion, the digital twin system 8004 receives the structural aspects of a digital twin. In embodiments, the structural aspects may include process definitions, layout definitions, and/or spatial definitions. In embodiments, a process definition defines a logical process that can be mapped to a diagrammatic format that forms the basis of what a digital twin viewer can interact with. Examples of processes may include workflows, hiring processes, manufacturing processes, logistics processes, inventory processes, product management processes, software processes, and the like. In embodiments, the spatial definition defines the geospatial configuration of an object or an environment. In embodiments, the spatial definition may be a 2D or 3D representation of an object or an environment. The spatial definition of an object or an environment may be provided as a CAD file, a LIDAR scan, a 2D or 3D image, or the like, including logical relationships, organizational hierarchy, physical relationships, schematic relationships, and/or interconnectivity between objects and/or environments. In embodiments, a layout definition defines the relationship between objects with other objects and/or an environment. In embodiments, the layout definition may further define the manner by which objects move with respect to other objects and/or an environment. Examples of layouts may include electrical wiring diagrams, piping schematics, assembly line diagrams, circuit diagrams, hierarchical relationships, network layouts, network schematics, organizational charts, and the like. In embodiments, a layout definition may include a set of properties of an object or environment. Examples of properties of an object may include physical properties, such as a material of an object, a weight of an object, a density of an object, a conductivity of an object, a resistance of an object, a maximum speed of an object, a maximum acceleration of an object, possible movements of an object, a reactivity of an object, and/or the like. Examples of properties of an environment may include materials of the floors, walls, the roof, and the like, coefficient of friction of the floor, restricted areas within the environment, paths within the environment, and/or other suitable properties. In some embodiments, users may upload layout definitions, process definitions, and/or spatial definitions to the digital twin system 8004. Additionally or alternatively, the digital twin system 8004 may provide a graphical user interface that allows users to define the layout definitions, process definitions, and/or spatial definitions. In some embodiments, users may import digital twins from 3rd party sources. For example, a producer of a particular object may also provide a digital twin of the object, which may then be imported to the digital twin system 8004.

During system data configuration and ingestion, a user defines the data sources that provide data that hydrates or populates a digital twin and configures a data bus to receive data from the various data sources. As discussed, the data sources may be received from various systems, including sensor systems, ERPs, CRMs, financial systems, inventory management systems, invoicing systems, 3rd party systems (e.g., weather services, news services, government databases, and the like), and other suitable systems. In embodiments, the user may identify the data sources and may provide any information required to enable a data bus to receive data from the data sources and may further define the associations between the data derived from the data sources and the digital twin elements. A data bus may refer to a middleware layer that provides the data wiring and data infrastructure for moving data from one system to another. The data bus may be configured to handle real-time data, near real-time data, aggregated data, and/or stored data, or any combination thereof. The data bus may provide data directly to a digital twin and/or may store the data in the data warehouse that hydrates the digital twins. In embodiments, the user may provide API interface or keys and/or webhook URLs to the digital twin system 8004 (e.g., via a GUI) thereby enabling data acquisition from the data sources. In embodiments, the digital twin system 8004 may configure the data bus to access the data sources and/or to receive data from the data sources. In some of these embodiments, the digital twin system 8004 may generate a webhook URL for a particular digital twin or set of digital twins and may provide the webhook URL to the data source, such that the data source can push real-time or near real-time data to the data bus. Additionally or alternatively, the digital twin system 8004 may obtain an API interface or key from the data source, such that the data bus can request data from the data source using the API interface or key.

In embodiments, the digital twin system 8004 may generate a foreign key that associates different types of data with the structural elements of the digital twin. In this way, the foreign key ties particular data types to various structural or logical or schematic elements, such that when the digital twin is depicted, the real-world data collected from the various data sources is connected to the corresponding states of the digital twin. For example, sensor data received from a subset of sensors of a sensor system that monitor a particular machine component in a real world environment may be associated with a digital twin of a machine component, such that the sensor data may be depicted in the digital twin of the machine component. In embodiments, the user may provide input to the digital twin system 8004 during the configuration phase to tie particular data types to various elements of a digital twin. The data types that are associated with the digital twin may include raw data, processed data, analytical data, derived data, and the like. To the extent a particular data stream is processed before being served into a digital twin (e.g., sensor data that is averaged over a period of time or a warning condition that is depicted when sales data dips below a threshold), the user may define the operations or the associated display highlight that are performed on the data before it is served into a digital twin. In these scenarios, the processed data may be associated with a respective digital twin component in the foreign key.

Once the data bus is configured for a particular digital twin and the structural, logical, or schematic elements (e.g., layout definitions, process definitions, and spatial definitions) of the digital twin are defined, the digital twin system 8004 may perform digital simulations on the digital twin and/or may serve the digital twin to a digital twin-enabled application based on the structural elements of the digital twin, the connected systems data sources, and the foreign key of the digital twin. In embodiments, the digital twins may be role-based digital twin, whereby the views into the digital twin that are served to a user occupying a particular role within an organization. In this way, each user can interact with a respective role-based digital twin and may gain appropriate perspectives based on their respective needs with respect to an organization. In another embodiment, a plurality of users can interact with a shared role-enabled digital twin and may gain appropriate perspectives based on their respective needs with respect to an organization to that single digital twin. In embodiments, a role-based digital twin may allow the user to provide feedback to the source systems to allow for controls of the source system environments, such as corrective actions taken with respect to a source system. In some embodiments, a plurality of users can make operational changes with a shared role-based digital twin and each user sees these changes in an appropriate way for their role. Furthermore if the operational change involves multiple users, the digital twin can enable a role-based workflow management of the depicted environment (e.g., the CEO may approve an expenditure to change machinery as requested by the CTO).

In embodiments, the digital twin system 8004 may receive requests to execute digital twin simulations with respect to a digital twin. Requests to perform digital twin simulations may be received from digital twin applications and/or from internal processes. In embodiments, a digital twin simulation allows for the building of interactive models based on the processes, layouts, and/or spatial representations of a digital twin. The digital twin simulations may provide the degrees of freedom to allow for the different processes to be altered in response to dynamic data inputs. For example, a digital twin simulation may be executed to depict how a bearing can move on a compressor when the compressor is operated at different operating conditions or how water flows through a systems of pipes model at different temperatures or with different amounts of buildup in the piping. In embodiments, the digital twin system 8004 may output the results of the simulation, which may, for example, depict the impact of the simulation parameters on a particular aspect of the digital twin.

In embodiments, a digital twin application may request and depict a digital twin to a user, this digital twin can be a new twin for that user or role specific access with role specific views to an existing or shared digital twin. A digital twin application may be provided on mobile applications, virtual reality applications, PCs, and the like. In embodiments, a digital twin application provides a request to the digital twin system 8004 for a particular digital twin, where the request may include a user identifier of the user and/or a role of the user. In embodiments, the digital twin system 8004 may include or interface with digital twin application coordinators that receive requests from digital twin applications for a digital twin. In embodiments, a digital twin application controller maintains and leverages a set of business rules for a particular digital twin that are required by a digital twin application. In some of these embodiments, the set of role-based rules are a set of role-based rules that control the states that a user can access given their role within an organization and a clearance of the user. In these embodiments, the digital twin application controller may determine whether to grant an instance of a digital twin application access to a particular user based on the business rules and the role of the user. In embodiments, the digital twin system 8004 may include an application services layer that allows multiple users to connect to the back end of the digital twin application coordinator, either directly or through a shared digital twin. In embodiments, these connections may include web services, publish and subscribe information buses, simple object access protocols, and/or other suitable application interfaces. The application services layer may return a requested digital twin to a requesting instance of a digital twin application, which in turn depicts the digital twin to the user. The user may then interact with the digital twin via the application to view different states of the digital twin, to request simulations, or to interact with other users of the same role or different roles in the digital twin environment, and the like.

In an example implementation of the framework discussed in FIG. 70, the digital twin system 8004 may be configured to generate enterprise digital twins in connection with a value chain. For example, an enterprise that produces goods internationally (or at multiple facilities) may configure a set of digital twins, such as supplier twins that depict the enterprise's supply chain, factory twins of the various production facilities, product twins that represent the products made by the enterprise, distribution twins that represent the enterprise's distribution chains, and other suitable twins. In doing so, the enterprise may define the structural elements of each respective digital twin as well as any system data that corresponds to the structural elements of the digital twin. For instance, in generating a production facility twin, the enterprise may the layout and spatial definitions of the facility and any processes that are performed in the facility. The enterprise may also define data sources corresponding to value chain entities, such as sensor systems, smart manufacturing equipment, inventory systems, logistics systems, and the like that provide data relevant to the facility. The enterprise may associate the data sources with elements of the production facility and/or the processes occurring the facility. Similarly, the enterprise may define the structural, process, and layout definitions of its supply chain and its distribution chain and may connect relevant data sources, such as supplier databases, logistics platforms, to generate respective distribution chain and supply chain twins. The enterprise may further associate these digital twins to have a view of its value chain. In embodiments, the digital twin system 8004 may perform simulations of the enterprise's value chain that incorporate real-time data obtained from the various value chain entities of the enterprise. In some of these embodiments, the digital twin system 8004 may recommend decisions to a user interacting with the enterprise digital twins, such as when to order certain parts for manufacturing a certain product given a predicted demand for the manufactured product, when to schedule maintenance on machinery and/or replace machinery (e.g., when digital simulations on the digital twin indicates the demand for certain products may be the lowest or when it would have the least effect on the enterprise's profits and losses statement), what time of day to ship items, or the like. The foregoing example is a non-limiting example of the manner by which a digital twin may ingest system data and perform simulations in order to further one or more goals.

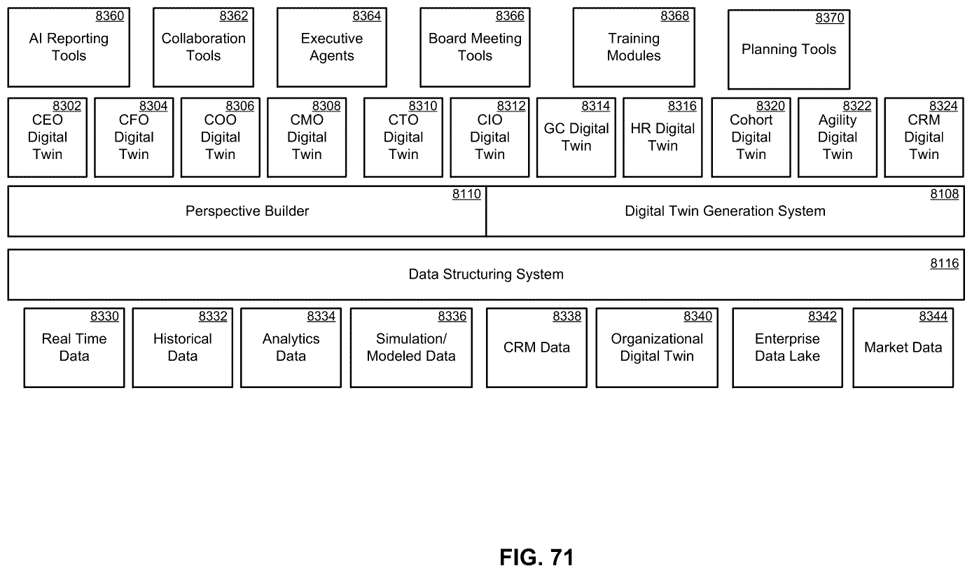

FIG. 71 illustrates examples of different types of enterprise digital twins, including executive digital twins, in relation to the data layer, processing layer, and application layer of the enterprise digital twin framework. In embodiments, executive digital twins may include, but are not limited to, CEO digital twins 8302, CFO digital twins 8304, COO digital twins 8306, CMO digital twins 8308, CTO digital twins 8310, CIO digital twins 8312, GC digital twins 8314, HR digital twins 8316, and the like. Additionally, the enterprise digital twins that may be relevant to the executive suite may include cohort digital twins 8320, agility digital twins 8322, CRM digital twins 8324, and the like. The discussion of the different types of digital twins is provided for example and not intended to limit the scope of the disclosure. It is understood that in some embodiments, users may alter the configuration of the various executive digital twins based on the business needs of the enterprise, the reporting structure of the enterprise, and the roles and responsibilities of the various executives within the enterprise.

In embodiments, executive digital twins and the additional enterprise digital twins are generated using various types of data collected from different data sources. As discussed, the data may include real-time data 8330, historical data 8332, analytics data 8334, simulation/modeled data 8336, CRM data 8338, organizational data, such as org charts and/or an organizational digital twin 8340, an enterprise data lake 8342, and market data 8344. In embodiments, the real-time data 8330 may include sensor data collected from one or more IoT sensor systems, which may be collected directly from each sensor and/or by various data collection devices associated with the enterprise, including readers (e.g., RFID, NFC, and Bluetooth readers), beacons, gateways, repeaters, mesh network nodes, WIFI systems, access points, routers, switches, gateways, local area network nodes, edge devices, and the like. Real-time data 8330 may include additional or alternative types of data that are collected in real-time, such as real-time sales data, real-time cost data, project management data that indicates the status of current projects, and the like. Historical data may be any data collected by the enterprise and/or on behalf of the enterprise in the past. This may include sensor data collected from the sensor systems of the enterprise, sales data, cost data, maintenance data, purchase data, employee hiring data, employee on-boarding data, employee retention data, legal-related data indicating legal proceedings, patent filing data indicating patent filings and issued patents, project management data indicating historical progress of past and current projects, product data indicating products that are on the market, and the like. Analytics data 8334 may be data derived by performing one or more analytics processes on data collected by and/or on behalf of the enterprise. Simulation/modeled data 8336 may be any data derived from simulation and/or behavior modeling processes that are performed with respect to one or more digital twins. CRM data 8336 may include data obtained from a CRM of the enterprise. An organizational digital twin 8340 may be a digital twin of the enterprise. The enterprise data lake 8342 may be a data lake that includes data collected from any number of sources. In embodiments, the market data 8342 may include data that is collected from disparate data sources concerning or related to competitors and other cohorts in the marketplace and supply chain. Market data 8342 may be collected from many different sources and may be structured or unstructured. In embodiments, market data 8342 may contain an element of uncertainty that may be depicted in a digital twin that relies on such market data 8342, such as by showing error bars, probability cones, random walk paths, or the like. It is appreciated that the different types of data highlighted above may overlap. For example: historical data may be obtained from the CRM data; the enterprise data lake 8342 may include real-time data 8330, historical data 8332, analytics data 8332, simulated/modeled data 8336, and/or CRM data 8336; and analytics data 8334 may be based on historical data 8332, real-time data 8332, CRM data 8336, and/or market data 8342. Additional or alternative types of data may be used to populate an enterprise digital twin.

In embodiments, the data structuring system 8106 may structure the various data collected by and/or on behalf of the enterprise. In embodiments, the digital twin generation system 8108 generates the enterprise digital twins. As discussed, the digital twin generation system 8108 may receive a request for a particular type of digital twin (e.g., a CEO digital twin 8302 or a CTO digital twin 8310) and may determine the types of data needed to populate the digital twin based on the configuration of the requested type of digital twin. In embodiments, the digital twin generation system 8108 may then generate the requested digital twin based on the various types of data (which may include structured data structured by the data structuring system 8106). In some embodiments, the digital twin generation system 8108 may output the generated digital twin to a client application 8052, which may then display the requested digital twins.

In embodiments, a CEO digital twin 8302 is a digital twin configured for the CEO or analogous top-level decision maker of an enterprise. The CEO digital twin 8302 may include high-level views of different states and/or operations data of the enterprise, including real-time and historical representations of major assets, processes, divisions, performance metrics, the condition of different business units of the enterprise, and any other mission-critical information type. In embodiments, the CEO digital twin 8302 may work in connection with the EMP 8000 to provide simulations, predictions, statistical summaries, decision-support based on analytics, machine learning, and/or other AI and learning-type processing of inputs (e.g., fiscal data, competitor data, product data, and the like). In embodiments, a CEO digital twin 8302 may provide functionality including, but not limited to, management of personnel, delegation of tasks, decisions, or tasks, coordination with the Board of Directors and/or strategic partners, risk management, policy management, oversight of budgets, resource allocation, investments, and other executive-related resources.

In embodiments, the types of data that may be populate a CEO digital twin 8302 may include, but are not limited to: macroeconomic data, microeconomic analytic data, forecast data, demand planning data, employment and salary data, analytic results of AI and/or machine learning modeling (e.g., financial forecasting), prediction data, recommendation data, securities-relevant financial data (e.g., earnings, profitability), industry analyst data (e.g., Gartner quadrant), strategic competitive data (e.g., news and events regarding industry trends and competitors), business performance metrics by business unit that may be relevant to evaluating performance of the business units (e.g., P&L, head count, factory health, supply chain metrics, sales metrics, R&D metrics, marketing metrics, and many others), Board package data, or some other type of data relevant to the operations of the CEO and/or executive department. In embodiments, the digital twin system 8004 may obtain securities-relevant financial data from, for example, the enterprise's accounting software (e.g., via an API), publicly disclosed financial statements, third-party reports, tax filings, and the like. In embodiments, the digital twin system 8004 may obtain strategic competitive data from public news sources, from publicly disclosed financial reports, and the like. In embodiments, macroeconomic data may be derived analytically from various financial and operational data collected by the EMP 8000. In embodiments, the business performance metrics may be derived analytically, based at least in part on real time operations data, by the artificial intelligence services system 8010 and/or provided from other users and/or their respective executive digital twins. The CEO digital twin 8302 may be used to define real time operations data parameters of interest and to monitor, collect, analyze, and interpret real time operations data for conformance to and alignment with an organization's stated business objects, Board requirements, industry best practice, regulation, or some other criterion.

In embodiments, a CEO digital twin 8302 may include high-level views of different states of the enterprise, including real-time and historical representations of major assets, the condition of different business units of the enterprise, and any mission-critical information. The CEO digital twin 8302 may initially depict the various states at a lower granularity level. In embodiments, a user that is viewing the CEO digital twin 8302 may select a state to drill down into the selected state and view the selected state at a higher level of granularity. For example, the CEO digital twin 8302 may initially depict a subset of the various states of the enterprise at a lower granularity level, including a financial-department state (e.g., a visual indicator indicating an overall financial health score of the enterprise). In response to selection, the CEO digital twin 8302 may provide data, analytics, summary, and/or reporting including, but not limited to, real-time, historical, aggregated, comparison, and/or forecasted financial information (e.g., real-time, historical, simulated, and/or forecasted revenues, liabilities, and the like). In this way, the CEO digital twin 8302 may initially present the user (e.g., the CEO) with a view of various different aspects of the enterprise (e.g., different indicators to indicate different “health” levels of a respective business unit or part of the enterprise) but may allow the user to select which aspects require more of her attention. In response to such a selection, the CEO digital twin 8302 may request a more granular view of the selected state(s) from the EMP 8000, which may return the requested states at the more granular level.

In embodiments, a CEO digital twin 8302 may include an executive-level digital twin of the executive department (e.g., C-suite, directors, Board members, and the like), which the user may use to identify, assign, instruct, oversee and review executive department personnel and third-party personnel, departments, organizations and the like that are associated with the activities of the executive of an organization, including the Board of Directors and the like that are involved in the oversight of the organization's management. In embodiments, the executive-level digital twin may include a definition of the various roles, employees, and departments working under the CEO, the reporting structure for each individual in the business unit and may be populated with the various names and/or other identifiers of the individuals filling the respective roles. In embodiments, the CEO digital twin 8302 may include a graphical user interface that provides the user the ability to define/redefine personnel groupings, assign performance criteria and metrics to business units, roles, and/or individuals, and/or assign/delegate tasks to business units, roles, and/or individuals, and the like via the executive-level digital twin. In embodiments, the executive-level digital twin may provide real-time operations data of the organization to continuously evaluate the personnel groupings' performance against the stored performance criteria.

In embodiments, a CEO digital twin 8302 may be configured to interface with the collaboration suite 8006 to specify and provide a set of collaboration tools that may be leveraged by the executive department and associated parties. The collaboration tools may include video conferencing tools, “in-twin” collaboration tools (e.g., where the collaboration occurs to some extent within a common interface by which the digital twin entities are viewed and collaboration activities take place and/or where the components of the EMP that used to configure, operate or support the digital twin also govern collaboration around digital twin entities and workflows), whiteboard tools, agile development environment tools (such as features in Slack™ environments), presentation tools, word processing tools, spreadsheet tools, and the like, as described herein. Collaboration and communication rules may be configured based at least in part on using the AI reporting tool, as described herein. The collaboration tools may include collaborative communication (e.g., facilitating live conferencing where participants are simultaneously presented with conference-related views of digital twin entities or workflows), asynchronous collaboration (such as where actions on digital twin entities, comments, or the like are represented to different users who interact with the entities), version control features, and many others.

In embodiments, a CEO digital twin 8302 may be configured to provide research, track, and report on an executive department initiative including, but not limited to, an overall strategic goal, policy implementation, product roll-out, Board interaction, investment or acquisition, investor relations, public relations and press handling, budgeting, or some other type of executive initiative. The CEO digital twin 8302 may interact with and share such data and reporting with other executive digital twins, including, but not limited to, a CFO digital twin, a COO digital twin, and the like. In embodiments, the CEO digital twin 8302 or an executive agent integrated with or within it (such as one trained to undertake expert executive actions as described elsewhere herein) may leverage intelligence services (e.g., data analytics, machine learning and A.I. processes) to analyze financial reports, projections, simulations, budgets, and related summaries to identify key departments, personnel, third-party or others that are, for example, listed in, or subject to, a project, initiative, budget line item and the like, and who therefore may have an interest in such material. Such material pertaining to a given party may be abstracted and summarized for presentation, and formatted and presented automatically, or at the direction of the CEO or other user, to the party that is the origin of the expense and/or subject of the material. For example, the CEO digital twin 8302 may assemble materials for the purposes of developing presentations, speaking points, press releases, or some other material for the CEO or other executive personnel to use for public presentation. In an example, a CEO in anticipation of giving a conference presentation on the introduction of a new company product may use the CEO digital twin 8302 to specify and configure the identification, collection and assembly of operations data that is relevant to the upcoming presentation, such as product data (e.g., units produced, units shipped), financial data (e.g., products sold, products reserved), graphic presentation information (e.g., product photos, maps of product distribution, graphs of anticipated sales), forecasting data (e.g., market growth expected), or some other type of data and assemble such information in a presentation format, such as presentation slides, white paper template, speech talking points, press release, or some other summary format that may form the basis of the presentation or be distributed in conjunction with the presentation and/or its marketing.

In embodiments, a CEO digital twin 8302 may be configured to track and report on stakeholder communications (e.g., reports, Board requests, investor requests) related to the executive department. The CEO digital twin 8302 may present, store, analyze, reconcile and/or report on executive activities related to parties with whom the executive department is contracting, cooperating with, reporting to and so forth, such as key personnel, outside contractors, the press, the Board of Directors, or others.

In embodiments, the CEO digital twin 8302 may be configured to simulate one or more aspects of the enterprise. Such simulations may assist the user (e.g., the CEO) in making executive level decisions. For example, simulations of a proposed executive initiative may be tested, for example using the modeling, machine learning, and/or AI techniques, as described herein, by simulating temporal effects on initiatives (e.g., introduction of a new product), varying financial parameters (e.g., potential investment levels), targeting parameters (e.g., geographic, demographic, or the like), and/or other suitable executive parameters. In embodiments, the digital twin simulation system 8116 may receive a request to perform an executive simulation requested by the CEO digital twin 8302, where the request indicates one or more parameters that are to be varied in one or more enterprise digital twins. In response, the digital twin simulation system 8116 may return the simulation results to the CEO digital twin 8302, which in turn outputs the results to the user via the client device display. In this way, the user may be provided with various outcomes corresponding to different parameter configurations. For example, a user may request a set of simulations to be run to test different supply chain strategies to see how the different strategies affect the throughput of a manufacturing facility and the overall impact on the profits and losses of the enterprise. The digital twin simulation system 8116 may perform the simulations by varying the different supply chain strategies and may output the throughputs and P&L forecasts for each respective supply chain strategy. In some embodiments, the user may select a parameter set based on the various outcomes, and iterate simulations based at least on the varied prior outcomes. Drawing from the previous example, the user may decide to select the supply chain strategy that maximizes P&L forecasts but does not adversely affect throughput of the manufacturing facility. In some embodiments, an executive agent may be trained to recommend and/or select a parameter set based on the respective outcomes associated with each respective parameter set.

In embodiments, a CEO digital twin 8302 may be configured to store, aggregate, merge, analyze, prepare, report and distribute material relating to an executive strategy, executive planning, executive activities, and/or executive initiatives. For example, the CEO digital twin 8302 may be associated with a plurality of databases or other repositories of financial materials, summaries and reports and analytics, including such materials, summaries and reports and analytics related to prior executive activity (e.g., prior quarterly financial performance, prior investments, prior strategic partners, co-developments, and the like), each of which may be further associated with financial and performance metrics pertaining to the campaign and which are also accessible to the CEO digital twin 8302.

In embodiments, a CEO digital twin 8302 may be configured to store, aggregate, merge, analyze, prepare, report and distribute material relating to financial reporting, ratings, rankings, financial trend data, income data, or other data related to an executive's responsibilities. A CEO digital twin 8302 may link to, interact with, and be associated with external data sources, and able to upload, download, aggregate external data sources, including with the EMP's internal data, and analyze such data, as described herein. Data analysis, machine learning, AI processing, and other analysis may be coordinated between the CEO digital twin 8302 and an analytics team based at least in part on using the artificial intelligence services system 8010. This cooperation and interaction may include assisting with seeding executive-related data elements and domains in the enterprise data store 8012 for use in modeling, machine learning, and AI processing to identify an optimal business strategy, or some other executive-relating metric or aspect, as well as identification of the optimal data measurement parameters on which to base judgement of an executive initiative's success. Examples of data sources 8020 that may be connected to, associated with, and/or accessed from the CEO digital twin 8302 may include, but are not limited to, the sensor system 8022 having sensors that sensor data from facilities (e.g., manufacturing facilities, shipping and logistics facilities, transportation facilities, agricultural facilities, resource extraction facilities, computing facilities, and many others) and/or other physical entities of the enterprise, the sales database 8024 that is updated with sales figures in real time, the CRM system 8026, the content marketing platform 8028, financial databases 8030, surveys 8032, org charts 8034, workflow management systems 8036, third-party data sources 8038, customer databases 8040 that store customer data, and/or third-party data sources 8038 that store third-party data, edge devices 8042 that report data relating to physical assets (e.g., smart machinery/manufacturing equipment, sensor kits, autonomous vehicles of the enterprise, wearable devices, and the like), enterprise resource management systems 8044, HR systems 8046, content management systems 8016, and the like). In embodiments, the digital twin system 8004 abstracts the different views (or states) within the digital twin to the appropriate granularity. For instance, the digital twin system 8004 may have access to all the sensor data collected on behalf of the enterprise as well as access to real-time sensor data streams. Typically, such data is far too granular for an executive such as a CEO, and sensor data readings are often of little importance to the CEO unless associated with a mission critical state or operation. In this example, however, if the sensor readings from a particular physical asset (e.g., a critical piece of manufacturing equipment) are indicative of a potentially critical situation (e.g., failure state, dangerous condition, or the like), then the analytics that indicate the potentially critical situation may become very important to the CEO. Thus, the digital twin system 8004 may, when building the appropriate perspective for the CEO, include a state indicator of the physical asset in the CEO digital twin. In this way, the CEO can drill down into the state indicator of the physical asset to view the potentially critical situation at a greater granularity (e.g., the machinery and an analysis of the sensor data used to identify the situation).

In embodiments, a CEO digital twin 8302 may be configured to monitor an organization's performance based at least in part on real time operations data and the use of the monitoring agent of the client application 8052, as described herein, that is associated with the CEO digital twin 8302. The monitoring agent may report on such activities to the EMP 8000 for presentation in a user interface that is associated with the CEO digital twin 8302. In response, the EMP 8000 may train an executive agent (which may include one or more machine-learned models) to handle and process such notifications when they next arrive, and escalate and/or alert the CEO when such notifications are of an urgent nature, such as an announcement of an acquisition by a competitor, a report indicating an under-performing business unit, a high-profile press article, a radical change in the stock market (for the CEO's company, a cohort member, or the market as a whole), a downgrade in rating by an industry analyst, an external event likely to disrupt operations (such as a natural disaster or epidemic) or some other important event. In embodiments, the CEO digital twin 8302 may generate performance alerts based on real time operations data, performance trends, and the like. This may allow a CEO to optimize initiatives in real-time without having to manually request such real-time data; the CEO digital twin 8302 may automatically present such information and related/necessary alerts as configured by the organization, CEO, or some other interested party.

In embodiments, a CEO digital twin 8302 may be configured to report on the performance of the executive department, personnel of the executive department, executive activities, executive content, executive platforms, executive partners, or some other aspect of management within a CEO's responsibilities. Reporting may be to the CEO, the executive department, to other executives of an organization (e.g., the COO), or to outside third parties (e.g., partners, press releases, and the like). As described herein, reporting may include stakeholder summaries, minutes of meetings, presentations, sales data, customer data, financial performance metrics, personnel metrics, data regarding resource usage, industry summaries (e.g., summaries of merger and acquisition activity in an industry segment), or some other type of reporting data. Reporting and the content of reporting may be shared by the CEO digital twin 8302 with other executive digital twins. The reporting functionality of the CEO digital twin 8302 may also be used for populating new or preset reporting formats, and the like. Templets of common reporting formats may be stored and associated with the CEO digital twin 8302 to automate the presentation of data and analytics according to pre-defined formats, styles and system requirements. In embodiments, an executive agent trained by the user may be trained to surface the most important reports to the user. For example, if the user (e.g., the CEO) consistently views and follows up on sales data reports but routinely skips over reports relating to the manufacturing KPIs, the executive agent may automatically surface sales data reports to the user and may automatically delegate manufacturing KPIs to another executive digital twin (e.g., the COO digital twin).

In embodiments, a CEO digital twin 8302 may be configured to monitor, store, aggregate, merge, analyze, prepare, report and distribute material relating to competitors of a CEO's organization, or named entities of interest. In embodiments, such data may be collected by the EMP 8000 via data aggregation, spidering, web-scraping, or other techniques to search and collect competitor information from sources including, but not limited to, information on investment and/or acquisitions, press releases, SEC or other financial reports, or some other publicly available data. For example, a user wishing to monitor a certain competitor may request that the CEO digital twin 8302 provide materials relating to the certain competitor. In response, the EMP 8000 may identify a set of data sources that are either publicly available or to which the enterprise of the CEO has access (e.g., internal data sources, licensed third-party data, or the like). The EMP 8000 may configure a cohort digital twin 8320 based on the types of data/analysis/services the user requests and the identified set of data sources. The EMP 8000 may then serve the cohort digital twin 8320 associated with the requested party (e.g., competitor) to the CEO digital twin 8302.

In embodiments, a CEO digital twin 8302 may be configured to monitor, store, aggregate, merge, analyze, prepare, report and distribute material relating to regulatory activity, such as government regulations, industry best practices or some other requirement or standard. For example, the CEO digital twin 8302 may be in communication with another enterprise digital twin, such as a General Counsel digital twin 8314, through which the legal team can keep the CEO apprised of new regulation or regulation changes as they occur.

In embodiments, the client application 8052 that executes the CEO digital twin 8302 may be configured with an executive agent 8364 that is trained on the CEO's actions (which may be indicative of behaviors, and/or preferences). In embodiments, the executive agent 8364 may record the features relating to the actions (e.g., the circumstances relating to the user's action) to the expert agent system 8008. For example, the executive agent 8364 may record each time the user delegates a task to a subordinate (which is the action) as well as the features surrounding the delegation of the task (e.g., an event that caused the user to delegate the task, the type of task that was delegated, the role to which the task was delegated, instructions provided by the user with the delegation, and the like). The executive agent 8364 may report the actions and features to the expert agent system 8008 and the expert agent system 8008 may train the executive agent 8364 on the manner by which the executive agent 8364 can delegate or recommend delegation of tasks in the future. Once trained, the executive agent 8364 may automatically perform actions and/or recommend actions to the user. Furthermore, in embodiments, the executive agent 8364 may record outcomes related to the performed/recommended actions, thereby creating a feedback loop with the expert agent system 8008.

References to features and functions of the EMP and digital twins in this example of a CEO digital twin 8302 should be understood to apply to other digital twins, and their respective projects and workflows, except where context indicates otherwise.

In embodiments, a Chief Financial officer (CFO) digital twin 8304 may be a digital twin configured for a CFO of an enterprise, or an analogous executive tasked with overseeing the finance-related tasks of the enterprise. A CFO digital twin 8304 may provide data, analytics, summary, and/or reporting including, but not limited to, real-time, historical, aggregated, comparison, and/or forecasted financial information (e.g., real-time, historical, simulated, and/or forecasted sales figures, expenditures, revenues, liabilities, and the like). In embodiments, the CFO digital twin may work in connection with the EMP 8000 to provide simulations, predictions, statistical summaries, decision support based on analytics, machine learning, and/or other AI and learning-type processing of inputs (e.g., accounting data, sales data, sensor data and the like).

In embodiments, a CFO digital twin 8304 may provide features and functionality including, but not limited to, management of financial personnel, partners and outside consultants and contractors (e.g., accounting firms, auditors and the like), oversight of budgets, procurement, expenditures, receivables, and other finance-related resources, compliance, oversight of sales and sales staff and departments' financial performance, management of contracting, management of internal policies (e.g., policies related to expenditures and reporting), tax law, finance-related privacy law (e.g., pertaining to credit agency data), reporting, compliance, and regulatory analysis.

In embodiments, the types of data that may populate a CFO digital twin may include, but are not limited to, financial performance metrics by business unit, by product, by geography, by factory, by store location(s), by asset class, earnings, cash, balance sheet data, cash flow, profitability, resource utilization, audit data, general ledger data, asset performance data, securities and commodities data, insurance and risk management data, asset aging and depreciation data, asset allocation data, macroeconomic data, microeconomic analytic data, tax data, pricing data, competitive product and pricing data, forecast data, demand planning data, employment and salary data, analytic results of AI and/or machine learning modeling (e.g., financial forecasting), prediction data, recommendation data, or some other type of data relevant to the operations of the CFO and/or finance department. In embodiments, “datum,” “data,” “dataset,” “datastore,” “data warehouse,” and/or “database,” as used herein, may refer to information that is stored in a numeric or statistical format, including summaries, inputs or outputs in statistical or scientific notation, and also includes information that is stored in natural language format (e.g., text excerpts from reports, press releases, statutes and the like), information in a graphic format (e.g., financial performance graphs), information in audio and/or audio-visual format (e.g., recorded audio from conference calls or video from presentations, including natural language transcript summaries of audio and/or audio-visual formatted information), or some other type of information.

In embodiments, a CFO digital twin 8304 may depict a finance department twin of the finance department, which the user may use to identify, assign, instruct, oversee and review finance department personnel and third-party personnel that are associated with the finance activities of an organization, including third-party partners and other outside contractors, such as accounting firms, tax lawyers and the like that are involved in the organization's finance endeavors. Examples of such organization personnel include, but are not limited to, finance department staff, sales analysts, statisticians, data scientists, executive personnel, human resources staff, Board Members, advisors, or some other type of organization personnel relevant to the functioning of a finance department. Examples of a finance department's third-party personnel include, but are not limited to, lawyers, accountants, management consultants, social media platform personnel, finance partners, consultants, contractors, financial firm staff, auditors, or some other type of third-party personnel.

In embodiments, the CFO digital twin 8304 may include a definition of the various roles/employees working under the CFO, the reporting structure, and associated permissions, for each individual in the business unit, and may be populated with the various names and/or other identifiers of the individuals filling the respective roles. In embodiments, a user (e.g., the CFO of an enterprise) may use the CFO digital twin 8304 to adjust the reporting structure within the finance department and/or to grant permissions to one or more individuals within the department.

In embodiments, a CFO digital twin 8304 may be configured to interface with the collaboration suite 8006 to specify and provide a set of collaboration tools that may be leveraged by the finance department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein.

In embodiments, a CFO digital twin 8304 may be configured to research, create, track and report on a finance department initiative including, but not limited to, an overall department budget, a budget for a single or group of finance initiatives, an audit, a third-party vendor activity, or some other type of expense or budget. In embodiments, the CFO digital twin 8304 may interact with and share such expense or budget data and reporting with other enterprise twins, as described herein, including, but not limited to, a digital twin related to accounts payable, executive staff such as the CEO (e.g., CEO digital twin) or COO (e.g., the COO digital twin), or other suitable enterprise digital twins. In embodiments, the CFO digital twin 8304 may leverage one or more intelligence services of the EMP 8000 based at least in part on the data analytics, machine learning and A.I. processes, as described herein, to provide financial reports, projections, simulations, budgets and related summaries. In some of these embodiments, the CFO digital twin 8304 my use the intelligence services to identify key departments, personnel, third-party or others that are, for example, listed in, or subject to, the budget line item and who therefore may have an interest in such material. Budget material pertaining to a given party may be abstracted and summarized for presentation independent from the entirety of the budget, and formatted and presented automatically, or at the direction of the CFO or other user, to the party that is the origin of the expense and/or subject of the budget item.

In some embodiments, a CFO digital twin 8304 may be configured to track and report on inbound and outbound billing (i.e., accounts receivable and payable) related to the finance department and/or organization. In embodiments, the CFO digital twin 8304 may include a billing digital twin that identifies the billing department, personnel, processes and systems associated with the billing workflows of the enterprise. In these embodiments, the billing digital twin may interact present, store, analyze, reconcile and/or report on billing activities related to parties with whom the finance department is interacting. In some embodiments, the user of the CFO digital twin 8304 may approve bills, issue bills, drill down into a set of bills, initiate investigations of bills or the like via the GUI if the CFO digital twin 8304.

In embodiments, a CFO digital twin 8304 may be configured to provide a user (e.g., a CFO or other finance department executive) with information that is unique to the CFO digital twin 8304 and thus can provide insights and perspectives on financial performance that are unique to the CFO digital twin 8304. For example, in supply chain planning, demand forecasting, operational planning and other of the CFO's activities, traditional data sources, models and projections may be “siloed” in ways, meaning they may be quantitatively robust within a particular domain, but that domain may be constrained by factors including, but not limited to, the origins of the data, the format within which the data is recorded, the statistical weights used in creating or transforming the data that is available, or some other constraint. In embodiments, the EMP 8000 in connection with the CFO digital twin 8304 may create and derive new financial metrics and analytics including, but not limited to, functionalities such as native data and model creation, and data and model combinations and aggregations based at least in-part on the real time operations of an organization. Native data and model creation, such as specifying the data to be collected, the format within which to collect and store the data, the data transformations to model, and so forth gives one the ability to craft, combine, aggregate, modify, transform, and/or weight the native data (including in combination with other third-party data) in manners that are appropriately mathematically tuned to the modeling, analysis, machine learning, and/or AI techniques that are performed by the EMP 8000 and CFO digital twin 8304, rather than being reliant on data and/or model presets. Similarly, in the analytic context of the CFO's operations and the function of the EMP and CFO digital twin 8304, native data and model creation and structuring by the EMP and CFO digital twin 8304 enables analytics, machine learning, AI operations and the like, yielding new analytic results and insights, based at least in part on the real time operations of an organization, because the EMP and CFO digital twin 8304 has enabled the CFO to move further up in financial data creation and modeling operations to assert greater creative control over the types of data and other input material to be used in developing analytic insights that may be created and reported for the purpose of improving performance including, but not limited to, product margins (e.g., gross, contribution, net and the like), product features, upsell opportunities or some other performance metric.

In embodiments, the CFO digital twin 8304 may be configured to simulate finance-related activities on behalf of a user. In these embodiments, the user may identify one or more parameters that can be varied during for a simulation including, but not limited to, financial and/or budget parameters, pricing and sales goal settings, process designs, and maintenance/infrastructure upgrades, internal controls design, product testing frequencies/types, manufacturing downtimes, flexible workforce planning, and the like. In these embodiments, the digital twin simulation system 8116 may receive a request to perform the simulation requested by the CFO digital twin 8304, where the request indicates features and the parameters, including financial parameters, that are to be varied. In response, the digital twin simulation system 8116 may return the simulation results to the CFO digital twin 8304, which in turn outputs the results to the user via the client device display. In this way, the user is provided with various outcomes corresponding to different parameter configurations. In some embodiments, the user may select a parameter set based on the various outcomes. In some embodiments, an executive agent trained by the user may select the parameter sets based on the various outcomes. The simulations, analytics and/or modeling performed by the CFO digital twin 8304 may be used to mitigate risk for IPO, M&A, equity and debt offerings, or some other type of transaction. The simulations, analytics and/or modeling performed by the CFO digital twin 8304 may be used to create and structure sales incentives, including commissions and other performance-based compensation. The simulations, analytics and/or modeling performed by the CFO digital twin 8304 may be used to evaluate insurance offerings and other information related to business interruption preparedness. The simulations, analytics and/or modeling performed by the CFO digital twin 8304 may be used to analyze loan covenant monitoring and projections. The CFO equipped with digital twin 8304 will be better able to adapt quickly to change by predicting headwinds, forecasting operational performance, and making informed decisions across departments while mitigating risk.

In embodiments, a CFO digital twin 8304 may be configured to manage operational planning, based at least in part by leveraging predictive analytics for sales planning, and supply chain management in order to increase company efficacy while optimizing operating expenses.

In embodiments, a CFO digital twin 8304 may be configured to access insights across environmental resource management (ERM) solutions for risk oversight that includes, but is not limited to, internal controls design, testing, certification, and reporting while directing listed actions into a repository. In embodiments, a CFO digital twin 8304 may be configured to streamline governance, risk management, and compliance processes in order to connect risk and compliance across the organization and manage complex audit fieldwork and work papers.

In embodiments, a CFO digital twin 8304 may be configured to store, aggregate, merge, analyze, prepare, report and distribute material relating to a financial strategy, plan, activity or initiative. For example, the CFO digital twin 8304 may be associated with a plurality of databases or other repositories of financial materials, summaries and reports and analytics, including such materials, summaries and reports and analytics related to prior financial activity (e.g., prior quarterly financial performance), each of which may be further associated with third-party financial or economic data.

In embodiments, a CFO digital twin 8304 may be configured to store, aggregate, merge, analyze, prepare, report and distribute material relating to financial reporting, ratings, rankings, financial trend data, income data, or other finance department-related data. A CFO digital twin 8304 may link to, interact with, and be associated with external data sources, and able to upload, download, aggregate external data sources, including with the EMP's internal data, and analyze such data. Data analytics, machine learning, AI processing, and other data-driven processes may be coordinated between the CFO digital twin 8304 and an analytics team based at least in-part on insights derived by the artificial intelligence services system 8010. This cooperation and interaction may include assisting with seeding finance-related data elements and domains in the enterprise data store 8012 for use in modeling, machine learning, and AI processing to identify the optimal financial strategy, or some other finance-related metric or aspect, as well as identification of the optimal data measurement parameters on which to base judgement of a finance endeavor's success. Examples of data sources 8020 that may be connected to, associated with, and/or accessed from the CFO digital twin 8304 may include, but are not limited to, the sensor system 8022, the sales database 8024 that is updated with sales figures in real time, the CRM system 8026, news websites 8048, the financial database 8030 that tracks costs of the business, an org chart 8034, a workflow management system 8036, customer databases 1S40 that store customer data, and/or third-party data sources 8038 that store third-party data.

In embodiments, a CFO digital twin 8304 may aggregate data sources and types, creating new data types, summaries and reports that are not available elsewhere. This may reduce reliance upon the need of multiple third-party providers and current solutions. This may, among other benefits and improvements, reduce expenses associated with acquiring data needed for sound financial decision making.

In embodiments, a CFO digital twin 8304 may be configured to monitor a user's performance of finance-related tasks via a monitoring function of an agent of the client application 8052 executing the CFO digital twin 8304. In embodiments, the monitoring function of the executive agent may report on certain activities to the EMP 8000 that are undertaken by the user when interfacing with the CFO digital twin 8304. In response, the EMP 8000 may train the executive agent (which may include one or more machine-learned models) to handle and process such finance-related tasks when they next arrive. For example, the monitoring function may monitor when the user (e.g., the CFO) escalates a state of the CFO digital twin 8304 to the CEO and/or when the user delegates a task to a subordinate via the CFO digital twin 8304. Each time such escalations and/or delegation events occur and/or when the user (e.g., the CFO or other finance executive) responds to an alert or other notifications of an urgent nature and may report and may report the actions taken by the user in response to each respective account to the EMP 8000. In response, the expert agent system 8008 may train an executive agent 8364 based on the reported actions, which in turn may be leveraged by the CFO digital twin to respond to certain later occurring events on which the executive agent 8364 was trained on (e.g., analytics showing poor financial performance or finance activity (e.g., a new investment). For example, an executive agent 8364 trained with respect to a CFO digital twin 8304 may automatically issue financial performance alerts to certain employees based on performance trends of one or more business units. In another example, the executive agent 8304 may automatically escalate a notification to the CEO (which may be depicted in the CEO digital twin 8302) when certain metrics indicate a poor financial forecast. In embodiments, the executive agent 8364 in connection with the CFO digital twin 8304 may allow a CFO to optimize initiatives in real-time without having to manually request such real-time financial performance data. In some embodiments, the CFO digital twin 8304 may automatically present such information and related/necessary alerts as configured by the configuring user, the CFO, or some other user having such permissions.

In embodiments, an executive agent 8364 trained in connection with a CFO digital twin 8304 may be configured to report on the performance of the finance department, personnel of the finance department, finance activities, finance content, finance platforms, finance partners, or some other aspect of management within a CFO's responsibilities. Reporting may be to the CEO, the Board of Directors, other executives of an organization (e.g., the COO), or to outside third parties (e.g., partners, press releases, and the like). The reporting functionality of the CFO digital twin 8304 may also be used for populating required data for formal reporting requirements such as shareholder statements, annual reports, SEC filings, and the like. Templets of common reporting formats may be stored and associated with the CFO digital twin 8304 to automate the presentation of data and analytics according to pre-defined formats, styles and system requirements.

In embodiments, a CFO digital twin 8304 in combination with the EMP 8000 may be configured to monitor, store, aggregate, merge, analyze, prepare, report and distribute material relating to competitors of a CFO's organization, or named entities of interest. In embodiments, such data may be collected by the EMP 8000 via data aggregation, spidering, web-scraping, or other techniques to search and collect competitor information from sources including, but not limited to, press releases, SEC or other financial reports, mergers and acquisitions activity, or some other publicly available data.

In embodiments, a CFO digital twin 8304 in combination with the EMP 8000 may be configured to monitor, store, aggregate, merge, analyze, prepare, report and distribute material relating to regulatory activity, such as government regulations, industry best practices or some other requirement or standard. For example, the CFO digital twin 8304 may be in communication with another enterprise digital twin, such as a General Counsel digital twin 8314, through which the legal team can keep the CFO apprised of new regulations or regulation changes as they occur.

In embodiments, the client application 8052 that executes the CFO digital twin 8304 may be configured with an executive agent that reports a CFO's behaviors and preferences (or other finance personnel's behaviors and preferences) to the expert agent system 8008, as described herein, and the expert agent system 8008 may train the executive agent on how the CFO or other finance personnel respond to certain situations and adjust its operation based at least in part on the data collection, analysis, machine learning and A.I. techniques, as described herein. The foregoing examples are optional examples and are not intended to limit the scope of the disclosure.

References to features and functions of the EMP and digital twins in this example of a finance department and a CFO digital twin 8304 should be understood to apply to other departments and digital twins, and their respective projects and workflows, except where context indicates otherwise.

In embodiments, a Chief Operating officer (COO) digital twin 8306 may be a digital twin configured for a COO of an enterprise, or an analogous executive tasked with overseeing the operations tasks of the enterprise. A COO digital twin 8306 may provide functionality including, but not limited to, management of personnel and partners, oversight of various departments (e.g., oversight over marketing department, HR department, sales department, and the like), project management, implementation and/or rollouts of business processes and workflows, budgeting, reporting, and many other operations-related tasks.

In embodiments, a COO digital twin 8306 may provide data, analytics, summary, and/or reporting including, but not limited to, real-time, historical, aggregated, comparison, and/or forecasted financial information (e.g., sales, expenditures, revenues, liabilities, profitability, cash flow and the like), mergers and acquisitions information, systems data, reporting and controls data, or some other operations related information. In embodiments, the COO digital twin 8306 may work in connection with the EMP 8000 to provide simulations, predictions, statistical summaries, decision support based on analytics, machine learning, and/or other AI and learning-type processing of inputs (e.g., equipment data, sensor data and the like), for example those related to the development, communication and implementation of effective growth strategies and processes for an organization.

In embodiments, the types of data that may populate a COO digital twin may include, but are not limited to, operations data, key performance indicators (KPIs) for factories/plants, business units, assets/equipment; uptime/downtime, safety data, risk management data, supply chain/component availability data, demand plan data, logistics data, workflow data, financial performance metrics by business unit, by product, by geography, by factory, by store location(s), by asset class, earnings, resource utilization; audit data, asset performance data, asset aging and depreciation data, asset allocation data, or some other type of operations-relevant data or information.

In embodiments, a COO digital twin 8306 may depict a twin of the operations department, which the user may use to identify, assign, instruct, oversee and review operations department personnel and third-party personnel that are associated with the design, implementation and evaluation of operational processes, internal infrastructures, reporting systems, company policies, and the like.

In embodiments, the COO digital twin 8306 may include a definition of the various roles/employees working under the COO, the reporting structure, and associated permissions, for each individual in the business unit, and may be populated with the various names and/or other identifiers of the individuals filling the respective roles.

In embodiments, a COO digital twin 8306 may be configured to interface with the collaboration suite 8006 to specify and provide a set of collaboration tools that may be leveraged by the operations department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein.

In some of these embodiments, the COO digital twin 8306 may be configured to simulate operations activities, such as a proposed new operational plan, process or program. In these embodiments, the digital twin simulation system 8116 may receive a request to perform the simulation requested by the COO digital twin 8306, where the request indicates features and the parameters of the operational plan or other activity that is proposed for implementation, the associated variables for which may be altered or varied to produce differing simulation environments. In response, the digital twin simulation system 8116 may return the simulation results to the COO digital twin 8306, which in turn outputs the results to the user via the client device display. In this way, the user is provided with various outcomes corresponding to different operational parameter configurations. In embodiments, an executive agent trained by the user may select the parameter sets based on the various outcomes.

In embodiments, a COO digital twin 8306 may be configured to store, aggregate, merge, analyze, prepare, report and distribute material relating to an operations strategy, plan, activity or initiative. For example, the COO digital twin 8306 may be associated with a plurality of databases or other repositories of operational data, summaries and reports and analytics, including such materials, summaries and reports and analytics related to prior operations activity, each of which may be further associated with financial and performance metrics pertaining to the activity and which are also accessible to the COO digital twin 8306.

In embodiments, a COO digital twin 8306 may be configured to monitor operational performance, including in real time, based at least in part on use of the monitoring agent of the client application 8052, as described herein, that is associated with the COO digital twin 8306. The monitoring agent may report on such activities to the EMP 8000 for presentation in a user interface that is associated with the COO digital twin 8306. In response, the EMP 8000 may train an executive agent (which may include one or more machine-learned models) to handle and process such notifications when they next arrive and escalate and/or alert the COO when such notifications are of an urgent nature.

In embodiments, a COO digital twin 8306 may be configured to report on the performance of the operations department, personnel of the operations department, operations activities, operations content, operations platforms, operations partners, or some other aspect of management within a COO's responsibilities.

In embodiments, the EMP 100 trains and deploys executive agents on behalf of enterprise users. In embodiments, an executive agent is an AI-based software system that performs tasks on behalf of and/or suggests actions to a respective executive user. In embodiments, the EMP 100 receives data from various data sources associated with a particular entity or workflow and learns the workflows performed by the particular user based on the data and the surrounding circumstances or context. For example, the user may be a COO that is presented a COO digital twin 8306. Among the responsibilities of the COO may be scheduling maintenance and replacement of equipment in a manufacturing, warehouse, or other operational facility. The states depicted in the COO digital twin 8306 may include depictions of the condition of different pieces of equipment within the operational facility. In this example, the COO may schedule maintenance via the digital twin when a piece of equipment is determined to be in a first condition (e.g., a deteriorating condition) and may issue a request to the COO via the COO digital twin 8306 to replace the piece of equipment when the equipment is determined to be in a second condition (e.g., a critical condition). The executive agent may learn the COO's tendencies based on the COO's previous interaction with the COO digital twin 8306. Once trained, the executive agent may automatically request replacements from the COO when a particular piece of equipment is determined to be in the second condition and may automatically schedule maintenance if the piece of equipment is in the first condition.

In embodiments, the client application 8052 that executes the COO digital twin 8306 may be configured with an executive agent that reports a COO's behaviors and preferences (or other operations personnel's behaviors and preferences) to the executive agent system 8008, as described herein, and the executive agent system 8008 may train the executive agent on how the COO or other executive personnel respond to certain situations and adjust its operation based at least in part on the data collection, analysis, machine learning and A.I. techniques, as described herein. The foregoing examples are optional examples and are not intended to limit the scope of the disclosure.

References to features and functions of the EMP and digital twins in this example of an operations department and a COO digital twin 8306 should be understood to apply to other departments and digital twins, and their respective projects and workflows, except where context indicates otherwise.

In embodiments, a Chief Marketing officer (CMO) digital twin 8308 may be a digital twin configured for a CMO of an enterprise, or an analogous executive tasked with overseeing the marketing tasks of the enterprise. A CMO digital twin 8308 may provide functionality including, but not limited to, management of personnel and partners, development and oversight of marketing budgets and resources, management of marketing and advertising platforms, development and management of marketing content, strategies and campaigns, reporting, competitor analysis, regulatory analysis, and management of data privacy and security.

In embodiments, the types of data that may populate and/or be utilized by a CMO digital twin 8308 may include, but are not limited to, macroeconomic data; market pricing data; competitive product and pricing data; microeconomic analytic data; forecast data; demand planning data; competitive matrix data; product roadmap; product capability data; consumer behavior data; consumer profile data; collaborative filtering data; analytic results of AI and/or machine learning modeling; channel data; demographic data; geographic data; prediction data; recommendation data, or some other type of data relevant to the operations of the CMO and/or marketing department.

In embodiments, an executive digital twin, such as a CMO digital twin 8308 or other executive digital twin may depict a twin of a department, such as the marketing department or other department, which the user may use to identify, assign, instruct, oversee and review department personnel and third-party personnel that are associated with the activities of a particular department of an organization, including third-party partners and other outside associates involved in the organization's related endeavors. Examples of such organization personnel include, but are not limited to, an organization's marketing staff, sales staff, finance staff, product design personnel, engineers, analysts, statisticians, data scientists, advertising staff, executive personnel, human resources staff, Board Members, advisors, or some other type of organization personnel. Examples of an organization's third-party personnel include, but are not limited to, advertising firm staff, ad exchange staff, outside creative or content developers, social media platform personnel, co-marketing partners, consultants, contractors, financial firm staff, auditors, or some other type of third-party personnel. In embodiments, the departmental twin (in this example a marketing department twin) may include a definition of the various roles/employees working under the executive (e.g., CMO), the reporting structure, and associated permissions, for each individual in the business unit, and may be populated with the various the names and/or other identifiers of the individuals filling the respective roles. In embodiments, the department twin (e.g., marketing department twin) may include subsections that are specific to an activity or initiative, such as a marketing or advertising campaign. In this way, the executive (e.g., a CMO) may easily identify the personnel and third-party providers that are involved in the initiative and/or assign individuals and/or third parties to the initiative. A user may define one or more restrictions, permissions, and/or access rights of the individuals indicated in the business unit (e.g., using the enterprise configuration system 8002), as described herein, such that the restrictions, permissions, and/or access rights can be controlled by the CMO (or analogous user). In embodiments, the permissions to define such restrictions and/or rights may be, for example, defined in the organizational digital twin that lists the user as having a role that permits implementing permissions, restrictions, and/or access rights to roles/individuals In embodiments, a personnel restriction or right associated with a role/individual may be specific to a project, such as a marketing or advertising campaign, and may define one or more types of data that a particular user or group of users is allowed, or not allowed, to access (either directly or in a digital twin). For example, a first marketing campaign twin may allow a marketing department employee to review the first marketing budget for a first marketing campaign and approve marketing expenditures for the first marketing campaign up to $10,000, but a second marketing campaign twin may disallow the same employee from any budgetary review or expenditures. Similar approaches can be used by projects of various types across an organization and its departments, such as product development projects, logistics projects, corporate development projects, service projects, and many others. In embodiments, a breach, or attempted breach, of a restriction, permission or access right may invoke a notice, alert, warning or some other action to an individual notifying them of the breach or attempted breach. In an example such a notice, alert, or warning may be sent to an individual that is identified based at least in part on the individual's position in the org chart relative to the person breaching or attempting to breach a restriction, permission or access right. In another example, such a notice, alert, or warning may be sent to an individual that is not identified in a departmental org chart and/or specific project or campaign, but rather may be sent to an individual that is identified based at least in part on a rule that is defined in the organizational twin of the entire enterprise. For example, a rule stored within an organizational digital twin of the entity may specify that an alert must be sent to an Information Security Department staff member, or some other staff member, upon an attempted login to a forbidden file, or other, system. Other rules may be related to geographic, temporal, or other types of restrictions, as described herein. In embodiments, an alert may be an email, phone call, text, or some other communication type.

In embodiments, a CMO digital twin 8308 may be configured to oversee and manage personnel and human resources issues and activities related to the marketing department. For example, a marketing department twin may map each individual within the marketing department to her respective marketing department. Using the CMO digital twin 8308, the user may be able to select a department to see greater detail on the functioning of the department. Alternatively, this step may be automatically performed by the CMO digital twin 8308, requiring no action from the user (e.g., the CMO) (e.g., via an executive agent trained by the user). For example, the greater detail might include the number of vacancies currently associated with the department and the duration that each of the open positions has remained unfilled, estimated salary data associated with the open positions, and the like. The user may be able to also select to see more information on the budget associated with a given department, such as a department with a personnel vacancy, in order to see if there is currently available budget to cover a new hire for the department. Alternatively, this step may be automatically performed by the CMO digital twin 8308, requiring no action from the user. Continuing the example, if there is budget to cover a new hire, the CMO digital twin 8308 may provide a link or other opportunity for the user to initiate a communication with human resources or some other department personnel to begin the process of posting a job listing. Alternatively, this step may be automatically performed by the CMO digital twin 8308 (e.g., via an executive agent executing on behalf of the user), requiring no action from the user. This communication may be drawn from a repository of form emails, letters or other communications so that the user need not compose the communication, but rather only signal within the CMO digital twin 8308 that such communication should be sent. Similarly, based on the communication type (e.g., “initiate a new marketing job posting”) the user may not need to select the receiving party, whom may be stored in the EMP as the appropriate recipient based at least in part on a rule associated with the communication type. Continuing the example further, alternatively, if there is not budget available to cover a new hire, a second type of communication may be invoked by the CMO digital twin 8308, for example, an email, calendar invitation to reserve a meeting, or some other type of communication may be selected to be sent to the CFO, or other financial personnel, to request a meeting to discuss the marketing department's budget or initiate some other activity. Following this example, if and when the new hires are approved, the CMO digital twin may allow the user to delegate the hiring task to a subordinate or herself. In the event the user is assigned the hire the new employee, the CMO digital twin 8308 may provide materials regarding candidates (e.g., resume, referrals, interview notes from interviewers, or the like) and the user may select one or more candidates to further consider, interview, or hire.

In an example, a user may be able to select a sub-department within the marketing department to view the performance of the sub-department in greater detail. For example, the greater detail might include the number of types of training sessions, tutorials, events, conferences, and the like that personnel in the selected marketing department have received. The user may be able to compare such training and event attendance levels with a specified target criterion that is stored in EMP, or that is associated with the EMP. This may result in the CMO digital twin 8308 reporting to the CMO a listing of personnel in her department whose training and/or event attendance fails to meet the target criterion. This listing may be prioritized by the CMO digital twin 8308 to highlight those staff members most in need of further training. The user may be able to also select to see more information on the budget associated with a given department, such as a department with staff who do not have adequate training according to the target criterion, in order to see if there is currently available budget to cover additional training for the department. If there is budget to cover additional training, the CMO digital twin 8308 may provide, for example, a link or other opportunity for the user to initiate a communication to a staff member in need of training to alert them that they must schedule training and/or attendance at an event within a timeframe. This communication may be drawn from a repository of form emails, letters or other communications so that the user need not compose the communication, but rather only signal within the CMO digital twin 8308 that such communication should be sent. Continuing the example further, a second type of communication may be invoked by the CMO digital twin 8308, for example, a request for information, training registration, or some other type of communication may be selected to be sent to a third-party training vendor that is used by the marketing department, a conference event registration, or other training or event entity, to request scheduling training and/or event registration, or some other activity. Alternatively, the steps, discussed above, for tracking and reporting on marketing personnel training and attendance may be automatically performed by the CMO digital twin 8308, requiring no action from the user. References to features and functions of the EMP and digital twins in this example of a marketing department and a CMO digital twin 8308 should be understood to apply to other departments and digital twins, and their respective projects and workflows, except where context indicates otherwise.

In embodiments, a CMO digital twin 8308 may be configured to interface with the collaboration suite 8006 to specify and provide a set of collaboration tools that may be leveraged by the marketing department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein.

In embodiments, a CMO digital twin 8308 may be configured to research, create, track and report on a marketing department budget including, but not limited to, an overall department budget, a budget for a single or group of marketing or advertising campaigns, a budget for a third-party vendor, or some other type of budget. The CMO digital twin 8308 may interact with and share such budget data and reporting with other executive twins, as described herein, including, but not limited to, a digital twin related to the finance department, accounts payable, executive staff such as the CEO and CFO, or others. The CMO digital twin 8308 may include intelligence, based at least in part on the data analytics, machine learning and A.I. processes, as described herein, to read marketing budgets and related summaries and data in order to identify key departments, personnel, third-party or others that are, for example, listed in, or subject to, the budget line item and who therefore may have an interest in such material. Budget material pertaining to a given party may be abstracted and summarized for presentation independent from the entirety of the budget, and formatted and presented automatically, or at the direction of a user, to the party that is the subject of the budget item. In a simplified example, a CMO may create a new marketing campaign, “Airline-Airfare coupon texting campaign-January,” which includes the following line items: Third-party advertising firm content creation $15,000; Social media platform placement $50,000; analytics department $25,000, and so forth. The entirety of the budget may be shared (at the election of the user or automatically) with parties that must approve the full budget, such as a CFO. As described herein this sharing may be accomplished by the CMO digital twin 8308 communicating directly with a CFO digital twin, so that the information is presented to the CFO without requiring the CFO to have knowledge of the budget or requesting the budget. Subparts of the budget, for example, the analytics department line item, may be automatically sent to the head of the analytics department by the CMO digital twin 8308 to inform that department of the total amount of authorized spending that is approved for that department for the specific marketing campaign.

In embodiments, a CMO digital twin 8308 may be configured to track and report on inbound and outbound billing (i.e., accounts receivable and payable) related to the marketing department. The billing department, personnel, processes and systems, including a Billing digital twin may interact with the CMO digital twin 8308 to present, store, analyze, reconcile and/or report on billing activities related to parties with whom the marketing department is contracting, such as ad agencies, ad networks, ad exchanges, content creators, advertisers, social media platforms, television, radio, online entities, or others.

In embodiments, a CMO digital twin 8308 may be configured to depict marketing campaign twins. In these embodiments, the CMO digital twin 8308 may depict various states and/or items relating to a marking campaign such as marketing content associated with a marketing campaign, market research performed with respect to a marketing campaign, tracking data of marketing content associated with marketing campaigns (e.g., geographic reach of marketing campaigns, demographic data associated with campaigns, etc.), analyses of marketing campaigns (e.g., outcomes related to marketing campaigns on various platforms), and the like. In some embodiments, a CMO digital twin may be configured to automatically report on marketing campaign-related activity via a user interface associated with the CMO digital twin 8308. Such activities may be determined using marketing department metadata that indicates state changes, such as an alteration to a website content, a change to a product photograph in an advertisement, a change in wording of a mailing, and the like. The CMO digital twin 8308 may also depict activity among a class of entities that are monitored or that are specified for monitoring in the CMO digital twin 8308, such as a new press release regarding a discounted advertising opportunity available from an ad exchange. In embodiments, a CMO digital twin 8308 may be configured to provide research, tracking, monitoring, and analyses of media content performance across various marketing related platforms, and automatically report on such activity to a user interface associated with the CMO digital twin 8308. Such platforms may include, but are not limited to, customer relationship platforms (CRMs), organization website(s), social media, blogs, press releases, mailings, in-store or other promotions, or some other type of marketing platform-related material or activity.

In some of these embodiments, the CMO digital twin 8308 may be configured to simulate marketing campaigns, such that the simulations of the marketing campaign may vary parameters such as vehicles (e.g., social media, television, billboards, print, etc.), budget, targeting parameters (e.g., geographic, demographic, or the like), and/or other suitable marketing campaign parameters. In these embodiments, the digital twin simulation system 8116 may receive a request to perform the simulation CMO digital twin, where the request indicates campaign features and the parameters that are to be varied. In response, the digital twin simulation 8116 may return the simulation results to the CMO digital twin 8308, which in turn outputs the results to the user via the client device display. In this way, the user is provided with various outcomes corresponding to different parameter configurations. In some embodiments, the user may select a parameter set based on the various outcomes. In some embodiments, an executive agent trained by the user may select the parameter sets based on the various outcomes.

In embodiments, a CMO digital twin 8308 may be configured to store, aggregate, merge, analyze, prepare, report and distribute material relating to a marketing strategy, plan, campaign or initiative. For example, the CMO digital twin 8308 may be associated with a plurality of databases or other repositories of marketing presentation materials, summaries and reports and analytics, including such presentation materials, summaries and reports and analytics related to prior marketing campaigns, each of which may be further associated with financial and performance metrics pertaining to the campaign and which are also accessible to the CMO digital twin 8308. Such historical marketing campaign material may consist of advertising, marketing or other content that may be categorized based in part on the financial and performance metrics with which it is associated. For example, there may be a first category called “Market Tested Content,” which consists of content that has been field deployed in a marketing campaign within a customer population, the actual performance of which is therefore fully known based on actual market testing. Because the marketing content from this category has been field tested, the content may be scored based at least in part on the financial, performance or other data with which it is associated. A second category may be “New Content—Simulation Tested,” which consists of content that has not been deployed in the field, but which has been subject to analytic testing such as simulated customer segmentation analysis, simulated A/B testing, simulated attribution modeling, simulated market mix modeling, machine learning, A.I. techniques including, but not limited to, classification, probabilistic modeling, learning techniques, and the like. Because the marketing content from this category has been simulation tested, the content may be scored based at least in part on the simulated performance data or other data with which it is associated. Continuing the example, a third category of content may be “New Content—Panel Tested,” which consists of content that has not been deployed in the field, nor simulation tested, but which has been subject to testing among a human panel for their views, opinions and impressions. Because the marketing content from this category has been human panel tested, the content may be scored based at least in part on the performance data, as reported by the human panel, or other data with which it is associated. A final, fourth category of content may be “New-Untested,” which is newly developed or other content that has not been tested in the field, in simulation, or by a human panel. The CMO digital twin 8308 may utilize the machine learning, A.I. and other analytic capabilities, as described herein, to analyze the content of the four categories of content and classify and score the content characteristics that are probabilistically associated with improved financial or other performance for stated types of marketing campaigns or marketing subject matter. Statistical weights may be applied to such characteristics, where the weight is indicative of a greater degree of financial or some performance metric of interest. Similarly, the characteristics of the market may be analyzed vis-a-vis the marketing content to determine the consumer characteristics that are probabilistically associated with improved financial or other performance for given marketing content. The CMO digital twin 8308 may provide a user interface within which access to this repository of stored data on content category, consumer and performance is available. When planning a marketing campaign, the CMO, or other marketing personnel, may use the CMO digital twin 8308 to select from this repository of content, that content which probabilistically will perform better with the intended consumer targets of the new campaign. For example, from historical marketing field tests from actual prior marketing campaigns, the data may show that marketing content having images of large dogs outperformed (based on, for example, ad conversion rates) content picturing small dogs, and this effect was positively correlated with age (i.e., older persons have an even greater preference for larger dogs). The performance data from the simulation-tested content may show a similar, but smaller effect based on the size of the dog images in the content, and the panel-tested data may show a similar effect for large dog imagery in content, but also have performance data indicating that the effect appears, based on the panel data, to be muted for persons 15 years or younger (i.e., young persons are more attracted to smaller dog breeds than older persons). For the CMO using the CMO digital twin 8308 this data, and the characteristics of the more successful content, may be used to select from the fourth category of content (“New-Untested”) that content that is most appropriate for a new marketing campaign intended to sell a soft drink. In embodiments, the artificial intelligence services system 8010 of the EMP 8000 may select the content and segment its presentation based at least in part on the prior performance data, so that the ads that are presented on platforms that tend to have persons over 15 will use content having a predominance of large breed dogs, and those platforms with younger audiences will offer a greater mix of dog breeds and possibly a preference for small breed dogs in marketing images. As the marketing campaign deployed to the field, the CMO digital twin 8308 may monitor, track and report on the marketing campaign's performance so that the CMO can review and intervene as necessary. Once the new content has been field tested it may be stored and classified in the first category of content, “Market Tested Content,” along with the related financial and performance metrics. In another example, similar stored content, content categories, characteristics and financial and performance metrics may be used by the CMO digital twin 8308 to recommend, for example, search engine optimization (SEO), or other marketing strategies and techniques.

In embodiments, a CMO digital twin 8308 may be configured to store, aggregate, merge, analyze, prepare, report and distribute material relating to market surveys, online surveys, customer panels, ratings, rankings, marketing trend data or other data related to marketing. A CMO digital twin 8308 may link to, interact with, and be associated with external data sources, and able to upload, download, aggregate external data sources, including with the EMP's internal data, and analyze such data, as described herein. Data analysis, machine learning, AI processing, and other analysis may be coordinated between the CMO digital twin 8308 and an analytics team based at least in part on using the artificial intelligence services system 8010. This cooperation and interaction may include assisting with seeding data elements and domains in the enterprise data store 8012 for use in modeling, machine learning, and AI processing to identify the optimal marketing content, sales channels, target consumers, price points, timing, or some other marketing-relating metric or aspect, as well as identification of the optimal data measurement parameters on which to base judgement of a marketing endeavor's success. Examples of data sources 8020 that may be connected to, associated with, and/or accessed from the CMO digital twin 8308 may include, but are not limited to, the sensor system 8022, the sales database 8024 that is updated with sales figures in real time, the CRM system 8026, the content marketing platform 8028, news websites, the financial database 8030 that tracks costs of the business, surveys 8032 (e.g., customer satisfaction surveys), an org chart 8034, a workflow management system 8036, customer databases 8040 that store customer data, and/or third-party data sources 8038 that store third-party data.

In embodiments, a CMO digital twin 8308 may be configured to assist in the development of a new marketing campaign. For example, the CMO digital twin 8308 may identify an internal and external partner team for a marketing campaign. For example, individuals who are ideal candidates to assist with a marketing campaign may be identified based at least in part on experience and expertise data that is stored within or in association with the CMO digital twin 8308. In another example, the CMO digital twin 8308 may identify marketing campaign goals and record, monitor and track the campaign's performance relative to those goals and present, in real-time, the tracking of the campaign to the CMO within a user interface that is associated with the CMO digital twin 8308. Examples of marketing targets include, but are not limited to, unit distribution, customer acquisition customer retention, customer churn, customer loyalty (e.g., repeat purchases), customer acquisition costs, duration of average sales cycle, ad conversion rate, sales growth, geographic expansion of sales, demographic expansion of sales, market penetration, percentage of market control, marketing campaign ROI, regional comparison of performance, channel analysis, sales partner analysis, marketing partner analysis, or some other marketing target.

In embodiments, a CMO digital twin 8308 may be configured to monitor customer feedback loops, customer opinions, customer satisfaction, complaints, product returns and the like based at least in part on use of the monitoring agent of the client application 8052, as described herein, that is associated with the CMO digital twin 8308. Such feedback data may include, but is not limited to, data that derives from call center activity, chatbot activity, email (e.g., complaints), product returns, Better Business Bureau submissions, or some other type of customer feedback or manifestation of customer opinion. The client application 8052 may include a monitoring agent that monitors the manner by which customers or others respond to a marketing campaign. The monitoring agent may report the customer's response to such campaigns to the EMP 8000 for presentation in a user interface that is associated with the CMO digital twin 8308. In response, the EMP 8000 may train an executive agent (which may include one or more machine-learned models) to handle and process such notifications when they next arrive, and escalate and/or alert the CMO when such notifications are of an urgent nature, for example, an announcement of a class action lawsuit related to a product that is the subject of a marketing campaign. In embodiments, the CMO digital twin 8308 may generate performance alerts based on performance trends. This may allow a CMO to optimize marketing campaigns in real-time without having to manually request such real-time performance data; the CMO digital twin 8308 may automatically present such information and related/necessary alerts as configured by the organization, CMO, or some other interested party.

In embodiments, a CMO digital twin 8308 may be configured to report on the performance of the marketing department, personnel of the marketing department, marketing campaigns, marketing content, marketing platforms, marketing partners, or some other aspect of management within a CMO's purview. Reporting may be to the CMO, the marketing department, to other executives of an organization (e.g., the CEO), or to outside third parties (e.g., marketing partners, press releases, and the like). As described herein, reporting may include sales summaries, customer data, marketing campaign performance metrics, cost-per-sale data, cost-per-conversion data, customer analysis, such as predicted customer lifetime value for newly acquired customers, or some other type of reporting data. Reporting and the content of reporting may be shared by the CMO digital twin 8308 with other executive digital twins, for example, data related to new customers having a particularly high predicted customer lifetime value may be shared with a sales staff for the purpose of exploring cross-selling opportunities. The reporting functionality of the CMO digital twin 8308 may also be used for populating required data for formal reporting requirements such as shareholder statements, annual reports, SEC filings, and the like. Templets of common reporting formats may be stored and associated with the CMO digital twin 8308 to automate the presentation of data and analytics according to pre-defined formats, styles and system requirements

In embodiments, a CMO digital twin 8308 may be configured to monitor, store, aggregate, merge, analyze, prepare, report and distribute material relating to competitors of a CMO's organization, or named entities of interest. In embodiments, such data may be collected by the EMP 8000 via data aggregation, spidering, web-scraping, or other techniques to search and collect competitor information from sources including, but not limited to, press releases, SEC or other financial reports, mergers and acquisitions activity, or some other publicly available data.

In embodiments, a CMO digital twin 8308 may be configured to monitor, store, aggregate, merge, analyze, prepare, report and distribute material relating to regulatory activity, such as government regulations, industry best practices or some other requirement or standard. For example, the marketing industry is subject to data privacy and security laws in many jurisdictions, and it is an area of law and regulation that is experiencing rapid change. In embodiments, the CMO digital twin 8308 may be in communication with another enterprise digital twin, such as a General Counsel digital twin 8314, through which the legal team can keep the CMO apprised of new regulation or regulation changes as they occur. Similarly, as a CMO develops new market campaigns and selects the jurisdictions (e.g., United States vs Europe) and populations that will be a part of the campaigns (e.g., minors vs. adults), the CMO digital twin 8308 may automatically send a synopsis of the aspects of the campaigns that are relevant for privacy law review so that the campaign may be vetted for legal and regulatory compliance prior to launch. In an example, such a marketing campaign synopsis might include a summary of the jurisdictions of the campaign, intended audience, means of obtaining consent, the type of consent to be obtained (e.g., opt-in, opt-out, passive), and so forth. Once approved and launched, as customer consents and other data privacy-related information is received by an organization, the CMO digital twin 8308 may facilitate the CMO tracking metrics, for example the percentage of customers choosing to opt-in to receive future marketing material (e.g., email solicitations). As the organization receives privacy related material it may store such information for future retrieval, summary, deletion or other activity, for example, in response to a data subject request from an EU citizen who has requested their data be deleted (i.e., exercising their “right to be forgotten”). In embodiments, the CMO digital twin 8308 may monitor, store, aggregate, merge, analyze, prepare, report and distribute material relating to what customer data is collected, the party responsible for its collection and storage, the location and duration of storage, and so forth. This data may be called forth by the CMO digital twin 8308, for example, in the event of a data breach. The CMO digital twin 8308 may be able to summarize, for example, a list of persons affected by the breach and the type of data that was breached and share this information with a Chief Privacy Officer (CPO), including sharing with the CPO digital twin.

In embodiments, the client application 8052 that executes the CMO digital twin 8308 may be configured with an executive agent that reports a CMO's behaviors and preferences (or other marketing personnel's behaviors and preferences) to the expert agent system 8008, as described herein, and the expert agent system 8008 may train the executive agent on how the CMO or other marketing personnel respond to certain situations and adjust its operation based at least in part on the data collection, analysis, machine learning and A.I. techniques, as described herein.

In embodiments, a Chief Technical officer (CTO) digital twin 8310 may be a digital twin configured for a CTO or other technology executive of an enterprise tasked with overseeing and managing the R&D, technology development, technical implementations of the enterprise, and/or engineering activities of the enterprise. In embodiments, the CTO digital twin 8310 provides real-time views of enterprise technology assets, including technology capabilities and versions. For example, in a manufacturing enterprise, a CTO digital twin 8310 may depict where environment-compatible updates, upgrades, or substitutions may be available. A CTO digital twin 8310 may provide data, analytics, summary, and/or technical reporting including, but not limited to, real-time, historical, aggregated, comparison, and/or forecasted technical information (e.g., real-time, historical, simulated, and/or forecasted technical performance data related to company products, benchmarking results, and the like). A CTO using by a CTO digital twin 8310 may be better able to stay abreast of technical developments and software engineering impacts by engaging in continuous virtualized learning using the CTO digital twin 8310. In embodiments, the CTO digital twin 8310 may assist in virtual collaboration (a CTO-essential skill), as a CTO will need to partner with in-house engineers and external vendors in a virtual environment to imagine and ideate to achieve something, often something that hasn't been done before. In embodiments, the CTO digital twin may work in connection with the EMP 8000 to provide simulations, predictions, statistical summaries, decision support based on analytics, machine learning, and/or other AI and learning-type processing of inputs (e.g., technical performance data, sensor data and the like).

In embodiments, the CTO digital twin 8310 may provide features and functionality including, but not limited to, management of technical personnel, partners and outside consultants and contractors (e.g., developers, beta testers, and the like), oversight of budgets, procurement, expenditures, policy compliance (e.g., policies related to code usage, storage, documentation, and the like), and other technology, development, and/or engineering-related resources, and/or reporting.

In embodiments, the types of data that may populate a CTO digital twin may include, but are not limited to, technology performance and specification data, interoperability and compatibility data, cybersecurity data, competitor data, failure mode effects analysis (FMEA) data, technology/engineering roadmap data, information technology systems data (including with respect to any of the hardware, software, networking, and other types mentioned or described herein), operations technology and systems data, uptime/downtime/operational performance data, asset aging/vintage/timing data, technical performance metrics by business unit, by product, by geography, by factory, by store location(s), resource utilization, competitive product and pricing data, forecast data, demand planning data, analytic results of AI and/or machine learning modeling (e.g., technical forecasting), prediction data, metrics relating to patent disclosures, patent filings, and/or patent grants, recommendation data, and/or other types of data relevant to the operations of the CTO and/or technology, development, and/or engineering department.

In embodiments, the CTO digital twin 8310 may depict a twin of a set of technology, development, and/or engineering departments, which the user may use to identify, assign, instruct, oversee and review technology, development, and/or engineering department personnel and third-party personnel that are associated with the technology, development, and/or engineering activities of an organization, including third-party partners and other outside contractors, such as third-party developers and/or testers that are involved in the organization's technology, development, and/or engineering activities. Examples of such organization personnel include, but are not limited to, technology, development, and/or engineering department staff, sales staff and analysts, statisticians, data scientists, or some other type of organization personnel relevant to the functioning of a technology, development, and/or engineering department. Examples of a technology, development, and/or engineering department's third-party personnel include, but are not limited to, management consultants, developers, software engineers, testers, and/or engineering partners, consultants, contractors, technical firm staff, auditors, or some other type of third-party personnel.

In embodiments, the CTO digital twin 8310 may include a definition of the various roles/employees working under the CTO, the reporting structure, and associated permissions, for each individual in the business unit, and may be populated with the various names and/or other identifiers of the individuals filling the respective roles.

In embodiments, the client application 8052 executing a CTO digital twin 8310 may interface with the collaboration suite 8006 to specify and provide a set of collaboration tools that may be leveraged by the technology, development, and/or engineering department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein. Collaboration and communication tools and associated rules may be configured to use company-, industry- and domain-specific taxonomies and lexicons when representing entities, states and flows within the CTO digital twin 8310.

In embodiments, the CTO digital twin 8310 may be configured to allow a user to research, create, track and report on a technology, development, and/or technology or engineering department initiative including, but not limited to, a new product development, update, enhancement, replacement, upgrade, or the like. In embodiments, the CTO digital twin 8310 may be associated and/or in communication with databases, including databases storing analytic and/or product data and product performance data, and present information to an interface associated with the CTO digital twin 8310, as described herein. As product development advances, real time operations and other technical information may be used to continuously update the product development summary that is available for the CTO or other technical personnel to review. The CTO digital twin 8310 may also be associated and/or in communication with databases, including databases storing analytic and/or competitive product data and product performance data, and present this information to an interface associated with the CTO digital twin 8310, as described herein. As the CTO's company's products change, and competitor products change, their current state and specifications may be presented by the CTO digital twin 8310 for the CTO or other technical personnel to review direct product comparisons. Such comparisons may be used, in part, to produce analytics, scores, reports and the like indicating the relative advantages and/or disadvantages that a company's product(s) has relative to competitor product(s). In an example, a report may be automatically provided to the marketing department to emphasize the relative advantages that a company product has over a competitor product (e.g., speed of processing) that should be used in a new marketing campaign. Sharing with the marketing department may be accomplished, in part, by the CTO digital twin 8310 communicating with the CMO digital twin 8308 to present reports or other information to the CMO or marketing staff.

In embodiments, the CTO digital twin 8310 may be configured to present simulations of technology development and/or engineering activities. For example, in some embodiments, the digital twin system 8004 may simulate product usage under a plurality of constraints that might impact product performance, such as an operating environment, processing speed, storage or other platform characteristics. In embodiments, real time operations data, such as operations data available through the EMP 100, may be incorporated into simulated data for the purposes of running operational simulations. This may allow a CTO to a gain a deeper understanding of the operation of the company's products in the real world and within an altered, simulated real world environment. It may also allow operational digital twin-based product architectures to be built that link actual product production with business priorities to enable simulated decision making in a virtual environment and assist in the evaluation of vendor supplied solutions by enabling the review of such digital twins in the context of their supplied solutions and the relationship to the business. In embodiments, simulations may also include simulations related to varying technical and/or product specification parameters, product design and monitoring, internal controls design, testing, certification, and deliver technical and non-technical data in reports, presentations, and dashboards for technical decision making. In these embodiments, the digital twin simulation system 8116 may receive a request to perform the simulation requested by the CTO digital twin 8310, where the request indicates features and the parameters, including technical parameters, that are to be varied. In response, the digital twin simulation system 81D16 may return the simulation results to the CTO digital twin 8310, which in turn outputs the results to the user via the client device display. In this way, the user is provided with various outcomes corresponding to different technical and/or product parameter configurations. In some embodiments, the user may select a parameter set based on the various outcomes. In some embodiments, an executive agent trained by the user may select a technical parameter set based on the various outcomes. The simulations, analytics and/or modeling performed by the CTO digital twin 8310 may be used to reduce testing time, design time, or some other type of technical cost. The simulations, analytics and/or modeling performed by the CTO digital twin 8310 may be used to create and structure product development and testing plans. The simulations, analytics and/or modeling performed by the CTO digital twin 8310 may be used to evaluate product go-to-market timing and preparedness. The CTO equipped with a CTO digital twin 8310 will be better able to adapt quickly to identify product and/or technical parameters in need of further development and predict products' operational performance. This may reduce errors, speed testing and reduce the need for patches, bug fixes, updates and the like and flatten agile process management.

In embodiments, the CTO digital twin 8310 may provide an interface that allows a user to research, create, track and report on a technology, development, and/or engineering department initiative including, but not limited to, an overall department budget, a budget for a single or group of technology, development, and/or engineering initiatives, a third-party vendor activity, or some other type of expense or budget. The CTO digital twin 8310 may interact with and share such expense or budget data and reporting with other executive twins, including, but not limited to, a digital twin related to accounts payable, executive staff such as the CEO, and/or others.

In embodiments, the CTO digital twin 8310 may leverage the artificial intelligence services system 8010 (e.g., data analytics, machine learning and A.I. processes) to read technical reports, projections, simulations, and related summaries and data in order to identify key departments, personnel, third-party or others that are, for example, listed in, or subject to, a technical item or detail provided.

In embodiments, the CTO digital twin 8310 may be configured to provide a CTO, or other technology, development, and/or engineering department personnel, with information that is unique to the CTO digital twin 8310 and thus can provide insights and perspectives on technical performance that are unique to the CTO digital twin 8310, based at least in part on the CTO digital twin 8310 make making use of real time production, development and operational data based on both real world and simulated activity.

In embodiments, the CTO digital twin 8310 may be configured to manage operational planning, based at least in part by leveraging predictive analytics for development planning, and supply chain management in order to increase company efficacy while optimizing operating expenses. In embodiments, the CTO digital twin 8310 may be configured to obtain and depict oversight activity that includes, but is not limited to, internal controls design, testing, and reporting while directing listed actions the appropriate personnel.

In embodiments, the CTO digital twin 8310 may be configured to depict, aggregate, merge, analyze, prepare, report and distribute material relating to a technical strategy, plan, activity or initiative. For example, the CTO digital twin 8310 may be associated with a plurality of databases or other repositories of technical materials, summaries and reports and analytics, including such materials, summaries and reports and analytics related to prior technical activity and results (e.g., bug testing), each of which may be further associated with third-party technical or economic data, including competitor product data and/or technical benchmarks.

In embodiments, the CTO digital twin 8310 may be configured to depict, aggregate, merge, analyze, prepare, report and distribute material relating to technical reporting, ratings, rankings, technical trend data, or other data related to company technology, development, and/or engineering. A CTO digital twin 8310 may link to, interact with, and be associated with external data sources, and able to upload, download, aggregate external data sources, including with the EMP's internal data, and analyze such data, as described herein. Data analysis, machine learning, AI processing, and other analysis may be coordinated between the CTO digital twin 8310 and an analytics team based at least in part on using the intelligence services system 8010. This cooperation and interaction may include assisting with seeding technology, development, and/or engineering-related data elements and domains in the enterprise data store 8012 for use in modeling, machine learning, and AI processing to identify the optimal technical strategy, or some other technology, development, and/or engineering-relating metric or aspect, as well as identification of the optimal data measurement parameters on which to base judgement of a technology initiative, development initiative, and/or engineering endeavor's success. Examples of data sources 8020 that may be connected to, associated with, and/or accessed from the CTO digital twin 8310 may include, but are not limited to, the sensor system 8022, the sales database 8024 that is updated with sales figures in real time, a technology, development, and/or engineering platform, news websites 8048, a technical database that tracks costs of the business, an org chart 8034, a workflow management system 8036, customer databases 8040 that store customer data, and/or third-party data sources 8038 that store third-party data.

In embodiments, the CTO digital twin 8310 may aggregate data sources and types, creating new data types, summaries and reports that are not available elsewhere. This may reduce reliance upon the need of multiple third-party providers and current solutions. This may, among other benefits and improvements, reduce expenses associated with acquiring data needed for sound technical decision making.

In embodiments, the CTO digital twin 8310 may be configured to monitor technical performance, including real time monitoring, based at least in part on use of the monitoring agent of the client application 8052, as described herein, that is associated with the CTO digital twin 8310. The monitoring agent may report on such activities to the EMP 8000 for presentation in a user interface that is associated with the CTO digital twin 8310. In response, the EMP 8000 may train an executive agent (which may include one or more machine-learned models) to handle and process such notifications when they next arrive, and escalate and/or alert the CTO when such notifications are of an urgent nature, for example, an identification of a new technical bug or a security patch that is urgently needed. In embodiments, the CTO digital twin 8310 may generate technical performance alerts based on performance trends. This may allow a CTO to optimize initiatives in real-time without having to manually request such real-time technical performance data; the CTO digital twin 8310 may automatically present such information and related/necessary alerts as configured by the organization, CTO, or some other interested party.

In embodiments, the CTO digital twin 8310 may be configured to report on the performance of the technology, development, and/or engineering department, personnel of the technology, development, and/or engineering department, technology, development, and/or engineering activities, technology, development, and/or engineering content, technology, development, and/or engineering platforms, technology, development, and/or engineering partners, or some other aspect of management within a CTO's responsibilities. Reporting may be to the CEO, the technology, development, and/or engineering department, to other executives of an organization (e.g., the CIO), or to outside third parties.

In embodiments, the CTO digital twin 8310 may be configured to monitor, store, aggregate, merge, analyze, prepare, report and distribute material relating to industry best practices, benchmarks, or some other requirement or standard. For example, the CTO digital twin 8310 may be in communication with another enterprise digital twin, such as a CIO digital twin 8312, through which the technical team can keep the CIO apprised of changes as they occur.

In embodiments, the client application 8052 that executes the CTO digital twin 8310 may be configured with an executive agent that reports a CTO's behaviors and preferences (or other technology, development, and/or engineering personnel's behaviors and preferences) to the executive agent system 8008, as described herein, and the executive agent system 8008 may train the executive agent on how the CTO or other technology, development, and/or engineering personnel respond to certain situations and adjust its operation based at least in part on the data collection, analysis, machine learning and A.I. techniques, as described herein.

References to features and functions of the EMP and digital twins in this example of the CTO digital twin 8310 should be understood to apply to other departments and digital twins, and their respective projects and workflows, except where context indicates otherwise.

In embodiments, a Chief Information Officer (CIO) digital twin 8312 may be a digital twin configured for the CIO of an enterprise, or analogous executive tasked with overseeing the intelligence, information, data, knowledge, and/or IT operations of the enterprise. In embodiments, a CIO digital twin 8312 depicts a real time representation of an organization's information assets and workflows including data relating to data security, network security and enterprise knowledge. The real time representation may be based at least in part on real-time operations data that tracks the performance of an organization's information infrastructure, including internal information assets, customer-facing technologies, and information assets provided and/or serviced by third parties, such as cloud computing service providers. For example, a CIO digital twin 8312 may receive real time information regarding the performance of a network, such as an intranet used by an organization, APIs that are accessed by the enterprise, APIs that are exposed by the enterprise, software that is running on the enterprises software, or the like. The information may be aggregated and presented to a CIO in order to provide him an overview of the general performance of the computing infrastructure of the enterprise. For example, the CIO digital twin may indicate whether there are any network outages occurring, whether there are any security risks detected in the enterprises network, whether any software systems are operating improperly, and may other scenarios. In embodiments, the CIO digital twin 8312 may present a user interface that allows a user (e.g., the CIO) to select particular network assets to review in greater detail, such as an asset the real time operations data indicates is experiencing an operational failure or other issue. Such real time operations data related to IT and other information asset performance may allow the CIO to better track the performance and needs of an organization's information and IT infrastructure and better enable him to troubleshoot issues, simulate solutions, select appropriate information and IT management actions, and maintain the organization's information and IT infrastructure.

In embodiments, a CIO digital twin 8312 may provide data, analytics, summary, and/or information and IT reporting including, but not limited to, real-time, historical, aggregated, comparison, and/or forecasted information (e.g., real-time, historical, simulated, and/or forecasted performance data related to company information and IT assets, third-party assets, and the like). A CIO empowered by a CIO digital twin 8312 may be better able to maintain and evolve information and IT assets through continuous monitoring using the CIO digital twin 8312. A CIO digital twin 8312 may assist in virtual monitoring and testing in a virtual environment to test implementations, changes, reconfigurations, the introduction and/or removal of components and other assets, and the like. In embodiments, the CIO digital twin may work in connection with the EMP 8000 to provide simulations, predictions, statistical summaries, decision support based on analytics, machine learning, and/or other AI and learning-type processing of inputs (e.g., performance data, sensor data, and the like).

In embodiments, the types of data that may populate a CIO digital twin 8312 may include, but are not limited to, information and IT asset performance and specification data, interoperability and compatibility data, cybersecurity data, uptime/downtime/operational performance data, asset aging/vintage/timing data, resource utilization, results of AI and/or machine learning modeling (e.g., IT performance simulations), or some other type of data relevant to the operations of the CIO.

In embodiments, a CIO digital twin 8312 may be configured to interface with the collaboration suite 8006 to specify and provide a set of collaboration tools that may be leveraged by the technology, development, and/or engineering department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein. Collaboration and communication tools and associated rules may be configured to use company-, industry- and domain-specific taxonomies and lexicons when representing entities, states and flows within the CIO digital twin 8312.

In embodiments, the CIO digital twin 8312 may be configured to provide simulations of an organization's information and IT activities including, but not limited to network utilization, disaster planning, IT asset selection, maintenance protocols, downtime planning, and the like that is simulated under a plurality of hypothetical IT environments and scenarios that might impact performance, such as a security breach, IT asset failure, information failure, network congestion, or other activity or event. Real time operations data, such as that available through the EMP, as described herein, may be incorporated into simulated information or IT Infrastructure scenarios for the purposes of running operational simulations. The simulations, analytics and/or modeling performed by the EMP 100 with respect to a CIO digital twin 8312 may be used to reduce testing time, design time, or some other type of IT cost. The simulations, analytics and/or modeling performed by the CIO digital twin 8312 may be used to create and structure IT assets, networks, and guide development and testing plans. The simulations, analytics and/or modeling performed by the CIO digital twin 8312 may be used to evaluate network security, performance, and other features. The CIO equipped with digital twin 8312 may quickly identify optimal asset configurations to maximize operational performance.

In embodiments, a CIO digital twin 8312 may be configured to provide a user (e.g., the CIO) with information that is unique to the CIO digital twin 8312 and thus can provide insights and perspectives on information and IT asset performance that are unique to the CIO digital twin 8312, based at least in part on the CIO digital twin 8312 make making use of real time production, development and operational data based on both real world and simulated activity. In embodiments, the CIO digital twin 8312 may be configured to manage operational planning, based at least in part by leveraging predictive analytics for development planning. In embodiments, a CIO digital twin 8312 may be configured to store, aggregate, merge, analyze, prepare, report and distribute material relating to an information and/or IT strategy, scenario, event, plan, activity or initiative. For example, the CIO digital twin 8312 may be associated with a plurality of databases or other repositories of information, materials, summaries and reports and analytics, including such materials, summaries and reports and analytics related to prior events, activity and results (e.g., a system outage).

In embodiments, a CIO digital twin 8312 may be configured to store, aggregate, merge, analyze, prepare, report and distribute material relating to information and/or IT reporting, ratings, rankings, information, knowledge and IT trend data, or other data related to company information and/or IT assets and infrastructure. A CIO digital twin 8312 may link to, interact with, and be associated with external data sources, such that the CIO digital twin 8312 may upload, download, aggregate external data sources, and/or analyze such enterprise data.

In embodiments, a CIO digital twin 8312 may be configured to monitor IT performance, including in real time, based at least in part on use of the monitoring agent of the client application 8052, as described herein, that is associated with the CIO digital twin 8312. The monitoring agent may report on such activities to the EMP 8000 for presentation in a user interface that is associated with the CIO digital twin 8312. In response, the EMP 8000 may train an executive agent (which may include one or more machine-learned models) to handle and process such notifications when they next arrive and escalate and/or alert the CIO when such notifications are urgent.

In embodiments, a CIO digital twin 8312 may be configured to report on the performance of an organization's IT assets, network, or some other aspect of management within a CIO's responsibilities. In embodiments, the client application 8052 that executes the CIO digital twin 8312 may be configured with an executive agent that reports a CIO's behaviors and preferences to the executive agent system 8008, and the executive agent system 8008 may train the executive agent on how the CIO or other personnel respond to certain IT situations and adjust its operation based at least in part on the data collection, analysis, machine learning and A.I. techniques described throughout the disclosure.

References to features and functions of the EMP and digital twins in this example of a marketing department and a CIO digital twin 8312 should be understood to apply to other departments and digital twins, and their respective projects and workflows, except where context indicates otherwise.

In embodiments, a general counsel (GC) digital twin 8314 may be an executive digital twin configured for the general counsel (GC) of an enterprise, or an analogous executive tasked with overseeing the legal department and/or outside counsel of the enterprise. A GC digital twin 8314 may provide functionality including, but not limited to, management of legal personnel, partners and outside counsel, oversight of legal budgets and resources, compliance, management of contracting and litigation, management of internal policies, intellectual property, employment law, tax law, privacy law, reporting, and regulatory analysis.

In embodiments, the types of data that may populate and/or be utilized by a GC digital twin 8314 may include, but are not limited to, budgetary data (e.g., external legal spend, internal legal spend, ancillary legal costs, and the like), regulatory data (e.g., regulatory requirements, regulatory actions taken, and the like); contract and licensing data (e.g., in progress negotiations, current contract obligations, past contract obligations, and the like); compliance data (e.g., compliance requirements, compliance actions taken, and the like, litigation data (e.g., potential litigations sources, pending litigations, past litigations, settlement agreements, and the like), employment data (e.g., employment contracts, employee complaints, employee stock options, and the like), intellectual property data (e.g., filed patent applications, patent dockets, issued patents, trademark applications, trademark docket data, registered trademarks, and the like), tax data, privacy data, regulatory data, analytic results of AI and/or machine learning modeling; prediction data; recommendation data, or some other type of data relevant to the operations of the GC and/or legal department.

In embodiments, a GC digital twin 8314 may be configured based at least in part on using the collaboration suite 8006 to specify and provide a set of collaboration tools that may be leveraged by the legal department and associated parties. The collaboration tools may include video conferencing tools, “in-twin” collaboration tools, whiteboard tools, presentation tools, word processing tools, spreadsheet tools, and the like, as described herein. Collaboration and communication rules may be configured based at least in part on using the AI reporting tool, as described herein. Collaboration and communication tools and associated rules may be configured to use company-, industry- and domain-specific taxonomies and lexicons when representing entities, states and flows within the GC digital twin 8314, such as ones related to particular bodies of law, regulation, jurisdiction, or practice area, such as ones related to corporate law, commercial law, bankruptcy law, the law of secured transactions, banking law, customs law, export control regulations, maritime law, trade law, international treaties, securities law, contracts law, environmental law, international law, privacy law, data privacy law, patent law, civil and criminal procedure, trademark law, copyright law, trade secret law, unfair competition law, law of torts, property law, advertising law, and many others.

In embodiments, a GC digital twin 8314 may be configured to research, create, track and issue reports on a legal department budget including, but not limited to, an overall department budget, a budget for a specific project, such as “U.S. patent filings,” or group of projects, a budget for a specific litigation, a budget for a third-party vendor, such as outside counsel, or some other type of legal budget. A GC digital twin 8314 may be configured to create, track, provide research, and report on financial data related to material under review or supervisions of the legal department including, but not limited to, licensing revenues, licensing expenditures, or some other type of financial data related to legal department review and responsibilities. In embodiments, he GC digital twin 8314 may interact with and share such licensing revenue and/or budget data and reporting with other executive twins, as described herein, including, but not limited to, a CFO digital twin 8304, CEO digital twin, COO digital twin, CTO digital twin, and the like. In embodiments, the GC digital twin 8314 may include intelligence, based at least in part on the data analytics, machine learning and A.I. processes, as described herein, to read legal contracts, licenses, budgets and related summaries and data in order to identify key departments, personnel, third-party or others that are, for example, listed in, or subject to, or impacted by a license and/or budget line item and who therefore may have an interest in such material. License and/or budget material pertaining to a given party may be abstracted and summarized for presentation independent from the entirety of the budget, and formatted and presented automatically, or at the direction of a user, to the party that is the subject of the budget item. In a simplified example, a GC may have license(s) under her department's review which have line items, schedules, appendices and the like detailing licensing revenues that will be owed to the organization over a prescribed timeframe. The GC may use the GC digital twin 8314 to consolidate, summarize and/or share such financial data derived, or to be derived, from licensing revenues with another executive in an organization, such as the CFO (e.g., via a CFO digital twin) and/or CEO (e.g., via a CEO digital twin). The data shared may indicate the licensing revenues to be obtained in a given financial quarter to assist the CFO and others in maintaining an accurate and current summary of projected quarterly revenues.

In embodiments, a GC digital twin 8314 may be configured to track and report on inbound (e.g., settlement or litigation revenue) and outbound billing (e.g., outside counsel costs) related to the legal department. The billing department, personnel, processes and systems may interact with the GC digital twin 8314 to present, store, analyze, reconcile and/or report on billing activities related to parties with whom the legal department is contracting, such as outside counsel, consultants, research services, online entities, or others. In embodiments, a GC digital twin 8314 may be configured to research, track, monitor, store, analyze, create and distribute legal content, and automatically report on such activity to a user interface associated with the GC digital twin 8314. Such activities might include storing data so that the GC digital twin 8314 may detect a state change, for example, a new court filing in a litigation, a communication received from outside counsel, a new license draft from opposing counsel, a draft patent application, a notice from the United States Patent and Trademark Office, or some other type of new or updated material. The GC digital twin 8314 may also detect activity among a class of entities that are monitored or that are specified for monitoring in the GC digital twin 8314, such as particular courts, regulatory or legislative bodies or some other type of entity. In embodiments, a GC digital twin 8314 may be configured to research, track, monitor, store, and analyze content of various legal related platforms, and automatically report on such activity to a user interface associated with the GC digital twin 8314. Such platforms may include, but are not limited to, bar or other legal associations, courts, legal search platforms, social media, legal blogs, press releases, or some other type of legal platform-related material or activity.

In embodiments, a GC digital twin 8314 may be configured to store, aggregate, merge, analyze, prepare, report and distribute material relating to a legal strategy, legal documents, litigation, legal recommendations or some other legal activity. For example, the GC digital twin 8314 may be associated with a plurality of databases or other repositories of legal materials, contracts, licenses, intellectual property (e.g., patent filings), summaries and reports and analytics. A GC digital twin 8314 may link to, interact with, and be associated with external data sources, and able to upload, download, aggregate external data sources, including with the EMP's internal data, and analyze such data, as described herein. Data analysis, machine learning, AI processing, and other analysis may be coordinated between the GC digital twin 8314 and an analytics team based at least in part on using the intelligence services system 8010. This cooperation and interaction may include assisting with seeding data elements and domains in the enterprise data store 8012 for use in modeling, machine learning, and AI processing to identify the optimal and/or relevant legal content, legal documents, parties associated with a legal activity (e.g., a litigation), as well as identification of the optimal data measurement parameters on which to base judgement of a legal endeavor's success (e.g., licensing revenue, staying within a stated budget for the use of outside counsel, and the like). Examples of data sources 8020 that may be connected to, associated with, and/or accessed from the GC digital twin 8314 may include, but are not limited to, a legal research platform, legal websites, news websites 8048, the financial database 8030, contracts database, an HR database 8046, a workflow management system 8036, and/or third-party data sources 8038 that store third-party data.

In embodiments, a GC digital twin 8314 may be configured to assist in the development of a new legal endeavor, such as pursuit of a new contract, review of a new law or regulation impacting a business, litigation or arbitration, or some other legal activity. For example, the GC digital twin 8314 may identify an internal and external partner (e.g., outside counsel) team for a legal action. For example, individuals who are ideal candidates to assist with a legal action may be identified based at least in part on experience and expertise data that is stored within or in association with the GC digital twin 8314. For example, the GC may be initiating negotiations of a joint development agreement between entities that are located in the United States and Taiwan and may need to obtain outside Taiwanese counsel. Using the GC digital twin 8314, the GC may be presented with details of prior outside counsel used in Taiwan for similar projects. In another example, if the GC digital twin 8314 does not locate details of prior outside counsel used in Taiwan for similar projects, the GC digital twin 8314 may scan, research, collect and summarize information from public or other sources on highly rated, recommended or other Taiwanese outside counsel that may be appropriate, based on skills, experience and the like, to work on the joint development agreement project.

In embodiments, the GC digital twin 8314 may identify legal project goals and record, monitor and track the project's performance relative to those goals and present, in real-time, the tracking of the project to the GC within a user interface that is associated with the GC digital twin 8314. For example, the GC digital twin 8314 may include a clickable dashboard that, when clicked, illustrates the status of a set of legal projects. In some embodiments, the dashboard may include timelines for each project and a relative status of each project with respect to its timeline.

In embodiments, a GC digital twin 8314 may be configured to report on the performance of the legal department, personnel of the legal department, legal actions, legal content, legal platforms, legal partners, or some other aspect of a GC's management. Reporting may be to the GC, the legal department, to other executives of an organization (e.g., the CEO), or to outside third parties (e.g., outside counsel, legal notices, press releases, and the like). Reporting and the content of reporting may be shared by the GC digital twin 8314 with other executive digital twins, for example, data related to regulation compliance, ongoing litigation, or some other legal activity. The reporting functionality of the GC digital twin 8314 may also be used for populating required data for formal reporting requirements such as shareholder statements, annual reports, SEC filings, and the like. Templates of common reporting formats may be stored and associated with the GC digital twin 8314 to automate the presentation of data and analytics according to pre-defined formats, styles and system requirements. In some embodiments, the GC digital twin may be configured to leverage an executive agent 8364 trained on behalf of the GC to create and disseminate the reports.

In embodiments, a GC digital twin 8314 may be configured to monitor, store, aggregate, merge, analyze, prepare, report and distribute material relating to regulatory activity, such as government regulations, regulatory compliance, legislation, court opinions, industry best practices or some other requirement or standard. For example, the GC digital twin 8314 may keep the GC apprised of new regulation or regulation changes as they occur. The GC may set parameters of the GC digital twin 8314 regarding the legal domains, subject matter areas, jurisdictions, or some other parameter, that are of interest to the GC that the GC digital twin 8314 should monitor.

In embodiments, a GC digital twin 8314 may leverage an executive agent 8364 that is trained on user's (e.g., GC) behaviors and preferences (or other legal personnel's behaviors and preferences). In embodiments, the client application 8052 hosting the GC digital twin 8314 may track the user's actions relating to various events, notifications, alerts, or the like and may report the tracked events using the expert agent system 8008, as described herein. In response, the expert agent system 8008 may learn how the GC or other legal personnel respond to certain situations and may train an execute agent 8364 on behalf of the user (e.g., GC), such that the executive agent 8364 may respond to similar situations once deployed.

References to features and functions of the EMP and digital twins in this example of a legal department and a GC digital twin 8314 should be understood to apply to other departments and digital twins, and their respective projects and workflows, except where context indicates otherwise.

In embodiments, a Chief Human Resources Officer (CHRO) digital twin 8316 (or HR digital twin 8316) is an executive digital twin configured for a human resources executive (e.g., a CHRO) of an enterprise or analogous executive tasked with overseeing the human resources HR aspects of the enterprise, such as a Chief People Officer (CPO), a chief talent officer, a head of human resources, a director of human resources, or the like. In embodiments, the CHRO digital twin 8316 may depict different HR-related states of the enterprise, such as states relating to human capital management, workforce management, risk management, and the management of payroll, recruitment, regulatory compliance, employee performance, benefits, employee relations, time and attendance, training and development, compensation, onboarding, offboarding, succession planning, and the like. In embodiments, the CHRO digital twin 8316 may initially depict the various states at a lower granularity level. A user that is viewing the CHRO digital twin 8316 may select a state to drill down into the selected state and view the selected state at a higher level of granularity.

In embodiments, the types of data that may be depicted in CHRO digital twin 8316 may include, but are not limited to: individual employee data, key performance indicators by business unit, key performance indicators by individual employee, risk management data, regulatory compliance data (e.g., OSHA and EPA compliance data), safety data, diversity data, benefits data (e.g., medical, dental, vision, and health savings accounts (HSA)) compensation data, compensation comparison data, compensation trend data, payroll data, overtime data, recruitment data, employee referrals data, applicant data, applicant screening data, applicant reference data, applicant background check data, offer data, time and attendance data, employee relations data, employee complaints data, onboarding data, offboarding data, employee training and development data, employee turnover rate data, voluntary employee turnover rate data, new hire turnover rate data, high performer turnover rate data, turnover rate by performance rating data, headcount and/or headcount planning data (e.g., headcount to plan percentage), promotion rate data, succession plan data, organizational levels data, span of control data, employee survey data, cost to move employees below midpoint data, comparative ratio data, simulation data, decision support data from AI and/or machine learning systems, prediction data from AI and/or machine learning systems, classification data from AI and/or machine learning systems, detection and/or identification data from AI and/or machine learning systems, and the like.

In embodiments, a CHRO digital twin 8316 may depict a data item with an icon indicating whether the data item is at a normal state, a suboptimal state, a critical state, or an alarm state. In embodiments, the icons may be different colors, fonts, symbols, codes or the like. For example, a CHRO digital twin 8316 may depict high performer turnover rate data with an orange icon indicating that the high performer turnover rate is at a critical level. Continuing the example, an HR executive may be enabled to escalate the high performer turnover rate data to another executive, such as the CEO, via the CHRO digital twin 8316. In embodiments, a CHRO digital twin 8316 may automatically highlight data items that are at suboptimal, critical, or alarm state.

In embodiments, a CHRO digital twin 8316 may be configured to provide an “in-twin” collaboration suite having tools that may facilitate communication and collaboration between enterprise stakeholders. In embodiments, the “in-twin” collaboration tools may include an interface enabling a user to escalate and/or deescalate data sets to another user associated with the enterprise. In embodiments, the interface may be configured to enable a user to send a message with the data set, generate a request or assign a task related to the data set, and/or schedule an event associated with the data set. In embodiments, AI and/or machine learning could be leveraged to suggest message content, suggest event scheduling, suggest a request or task, and/or suggest a request or task assignee. For example, an HR executive could escalate a data set related to employee training to the GC with a predictive text message about employee training and a calendar request at a time determined by AI and/or machine learning to attend a meeting related to employee training. In embodiments, the “in twin” collaboration tools include digital twin conferences. In embodiments, the “in twin” collaboration tools may include an “in-twin” messaging system and/or an “in-twin” video conferencing system for enabling enterprise stakeholders to communicate. In embodiments, a machine learning and/or AI system may be leveraged for automatically generating and/or assigning tasks from these communications. In embodiments, the “in-twin” videoconferencing system supports subchats. In embodiments, the subchats may be created via a “drag-and-drop” action in the user interface. In embodiments, the “in-twin” videoconferencing system may leverage machine learning and/or AI to make suggestions to optimize a user's lighting, audio, camera placement, and the like. In embodiments, the “in twin” videoconferencing system leverages machine learning and/or AI to automatically disable the video feed upon the detection of an inappropriate activity in the video feed. In embodiments, the “in twin” collaboration suite includes an “in-twin” stakeholder approval system for collecting approval on actions from other enterprise stakeholders. In embodiments, “in-twin” collaboration tools may include an AI-driven translation system configured to intelligently translate communications amongst enterprise stakeholders to achieve maximum understanding by the user of the digital twin, wherein the AI driven translation system is configured to translate from a first language to a second language (e.g., translate English into a foreign language) and is also configured to translate terminology or jargon such that it is consumable by the user. These features described in connection with the CHRO digital twin 8316 may be deployed with other types of digital twins described herein, including ones for other executives, including to facilitate collaboration among different types of executives, such as for enterprise control tower activities, such as monitoring operations, development activities, or other aspects of the enterprise across locations, departments, and functions. Collaboration and communication tools and associated rules may be configured to use company-, industry- and domain-specific taxonomies and lexicons when representing entities, states and flows within the CHRO digital twin 8316, such as ones relating to health and safety of workers, ones related to education and training, ones related to performance indicators, ones related to worker attributes (including psychographic, demographic and similar factors), and many others.

In embodiments, a CHRO digital twin 8316 may be configured to identify, interview, select, hire, and onboard new employees. In some of these embodiments, the CHRO digital twin 8316 may be configured to research, track, and report on applicant data, including, but not limited to, employee referral data, applicant education data, applicant testing data, applicant experience data, applicant reference data, applicant screening data, applicant background check data, applicant interview data, job application data, applicant resume data, applicant cover letters, applicant offer data, and the like. The CHRO digital twin 8316 may interact with and share such applicant data and reporting with other executive digital twins, as described herein. The CHRO digital twin 8316 may include machine learning, AI, and/or other intelligence such as analytics, to process job applications, resumes, cover letters, applicant reference materials, applicant screening data, applicant interview data, and the like in order to identify and select potential new employees and/or to identify other executives or enterprise stakeholders that may be interested in such information.

In embodiments, the EMP 8000 may obtain HR-relevant data from the enterprise's human resources management software (e.g., via an API), human capital software, workforce management software, payroll software, applicant tracking software, accounting software, employee applicant software, publicly disclosed financial statements, third-party reports, tax filings, social media software, job listing websites, recruitment software, and the like.

In embodiments, a CHRO digital twin 8316 may provide an interface for an HR executive to perform one or more HR-related workflows. For example, the CHRO digital twin 8316 may provide an interface for an HR-executive to perform, supervise, or monitor workflows, the entities involved in the workflows, and attributes thereof, such as onboarding workflows, offboarding workflows, dismissal workflows, decision documentation workflows, succession planning workflows, candidate assessment workflows, candidate screening workflows, compliance workflows, disciplinary workflows, review workflows, interview workflows, offer workflows, employee training workflows, and many others.

In embodiments, a CHRO digital twin 8316 may leverage an executive agent 8364 that is trained on a user's (e.g., an HR executive's) actions (e.g., behaviors, responses, interactions and preferences) using the expert agent system 8008 in response to events and situations encountered by the user (e.g., alerts, notifications, escalations, delegations, presentations of data, events, and the like). In some of these embodiments, the client application 8052 hosting the CHRO digital twin 8316 may report actions taken by the user in response to various events encountered by the user via the CHRO digital twin 8316. For example, the client application 8052 may identify events such as a request to authorize a new hire, a request to terminate an employee, or a notification indicating that employee turnover has reached a critical threshold. In this example, the client application 8052 may record and report the actions taken by the user in response to such events and may report the actions in relation to the identified events to the expert agent system 8008, as well as any other features that are relevant to the event. In response, the expert agent system 8008 may train an executive agent 8364 on behalf of the user, such that the executive agent may perform or recommend actions to the user when similar events are encountered in the future.

References to features and functions of the EMP and digital twins in this example of a human resources department and a CHRO digital twin 8316 should be understood to apply to other departments and digital twins, and their respective projects and workflows, except where context indicates otherwise.

In embodiments, the executive digital twins may link to, interact with, integrate with and/or be used by a number of different applications. For example, the executive digital twins may be used in automated AI-reporting tools 8360, collaboration tools 8362, in connection with executive agents 8364, in board meeting tools 8366, for training modules 8368, and for planning tools 8370.

In embodiments, AI reporting tools 8360 assist users to report one or more states to another user. For example, a subordinate may need to report an identified issue to a higher-ranking member of the enterprise (e.g., CTO may wish to report an issue that needs to be addressed to the CEO). In embodiments, the AI reporting tool 8360 may be configured to receive a request to report a state from a client device 8050. In embodiments, the AI-reporting tool 8360 may identify the appropriate recipients of the reported state based on the type of request, the role of the user that issued the request and the organizational structure of the entity. In some embodiments, the AI-reporting tool may determine the role of the user and the recipients of the report from the organizational digital twin of the enterprise. In some embodiments, the AI-reporting tool 8360 may determine whether the intended recipients of a notification have access rights to the data being shared from the executive digital twin. For example, if the CFO is reporting to the CEO, it is likely that the CEO has access to all the enterprise's data and will not be precluded from receiving the report. Conversely, if the CFO wishes to delegate the handling of an issue via the AI-reporting tool to an employee in her business unit, the recipient may not have access to such data. In this scenario, the AI-reporting tool 8360 may notify the requesting user (e.g., the CFO) that certain types of data may not be shared with the subordinate employee and may determine a manner by which the issue may be reported to the subordinate without sharing the non-accessible data. Upon determining that a user has access rights to view a particular state of data, the AI-reporting tool 8360 may generate a report that is for the intended recipient. In embodiments, the AI-reporting tool may leverage the NLP services of the intelligence system to generate the report. In some embodiments, the AI-reporting tool 8360 may leverage an executive agent 8364 to determine when to report a state and the appropriate recipients of the reported state. In these embodiments, the executive agent 8364 may be trained on interactions of the user with the client application 8052 and digital twins that were previously presented to the user.

In some embodiments, the AI-reporting tool 8360 may be configured to monitor one or more user-defined key performance indicators (KPIs). Examples of KPIs of an enterprise may include, but are not limited to, with respect to systems, facilities, processes, functions, or workforce units: uptime (e.g., of an assembly line or other manufacturing system), capacity utilization, on-standard operating efficiency, overall effectiveness, downtime, amount of unscheduled downtime, setup time, an amount of inventory turns, inventory accuracy, quality metrics relating to products and services, first-pass yield amounts for the enterprise, an amount of rework required, days-sales-outstanding (DSOs), an amount of scrap or waste produced, throughput, changeover, maintenance percentage, yield per system or unit, overall yield, industry reviews, industry ratings, customer reviews, customer ratings, editorial reviews, awards, social media and website attention metrics, search engine performance metrics, safety metrics, health metrics, environmental impact metrics, political metrics, certification and testing metrics, regulatory metrics, social impact metrics, financial and investment metrics, corporate bond ratings, trade association metrics, union metrics, lobbying organization ratings, advertising performance metrics, referral metrics, and many others. Additional or alternative KPI metrics may be defined by a user. Examples of these KPI metrics may include an amount or percentage of failed audits, a number or percentage of deliveries that are on-time/late, a number of customer returns, a number of employee training hours, employee turnover percentage, number of reportable health or safety incidents, revenue per employee, profit per employee, schedule attainment metrics, total cycle time, and the like.

In embodiments, the collaboration tools 8362 include various tools that allow collaboration between executives of the enterprise. In embodiments, the collaboration tools include digital-twin enabled video conferencing. In these embodiments, the EMP 8000 may present participants in the video conference with the requested view of an enterprise digital twin. For example, during a Board meeting, a CTO proposing an update to the machinery or equipment in a facility may present an environment digital twin of the facility where the updates to the machinery or equipment would be made. In this example, the CTO may illustrate the results of simulations performed in the facility without the updates and with the updates. The simulation may illustrate how the update may benefit the enterprise using a number of selected metrics (e.g., throughput, profits, employee safety, or the like). Collaboration and communication tools and associated rules may be configured to use company-, industry- and domain-specific taxonomies and lexicons when representing entities, states and flows within the digital twin.

In embodiments, executive agents 8364 are expert agents that are trained to perform tasks on behalf of executive users. As discussed, in some embodiments, a client application may monitor the user of the client application by a user when using the client application 8052. In these embodiments, the client application 8052 may monitor the states of an executive digital twin that the user drills down into, the states that the user reports to a superior and/or delegates to a team member in her respective business unit, decisions that are made, and the like. As the user uses the client application 8052, the expert agent system 8008 may train one or more machine-learned models on behalf of the particular user, such that the models may be leveraged by an executive agent 8364 to perform tasks on behalf of or recommend actions to the user.

In embodiments, Board meeting tools 8366 are tools that are used to prepare for, to access within and/or to follow-up on board and similar meetings, such as Board of Directors, Board of Trustees, shareholder meetings, annual meetings, investor meetings, and other important meetings. References to Board meetings herein should be understood to encompass these and other important meetings that require executive preparation, attendance and/or attention. In embodiments, Board meeting tools 8366 may allow different users to present one or more states of an enterprise digital twins within the context of a Board report or Board meeting. For example, a user (e.g., a COO) may share a simulation of a proposed logistics solution from the COO digital twin 8366 with one or more devices (e.g., a device in the Board room and/or devices of participants accessing the Board meeting remotely). In embodiments, a Board meeting tool 8366 may limit access to certain types of data based on time, scope, and permissions. For example, a Board meeting tool 8366 may require that all geolocations that board members be registered before a Board meeting (e.g., Board room, designated home offices for those joining by phone or video, and the like), such that some or all of the data depicted in a digital twin that is being presented can only be viewed on a device that is at one of the registered geolocations and/or only for a defined duration, such as from a few hours before through a few hours after a meeting, or only during the meeting. Similarly, in embodiments, the Board meeting tools 8366 may limit access to some or all of the data shared in a presented digital twin to particular times (e.g., during the Board meeting or the day of the Board meeting). Other examples of board meeting tools 8366 are discussed throughout the application.

In embodiments, training modules 8368 may include software tools that are used to train a user. In embodiments, the training modules 8368 may leverage digital twins to improve executive training for an enterprise. For example, a training module 8368 may provide real-world examples that are based on the data collected from the enterprise. The training module 8368 may present the user with different scenarios via an executive digital twin 8368 and the user may take actions. Based on the actions, the training module 8368 may request a simulation from the EMP 8000, which in turn returns the results to the user. In this way, the user may be trained on scenarios that are based on the actual enterprise of the user.

In embodiments, planning tools 8370 are software tools that leverage digital twins to assist users to make plans for the enterprise. In embodiments, a planning tool 8370 may be configured to provide a graphical user interface that allows an executive to make plans (e.g., budgets, defining KPIs, etc.). In some embodiments, the planning tool 8370 may be configured to request a simulation from the IMP 8000 given the parameters set in the created plan. In response, the EMP 8000 may return the results of the simulation and the user can determine whether to adjust the plan. In this way, the user may iteratively refine the plan to achieve one or more objectives. In embodiments, an executive agent 8362 may monitor the track the actions taken while the plan is being refined by the user so that the expert agent system 8008 may train the executive agent 8362 to generate or recommend plans to the user in the future.

The enterprise digital twins may be leveraged and/or interface with other software applications without departing from the scope of the disclosure.

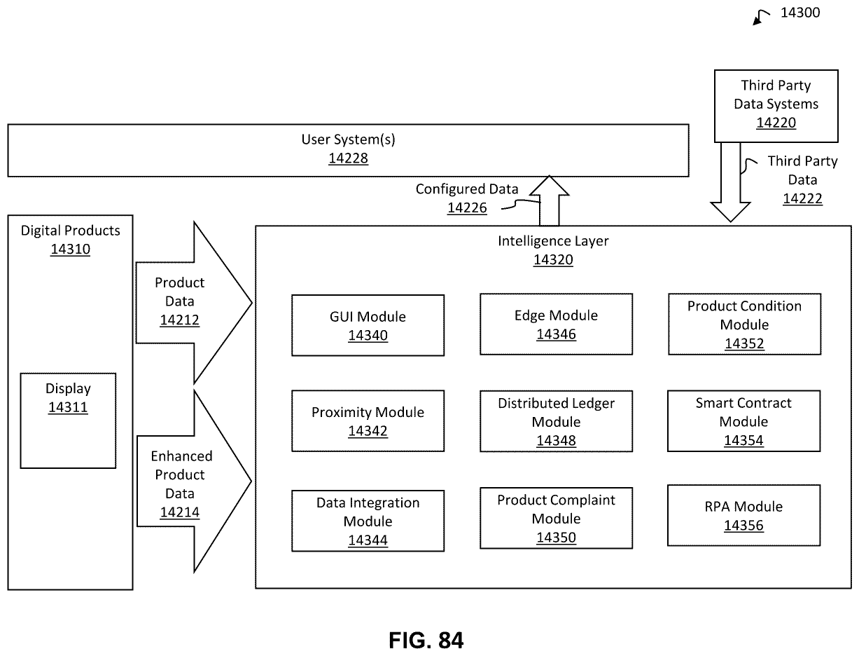

FIG. 84 illustrates an example implementation of the EMP 8000. In this example, the EMP 8000 is in communication with a plurality of client applications 8052 and a set of enterprise assets 8400. In the example, the EMP 8000 receives enterprise data from a set of enterprise entities 8400, such as the sensor system 8022, physical entities 8402, digital entities 8404, computational entities 8406, and/or network entities 8408 belonging to and/or associated with the enterprise. In embodiments, the enterprise data may relate to environments, processes, and/or a condition of the enterprise. For example, the sensor system 8022 may be deployed within an enterprise facility (e.g., manufacturing facility, warehouse, distribution center, logistics facility, transportation facility, office building, customer location, retail location, agricultural facility, natural resource extraction facility, or the like) of the enterprise, whereby the sensor system 8022 provides sensor readings (e.g., vibration data, location data, motion data, temperature data, pressure data, or the like) relating to the facility in general or a piece of machinery, equipment, or other physical or workforce asset within the facility. Within the facility, a number of physical assets (e.g., robots, autonomous vehicles, smart equipment, personnel and the like) or other entities may output data streams relating to the operation of the assets or other entities. Additionally or alternatively, the enterprise may include a number of digital assets (e.g., CRM, ERP, databases, or the like) that provide data streams relating to sales, costs, human resources or the like. The network entities may provide networking-related data, including bandwidth, API requests, throughput, detected cyber-attacks, or the like. The computational entities may provide data relating to a computing infrastructure of an enterprise. In some embodiments, the enterprise management system 8000 may receive data from other sources as well, including third-party data 8038 from third-party data providers. Taken in combination, the data from the enterprise assets 8400 and/or other data sources may provide information relating to the status of the industrial facility and the machinery contained therein, the state of various processes (e.g., industrial processes, sales workflows, hiring processes, logistics workflows, and the like), the efficiencies of the processes, the financial health of the enterprise, and the like.

In embodiments, the enterprise entities may communicate directly with the EMP 8000 via a communication network. Additionally or alternatively, one or more of the enterprise assets may stream data to a local data collection system 8420 that collects and stores enterprise data locally. In some embodiments, the local data collection system 8420 may provide the collected data to an edge intelligence system 8422 of the enterprise.

In embodiments, the edge intelligence system 8422 may be executed by an edge device 8042 configured to receive data, such as from the local data collection systems 8420, a local sensor system 8022, or other enterprise entities 8400 that are located in or near a physical location of the entities (e.g., at an industrial facility) and may perform one or more edge-related processes relating to the received data. The edge device may be a pre-configured and/or substantially self- or automatically configuring computing device, such as an “edge intelligence in a box” device. An edge-related process may refer to a process that is performed at an edge device in order to store sensor data, reduce bandwidth on a communication network, and/or reduce the computational resources required at a backend system. Examples of edge processes can include data filtering, signal filtering, data processing, compression, encoding, quick-predictions, quick-notifications, emergency alarming, and the like, and may include creation of automated smart data bands. For example, the edge intelligence system 8422 may determine whether to transmit a subset of the data to the EMP 8000 or to store the subset of the data locally until it is explicitly requested from the EMP 8000. In another example, the edge intelligence system 8422 may be configured to compress data streams (e.g., sensor data streams) to improve data throughput of high-volume data streams (e.g., vibration data). In some embodiments, the edge intelligence system 8422 may be configured to analyze the high-volume data to determine whether to compress or stream a raw data stream. In some embodiments, the local data collection system 8420 and the edge intelligence system 8422 may be embodied in edge devices 8042 of the enterprise. In some embodiments, the edge intelligence system 8422 may communicate data to the EMP 8000. In some of these embodiments, the edge intelligence system 8422 communicates data to the EMP 8000 via a network enhancement system 8424.

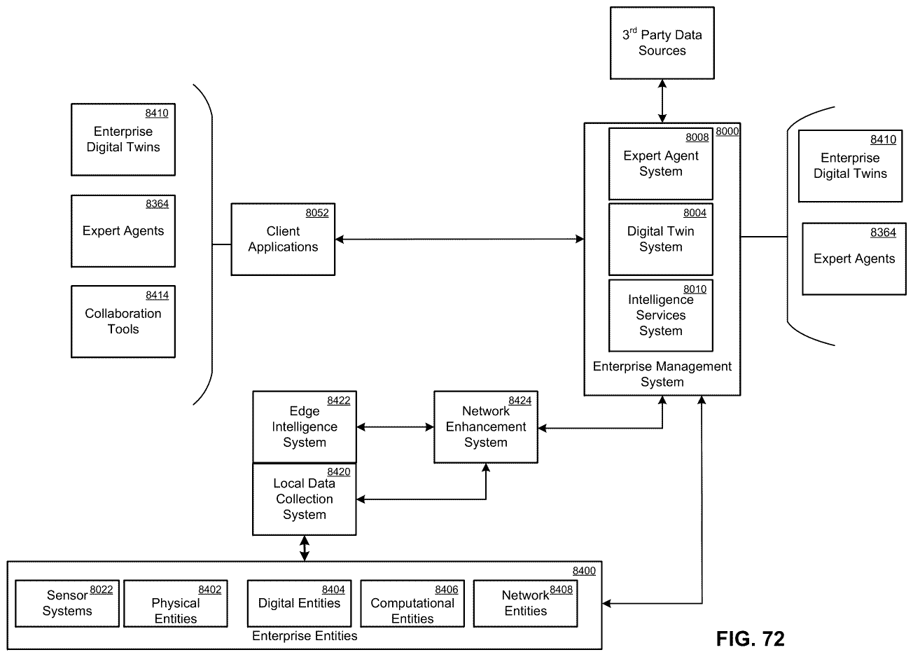

In embodiments, the network enhancement system 8424 may be configured to optimize flow of data transmitted from one or both of the edge intelligence system 8422 and the local data collection system 8420 and received by the EMP 8000. For example, a local data collection system 8420 may be configured to collect data from one or more real world environments, entities, ecosystems, and/or processes, which may be analyzed by a connected edge intelligence system 8422. In this example, the edge intelligence system 8422 may transmit the collected data to the network enhancement system 8424, which may optimize transmission of the data to the EMP 8000 (also shown in FIG. 72) for processing and implementation by the EMP 8000. The EMP 8000 may store, analyze, or otherwise process the transmitted data to the client applications 8052, such that the client applications 8052 may update enterprise digital twins (e.g., role-based digital twins, environment digital twins, cohort digital twins, and the like) that are hosted by the client applications 8052.

In embodiments, the network enhancement system 8424 may include one or more signal amplifiers, signal repeaters, digital filters, analog filters, digital-to-analog converters, analog-to-digital converter and/or antennae configured to optimize the flow of data. In some embodiments, the network enhancement system may include a wireless repeater system such as is disclosed by U.S. Pat. No. 7,623,826 to Pergal, the entirety of which is hereby incorporated by reference. The network enhancement system 8424 may optimize the flow of data by, for example, filtering data, repeating data transmission, amplifying data transmission, adjusting one or more sampling rates and/or transmission rates, and implementing one or more data communication protocols.

In embodiments, the network enhancement system 8424 may include one or more processors configured to perform digital signal processing to optimize the flow of data. The one or more processors may implement optimization algorithms to optimize the flow of data. The one or more processors may determine one or more optimal paths in a network, the network enhancement system 8424 transmitting the data along the one or more optimal paths. The network enhancement system 8424 may be configured to implement a software filter via the one or more processors. The software filter may filter data before transmission to the EMP 8000, for example to lower network bandwidth consumed by data transmission. The one or more processors may determine that portions of data are relevant only to one or more intended recipients, such as digital twins, executive agents, collaboration suites, or other components of the EMP 8000 and determine optimal paths based upon intended recipients of the portions of data.

In embodiments, the network enhancement system 8424 may be configured to optimize data flow between a plurality of nodes over a plurality of data paths. In some embodiments, the network enhancement system 8424 may transmit a first portion of data over a first path of the plurality of data paths and a second portion of data over a second path of the plurality of data paths. The network enhancement system 8424 may determine that one or more data paths. such as the first data path, the second data path, other data paths, are advantageous for transmission of one or more portions of data. The network enhancement system 8424 may make determinations of advantageous data paths based upon one or more networking variables, such as one or more types of data being transmitted, one or more protocols being suitable for transmission, present and/or anticipated network congestion, timing of data transmission, present and/or anticipated volumes of data being or to be transmitted, and the like. Protocols suitable for transmission may include transmission control protocol (TCP), user datagram protocol (UDP), and the like. In some embodiments, the network enhancement system may be configured to implement a method for data communication such as is disclosed by U.S. Pat. No. 9,979,664 to Ho et al., the entirety of which is hereby incorporated by reference.

The EMP 8000 receives enterprise data (e.g., directly or via the network enhancement system 8424, an edge intelligence system 8422, a local data collection system 8420 or from any other data source). In embodiments, the digital twin system 8004 may structure and/or store the enterprise data in one or more digital twin databases (e.g., graph databases, relational databases, SQL databases, distributed databases, blockchains, caches, servers, and/or the like). In embodiments, the client application 8052 requests an enterprise digital twin 8410 from the EMP 8000. In response, the digital twin system 8004 may generate and serve the requested enterprise digital twin 8410 (e.g., a role-based digital twin, executive digital twin, environment digital twin, process digital twin, cohort digital twins, or the like) to the client application 8052, whereby the enterprise digital twin 8410 may include the enterprise data and/or data that was derived from the enterprise data (e.g., by the intelligence services system). The client application 8052 may provide an interface for the user of the client application 8052 to interact with the requested digital twin 8410. For example, the user may delegate tasks relating to a depicted state to subordinates and/or may notify a superior of a depicted state via the digital twin interface. In another example, the user may drill down into a particular state and may initiate a corrective action via the digital twin interface. In some embodiments, the client application 8052 may allow the user to share the digital twin 8410 (or a portion thereof) within a collaboration tool 8414 or access collaboration features of a collaboration tool 8414 within the twin 8410. For example, the client application 8052 may allow the user to share a depicted state of the digital twin 8410 into a board meeting collaboration tool Additionally or alternatively, an expert agent 8364 may monitor the interactions of the user with the digital twin and may report the interactions to the expert agent system 8008 of the EMP. In embodiments, the expert agent system 8008 may receive the interactions and may train the expert agent 8364 based on the interactions with the digital twin, as well as outcomes stemming from the expert agent. For example, the expert agent may be trained to identify situations where the user delegates tasks or notifies a superior.

The executive digital twins discussed with respect to FIG. 71 are provided for example and not intended to limit the scope of the disclosure. Additional and/or alternative data types may be included in a respective type of executive digital twin.

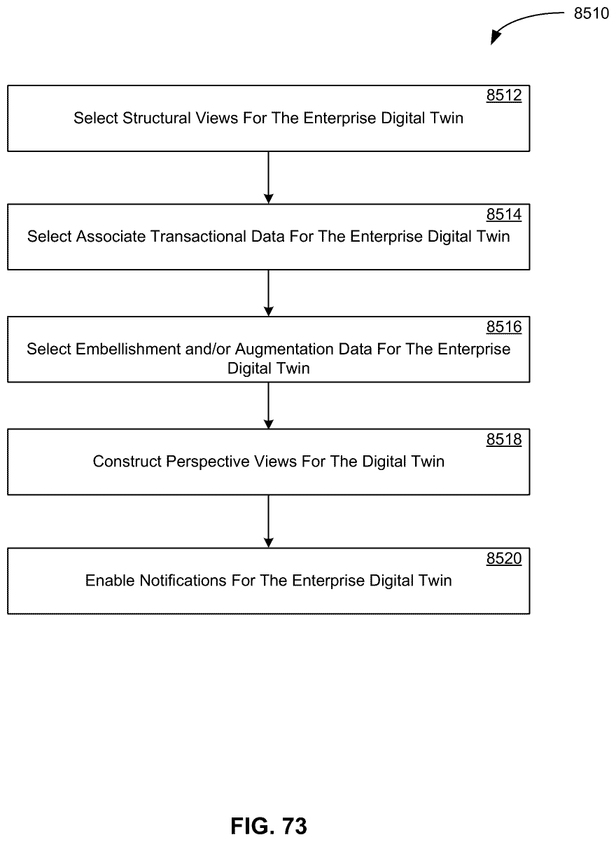

FIG. 73 illustrates an example method 8510 for configuring and serving an enterprise digital twin. In embodiments, the method may be executed by the digital twin system 8004. The method may be performed with respect to different types of enterprise digital twins, including role-based digital twins (e.g., executive digital twins), cohort digital twins, environment digital twins, process digital twins, and/or the like.

At 8512, the structural views for a particular type of digital twin are selected. In embodiments, the structural views can be stored in a graph database (representing interconnected data) or in a geospatial database (representing coordinates of actual facilities).

At 8514, associated transactional data for the digital twin is selected. In embodiments, a combination of interaction data and transaction data is selected at grain that is suitable for the dynamic interaction within the digital twin is selected. This selection process may involve dynamic configuration of the structure, functions and features of a data mart or other summarization system and/or may work dynamically using typically high-performance database storage mechanisms (such as columnar databases or in memory databases).

At 8516, embellishment and/or augmentation data for the digital twin is selected. In embodiments, embellishment data are the associated attributes that can be tied to elements within the executive digital twin. For example, in generating an environment digital twin of a facility, embellishment or augmentation data may include the ages of machinery or other assets in the facility, the names of key third-party suppliers that could replace items with supply chain deliveries, the inputs or outputs of process flows that occur within the facility, identities of managers, indicators of states and flows, and many others. In an abstract executive digital twin the embellishment data may include social media data, for example sentiment analytics that can be associated with the customer hierarchical views.

At 8518, a representation medium for the digital twin is selected. In embodiments, the final representation can be multi-faceted, this can include a range of devices from simple mobile phone-based devices and touchscreen tablets to special-purpose devices and/or immersive AR/VR headsets, among many others. The representation medium impacts the volume and nature of data that is preferably selected in the earlier steps. In embodiments, selection of a representation medium is provided as a feedback indicator to the data and networking pipeline, such that filtering and data path selection can be undertaken with awareness of end device and other capabilities and requirements of the representation medium. This may occur automatically, such as by an agent that is trained to provide context-sensitive feedback based on a training set of outcomes.

At 8520, the perspective views are constructed. In embodiments, the perspective builder 8110 generates a level and nature of data that allows for different types of user to interact with the digital twin while gaining the appropriate level of perspective. For example, with a CEO-level view the CEO may require the context of third-party alternatives, market forces, and current strategic initiatives. In this example, the perspective builder 8110 takes these considerations into account in producing the level of digital twin appropriate for the CEO, furthermore this will impact the data selection process as different grains of data are appropriate for the different views. These different perspectives can be simultaneously interacted with various roles allowing the executive to provide their guidance on the same topic while seeing and interaction with information relevant to their specific needs.

At 8522, user notifications are enabled. In embodiments, notifications within the digital twin are controlled by the grain of the data selected and the required perspective. For example, a CTO level view requires notifications of various technology changes and technology market forces, the CTO digital twin is constantly being overlaid with these notifications that are structurally associated with the relevant part of the digital environment abstract or concrete. For example, in an organizational chart the CTO could be seeing the implementation options for new technology to provide more efficient communication between organizational units in strategic planning exercise to acquire a new company. Simultaneously the CFO is seeing the financial impacts of these various options, and the CEO is being notified of decisions that might impact the future market opportunities regarding the upcoming company acquisition.

The method is provided for example only. Additional and/or alternative methods may be performed to generate and serve digital twins without departing from the scope of the disclosure.

The method of FIG. 73 is provided for example and not intended to limit the scope of the disclosure. The method may include additional or alternative operations.

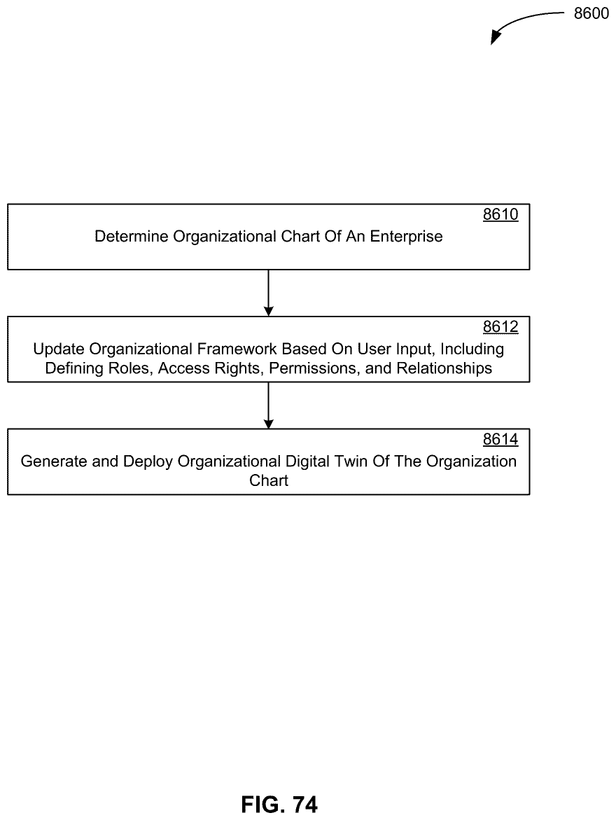

FIG. 74 illustrates an example set of operations of a method 8600 for configuring an organizational digital twin. In embodiments, the method may be executed at least in part by the digital twin system 8004. It is appreciated that the method may be executed by other suitable computing systems without departing from the scope of the disclosure.

At 8610 an organizational chart of an enterprise is determined. In embodiments, a user may upload the organizational chart via a GUI displayed to the user. In some embodiments, the digital twin system 8004 or a connected component may crawl one or more websites (e.g., the enterprise website, a social networking website, or the like) and may parse the crawled website(s) to determine the organizational chart.

At 8612, the organizational framework of the enterprise is updated based on user input. In embodiments, a user may define roles within the enterprise to individuals listed in the organizational chart, grant access rights to different roles and/or individuals, grant permissions to individuals and/or roles, and may define relationships between roles and/or individuals. In embodiments, the relationships may represent reporting structures, teams, business units, and the like.

At 8614, an organizational digital twin of the enterprise is generated and deployed. In embodiments, the digital twin system 8004 may generate the organizational digital twin by connecting data from the enterprise to the organizational chart. This may include information relating to the individuals, such as birthdate, social security or tax id, role, relationships, citizenship, employment status, salary, stock holdings, title, current status, goals or targets, and the like. Once deployed, the organizational chart may be continuously updated from one or more enterprise data sources. In embodiments, the organizational digital twin may be leveraged to determine the roles of individuals within an organization and/or the reporting structure of the digital twin.

The method of FIG. 74 is provided for example and not intended to limit the scope of the disclosure. The method may include additional or alternative operations.

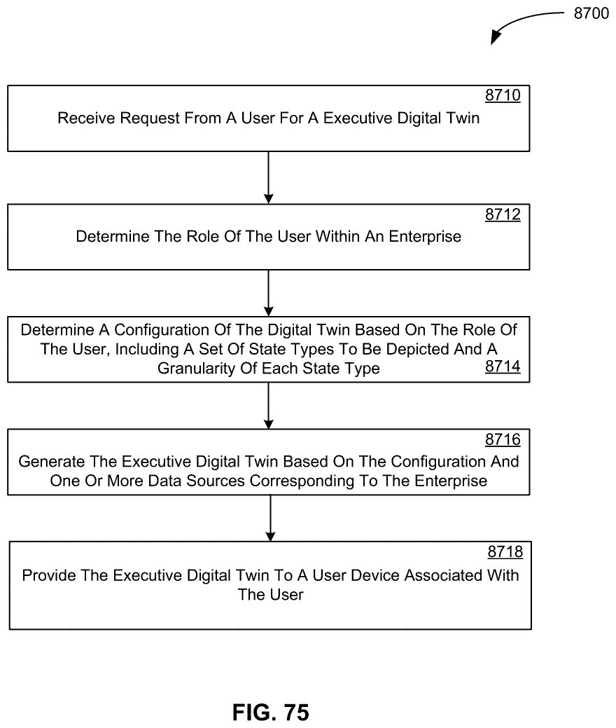

FIG. 75 illustrates an example set of operations of a method 8700 for generating an executive digital twin. In embodiments, the method may be executed at least in part by the digital twin system 8004. It is appreciated that the method may be executed by other suitable computing systems without departing from the scope of the disclosure.

At 8710, a request for an executive digital twin is received from a user. In embodiments, the digital twin system 8004 may receive a request for an executive digital twin from a user device associated with a user, such as a mobile device, a personal computer, a VR device, or the like. The request may indicate an identity of the user and/or a role of the user.

At 8712, a role of the user is determined. In embodiments, the digital twin system 8004 may determine a role of the user from the request and/or from an organizational digital twin of an enterprise associated with the user. In embodiments, the organizational digital twin may indicate the role of the user, the permissions of the user, the access rights of the user, restrictions of the user, and a reporting structure of the user.

At 8714, a configuration of the executive digital twin is determined based on the role of the user. In embodiments, the configuration of the executive digital twin indicates a set of states that re to be depicted in the executive digital twin and a granularity of the digital twin. In embodiments, the configuration of the executive digital twin is stored in a configuration file in the digital twin data store associated with the enterprise. The configuration file may define the initial states of the digital twin and the granularities of the states.

At 8716, a digital twin is generated based on one or more data sources corresponding to the enterprise. In embodiments, the digital twin system 8004 may determine the appropriate perspective for the requested digital twin based on the configuration of the digital twin and any access rights or restrictions of the user. In embodiments, the restrictions may include data restrictions, interaction restrictions, depth of data restrictions, usage restrictions, length of visibility restrictions, that the user may have. In some embodiments, generating the requested digital twin may include identifying the appropriate data sources for the digital twin given the perspective and obtaining any data that initially parameterizes the executive digital twin from the data sources.

At 8718, the executive digital twin is served to a user device of the user. In embodiments, the digital twin system 8004 may provide a file (e.g., a JSON file) containing the executive digital twin data and any data structures or visual elements that are needed to depict the executive digital twin by the user device. In embodiments, the digital twin system 8004 may also stream one or more real-time data or near-real time data streams to the user device (e.g., via a data bus), such that the executive digital twin may be updated with fresh data as the user interacts with the executive digital twin. The user may then interact with the digital twin. For example, the user may delegate tasks via the executive digital twin, request simulations via the executive digital twin, drill down into or zoom out of states depicted in the executive digital twin, report states to a supervisor via the executive digital twin, and/or the like.

The method of FIG. 75 is provided for example and not intended to limit the scope of the disclosure. The method may include additional or alternative operations.

### Intelligence System

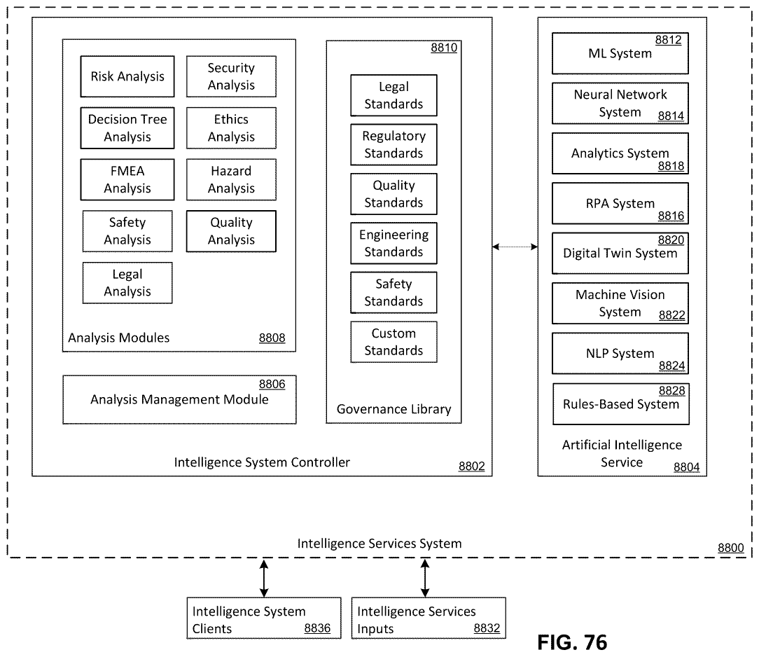

FIG. 76 illustrates an example intelligence services system 8800 (also referred to as “intelligence services”) according to some embodiments of the present disclosure. In embodiments, the intelligence services 8800 provides a framework for providing intelligence services to one or more intelligence service clients 8836. In some embodiments, the intelligence services 8800 framework may be adapted to be at least partially replicated in respective intelligence clients 8836 (e.g., VCN control towers and/or various VCN entities). In these embodiments, an individual client 8836 may include some or all of the capabilities of the intelligence services 8800, whereby the intelligence services 8800 is adapted for the specific functions performed by the subsystems of the intelligence client. Additionally or alternatively, in some embodiments, the intelligence services 8800 may be implemented as a set of microservices, such that different intelligence clients 8836 may leverage the intelligence services 8800 via one or more APIs exposed to the intelligence clients. In these embodiments, the intelligence services 8800 may be configured to perform various types of intelligence services that may be adapted for different intelligence clients 8836. In either of these configurations, an intelligence service client 8836 may provide an intelligence request to the intelligence services 8800, whereby the request is to perform a specific intelligence task (e.g., a decision, a recommendation, a report, an instruction, a classification, a prediction, a training action, an NLP request, or the like). In response, the intelligence services 8800 executes the requested intelligence task and returns a response to the intelligence service client 8836. Additionally or alternatively, in some embodiments, the intelligence services 8800 may be implemented using one or more specialized chips that are configured to provide AI assisted microservices such as image processing, diagnostics, location and orientation, chemical analysis, data processing, and so forth. Examples of AI-enabled chips are discussed elsewhere in the disclosure.

In embodiments, an intelligence services 8800 may include an intelligence service controller 8802 and artificial intelligence (AI) modules 8804. In embodiments, an artificial intelligence services 8800 receives an intelligence request from an intelligence service client 8836 and any required data to process the request from the intelligence service client 8836. In response to the request and the specific data, one or more implicated artificial intelligence modules 8804 perform the intelligence task and output an “intelligence response”. Examples of intelligence modules 8804 responses may include a decision (e.g., a control instruction, a proposed action, machine-generated text, and/or the like), a prediction (e.g., a predicted meaning of a text snippet, a predicted outcome associated with a proposed action, a predicted fault condition, and/or the like), a classification (e.g., a classification of an object in an image, a classification of a spoken utterance, a classified fault condition based on sensor data, and/or the like), and/or other suitable outputs of an artificial intelligence system.

In embodiments, artificial intelligence modules 8804 may include an ML module 8812, a rules-based module 8828, an analytics module 8818, an RPA module 8816, a digital twin module 8820, a machine vision module 8822, an NLP module 8824, and/or a neural network module 8814. It is appreciated that the foregoing are non-limiting examples of artificial intelligence modules, and that some of the modules may be included or leveraged by other artificial intelligence modules. For example, the NLP module 8824 and the machine vision module 8822 may leverage different neural networks that are part of the neural network module 8814 in performance of their respective functions.

It is further noted that in some scenarios, artificial intelligence modules 8804 themselves may also be intelligence clients 8836. For example, a rules-based intelligence module 8828 may request an intelligence task from an ML module 8812 or a neural network F41 module 8814, such as requesting a classification of an object appearing in a video and/or a motion of the object. In this example, the rules-based intelligence module 8828 may be an intelligence service client 8836 that uses the classification to determine whether to take a specified action. In another example, a machine vision module 8822 may request a digital twin of a specified environment from a digital twin module 8820, such that the ML module 8812 may request specific data from the digital twin as features to train a machine-learned model that is trained for a specific environment.

In embodiments, an intelligence task may require specific types of data to respond to the request. For example, a machine vision task requires one or more images (and potentially other data) to classify objects appearing in an image or set of images, to determine features within the set of images (such as locations of items, presence of faces, symbols or instructions, expressions, parameters of motion, changes in status, and many others), and the like. In another example, an NLP task requires audio of speech and/or text data (and potentially other data) to determine a meaning or other element of the speech and/or text. In yet another example, an AI-based control task (e.g., a decision on movement of a robot) may require environment data (e.g., maps, coordinates of known obstacles, images, and/or the like) and/or a motion plan to make a decision as to how to control the motion of a robot. In a platform-level example, an analytics-based reporting task may require data from a number of different databases to generate a report. Thus, in embodiments, tasks that can be performed by an intelligence services 8800 may require, or benefit from, specific intelligence service inputs 8832. In some embodiments, an intelligence services 8800 may be configured to receive and/or request specific data from the intelligence service inputs 8832 to perform a respective intelligence task. Additionally or alternatively, the requesting intelligence service client 8836 may provide the specific data in the request. For instance, the intelligence services 8800 may expose one or more APIs to the intelligence clients 8836, whereby a requesting client 8836 provides the specific data in the request via the API. Examples of intelligence service inputs may include, but are not limited to, sensors that provide sensor data, video streams, audio streams, databases, data feeds, human input, and/or other suitable data.

In embodiments, intelligence modules 8804 includes and provides access to an ML module 8812 that may be integrated into or be accessed by one or more intelligence clients 8836. In embodiments, the ML module 8812 may provide machine-based learning capabilities, features, functions, and algorithms for use by an intelligence service client 8836 such as training ML models, leveraging ML models, reinforcing ML models, performing various clustering techniques, feature extraction, and/or the like. In an example, a machine learning module 8812 may provide machine learning computing, data storage, and feedback infrastructure to a simulation system (e.g., as described above). The machine learning module 8812 may also operate cooperatively with other modules, such as the rules-based module 8828, the machine vision module 8822, the RPA module 8816, and/or the like.

The machine learning module 8812 may define one or more machine learning models for performing analytics, simulation, decision making, and predictive analytics related to data processing, data analysis, simulation creation, and simulation analysis of one or more components or subsystems of an intelligence service client 8836. In embodiments, the machine learning models are algorithms and/or statistical models that perform specific tasks without using explicit instructions, relying instead on patterns and inference. The machine learning models build one or more mathematical models based on training data to make predictions and/or decisions without being explicitly programmed to perform the specific tasks. In example implementations, machine learning models may perform classification, prediction, regression, clustering, anomaly detection, recommendation generation, and/or other tasks.

In embodiments, the machine learning models may perform various types of classification based on the input data. Classification is a predictive modeling problem where a class label is predicted for a given example of input data. For example, machine learning models can perform binary classification, multi-class or multi-label classification. In embodiments, the machine-learning model may output “confidence scores” that are indicative of a respective confidence associated with classification of the input into the respective class. In embodiments, the confidence scores can be compared to one or more thresholds to render a discrete categorical prediction. In embodiments, only a certain number of classes (e.g., one) with the relatively largest confidence scores can be selected to render a discrete categorical prediction.

In embodiments, machine learning models may output a probabilistic classification. For example, machine learning models may predict, given a sample input, a probability distribution over a set of classes. Thus, rather than outputting only the most likely class to which the sample input should belong, machine learning models can output, for each class, a probability that the sample input belongs to such class. In embodiments, the probability distribution over all possible classes can sum to one. In embodiments, a Softmax function, or other type of function or layer can be used to turn a set of real values respectively associated with the possible classes to a set of real values in the range (0, 1) that sum to one. In embodiments, the probabilities provided by the probability distribution can be compared to one or more thresholds to render a discrete categorical prediction. In embodiments, only a certain number of classes (e.g., one) with the relatively largest predicted probability can be selected to render a discrete categorical prediction.

In embodiments, machine learning models can perform regression to provide output data in the form of a continuous numeric value. As examples, machine learning models can perform linear regression, polynomial regression, or nonlinear regression. As described, in embodiments, a Softmax function or other function or layer can be used to squash a set of real values respectively associated with a two or more possible classes to a set of real values in the range (0, 1) that sum to one. For example, machine learning models can perform linear regression, polynomial regression, or nonlinear regression. As examples, machine learning models can perform simple regression or multiple regression. As described above, in some implementations, a Softmax function or other function or layer can be used to squash a set of real values respectively associated with a two or more possible classes to a set of real values in the range (0, 1) that sum to one.

In embodiments, machine learning models may perform various types of clustering. For example, machine learning models may identify one or more previously-defined clusters to which the input data most likely corresponds. In some implementations in which machine learning models performs clustering, machine learning models can be trained using unsupervised learning techniques.

In embodiments, machine learning models may perform anomaly detection or outlier detection. For example, machine learning models can identify input data that does not conform to an expected pattern or other characteristic (e.g., as previously observed from previous input data). As examples, the anomaly detection can be used for fraud detection or system failure detection.

In some implementations, machine learning models can provide output data in the form of one or more recommendations. For example, machine learning models can be included in a recommendation system or engine. As an example, given input data that describes previous outcomes for certain entities (e.g., a score, ranking, or rating indicative of an amount of success or enjoyment), machine learning models can output a suggestion or recommendation of one or more additional entities that, based on the previous outcomes, are expected to have a desired outcome

As described above, machine learning models can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, machine learning models can be or include one or more classifier models such as, for example, linear classification models; quadratic classification models; etc. Machine learning models may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning models can be or include one or more decision tree-based models such as, for example, classification and/or regression trees; chi-squared automatic interaction detection decision trees; decision stumps; conditional decision trees; etc.

Machine learning models may be or include one or more kernel machines. In some implementations, machine learning models can be or include one or more support vector machines. Machine learning models may be or include one or more instance-based learning models such as, for example, learning vector quantization models; self-organizing map models; locally weighted learning models; etc. In some implementations, machine learning models can be or include one or more nearest neighbor models such as, for example, k-nearest neighbor classifications models; k-nearest neighbors regression models; etc. Machine learning models can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

Machine learning models may include one or more clustering models such as, for example, k-means clustering models; k-medians clustering models; expectation maximization models; hierarchical clustering models; etc.

In some implementations, machine learning models can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine learning models can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In embodiments, artificial intelligence modules 8804 may include and/or provide access to a neural network module 8814. In embodiments, the neural network module 8814 is configured to train, deploy, and/or leverage artificial neural networks (or “neural networks”) on behalf of an intelligence service client 8836. It is noted that in the description, the term machine learning model may include neural networks, and as such, the neural network module 8814 may be part of the machine learning module 8812. In embodiments, the neural network module 8814 may be configured to train neural networks that may be used by the intelligence clients 8836. Non-limiting examples of different types of neural networks may include any of the neural network types described throughout this disclosure and the documents incorporated herein by reference, including without limitation convolutional neural networks (CNN), deep convolutional neural networks (DCN), feed forward neural networks (including deep feed forward neural networks), recurrent neural networks (RNN) (including without limitation gated RNNs), long/short term memory (LTSM) neural networks, and the like, as well as hybrids or combinations of the above, such as deployed in series, in parallel, in acyclic (e.g., directed graph-based) flows, and/or in more complex flows that may include intermediate decision nodes, recursive loops, and the like, where a given type of neural network takes inputs from a data source or other neural network and provides outputs that are included within the input sets of another neural network until a flow is completed and a final output is provided. In embodiments, the neural network module 8814 may be leveraged by other artificial intelligence modules 8804, such as the machine vision module 8822, the NLP module 8824, the rules-based module 8828, the digital twin module 8826, and so on. Example applications of the neural network module 8814 are described throughout the disclosure.

A neural network includes a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

In embodiments, the neural networks can be or include one or more feed forward neural networks. In feed forward networks, the connections between nodes do not form a cycle. For example, each connection can connect a node from an earlier layer to a node from a later layer.

In embodiments, the neural networks can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc. In some example embodiments, recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, neural networks can be or include one or more non-recurrent sequence-to-sequence models based on self-attention, such as Transformer networks. Details of an exemplary transformer network can be found at http://papers.nips.cc/paper/7181-attention-is-all-you-need.pdf.

In embodiments, the neural networks can be or include one or more convolutional neural networks. In some instances, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

In embodiments, the neural networks can be or include one or more generative networks such as, for example, generative adversarial networks. Generative networks can be used to generate new data such as new images or other content.

In embodiments, the neural networks may be or include autoencoders. In some instances, the aim of an autoencoder is to learn a representation (e.g., a lower-dimensional encoding) for a set of data, typically for the purpose of dimensionality reduction. For example, in some instances, an autoencoder can seek to encode the input data and then provide output data that reconstructs the input data from the encoding. Recently, the autoencoder concept has become more widely used for learning generative models of data. In some instances, the autoencoder can include additional losses beyond reconstructing the input data.

In embodiments, the neural networks may be or include one or more other forms of artificial neural networks such as, for example, deep Boltzmann machines; deep belief networks; stacked autoencoders; etc. Any of the neural networks described herein can be combined (e.g., stacked) to form more complex networks.

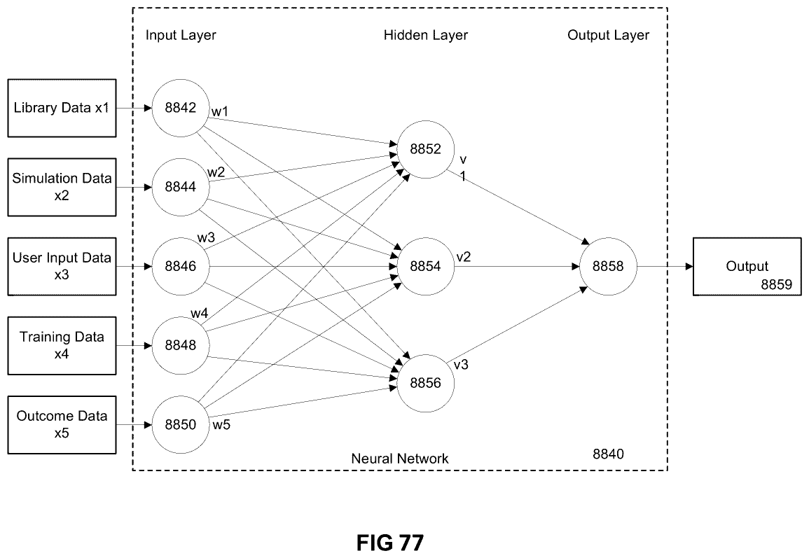

FIG. 77 illustrates an example neural network with multiple layers. Neural network 8840 may include an input layer, a hidden layer, and an output layer with each layer comprising a plurality of nodes or neurons that respond to different combinations of inputs from the previous layers. The connections between the neurons have numeric weights that determine how much relative effect an input has on the output value of the node in question. Input layer may include a plurality of input nodes 8842, 8844, 8846, 8848 and 8850 that may provide information from the outside world or input data (e.g., sensor data, image data, text data, audio data, etc.) to the neural network 8840. The input data may be from different sources and may include library data x1, simulation data x2, user input data x3, training data x4 and outcome data x5. The input nodes 8842, 8844, 8846, 8848 and 8850 may pass on the information to the next layer, and no computation may be performed by the input nodes. Hidden layers may include a plurality of nodes, such as nodes 8852, 8854, and 8856. The nodes in the hidden layer 8852, 8854, and 8856 may process the information from the input layer based on the weights of the connections between the input layer and the hidden layer and transfer information to the output layer. Output layer may include an output node 8858 which processes information based on the weights of the connections between the hidden layer and the output layer and is responsible for computing and transferring information from the network to the outside world, such as recognizing certain objects or activities, or predicting a condition or an action.

In embodiments, a neural network 8840 may include two or more hidden layers and may be referred to as a deep neural network. The layers are constructed so that the first layer detects a set of primitive patterns in the input (e.g., image) data, the second layer detects patterns of patterns and the third layer detects patterns of those patterns. In some embodiments, a node in the neural network 8840 may have connections to all nodes in the immediately preceding layer and the immediate next layer. Thus, the layers may be referred to as fully-connected layers. In some embodiments, a node in the neural network 8840 may have connections to only some of the nodes in the immediately preceding layer and the immediate next layer. Thus, the layers may be referred to as sparsely-connected layers. Each neuron in the neural network consists of a weighted linear combination of its inputs and the computation on each neural network layer may be described as a multiplication of an input matrix and a weight matrix. A bias matrix is then added to the resulting product matrix to account for the threshold of each neuron in the next level. Further, an activation function is applied to each resultant value, and the resulting values are placed in the matrix for the next layer. Thus, the output from a node i in the neural network may be represented as:

yi=f(Σxiwi+bi)

where f is the activation function, Σxiwi is the weighted sum of input matrix and bi is the bias matrix.

The activation function determines the activity level or excitation level generated in the node as a result of an input signal of a particular size. The purpose of the activation function is to introduce non-linearity into the output of a neural network node because most real-world functions are non-linear and it is desirable that the neurons can learn these non-linear representations. Several activation functions may be used in an artificial neural network. One example activation function is the sigmoid function σ(x), which is a continuous S-shaped monotonically increasing function that asymptotically approaches fixed values as the input approaches plus or minus infinity. The sigmoid function σ(x) takes a real-valued input and transforms it into a value between 0 and 1:

σ(x)=1/(1+exp(−x)).

Another example activation function is the tanh function, which takes a real-valued input and transforms it into a value within the range of [−1, 1]:

tanh(x)=2σ(2x)−1

A third example activation function is the rectified linear unit (ReLU) function. The ReLU function takes a real-valued input and thresholds it above zero (i.e., replacing negative values with zero):

f(x)=max(0,x).

It will be apparent that the above activation functions are provided as examples and in various embodiments, neural network 8840 may utilize a variety of activation functions including (but not limited to) identity, binary step, logistic, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, softexponential, sinusoid, sinc, gaussian, softmax, maxout, and/or a combination of activation functions.

In the example shown in FIG. 77, nodes 8842, 8844, 8846, 8848 and 8850 in the input layer may take external inputs x1, x2, x3, x4 and x5 which may be numerical values depending upon the input dataset. It will be understood that even though only five inputs are shown in FIG. 77, in various implementations, a node may include tens, hundreds, thousands, or more inputs. As discussed above, no computation is performed on the input layer and thus the outputs from nodes 8842, 8844, 8846, 8848 and 8850 of input layer are x1, x2, x3, x4 and x5 respectively, which are fed into hidden layer. The output of node 8852 in the hidden layer may depend on the outputs from the input layer (x1, x2, x3, x4 and x5) and weights associated with connections (w1, w2, w3, w4 and w5). Thus, the output from node 8852 may be computed as:

Y₈₈₅₂=f(x1w1+x2w2+x3w3+x4w4+x5w5+b₈₈₅₂).

The outputs from the nodes 8854 and 8856 in the hidden layer may also be computed in a similar manner and then be fed to the node 8858 in the output layer. Node 8858 in the output layer may perform similar computations (using weights v1, v2 and v3 associated with the connections) as the nodes 8852, 8854 and 8856 in the hidden layers:

Y₈₈₅₈=f(y₈₈₅₂v1+y₈₈₅₄v2+y₈₈₅₆v3+b₈₈₅₈);

where Y₈₈₅₈ is the output of the neural network 8840.

As mentioned, the connections between nodes in the neural network have associated weights, which determine how much relative effect an input value has on the output value of the node in question. Before the network is trained, random values are selected for each of the weights. The weights are adjusted during the training process and this adjustment of weights to determine the best set of weights that maximize the accuracy of the neural network is referred to as training. For every input in a training dataset, the output of the artificial neural network may be observed and compared with the expected output, and the error between the expected output and the observed output may be propagated back to the previous layer. The weights may be adjusted accordingly based on the error. This process is repeated until the output error is below a predetermined threshold.

In embodiments, backpropagation (e.g., backward propagation of errors) is utilized with an optimization method such as gradient descent to adjust weights and update the neural network characteristics. Backpropagation may be a supervised training scheme that learns from labeled training data and errors at the nodes by changing parameters of the neural network to reduce the errors. For example, a result of forward propagation (e.g., output activation value(s)) determined using training input data is compared against a corresponding known reference output data to calculate a loss function gradient. The gradient may be then utilized in an optimization method to determine new updated weights in an attempt to minimize a loss function. For example, to measure error, the mean square error is determined using the equation:

E=(target−output)²

To determine the gradient for a weight “w,” a partial derivative of the error with respect to the weight may be determined, where:

gradient=∂E/∂w

The calculation of the partial derivative of the errors with respect to the weights may flow backwards through the node levels of the neural network. Then a portion (e.g., ratio, percentage, etc.) of the gradient is subtracted from the weight to determine the updated weight. The portion may be specified as a learning rate “a.” Thus an example equation of determining the updated weight is given by the formula:

w new=w old−α∂E/∂w

The learning rate must be selected such that it is not too small (e.g., a rate that is too small may lead to a slow convergence to the desired weights) and not too large (e.g., a rate that is too large may cause the weights to not converge to the desired weights).

After the weight adjustment, the network should perform better than before for the same input because the weights have now been adjusted to minimize the errors.

As mentioned, neural networks may include convolutional neural networks (CNN). A CNN is a specialized neural network for processing data having a known, grid-like topology, such as image data. Accordingly, CNNs are commonly used for classification, object recognition and computer vision applications, but they also may be used for other types of pattern recognition such as speech and language processing.

A convolutional neural network learns highly non-linear mappings by interconnecting layers of artificial neurons arranged in many different layers with activation functions that make the layers dependent. It includes one or more convolutional layers, interspersed with one or more sub-sampling layers and non-linear layers, which are typically followed by one or more fully connected layers.

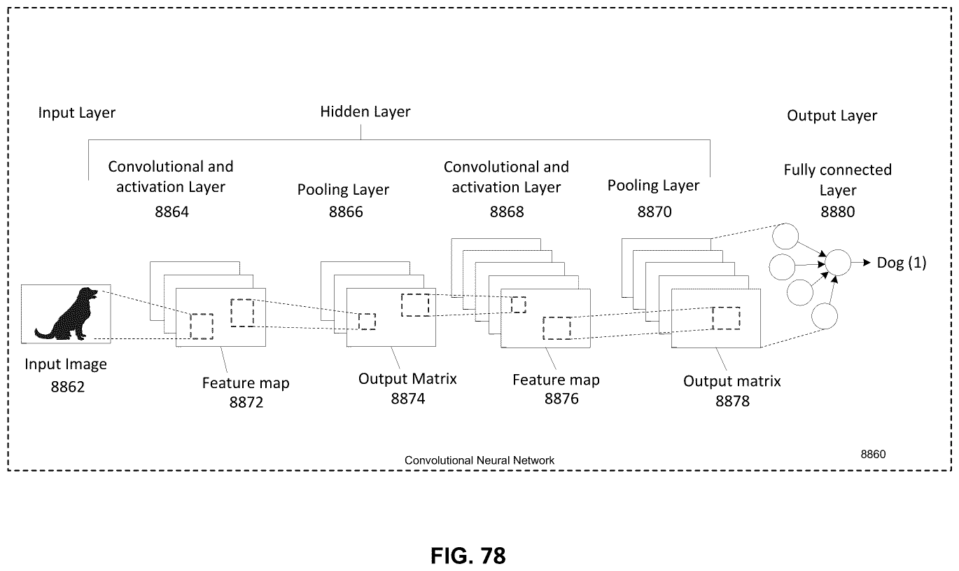

Referring to FIG. 78, a CNN 8860 includes an input layer with an input image 8862 to be classified by the CNN 8860, a hidden layer which in turn includes one or more convolutional layers, interspersed with one or more activation or non-linear layers (e.g., ReLU) and pooling or sub-sampling layers and an output layer-typically including one or more fully connected layers. Input image 8862 may be represented by a matrix of pixels and may have multiple channels. For example, a colored image may have a red, a green, and blue channels each representing red, green, and blue (RGB) components of the input image. Each channel may be represented by a 2-D matrix of pixels having pixel values in the range of 0 to 255. A gray-scale image on the other hand may have only one channel. The following section describes processing of a single image channel using CNN 8860. It will be understood that multiple channels may be processed in a similar manner.

As shown, input image 8862 may be processed by the hidden layer, which includes sets of convolutional and activation layers 8864 and 8868, each followed by pooling layers 8866 and 8870.

The convolutional layers of the convolutional neural network serve as feature extractors capable of learning and decomposing the input image into hierarchical features. The convolution layers may perform convolution operations on the input image where a filter (also referred as a kernel or feature detector) may slide over the input image at a certain step size (referred to as the stride). For every position (or step), element-wise multiplications between the filter matrix and the overlapped matrix in the input image may be calculated and summed to get a final value that represents a single element of an output matrix constituting a feature map. The feature map refers to image data that represents various features of the input image data and may have smaller dimensions as compared to the input image. The activation or non-linear layers use different non-linear trigger functions to signal distinct identification of likely features on each hidden layer. Non-linear layers use a variety of specific functions to implement the non-linear triggering, including the rectified linear units (ReLUs), hyperbolic tangent, absolute of hyperbolic tangent and sigmoid functions. In one implementation, a ReLU activation implements the function y=max (x, 0) and keeps the input and output sizes of a layer the same. The advantage of using ReLU is that the convolutional neural network is trained many times faster. ReLU is a non-continuous, non-saturating activation function that is linear with respect to the input if the input values are larger than zero and zero otherwise.

As shown in FIG. 78, the first convolution and activation layer 8864 may perform convolutions on input image 8862 using multiple filters followed by non-linearity operation (e.g., ReLU) to generate multiple output matrices (or feature maps) 8872. The number of filters used may be referred to as the depth of the convolution layer. Thus, the first convolution and activation layer 8864 in the example of FIG. 78 has a depth of three and generates three feature maps using three filters. Feature maps 8872 may then be passed to the first pooling layer that may sub-sample or down-sample the feature maps using a pooling function to generate output matrix 8874. The pooling function replaces the feature map with a summary statistic to reduce the spatial dimensions of the extracted feature map thereby reducing the number of parameters and computations in the network. Thus, the pooling layer reduces the dimensionality of the feature maps while retaining the most important information. The pooling function can also be used to introduce translation invariance into the neural network, such that small translations to the input do not change the pooled outputs. Different pooling functions may be used in the pooling layer, including max pooling, average pooling, and 12-norm pooling.

Output matrix 8874 may then be processed by a second convolution and activation layer 8868 to perform convolutions and non-linear activation operations (e.g., ReLU) as described above to generate feature maps 8876. In the example shown in FIG. 78, second convolution and activation layer 8868 may have a depth of five. Feature maps 8876 may then be passed to a pooling layer 8870, where feature maps 8876 may be subsampled or down-sampled to generate an output matrix 8878.

Output matrix 8878 generated by pooling layer 8870 is then processed by one or more fully connected layer 8880 that forms a part of the output layer of CNN 8860. The fully connected layer 8880 has a full connection with all the feature maps of the output matrix 8878 of the pooling layer 8870. In embodiments, the fully connected layer 8880 may take the output matrix 8878 generated by the pooling layer 8870 as the input in vector form, and perform high-level determination to output a feature vector containing information of the structures in the input image. In embodiments, the fully-connected layer 8880 may classify the object in input image 8862 into one of several categories using a Softmax function. The Softmax function may be used as the activation function in the output layer and takes a vector of real-valued scores and maps it to a vector of values between zero and one that sum to one. In embodiments, other classifiers, such as a support vector machine (SVM) classifier, may be used.

In embodiments, one or more normalization layers may be added to the CNN 8860 to normalize the output of the convolution filters. The normalization layer may provide whitening or lateral inhibition, avoid vanishing or exploding gradients, stabilize training, and enable learning with higher rates and faster convergence. In embodiments, the normalization layers are added after the convolution layer but before the activation layer.

CNN 8860 may thus be seen as multiple sets of convolution, activation, pooling, normalization and fully connected layers stacked together to learn, enhance and extract implicit features and patterns in the input image 8862. A layer as used herein, can refer to one or more components that operate with similar function by mathematical or other functional means to process received inputs to generate/derive outputs for a next layer with one or more other components for further processing within CNN 8860.

The initial layers of CNN 8860 e.g., convolution layers, may extract low level features such as edges and/or gradients from the input image 8862. Subsequent layers may extract or detect progressively more complex features and patterns such as presence of curvatures and textures in image data and so on. The output of each layer may serve as an input of a succeeding layer in CNN 8860 to learn hierarchical feature representations from data in the input image 8862. This allows convolutional neural networks to efficiently learn increasingly complex and abstract visual concepts.

Although only two convolution layers are shown in the example, the present disclosure is not limited to the example architecture, and CNN 8860 architecture may comprise any number of layers in total, and any number of layers for convolution, activation and pooling. For example, there have been many variations and improvements over the basic CNN model described above. Some examples include Alexnet, GoogLeNet, VGGNet (that stacks many layers containing narrow convolutional layers followed by max pooling layers), Residual network or ResNet (that uses residual blocks and skip connections to learn residual mapping), DenseNet (that connects each layer of CNN to every other layer in a feed-forward fashion), Squeeze and excitation networks (that incorporate global context into features) and AmobeaNet (that uses evolutionary algorithms to search and find optimal architecture for image recognition).

### Training of Convolutional Neural Network

The training process of a convolutional neural network, such as CNN 8860, may be similar to the training process discussed in FIG. 77 with respect to neural network 8840.

In embodiments, all parameters and weights (including the weights in the filters and weights for the fully-connected layer are initially assigned (e.g., randomly assigned). Then, during training, a training image or images, in which the objects have been detected and classified, are provided as the input to the CNN 8860, which performs the forward propagation steps. In other words, CNN 8860 applies convolution, non-linear activation, and pooling layers to each training image to determine the classification vectors (i.e., detect and classify each training image). These classification vectors are compared with the predetermined classification vectors. The error (e.g., the squared sum of differences, log loss, softmax log loss) between the classification vectors of the CNN and the predetermined classification vectors is determined. This error is then employed to update the weights and parameters of the CNN in a backpropagation process which may use gradient descent and may include one or more iterations. The training process is repeated for each training image in the training set.

The training process and inference process described above may be performed on hardware, software, or a combination of hardware and software. However, training a convolutional neural network like CNN 8860 or using the trained CNN for inference generally requires significant amounts of computation power to perform, for example, the matrix multiplications or convolutions. Thus, specialized hardware circuits, such as graphic processing units (GPUs), tensor processing units (TPUs), neural network processing units (NPUs), FPGAs, ASICs, or other highly parallel processing circuits may be used for training and/or inference. Training and inference may be performed on a cloud, on a data center, or on a device.

### Region Based CNNS (RCNNS) and Object Detection

In embodiments, an object detection model extends the functionality of CNN based image classification neural network models by not only classifying objects but also determining their locations in an image in terms of bounding boxes. Region-based CNN (R-CNN) methods are used to extract regions of interest (ROI), where each ROI is a rectangle that may represent the boundary of an object in image. Conceptually, R-CNN operates in two phases. In a first phase, region proposal methods generate all potential bounding box candidates in the image. In a second phase, for every proposal, a CNN classifier is applied to distinguish between objects. Alternatively, a fast R-CNN architecture can be used, which integrates the feature extractor and classifier into a unified network. Another faster R-CNN can be used, which incorporates a Region Proposal Network (RPN) and fast R-CNN into an end-to-end trainable framework. Mask R-CNN adds instance segmentation, while mesh R-CNN adds the ability to generate a 3D mesh from a 2D image.

In embodiments, artificial intelligence modules 8804 may provide access to and/or integrate a robotic process automation (RPA) module 8816. The RPA module 8816 may facilitate, among other things, computer automation of producing and validating workflows. In embodiments, an RPA module 8816 may monitor human interaction with various systems to learn patterns and processes performed by humans in performance of respective tasks. This may include observation of human actions that involve interactions with hardware elements, with software interfaces, and with other elements. Observations may include field observations as humans perform real tasks, as well as observations of simulations or other activities in which a human performs an action with the explicit intent to provide a training data set or input for the RPA system, such as where a human tags or labels a training data set with features that assist the RPA system in learning to recognize or classify features or objects, among many other examples. In embodiments, an RPA module 8816 may learn to perform certain tasks based on the learned patterns and processes, such that the tasks may be performed by the RPA module 8816 in lieu or in support of a human decision maker. Examples of RPA modules 8816 may encompass those in this disclosure and in the documents incorporated by reference herein and may involve automation of any of the wide range of value chain network activities or entities described therein.

In embodiments, the artificial intelligence modules 8804 may include and/or provide access to an analytics module 8818. In embodiments, an analytics module 8818 is configured to perform various analytical processes on data output from value chain entities or other data sources. In example embodiments, analytics produced by the analytics module 8818 may facilitate quantification of system performance as compared to a set of goals and/or metrics. The goals and/or metrics may be preconfigured, determined dynamically from operating results, and the like. Examples of analytics processes that can be performed by an analytics module 8818 are discussed below and in the document incorporated herein by reference. In some example implementations, analytics processes may include tracking goals and/or specific metrics that involve coordination of value chain activities and demand intelligence, such as involving forecasting demand for a set of relevant items by location and time (among many others).

In embodiments, artificial intelligence modules 8804 may include and/or provide access to a digital twin module 8820. The digital twin module 8820 may encompass any of a wide range of features and capabilities described herein In embodiments, a digital twin module 8820 may be configured to provide, among other things, execution environments for and different types of digital twins, such as twins of physical environments, twins of robot operating units, logistics twins, executive digital twins, organizational digital twins, role-based digital twins, and the like. In embodiments, the digital twin module 8820 may be configured in accordance with digital twin systems and/or modules described elsewhere throughout the disclosure. In example embodiments, a digital twin module 8820 may be configured to generate digital twins that are requested by intelligence clients 8836. Further, the digital twin module 8820 may be configured with interfaces, such as APIs and the like for receiving information from external data sources. For instance, the digital twin module 8820 may receive real-time data from sensor systems of a machinery, vehicle, robot, or other device, and/or sensor systems of the physical environment in which a device operates. In embodiments, the digital twin module 8820 may receive digital twin data from other suitable data sources, such as third-party services (e.g., weather services, traffic data services, logistics systems and databases, and the like. In embodiments, the digital twin module 8820 may include digital twin data representing features, states, or the like of value chain network entities, such as supply chain infrastructure entities, transportation or logistic entities, containers, goods, or the like, as well as demand entities, such as customers, merchants, stores, points-of-sale, points-of-use, and the like. The digital twin module 8820 may be integrated with or into, link to, or otherwise interact with an interface (e.g., a control tower or dashboard), for coordination of supply and demand, including coordination of automation within supply chain activities and demand management activities.

In embodiments, a digital twin module 8820 may provide access to and manage a library of digital twins. Artificial intelligence modules 8804 may access the library to perform functions, such as a simulation of actions in a given environment in response to certain stimuli.

In embodiments, artificial intelligence modules 8804 may include and/or provide access to a machine vision module 8822. In embodiments, a machine vision module 8822 is configured to process images (e.g., captured by a camera) to detect and classify objects in the image. In embodiments, the machine vision module 8822 receives one or more images (which may be frames of a video feed or single still shot images) and identifies “blobs” in an image (e.g., using edge detection techniques or the like). The machine vision module 8822 may then classify the blobs. In some embodiments, the machine vision module 8822 leverages one or more machine-learned image classification models and/or neural networks (e.g., convolutional neural networks) to classify the blobs in the image. In some embodiments, the machine vision module 8822 may perform feature extraction on the images and/or the respective blobs in the image prior to classification. In some embodiments, the machine vision module 8822 may leverage classification made in a previous image to affirm or update classification(s) from the previous image. For example, if an object that was detected in a previous frame was classified with a lower confidence score (e.g., the object was partially occluded or out of focus), the machine vision module 8822 may affirm or update the classification if the machine vision module 8822 is able to determine a classification of the object with a higher degree of confidence. In embodiments, the machine vision module 8822 is configured to detect occlusions, such as objects that may be occluded by another object. In embodiments, the machine vision module 8822 receives additional input to assist in image classification tasks, such as from a radar, a sonar, a digital twin of an environment (which may show locations of known objects), and/or the like. In some embodiments, a machine-vision module 8822 may include or interface with a liquid lens. In these embodiments, the liquid lens may facilitate improved machine vision (e.g., when focusing at multiple distances is necessitated by the environment and job of a robot) and/or other machine vision tasks that are enabled by a liquid lens.

In embodiments, the artificial intelligence modules 8804 may include and/or provide access to a natural language processing (NLP) module 8824. In embodiments, an NLP module 8824 performs natural language tasks on behalf of an intelligence service client 8836. Examples of natural language processing techniques may include, but are not limited to, speech recognition, speech segmentation, speaker diarization, text-to-speech, lemmatization, morphological segmentation, parts-of-speech tagging, stemming, syntactic analysis, lexical analysis, and the like. In embodiments, the NLP module 8824 may enable voice commands that are received from a human. In embodiments, the NLP module 8824 receives an audio stream (e.g., from a microphone) and may perform voice-to-text conversion on the audio stream to obtain a transcription of the audio stream. The NLP module 8824 may process text (e.g., a transcription of the audio stream) to determine a meaning of the text using various NLP techniques (e.g., NLP models, neural networks, and/or the like). In embodiments, the NLP module 8824 may determine an action or command that was spoken in the audio stream based on the results of the NLP. In embodiments, the NLP module 8824 may output the results of the NLP to an intelligence service client 8836.

In embodiments, the NLP module 8824 provides an intelligence service client 8836 with the ability to parse one or more conversational voice instructions provided by a human user to perform one or more tasks as well as communicate with the human user. The NLP module 8824 may perform speech recognition to recognize the voice instructions, natural language understanding to parse and derive meaning from the instructions, and natural language generation to generate a voice response for the user upon processing of the user instructions. In some embodiments, the NLP module 8824 enables an intelligence service client 8836 to understand the instructions and, upon successful completion of the task by the intelligence service client 8836, provide a response to the user. In embodiments, the NLP module 8824 may formulate and ask questions to a user if the context of the user request is not completely clear. In embodiments, the NLP module 8824 may utilize inputs received from one or more sensors including vision sensors, location-based data (e.g., GPS data) to determine context information associated with processed speech or text data.

In embodiments, the NLP module 8824 uses neural networks when performing NLP tasks, such as recurrent neural networks, long short term memory (LSTMs), gated recurrent unit (GRUs), transformer neural networks, convolutional neural networks and/or the like.

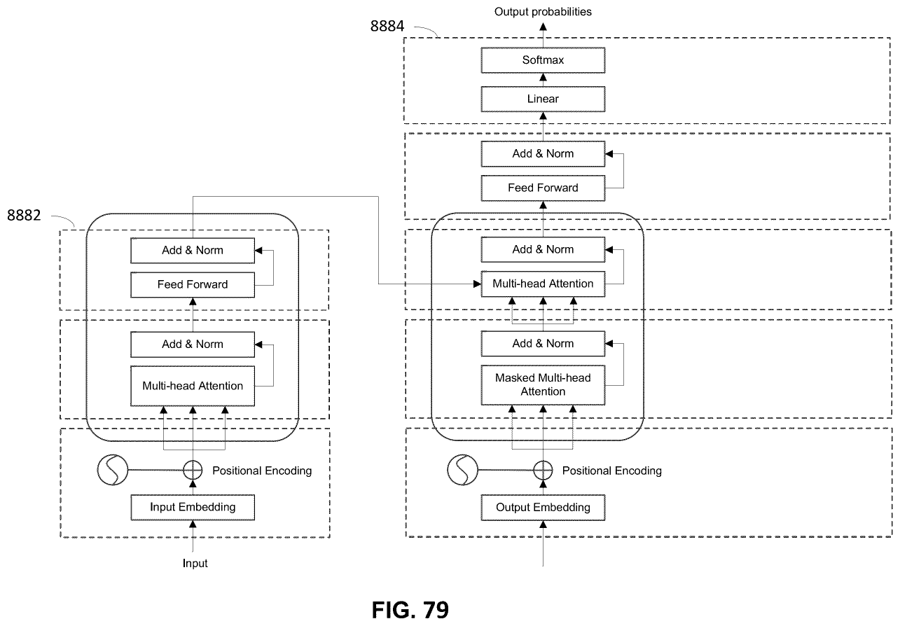

FIG. 79 illustrates an example neural network 8800 for implementing NLP module 8824. In the illustrated example, the example neural network is a transformer neural network. In the example, the transformer neural network 8800 includes three input stages and five output stages to transform an input sequence into an output sequence. The example transformer includes an encoder 8802 and a decoder 8804. The encoder 8802 processes input, and the decoder 8804 generates output probabilities, for example. The encoder 8802 includes three stages, and the decoder 8804 includes five stages. Encoder 8802 stage 1 represents an input as a sequence of positional encodings added to embedded inputs. Encoder 8802 stages 2 and 3 include N layers (e.g., N=6, etc.) in which each layer includes a position-wise feedforward neural network (FNN) and an attention-based sublayer. Each attention-based sublayer of encoder 8802 stage 2 includes four linear projections and multi-head attention logic to be added and normalized to be provided to the position-wise FNN of encoder 8802 stage 3. Encoder 8802 stages 2 and 3 employ a residual connection followed by a normalization layer at their output.

The example decoder 8804 processes an output embedding as its input with the output embedding shifted right by one position to help ensure that a prediction for position i is dependent on positions previous to/less than i. In stage 2 of the decoder 8804, masked multi-head attention is modified to prevent positions from attending to subsequent positions. Stages 3-4 of the decoder 8804 include N layers (e.g., N=6, etc.) in which each layer includes a position-wise FNN and two attention-based sublayers. Each attention-based sublayer of decoder 8804 stage 3 includes four linear projections and multi-head attention logic to be added and normalized to be provided to the position-wise FNN of decoder 8804 stage 4. Decoder 8804 stages 2-4 employ a residual connection followed by a normalization layer at their output. Decoder 8804 stage 5 provides a linear transformation followed by a softmax function to normalize a resulting vector of K numbers into a probability distribution 8806 including K probabilities proportional to exponentials of the K input numbers.

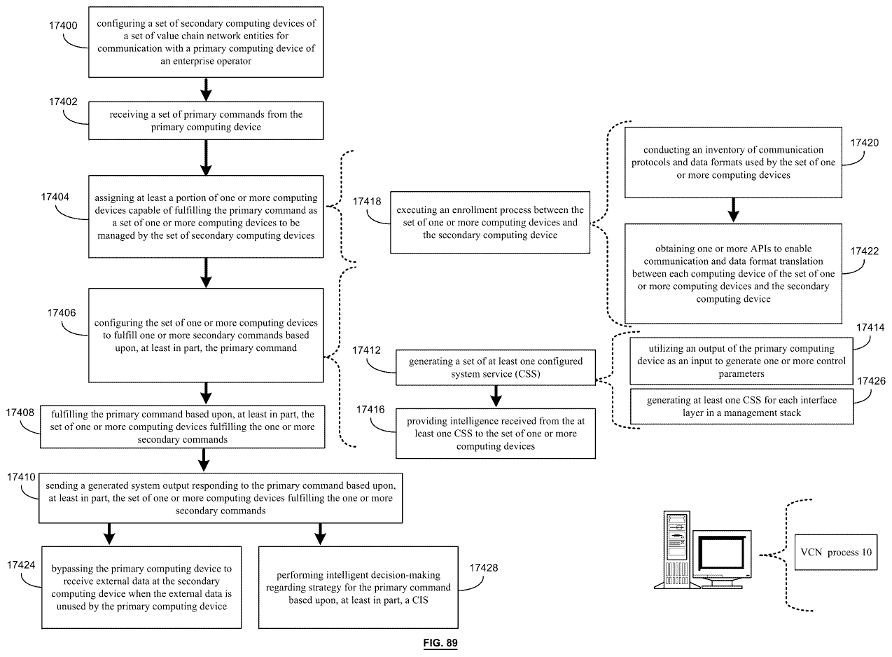

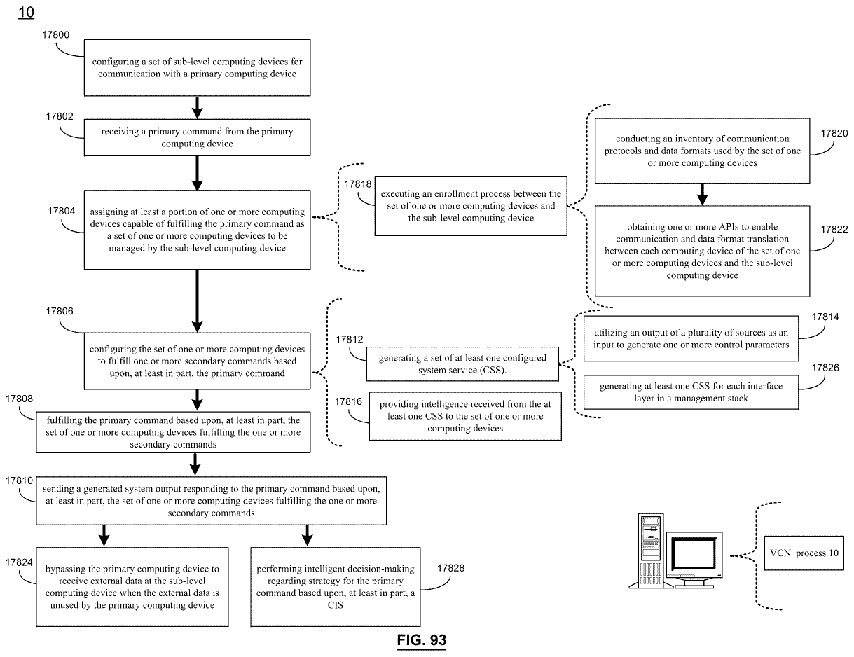

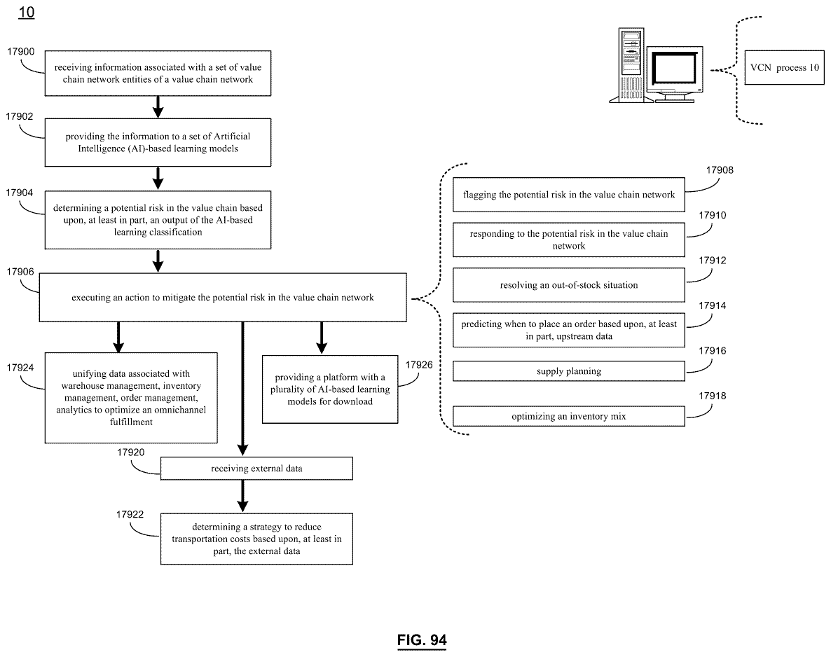

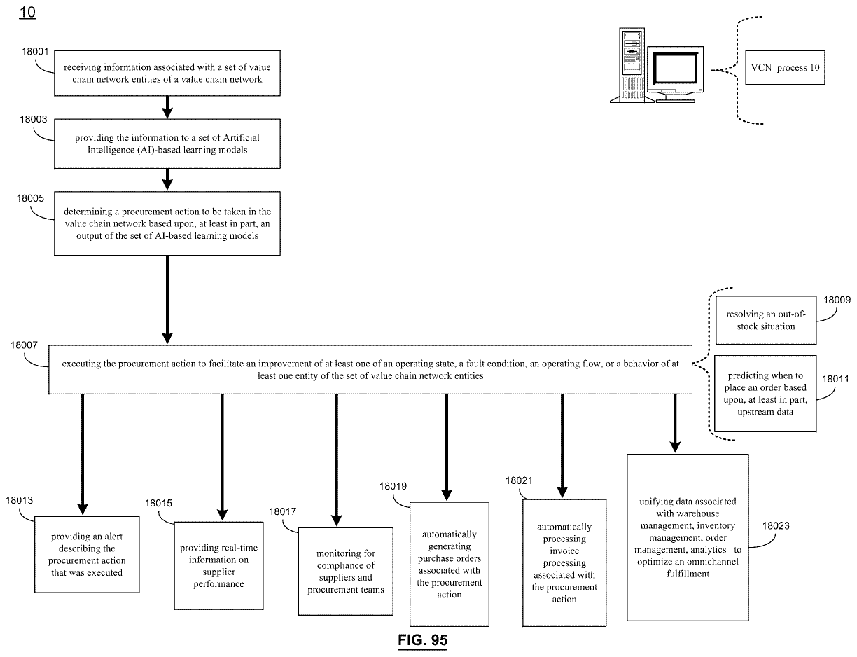

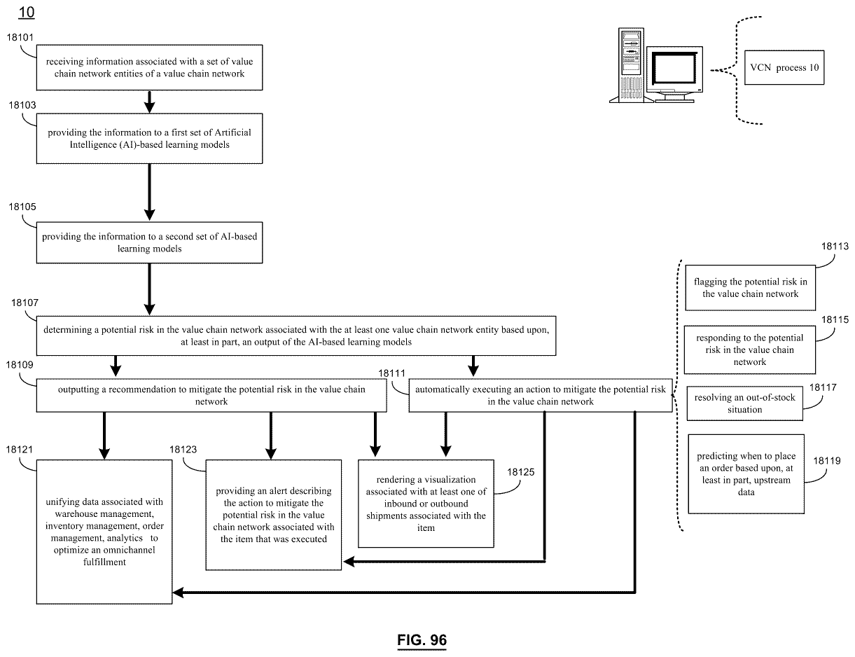

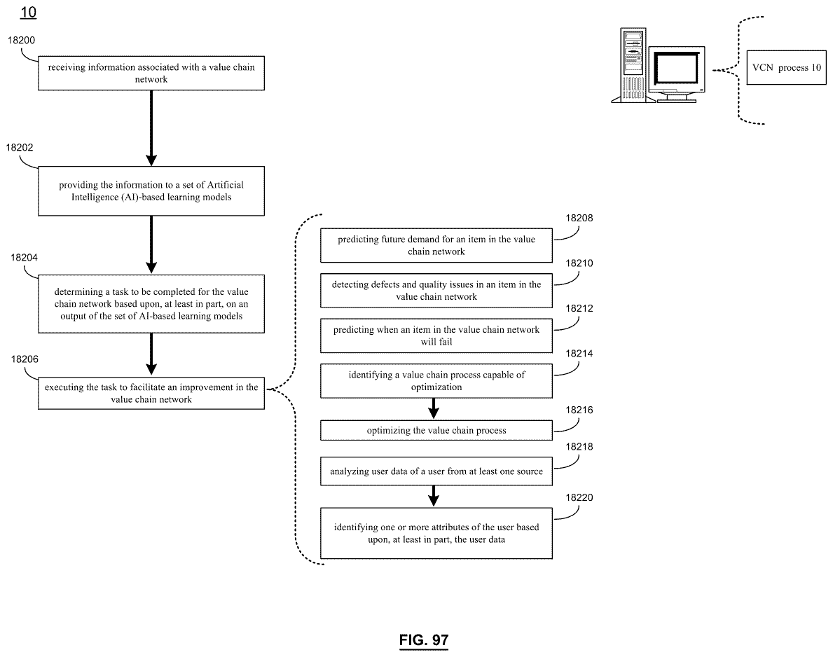

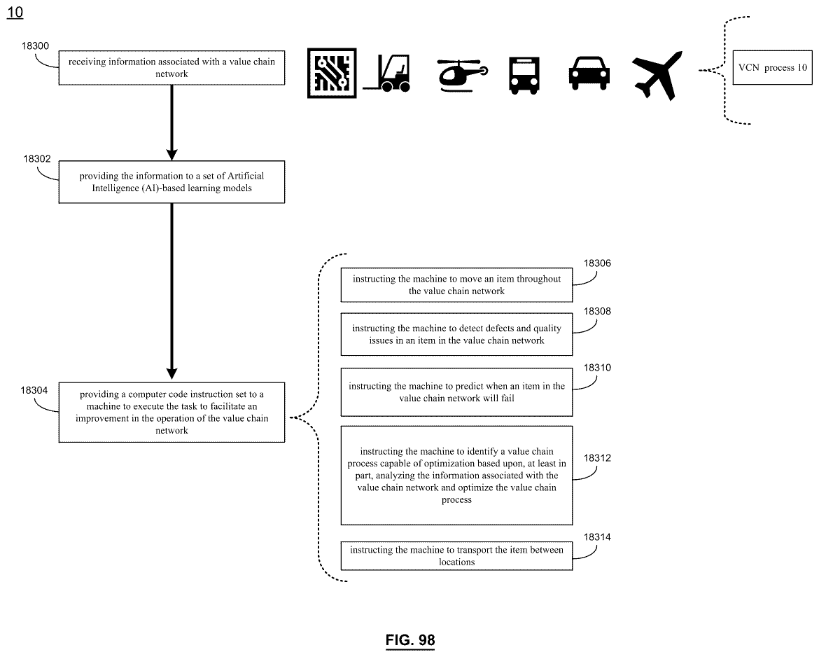

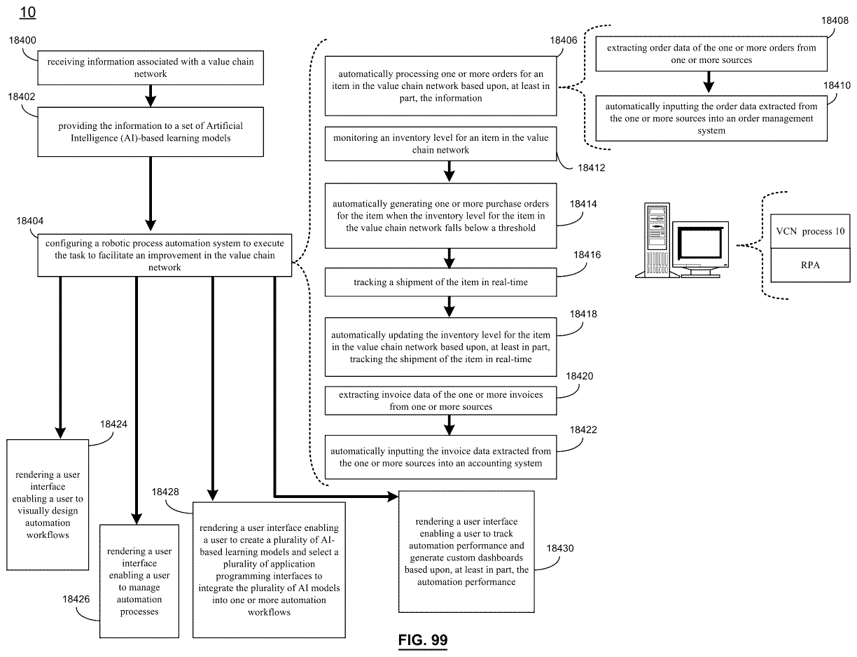

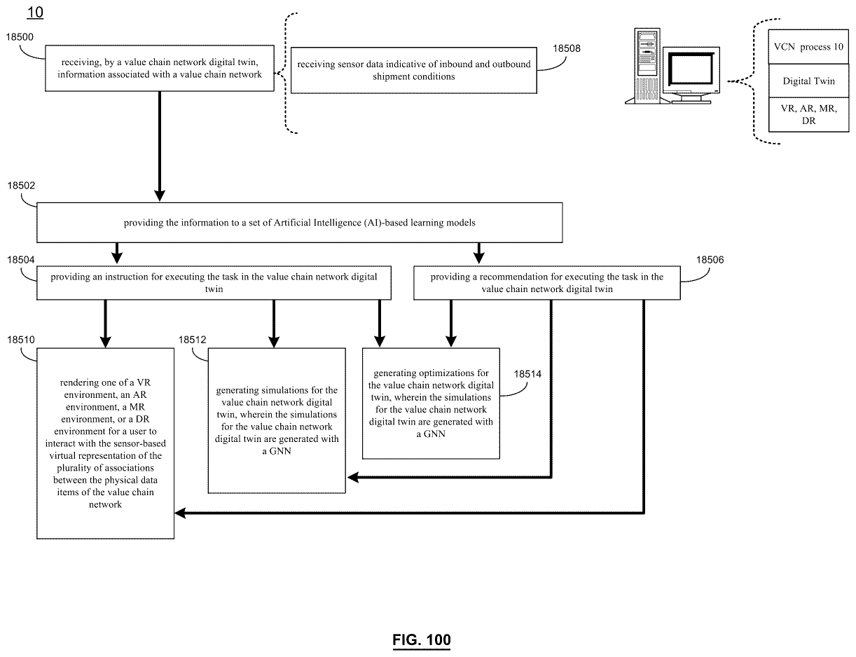

Additional examples of neural networks may be found elsewhere in the disclosure (e.g., FIGS. 78-103).

Referring back to FIG. 76, in embodiments, artificial intelligence modules 8804 may also include and/or provide access to a rules-based module 8828 that may be integrated into or be accessed by an intelligence service client 8836. In some embodiments, a rules-based module 8828 may be configured with programmatic logic that defines a set of rules and other conditions that trigger certain actions that may be performed in connection with an intelligence client. In embodiments, the rule-based module 8828 may be configured with programmatic logic that receives input and determines whether one or more rules are met based on the input. If a condition is met, the rules-based module 8828 determines an action to perform, which may be output to a requesting intelligence service client 8836. The data received by the rules-based engine may be received from an intelligence service input source 8832 and/or may be requested from another module in artificial intelligence modules 8804, such as the machine vision module 8822, the neural network module 8814, the ML module 8812, and/or the like. For example, a rule-based module 8828 may receive classifications of objects in a field of view of a mobile system (e.g., robot, autonomous vehicle, or the like) from a machine vision system and/or sensor data from a lidar sensor of the mobile system and, in response, may determine whether the mobile system should continue in its path, change its course, or stop. In embodiments, the rules-based module 8828 may be configured to make other suitable rules-based decisions on behalf of a respective client 8836, examples of which are discussed throughout the disclosure. In some embodiments, the rules-based engine may apply governance standards and/or analysis modules, which are described in greater detail below.

In embodiments, artificial intelligence modules 8804 interface with an intelligence service controller 8802, which is configured to determine a type of request issued by an intelligence service client 8836 and, in response, may determine a set of governance standards and/or analyses that are to be applied by the artificial intelligence modules 8804 when responding to the request. In embodiments, the intelligence service controller 8802 may include an analysis management module 8806, a set of analysis modules 8808, and a governance library 8810.

In embodiments, an intelligence service controller 8802 is configured to determine a type of request issued by an intelligence service client 8836 and, in response, may determine a set of governance standards and/or analyses that are to be applied by the artificial intelligence modules 8804 when responding to the request. In embodiments, the intelligence service controller 8802 may include an analysis management module 8806, a set of analysis modules 8808, and a governance library 8810. In embodiments, the analysis management module 8806 receives an artificial intelligence module 8804 request and determines the governance standards and/or analyses implicated by the request. In embodiments, the analysis management module 8806 may determine the governance standards that apply to the request based on the type of decision that was requested and/or whether certain analyses are to be performed with respect to the requested decision. For example, a request for a control decision that results in an intelligence service client 8836 performing an action may implicate a certain set of governance standards that apply, such as safety standards, legal standards, quality standards, or the like, and/or may implicate one or more analyses regarding the control decision, such as a risk analysis, a safety analysis, an engineering analysis, or the like.

In some embodiments, the analysis management module 8806 may determine the governance standards that apply to a decision request based on one or more conditions. Non-limiting examples of such conditions may include the type of decision that is requested, a geolocation in which a decision is being made, an environment that the decision will affect, current or predicted environment conditions of the environment and/or the like. In embodiments, the governance standards may be defined as a set of standards libraries stored in a governance library 8810. In embodiments, standards libraries may define conditions, thresholds, rules, recommendations, or other suitable parameters by which a decision may be analyzed. Examples of standards libraries may include, legal standards library, a regulatory standards library, a quality standards library, an engineering standards library, a safety standards library, a financial standards library, and/or other suitable types of standards libraries. In embodiments, the governance library 8810 may include an index that indexes certain standards defined in the respective standards library based on different conditions. Examples of conditions may be a jurisdiction or geographic areas to which certain standards apply, environmental conditions to which certain standards apply, device types to which certain standards apply, materials or products to which certain standards apply, and/or the like.

In some embodiments, the analysis management module 8806 may determine the appropriate set of standards that must be applied with respect to a particular decision and may provide the appropriate set of standards to the artificial intelligence modules 8804, such that the artificial intelligence modules 8804 leverages the implicated governance standards when determining a decision. In these embodiments, the artificial intelligence modules 8804 may be configured to apply the standards in the decision-making process, such that a decision output by the artificial intelligence modules 8804 is consistent with the implicated governance standards. It is appreciated that the standards libraries in the governance library may be defined by the platform provider, customers, and/or third parties. The standards may be government standards, industry standards, customer standards, or other suitable sources. In embodiments, each set of standards may include a set of conditions that implicate the respective set of standards, such that the conditions may be used to determine which standards to apply given a situation.

In some embodiments, the analysis management module 8806 may determine one or more analyses that are to be performed with respect to a particular decision and may provide corresponding analysis modules 8808 that perform those analyses to the artificial intelligence modules 8804, such that the artificial intelligence modules 8804 leverage the corresponding analysis modules 8808 to analyze a decision before outputting the decision to the requesting client. In embodiments, the analysis modules 8808 may include modules that are configured to perform specific analyses with respect to certain types of decisions, whereby the respective modules are executed by a processing system that hosts the instance of the intelligence services 8800. Non-limiting examples of analysis modules 8808 may include risk analysis module(s), security analysis module(s), decision tree analysis module(s), ethics analysis module(s), failure mode and effects (FMEA) analysis module(s), hazard analysis module(s), quality analysis module(s), safety analysis module(s), regulatory analysis module(s), legal analysis module(s), and/or other suitable analysis modules.

In some embodiments, the analysis management module 8806 is configured to determine which types of analyses to perform based on the type of decision that was requested by an intelligence service client 8836. In some of these embodiments, the analysis management module 8806 may include an index or other suitable mechanism that identifies a set of analysis modules 8808 based on a requested decision type. In these embodiments, the analysis management module 8806 may receive the decision type and may determine a set of analysis modules 8808 that are to be executed based on the decision type. Additionally or alternatively, one or more governance standards may define when a particular analysis is to be performed. For example, the engineering standards may define what scenarios necessitate a FMEA analysis. In this example, the engineering standards may have been implicated by a request for a particular type of decision and the engineering standards may define scenarios when an FMEA analysis is to be performed. In this example, artificial intelligence modules 8804 may execute a safety analysis module and/or a risk analysis module and may determine an alternative decision if the action would violate a legal standard or a safety standard. In response to analyzing a proposed decision, artificial intelligence modules 8804 may selectively output the proposed condition based on the results of the executed analyses. If a decision is allowed, artificial intelligence modules 8804 may output the decision to the requesting intelligence service client 8836. If the proposed configuration is flagged by one or more of the analyses, artificial intelligence modules 8804 may determine an alternative decision and execute the analyses with respect to the alternate proposed decision until a conforming decision is obtained.

It is noted here that in some embodiments, one or more analysis modules 8808 may themselves be defined in a standard, and one or more relevant standards used together may comprise a particular analysis. For example, the applicable safety standard may call for a risk analysis that can use or more allowable methods. In this example, an ISO standard for overall process and documentation, and an ASTM standard for a narrowly defined procedure may be employed to complete the risk analysis required by the safety governance standard.

As mentioned, the foregoing framework of an intelligence services 8800 may be applied in and/or leveraged by various entities of a value chain. For example, in some embodiments, a platform-level intelligence system may be configured with the entire capabilities of the intelligence services 8800, and certain configurations of the intelligence services 8800 may be provisioned for respective value chain entities. Furthermore, in some embodiments, an intelligence service client 8836 may be configured to escalate an intelligence system task to a higher-level value chain entity (e.g., edge-level or the platform-level) when the intelligence service client 8836 cannot perform the task autonomously. It is noted that in some embodiments, an intelligence service controller 8802 may direct intelligence tasks to a lower-level component. Furthermore, in some implementations, an intelligence services 8800 may be configured to output default actions when a decision cannot be reached by the intelligence services 8800 and/or a higher or lower-level intelligence system. In some of these implementations, the default decisions may be defined in a rule and/or in a standards library.

### Reinforcement Learning to Determine Optimal Policy

Reinforcement learning (RL), is a machine learning technique where an agent iteratively learns optimal policy through interactions with the environment. In RL, the agent must discover correct actions by trial-and-error so as to maximize some notion of long-term reward. Specifically, in a system employing RL, there exist two entities: (1) an environment and (2) an agent. The agent is a computer program component that is connected to its environment such that it can sense the state of the environment as well as execute actions on the environment. On each step of interaction, the agent senses the current state of the environment, s, and chooses an action to take, a. The action changes the state of the environment, and the value of this state transition is communicated to the agent by a reward signal, r, where the magnitude of r indicates the desirability of an action. Over time, the agent builds a policy, π, which specifies the action the agent will take for each state of the environment.

Formally, in reinforcement learning, there exists a discrete set of environment states, S; a discrete set of agent actions, A; and a set of scalar reinforcement signals, R. After learning, the system creates a policy, π, that defines the value of taking action aεA in state sεS. The policy defines Qπ(s, a) as the expected return value for starting from s, taking action a, and following policy π.

The reinforcement learning agent is trained in a policy through iterative exposure to various states, having the agent select an action as per the policy and providing a reward based on a function designed to reward desirable behavior. Based on the reward feedback, the system may “learn” the policy and becomes trained in producing desirable actions. For example, for navigation policy, RL agent may evaluate its state repeatedly (e.g., location, distance from a target object), select an action (e.g., provide input to the motors for movement towards the target object), evaluate the action using a reward signal, which provides an indication of the of the success of the action. (e.g., a reward of +10 if movement reduces the distance between a mobile system and a target object and −10 if the movement increases the distance). Similarly, the RL agent may be trained in grasping policy by iteratively obtaining images of a target object to be grasped, attempt to grasp the object, evaluate the attempt, and then execute the subsequent iteration using the evaluation of the attempt of the preceding iteration(s) to assist in determining the next attempt.

There may be several approaches for training the RL agent in a policy. Imitation learning is a key approach in which the agent learns from state/action pairs where the actions are those that would be chosen by an expert (e.g., a human) in response to an observed state. Imitation learning not just solves sample-inefficiency or computational feasibility problems, but also makes the training process safer. The RL agent may derive multiple examples of the state/action pairs by observing a human (e.g., navigating towards and grasping a target object), and uses them as a basis for training the policy. Behavior cloning (BC), that focuses on learning the expert's policy using supervised learning is an example of imitation learning approach.

Value based learning approach aims to find a policy comprising a sequence of actions that maximizes the expectation value of future reward (or minimizes the expected cost). The RL agent may learn the value/cost function and then derives a policy with respect to the same. Two different expectation values are often referred to: the state value V(s) and the action value Q (s,a) respectively. The state value function V(s) represents the value associated with the agent at each state whereas the action value function Q(s,a) represents the value associated with the agent at state s and performing action a. The value-based learning approach works by approximating optimal value (V* or Q*) and then deriving an optimal policy. For example, the optimal value function Q*(s, a) may be identified by finding the sequence of actions which maximize the state-action value function Q (s, a). The optimal policy for each state can be derived by identifying the highest valued action that can be taken from each state.

π*(s)=argmaxQ*(s,a)

To iteratively calculate the value function as actions within the sequence are executed and the mobile system transitions from one state to another, the Bellman Optimality equation may be applied. The optimal value function Q*(s,a) obeys Bellman Optimality equation and can be expressed as:

Q*(sₜ,aₜ)=E[rₜ₊₁+γmaxQ*(sₜ₊₁,aₜ₊₁)]

Policy based learning approach directly optimizes the policy function π using a suitable optimization technique (e.g., stochastic gradient descent) to fine tune a vector of parameters without calculating a value function. The policy-based learning approach is typically effective in high-dimensional or continuous action spaces.

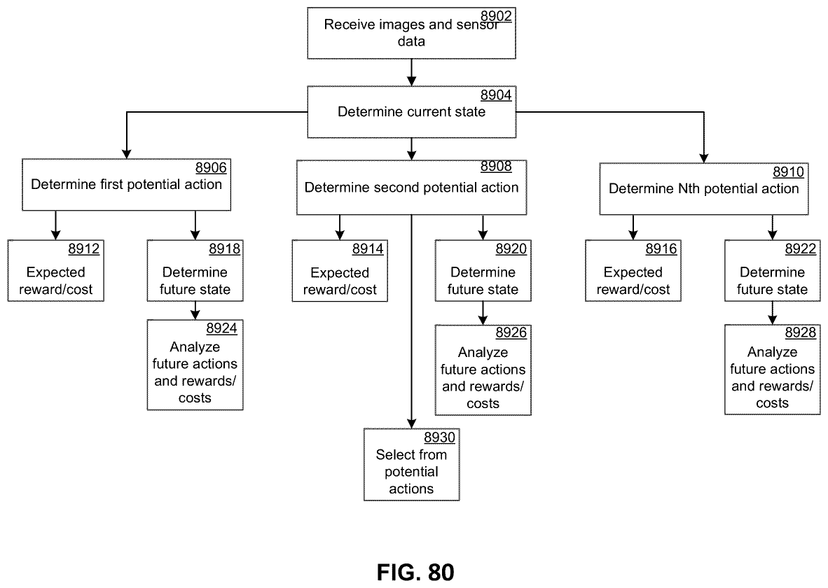

FIG. 80 illustrates an approach based on reinforcement learning and including evaluation of various states, actions and rewards in determining optimal policy for executing one or more tasks by a mobile system.

At 8902, a reinforcement learning agent (e.g., of the intelligence services system 8900) receives sensor information including a plurality of images captured by the mobile system in the environment. The analysis of one or more of these images may enable the agent to determine a first state associated with the mobile system at 8904. The data representing the first state may include information about the environment, such as images, sounds, temperature or time and information about the mobile system, including its position, speed, internal state (e.g., battery life, clock setting) etc.

At 8906, 8908, and 8910, various potential actions responsive to the state may be determined. Some examples of potential actions include providing control instructions to actuators, motors, wheels, wings flaps, or other components that controls the agent's speed, acceleration, orientation, or position; changing the agent's internal settings, such as putting certain components into a sleep mode to conserve battery life; changing the direction if the agent is in danger of colliding with an obstacle object; acquiring or transmitting data; attempting to grasp a target object and the like.

At 8912, 8914 and 8916, expected rewards may be determined for each of the potential actions based on a reward function. For each of the determined potential actions, an expected reward may be determined based on a reward function. The reward may be predicated on a desired outcome, such as avoiding an obstacle, conserving power, or acquiring data. If the action yields the desired outcome (e.g., avoiding the obstacle), the reward is high; otherwise, the reward may be low.

The agent may also look to the future to analyze whether there may be opportunities for realizing higher rewards in the future. At 8918, 8920, and 8922, the agent may determine future states resulting from potential actions respectively at 8906, 8908, and 8910.

For each of the future states predicted at 8918, 8920, and 8922, one or more future actions may be determined and evaluated. At steps 8924, 8926, and 8928, for example, values or other indicators of expected rewards associated with one or more of the future actions may be developed. The expected rewards associated with the one or more future actions may be evaluated by comparing values of reward functions associated with each future action At 8930, an action may be selected based on a comparison of expected current and future rewards.

In embodiments, the reinforcement learning agent may be pre-trained through simulations in a digital twin system. In embodiments, the reinforcement agent may be pre-trained using behavior cloning. In embodiments, the reinforcement agent may be trained using a deep reinforcement learning algorithm selected from Deep Q-Network (DQN), double deep Q-Network (DDQN), Deep Deterministic Policy Gradient (DDPG), soft actor critic (SAC), advantage actor critic (A2C), asynchronous advantage actor critic (A3C), proximal policy optimization (PPO), trust region policy optimization (TRPO).

In embodiments, the reinforcement learning agent may look to balance exploitation (of current knowledge) with exploration (of uncharted territory) while traversing the action space. For example, the agent may follow an ε-greedy policy by randomly selecting exploration occasionally with probability ε while taking the optimal action most of the time with probability 1-ε, where ε is a parameter satisfying 0<ε<1.

### Digital Product Networks

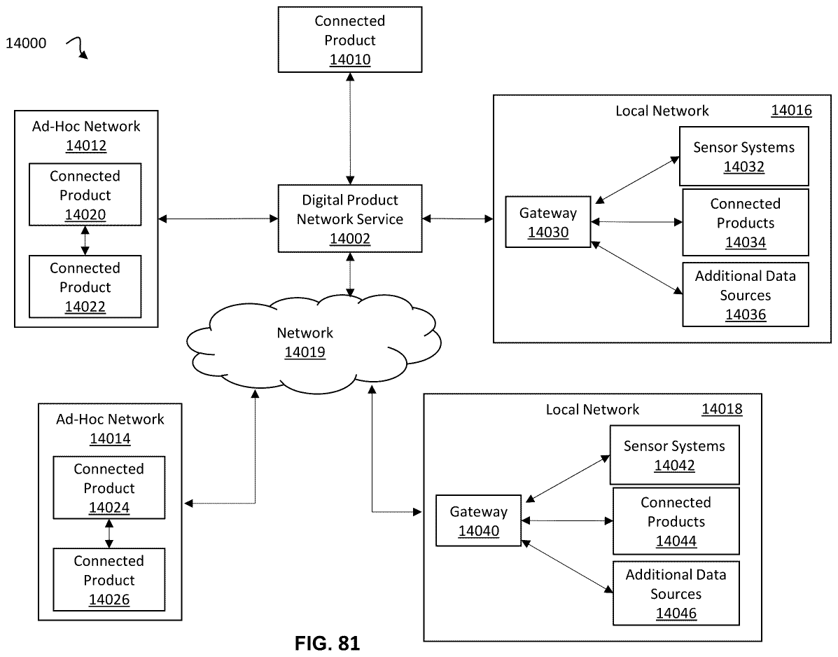

FIG. 81 illustrates communications between entities in an example digital product network 14000 according to some embodiments of the present disclosure. In some embodiments, digital product networks are communicatively coupled entities of a value chain network that may provide data related to product level behavior, product level usage, environmental data, data that is processed at the product level, and the like. For example, the product data may relate to at least one of sensors, vibration, humidity, temperature, pressure, proximity, level, accelerometers, gyroscope, infrared sensors, MEMs, liquid lenses, shock, security, machine, product, pneumatic, conductive, state dependent frequency monitor, ultrasonic, capacitance, or microwave.

An intelligence layer of the digital product network may then use the product level data to enable companies to solve challenges associated with customer demands for quality, efficiency, response, agility, and transparency. For example, the product level behavior and usage data may be combined with third-party sources to be analyzed and manipulated by artificial intelligence (AI) systems, machine learning (ML) systems, digital twin systems, robotic process automation (RPA) systems, etc. Data processing techniques may be related to at least one of obfuscation, forecasting, simulation, transformation, automation, reporting, matching, stream processing, event processing and policy, dispatch and orchestration, analytics and algorithms, or machine learning.

In some embodiments, the analytics may be related to at least one of descriptive analytics, diagnostic analytics, predictive analytics, or prescriptive analytics. The descriptive analytics describe what is happening using compressive, accurate, and live data for effective visualization. The diagnostic analytics provide ability to drill down to a root cause and an ability to isolate confounding information. The predictive analytics describe business strategy, active adaption, and simulation. The prescriptive analytics may be evidence-based recommendations to recommend actions and strategies based on challenger testing and may use advanced AI and analytical techniques to make specific recommendations.

In some embodiments, the digital product network is a network of products that have a familial relationship to each other. For example, the products may all have the same brand, be part of the same metaverse, generate data according to the same standardized format, be specifically designed to interact or communicate with each other, or the like. The digital product network collects information from different pieces of a product family to generate information and outcomes that are not available from a single product. The family may include physical goods or physical goods mixed with content. For example, the content may be technical data, user profile information, or other content.

In some embodiments, the analysis and manipulation may lead to valuable insights throughout the development, manufacturing, supply chain, and customer relationship stages of a product lifecycle. For example, emerging connectivity and technologies in connected products enable intelligent provisioning, data aggregation, and analytics that can be used to create product connection, transaction, and enablement platforms. The data generated by the connected products may be analyzed to bridge the gap between supply and demand chains.

Two of the types of interactions that may take place in the digital product network are loosely coupled interactions and platform interactions. For loosely coupled interactions, the products are not directly tied to each other. The products operate separately and do not inherently trust interactions with each other. For example, while cars are on the road, their systems do not rely on the data from other cars for vehicle steering, acceleration, or braking control. Products in these types of interactions may use shared intention information, such as when a nearby car indicates that the nearby car will soon change lanes. Products receiving and interpreting the intention may consider the intention when evaluating response patterns. Data from products that have loosely coupled interactions may be fused or integrated for use in artificial intelligence systems, machine learning systems, robotic process automation systems, digital twins, and the like.

Platform based interactions involve different products that share the same operating platform or ecosystem. This shared ecosystem is able to coordinate different kinds of response patterns and encourage or demand a specific response pattern. For example, smoke detectors in a building may be designed to operate independently, but by sharing a common framework they may trigger alarms or even critical event responses (e.g., set off sprinklers). A smoke detector may also increase its level of monitoring (e.g., frequency of sensor polling, frequency of data transmission, data fidelity) during periods of heightened alert to enable capabilities that may be otherwise dormant for reduced battery consumption. In the smoke detector example, the smoke detector may be communicatively coupled to a self-driving car system such that the car is redirected away from fire events. In some embodiments, a self-driving fire truck may drive to the fire event in response to the smoke detector alert. Such a self-responding fire truck may be beneficial where, for example, a community does not have a full-time professional fire department, such as in some rural locations where firefighters may respond to the fire location without first retrieving the fire truck.

In FIG. 81, an example of a digital product network service 14002 communicates with and executes algorithms related to a plurality of digital entities, such as connected products or intelligent products. For example, the digital product network service 14002 may be a version of the intelligence service 11T00 that is adapted for the specific functions of the digital product network 14000 described below.

In some example embodiments, the connected product may be enabled with a set of capabilities such as data processing, networking, sensing, autonomous operation, intelligent agent, natural language processing, speech recognition, voice recognition, touch interfaces, remote control, self-organization, self-healing, process automation, computation, artificial intelligence, analog or digital sensors, cameras, sound processing systems, data storage, data integration, and/or various Internet of Things (IoT) capabilities, among others. The connected product may include a form of information technology. The connected product may have a processor, computer random access memory, and a communication module. The product may be considered a value chain network entity that fits in a value chain network to provide product usage data.

In the example provided, a connected product 14010, an ad-hoc network 14012, an ad-hoc network 14014, a local network 14016, and a local network 14018 communicate with the digital product network service 14002 directly or through a network 14019.

The connected products may be consumer products, industrial products, or other products that have digital components that may communicate with or at least partially include the digital product network service 14002. The connected products may be various entities within various industries. For example, each of the connected products may relate to apparel, electronics (general), computers and computer peripherals, chemicals (specialty), machinery, food processing, auto parts, steel, retail (online), retail (distributors), retail (special lines), retail (general), retail (grocery and food), electronics (consumer and office), farming/agriculture, food wholesalers, or healthcare products.

The connected product 14010 communicates directly with the digital product network service. For example, the connected product 14010 may include an antenna to send electromagnetic band communications directly to an entity that hosts the digital product network service 14002. In some embodiments, the digital product network service 14002 is at least partially hosted within the connected product 14010. For example, the connected product 14010 may include sensors that send sensor data directly to various intelligence layer modules of the digital product network service 14002 that are programmed into processors of the connected product 14010.

The ad-hoc network 14012 includes a connected product 14020 and a connected product 14022. The connected product 14020 and the connected product 14022 communicate directly with each other and collectively communicate with the digital product network service 14002.

The ad-hoc network 14014 includes a connected product 14024 and a connected product 14026. The connected product 14024 and the connected product 14026 communicate directly with each other and communicate with the digital product network service 14002 through the network 14019.

The local network 14016 includes a gateway 14030, at least one sensor system 14032, at least one connected product 14034, and additional data sources 14036. In the example provided, the gateway 14030 communicates with each of the sensor systems 14032, connected products 14034, and additional data sources 14036. The gateway 14030 then communicates directly with the digital product network service 14002. In some embodiments, the gateway 14030 hosts the digital product network service 14002.

The local network 14018 includes a gateway 14040, at least one sensor system 14042, at least one connected product 14044, and at least one additional data source 14046. The gateway 14040 communicates with each of the sensor systems 14042, connected products 14044, and additional data sources 14046. The gateway 14040 then communicates with the digital product network service 14002 through the network 14019. For example, the gateway 14040 may be a router or home automation system hub.

Network 14019 may be any network for communicating data across large distances. In the example provided, the network 14019 is the Internet accessed through an internet service provider (ISP).

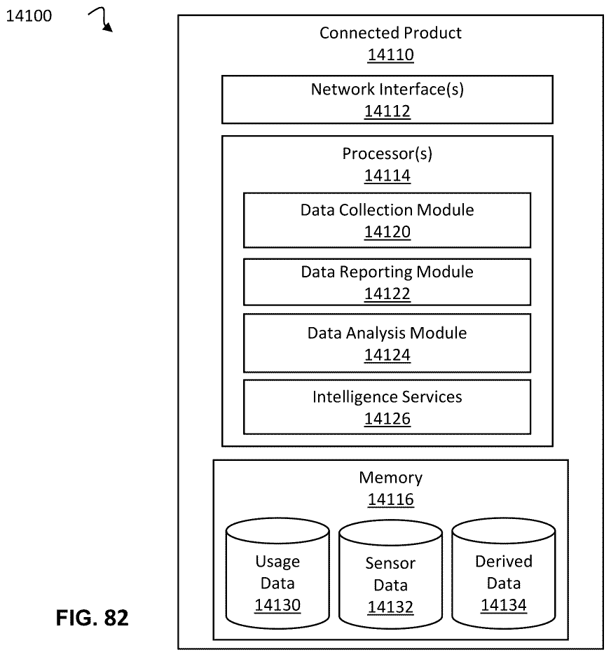

FIG. 82 illustrates an example of a connected product 14110. In the example provided, the connected product 14110 includes a network interface 14112, at least one processor 14114, and at least one memory 14116. In some embodiments, the connected products 14010, 14020, 14022, 14024, 14026, 14034, and 14044 have configurations that are similar to that of the connected product 14110.

The connected product 14110 includes at least one network interface 14112, at least one processor 14114, and at least one memory 14116. The network interface 14112 includes one or more communication units that communicate with a network (e.g., the Internet, a private network, and the like).

The processor 14114 may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor.

In the example provided, the processor 14114 includes a data collection module 14120, a data reporting module 14122, a data analysis module 14124, and intelligence services 14126. For example, the modules may be dedicated electronic circuits or non-transitory computer code committed to a computer for instructing the processor to perform the algorithm coded therein and described herein.

The data collection module 14120 instructs the connected product 14110 to receive data from sensors and/or the network interface 14112 and commit the received data to the memory 14116. The data reporting module 14122 retrieves data stored in the memory 14116 or redirects data from the sensors or the network interface 14112 and transmits the data out from the network interface 14112 to a recipient entity. The data analysis module 14124 and the intelligence services 14126 perform analysis and execute artificial intelligence and/or machine learning algorithms on the data.

The memory 14116 may be any type of non-transitory storage medium, such as one or more of a CD-ROM, DVD, memory, hard disk, flash drive, RAM, ROM, cache, network-attached storage, server-based storage, and the like. The memory 14116 stores methods, programs, codes, program instructions or other type of instructions capable of being executed by the processor 14114.

The memory 14116 stores data in various data structures. In the example provided, the data structures include a usage data structure 14130, a sensor data structure 14132, and a derived data structure 14134. The usage data structure 14130 stores data related to the use of the connected product 14110. For example, the usage data structure may store the time, location, settings, and other details regarding when and how the connected product has been used by a user. The sensor data structure 14132 stores data collected from sensors related to the connected product 14110. For example, the sensor data may be stored as quantized digital data corresponding to analog sensor signals generated from sensors within the connected product 14110 or received at the network interface 14112. The derived data structure 14134 stores data derived from the usage data and the sensor data. For example, the data analysis module 14124 may compare usage frequency from the usage data with environmental temperature from the sensor data to determine a frequency of use categorized by environmental temperature range to be stored in the derived data structure 14134.

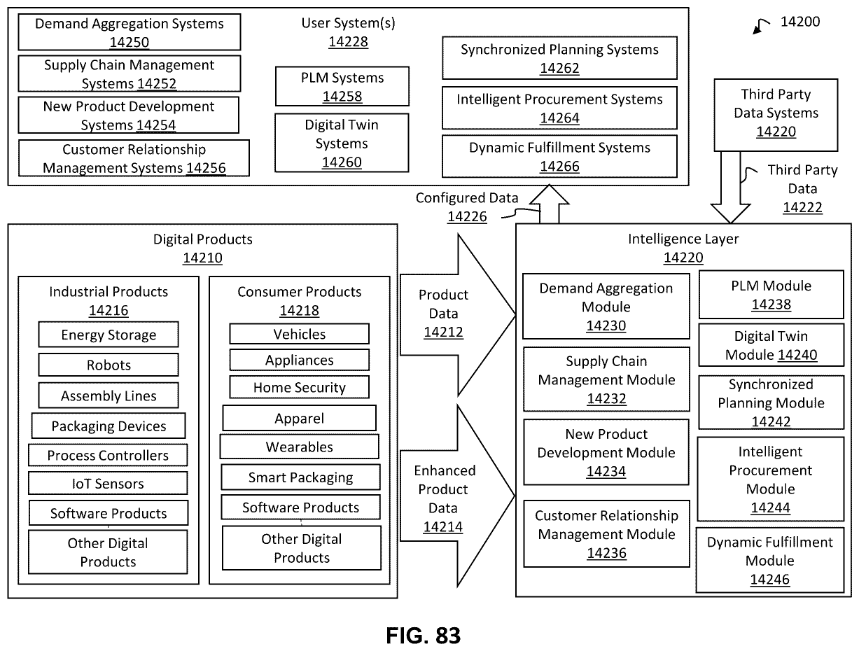

FIG. 83 illustrates a digital product network 14200. In the example provided, a collection of digital products 14210 share product data 14212 and enhanced product data 14214 with an intelligence layer 14220. For example, products (including goods and services) may create and transmit data, such as product level data, to a communication layer within the value chain network technology stack and/or to an edge data processing facility. This data may produce enhanced product level data and may be combined with third party data for further processing, modeling or other adaptive or coordinated intelligence activity at the intelligence layer. This may include, but is not limited to, producing and/or simulating product and value chain use cases, the data for which may be utilized by products, product development processes, product design, and the like.

The digital products 14210 may include industrial products 14216, consumer products 14218, and other types of connected products that may communicate with the intelligence layer 14220. In some embodiments, the digital products 14210 include at least one connected product 14110 of FIG. 82.

A third-party data system 14221 shares third party data 14222 with the intelligence layer 14220. For example, the third-party data systems 14221 may share third party data 14222 related to any supporting data used by the intelligence layer 14220 that is not already available in product data 14212.

The intelligence layer 14220 includes various modules that perform analysis on the product data 14212, the enhanced product data 14214, and the third party data 14220. The analysis outputs configured data 14226 to send to at least one user system 14228.

In the example provided, the intelligence layer 14220 includes a demand aggregation module 14230, a supply chain management module 14232, a new product development module 14234, a customer relationship management module 14236, a product lifecycle management (PLM) module 14238, a digital twin module 14240, a synchronized planning module 14242, an intelligent procurement module 14244, and a dynamic fulfillment module 14246. It should be appreciated that other embodiments may include other combinations and types of modules without departing from the scope of the present disclosure.

The user systems 14228 may be third party systems that purchase the configured data 14226, may purchase analytics produced by the user system 14228, or may be systems owned by the same enterprise that operates the intelligence layer 14220.

In the example provided, the user systems 14228 include a demand aggregation system 14250, a supply chain management system 14252, a new product development system 14254, a customer relationship management system 14256, a product lifecycle management (PLM) system 14258, a digital twin system 14260, a synchronized planning system 14262, an intelligent procurement system 14264, and a dynamic fulfillment system 14266. Each of the user systems corresponds to a different use for the configured data and is generated by a corresponding module in the intelligence layer.

PLM system 14238 may provide accurate and up-to-date product information accessible throughout the value chain and product lifecycle. The PLM system may enable enhanced cross-function and cross-organizational involvement in the design, collaborative innovation, design for manufacture/procurement, platform-based design philosophies, quicker time-to-market, and improved portfolio management.

New product development system 14234 is associated with developing and managing product and service value chains that are responsive to customer experience and are transformed by smart real-time data, advanced technologies, and agile innovation. The new product development systems may contribute to improved design quality, increased productivity, and enhanced communication and visibility. For example, improvements may be realized in: simulations that benefit from virtual model processing in detail without spending resources to physically test design in a real-world environment; monitoring with up to date/real time monitoring of user habits for future designs; ease of assembly design; design for ease of manufacturing/collection of parts that will form the product after assembly; design and conformance to specifications providing the fundamental basis for managing operations to produce quality products; and end-to-end transparency, real-time root cause analytics, and proactive resolution driven by customer connectivity for faster problem resolution, problem prevention, customer satisfaction, performance, compliance verification, and avoided warranties. Additional benefits may include supply chain management with the application of the Internet of Things, the use of advanced robotics, and the application of advanced analytics of big data in supply chain management performance and customer satisfaction. In addition to driving other user systems, many of the additional benefits may influence design decisions. Demand forecasting may be improved with predictive analytics to understand and predict customer demand to optimize supply decisions by corporate supply chain and business management. Predictive procurement may forecast the future price trends, price fluctuations, future risks to manage and the potentials required with the aid of a proper analysis based on previous procurement data. Real time/up to date product management may improve customer engagement and extend product lifecycles. Firms (manufacturing firms or 3rd Party contractors) may develop the capabilities to provide services and solutions that supplement their traditional product offerings (e.g., equipment maintenance, data migration, data storage).

In customer relationship management system 14236, an integrated solution can combine customer profiles, interactions, and transaction information from multiple applications to provide a view of customers with a solution that is equipped with industry-specific functionalities as well as business intelligence capabilities. For example, the digital product network may enable: remote diagnosis such that the subjects can be separated by physical distance instead of the subject being co-located with the person or system performing diagnostics; inter-machine connectivity (M2) by enabling a sensor or meter to communicate the information it records to application software that can use it; and warranty/repair with proactive and pre-emptive warranty management that becomes easier with an IoT based digital warranty management system. The digital product network may further improve: brand/product agility with real time product monitoring and ability to quickly survey the marketplace leading to greater brand agility; digital product quality with end-to-end transparency, real-time root cause analytics, and proactive resolution driven by customer connectivity; simulation by giving customer tools to virtual model process/use VR and AR in detail without spending resources to physically test design in a real-world environment; fractional ownership usage and tracking and physical good real-world compliance to meet parameters of agreements; common platform and product architecture for a set of stable components that support variety and ability to evolve in a system by constraining the linkages among the other components; and design for consumption insights and methods to improve how customers use/consume products.

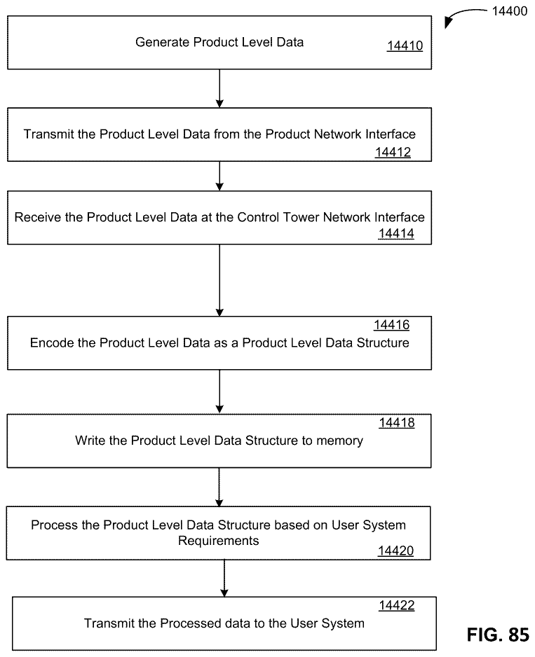

FIG. 84 illustrates an example digital product network 14300 and FIG. 85 illustrates a method 14400 of using the product level data according to some embodiments of the present disclosure. The digital product network 14300 is similar to the digital product network 14000, where like numbers refer to like components.

Digital products 14310 are similar to digital products 14210. In the example provided, the digital products include a set of digital products each having a product processor, a product memory, and a product network interface. In some embodiments, one of the digital products 14310 is a product network control tower that has a control tower processor, a control tower memory, and a control tower network interface. In some embodiments, the product network control tower is a server or a product that is not one of the digital products 14310. The product processor and the control tower processor collectively include non-transitory instructions that program the digital product network system as described herein. For example, the intelligence layer 14320 may be distributed amongst the digital products 14310 and remote servers.

In some embodiments, the digital products 14310 include a display 14311. In some embodiments, the display 14311 is associated with the product network control tower. The display 14311 presents images to a user of the display 14311. For example, the display 14311 may be a screen on a mobile phone, a television, a projector, or the like.

In the example provided, the set of digital products and the product network control tower have a set of microservices and a microservices architecture. The digital products 14210 or the digital products 14310 generate product level data at the product processor in task 14410 of method 14400. The digital products 14210 or digital products 14310 transmit the product level data from the product network interface in task 14412.

The product network control tower receives the product level data at the control tower network interface in task 14414. In the example provided, the product processor and the control tower processor are further programmed to communicate based on a shared communication system configured for facilitating communication of the product level data from the set of digital products amongst themselves and with the product control tower. In some embodiments, the shared communication system includes an electromagnetic licensed to an enterprise who operates or owns the digital product network 14300. In some embodiments, the communication system includes a shared security protocol for communicating over shared electromagnetic bands, local area networks, Internet, 5G, and the like.

The digital product network 14300 encodes the product level data as a product level data structure configured to convey parameters indicated by the product level data across the set of digital products in task 14416. The digital product network 14300 writes the product level data structure to at least one of the product memory and the control memory in task 14418. The digital product network 14300 processes the product level data structure in task 14420. The digital product network 14300 transmits the processed data to the user system in task 14422.

In some embodiments, the intelligence layer 14320 includes a graphical user interface (GUI) module 14340 and a proximity module 14342. The GUI module may generate at least one user interface display for presentation on the display 14311. The GUI module 14340 may generate the parameters of at least one digitally enabled product of the set of digital products in the at least one user interface display and may generate a proximity display of proximal digital products of the set of digital products in the at least one user interface display. In some embodiments, generating the proximity display includes generating the proximity display of proximal products that are geographically proximate, where the digital product network is further programmed to filter the proximal products by at least one of product type, product capability, or product brand. In some embodiments, generating the proximity display includes generating the proximity display of proximal products that are proximate to one of the set of digital products by product type proximity, product capability proximity, or product brand proximity.

In some embodiments, the intelligence layer 14320 includes a data integration module 14344. In some embodiments, the intelligence layer 14320 includes an edge computation and edge intelligence module or edge module 14346 for edge distributed decision making among the set of digital products. In some embodiments, the edge module 14346 is configured for edge network bandwidth management between or out of the set of digital products.

In some embodiments, the intelligence layer 14320 includes a distributed ledger system module 14348. In some embodiments, the distributed ledger system may be distributed exclusively within the digital products 14310. In some embodiments, the distributed ledger is a block chain ledger.

In some embodiments, the intelligence layer 14320 includes a quality management system having a product complaint module 14350 for capturing product complaints at the set of digital products. In some embodiments, the digital products 14310 detect complaints about other digital products 14310. For example, a digital product may use machine vision or sound processing to identify dissatisfaction of a user while the user is using a different digital product.

In some embodiments, the intelligence layer 14320 includes a product condition module 14352. Product condition module 14352 may identify a condition of the set of digital products. Product condition module 14352 may further encode the condition as one of the parameters of the product level data structure. Product condition module 14352 may further yet track and/or monitor the condition across the set of digital products. For example, a bicycle manufacturer may monitor the condition of sold smart bicycles to determine potential demand for repair parts or new bicycles. In another example, a rentable scooter company may monitor the condition of the active scooters in the scooter fleet to budget for repairs and replacement scooters.

In some embodiments, the intelligence layer 14320 includes a smart contract module 14354 for enabling the creation of smart contracts based on the product level data structure. In some embodiments, the intelligence layer 14320 configures the smart contracts based on a co-location-sensitive configuration of terms such that smart contract terms and conditions depend on proximity of a plurality of digital products of the set of digital products.

In some embodiments, the intelligence layer 14320 includes a robotic program automation (RPA) module 14356. In some embodiments, the RPA module 14356 is configured to gamify an interaction based on what digital products are in the set of digital products. In some embodiments, the RPA module 14356 generates RPA processes based on use of a plurality of digital products of the set of digital products.

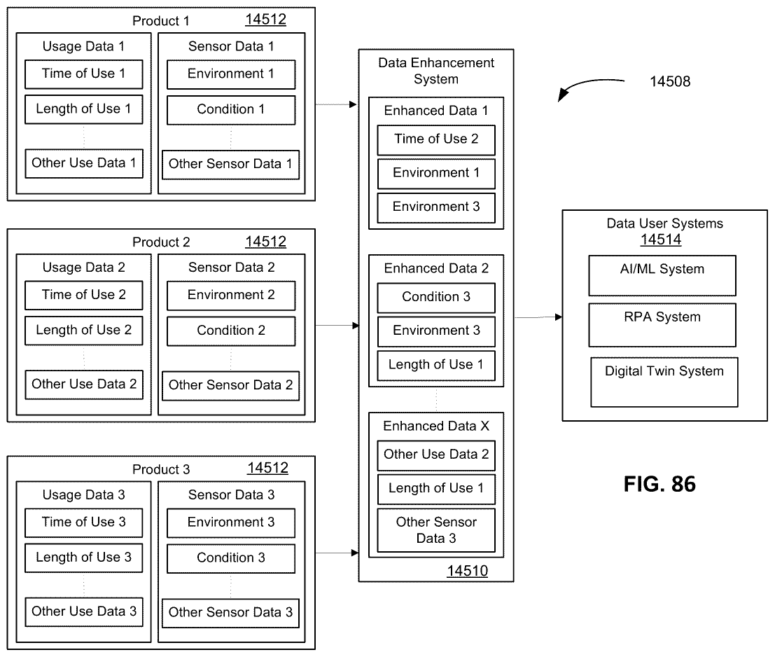

FIG. 86 illustrates an example of a digital product network system 14508 where a data enhancement system 14510 receives data from digital products 14512 for use by data user systems 14514. In some embodiments, the data enhancement includes at least one of data fusion and data integration to leverage cross-product data. The data enhancement system 14510 may be part of the intelligence service or layer, part of a digital twin, part of a control tower, in distributed processors in the products, or in other suitable systems.

The digital products 14512 are similar to the connected products 14110 described above. Each of the digital products 14512 provides data to the data enhancement system 14510. In the example provided, three different digital products 14512 are sharing data with the data enhancement system 14510. The data may be usage data for the product, sensor data collected by the product, data retrieved from other products, data incorporated from external sources, or other data obtained through other methods. For example, usage data may include a timestamp indicating when a product was used, length of time data indicating how long the product is in use, data indicating what other products the product interacted with during use, and any other suitable usage data. Sensor data may include environmental data, condition data, image data, sound data, and the like.

The data user system 14514 may be any systems that use or generate enhanced data. In some embodiments, the data user systems incorporate the data enhancement system 14510. For example, a machine learning system may train on various data streams from the products 14512 to generate enhanced data. In the example provided, the data user systems 14514 include AI/ML systems, Robotic Process Automation (RPA) systems, and digital twin systems.

In some embodiments, the digital product network system 14508 is a construction, home improvement, quality control, or similar system. For example, the products 14512 may be part of a family of tools. A laser level may provide leveling data input to a hand held self-levelling drill for ensuring accurate drill positioning. The digital product network may retrieve relevant specifications (e.g., for proper load bearing) provided from a job control facility. A tool belt may indicate the appropriate tool to use or access for the next task based on the specification. A tool box with digital capabilities may then indicate the appropriate drill bit and fastener type based on the material of the substrate to be drilled. The self-leveling drill may then retrieve the specification to set rotation speed, turn on or off a hammer drill function, etc. Data generated by the digital product tools may then be combined for validation of proper execution according to a workmanship specification.

In some embodiments, the digital product network system 14508 may be an air quality system, an energy auditing system, or a similar system. For example, the digital products 14512 may be cleaning products, air heating and cooling products, air filter products, window state detection products, or the like. A digital vacuum cleaner may detect the amount of dust and debris picked up during vacuum operations. The data enhancement system 14510 may then then fuse the dust data with data from a digital heating/cooling and air filter product system and weather data from a third party. Data user system 14514 may then train an AI system, an ML system, an RPA system, or the like with the fused data to predict indoor air quality metrics and potential causes of poor indoor air quality.

In some embodiments, the digital product network system 14508 is a sleep quality system. For example, the digital products 14512 may include a digital bed product, a light switch product, a refrigerator door state detector, or the like. The digital bed product may detect sleep duration, restlessness, and other sleep data. The light switch product may indicate the status of lights to indicate the amount of ambient light near the bed. The refrigerator door state detector may indicate what time the door was last opened before the user started sleeping in the bed. The data enhancement system 14510 may then fuse the sleep data with refrigerator use data and ambient light data. The data user system 14514 may then train an AI system, an ML system, an RPA system, or the like with the fused data to identify potential foods or eating behavior that may be contributing to poor sleep.

In some embodiments, the digital product network system 14508 is an electrical circuit analysis system. For example, the digital products 14512 may include a circuit breaker digital product, sensitive electronic products, or the like. The circuit breaker digital product may generate circuit use data. The sensitive electronic products may generate performance data or input voltage data. The data enhancement system 14510 may then fuse the circuit use data with performance data and voltage input data from various home digital products. The data user system 14514 may then train an AI system, an ML system, an RPA system, or the like with the fused data to map circuits in a building. recommend different receptacles to use for sensitive electronics to avoid performance issues from voltage drops on heavily loaded circuits, or the like.

In some embodiments, the digital product network system 14508 is a child entertainment management system. For example, the digital products 14512 may include digital children toys, televisions with viewing category data, or the like. The digital children toys may generate use data. The televisions may generate data indicating the time and duration of children show viewership. The data enhancement system 14510 may then fuse the children toy use data with the children show viewership. The data user system 14514 may then train an AI system, an ML system, an RPA system, or the like with the fused data to identify the types and features of toys that draw children away from the television, market new toys, develop new toys, calibrate toy focus groups, or the like.

In some embodiments, the digital product network system 14508 is a curation system for relating digital entertainment content to augmented reality. For example, the digital products 14512 may include televisions, augmented reality headwear, GPS locators, or the like. The data enhancement system 14510 may then fuse the television data with location information and landmark information. The data user system 14514 may then train an AI system, an ML system, an RPA system, or the like with the fused data to contextualize augmented reality depictions based on the substance of entertainment choices made on a playback device. For example, a television show set in town X may be linked to phone and headset digital products to present—in augmented reality—depictions, labels, markers, and other things that are thematically related to the substance of the television show while the user is in town X. The labels and markers may identify buildings where scenes occurred in the television show, such as indicating that “this building is where the Mafia Boss Z ran his operation.” In some embodiments, the system may present material related to botany. For example, augmented reality may curate indicators of flora-related environment features, etc. This could be used to curate a “tour” of a location new to a user. In some embodiments, the system may suggest five routes through a city when the user enters the city. The routes may be supplemented by augmented reality pertaining to user interests inferred from user media/entertainment consumption. The system may then offer related content on a user media player, television, book reader, phone etc.

In some embodiments, the digital product network system 14508 is an exercise system. For example, the digital products 14512 may include treadmills, exercise bicycles, stair mills, medicine balls with sensors, machine vision products, or the like. The exercise products may generate recordings, summaries, and analysis of workouts across a range of devices. The data enhancement system 14510 may then fuse the data generated across the exercise equipment products. The data user system 14514 may train an AI system, an ML system, an RPA system, or the like with the fused data to guide a user to use equipment in a manner that complements what the user has done on other equipment. The system may coordinate with devices that understand which muscle groups, calories, etc. are implicated or used. For example, when a user rides ten miles on a bike but has not used a treadmill, weights, step counter, etc., the system may indicate that the user should perform some exercise on specific equipment for a given duration based on the usage information. In some embodiments, the system may be used to monitor patients in cardio rehab. In some embodiments, the system may monitor athletes for sports-specific enhancements, including based on training sets of data by elite athletes across their platforms.

In some embodiments, the digital product network system 14508 is a carbon footprint calculation system. For example, the digital products 14512 may include personal devices or devices that detect actions that contribute to carbon release, such as cars, thermostats, appliances, food purchases (POS data), clothing, etc. The data enhancement system 14510 may then fuse the data generated across the carbon footprint calculation products. The data user system 14514 may then train an AI system, an ML system, an RPA system, or the like with the fused data to create a plan in line with a personal goal, family goal, business goal, regulatory requirement, or the like. In some embodiments, the plan implements device control to limit use of high-carbon release appliances when the footprint exceeds a threshold.

In some embodiments, the digital product network system 14508 is a cross-platform or cross-product reputation system. For example, the digital products 14512 may include various digital products that are capable of interacting with online communities. The data enhancement system 14510 may then fuse the data generated across the digital products. The data user system 14514 may then train an AI system, an ML system, an RPA system, or the like with the fused data to authenticate upstanding digital citizens and identify digital bad actors. The system may identify cheating, poor behavior, poor sportsmanship, adult language, or other indicators of potential activities that may conflict with terms of use or rules in various online communities, forums, applications, and games. The system may use metaverse IDs, government IDs, credit reports, criminal reports, or the like. The information may be shared across devices (e.g., personal computers, gaming devices, game consoles, gaming handhelds, mobile devices, wearables, virtual reality headsets, etc.) and databases. Metaverse IDs may be tied in with government IDs (e.g., state IDs, federal IDs, driver's licenses, passports, etc.) which may then also be tied to an individual's ID across one or more product categories (e.g., an ID for a website, an ID for an entity, a general metaverse ID), such that poor behavior, cheating, hacking, or the like is able to be flagged and/or punished across platforms. In some embodiments, the following types of behaviors are tracked: posting hateful content/discussion on social media, using cheating third-party programs in competitive environments and/or secure applications (e.g., cheat programs in video games, DDoSing websites/apps/game servers, terms of service violations of websites/apps/secure databases, money/transaction fraud through taking advantage of system vulnerabilities or third party programs, etc.). The IDs may be used to log into PCs, laptops, mobile devices, smart watches, smart devices, or the like. The IDs may be tied to a network gateway, cellular IDs, or other information further up the data stream from the device to prevent data from any device, IP address, user, or the like related to the flagged ID from participating in certain activities. Also, such traffic and interactions may be throttled, may be modified, subject to auditing, subject to real-time AI/ML monitoring, and the like. Furthermore, AI/ML processes may be trained to identify cheats, ToS violations, poor behavior, poor sportsmanship, etc. AI chipsets may be developed and implemented in devices for identifying such behaviors, programs, and the like. In some embodiments, the system includes incentive programs that provide rewards (e.g., NFTs) for good behavior across products. The rewards and financial details may be embodied in a digital wallet.

In some embodiments, the digital product network system 14508 is a personal health management system. The digital products 14512 may be a family that includes an implantable/permanent medical device, a wearable device, a smart phone, an external treatment device, or other health products. Implantable devices may generate data for tracking of blood chemistry, blood pressure, immune response, other “lab” data, as well as internal load bearing (such as to measure relative pressures on a joint). Wearable devices may measure and generate data for generalized health conditions, movement, activity, etc. Smart phone devices may measure and generate data for location and various user behavior characteristics, including social engagement, affect, happiness, and social metrics. External treatment devices may generate data indicating compliance with medication, physical therapy, and other treatment regimens. The data enhancement system 14510 may then fuse the data generated across the digital products and the data user system 14514 may then train an AI system, an ML system, an RPA system, or the like with the fused data to form a digital twin of the patient and the regimen for simulation, diagnosis, adjustment of treatment, communications and coaching, advance problem detection, etc. For example, the personal health management system may automate diagnosis, prescription, insurance (underwriting, making claims, auditing, payout, adjustment), treatment (medication, PT, surgery), long-term health care planning and recommendations, recommendations for wellness improvement (exercise modifications, social engagement), gamification of health-related behaviors, and other health related tasks and fields. In some embodiments, the system may monitor sleep patterns, heart rate, blood pressure, and other health parameters combined with data from a smart refrigerator to recommend the food a person should be eating to improve overall health.

In some embodiments, the digital product network system 14508 is an automobile digital reality system. The digital products 14512 may include automobiles, hearing devices, augmented reality (AR) devices, virtual reality (VR) devices, mixed reality (MR) devices, and the like. Such a family of products may revolve around a customer's car and look to leverage data streams across various products that could link to the vehicle. For example, fusing driving data and in-vehicle passenger observation with hearable data including noise, entertainment tracks, and spoken word content may give a holistic sense of the driver or passenger. An in-ear device may be specifically designed to work in a family of products with the car. AR/VR headsets may be equipped to help a driver learn to drive a specific car based on the current status and configuration of the car as determined by the products, rather than just for a type or model of car detached from the current configuration. An AR/VR headset may be configured to allow users to play social video games, such as games where a car owner may race their own car against friends in their own cars based on data indicating current tire condition, fuel levels, locations, etc.

In some embodiments, the digital product network system 14508 is a product family that has elements configured to reside and operate in a digital wallet, in the metaverse, in AR/VR devices, in a vehicle, in individual rooms of the home, at work, in a smart city, in nature, etc.

In some embodiments, the digital product network system 14508 is an industrial system. The digital products 14512 may include machine sensors indicating the need for adjustments to the machine (e.g., a need for increasing fan usage for a machine that is too hot, a need for lubrication, a need for materials in terms of manufacturing or packaging systems, a need for fixing broken or missing rollers indicated by a conveyor belt sensor, or the like). The data enhancement system 14510 may fuse sensor data within a warehouse for specific purposes such as environment (e.g., temperature, airflow, humidity, lighting, UV light, etc.). This fusing may relate to each of these types of data, or a combination of this data may be fused on a separate device such that the results of this data from an analysis engine may be only outputted to a mobile device based on thresholds (e.g., too cold-suggest heat, too much humidity-initiate dehumidifier or initiate humidifier when too dry, pull down shades if too much UV light, open windows or turn on fans for increased airflow etc.). This environment data may be fused with sensor data relating to manufacturing systems or systems for packaging devices. This data may be fused separately to an analysis engine providing results of machine statuses. The data user system 14514 may then train an AI system, an ML system, an RPA system, or the like with the fused data to create an analysis engine, recommendation engine, and/or automation engine that outputs to a software application on the mobile device with results of a combination of machine sensing and environment sensing to provide recommendations and/or automate systems to resolve environment issues or machine status issues. The system may also monitor a combination of environment conditions with machine status conditions for determining optimal conditions for greatest output to automatically adjust the machine and environment conditions to provide the optimal conditions while keeping costs minimal.

In some embodiments, the digital product network system 14508 is a sports equipment system. The digital products 14512 may include golf clubs and golf balls, baseball bats and baseballs, hockey sticks and hockey pucks, tennis racquets and tennis balls, bowling balls, and the like. The various striking implements and balls may generate data indicating how far, how straight, how on target the ball travels. A machine vision system or sensors in the striking implement may generate data about acceleration, angle, rotation, and other data about the swing of the striking implement. The data enhancement system 14510 may then fuse the data generated across the sports equipment, and the data user system 14514 may train an AI system, an ML system, an RPA system, or the like with the fused data to identify corrections to coach the user and improve the swing. In some embodiments, the system fuses data from smart exercise machines and smart watches/wearables.

In some embodiments, the digital product network system 14508 is a physical retail system. The digital products 14512 may include items to be purchased, packaging of the items, a shopping cart, a smartphone, or the like. The products may indicate the type of items added to the cart, the quantity of items added to the cart, the items on a shopping list in a smartphone, etc. The data enhancement system 14510 may fuse the data, and the data user system 14514 may train an AI system, an ML system, an RPA system, or the like with the fused data to make suggestions for complementary products, indicate the locations of the complementary products in the store, offer incentives, or the like. For example, the incentives may include discounts, reward points, digital badges, or the like.

In some embodiments, the digital product network system 14508 is a commercial lending risk management system. The digital products 14512 may include products in a warehouse, packaging, environment sensors, or similar products. The products may generate data indicating a proximity of different products in the same warehouse or the presence of the same or different products in different warehouses. The data enhancement system 14510 may fuse the data, and the data user system 14514 may train an AI system, an ML system, an RPA system, or the like with the fused data to alert the lender of movements in inventories that may indicate risks or non-compliance with loan (credit line) terms or put pricing in a different bracket or trigger extra fees. The system may also indicate extreme risks that government authorities could take interest in, such as hazardous or explosive materials stored or moved in dangerous conditions.

In some embodiments, the digital product network system 14508 is a media consumption recommendation system. The digital products 14512 may include microphones, televisions, and the like. The products may generate data indicating the music a person listens to, the person's taste in the books, the person's interest in television and movie content. The data enhancement system 14510 may fuse the data, and the data user system 14514 may train an AI system, an ML system, an RPA system, or the like with the fused data to recommend video games that may appeal to the person.

In some embodiments, the digital product network system 14508 is a health improvement system. The digital products 14512 may include networked exercise equipment, rowing machines, stationary bicycles, a smart appliance (e.g., refrigerator), wearables (e.g., smart ring or smart watch), smart beds, and other products. The products generate data that may be used to gain a better understanding of a user's overall health. The data enhancement system 14510 may fuse the data, and the data user system 14514 may train an AI system, an ML system, an RPA system, or the like with the fused data to learn about the user's eating habits, exercise habits, and sleeping/sitting habits. The system may determine if the user is burning too many calories or eating the wrong foods given their workout routines. The system may also track the user's sleep patterns and determine whether the user is exercising and/or eating at the right time. The networked exercise equipment may be owned by a user or may be owned by a gym. When the equipment is located at a gym, the exercise devices may pair with the user's phone or wearable device to know who is on the equipment, how long they used it, and the like. The smart refrigerator may include sensors and imaging devices that determine what the user is buying, what they are actually eating, and when they are eating it. In some embodiments, the smart refrigerator includes a profile of the user (e.g., family with kids, single, cohabitating but no kids, etc.) and/or a voice-controlled interface that verifies who is eating, what they are cooking and the like. The data may train the AI system to determine the user's overall health profile. The system may be configured to make recommendations to the user, such as better foods to eat, better times to eat, how much to exercise, what times to exercise, and the like.

In some embodiments, the digital product network system 14508 is a product maintenance system. The digital products 14512 may include any product or machinery that has some level of connectivity and some components of warranties/repair. The resulting data sets and cumulative data layer can be analyzed and used for remote diagnosis, warranty pricing, repair pricing, offers for replacements, offers for upgrades, or the like. For remote diagnosis, the subject can be separated by physical distance instead of the subject being co-located with the person or system performing the diagnostics. For warranty and repair pricing, proactive and pre-emptive warranty management becomes easier with an IoT based digital warranty management system.

In some embodiments, the digital product network system 14508 is a power consumption management system. The digital products 14512 may include thermostats, light switches, light bulbs, refrigerators, coffee makers, HVAC products, and the like. A power consumption monitor split out by breaker at an electrical service panel box can be linked to various household appliances/circuits. In some embodiments, the products provide sufficient data that the circuit panel box monitor may be omitted in favor of watching the usage patterns by product. A single circuit may be monitored for understanding different appliance consumption patterns (fridge on/off, vacuum on/off, HVAC on/off/heat/cool/fan) and may be a parent-umbrella over other smart devices (thermostats, light switches/bulbs, etc.). The system may combine the data and perform analysis of usage patterns (fridge temperature setting, coffee maker on-time, thermostat/HVAC usage, etc.) for maintenance, behavioral usage guidance, etc. For example, an HVAC may monitor airflow by power consumption (accounting for temperature, humidity, etc.) for recommending filter changes or behavioral suggestions to save energy.

In some embodiments, the digital product network system 14508 is a task management system. The digital products 14512 may include location sensors, status sensors, task completion sensors, and the like. The data enhancement system 14510 may fuse the data, and the data user system 14514 may train an AI system, an ML system, an RPA system, or the like with the fused data to coordinate tasks and/or services in a metaverse, in real life, or in both. For example, the system may use geolocation, couponing, logistics, etc. to determine which employees, family members, or other participants are in the best position to perform a task. The best position may be pre-programed or AI optimized for priorities such as savings, timing, importance, or the like. The system may provide task ordering, task instruction, and coordination of the other participants accordingly. The system may operate based on tasks to be performed in real life and in the metaverse work environments and may link the metaverse and real life activities. In some embodiments, the system may put services out to bid. In some embodiments, the system provides a metaverse work environment and a market for services in the metaverse for metaverse workers and real-life workers to work collaboratively to get to a result.

In some embodiments, the digital product network system 14508 is a personal health system. The digital products 14512 may include wearable devices, eyeglasses, eyeglasses with liquid lenses, active clothing (heating, cooling, stress/strain, forces, etc.), recreational devices (GPS monitor devices, etc.), building and other environmental systems (temperature, humidity, lighting, etc.), automotive systems, and the like. The products generate sensor or other data defined (micro or macro) that impacts personal health. The data enhancement system 14510 may fuse multiple data streams, including those outside of ecosystems that could be integrated to monitor and manage personal health. The data user system 14514 may train an AI system, an ML system, an RPA system, or the like with the fused data to augment and validate certain analytical models (GPS navigation algorithms, etc.). The system may provide active alerts, automated reporting that builds a personal profile over time, suggested active measures, instructions to enact the active measures (e.g., by activated clothing or other devices, etc.). The system may perform psychological evaluation, recommendations, referrals, identification of hazards such as temperature, UV exposure, pathogen presence, etc., accumulated exposure to carcinogens or other things that could lead to long-term illness, life-long medical analysis, activating clothing for temperature changes, massage, etc.

### Dual Process Artificial Neural Networks

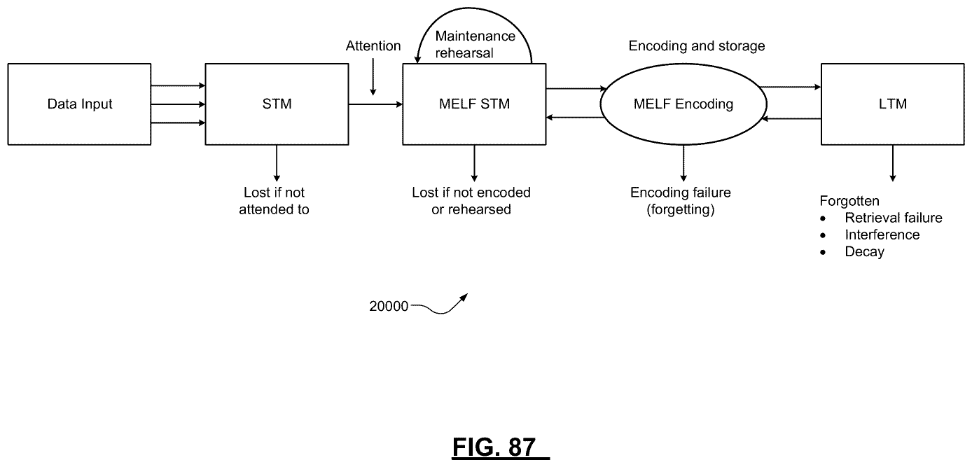

Referring to FIG. 76 in combination with FIG. 87, in embodiments, the intelligence services include a dual process artificial neural network (DPANN) system 20000. The DPANN system 20000 includes an artificial neural network (ANN) having behaviors and operational processes (such as decision-making) that are products of a training system and a retraining system. The training system is configured to perform automatic, trained execution of ANN operations. The retraining system performs effortful, analytical, intentional retraining of the ANN, such as based on one or more relevant aspects of the ANN, such as memory, one or more input data sets (including time information with respect to elements in such data sets), one or more goals or objectives (including ones that may vary dynamically, such as periodically and/or based on contextual changes, such as ones relating to the usage context of the ANN), and/or others. In cases involving memory-based retraining, the memory may include original/historical training data and refined training data. The DPANN system 20000 includes a dual process learning function (DPLF) configured to manage and perform an ongoing data retention process. The DPLF (including, where applicable, memory management process) facilitate retraining and refining of behavior of the ANN. The DPLF provides a framework by which the ANN creates outputs such as predictions, classifications, recommendations, conclusions and/or other outputs based on a historic inputs, new inputs, and new outputs (including outputs configured for specific use cases, including ones determined by parameters of the context of utilization (which may include performance parameters such as latency parameters, accuracy parameters, consistency parameters, bandwidth utilization parameters, processing capacity utilization parameters, prioritization parameters, energy utilization parameters, and many others).

In embodiments, the DPANN system 20000 stores training data, thereby allowing for constant retraining based on results of decisions, predictions, and/or other operations of the ANN, as well as allowing for analysis of training data upon the outputs of the ANN. The management of entities stored in the memory allows the construction and execution of new models, such as ones that may be processed, executed or otherwise performed by or under management of the training system. The DPANN system 20000 uses instances of the memory to validate actions (e.g., in a manner similar to the thinking of a biological neural network (including retrospective or self-reflective thinking about whether actions that were undertaken under a given situation where optimal) and perform training of the ANN, including training that intentionally feeds the ANN with appropriate sets of memories (i.e., ones that produce favorable outcomes given the performance requirements for the ANN).

In embodiments, the DPLF may be or include the continued process retention of one or more training datasets and/or memories stored in the memory over time. The DPLF thereby allows the ANN to apply existing neural functions and draw upon sets of past events (including ones that are intentionally varied and/or curated for distinct purposes), such as to frame understanding of and behavior within present, recent, and/or new scenarios, including in simulations, during training processes, and in fully operational deployments of the ANN. The DPLF may provide the ANN with a framework by which the ANN may analyze, evaluate, and/or manage data, such as data related to the past, present and future. As such, the DPLF plays a crucial role in training and retraining the ANN via the training system and the retraining system.

In embodiments, the DPLF is configured to perform a dual-process operation to manage existing training processes and is also configured to manage and/or perform new training processes, i.e., retraining processes. In embodiments, each instance of the ANN is trained via the training system and configured to be retrained via the retraining system. The ANN encodes training and/or retraining datasets, stores the datasets, and retrieves the datasets during both training via the training system and retraining via the retraining system. The DPANN system 20000 may recognize whether a dataset (the term dataset in this context optionally including various subsets, supersets, combinations, permutations, elements, metadata, augmentations, or the like, relative to a base dataset used for training or retraining), storage activity, processing operation and/or output, has characteristics that natively favor the training system versus the retraining system based on its respective inputs, processing (e.g., based on its structure, type, models, operations, execution environment, resource utilization, or the like) and/or outcomes (including outcome types, performance requirements (including contextual or dynamic requirements), and the like. For example, the DPANN system 20000 may determine that poor performance of the training system on a classification task may indicate a novel problem for which the training of the ANN was not adequate (e.g., in type of data set, nature of input models and/or feedback, quantity of training data, quality of tagging or labeling, quality of supervision, or the like), for which the processing operations of the ANN are not well-suited (e.g., where they are prone to known vulnerabilities due to the type of neural network used, the type of models used, etc.), and that may be solved by engaging the retraining system to retrain the model to teach the model to learn to solve the new classification problem (e.g., by feeding it many more labeled instances of correctly classified items). With periodic or continuous evaluation of the performance of the ANN, the DPANN system may subsequently determine that highly stable performance of the ANN (such as where only small improvements of the ANN occur over many iterations of retraining by the retraining system) indicates readiness for the training system to replace the retraining system (or be weighted more favorably where both are involved). Over longer periods of time, cycles of varying performance may emerge, such as where a series of novel problems emerge, such that the retraining system of the DPANN is serially engaged, as needed, to retrain the ANN and/or to augment the ANN by providing a second source of outputs (which may be fused or combined with ANN outputs to provide a single result (with various weightings across them), or may be provided in parallel, such as enabling comparison, selection, averaging, or context- or situation-specific application of the respective outputs).

In embodiments, the ANN is configured to learn new functions in conjunction with the collection of data according to the dual-process training of the ANN via the training system and the retraining system. The DPANN system 20000 performs analysis of the ANN via the training system and performs initial training of the ANN such that the ANN gains new internal functions (or internal functions are subtracted or modified, such as where existing functions are not contributing to favorable outcomes). After the initial training, the DPANN system 20000 performs retraining of the ANN via the retraining system. To perform the retraining, the retraining system evaluates the memory and historic processing of the ANN to construct targeted DPLF processes for retraining. The DPLF processes may be specific to identified scenarios. The ANN processes can run in parallel with the DPLF processes. By way of example, the ANN may function to operate a particular make and model of a self-driving car after the initial training by the training system. The DPANN system 20000 may perform retraining of the functions of the ANN via the retraining system, such as to allow the ANN to operate a different make and model of car (such as one with different cameras, accelerometers and other sensors, different physical characteristics, different performance requirements, and the like), or even a different kind of vehicle, such as a bicycle or a spaceship.

In embodiments, as quality of outputs and/or operations of the ANN improves, and as long as the performance requirements and the context of utilization for the ANN remain fairly stable, performing the dual-process training process can become a decreasingly demanding process. As such, the DPANN system 20000 may determine that fewer neurons of the ANN are required to perform operations and/or processes of the ANN, that performance monitoring can be less intensive (such as with longer intervals between performance checks), and/or that the retraining is no longer necessary (at least for a period of time, such as until a long-term maintenance period arrives and/or until there are significant shifts in context of utilization). As the ANN continues to improve upon existing functions and/or add new functions via the dual-process training process, the ANN may perform other, at times more “intellectually-demanding” (e.g., retraining intensive) tasks simultaneously. For example, utilizing dual process-learned knowledge of a function or process being trained, the ANN can solve an unrelated complex problem or make a retraining decision simultaneously. The retraining may include supervision, such as where an agent (e.g., human supervisor or intelligent agent) directs the ANN to a retraining objective (e.g., “master this new function”) and provides a set of training tasks and feedback functions (such as supervisory grading) for the retraining. In-embodiments, the ANN can be used to organize the supervision, training and retraining of other dual process-trained ANNs, to seed such training or retraining, or the like.

In embodiments, one or more behaviors and operational processes (such as decision-making) of the ANN may be products of training and retraining processes facilitated by the training system and the retraining system, respectively. The training system may be configured to perform automatic training of ANN, such as by continuously adding additional instances of training data as it is collected by or from various data sources. The retraining system may be configured to perform effortful, analytical, intentional retraining of the ANN, such as based on memory (e.g., stored training data or refined training data) and/or optionally based on reasoning or other factors. For example, in a deployment management context, the training system may be associated with a standard response by the ANN, while the retraining system may implement DPLF retraining and/or network adaptation of the ANN. In some cases, retraining of the ANN beyond the factory, or “out-of-the-box,” training level may involve more than retraining by the retraining system. Successful adjustment of the ANN by one or more network adaptations may be dependent on the operation of one or more network adjustments of the training system.

In embodiments, the training system may facilitate fast operating by and training of the ANN by applying existing neural functions of the ANN based on training of the ANN with previous datasets. Standard operational activities of the ANN that may draw heavily on the training system may include one or more of the methods, processes, workflows, systems, or the like described throughout this disclosure and the documents incorporated herein, such as, without limitation: defined functions within networking (such as discovering available networks and connections, establishing connections in networks, provisioning network bandwidth among devices and systems, routing data within networks, steering traffic to available network paths, load balancing across networking resources, and many others); recognition and classification (such as of images, text, symbols, objects, video content, music and other audio content, speech content, and many others); spoken words; prediction of states and events (such as prediction of failure modes of machines or systems, prediction of events within workflows, predictions of behavior in shopping and other activities, and many others); control (such as controlling autonomous or semi-autonomous systems, automated agents (such as automated call-center operations, chat bots, and the like) and others); and/or optimization and recommendation (such as for products, content, decisions, and many others). ANNs may also be suitable for training datasets for scenarios that only require output. The standard operational activities may not require the ANN to actively analyze what is being asked of the ANN beyond operating on well-defined data inputs, to calculate well-defined outputs for well-defined use cases. The operations of the training system and/or the retraining system may be based on one or more historic data training datasets and may use the parameters of the historic data training datasets to calculate results based on new input values and may be performed with small or no alterations to the ANN or its input types. In embodiments, an instance of the training system can be trained to classify whether the ANN is capable of performing well in a given situation, such as by recognizing whether an image or sound being classified by the ANN is of a type that has historically been classified with a high accuracy (e.g., above a threshold).

In embodiments, network adaptation of the ANN by one or both of the training system and the retraining system may include a number of defined network functions, knowledge, and intuition-like behavior of the ANN when subjected to new input values. In such embodiments, the retraining system may apply the new input values to the DPLF system to adjust the functional response of the ANN, thereby performing retraining of the ANN. The DPANN system 20000 may determine that retraining the ANN via network adjustment is necessary when, for example, without limitation, functional neural networks are assigned activities and assignments that require the ANN to provide a solution to a novel problem, engage in network adaptation or other higher-order cognitive activity, apply a concept outside of the domain in which the DPANN was originally designed, support a different context of deployment (such as where the use case, performance requirements, available resources, or other factors have changed), or the like. The ANN can be trained to recognize where the retraining system is needed, such as by training the ANN to recognize poor performance of the training system, high variability of input data sets relative to the historical data sets used to train the training system, novel functional or performance requirements, dynamic changes in the use case or context, or other factors. The ANN may apply reasoning to assess performance and provide feedback to the retraining system. The ANN may be trained and/or retrained to perform intuitive functions, optionally including by a combinatorial or re-combinatorial process (e.g., including genetic programming wherein inputs (e.g., data sources), processes/functions (e.g., neural network types and structures), feedback, and outputs, or elements thereof, are arranged in various permutations and combinations and the ANN is tested in association with each (whether in simulations or live deployments), such as in a series of rounds, or evolutionary steps, to promote favorable variants until a preferred ANN, or preferred set of ANNs is identified for a given scenario, use case, or set of requirements). This may include generating a set of input “ideas” (e.g., combinations of different conclusions about cause-and-effect in a diagnostic process) for processing by the retraining system and subsequent training and/or by an explicit reasoning process, such as a Bayesian reasoning process, a casuistic or conditional reasoning process, a deductive reasoning process, an inductive reasoning process, or others (including combinations of the above) as described in this disclosure or the documents incorporated herein by reference.

Referring to FIG. 160, in embodiments, the DPLF may perform an encoding process of the DPLF to process datasets into a stored form for future use, such as retraining of the ANN by the retraining system. The encoding process enables datasets to be taken in, understood, and altered by the DPLF to better support storage in and usage from the memory. The DPLF may apply current functional knowledge and/or reasoning to consolidate new input values. The memory can include short-term memory (STM), long-term memory (LTM), or a combination thereof. The datasets may be stored in one or both of the STM and the LTM. The STM may be implemented by the application of specialized behaviors inside the ANN (such as recurrent neural network, which may be gated or un-gated, or long-term short-term neural networks). The LTM may be implemented by storing scenarios, associated data, and/or unprocessed data that can be applied to the discovery of new scenarios. The encoding process may include processing and/or storing, for example, visual encoding data (e.g., processed through a Convolution Neural Network), acoustic sensor encoding data (e.g., how something sounds, speech encoding data (e.g., processed through a deep neural network (DNN), optionally including for phoneme recognition), semantic encoding data of words, such to determine semantic meaning, e.g., by using a Hidden Markov Model (HMM); and/or movement and/or tactile encoding data (such as operation on vibration/accelerometer sensor data, touch sensor data, positional or geolocation data, and the like). While datasets may enter the DPLF system through one of these modes, the form in which the datasets are stored may differ from an original form of the datasets and may pass-through neural processing engines to be encoded into compressed and/or context-relevant format. For example, an unsupervised instance of the ANN can be used to learn the historic data into a compressed format.

In embodiments, the encoded datasets are retained within the DPLF system. Encoded datasets are first stored in short-term DPLF, i.e., STM. For example, sensor datasets may be primarily stored in STM, and may be kept in STM through constant repetition. The datasets stored in the STM are active and function as a kind of immediate response to new input values. The DPANN system 20000 may remove datasets from STM in response to changes in data streams due to, for example, running out of space in STM as new data is imported, processed and/or stored. For example, it is viable for short-term DPLF to only last between 15 and 30 seconds. STM may only store small amounts of data typically embedded inside the ANN.

In embodiments, the DPANN system 20000 may measure attention based on utilization of the training system, of the DPANN system 20000 as a whole, and/or the like, such as by consuming various indicators of attention to and/or utilization of outputs from the ANN and transmitting such indicators to the ANN in response (similar to a “moment of recognition” in the brain where attention passes over something and the cognitive system says “aha!”). In embodiments, attention can be measured by the sheer amount of the activity of one or both of the systems on the data stream. In embodiments, a system using output from the ANN can explicitly indicate attention, such as by an operator directing the ANN to pay attention to a particular activity (e.g., to respond to a diagnosed problem, among many other possibilities). The DPANN system 20000 may manage data inputs to facilitate measures of attention, such as by prompting and/or calculating greater attention to data that has high inherent variability from historical patterns (e.g., in rates of change, departure from norm, etc.), data indicative of high variability in historical performance (such as data having similar characteristics to data sets involved in situations where the ANN performed poorly in training), or the like.

In embodiments, the DPANN system 20000 may retain encoded datasets within the DPLF system according to and/or as part of one or more storage processes. The DPLF system may store the encoded datasets in LTM as necessary after the encoded datasets have been stored in STM and determined to be no longer necessary and/or low priority for a current operation of the ANN, training process, retraining process, etc. The LTM may be implemented by storing scenarios, and the DPANN system 20000 may apply associated data and/or unprocessed data to the discovery of new scenarios. For example, data from certain processed data streams, such as semantically encoded datasets, may be primarily stored in LTM. The LTM may also store image (and sensor) datasets in encoded form, among many other examples.

In embodiments, the LTM may have relatively high storage capacity, and datasets stored within LTM may, in some scenarios, be effectively stored indefinitely. The DPANN system 20000 may be configured to remove datasets from the LTM, such as by passing LTM data through a series of memory structures that have increasingly long retrieval periods or increasingly high threshold requirements to trigger utilization (similar to where a biological brain “thinks very hard” to find precedent to deal with a challenging problem), thereby providing increased salience of more recent or more frequently used memories while retaining the ability to retrieve (with more time/effort) older memories when the situation justifies more comprehensive memory utilization. As such, the DPANN system 20000 may arrange datasets stored in the LTM on a timeline, such as by storing the older memories (measured by time of origination and/or latest time of utilization) on a separate and/or slower system, by penalizing older memories by imposing artificial delays in retrieval thereof, and/or by imposing threshold requirements before utilization (such as indicators of high demand for improved results). Additionally or alternatively, LTM may be clustered according to other categorization protocols, such as by topic. For example, all memories proximal in time to a periodically recognized person may be clustered for retrieval together, and/or all memories that were related to a scenario may be clustered for retrieval together.

In embodiments, the DPANN system 20000 may modularize and link LTM datasets, such as in a catalog, a hierarchy, a cluster, a knowledge graph (directed/acyclic or having conditional logic), or the like, such as to facilitate search for relevant memories. For example, all memory modules that have instances involving a person, a topic, an item, a process, a linkage of n-tuples of such things (e.g., all memory modules that involve a selected pair of entities), etc. The DPANN system 20000 may select sub-graphs of the knowledge graph for the DPLF to implement in one or more domain-specific and/or task-specific uses, such as training a model to predict robotic or human agent behavior by using memories that relate to a particular set of robotic or human agents, and/or similar robotic or human agents. The DPLF system may cache frequently used modules for different speed and/or probability of utilization. High value modules (e.g., ones with high-quality outcomes, performance characteristics, or the like) can be used for other functions, such as selection/training of STM keep/forget processes.

In embodiments, the DPANN system 20000 may modularize and link LTM datasets, such as in various ways noted above, to facilitate search for relevant memories. For example, memory modules that have instances involving a person, a topic, an item, a process, a linkage of n-tuples of such things (such as all memory modules that involve a selected pair of entities), or all memories associated with a scenario, etc., may be linked and searched. The DPANN system 20000 may select subsets of the scenario (e.g., sub-graphs of a knowledge graph) for the DPLF for a domain-specific and/or task-specific use, such as training a model to predict robotic or human agent behavior by using memories that relate to a particular set of robotic or human agents and/or similar robotic or human agents. Frequently used modules or scenarios can be cached for different speed/probability of utilization, or other performance characteristics. High value modules or scenarios (ones where high-quality outcomes results) can be used for other functions, such as selection/training of STM keep/forget processes, among others.

In embodiments, the DPANN system 20000 may perform LTM planning, such as to find a procedural course of action for a declaratively described system to reach its goals while optimizing overall performance measures. The DPANN system 20000 may perform LTM planning when, for example, a problem can be described in a declarative way, the DPANN system 20000 has domain knowledge that should not be ignored, there is a structure to a problem that makes the problem difficult for pure learning techniques, and/or the ANN needs to be trained and/or retrained to be able to explain a particular course of action taken by the DPANN system 20000. In embodiments, the DPANN system 20000 may be applied to a plan recognition problem, i.e., the inverse of a planning problem: instead of a goal state, one is given a set of possible goals, and the objective in plan recognition is to find out which goal was being achieved and how.

In embodiments, the DPANN system 20000 may facilitate LTM scenario planning by users to develop long-term plans. For example, LTM scenario planning for risk management use cases may place added emphasis on identifying extreme or unusual, yet possible, risks and opportunities that are not usually considered in daily operations, such as ones that are outside a bell curve or normal distribution, but that in fact occur with greater-than-anticipated frequency in “long tail” or “fat tail” situations, such as involving information or market pricing processes, among many others. LTM scenario planning may involve analyzing relationships between forces (such as social, technical, economic, environmental, and/or political trends) in order to explain the current situation, and/or may include providing scenarios for potential future states.

In embodiments, the DPANN system 20000 may facilitate LTM scenario planning for predicting and anticipating possible alternative futures along with the ability to respond to the predicted states. The LTM planning may be induced from expert domain knowledge or projected from current scenarios, because many scenarios (such as ones involving results of combinatorial processes that result in new entities or behaviors) have never yet occurred and thus cannot be projected by probabilistic means that rely entirely on historical distributions. The DPANN system 20000 may prepare the application to LTM to generate many different scenarios, exploring a variety of possible futures to the DPLM for both expected and surprising futures. This may be facilitated or augmented by genetic programming and reasoning techniques as noted above, among others.

In embodiments, the DPANN system 20000 may implement LTM scenario planning to facilitate transforming risk management into a plan recognition problem and apply the DPLF to generate potential solutions. LTM scenario induction addresses several challenges inherent to forecast planning. LTM scenario induction may be applicable when, for example, models that are used for forecasting have inconsistent, missing, unreliable observations; when it is possible to generate not just one but many future plans; and/or when LTM domain knowledge can be captured and encoded to improve forecasting (e.g., where domain experts tend to outperform available computational models). LTM scenarios can be focused on applying LTM scenario planning for risk management. LTM scenarios planning may provide situational awareness of relevant risk drivers by detecting emerging storylines. In addition, LTM scenario planning can generate future scenarios that allow DPLM, or operators, to reason about, and plan for, contingencies and opportunities in the future.

In embodiments, the DPANN system 20000 may be configured to perform a retrieval process via the DPLF to access stored datasets of the ANN. The retrieval process may determine how well the ANN performs with regard to assignments designed to test recall. For example, the ANN may be trained to perform a controlled vehicle parking operation, whereby the autonomous vehicle returns to a designated spot, or the exit, by associating a prior visit via retrieval of data stored in the LTM. The datasets stored in the STM and the LTM may be retrieved by differing processes. The datasets stored in the STM may be retrieved in response to specific input and/or by order in which the datasets are stored, e.g., by a sequential list of numbers. The datasets stored in the LTM may be retrieved through association and/or matching of events to historic activities, e.g., through complex associations and indexing of large datasets.

In embodiments, the DPANN system 20000 may implement scenario monitoring as at least a part of the retrieval process. A scenario may provide context for contextual decision-making processes. In embodiments, scenarios may involve explicit reasoning (such as cause-and-effect reasoning, Bayesian, casuistic, conditional logic, or the like, or combinations thereof) the output of which declares what LTM-stored data is retrieved (e.g., a timeline of events being evaluated and other timelines involving events that potentially follow a similar cause-and-effect pattern). For example, diagnosis of a failure of a machine or workflow may retrieve historical sensor data as well as LTM data on various failure modes of that type of machine or workflow (and/or a similar process involving a diagnosis of a problem state or condition, recognition of an event or behavior, a failure mode (e.g., a financial failure, contract breach, or the like), or many others).

### VCN System of Systems

As discussed throughout and referring also at least to the example implementations of FIGS. 161-173, a VCN process, such as VCN process 10, may configure 17400 a set of secondary computing devices of a set of value chain network entities for communication with a primary computing device of an enterprise operator, wherein the primary computing device may manage the set of secondary computing devices. In some implementations, VCN process 10 may receive 17402 (e.g., via at least one member of the set of secondary computing devices) a set of primary commands from the primary computing device, wherein each of the set of commands may be at least one of a task or a request. In some implementations, VCN process 10 may assign 17404 at least a portion of one or more computing devices capable of fulfilling the primary command as a set of one or more computing devices to be managed by the set of secondary computing devices. In some implementations, VCN process 10 (e.g., via the set of secondary computing devices) configure 17406 the set of one or more computing devices to fulfill one or more secondary commands based upon, at least in part, the primary command. In some implementations, VCN process 10 may (e.g., via the set of secondary computing devices) fulfill 17408 the primary command based upon, at least in part, the set of one or more computing devices fulfilling the one or more secondary commands. In some implementations, VCN process 10 may send 17410 a generated system output to the primary computing device responding to the primary command based upon, at least in part, the set of one or more computing devices fulfilling the one or more secondary commands.

In some implementations, configuring the set of one or more computing devices to fulfill the one or more secondary commands may include generating 17412 a set of at least one configured system service (CSS). In some implementations, generating the set of at least one CSS may include utilizing 17414 an output of the primary computing device as an input to generate one or more control parameters. In some implementations, configuring the set of one or more computing devices to fulfill the one or more secondary commands may include providing 17416 intelligence received from the at least one CSS to the set of one or more computing devices. In some implementations, assigning at least the portion of one or more computing devices capable of fulfilling the primary command as the set of one or more computing devices to be managed by the secondary computing device may include executing 17418 an enrollment process between the set of one or more computing devices and the secondary computing device. In some implementations, executing the enrollment process may include conducting 17420 an inventory of communication protocols and data formats used by the set of one or more computing devices. In some implementations, the secondary computing device (e.g., via VCN process 10) may obtain 17422 one or more application programming interfaces (APIs) to enable communication and data format translation between each computing device of the set of one or more computing devices and the secondary computing device. In some implementations, the primary computing device (e.g., via VCN process 10) may be bypassed 17424 to receive external data at the secondary computing device when the external data is unused by the primary computing device. In some implementations, generating the set of at least one CSS may include generating 17426 at least one CSS for each interface layer in a management stack. In some implementations, intelligent decision-making regarding strategy for the primary command may be performed 17428 based upon, at least in part, a configured intelligence service (CIS). In some implementations, the set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

As also discussed throughout and referring also at least to the example implementations of FIGS. 161-173, a VCN process, such as VCN process 10, may configure 17800 a set of sub-level computing devices for communication with a primary computing device, wherein the primary computing device may manage the set of sub-level computing devices to orchestrate performance of a set of value chain network entities. In some implementations, VCN process 10 may receive 17802 (e.g., via the set of sub-level computing devices) a primary command from the primary computing device, wherein the command may be one of a task or a request associated with the value chain network. In some implementations, VCN process 10 may assign 17804 at least a portion of one or more computing devices capable of fulfilling the primary command as a set of one or more computing devices to be managed by the sub-level computing device, wherein the sub-level computing device may be a computing device that manages or executes performance of a particular entity or relationship of the value chain network. In some implementations, VCN process 10 may (e.g., via the sub-level computing device) configure 17806 the set of one or more computing devices to fulfill one or more secondary commands based upon, at least in part, the primary command. In some implementations, VCN process 10 may (e.g., via the sub-level computing device) fulfill 17808 the primary command based upon, at least in part, the set of one or more computing devices fulfilling the one or more secondary commands.

Configuring the set of one or more computing devices to fulfill the one or more secondary commands may include generating 17812 a set of at least one configured system service (CSS). Generating the set of at least one CSS may include utilizing 17814 an output of a plurality of sources as an input to generate one or more control parameters. Configuring the set of one or more computing devices to fulfill the one or more secondary commands may include providing 17816 intelligence received from the at least one CSS to the set of one or more computing devices. Assigning at least the portion of one or more computing devices capable of fulfilling the primary command as the set of one or more computing devices to be managed by the sub-level computing device may include executing 17818 an enrollment process between the set of one or more computing devices and the sub-level computing device. Executing the enrollment process may include conducting 17820 an inventory of communication protocols and data formats used by the set of one or more computing devices. The sub-level computing device may obtain 17822 one or more application programming interfaces (APIs) to enable communication and data format translation between each computing device of the set of one or more computing devices and the sub-level computing device. The primary computing device may be bypassed 17824 to receive external data at the sub-level computing device when the external data is unused by the primary computing device. Generating the set of at least one CSS may include generating 17826 at least one CSS for each interface layer in a management stack. Intelligent decision-making may be performed 17828 regarding strategy for the primary command based upon, at least in part, a configured intelligence service (CIS). The set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. A generated system output may be sent 17810 to the primary computing device responding to the primary command based upon, at least in part, the set of one or more computing devices fulfilling the one or more secondary commands.

As also discussed throughout and referring also at least to the example implementations of FIGS. 161-173, a VCN process, such as VCN process 10, may receive 17900, by a computing device, information associated with a set of value chain network entities of a value chain network, the information generated by at least one of a set of sensors of the set of value chain network entities, a set of IoT devices configured to collect data relating to the set of value chain network entities, or a set of APIs configured to publish data relating to the set of value chain network entities. In some implementations, VCN process 10 may provide 17902 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. In some implementations, VCN process 10 may determine 17904 a potential risk in the value chain based upon, at least in part, an output of the AI-based learning classification. In some implementations, VCN process 10 may execute 17906 an action to mitigate the potential risk in the value chain network.

Executing the action to mitigate the potential risk in the value chain network may include flagging 17908 the potential risk in the value chain network. Executing the action to mitigate the potential risk in the value chain network may include responding 17910 to the potential risk in the value chain network. Executing the action to mitigate the potential risk in the value chain network may include resolving 17912 an out-of-stock situation. Executing the action to mitigate the potential risk in the value chain network may include predicting 17914 when to place an order based upon, at least in part, upstream data. Executing the action to mitigate the potential risk in the value chain network may include supply planning 17916. Executing the action to mitigate the potential risk in the value chain network may include optimizing 17918 an inventory mix. External data may be received 17920, and a strategy to reduce transportation costs may be determined 17922 based upon, at least in part, the external data. Data associated with warehouse management, inventory management, order management, analytics may be unified 17924 to optimize an omnichannel fulfillment. A platform may be provided 17926 with a plurality of AI-based learning models for download. The set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. The set of AI-based learning models may include at least one of a transformer model, a convolutional neural network, a deep learning model trained on a set of outcomes of the value chain network entity, a supervised model, a semi-supervised model, an unsupervised model, or a reinforcement model. The training data set for the set of AI-based learning models may include one of a set of objects or events that are labeled to classify the set of objects or events according to a classification taxonomy that may include at least one of the operating state, the fault condition, the operating flow, or the behavior.

As also discussed throughout and referring also at least to the example implementations of FIGS. 161-173, a VCN process, such as VCN process 10, may 18001 receive, by a computing device, information associated with a set of value chain network entities of a value chain network, the information generated by at least one of a set of sensors of the set of value chain network entities, a set of IoT devices configured to collect data relating to the set of value chain network entities, or a set of APIs configured to publish data relating to the set of value chain network entities. In some implementations, VCN process 10 may provide 18003 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. In some implementations, VCN process 10 may determine 18005 a procurement action to be taken in the value chain network based upon, at least in part, an output of the set of AI-based learning models. In some implementations, VCN process 10 may execute 18007 the procurement action to facilitate an improvement of at least one of an operating state, a condition, a flow or a behavior of at least one entity of the set of value chain network entities.

In some implementations, executing the procurement action may include resolving 18009 an out-of-stock situation. In some implementations, executing the procurement action may include predicting 18011 when to place an order based upon, at least in part, upstream data. In some implementations, VCN process 10 may provide 18013 an alert describing the procurement action that was executed. In some implementations, the information may include past behavior over time, historical data, and current data. In some implementations, VCN process 10 may provide 18015 real-time information on supplier performance. In some implementations, VCN process 10 may monitor 18017 compliance of suppliers and procurement teams. In some implementations, VCN process 10 may automatically generate 18019 purchase orders associated with the procurement action. In some implementations, VCN process 10 may automatically process 18021 invoice processing associated with the procurement action. In some implementations, VCN process 10 may unify 18023 data associated with warehouse management, inventory management, order management, analytics to optimize an omnichannel fulfillment. In some implementations, the set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model. In some implementations, the training data set for the set of AI-based learning models may include one of a set of objects or events that are labeled to classify the set of objects or events according to a classification taxonomy that may include at least one of the operating state, the fault condition, the operating flow, or the behavior. In some implementations, VCN process 10 may execute the procurement action by a value chain network digital twin.

As also discussed throughout and referring also at least to the example implementations of FIGS. 161-173, a VCN process, such as VCN process 10, may receive 18101, by a computing device, information associated with a set of value chain network entities of a value chain network, the information generated by at least one of a set of sensors of the set of value chain network entities, a set of IoT devices configured to collect data relating to the set of value chain network entities, or a set of APIs configured to publish data relating to the set of value chain network entities. In some implementations, VCN process 10 may provide 18103 the information to a first set of Artificial Intelligence (AI)-based learning models, wherein at least one member of the first set of AI-based learning models may be trained on a training data set of value chain network data to generate a prediction of future demand for an item in the value chain network. In some implementations, VCN process 10 may provide 18105 the information to a second set of AI-based learning models, wherein at least one member of the second set of AI-based learning models may be trained on a training data set of a set of value chain network entities operating data to classify at least one of: an operating state, a fault condition, an operating flow, or a behavior of at least one value chain entity of the set of value chain network entities. In some implementations, VCN process 10 may determine 18107 a potential risk in the value chain network associated with the at least one value chain network entity based upon, at least in part, an output of the AI-based learning models. In some implementations, VCN process 10 may output 18109 a recommendation to mitigate the potential risk in the value chain network or may automatically execute 18111 an action to mitigate the potential risk in the value chain network.

In some implementations, executing the action to mitigate the potential risk in the value chain network associated with the item may include flagging 18113 the potential risk in the value chain network associated with the item. In some implementations, executing the action to mitigate the potential risk in the value chain network associated with the item may include responding 18115 to the potential risk in the value chain network associated with the item. In some implementations, executing the action to mitigate the potential risk in the value chain network associated with the item may include resolving 18117 an out-of-stock situation. In some implementations, executing the action to mitigate the potential risk in the value chain network associated with the item may include predicting 18119 when to place an order based upon, at least in part, upstream data. In some implementations, VCN process 10 may unify 18121 data associated with warehouse management, inventory management, order management, analytics to optimize an omnichannel fulfillment. In some implementations, VCN process 10 may provide 18123 an alert describing the action to mitigate the potential risk in the value chain network associated with the item that was executed. The information may include past behavior over time, historical data, and current data. In some implementations, the potential risk may be a potential disruption in the value chain network associated with the item. In some implementations, VCN process 10 may render 18125 a visualization associated with at least one of inbound or outbound shipments associated with the item. In some implementations, the set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model. In some implementations, the training data set for the set of AI-based learning models may include one of a set of objects or events that are labeled to classify the set of objects or events according to a classification taxonomy that may include at least one of the operating state, the fault condition, the operating flow, or the behavior.

As also discussed throughout and referring also at least to the example implementations of FIGS. 161-173, a VCN process, such as VCN process 10, may receive 18200, by a computing device, information associated with a value chain network, the information generated by at least one of a set of sensors of a set of value chain network entities, a set of IoT devices configured to collect data relating to the set of value chain network entities, or a set of APIs configured to publish data relating to the set of value chain network entities. In some implementations, VCN process 10 may provide 18202 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. In some implementations, VCN process 10 may determine 18204 a task to be completed for the value chain network based upon, at least in part, on an output of the set of AI-based learning models. In some implementations, VCN process 10 may execute 18206 the task to facilitate an improvement in the value chain network.

In some implementations, executing the task may include predicting 18208 future demand for an item in the value chain network. In some implementations, executing the task may include detecting 18210 defects and quality issues in an item in the value chain network. In some implementations, executing the task may include predicting 18212 when an item in the value chain network will fail. In some implementations, executing the task may include identifying 18214 a value chain process capable of optimization based upon, at least in part, analyzing the information associated with the value chain network, and optimizing 18216 the value chain process. In some implementations, executing the task may include analyzing 18218 user data of a user from at least one source, and identifying 18220 one or more attributes of the user based upon, at least in part, the user data. The information may include one or more of historical sales data and market trends associated with the item. The information may include one or more of a video and a photo associated with the item. The information may include data from one or more sensors associated with the item. The value chain process may include one or more of transportation routing, inventory management, or supplier selection. The set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. The set of AI-based learning models may include at least one of a transformer model, a convolutional neural network, a deep learning model trained on a set of outcomes of the value chain network entity, a supervised model, a semi-supervised model, an unsupervised model, or a reinforcement model. The training data set for the set of AI-based learning models may include one of a set of objects or events that are labeled to classify the set of objects or events according to a classification taxonomy that may include at least one of the operating state, the fault condition, the operating flow, or the behavior.

As also discussed throughout and referring also at least to the example implementations of FIGS. 161-173, a VCN process, such as VCN process 10, may receive 18300, by a computing device, information associated with a value chain network, the information generated by at least one of a set of sensors of a set of value chain network entities, a set of IoT devices configured to collect data relating to the set of value chain network entities, or a set of APIs configured to publish data relating to the set of value chain network entities. In some implementations, VCN process 10 may provide 18302 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network and at least one member of the set of AI-based learning models is trained on the training data set to determine, upon receiving the classification, a task to be completed for the value chain network. In some implementations, VCN process 10 may provide 18304 a computer code instruction set to a machine to execute the task to facilitate an improvement in the operation of the value chain network.

In some implementations, providing the computer code instruction set to the smart machine to execute the task may include instructing 18306 the machine to move an item throughout the value chain network. In some implementations, providing the computer code instruction set to the machine to execute the task may include instructing 18308 the machine to detect defects and quality issues in an item in the value chain network. In some implementations, providing the computer code instruction set to the machine to execute the task may include instructing 18310 the machine to predict when an item in the value chain network will fail. In some implementations, providing the computer code instruction set to the machine to execute the task may include instructing 18312 the machine to identify a value chain process capable of optimization based upon, at least in part, analyzing the information associated with the value chain network, and optimize the value chain process. In some implementations, providing the computer code instruction set to the machine to execute the task may include instructing 18314 the machine to transport the item between locations. The machine may include one or more of a robot, an automated guided vehicle (AGV), or a drone. The information associated with the value chain network may include one or more of a video and a photo associated with the item to detect the defects and quality issues in the item in the value chain network. The information associated with the value chain network may include data from one or more sensors associated with the item to predict when the item in the value chain network will fail. The value chain process may include one or more of transportation routing, inventory management, supplier selection, or warehouse management. The set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. The set of AI-based learning models may include at least one of a transformer model, a convolutional neural network, a deep learning model trained on a set of outcomes of the value chain network entity, a supervised model, a semi-supervised model, an unsupervised model, or a reinforcement model. The training data set for the set of AI-based learning models may include one of a set of objects or events that are labeled to classify the set of objects or events according to a classification taxonomy that may include at least one of the operating state, the fault condition, the operating flow, or the behavior.

As also discussed throughout and referring also at least to the example implementations of FIGS. 161-173, a VCN process, such as VCN process 10, may receive 18400, by a computing device, information associated with a value chain network, the information generated by at least one of a set of sensors of a set of value chain network entities, a set of IoT devices configured to collect data relating to the set of value chain network entities, or a set of APIs configured to publish data relating to the set of value chain network entities. In some implementations, VCN process 10 may provide 18402 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network and at least one member of the set of AI-based learning models is trained on the training data set to determine, upon receiving the classification, a task to be completed for the value chain network. In some implementations, VCN process 10 may (e.g., via a robotic process automation system) configure 18404 the robotic process automation system to execute the task to facilitate an improvement in the value chain network.

In some implementations, the task may include automatically processing 18406 one or more orders for an item in the value chain network based upon, at least in part, the information, wherein automatically processing the one or more orders for the item in the value chain network may include extracting 18408 order data of the one or more orders from one or more sources and automatically inputting 18410 the order data extracted from the one or more sources into an order management system. In some implementations, the task may include monitoring 18412 an inventory level for an item in the value chain network and automatically generating 18414 one or more purchase orders for the item when the inventory level for the item in the value chain network falls below a threshold. In some implementations, VCN process 10 may track 18416 a shipment of the item in real-time and the inventory level for the item in the value chain network may be automatically updated 18418 based upon, at least in part, tracking the shipment of the item in real-time. In some implementations, the task may include VCN process 10 extracting 18420 invoice data of the one or more invoices from one or more sources and automatically inputting 18422 the invoice data extracted from the one or more sources into an accounting system. In some implementations, VCN process 10 may render 18424 a user interface enabling a user to visually design automation workflows. In some implementations, VCN process 10 may render 18426 a user interface enabling a user to manage automation processes. In some implementations, VCN process 10 may render 18428 a user interface enabling a user to create a plurality of AI-based learning models and select a plurality of application programming interfaces to integrate the plurality of AI models into one or more automation workflows. In some implementations, VCN process 10 may render 18430 a user interface enabling a user to track automation performance and generate custom dashboards based upon, at least in part, the automation performance. The set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. The set of AI-based learning models may include at least one of a transformer model, a convolutional neural network, a deep learning model trained on a set of outcomes of the value chain network entity, a supervised model, a semi-supervised model, an unsupervised model, or a reinforcement model. The training data set for the set of AI-based learning models may include one of a set of objects or events that are labeled to classify the set of objects or events according to a classification taxonomy that may include at least one of the operating state, the fault condition, the operating flow, or the behavior.

As also discussed throughout and referring also at least to the example implementations of FIGS. 161-173, a VCN process, such as VCN process 10, may receive 18500, by a value chain network digital twin, information associated with a value chain network, wherein the information may include a virtual representation of a plurality of associations between physical data items of the value chain network, and wherein the information may be dynamic, real-time and time-phased. In some implementations, VCN process 10 may provide 18502 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network and at least one member of the set of AI-based learning models may be trained on the training data set to determine, upon receiving the classification, a task to be completed for the value chain network. In some implementations, VCN process 10 may provide 18504 at least one of an instruction for executing the task in the value chain network digital twin or provide 18506 a recommendation for executing the task in the value chain network digital twin may be provided.

In some implementations, receiving the information associated with the value chain network may include receiving 18508 sensor data indicative of inbound and outbound shipment conditions. In some implementations, VCN process 10 may render 18510 one of a virtual reality (VR) environment, an augmented reality (AR) environment, a mixed reality (MR) environment, or a diminished reality (DR) environment for a user to interact with the sensor-based virtual representation of the plurality of associations between the physical data items of the value chain network. In some implementations, the information may include real-time data about one of inbound prepaid shipments from suppliers linked to orders or inventory coming into a network associated with the value chain network. In some implementations, VCN process 10 may generate 18512 simulations for the value chain network digital twin, wherein the simulations for the value chain network digital twin may be generated with a graphical neural network (GNN). In some implementations, VCN process 10 may generate 18514 optimizations for the value chain network digital twin, wherein the simulations for the value chain network digital twin may be generated with a graphical neural network (GNN). In some implementations, a robotic operating system may enable the value chain network digital twin. In some implementations, the value chain network digital twin may operate within a digital twin system having one or more sets of one or more digital twins, wherein each digital twin of the one or more sets may include an embedded marketplace for digital twin simulations. In some implementations, the value chain network digital twin may operate within a digital twin system having one or more sets of one or more digital twins, wherein each digital twin of the one or more sets may include an embedded marketplace for one of artificial intelligence-based learning models or artificial intelligence-based algorithms. In some implementations, the value chain network digital twin may operate within a digital twin system having one or more sets of one or more digital twins, wherein each digital twin of the one or more sets may include an embedded marketplace for data. In some implementations, the set of the value chain network entities may include at least one of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities. In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model. In some implementations, the training data set for the set of AI-based learning models may include one of a set of objects or events that are labeled to classify the set of objects or events according to a classification taxonomy that may include at least one of the operating state, the fault condition, the operating flow, or the behavior.

As autonomous and semi-autonomous systems (generally referred to as autonomous-oriented systems) become more prevalent, the interaction among and between such systems will require varying degrees of management. This management may range from high-level coordination to direct facilitation and/or direct control. For example, an autonomous-oriented system may rely on or interact with one or more other autonomous-oriented systems. To illustrate, one autonomous-oriented system may be assigned or otherwise assume a principal task. This autonomous-oriented system may be referred to as a primary autonomous-oriented (PAO) system.

In various implementations, the principal task can be divided into subtasks. These subtasks may be controlled by or utilize one or more secondary autonomous-oriented (SAO) systems. In a simple configuration, this could mean that one SAO system is responsible for each subtask. In other configurations, one SAO system could be responsible for multiple subtasks. In various implementations, a single subtask may be handled by a set of SAO systems.

In a situation where the principal task has many subtasks, the PAO system therefore has the responsibility to manage some aspect of the SAO systems. For instance, the PAO system may communicate information to an SAO system to initiate functionality of the SAO system to complete the subtask (for example, by providing an initial input to the SAO system). In other situations, the PAO system leverages SAO systems that are generating data or information at some ongoing frequency to manage a particular subtask. In this situation, the PAO system may be configured to access or to request some portion of the information generated by the ongoing SAO system. As an example, the primary task, such as a logistics task, may have a subtask to determine the current weather or a prediction of the weather at a future date. Here, there may be an SAO system (e.g., operated by a third party) that determines weather information on an ongoing basis. Since such an SAO system already exists in operation, part of the PAO system's responsibility to perform the primary task would be to interface with the SAO system to obtain the necessary weather information.

Depending on the extent of the primary task, a subtask may be further nested—that is, much like a primary task, a subtask could be divided into more tasks that can each be controlled by one or more SAO systems. Dividing a primary task into multiple levels of subtasks (e.g., a first level of subtasks, a second level of sub-subtasks, a third level of sub-sub-subtasks, etc.) may be advantageous for autonomous/semi-autonomous systems. One example and non-limiting advantage in various implementations is parallel processing. With a primary task divided into tasks and levels of tasks, the execution of the primary task may be distributed across a greater number of computing resources (e.g., computer resources underlying SAO systems). Leveraging individual systems allows each system to execute their task(s) autonomously such that a certain set of tasks may be executed simultaneously. This parallel approach may therefore reduce the processing time for the entirety of the primary task because, to the extent logistically and technologically feasible, subtasks are completed at overlapping times rather than sequentially.

While distributing executable tasks across a vast number of resources (e.g., SAO systems) may result in efficient time for processing, this efficiency has a cost in terms of coordination effort and complexity. The coordination between autonomous-oriented systems may be difficult. For example, knowing what resources to make accessible to autonomous-oriented systems or knowing how to configure a set of autonomous-oriented systems for a primary task can dissuade even those who could ultimately derive value from coordinating such implementation. To further complicate the matter, one or more autonomous-oriented systems may already be deployed performing functions that are independent of the primary task. Here, it may be beneficial to utilize these deployed autonomous-oriented systems, but configuring the PAO system to integrate deployed systems to assist with the primary task can present compatibility issues.

One environment that is ripe for autonomous-oriented systems management is an organization or enterprise. A business organization that functions as an enterprise can have a lot of moving pieces with a particular overarching purpose, goal, or objective. For instance, a business purpose may be to produce a particular product line. To achieve its purpose, the enterprise may have a structure that includes various business units, such as divisions, departments, job roles, facilities, etc. An enterprise may span multiple business sectors and may therefore have business units, such as divisions, that can be dedicated to a particular business sector.

Although the structure of an enterprise in terms of its business units may differ, there are organizational roles that may be common across many enterprises. A corporate entity typically has tax obligations, human resources to manage, and financial and contractual obligations. From this perspective, enterprise-style businesses tend to have, among others, an accounting department for financial and tax matters, a sales department to initiate contractual obligations, a human resources department to manage the human resources, a legal department to oversee contracts and other legal matters, etc. The business units of an enterprise can also differ depending on the type of company or activity that a particular portion of the company (i.e., division) performs. As an example, when divisions of an enterprise make products, these divisions may have additional departments to support production, such as an engineering department, a quality department, a procurement team, a manufacturing department, a logistics department, a general operations team, etc.

The nature of an enterprise's autonomous-oriented systems likely depends to some degree on the structure of the enterprise. To illustrate, some organizations may be structured such that a business unit is shared by multiple divisions. As an example, an organization shares various administrative functions. That is, although an organization may have several divisions, all of the divisions use the same legal department or human resources department. In other situations, it may make sense that a particular role or activity is included in each business unit. For instance, a manufacturing company may have several divisions where each division manufactures different products. Here, each division may have its own accounting department or sales department because overseeing those departments may be contextually dependent on the product manufactured. In other words, a sales department for a first product (e.g., a software product) may demand different job skills or educational background than a sales department for a second product (e.g., a semiconductor).

With many permutations as to the structure of an enterprise, certain aspects of the enterprise may be or become disjointed from others aspect of the enterprise. For example, a quality department in one division may have little to no idea what a quality department in another division is doing. Unfortunately, this can mean that autonomous-oriented systems- or non-autonomous system(s) relied on by autonomous-oriented systems—that are deployed by the first quality department can be unknown to the second quality department even though the systems may be of value to the second quality department. As an enterprise becomes larger, this type of problem can amplify such that managing or tracking resources such as autonomous-oriented systems can become seemingly untenable. If this type of situation arises, it is nearly inevitable that compatibility and cooperation among autonomous-oriented systems can be difficult and/or non-existent. This disappointing reality can result in underutilization of resources and/or a lack of cooperative synergy. Moreover, without addressing some of these issues, the increasing prevalence of autonomous-oriented systems can translate to an ever-increasing collective mismanagement of available autonomous-oriented resources. For example, an enterprise may struggle to operate autonomously or semi-autonomously even though it has the capability or may deploy future resources that hinder its current autonomous capabilities.

One approach to address some of the issues with resource management at the enterprise level is to design a control architecture based on an enterprise's value chain. A value chain can refer to a set of connections between organizations, business units, or individuals associated with these entities. In a value chain, the connections are based on interactions that promote a measure of value. For example, an enterprise value chain is a set of connections that promote value for the overarching purpose, goal, or objective of the enterprise. For a commercial enterprise, the value chain may generally be constructed according to a set of relationships that produce and/or increase owner/shareholder value as the measure of value.

In some configurations, value chains may be further classified into value chain networks. Similar to a value chain that includes a set of connections, the set of connections for a value chain network includes a group of entities with one or more similar attributes (e.g., similar asset management responsibilities/controls). This group may be considered a “network” of a value chain because, for example, the interactions of the group demand shared information, data, and/or resources. In some implementations, such as an enterprise value chain, a value chain network may refer to a grouping that occurs at a particular level within the enterprise. For instance, each “network” of the value chain network may be formed at the business unit level of the enterprise. Each network may be responsible for the execution of some range of tasks or activities in furtherance of the goal or purpose of the enterprise. For example, a particular business unit can be referred to as a unit structure because the members of business units share similar role obligations (e.g., share, collaborate, and/or manage similar resources, information, and/or data). In some implementations, a set or group of the value chain network entities may include, but is not limited to one or more of products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

In various implementations, an enterprise may have multiple value chain networks. This could mean that one value chain network may refer to an operations business unit of the enterprise (i.e., an operations value chain network). Another value chain network may be a marketing and sales business unit of the enterprise (i.e., a marketing and sales value chain network). Yet another value chain network may be for a logistics business unit of the enterprise (i.e., a logistics value chain network). In this sense, a value chain network for a commercial business may be an economic ecosystem where each member of the network relies on other members of the network to promote value. The members of these networks may be internal members of the enterprise (e.g., teams or individual employees) or external members (e.g., customers).

As systems, such as autonomous-oriented systems, continue to improve, custom or selectively enhanced value chains according to the architecture disclosed herein may further expand (e.g., contribute to) the value capacity of these value chains. For example, the control architecture seeks to coordinate connectivity, high-level strategy, and/or control capabilities across one or more enterprise value chains to increase a target value metric. Moreover, the architecture may promote incremental value benefits for downstream elements (e.g., SAO systems) by providing a structure that enables cooperative configurations of task/subtask processing. In other words, SAO systems that provide services can have their configurations tuned on a higher management plane (e.g., a control plane) rather than at the particular individual SAO system level (e.g., a data plane). In this respect, SAO systems can be configured to cooperate together with configurations that optimize their collective autonomy.

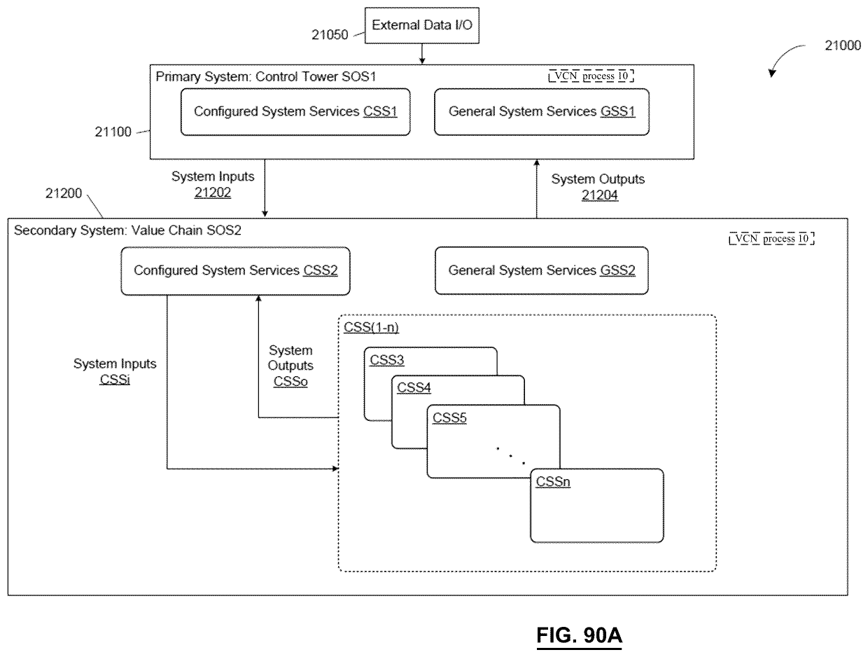

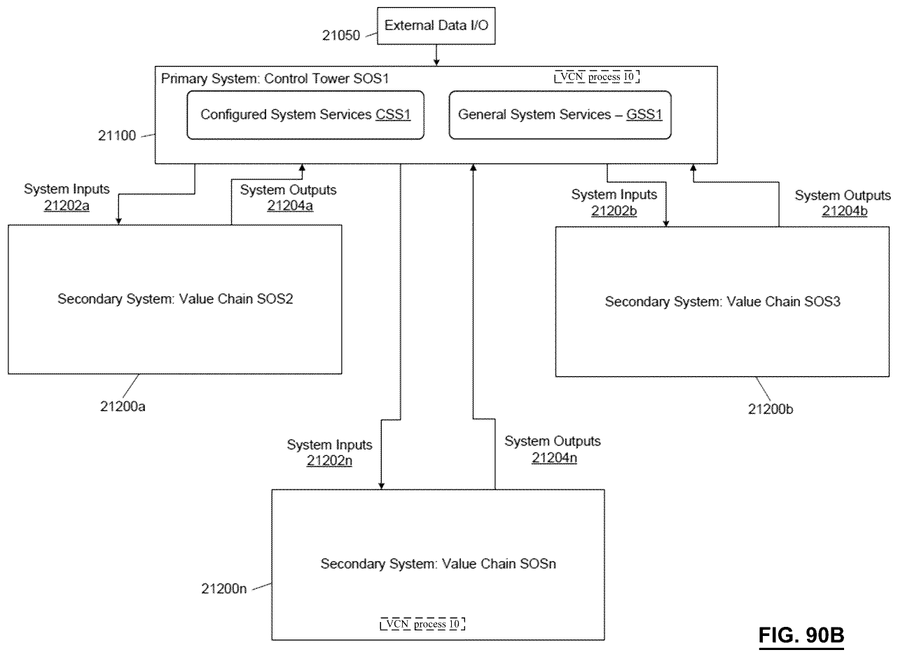

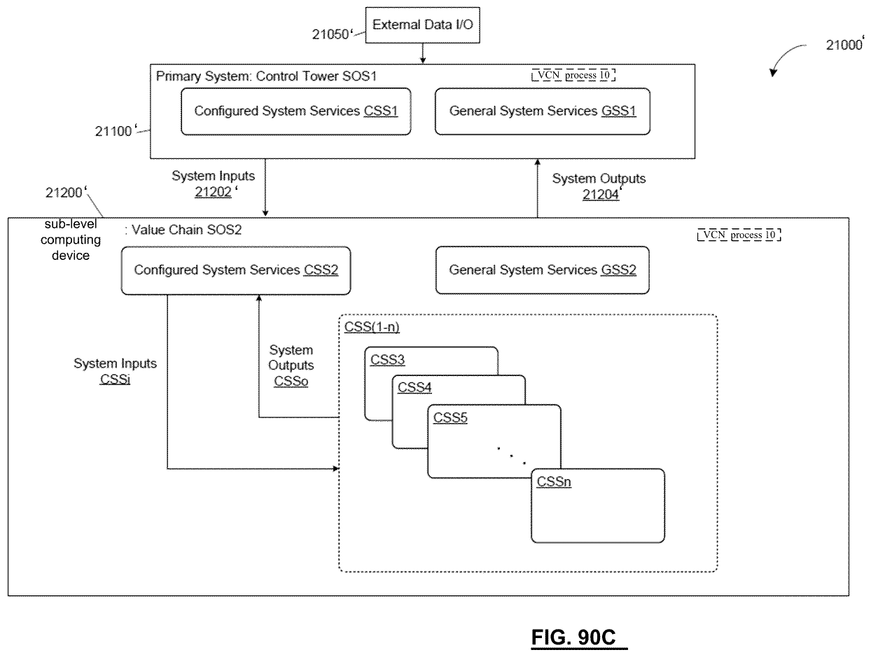

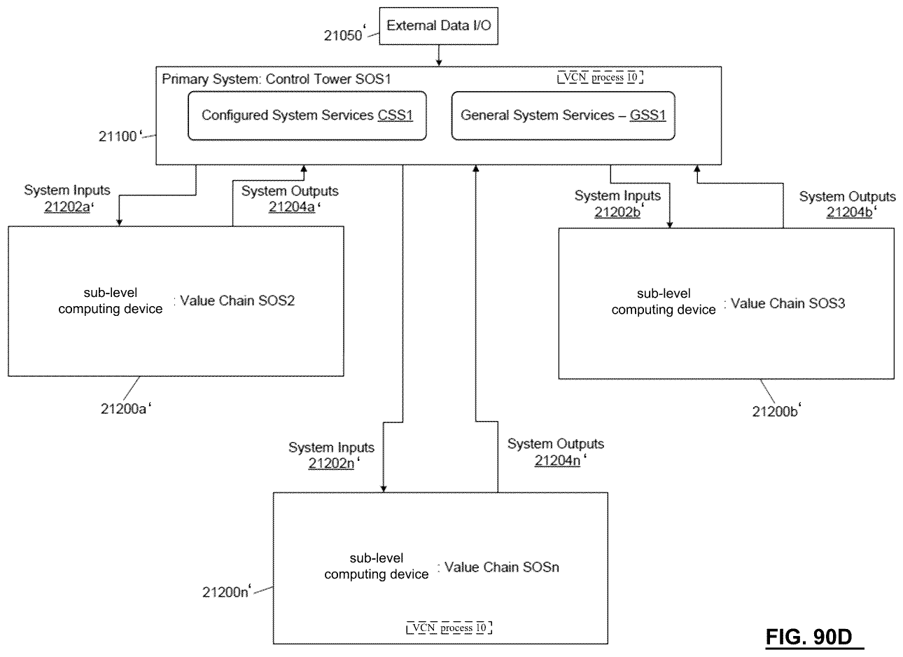

Referring to the example implementation of FIG. 90A, in some implementations, a control architecture 21000 generally includes a primary system 21100 (e.g., a PAO system) and one or more secondary systems 21200 (SAO system(s)). Each of the primary system 21100 and the second secondary system(s) 21200 functions in the control architecture 21000 as a system of systems (SOS). Here, a “system of systems” refers to a structure that provides cooperative coordination among a set of systems (e.g., already deployed/available systems such as autonomous-oriented systems) that are configurable for the execution of one or more services/tasks. The terminology of “system” of systems therefore indicates that a particular system (e.g., primary or secondary system) is the liaison system for a set of underlying systems. For instance, an SOS is deployed for a particular management or facilitation goal (e.g., to achieve a particular target metric or quantifiable measure of value). This type of SOS structure allows a first SOS to communicate with a second SOS without the need to interface with the set of systems for which an SOS is responsible for.

By having a first SOS communicate with a second SOS without the need to interface with the set of systems for which the second SOS is responsible, the control architecture 21000 may be able to minimize compatibility issues between all of the systems demanded for execution a primary task (e.g., autonomous execution). For example, if the underling systems are combinations of different hardware and/or programmable software, being able to have a uniform communication language or protocol to have the systems communicate with each can be incredibly difficult. With the control architecture 21000, systems may be setup in a set or a grouping that is configured by a particular SOS that is capable of communicating with members of the set. In this respect, the SOS of the group/set only needs communication tools for its set of systems and for outside communication with one or more SOSs. For instance, the secondary system 21200 includes communication tools to configure its underlying set of systems and communication tools to interface with the primary system 21100. The control architecture 21000 therefore can be quite elastic and permit scalability for communication between multiple SOSs without any individual SOS being responsible for all or a substantial portion of communication tools for all systems utilized within a particular implementation (i.e., instance) of the control architecture 21000.

As will be discussed in greater detail below, VCN process 10 may assign at least a portion of one or more computing devices capable of fulfilling the primary command as a set of one or more computing devices to be managed by the set of secondary computing devices. In some implementations, assigning at least the portion of one or more computing devices capable of fulfilling the primary command as the set of one or more computing devices to be managed by the secondary computing device may include executing 17418 an enrollment process between the set of one or more computing devices and the secondary computing device, and in some implementations, executing the enrollment process may include conducting 17420 an inventory of communication protocols and data formats used by the set of one or more computing devices. In some configurations, to promote communication compatibility, the systems of a set of systems for an SOS undergo an enrollment process. In this respect, the enrollment process may function as a configuration stage where an SOS ensures that it can communicate with the set of systems that it is intended to manage. For instance, each system may include its own data format(s) and/or communication protocol(s). In order for the SOS to manage and/or to configure its corresponding systems, it may therefore need to inventory and/or learn one or more ways to communicate using the communication protocols of its underlying system(s) and one or more ways to translate data formats amongst its enrolled members.

In some implementations, this configuration state may include enrolling a member system by determining at least one communication protocol for the enrollee and/or at least one data format for the enrollee. Once determined, the SOS may log or map this information (e.g., the communication protocol and/or data format) to inform the SOS the means of communication or data formatting to use when communicating with a particular system. In some configurations, the enrollment process can serve as a form of maintenance to ensure that the SOS is capable of communicating with and among its systems. For instance, when a system enrolls with the SOS, the SOS can check that it supports the enrolling systems' communication protocol(s) and/or data format(s). As an example of this check, the SOS may determine whether it has the latest version of a communication protocol or data format.

In some implementations, the secondary computing device (e.g., via VCN process 10) may obtain 17422 one or more application programming interfaces (APIs) to enable communication and data format translation between each computing device of the set of one or more computing devices and the secondary computing device. For instance, the enrollment process may configure aspects of an interface layer (e.g., discussed in detail below with respect to the interface layer 21350). For example, the enrollment process may determine and/or assign the appropriate application programming interfaces (APIs) or software development kits (SDKs) (or portions thereof) to be accessible or available to an SOS. For instance, the enrollment process generates a library of communication tools that permit communication with the systems associated with the SOS such that the SOS can reference or implement tools from the library to configure systems, integrate system outputs, and/or communicate data to/from a particular system.

In some examples, the set of systems corresponding to an SOS is a grouping of similar or interoperable systems. For instance, a clustering algorithm may identify systems that can be grouped together and managed by an SOS to perform a particular task/service. To form such a grouping, the clustering algorithm may consider various communication protocols and/or data formats. Additionally and/or alternatively, the clustering algorithm considers the task or service that the SOS is configuring and generates a set of candidate systems that are capable of performing some portion of the task (e.g., individually or collectively). For instance, some aspect of robotics is involved in the task and the clustering algorithm identifies candidate robots from a robotic fleet.

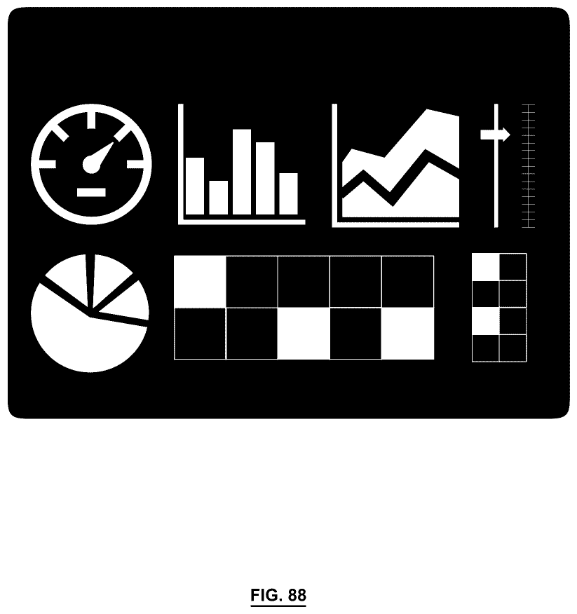

Generally, there are at least two primary avenues for companies to achieve control towers. As an example, large companies may create their own solutions in their respective ecosystems through the integration of disparate tools (e.g., Enterprise resource planning (ERP), TCM, product lifecycle management (PLM), etc.), where the ultimate control tower may be driven/enabled by ERP systems. As another example, small and medium companies may opt to contract and outsource control tower capabilities and operations with third/fourth party logistics providers (e.g., FedEx, DHL, BlueYonder, etc.) that integrate with ERP systems and are possibly connected by the cloud providers (both private and public). However, as noted above, while distributing executable tasks across a vast number of resources (e.g., SAO systems) may result in efficient time for processing, this efficiency has a cost in terms of coordination effort and complexity, not to mention communication protocol and data formatting compatibility issues. As will be discussed throughout, VCN process 10 may achieve the efficiency with less complexity and coordination effort, thereby simplifying and improving the processing time. Instead of sharing data linearly (i.e., from party to party), value chain network participants may use VCN process 10 to send all relevant data to a unified data repository, where the information is accessed by relevant partners (e.g., suppliers, manufacturers, warehouses/distribution centers, businesses, customers, etc.). Control towers allow companies to analyze operational data in real-time, allowing for proactive risk management, and more granular control over operations overall. Moreover, as discussed herein, a control tower dashboard may be a real-time dashboard(s), with advanced analytics, alert-driven event management, AI-based flagging and responses to potential disruptions in the value chain, intelligent procurement, predictive sourcing, automation (e.g., smart machine and robotic process automation), and digital twin information, all in one place. An example control tower dashboard (e.g., control tower dashboard 17300) is shown in the example implementation of FIG. 88.

### Control Tower for Computational Tasks of Value Chain Network Entities

In some implementations, a VCN process, such as VCN process 10, may configure 17400 a set of secondary computing devices (e.g., secondary systems 21200) of a set of value chain network entities for communication with a primary computing device (e.g., primary system 21100) of an enterprise operator, wherein the primary computing device may manage the set of secondary computing devices. For instance, in the example implementation depicted in FIG. 90A, the primary system 21100 is deployed as a control tower SOS. When a system is arranged as a control tower SOS, the system is typically deployed as a manager or primary facilitator among a set of secondary systems 21200 (e.g., as shown in FIG. 90B). As a manager (or other similar user), the overarching goal of the control tower may be to propagate a strategy (e.g., optimize a set of secondary systems 21200 for a particular primary task or primary service), to provide oversight to a system arrangement (e.g., system monitoring), and/or to control a set of systems (e.g., tune input parameters to secondary systems 21200 to produce a target result).

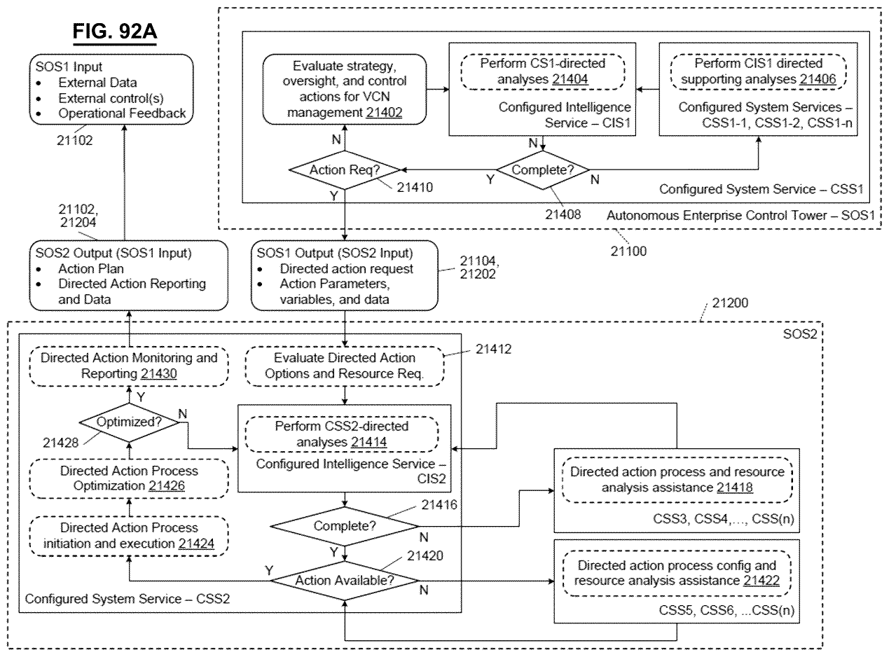

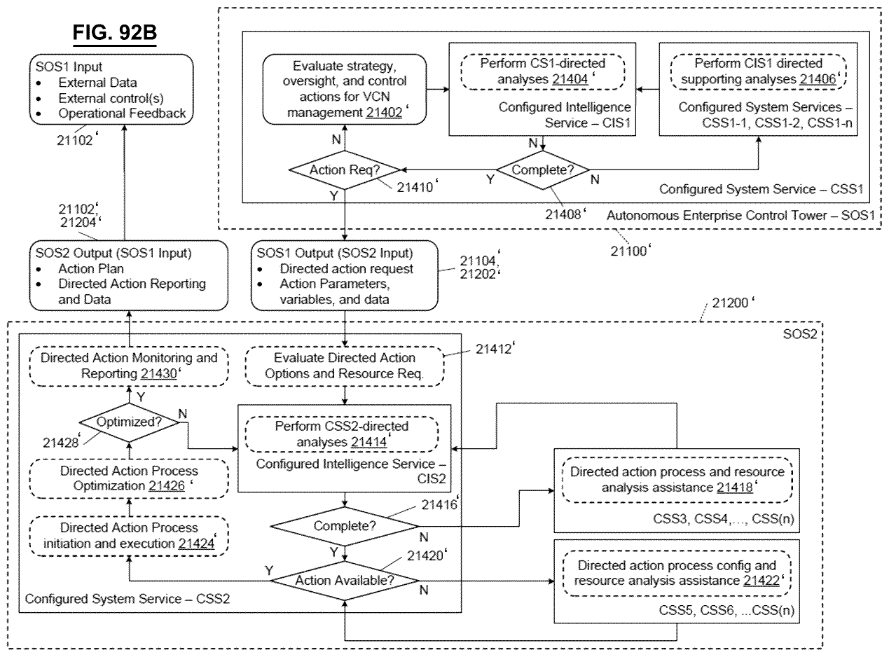

In some implementations, VCN process 10 may receive 17402 (e.g., via at least one member of the set of secondary computing devices) a set of primary commands from the primary computing device, wherein each of the set of commands may be at least one of a task or a request. For instance, and referring at least to the example implementation of FIG. 92A, the primary system 21100 receives a set of inputs 21102. Here, some examples of these inputs 21102 include external data (e.g., similar to external data 21050), external controls imposed on the system, and/or operational feedback. As a control tower or primary system 21100, upon receipt of the inputs 21102 at 21402, the primary system 21100 (e.g., using a CSS1) identifies that the inputs 21102 correspond to a particular request to perform a primary task. As part of the performance of the primary task, the primary system 21100 may be configured to perform managerial functions. These managerial functions may include: determining a strategy to perform the requested task; providing oversight for execution of the requested task; and/or controlling actions that execute the requested task.

As shown in FIG. 90A, the secondary system 21200 is also capable of generating a system output 21204 that may be communicated to the primary system 21100. The primary system 21100 may receive or otherwise obtain the system output 21204 at various times during an instance of the secondary system 21200. In other words, the generation of a system output 21204 may occur during initialization of the secondary system 21200, during simulation of the secondary system 21200, during operation/implementation of the secondary system 21200, or during some wind-down or final phase of the secondary system 21200 (e.g., in response to the secondary system 21200 completing a task/service).

In some examples, the system output 21204 functions as a feedback loop. For instance, as a feedback loop, the system output 21204 may inform the intelligence of the CSS. Here, by informing the intelligence of the CSS, the primary system 21100 via its CSS may further tune or fine tune the parameters that are generated and provided to the secondary system 21200 as system inputs 21202. In other words, in some circumstances, systems inputs 21202 may be provided to the secondary system 21200 on an ongoing basis (e.g., for ongoing product production). In these circumstances, the system outputs 21204 of the secondary system 21200 may impact the next round or iteration of system inputs 21202 provided to the secondary system 21200. In other words, the system outputs 21204 are capable of updating and/or modifying the system inputs 21202 due to the intelligent functionality of the CSS of the primary system 21100.

Referring further to FIG. 90A, the secondary system 21200 is a value chain SOS. In other words, the configuration promoted by the secondary system 21200 is generally optimized for a particular value metric or target metric. The focus and/or dependence on this value metric is therefore generally carried through or applied to the CSS of the secondary system 21200. For instance, the target metric is profit and therefore the secondary system 21200 performs its functionality with profit as a primary optimization variable when configuring its associated systems.

As shown in FIG. 90A, in some examples, the CSS configures the set of systems associated with the secondary system 21200. Here, the set of systems that is configurable by the CSS2 is illustrated by n number of additional CSSs (1-n). In other words, a secondary system 21200 may be responsible for performing some group of subtask(s) or service(s) to execute a primary task/service. Each subtask/service within that group may be associated with one or more systems (e.g., SOA systems). Stated differently, the one or more systems are capable of enabling and/or performing a subtask/service when configured. Meaning that, systems, such as SAO systems, are capable of performing functions that result in the execution of a range of tasks or services. These functions may be parameterized (e.g., according to a configuration) to tune the system to perform a particular task/service within the range or a specialized version of a task/service. In this respect, the CSSs of the secondary system 21200 therefore may enable or configure the set of systems that perform the corresponding subtask(s)/service(s).

As a simple example, the CSSs2 of the secondary system 21200 includes three systems and a CSS (e.g., CSS3-CSS5) that corresponds to each system (though a one-to-one relationship is described, other relationships are possible). In this example, the CSS2 of the secondary system 21200 would have to configure three CSSs to provide the services/tasks associated with the secondary system 21200. To illustrate, if the primary task was production of a product, the secondary system 21200 may be responsible for a subtask/service of the production—e.g., logistics. Here, although the secondary system 21200 is responsible for logistics, part of that responsibility may be the management or facilitation of systems associated with three different logistic channels—e.g., trucking logistics, flight logistics, and water vessel logistics. Accordingly, each of those three logistic channels may be configured to have its own CSS such that the secondary system 21200 provides configuration data for the operations of the three CSSs associated with each of those logistic channels. In this respect, the secondary system 21200 is able to generate configuration data that ensures that each CSS associated with each of the logistic channels collectively is optimized for the primary task. For instance, instead of each of the CSSs of the logistic channels only seeking their own self-optimization, the optimization is driven from a higher level. Meaning, that, for example, the water vessel logistics on its own may not seem to be optimized specifically for water vessel logistics of the product, but in the scheme of the entire logistics for the product, it is optimized in conjunction with the flight logistics and the trucking logistics so that the target metric is maximized (or minimized) across all of the logistic systems.

In some implementations, the primary system 21100 is the system that dictates or determines the set of services/tasks performed by each secondary system 21200. For example, the intelligence associated with the primary system 21100 determines the number of secondary systems 21200 that may be required for a particular primary task and/or the available systems that would enable the primary task. For instance, the primary system determines a combination of available systems that would enable the primary task. In this situation, the intelligence of the primary system 21100 recognizes that individually configured systems working together in some combination can perform some aspect of the primary task.

In some implementations, as noted above, VCN process 10 may assign 17404 at least a portion of one or more computing devices capable of fulfilling the primary command as a set of one or more computing devices to be managed by the set of secondary computing devices. For example, primary system 21100 as a control tower SOS receives a primary task or service request, as discussed above. In response to the receipt of the primary task or service request, the primary system 21100 determines a set of systems that can fulfill the request from a pool of available system resources (e.g., a pool of autonomous-oriented systems). In some implementations, the determined set of systems are parsed or classified into groups where each group is assigned to a secondary system 21200. As will be discussed below, each secondary system 21200 may generate a set of CSSs for the set of systems that are assigned to it.

In some implementations, VCN process 10 (e.g., via the set of secondary computing devices) may configure 17406 the set of one or more computing devices to fulfill one or more secondary commands based upon, at least in part, the primary command. For instance, with the CSSs scaled to the assigned set of systems, the secondary system 21200 configures each system of the set using the CSSs so that the set associated with the secondary system 21200 can collectively perform/enable the primary task with execution of its one or more tasks/services.

In some implementations, as noted above, configuring the set of one or more computing devices to fulfill the one or more secondary commands may include generating 17412 a set of at least one configured system service (CSS). For instance, FIG. 90A depicts a single primary system 21100 as the control tower SOS and a secondary system 21200 as a value chain SOS. Each SOS (e.g., the primary system 21100 or the secondary system 21200) generally includes at least one configured system service (CSS) and a general system service (GSS). For example, the primary system 21100 is shown with a first CSS (CSS1) and a first GSS (GSS1) while the secondary system 21200 is shown with a second CSS (CSS2) and a second GSS (GSS2). In this respect, each CSS and GSS may be tailored or dependent upon the SOS with which it is associated. For example, in some implementations, when the primary system 21100 as the control tower SOS is setup for oversight, the CSS1 and the GSS1 are configured to provide service(s) for oversight.

It will be appreciated after reading the present disclosure that any individual parts of the present disclosure that use a processor may include some or all of VCN process 10 (and vice versa). For example, VCN process 10 may include some or all of a CSS, a GSS, a primary system, a secondary system, a service, an application, etc. That is, any individual parts of the present disclosure that use a processor may be configured to effectuate some or all of the functionality of VCN process 10 (and vice versa). Accordingly, in some implementations, VCN process 10 may be a purely server-side process, a purely client-side process, or a hybrid server-side/client-side process that is cooperatively executed. Furthermore, it will be appreciated after reading the present disclosure that VCN process 10 may apply equally to the demand side as the supply side. That is, VCN process 10 is described with examples of obtaining information and insights for things affecting the supply of an item; however, VCN process 10 may also be used with examples of obtaining information and insights for things affecting the demand of an item. As such, the description of VCN process 10 being used for the supply side should be taken as example only and not to otherwise limit the scope of the present disclosure.

Factors that may affect the demand of an item may include, e.g.: Customer attributes, such as geographic location, historical purchasing habits and preferences, financial capacity, interactions with similar or proximal products, lifetime value; Market trends, such as popularity of particular products or categories of products, activism or social movements (e.g., palm oil is linked to the destruction of biodiversity, deforestation, etc. and demand for products with this ingredient may be suppressed as a result of increasing social awareness of negative impacts), seasonal demand; Competition, such as availability/price/appearance/brand value of competing or substitute products; Economic, such as correlation of item purchases with economic factors such as consumer spending, interest rates, exchange rates, etc.; Governmental/Regulatory, such as trade restrictions, tariffs, regulations related to import/export control or materials/ingredients; Marketing, such as advertising campaign metrics (e.g., website traffic, total page views, bounce rate, engagement rate, cost per click, cost per lead, cost per acquisition, conversion rate, longevity).

The GSS functions to provide general system integration and operations such as data storage, data processing, networking, and other shared functionality (e.g., the GSS may have similar functionality to aspects of data processing systems 1612, 10206, 12030, 12130, 12142, 13024 and/or data storage systems 624). In FIGS. 90A and 90B, the GSS is shown with a dashed-lined perimeter to represent that the GSS may be included locally within a deployed instance of an SOS (e.g., a primary system or a secondary system) or operate remotely yet in communication with an SOS. When deployed locally, the GSS may be configured in dedication to its associated SOS. In that respect, aspects of the GSS may be optimized, programmed, or configured to the instance of the SOS. When functioning remotely, the GSS may operate as a global GSS that one or more systems (e.g., a primary system 21100 and/or a secondary system(s) 21200) can access/utilize. Here, this type of global configuration may be advantageous, depending on the deployment of the control architecture 21000, because data storage and data processing functionality is shared among systems. Meaning that, data format compatibility or other data compliance related aspects are potentially addressed on the front-end (e.g., designed for compatibility).

In some implementations, generating the set of at least one CSS may include utilizing 17414 an output of the primary computing device as an input to generate one or more control parameters. The CSS for an SOS functions to configure the set of systems corresponding to the SOS to perform a set of tasks or services based on intelligence determined by the CSS. The intelligence performed for the CSSs is generally determined by a configured intelligence system CIS that is a part of (e.g., as shown in FIG. 92A) or associated with the CSSs. More particularly, the configured intelligence service CIS used by the CSS has the intelligence capabilities of or that are similar to the intelligence services system 8800 except that the configured intelligence system CIS is an intelligence services system that is configured, for example, by the CSS to provide intelligence for a particular set of system services. In this respect, the CSSs may act akin to the intelligence service client 8836 in its relationship with the configured intelligence system CIS. For instance, if the primary task of primary system 21100 is to control the production of a product, the intelligence of the CSS identifies system resources that (e.g., a set of systems) are available (e.g., within the enterprise ecosystem) to control production of the product and configures these control-based resources to generate control parameters that downstream production resources demand to produce the product. To extend this example to FIG. 90A, the primary system 21100 generates an output that is provided to the secondary system 22000 as a system input 21202. If the CSS1 generates control parameters, these control parameters may be fed as output of the primary system 21100 to the secondary system 21200 as system inputs 21202. The secondary system 21200 may then utilize the system inputs 21202 to configure its own CSS (e.g., the CSS2).

In some implementations, VCN process 10 may (e.g., via the set of secondary computing devices) fulfill 17408 the primary command based upon, at least in part, the set of one or more computing devices fulfilling the one or more secondary commands. For instance, FIG. 90B is similar to FIG. 90A except that FIG. 90B illustrates multiple secondary systems 21200a-n being managed by the primary system 21100. That is, multiple SOS instances may be coordinated via a single control tower SOS instance. The number of secondary systems 21200 associated with a control tower SOS or primary system 21100 may depend on several variables. Some of these variables may include, e.g., the selected set of systems to fulfill a service/task request, the type of systems selected, the configurable parameters of the selected systems, the communication capabilities of the selected systems, the manner in which the systems may be combined or cooperate, and the structure or characteristics of the enterprise deploying the control architecture 21000.

In some configurations, the set of systems selected to fulfill a service/task request (e.g., a request for a primary task) includes one or more third-party systems that the enterprise can access or utilize. For instance, for autonomous generation of a product, the primary system 21100 may inquire about demand for the product using a customer relations management (CRM) system managed by a third party. Here, the primary system 21100 or a secondary system 21200 may provide the CRM system with data that characterizes the product to be generated in order to query the CRM system to determine an estimated demand forecast from customers who have an interest in the type of product that has been characterized. In some implementations, the CRM system returns an output (e.g., a forecasted demand) based on the input data that is then configured to inform or be communication to one or more other systems. Therefore, when third-party systems are integrated in the configured systems workflow of the control architecture 21000, the SOS can determine acceptable inputs to these third-party systems and expected/anticipated outputs so that outputs can be pipeline data to the appropriate CSS.

In some implementations, VCN process 10 may send 17410 a generated system output to the primary computing device responding to the primary command based upon, at least in part, the set of one or more computing devices fulfilling the one or more secondary commands. For instance, and to expand on the previous example using FIG. 90B for example purposes only, when the set of systems that fulfill the request are parsed or classified into n groups, the primary system 21100 assigns the first group to the first secondary system 21200a, the second group to the second secondary system 21200b, and the nth group to the nth secondary system 21200n. Here, outputs from the primary system 21100 may be provided to any or all of the secondary systems 21200a-n to form the system inputs 21200a-n for the secondary systems 21200. Much like the single secondary system example of FIG. 90A, each secondary system 21200 is capable of generating system outputs 21204a-n that are communicated to or obtained by the primary system 21100. Although not shown, each of these secondary systems 21200, as SOS instances, may include CSSs and/or GSSs. Therefore, each secondary system 21200 generates a set of CSSs for the set of systems that are assigned to it.

In some implementations, an SOS has the capabilities to interface with entities or resources that are external to the SOS. For instance, FIGS. 90A and 90B illustrate the primary system 21100 as the control tower receiving external data inputs/outputs (I/O) 21050. Some examples of external data I/Os 21050 include asset indicators (e.g., asset statuses, asset locations, asset time of life, etc.), market data (e.g., for markets impacted/associated with an enterprise asset), weather data, sensor data (e.g., from robotic fleet management, IoT, digital twin, environmental container conditions such as temperature, humidity or light intensity, etc.), enterprise resource planning (ERP) data, network data (e.g., connectivity data), event data (e.g., holidays, event logs, cycle time, running time, etc.), local media, social media, geospatial data, economic data (e.g., inflation rates, unemployment rates, exchange rates, stock prices, investor sentiment data), web analytics (e.g., website traffic, search engine trends, website interaction behaviors), supplier performance data (e.g., supplier reputation and performance data and trends, supplier lead times, supplier quality), logistics and shipping data (e.g., freight rates, carrier performance, shipping route data), national/global news media (e.g., worker strikes, labor shortages, natural disasters, geopolitical instability). In some examples, the external data I/O 21050 is provided by another control tower SOS. Additionally and/or alternatively, the external data I/O 21050 may be generated by a third-party system that is or is not included in the control architecture 21000 such as a software as a service (SaaS) provider to the enterprise.

In some implementations, the primary computing device (e.g., via VCN process 10) may be bypassed 17424 to receive external data at the secondary computing device when the external data is unused by the primary computing device. For example, the control architecture 21000 is not limited to only the primary system 21100 receiving the external data 21050. In some configurations, it may be more efficient from a data management or data flow approach to feed external data 21050 directly to a secondary system 21200 or to a component of a secondary system 21200 (e.g., a CSS). For instance, a system of the secondary system 21200 rather than a system of the primary system 21100 is the system that consumes the external data 21050. In some instances, if the external data 21050 is not utilized by the primary system 21100 (e.g., the CSS), then having the primary system 21100 ingest, store, and/or relay the external data 21050 to a secondary system 21200 that consumes the external data 21050 may become burdensome or computationally expensive.

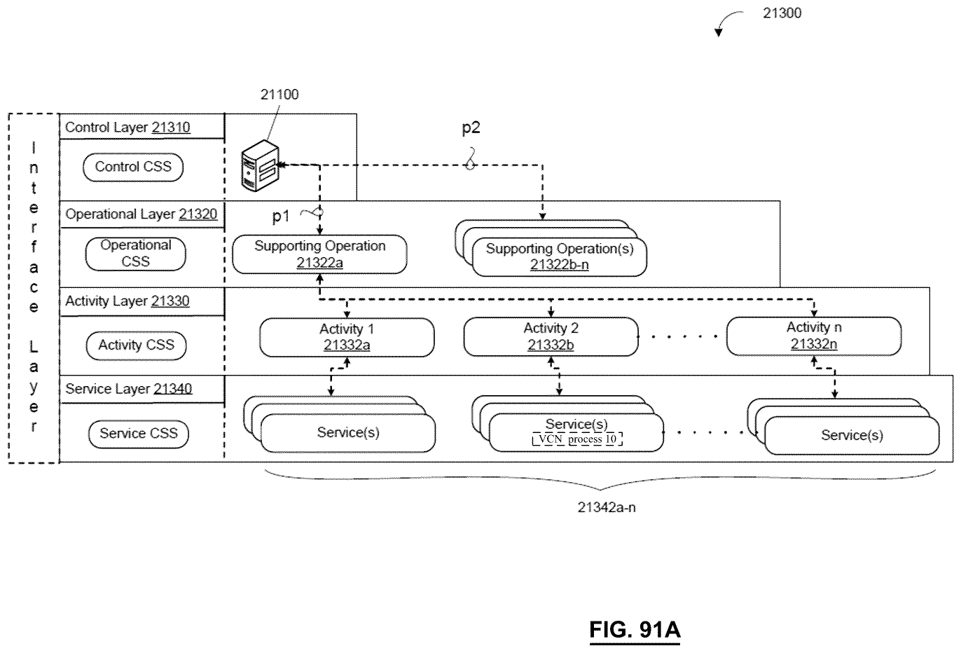

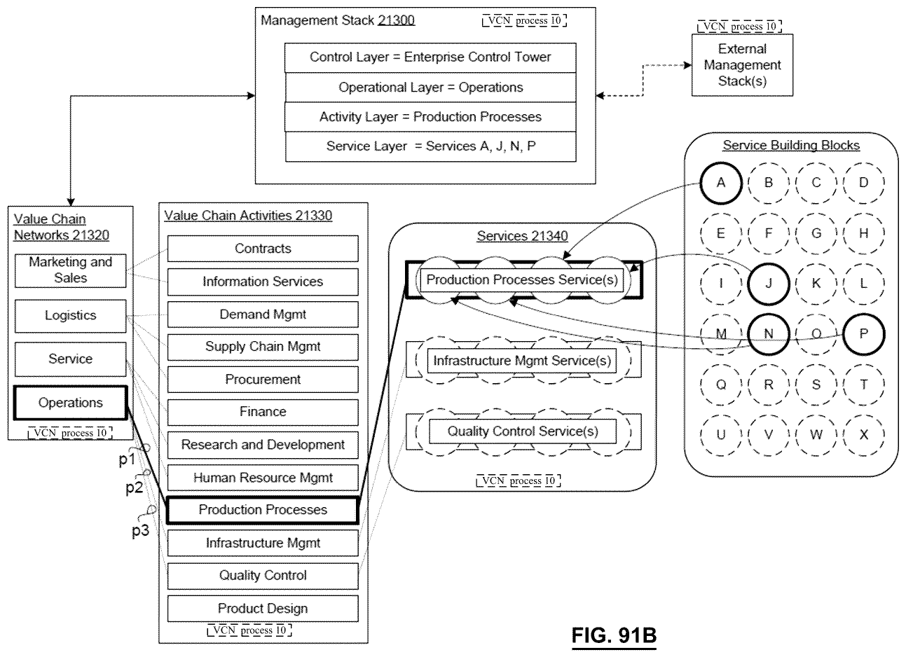

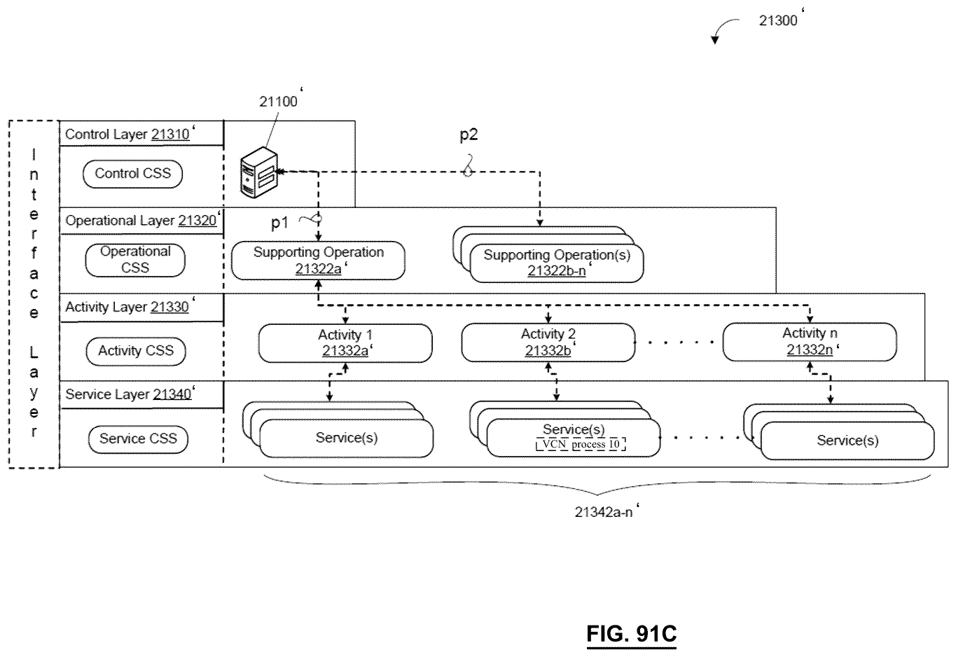

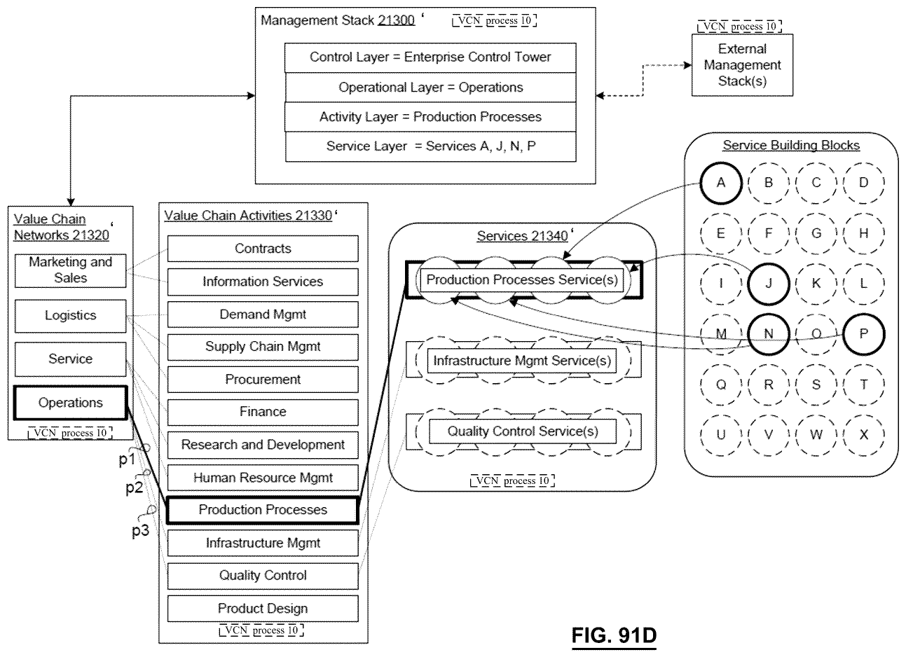

Referring to the example implementations of FIGS. 91A and 91B, the control architecture 21000 may be adapted to cater to a specific organization of an enterprise. In other words, the SOS structure that includes the CSS may be deployed to provide system management at any business unit level. To illustrate, FIG. 91A depicts a management stack 21300 (also referred to as stack 21300) that includes a control layer 21310, an operational layer 21320, an activity layer 21330, and a service layer 21340. Although the management stack 21300 is depicted as a 4-layer management stack 21300, the principles of a primary SOS system and a secondary SOS system may be applied to more or less layers (e.g., a 3-layer stack, a 5-layer stack, or a 10-layer stack). As shown in FIG. 91B, one reason for the 4-layer management stack 21300 is that it may track an enterprise's value chain workflow. For instance, in FIG. 91B, an enterprise may have a plurality of enterprise value chain networks that correspond to the operational groups/teams of the enterprise. FIG. 91A has four different operational groups-marketing and sales, logistics, service, and operations. Each operational group may be capable or expected to perform one or more activities for the enterprise. And moreover, each activity may use a set of services to perform the respective activity. In this sense, the service layer 21340 of the management stack 21300 corresponds to the set of services 21342a-n (e.g., data sourcing services, data processing services, intelligence services, analytics services, smart contracts services, distributed ledger services, governance services, security services, risk management services, etc.) that perform an activity 21332. The activity layer 21330 corresponds to the activity 21332 performed by an operational group of the enterprise and the operational layer 21320 corresponds to the particular operational team performing the activity 21332 with the set of services 21342.

In some implementations, a distributed ledger service may increase traceability of material supply chain to ensure corporate standards are met, as well as lower losses from counterfeit/gray market trading. A distributed ledger service may also improve visibility and compliance over outsourced contract manufacturing, as well as reduce paperwork and administrative costs, strengthen corporate reputation through providing transparency of materials used in products, improve credibility and public trust of data shared, reduce potential public relations risk from supply chain malpractice, and engage stakeholders.

In some implementations, a governance service may be used for access of a system in a VCN setting, including a set of policies, procedures, and controls that are implemented to ensure secure access to the system. The governance service may be responsible for managing and controlling access to the system by employees, suppliers, and other stakeholders in the supply chain network. The governance service may define the rules and requirements for accessing the system, including the authentication and authorization processes. This may involve establishing user roles and permissions, defining access levels, and implementing controls to ensure that only authorized individuals can access the system. The governance service may also be responsible for monitoring and auditing system access to detect and prevent unauthorized access or misuse of the system. This may involve regular review of user access logs and other system activity to identify potential security breaches or policy violations. Additionally, the governance service may be responsible for enforcing compliance with regulatory requirements and industry standards for data privacy and security. This may involve establishing and maintaining security protocols and procedures to protect sensitive data and information from unauthorized access or disclosure. In some implementations, innovations such as haptics, biometrics, and AI may be applied to enhance the security and functionality of the governance service. For instance, haptics may be used to provide a multi-factor authentication process that includes physical verification such as fingerprints or facial recognition, in addition to traditional login credentials such as username and password. Biometrics may also be used to enable continuous authentication, which may involve monitoring user behavior and biometric data to detect and prevent unauthorized access or suspicious activity. AI may be used to analyze access logs and other system activity data to identify potential security threats or policy violations in real-time. This may include identifying patterns of access that are outside of normal behavior or detecting unusual activity that could indicate a security breach. A scoring system may be used to assess the performance or behavior of individuals or organizations within the governance system. This may be used to identify areas for improvement or to provide incentives for good behavior. A Know Your Business (KYB) system may be used to verify the identity and legitimacy of businesses that are operating within the governance system. This may help prevent fraud, money laundering, or other illegal activities. A KYC system may be used to verify the identity of individuals who are participating in the governance system. This may help prevent fraud, identity theft, or other illegal activities. In some implementations, integrated blockchain technology may be used as a distributed ledger to record and verify transactions or interactions within the governance system. For example, a blockchain-based voting system may be used to ensure the integrity of elections or decision-making processes within the governance system. Another way to use blockchain is to create smart contracts that automatically execute certain actions or decisions within the governance system based on predefined rules. This can help reduce the risk of human error or fraud. Blockchain may also be used to create decentralized autonomous organizations (DAOs), which are organizations that operate based on rules encoded in smart contracts on a blockchain. DAOs may be used to create more democratic and decentralized governance structures, where decisions are made through transparent and decentralized voting processes.

As mentioned previously, the organizational structure of an enterprise, and especially a large enterprise, means that it is likely that multiple value chains may need to be managed or controlled to perform the objective, goal, or purpose of the enterprise. With this being the case, the control architecture 21000 may enable a primary system 21100 or control tower SOS to control multiple value chains from a central management position. For example, FIG. 91A depicts a single control tower SOS on the control layer 21310 as the overall management hub for the management stack 21300. The primary system 21100 may then manage one or more supporting operations 21322 (e.g., secondary systems 21200 that are operation specific) on the operational layer 21320. For instance, a first value chain may follow the first path p1 while a second value chain may follow the second path p2. For either value chain, the operational layer 21320 includes a set of supporting operations 21322. In terms of this example, a value chain network refers to a value chain that flows through a particular operational entity. That is, each operational entity or supporting operation has its own network of activities 21332 and services 21342 that enable the operational entity to properly function for the enterprise. For example, each supporting operation 21322 is shown to perform one or more activities 21332a-n on the activity layer 21330 with each activity 21332 supported by a set of services 21342a-n associated with the service layer 21340.

Referring specifically to the stack 21300 of FIG. 91A, the first path p1 flows through a first supporting operation 21322a. The first supporting operation 21322a includes n number of activities 21332a-n. Each activity 21332 is supported by a set of services 21342. For comparison, the second path p2 may flow through another supporting operation 21322 (e.g., a second supporting operation 21322b) of a set of supporting operations 21322a-n and then have a similar network structure with a corresponding set of activities 21332 performed/enabled by an underlying set of services 21342. In this respect, the stack 21300 is able to accommodate any number of supporting operations indicating that any number of value chains/value chain networks may be deployed with a single instance of a control tower SOS.

In some implementations, generating the set of at least one CSS may include generating 17426 at least one CSS for each interface layer in a management stack (e.g., management stack 21300). For instance, in some configurations, as shown in FIG. 91A, the functionality of each layer may be orchestrated by one or more SOS units. Meaning that, each layer may have one or more CSS that is capable of configuring the systems to provide the services demanded at each layer. In other words, each layer may have at least one local CSS to ensure the functionality of the layer can occur in an autonomous-oriented manner (e.g., autonomously or semi-autonomously). Each layer may be arranged to manage or control its proximate lower level. In this arrangement, the CSS for a particular layer functions to provision configurations (e.g., inputs, starter materials, connect data pipelines, etc.) that allow a lower level to function. For instance, the operational CSS associated with the operational layer 21320 configures systems that enable the set of activities 2132 to operate. Similarly, the CSSs of the activity layer 21330 configures systems that enable the set of services 21342 to function. At the lowest level, shown as the service layer 21340, the CSSs associated with this service layer 21340 enable the execution of the set of services 21342.

In some implementations, each layer in the management stack 21300 is capable of communicating with another layer using an interface layer 21350. The interface layer 21350 may include communication tools or protocols that enable one SOS to communicate with another SOS potentially anywhere in the stack 21300. The interface layer 21350 may also function to limit which layers (or SOSs) can communicate with which other layers (or other SOSs). That is, an architect of the stack 21300 may prefer for some communication tools to be limited to higher level control or vice versa (e.g., limited to service layer communication). In this respect, the interface layer 21350 can apply communication access controls at the layer level.

In some configurations, the interface layer 21350 includes a range of communication tools that permit one system to communicate with another system. For example, the interface layer 21350 includes a plurality of application programming interfaces (APIs) that allow software associated with one system or SOS to communicate with software of another SOS. An API is a software tool that generally facilitates communication between two platforms (e.g., between two CSSs or between two SOS systems). APIs are typically designed to standardize the way programmers/developers interact with a platform (e.g., a software application). In other words, prior to APIs, programmers/developers would likely have to customize the manner in which they interact or connect with the services of an application. With APIs, there are typically technical specifications in the form of documentation that is associated with the API that specifies how to integrate with the API. When using an application, a user may initiate a task/service from the application that generates a request. The API associated with the application may then make a call that relays the request to a destination or API endpoint (e.g., a uniform resource locator (URL) of a server). Upon receipt of the request, the API endpoint facilitates the execution of the task (e.g., by a third-party application or database that provides the task/service). From that perspective, APIs can ease the development and user experience by connecting disparate system (e.g., disparate software applications). In other words, by using an API, the entity configuring a system or application to perform a service can integrate the functionality of other systems without having to design those systems' functionality in-system. Some examples of APIs that the interface layer 21350 may include are Web APIs used to access web browsers or web-based devices, Simple Object Access Protocol (SOAP) APIs that use extensible markup language (XML) and XML schema to perform calls and structure payloads, Open APIs (also known as public APIs), Representative State Transfer (REST) APIs that use stateless communication protocols, JavaScript Objection Notation (JSON)-Remote Programming Calls (RPC) for asynchronous server calls, and other custom APIs. By making an array of APIs accessible to portions of the stack 21300, the interface layer 21350 helps ensure that the language of one system is capable of being translated to a language of another system. Otherwise, the set of systems deployed in a given instance of the management stack 21300 may have communication compatibility issues or suffer from the inability to cooperatively integrate cross-functionality.

The interface layer 21350 is also configured to use other communication tools such as a user interface (UI) (e.g., graphical user interfaces (GUI)) and software development kits (SDKs). Here, a GUI may correspond to the interface of an API or refer to another interface designed to curate a user experience and interaction with one or more systems. For instance, a system has a GUI that can receive configuration data from CSSs (e.g., to populate data entry fields provided by the GUI to receive a set of inputs). The GUI generally contains graphical elements with underlying functionality. These graphical elements may enable navigation and/or trigger execution of functions of the system associated with the GUI. It will be appreciated that other types of UIs may be included (e.g., audio-based UIs, gesture-based UIs, digital twin interface, smart wallet interface, augmented reality interface, virtual reality interface, mixed reality interface, interfaces with embedded marketplaces for assets, services, models, data, interfaces that may provide data stories, smart wallet interface that may provide data stories related to a transaction, an account, a set of accounts, etc., smart wallet interface that may manage receipts, interfaces that may provide recommendations/predictions etc.,) without departing from the scope of the present disclosure. In some implementations, a digital twin interface may facilitate the creation and management of a virtual replica of the physical elements, processes, and entities involved in a value chain network. Users may utilize the interface to visualize, simulate, or analyze operations, workflows, scenarios, or strategies pertaining to the value chain network in a virtual environment. In some implementations, a smart wallet interface may allow for the management of transactions, credentials, and digital assets within a network. It may include mechanisms for creating, amending, or substantiating smart contracts. The smart wallet interface may allow value chain network entities to exchange digital assets in a secure manner by ensuring the authenticity of transactions and their participants.

An SDK or devkit may refer to the set of building tools (e.g., software building tools) for a specific platform (e.g., system). Often, the tools of an SDK may include resources such as a compiler that translates from one programming language to another, code samples that provide examples of coding for the platform, code libraries with sets of preconfigured code sequences (e.g., common or frequently used coding functions), testing and analytics tools that generate metrics/analytics to quantify the performance of programming in, for example, testing and production environments, documentation that provides information or instructions to programmers/developers (e.g., instructions about other tools of the SDK), debuggers that are capable of identifying coding errors, and one or more APIs to relay calls to other services and systems. By deploying these tools, a new application may be built (e.g., beginning with an integrated development environment (IDE)) or an existing application may be modified. In some examples, for mobile application development, the SDK may be Apple's IOS SDK or Google's Android SDK. On the other hand, for large-scale applications, such as enterprise Software-as-a-Service (SaaS), proprietary web applications, or desktop software applications, the SDK may be open source.NET SDK.

With a management stack 21300, each layer of the stack 21300 may include one or more SOS units. As shown in FIG. 91A, the management stack 21300 maintains a similar hierarchical arrangement to that of the simple primary and secondary system 21100, 21200 of FIG. 90A. That is, the control layer 21310 that functions to control the value chain includes a control tower SOS as the primary system 21100.

Referring to FIG. 91B, an example management stack 21300 is shown for a particular enterprise value chain. In this example, the control layer 21310 is a primary system 21100 or enterprise control tower SOS. The operational layer 21320 includes four potential value chain networks corresponding to the supporting operations 2132 of (1) marketing and sales, (2) logistics, (3) service, and (4) operations. As shown by the darkened outline, the particular value chain depicted in FIG. 91B includes operations as the operational layer 21320. Here, with the operational layer 21320 corresponding to the operations group of the enterprise, the activity 21332 for the activity layer 21330 may be one of several activities 21332 that operations may perform. For instance, FIG. 91B illustrates a menu or set of activities 21332 that are associated with the operations group of the enterprise. Of the set of activities 21332 depicted, the operations group is responsible for performing the activities 21332 of production processes, infrastructure management, and quality control. In this respect, the primary system 21100 of the control layer 21310 may have a value chain dedicated to the management and/or control of each of these activities 21332 in relation to operations as the supporting operation 21322 for the enterprise. That is, the first path p1 of FIG. 91B illustrates a first value chain that corresponds to operations performing the activity 21332 of production processes. The second path p2 illustrates a second value chain that corresponds to operations performing the activity 21332 of infrastructure management. The third path p3 illustrates a third value chain that corresponds to operations performing the activity 21332 of quality control.

In some configurations, such as FIG. 91B, each enterprise group at the operational layer 21320 may have a corresponding set of activities 21332 that it can perform. For instance, FIG. 91B depicts that the marketing and sales group at the operational layer 21320 may perform the activities 21332 of contracts and information services. The logistics group at the operational layer 21320 may perform the activities 21332 of demand management, supply chain management, and procurement. The service group at the operational layer 21320 may perform the activities 21332 of finance, research and development, and human resource management. In these configurations, each activity flow path p can correspond to a value chain network. In that sense, the enterprise control tower may be simultaneously or sequentially managing upwards of a dozen value chain networks.

FIG. 91B also depicts that the services layer 21340 of the value chain differs based on the activity 21332 to be executed by one or more services 21342. For example, the value chain portrayed as the first path p1 may include a different set of services for the activity 21332 of production processes than the second path p2 for the activity 21332 of infrastructure management. Likewise, the third path p3 for the activity 21332 may have a completely different set of services than both activities 21332 of production processes and infrastructure management. It will be appreciated that more or less paths may be used.

Referring to FIG. 91B specifically, the service layer 21340 shows a set of services 21342 that are executed in some combination to perform the production processes activity 21332. The set of services may be a unique mix or combination of service building blocks. A building block generally refers to a system that may be configured individually or in combination with another one or more systems to perform task(s)/service(s) that enable a particular activity 21332 (e.g., autonomously allow the activity 21332 to occur). In this sense, it can be said each building block or service 21342 can have a particular configuration to support CSSs for an SOS. In FIG. 91B, the activity 21332 of production processes may be executed by a set of services 21342 that includes service building blocks A, J, N, and P. Although not depicted, a similar example would be that the activity 21332 of infrastructure management may include service building blocks A, G, and O. As supported by these examples, a building block, such as A, may be configured in combination with two different sets of services in order to perform different activities 21332 (e.g., production processes services v. infrastructure management services). With this being the case, permutations of building blocks can perform a vast array of activities 21332.

There may be a variety of service building blocks that may be configured to perform activates/actions for the purpose of the primary task. The building blocks that may be implemented by the control architecture 21000 are not limited to a particular ecosystem, but rather may transcend the ecosystems that they are described in relation to herein to provide a configured function or set of functions for the control architecture 21000. For instance, each of the applications 614, applications 630, the value chain entities 652, demand management applications 824, 1502, supply chain applications 812, 1500, intelligent product applications 1510, asset management applications 1530, and enterprise resource management applications 1520 from the VCNP 604 may be a building block. Other examples of buildings blocks may include adaptive intelligent systems 614, artificial intelligence systems 1160, 10212 (including hybrid artificial intelligence systems 3060), and/or other systematic services, such as artificial intelligence and computational systems 634, robotic process automation (RPA) systems 1442, protocol adaptors 1110, packet acceleration systems 1410, edge compute management systems 1400, edge intelligence systems 1420, edge networking systems 16100, adaptive networking systems 1430, state and event managers 1450, opportunity miners 1460, artificial intelligence systems 1160, digital twin systems 1700, digital twin simulation systems 2020, machine vision systems 1600, entity interaction systems 1920, real time monitoring systems 1520, visual monitoring systems 1930, point of interaction systems 1530, physical process observations systems 1510, robotic-oriented systems (e.g., robotic motion tracking systems), machine state monitoring systems 1940, IoT systems 1172, user feedback systems 1534, location monitoring systems 1532, behavioral monitoring systems 1538, entity discovery systems 1900, classification systems 1610, data processing systems 1612, signal processing systems 1614, prediction systems 1620, configuration systems 1630, control systems 1640, analytic systems 1650, testing/diagnostic systems 1660, security systems 1670, and quantum computing systems 17000. For additive manufacturing, some examples of building blocks include systems/services for the additive manufacturing platform 10110, such as additive manufacturing units 10102, pre-processing systems 10104, post-processing systems 10106, material handling systems 10108, finishing systems 10121, packaging systems 10122, shipping systems 10124, processing systems 10127, data acquisition systems 10602, design and simulation systems 10116, Product Lifecycle management (PLM) systems 10648, maintenance management systems (MMS) 10650, Quality Management systems (QMS) 10652, certification systems 10654, compliance systems 10656, feedstock formulation systems 10706, risk prediction and management systems 10712, marketing and customer service systems 10716, and AI systems 10212. With respect to liquid lens, some examples of building block include systems/services associated with dynamic visions systems 11200. For robotic fleet management, examples of building blocks include systems/services relating to the fleet management platform 12000, such as fleet operations systems 12002, robot operating units 12040, robot control systems 12150, robot security systems 12170, robotic process automation (RPA) systems 12216, vision and sensing systems 12112, and motion planning systems 12158. For smart containers, examples of building blocks include systems/services relating to the smart intermodal shipping container system 1300, such as smart containers 13026, smart container operating units 13040, logistics systems 13016, maintenance management systems 13028, smart container task assemblies 13050, security systems 13046, communication management systems 13010, remote-control systems 13012, human interface systems 13038, fleet management systems 13002, fleet configuration systems 13020, quantum computing services 13008, and smart container digital twins (e.g., smart container fleet manager digital twin 13328). For digital product networks, examples of building blocks include systems/services relating to the digital product network 14000, such as digital product network services 14002, connected products 14010, digital products 14210, demand aggregation systems 14250, supply chain management systems 14252, new product development systems 14254, customer relationship management systems 14256, PLM systems 14258, digital twin systems 14260, synchronized planning systems 14262, intelligent procurement systems 14264, dynamic fulfillment systems 14266, and digital product network systems 14508. For smart contracts, examples of building blocks include systems/services relating to the smart futures contract system 15000, such as futures systems 15006, smart contract services 15020, demand aggregation services 15022, digital wallets 15024, risk determination services 15026, and RPA services 15028. For biology-based systems, examples of building blocks include systems/services relating to the thalamus service 18001, such as control systems 18002, intake data management systems 18028, and intake controllers 18008. For energy systems, examples of building blocks include systems/services relating to the energy system 19000. For dual process artificial neural networks, examples of building blocks include systems/services relating to the dual process artificial neural network (DPANN) system 20000. Although these systems are specifically enumerated as potential building blocks, this list is non-exhaustive and may include other applications, systems, and/or services described herein or others not specifically described, but of a similar nature to systems/services of this disclosure. As explained previously, one or more of these building blocks may be particularly configured as well as mixed and matched in various combinations to form a set of building blocks capable of performing a target task, activity, or action.

In some implementations, there may be multiple sets of service building blocks that are capable of performing a given activity 21332, especially in a configuration that may be dictated by CSSs. When this is the case, an SOS, such as a primary system 21100, can (as noted above) identify the candidate sets of service building blocks that are capable of performing an activity 21332 and determine an optimal set from the candidate sets. In some examples, the optimal set of service building blocks is determined by an optimization algorithm that weighs one or more different importance factors. Some examples of importance factors include consumption of computing resources, duty cycle, response time, estimated time to complete the activity 21332, amount of computing resources consumed by internal resources in relation to third-party resource consumption, training or initiation time, quality metrics, inventory metrics/thresholds, human resource expenditure, overhead, cost, raw material consumption, operational capacity, and resource utilization.

Although FIG. 91B illustrates twenty-four service building blocks, there may be a greater or a fewer number of service building blocks depending on the services available to an enterprise. In some examples, the number of service building blocks is contingent upon the number of services that systems of the enterprise are capable of performing. Meaning that, an enterprise with five systems capable of performing seven service(s)/task(s) may have seven service building blocks such that the enterprise can deploy a configured instance of some set/subset of the seven service blocks. With this type of structure, a management stack 21300 can focus on optimizing a configuration for a combination of services rather than trying to optimize or configure each service individually.

FIG. 92A illustrates an example of the functionality of the control architecture 21000. Here, the control architecture 21000 includes a primary system 21100 labeled as an autonomous enterprise control tower SOS1 and a secondary system 21200 labeled as an autonomous enterprise SOS2. As previously mentioned, here, the highest-level SOS is the primary system 21100 while the lower level SOS is the secondary system 21200. With nested or grouped systems, the functionality or characteristics of one particular system (e.g., the primary system 21100) may be unique or differentiable with respect to another system (e.g., the secondary system 21200) due to the types of inputs and/or outputs associated with each system. In other words, a first set of inputs to a system can influence an arrangement of services (e.g., intelligence services) to form a unique configuration of those services for the system.

In some implementations, configuring the set of one or more computing devices to fulfill the one or more secondary commands may include providing 17416 intelligence received from the at least one CSS to the set of one or more computing devices. For instance, in some examples, such as FIG. 92A, the CSS1 of the primary system 21100 includes a first configured intelligence service CIS1 that, at 21404, receives a directed request to perform intelligent processing for the CSS1. Here, this request may be referred to as an “intelligence request” from the CSS. Intelligent processing may refer to using, at the configured intelligence service (CIS), intelligence capabilities of or similar to the intelligence services system 8800. In some examples, the arrangement of the configured intelligence service CIS is identical to that of the intelligence services system 8800 (e.g., shown in FIG. 78) except that it has an intelligence configuration (e.g., configured by its associated CSSs) that has been adapted to support a particular system service or set of system services. In the case of a control tower or primary system 21100, this intelligent processing at 21404 may perform analysis of one or more of the managerial functions. In some implementations, intelligent decision-making regarding strategy for the primary command may be performed 17428 based upon, at least in part, the CIS. For instance, when the primary system 21100 is determining a strategy to perform the requested task (i.e., the primary task), the intelligence service is capable of performing intelligent decision-making regarding strategy for the requested task. This decision making may include decomposing the primary task into a set of subtasks, determining secondary systems 21200 that may be capable of performing the primary task, evaluating the availability of one or more secondary systems 21200, predicting an efficient use of resources to perform the primary task, and/or allocating system resources to the primary task or some portion of the primary task.

In some implementations, the first configured intelligence service CIS1 is supported by other system services. That is, at 21406, one or more other system services may be configured to perform supporting analytics for the intelligence services of the first configured intelligence service CIS1. For example, FIG. 92A illustrates n number of CSSs CSS1-1 . . . . CSS1-n to represent the other system services that have been configured to support the first configured intelligence service CIS. As an example, when the first configured intelligence service CIS1 is evaluating the availability of secondary systems 21200, a set of supporting system services may be configured to query various systems to determine system capabilities or resource utilization. In this sense, the CSSs CSS1-n have been configured for resource management and resource reporting.

In response to performing intelligent processing, the CSS1, at 21408, determines whether the processing has provided adequate intelligence in response to the intelligence request (i.e., has successfully fulfilled the intelligence request). In some implementations, to evaluate whether the intelligent processing is complete, the CSS determines whether the output or decision generated by the configured intelligence system CIS satisfies a threshold (e.g., a decision-making threshold). For instance, the output or decision from the configured intelligence service CIS may be bound by constraints. Here, these constraints may individually or collectively correspond to the decision-making threshold. In some examples, these constraints correspond to the set of inputs 21102 to the primary system 21100. For instance, the constraints are derived from or related to one or more external controls provided to the primary system 21100 as an input 21102.

In some configurations, the CSS1 determines whether the intelligent processing has provided adequate intelligence for the intelligence request in response to an output from the configured intelligence service CIS. In other configurations, there may be an event which triggers an evaluation of whether the intelligent processing has provided adequate intelligence in response to the intelligence request. For instance, the event may be a time-based event such as an expiration of a set duration after receiving the request or an expiration of a time period based on a set frequency for evaluating the intelligent processing.

As shown in FIG. 92A, in response to the intelligent processing failing to provide sufficient intelligence for the intelligence request or being incomplete at the time of evaluation, the CSS1 may iteratively repeat the intelligent processing at 21404 and 21406 in furtherance of the intelligence request. When another iteration occurs, that iteration of intelligent processing may also include another iteration of support from one or more of the other system services (e.g., shown as CSSs CSS1-n). In some examples, an iteration may require less (or more) system services than a prior iteration. In this respect, each iteration may include an operation that identifies which, if any, of the supporting system services are demanded for the present iteration. Moreover, each iteration may demand a different configuration for the supporting system service(s). When a different configuration is requested, the CSS1 can generate configuration data prior to the provision of services by the supporting system services during the present iteration. That is, although the configuration system services CSS of the primary system 21100 may be designed for the requested functionality of the primary system 21100, this configuration may vary to some extent during sequential intelligent processing (e.g., within some expected variance).

In response to a determination that the intelligent processing of the configured intelligence service CIS has provided adequate intelligence in response to the intelligence request, the CSS is configured to determine at 21410 whether further action is required (e.g., from one or more secondary systems 21200). That is, the CSS of the primary system 21100 is a system designed to perform a particular service or set of services (e.g., based on the primary task). Here, at 21410, if the output of the configured intelligence service CIS satisfies or enables the CSS to perform its own set of services to satisfy the primary task without further input or influence, then the primary system 21100 may complete the request without involving the secondary system 21200.

However, in some examples, the primary system 21100 requires at least another level of services to perform the primary task. The primary system 21100 may call on any number of secondary systems 21200 (e.g., via an output 21104) to perform a directed set of tasks. To call on the secondary system 21200, the primary system 21100 may generate an output 21104 that functions as an input 21202 to the secondary system 21200. As shown in FIG. 92A, this output 21104 may be a directed action request or some action-configuring information such as parameters, variables, or data. Here, this output 21104 by the primary system 21100 may enable the secondary system 21200 to be configured to perform actions/functions in furtherance of the primary task or to perform according to the directed action request. For example, the directed action request requests that the secondary system 21200 executes or facilitates the execution of one or more subtasks associated with primary request. As an example, the directed action request includes an executable sequence of tasks for the secondary system 21200 to perform.

In response to the secondary system 21200 receiving the output 21104 of the primary system 21100 (as the input 21202 to the secondary system 21200), the secondary system 21200, at 21412, is configured to evaluate the output 21204. That is, the secondary system 21200 may evaluate the directed action request included in the output 21104 of the primary system 21100. For instance, as shown in FIG. 92A, a CSS2 evaluates the output 21104 from the primary system 21100. In some implementations, the evaluation of the directed action request by the secondary system 21200 includes an evaluation of resource requirements and/or resource options that are available to perform the directed action request.

Similar to functionality of the primary system 21100, the CSS2 of the secondary system 21100 includes a second configured intelligence service CIS2. In some examples, after evaluating the directed request included in the output 21104 from the primary system 21100, the CSS2 generates an intelligence request based on, or derived from, that directed request. For example, FIG. 92A, at 21414, depicts the second configured intelligence service CIS2 performing CSS2-directed analysis to represent the execution of the intelligence request based on the directed request.

In some configurations, to generate the intelligence request, the CSS2 generates configuration data. In some examples, the configuration data provided by the CSSs2 configures all or some portion of the artificial intelligence service or the intelligence system controller (e.g., the analysis modules, the analysis management module, or the governance library) for an intelligence services system (e.g., shown in FIG. 76). Here, by configuring the intelligence services system with the provided configuration data, the intelligence services system may be considered a “configured intelligence service.” When generating the configuration data for the intelligence request, the CSS2 may leverage information that it receives from the directed request in order to perform intelligent processing for the CSS1.

Much like step 21408 for the primary system 21100, the secondary system 21200, at 21416, is configured to determine whether the intelligent processing at 21414 has provided adequate intelligence in response to the intelligence request (i.e., has successfully fulfilled the intelligence request). In some implementations, to evaluate whether the intelligent processing is complete, the CSS2 determines whether the output or decision generated by the second configured intelligence system CIS2 satisfies a threshold (e.g., the decision-making threshold). For instance, the output or decision from the second configured intelligence service CIS2 may be bound by constraints. Here, these constraints may individually or collectively correspond to the decision-making threshold. In some examples, these constraints correspond to the set of inputs 21202 to the secondary system 22100.

In some configurations, the CSS2 determines whether the intelligent processing has provided adequate intelligence for the intelligence request in response to an output from the second configured intelligence service CIS2. In other configurations, there may be an event which triggers an evaluation of whether the intelligent processing has provided adequate intelligence in response to the intelligence request. For instance, the event may be a time-based event such as an expiration of a set duration after receiving the request or an expiration of a time period based on a set frequency for evaluating the intelligent processing.

As shown in FIG. 92A, in response to the intelligent processing failing to provide sufficient intelligence for the intelligence request or being incomplete at the time of evaluation, the CSS2 may iteratively repeat the intelligent processing at 21418 and 21414 in furtherance of the intelligence request. When another iteration occurs, that iteration of intelligent processing may also include supporting functionality at 21418 from one or more of the other system services (e.g., shown as CSSs3, CSS4, CSS (n)). In some examples, an iteration may require less (or more) system services than a prior iteration. In this respect, each iteration may include an operation that identifies which, if any, of the supporting system services are demanded for the present iteration. Moreover, each iteration may demand a different configuration for the supporting system service(s). When a different configuration is requested, the CSS2 can generate configuration data prior to the provision of services by the supporting system services during the present iteration. That is, although the configuration system services CSS of the secondary system 21200 may be designed for the requested functionality of the secondary system 21200, this configuration may vary to some extent during sequential intelligent processing (e.g., within some expected variance).

In response to a determination at 21416 that the intelligent processing of the second configured intelligence service CIS2 has provided adequate intelligence in response to the intelligence request, the CSS2 is configured to determine at 21420 whether an action is available to fulfill the directed action request from the primary system 21100. When there is an action available to fulfill the directed action request at 21420, the CSS2 proceeds to 21424. On the other hand, if an action is not available at 21420 to fulfill the directed action request, the CSS2 may perform directed action process configuration and/or directed action resource analysis assistance using one or more additional system services at 21422 (e.g., shown as CSS5, CSS6, and CSS (n)). Here, these additional system services may be another SOS or an external service.

At 21420, when the CSS2 determines that there is an action available to fulfill the directed request, the process proceeds to 21424. Here, at 21424, the CSS2 initiates and/or executes a process determined by or based on the available action and/or the intelligent processing response from the second configured intelligence service CIS2.

Optionally, as shown at 21426 and 21428, the process that is to be initiated or executed can undergo an optimization operation. For example, at 21428, the second configured intelligence system CIS2 determines whether the directed action process is an optimized process. In some implementations, to determine whether the directed action process is an optimized process, the CSS2 determines whether the process satisfies a set of optimization constraints. In other implementations, the CSS2, at 21428, determines whether the process satisfies a designed objective function. In some instances, the objective function is based on the primary task (e.g., in combination with any external controls included in the primary system input 21102). In other instances, the objective function is based on the secondary task specified by the directed action request from the secondary system input 21202.

At 21430, the CSS2 reports a response to the directed action request as an output 21204 of the secondary system 21200. For example, the output 21204 is an action plan for the primary task. Additionally and/or alternatively, the output 21204 of the secondary system 21200 being reported to the primary system 21100 is that some set of actions were executed at the secondary system 21200 to support the primary task as directed by the direct action request from the primary system 21100. When reporting the execution of some set of actions, the output 21204 of the secondary system 21200 may include data or information related to the execution of the set of actions. In some configurations, the data or information is monitoring data that characterizes the performance of the set of actions implemented by the secondary system 21200 at some snapshot in time or over a certain period of time.

Although FIG. 92A illustrates operational details about the inputs and outputs of a single primary system 21100 and a single secondary system 21200 (e.g., as shown in FIG. 90A), there may be any number of secondary systems 21200 managed by either the primary system 21100 or a particular secondary system 21200. When a set of additional secondary systems 21200 are managed by the secondary system 21200, these additional secondary systems 21200 may be referred to as secondary subsystems. When there are multiple secondary systems 21200 for a control architecture 21000 (e.g., as shown in FIG. 90B), each secondary system 21200 may follow a similar set of operations (e.g., operations referenced by 21412-21430) in support of the primary task for the primary system 21100.

### Mini Control Tower for Value Chain Network Entities

A mini control tower is typically connected to a larger control tower (e.g., a larger secondary computing device, a primary computing device, etc.), which is responsible for managing the overall performance of the VCN. As will be discussed below, the larger control tower integrates data from all of the mini control towers and other sources to provide a comprehensive view of the VCN. This enables the larger control tower to identify trends, predict potential issues, and optimize the performance of the entire supply chain network. In some implementations, the mini control tower(s) and the larger control tower may be connected through a communication network that enables real-time data exchange and collaboration. The mini control tower may provide detailed information on specific areas of the supply chain network, while the larger control tower provides a more holistic view of the entire network. This integration enables the control towers to work together to optimize the performance of the supply chain network and ensure that it operates efficiently and effectively.

Referring to the example implementation of FIG. 90C, in some implementations, a control architecture 21000′ generally includes a primary system 21100′ (e.g., a PAO system) and one or more sub-level computing devices 21200′. Each of the primary system 21100′ and the sub-level computing devices 21200′ may function in the control architecture 21000′ as a system of systems (SOS). Here, a “system of systems” refers to a structure that provides cooperative coordination among a set of systems (e.g., already deployed/available systems such as autonomous-oriented systems) that are configurable for the execution of one or more services/tasks. The terminology of “system” of systems therefore indicates that a particular system (e.g., primary or secondary system) is the liaison system for a set of underlying systems. For instance, an SOS is deployed for a particular management or facilitation goal (e.g., to achieve a particular target metric or quantifiable measure of value). This type of SOS structure allows a first SOS to communicate with a second SOS without the need to interface with the set of systems for which an SOS is responsible for.

By having a first SOS communicate with a second SOS without the need to interface with the set of systems for which the second SOS is responsible, the control architecture 21000′ may be able to minimize compatibility issues between all of the systems demanded for execution a primary task (e.g., autonomous execution). For example, if the underling systems are combinations of different hardware and/or programmable software, being able to have a uniform communication language or protocol to have the systems communicate with each can be incredibly difficult. With the control architecture 21000′, systems may be setup in a set or a grouping that is configured by a particular SOS that is capable of communicating with members of the set. In this respect, the SOS of the group/set only needs communication tools for its set of systems and for outside communication with one or more SOSs. For instance, the sub-level computing device 21200′ may include communication tools to configure its underlying set of systems and communication tools to interface with the primary system 21100′. The control architecture 21000′ therefore can be quite elastic and permit scalability for communication between multiple SOSs without any individual SOS being responsible for all or a substantial portion of communication tools for all systems utilized within a particular implementation (i.e., instance) of the control architecture 21000′ as well as control architecture 21000 of FIGS. 90A and 90B.

For instance, in some implementations, a VCN process, such as VCN process 10, may configure 17800 a set of sub-level computing devices (e.g., sub-level computing devices 21200′) for communication with a primary computing device (e.g., primary system 2100′), wherein the primary computing device may manage the set of sub-level computing devices to orchestrate performance of a set of value chain network entities. For instance, in the example implementation depicted in FIG. 90C, the primary system 21100′ is deployed as a control tower SOS. When a system is arranged as a control tower SOS, the system is typically deployed as a manager or primary facilitator among a set of sub-level computing devices 21200′ (e.g., as shown in FIG. 90D). As a manager (or other similar user), the overarching goal of the control tower may be to propagate a strategy (e.g., optimize a set of sub-level computing devices 21200′ for a particular primary task or primary service), to provide oversight to a system arrangement (e.g., system monitoring), and/or to control a set of systems (e.g., tune input parameters to sub-level computing devices 21200′ to produce a target result).

In some implementations, VCN process 10 may receive 17802 (e.g., via at least one member of the set of sub-level computing devices) a set of primary commands from the primary computing device, wherein each of the set of commands may be at least one of a task or a request associated with the value chain network. For instance, and referring at least to the example implementation of FIG. 92B, the primary system 21100′ receives a set of inputs 21102′. Here, some examples of these inputs 21102′ include external data (e.g., similar to external data 21050′), external controls imposed on the system, and/or operational feedback. As a control tower or primary system 21100′, upon receipt of the inputs 21102′ at 21402, the primary system 21100′ (e.g., using a CSS1) identifies that the inputs 21102′ correspond to a particular request to perform a primary task. As part of the performance of the primary task, the primary system 21100′ may be configured to perform managerial functions. These managerial functions may include: determining a strategy to perform the requested task; providing oversight for execution of the requested task; and/or controlling actions that execute the requested task.

As shown in FIG. 90C, the sub-level computing device 21200′ is also capable of generating a system output 21204′ that may be communicated to the primary system 21100′. The primary system 21100′ may receive or otherwise obtain the system output 21204′ at various times during an instance of the sub-level computing device 21200′. In other words, the generation of a system output 21204′ may occur during initialization of the sub-level computing device 21200′, during simulation of the sub-level computing device 21200′, during operation/implementation of the sub-level computing device 21200′, or during some wind-down or final phase of the sub-level computing device 21200′ (e.g., in response to the sub-level computing device 21200′ completing a task/service).

In some examples, the system output 21204′ functions as a feedback loop. For instance, as a feedback loop, the system output 21204′ may inform the intelligence of the CSS. Here, by informing the intelligence of the CSS, the primary system 21100′ via its CSS may further tune or fine tune the parameters that are generated and provided to the sub-level computing device 21200′ as system inputs 21202′. In other words, in some circumstances, systems inputs 21202′ may be provided to the sub-level computing device 21200′ on an ongoing basis (e.g., for ongoing product production). In these circumstances, the system outputs 21204′ of the sub-level computing device 21200′ may impact the next round or iteration of system inputs 21202′ provided to the sub-level computing device 21200′. In other words, the system outputs 21204′ are capable of updating and/or modifying the system inputs 21202′ due to the intelligent functionality of the CSS of the primary system 21100′.

Referring further to FIG. 90C, the sub-level computing device 21200′ is a value chain SOS. In other words, the configuration promoted by the sub-level computing device 21200′ is generally optimized for a particular value metric or target metric. The focus and/or dependence on this value metric is therefore generally carried through or applied to the CSS of the sub-level computing device 21200′. For instance, the target metric is profit and therefore the sub-level computing device 21200′ performs its functionality with profit as a primary optimization variable when configuring its associated systems.

As shown in FIG. 90C, in some examples, the CSS configures the set of systems associated with the sub-level computing device 21200′. Here, the set of systems that is configurable by the CSS2 is illustrated by n number of additional CSSs(1-n). In other words, a sub-level computing device 21200′ may be responsible for performing some group of subtask(s) or service(s) to execute a primary task/service. Each subtask/service within that group may be associated with one or more systems (e.g., SOA systems). Stated differently, the one or more systems are capable of enabling and/or performing a subtask/service when configured. Meaning that, systems, such as SAO systems, are capable of performing functions that result in the execution of a range of tasks or services. These functions may be parameterized (e.g., according to a configuration) to tune the system to perform a particular task/service within the range or a specialized version of a task/service. In this respect, the CSSs of the sub-level computing device 21200′ therefore may enable or configure the set of systems that perform the corresponding subtask(s)/service(s).

As a simple example, the CSSs2 of the sub-level computing device 21200′ includes three systems and a CSS (e.g., CSS3-CSS5) that corresponds to each system (though a one-to-one relationship is described, other relationships are possible). In this example, the CSS2 of the sub-level computing device 21200′ would have to configure three CSSs to provide the services/tasks associated with the sub-level computing device 21200′. To illustrate, if the primary task was production of a product, the sub-level computing device 21200′ may be responsible for a subtask/service of the production—e.g., logistics. Here, although the sub-level computing device 21200′ is responsible for logistics, part of that responsibility may be the management or facilitation of systems associated with three different logistic channels—e.g., trucking logistics, flight logistics, and water vessel logistics. Accordingly, each of those three logistic channels may be configured to have its own CSS such that the sub-level computing device 21200′ provides configuration data for the operations of the three CSSs associated with each of those logistic channels. In this respect, the sub-level computing device 21200′ is able to generate configuration data that ensures that each CSS associated with each of the logistic channels collectively is optimized for the primary task. For instance, instead of each of the CSSs of the logistic channels only seeking their own self-optimization, the optimization is driven from a higher level. Meaning, that, for example, the water vessel logistics on its own may not seem to be optimized specifically for water vessel logistics of the product, but in the scheme of the entire logistics for the product, it is optimized in conjunction with the, e.g., flight logistics and the trucking logistics, so that the target metric is maximized (or minimized) across all of the logistic systems.

In some implementations, the primary system 21100′ is the system that dictates or determines the set of services/tasks performed by each sub-level computing device 21200′. For example, the intelligence associated with the primary system 21100′ determines the number of sub-level computing devices 21200′ that may be required for a particular primary task and/or the available systems that would enable the primary task. For instance, the primary system determines a combination of available systems that would enable the primary task. In this situation, the intelligence of the primary system 21100′ recognizes that individually configured systems working together in some combination can perform some aspect of the primary task.

In some implementations, as noted above, VCN process 10 may assign 17804 at least a portion of one or more computing devices capable of fulfilling the primary command as a set of one or more computing devices to be managed by the set of sub-level computing device, wherein the sub-level computing device is a computing device that manages or executes performance of a particular entity or relationship of the value chain network. For instance, a mini control tower in a VCN (supply or demand) may be a sub-level control tower that focuses on a specific area or aspect of the supply chain. It is typically responsible for monitoring and managing the performance of a particular segment (e.g., entity or relationship between multiple entities) of the supply chain, such as a specific warehouse or distribution center, transportation route, or supplier. For example, primary system 21100′ as a control tower SOS receives a primary task or service request, as discussed above. In response to the receipt of the primary task or service request, the primary system 21100′ determines a set of systems that can fulfill the request from a pool of available system resources (e.g., a pool of autonomous-oriented systems). In some implementations, the determined set of systems are parsed or classified into groups where each group is assigned to a sub-level computing device 21200′. As will be discussed below, each sub-level computing device 21200′ may generate a set of CSSs for the set of systems that are assigned to it. “Mini control towers” may be beneficial to proliferate through the connection of previously siloed operational segments. Disparate solutions of the value chain technology may continue to converge towards the goal of turning these “mini control towers” into enterprise-wide control towers that enable greater automation and visibility throughout a company's supply-chain. Additionally, unlike currently known control towers that are limited to the supply-chain, the control towers (and mini control towers) of the present disclosure are also integrated with the demand side of enterprises. As will be clear after reading the present disclosure, the mini control tower may be considered as the preliminary step before a fully functional control tower (e.g., with a company-wide dashboard as discussed throughout). Generally speaking, the mini control tower may be considered the slot in application partners within the control tower (i.e., the interaction between data aggregation at the control tower).

In some implementations, VCN process 10 (e.g., via the set of sub-level computing device) may configure 17806 the set of one or more computing devices to fulfill one or more secondary commands based upon, at least in part, the primary command. For instance, with the CSSs (discussed further below) scaled to the assigned set of systems, the sub-level computing device 21200′ configures each system of the set using the CSSs so that the set associated with the sub-level computing device 21200′ can collectively perform/enable the primary task with execution of its one or more tasks/services.

In some implementations, as noted above, configuring the set of one or more computing devices to fulfill the one or more secondary commands may include generating 17812 a set of at least one configured system service (CSS). For instance, FIG. 90C depicts a single primary system 21100′ as the control tower SOS and a sub-level computing device 21200′ as a value chain SOS. Each SOS (e.g., the primary system 21100′ or the sub-level computing device 21200′) generally includes at least one configured system service (CSS) and a general system service (GSS). For example, the primary system 21100′ is shown with a first CSS (CSS1) and a first GSS (GSS1) while the sub-level computing device 21200′ is shown with a second CSS (CSS2) and a second GSS (GSS2). In this respect, each CSS and GSS may be tailored or dependent upon the SOS with which it is associated. For example, in some implementations, when the primary system 21100′ as the control tower SOS is setup for oversight, the CSS1 and the GSS1 are configured to provide service(s) for oversight.

It will be appreciated after reading the present disclosure that any individual parts of the present disclosure that use a processor may include some or all of VCN process 10 (and vice versa). For example, VCN process 10 may include some or all of a CSS, a GSS, a primary system, a sub-level computing device, a service, an application, etc. That is, any individual parts of the present disclosure that use a processor may be configured to effectuate some or all of the functionality of VCN process 10 (and vice versa). Accordingly, in some implementations, VCN process 10 may be a purely server-side process, a purely client-side process, or a hybrid server-side/client-side process that is cooperatively executed. Furthermore, it will be appreciated after reading the present disclosure that VCN process 10 may apply equally to the demand side as the supply side. That is, VCN process 10 is described with examples of obtaining information and insights for things affecting the supply of an item; however, VCN process 10 may also be used with examples of obtaining information and insights for things affecting the demand of an item. For example, factors that may affect the demand of an item may include, e.g.: Customer attributes, such as geographic location, historical purchasing habits and preferences, financial capacity, interactions with similar or proximal products, lifetime value; Market trends, such as popularity of particular products or categories of products, activism or social movements (e.g., palm oil is linked to the destruction of biodiversity, deforestation, etc. and demand for products with this ingredient may be suppressed as a result of increasing social awareness of negative impacts), seasonal demand; Competition, such as availability/price/appearance/brand value of competing or substitute products, Economic, such as correlation of item purchases with economic factors such as consumer spending, interest rates, exchange rates, etc.; Governmental/Regulatory, such as trade restrictions, tariffs, regulations related to import/export control or materials/ingredients; Marketing, such as advertising campaign metrics (e.g. website traffic, total page views, bounce rate, engagement rate, cost per click, cost per lead, cost per acquisition, conversion rate, longevity). As such, the description of VCN process 10 being used for the supply side should be taken as example only and not to otherwise limit the scope of the present disclosure.

The GSS functions to provide general system integration and operations such as data storage, data processing, networking, and other shared functionality (e.g., the GSS may have similar functionality to aspects of data processing systems 1612, 10206, 12030, 12130, 12142, 13024 and/or data storage systems 624). In FIGS. 90C and 90D, the GSS is shown with a dashed-lined perimeter to represent that the GSS may be included locally within a deployed instance of an SOS (e.g., a primary system or a sub-level computing device) or operate remotely yet in communication with an SOS. When deployed locally, the GSS may be configured in dedication to its associated SOS. In that respect, aspects of the GSS may be optimized, programmed, or configured to the instance of the SOS. When functioning remotely, the GSS may operate as a global GSS that one or more systems (e.g., a primary system 21100′ and/or a sub-level computing device(s) 21200′) can access/utilize. Here, this type of global configuration may be advantageous, depending on the deployment of the control architecture 21000′, because data storage and data processing functionality is shared among systems. Meaning that, data format compatibility or other data compliance related aspects are potentially addressed on the front-end (e.g., designed for compatibility).

In some implementations, generating the set of at least one CSS may include utilizing 17814 an output of a plurality of sources as an input to generate one or more control parameters. For instance, the mini control tower(s) may collect data from various sources, including sensors, enterprise resource planning (ERP) systems, warehouse management systems (WMS), transportation management systems (TMS), local media, national media, social media, etc. and other sources. The data is analyzed to identify potential issues or bottlenecks in the supply chain and to determine the best course of action to resolve these issues. The CSS for an SOS functions to configure the set of systems corresponding to the SOS to perform a set of tasks or services based on intelligence determined by the CSS. The intelligence performed for the CSSs is generally determined by a configured intelligence system CIS that is a part of (e.g., as shown in FIG. 92B) or associated with the CSSs. More particularly, the configured intelligence service CIS used by the CSS has the intelligence capabilities of or that are similar to the intelligence services system 8800 except that the configured intelligence system CIS is an intelligence services system that is configured, for example, by the CSS to provide intelligence for a particular set of system services. In this respect, the CSSs may act akin to the intelligence service client 8836 in its relationship with the configured intelligence system CIS. For instance, if the primary task of primary system 21100′ is to control the production of a product, the intelligence of the CSS identifies system resources that (e.g., a set of systems) are available (e.g., within the enterprise ecosystem) to control production of the product and configures these control-based resources to generate control parameters that downstream production resources demand to produce the product. To extend this example to FIG. 90C, the primary system 21100′ generates an output that is provided to the sub-level computing device 22000′ as a system input 21202′. If the CSS1 generates control parameters, these control parameters may be fed as output of the primary system 21100′ to the sub-level computing device 21200′ as system inputs 21202′. The sub-level computing device 21200′ may then utilize the system inputs 21202′ to configure its own CSS (e.g., the CSS2).

In some implementations, VCN process 10 may (e.g., via the set of sub-level computing device) fulfill 17808 the primary command based upon, at least in part, the set of one or more computing devices fulfilling the one or more secondary commands. For instance, FIG. 90D is similar to FIG. 90C except that FIG. 90D shows multiple sub-level computing devices 21200′a-n being managed by the primary system 21100′. That is, multiple SOS instances may be coordinated via a single control tower SOS instance. The number of sub-level computing devices 21200′ associated with a control tower SOS or primary system 21100′ may depend on several variables. Some of these variables may include, e.g., the selected set of systems to fulfill a service/task request, the type of systems selected, the configurable parameters of the selected systems, the communication capabilities of the selected systems, the manner in which the systems may be combined or cooperate, and the structure or characteristics of the enterprise deploying the control architecture 21000′.

In some configurations, the set of systems selected to fulfill a service/task request (e.g., a request for a primary task) includes one or more third-party systems that the enterprise can access or utilize. For instance, for autonomous generation of a product, the primary system 21100′ may inquire about demand for the product using a customer relations management (CRM) system managed by a third party. Here, the primary system 21100′ or a sub-level computing device 21200′ may provide the CRM system with data that characterizes the product to be generated in order to query the CRM system to determine an estimated demand forecast from customers who have an interest in the type of product that has been characterized. In some implementations, the CRM system returns an output (e.g., a forecasted demand) based on the input data that is then configured to inform or be communication to one or more other systems. Therefore, when third-party systems are integrated in the configured systems workflow of the control architecture 21000′, the SOS can determine acceptable inputs to these third-party systems and expected/anticipated outputs so that outputs can be pipeline data to the appropriate CSS.

In some implementations, VCN process 10 may send 17810 a generated system output to the primary computing device responding to the primary command based upon, at least in part, the set of one or more computing devices fulfilling the one or more secondary commands. For instance, and to expand on the previous example using FIG. 90D for example purposes only, when the set of systems that fulfill the request are parsed or classified into n groups, the primary system 21100′ assigns the first group to the first sub-level computing device 21200′a, the second group to the second sub-level computing device 21200′b, and the nth group to the nth sub-level computing device 21200′n. Here, outputs from the primary system 21100′ may be provided to any or all of the sub-level computing devices 21200′a-n to form the system inputs 21200′a-n for the sub-level computing devices 21200′. Much like the single sub-level computing device example of FIG. 90C, each sub-level computing device 21200′ is capable of generating system outputs 21204′a-n that are communicated to or obtained by the primary system 21100′. In some implementations, each of these sub-level computing devices 21200′, as SOS instances, may include CSSs and/or GSSs. Therefore, each sub-level computing device 21200′ generates a set of CSSs for the set of systems that are assigned to it.

In some implementations, an SOS has the capabilities to interface with entities or resources that are external to the SOS. For instance, FIGS. 90C and 90D illustrate the primary system 21100′ as the control tower receiving external data inputs/outputs (I/O) 21050′. Some examples of external data I/Os 21050′ include asset indicators (e.g., asset statuses, asset locations, asset time of life, etc.), market data (e.g., for markets impacted/associated with an enterprise asset), weather data, sensor data (e.g., from robotic fleet management, IoT, digital twin, environmental container conditions such as temperature, humidity or light intensity, etc.), enterprise resource planning (ERP) data, network data (e.g., connectivity data), event data (e.g., holidays, event logs, cycle time, running time, etc.), local media, social media, etc. In some examples, the external data I/O 21050′ is provided by another control tower SOS. Additionally and/or alternatively, the external data I/O 21050′ may be generated by a third-party system that is or is not included in the control architecture 21000′ such as a software as a service (SaaS) provider to the enterprise.

In some implementations, the primary computing device (e.g., via VCN process 10) may be bypassed 17824 to receive external data at the sub-level computing device when the external data is unused by the primary computing device. For example, the control architecture 21000′ is not limited to only the primary system 21100′ receiving the external data 21050′. In some configurations, it may be more efficient from a data management or data flow approach to feed external data 21050′ directly to a sub-level computing device 21200′ or to a component of a sub-level computing device 21200′ (e.g., a CSS). For instance, a system of the sub-level computing device 21200′ rather than a system of the primary system 21100′ is the system that consumes the external data 21050′. In some instances, if the external data 21050′ is not utilized by the primary system 21100′ (e.g., the CSS), then having the primary system 21100′ ingest, store, and/or relay the external data 21050′ to a sub-level computing device 21200′ that consumes the external data 21050′ may become burdensome or computationally expensive.

Referring to the example implementations of FIGS. 91C and 91D, the control architecture 21000′ may be adapted to cater to a specific organization of an enterprise. In other words, the SOS structure that includes the CSS may be deployed to provide system management at any business unit level. To illustrate, FIG. 91C depicts a management stack 21300′ (also referred to as stack 21300′) that includes a control layer 21310′, an operational layer 21320′, an activity layer 21330′, and a service layer 21340′. Although the management stack 21300′ is depicted as a 4-layer management stack 21300′, the principles of a primary SOS system and a secondary SOS system may be applied to more or less layers (e.g., a 3-layer stack, a 5-layer stack, or a 10-layer stack). As shown in FIG. 91D, one reason for the 4-layer management stack 21300′ is that it may track an enterprise's value chain workflow. For instance, in FIG. 91D, an enterprise may have a plurality of enterprise value chain networks that correspond to the operational groups/teams of the enterprise. FIG. 91C has four different operational groups-marketing and sales, logistics, service, and operations. Each operational group may be capable or expected to perform one or more activities for the enterprise. And moreover, each activity may use a set of services to perform the respective activity. In this sense, the service layer 21340′ of the management stack 21300′ corresponds to the set of services 21342′a-n (e.g., data sourcing services, data processing services, intelligence services, analytics services, smart contracts services, distributed ledger services, governance services, security services, risk management services, etc.) that perform an activity 21332′. The activity layer 21330′ corresponds to the activity 21332′ performed by an operational group of the enterprise and the operational layer 21320′ corresponds to the particular operational team performing the activity 21332′ with the set of services 21342′.

In some implementations, a distributed ledger service may increase traceability of material supply chain to ensure corporate standards are met, as well as lower losses from counterfeit/gray market trading. A distributed ledger service may also improve visibility and compliance over outsourced contract manufacturing, as well as reduce paperwork and administrative costs, strengthen corporate reputation through providing transparency of materials used in products, improve credibility and public trust of data shared, reduce potential public relations risk from supply chain malpractice, and engage stakeholders.

In some implementations, a governance service may be used for access of a system in a VCN setting, including a set of policies, procedures, and controls that are implemented to ensure secure access to the system. The governance service may be responsible for managing and controlling access to the system by employees, suppliers, and other stakeholders in the supply chain network. The governance service may define the rules and requirements for accessing the system, including the authentication and authorization processes. This may involve establishing user roles and permissions, defining access levels, and implementing controls to ensure that only authorized individuals can access the system. The governance service may also be responsible for monitoring and auditing system access to detect and prevent unauthorized access or misuse of the system. This may involve regular review of user access logs and other system activity to identify potential security breaches or policy violations. Additionally, the governance service may be responsible for enforcing compliance with regulatory requirements and industry standards for data privacy and security. This may involve establishing and maintaining security protocols and procedures to protect sensitive data and information from unauthorized access or disclosure. In some implementations, innovations such as haptics, biometrics, and AI may be applied to enhance the security and functionality of the governance service. For instance, haptics may be used to provide a multi-factor authentication process that includes physical verification such as fingerprints or facial recognition, in addition to traditional login credentials such as username and password. Biometrics may also be used to enable continuous authentication, which may involve monitoring user behavior and biometric data to detect and prevent unauthorized access or suspicious activity. AI may be used to analyze access logs and other system activity data to identify potential security threats or policy violations in real-time. This may include identifying patterns of access that are outside of normal behavior or detecting unusual activity that could indicate a security breach. A scoring system may be used to assess the performance or behavior of individuals or organizations within the governance system. This may be used to identify areas for improvement or to provide incentives for good behavior. A Know Your Business (KYB) system may be used to verify the identity and legitimacy of businesses that are operating within the governance system. This may help prevent fraud, money laundering, or other illegal activities. A KYC system may be used to verify the identity of individuals who are participating in the governance system. This may help prevent fraud, identity theft, or other illegal activities. In some implementations, integrated blockchain technology may be used as a distributed ledger to record and verify transactions or interactions within the governance system. For example, a blockchain-based voting system may be used to ensure the integrity of elections or decision-making processes within the governance system. Another way to use blockchain is to create smart contracts that automatically execute certain actions or decisions within the governance system based on predefined rules. This can help reduce the risk of human error or fraud. Blockchain may also be used to create decentralized autonomous organizations (DAOs), which are organizations that operate based on rules encoded in smart contracts on a blockchain. DAOs may be used to create more democratic and decentralized governance structures, where decisions are made through transparent and decentralized voting processes.

As mentioned previously, the organizational structure of an enterprise, and especially a large enterprise, means that it is likely that multiple value chains may need to be managed or controlled to perform the objective, goal, or purpose of the enterprise. With this being the case, the control architecture 21000′ may enable a primary system 21100′ or control tower SOS to control multiple value chains from a central management position. For example, FIG. 91C depicts a single control tower SOS on the control layer 21310′ as the overall management hub for the management stack 21300′. The primary system 21100′ may then manage one or more supporting operations 21322′ (e.g., sub-level computing devices 21200′ that are operation specific) on the operational layer 21320′. For instance, a first value chain may follow the first path p1 while a second value chain may follow the second path p2. For either value chain, the operational layer 21320′ includes a set of supporting operations 21322′. In terms of this example, a value chain network refers to a value chain that flows through a particular operational entity. That is, each operational entity or supporting operation has its own network of activities 21332′ and services 21342′ that enable the operational entity to properly function for the enterprise. For example, each supporting operation 21322′ is shown to perform one or more activities 21332′a-n on the activity layer 21330′ with each activity 21332′ supported by a set of services 21342′a-n associated with the service layer 21340′.

Referring specifically to the stack 21300′ of FIG. 91C, the first path p1 flows through a first supporting operation 21322′a. The first supporting operation 21322′a includes n number of activities 21332′a-n. Each activity 21332′ is supported by a set of services 21342′. For comparison, the second path p2 may flow through another supporting operation 21322′ (e.g., a second supporting operation 21322′b) of a set of supporting operations 21322′a-n and then have a similar network structure with a corresponding set of activities 21332′ performed/enabled by an underlying set of services 21342′. In this respect, the stack 21300′ is able to accommodate any number of supporting operations indicating that any number of value chains/value chain networks may be deployed with a single instance of a control tower SOS.

In some implementations, generating the set of at least one CSS may include generating 17826 at least one CSS for each interface layer in a management stack (e.g., management stack 21300′). For instance, in some configurations, as shown in FIG. 91C, the functionality of each layer may be orchestrated by one or more SOS units. Meaning that, each layer may have one or more CSS that is capable of configuring the systems to provide the services demanded at each layer. In other words, each layer may have at least one local CSS to ensure the functionality of the layer can occur in an autonomous-oriented manner (e.g., autonomously or semi-autonomously). Each layer may be arranged to manage or control its proximate lower level. In this arrangement, the CSS for a particular layer functions to provision configurations (e.g., inputs, starter materials, connect data pipelines, etc.) that allow a lower level to function. For instance, the operational CSS associated with the operational layer 21320′ configures systems that enable the set of activities 21332′ to operate. Similarly, the CSSs of the activity layer 21330′ configures systems that enable the set of services 21342′ to function. At the lowest level, shown as the service layer 21340′, the CSSs associated with this layer 21340′ enable the execution of the set of services 21342′.

In some implementations, each layer in the management stack 21300′ is capable of communicating with another layer using an interface layer 21350′. The interface layer 21350′ may include communication tools or protocols that enable one SOS to communicate with another SOS potentially anywhere in the stack 21300′. The interface layer 21350′ may also function to limit which layers (or SOSs) can communicate with which other layers (or other SOSs). That is, an architect of the stack 21300′ may prefer for some communication tools to be limited to higher level control or vice versa (e.g., limited to service layer communication). In this respect, the interface layer 21350′ can apply communication access controls at the layer level.

In some configurations, the interface layer 21350′ includes a range of communication tools that permit one system to communicate with another system. For example, the interface layer 21350′ includes a plurality of application programming interfaces (APIs) that allow software associated with one system or SOS to communicate with software of another SOS. An API is a software tool that generally facilitates communication between two platforms (e.g., between two CSSs or between two SOS systems). APIs are typically designed to standardize the way programmers/developers interact with a platform (e.g., a software application). In other words, prior to APIs, programmers/developers would likely have to customize the manner in which they interact or connect with the services of an application. With APIs, there are typically technical specifications in the form of documentation that is associated with the API that specifies how to integrate with the API. When using an application, a user may initiate a task/service from the application that generates a request. The API associated with the application may then make a call that relays the request to a destination or API endpoint (e.g., a uniform resource locator (URL) of a server). Upon receipt of the request, the API endpoint facilitates the execution of the task (e.g., by a third-party application or database that provides the task/service). From that perspective, APIs can ease the development and user experience by connecting disparate system (e.g., disparate software applications). In other words, by using an API, the entity configuring a system or application to perform a service can integrate the functionality of other systems without having to design those systems' functionality in-system. Some examples of APIs that the interface layer 21350′ may include are Web APIs used to access web browsers or web-based devices, Simple Object Access Protocol (SOAP) APIs that use extensible markup language (XML) and XML schema to perform calls and structure payloads, Open APIs (also known as public APIs), Representative State Transfer (REST) APIs that use stateless communication protocols, JavaScript Objection Notation (JSON)-Remote Programming Calls (RPC) for asynchronous server calls, and other custom APIs. By making an array of APIs accessible to portions of the stack 21300′, the interface layer 21350′ helps ensure that the language of one system is capable of being translated to a language of another system. Otherwise, the set of systems deployed in a given instance of the management stack 21300′ may have communication compatibility issues or suffer from the inability to cooperatively integrate cross-functionality.

The interface layer 21350′ is also configured to use other communication tools such as a user interface (UI) (e.g., graphical user interfaces (GUI)) and software development kits (SDKs). Here, a GUI may correspond to the interface of an API or refer to another interface designed to curate a user experience and interaction with one or more systems. For instance, a system has a GUI that can receive configuration data from CSSs (e.g., to populate data entry fields provided by the GUI to receive a set of inputs). The GUI generally contains graphical elements with underlying functionality. These graphical elements may enable navigation and/or trigger execution of functions of the system associated with the GUI. It will be appreciated that other types of UIs may be included (e.g., audio-based UIs, gesture-based UIs, digital twin interface (as discussed throughout), smart wallet interface (as discussed throughout), etc.) without departing from the scope of the present disclosure.

An SDK or devkit may refer to the set of building tools (e.g., software building tools) for a specific platform (e.g., system). Often, the tools of an SDK may include resources such as a compiler that translates from one programming language to another, code samples that provide examples of coding for the platform, code libraries with sets of preconfigured code sequences (e.g., common or frequently used coding functions), testing and analytics tools that generate metrics/analytics to quantify the performance of programming in, for example, testing and production environments, documentation that provides information or instructions to programmers/developers (e.g., instructions about other tools of the SDK), debuggers that are capable of identifying coding errors, and one or more APIs to relay calls to other services and systems. By deploying these tools, a new application may be built (e.g., beginning with an integrated development environment (IDE)) or an existing application may be modified. In some examples, for mobile application development, the SDK may be Apple's IOS SDK or Google's Android SDK. On the other hand, for large-scale applications, such as enterprise Software-as-a-Service (SaaS), proprietary web applications, or desktop software applications, the SDK may be open source .NET SDK.

With a management stack 21300′, each layer of the stack 21300′ may include one or more SOS units. As shown in FIG. 91C, the management stack 21300′ maintains a similar hierarchical arrangement to that of the simple primary and sub-level computing device 21100′, 21200′ of FIG. 90C. That is, the control layer 21310′ that functions to control the value chain includes a control tower SOS as the primary system 21100′.

Referring to FIG. 91D, an example management stack 21300′ is shown for a particular enterprise value chain. In this example, the control layer 21310′ is a primary system 21100′ or enterprise control tower SOS. The operational layer 21320′ includes four potential value chain networks corresponding to the supporting operations of (1) marketing and sales, (2) logistics, (3) service, and (4) operations. As shown by the darkened outline, the particular value chain depicted in FIG. 91D includes operations as the operational layer 21320′. Here, with the operational layer 21320′ corresponding to the operations group of the enterprise, the activity 21332′ for the activity layer 21330′ may be one of several activities 21332′ that operations may perform. For instance, FIG. 91D illustrates a menu or set of activities 21332′ that are associated with the operations group of the enterprise. Of the set of activities 21332′ depicted, the operations group is responsible for performing the activities 21332′ of production processes, infrastructure management, and quality control. In this respect, the primary system 21100′ of the control layer 21310′ may have a value chain dedicated to the management and/or control of each of these activities 21332′ in relation to operations as the supporting operation 21322′ for the enterprise. That is, the first path p1 of FIG. 91D illustrates a first value chain that corresponds to operations performing the activity 21332′ of production processes. The second path p2 illustrates a second value chain that corresponds to operations performing the activity 21332′ of infrastructure management. The third path p3 illustrates a third value chain that corresponds to operations performing the activity 21332′ of quality control.

In some configurations, such as FIG. 91D, each enterprise group at the operational layer 21320′ may have a corresponding set of activities 21332′ that it can perform. For instance, FIG. 91D depicts that the marketing and sales group at the operational layer 21320′ may perform the activities 21332′ of contracts and information services. The logistics group at the operational layer 21320′ may perform the activities 21332′ of demand management, supply chain management, and procurement. The service group at the operational layer 21320′ may perform the activities 21332′ of finance, research and development, and human resource management. In these configurations, each activity flow path p can correspond to a value chain network. In that sense, the enterprise control tower may be simultaneously or sequentially managing upwards of a dozen value chain networks.

FIG. 91D also depicts that the services layer 21340′ of the value chain differs based on the activity 21332′ to be executed by one or more services 21342′. For example, the value chain portrayed as the first path p1 may include a different set of services for the activity 21332′ of production processes than the second path p2 for the activity 21332′ of infrastructure management. Likewise, the third path p3 for the activity 21332′ may have a completely different set of services than both activities 21332′ of production processes and infrastructure management. It will be appreciated that more or less paths may be used.

Referring to FIG. 91D specifically, the service layer 21340′ shows a set of services 21342′ that are executed in some combination to perform the production processes activity 21332′. The set of services may be a unique mix or combination of service building blocks. A building block generally refers to a system that may be configured individually or in combination with another one or more systems to perform task(s)/service(s) that enable a particular activity 21332′ (e.g., autonomously allow the activity 21332′ to occur). In this sense, it can be said each building block or service 21342′ can have a particular configuration to support CSSs for an SOS. In FIG. 91D, the activity 21332′ of production processes may be executed by a set of services 21342′ that includes service building blocks A, J, N, and P. Although not depicted, a similar example would be that the activity 21332′ of infrastructure management may include service building blocks A, G, and O. As supported by these examples, a building block, such as A, may be configured in combination with two different sets of services in order to perform different activities 21332′ (e.g., production processes services v. infrastructure management services). With this being the case, permutations of building blocks can perform a vast array of activities 21332′.

There may be a variety of service building blocks that may be configured to perform activates/actions for the purpose of the primary task. The building blocks that may be implemented by the control architecture 21000′ are not limited to a particular ecosystem, but rather may transcend the ecosystems that they are described in relation to herein to provide a configured function or set of functions for the control architecture 21000′. For instance, each of the applications 614, applications 630, the value chain entities 652, demand management applications 824, 1502, supply chain applications 812, 1500, intelligent product applications 1510, asset management applications 1530, and enterprise resource management applications 1520 from the VCNP 604 may be a building block. Other examples of buildings blocks may include adaptive intelligent systems 614, artificial intelligence systems 1160, 10212 (including hybrid artificial intelligence systems 3060), and/or other systematic services, such as artificial intelligence and computational systems 634, robotic process automation (RPA) systems 1442, protocol adaptors 1110, packet acceleration systems 1410, edge compute management systems 1400, edge intelligence systems 1420, edge networking systems 16100, adaptive networking systems 1430, state and event managers 1450, opportunity miners 1460, artificial intelligence systems 1160, digital twin systems 1700, digital twin simulation systems 2020, machine vision systems 1600, entity interaction systems 1920, real time monitoring systems 1520, visual monitoring systems 1930, point of interaction systems 1530, physical process observations systems 1510, robotic-oriented systems (e.g., robotic motion tracking systems), machine state monitoring systems 1940, IoT systems 1172, user feedback systems 1534, location monitoring systems 1532, behavioral monitoring systems 1538, entity discovery systems 1900, classification systems 1610, data processing systems 1612, signal processing systems 1614, prediction systems 1620, configuration systems 1630, control systems 1640, analytic systems 1650, testing/diagnostic systems 1660, security systems 1670, and quantum computing systems 17000. For additive manufacturing, some examples of building blocks include systems/services for the additive manufacturing platform 10110, such as additive manufacturing units 10102, pre-processing systems 10104, post-processing systems 10106, material handling systems 10108, finishing systems 10121, packaging systems 10122, shipping systems 10124, processing systems 10127, data acquisition systems 10602, design and simulation systems 10116, Product Lifecycle management (PLM) systems 10648, maintenance management systems (MMS) 10650, Quality Management systems (QMS) 10652, certification systems 10654, compliance systems 10656, feedstock formulation systems 10706, risk prediction and management systems 10712, marketing and customer service systems 10716, and AI systems 10212. With respect to liquid lens, some examples of building block include systems/services associated with dynamic visions systems 11200. For robotic fleet management, examples of building blocks include systems/services relating to the fleet management platform 12000, such as fleet operations systems 12002, robot operating units 12040, robot control systems 12150, robot security systems 12170, robotic process automation (RPA) systems 12216, vision and sensing systems 12112, and motion planning systems 12158. For smart containers, examples of building blocks include systems/services relating to the smart intermodal shipping container system 1300, such as smart containers 13026, smart container operating units 13040, logistics systems 13016, maintenance management systems 13028, smart container task assemblies 13050, security systems 13046, communication management systems 13010, remote-control systems 13012, human interface systems 13038, fleet management systems 13002, fleet configuration systems 13020, quantum computing services 13008, and smart container digital twins (e.g., smart container fleet manager digital twin 13328). For digital product networks, examples of building blocks include systems/services relating to the digital product network 14000, such as digital product network services 14002, connected products 14010, digital products 14210, demand aggregation systems 14250, supply chain management systems 14252, new product development systems 14254, customer relationship management systems 14256, PLM systems 14258, digital twin systems 14260, synchronized planning systems 14262, intelligent procurement systems 14264, dynamic fulfillment systems 14266, and digital product network systems 14508. For smart contracts, examples of building blocks include systems/services relating to the smart futures contract system 15000, such as futures systems 15006, smart contract services 15020, demand aggregation services 15022, digital wallets 15024, risk determination services 15026, and RPA services 15028. For biology-based systems, examples of building blocks include systems/services relating to the thalamus service 18001, such as control systems 18002, intake data management systems 18028, and intake controllers 18008. For energy systems, examples of building blocks include systems/services relating to the energy system 19000. For dual process artificial neural networks, examples of building blocks include systems/services relating to the dual process artificial neural network (DPANN) system 20000. Although these systems are specifically enumerated as potential building blocks, this list is non-exhaustive and may include other applications, systems, and/or services described herein or others not specifically described, but of a similar nature to systems/services of this disclosure. As explained previously, one or more of these building blocks may be particularly configured as well as mixed and matched in various combinations to form a set of building blocks capable of performing a target task, activity, or action.

In some implementations, there may be multiple sets of service building blocks that are capable of performing a given activity 21332′, especially in a configuration that may be dictated by CSSs. When this is the case, an SOS, such as a primary system 21100′, can (as noted above) identify the candidate sets of service building blocks that are capable of performing an activity 21332′ and determine an optimal set from the candidate sets. In some examples, the optimal set of service building blocks is determined by an optimization algorithm that weighs one or more different importance factors. Some examples of importance factors include consumption of computing resources, duty cycle, response time, estimated time to complete the activity 21332′, amount of computing resources consumed by internal resources in relation to third-party resource consumption, training or initiation time, quality metrics, inventory metrics/thresholds, human resource expenditure, overhead, cost, raw material consumption, operational capacity, and resource utilization.

Although FIG. 91D illustrates twenty-four service building blocks, there may be a greater or a fewer number of service building blocks depending on the services available to an enterprise. In some examples, the number of service building blocks is contingent upon the number of services that systems of the enterprise are capable of performing. Meaning that, an enterprise with five systems capable of performing seven service(s)/task(s) may have seven service building blocks such that the enterprise can deploy a configured instance of some set/subset of the seven service blocks. With this type of structure, a management stack 21300′ can focus on optimizing a configuration for a combination of services rather than trying to optimize or configure each service individually.

FIG. 165B illustrates an example of the functionality of the control architecture 21000′. Here, the control architecture 21000′ includes a primary system 21100′ labeled as an autonomous enterprise control tower SOS1 and a sub-level computing device 21200′ labeled as an autonomous enterprise SOS2. As previously mentioned, here, the highest-level SOS is the primary system 21100′ while the lower level SOS is the sub-level computing device 21200′. With nested or grouped systems, the functionality or characteristics of one particular system (e.g., the primary system 21100′) may be unique or differentiable with respect to another system (e.g., the sub-level computing device 21200′) due to the types of inputs and/or outputs associated with each system. In other words, a first set of inputs to a system can influence an arrangement of services (e.g., intelligence services) to form a unique configuration of those services for the system.

In some implementations, configuring the set of one or more computing devices to fulfill the one or more secondary commands may include providing 17816 intelligence received from the at least one CSS to the set of one or more computing devices. For instance, in some examples, such as FIG. 92B, the CSS1 of the primary system 21100′ includes a first configured intelligence service CIS1 that, at 21404′, receives a directed request to perform intelligent processing for the CSS1. Here, this request may be referred to as an “intelligence request” from the CSS. Intelligent processing may refer to using, at the configured intelligence service (CIS), intelligence capabilities of or similar to the intelligence services system 8800. In some examples, the arrangement of the configured intelligence service CIS is identical to that of the intelligence services system 8800 (e.g., shown in FIG. 78) except that it has an intelligence configuration (e.g., configured by its associated CSSs) that has been adapted to support a particular system service or set of system services. In the case of a control tower or primary system 21100′, this intelligent processing at 21404′ may perform analysis of one or more of the managerial functions. In some implementations, intelligent decision-making regarding strategy for the primary command may be performed 17828 based upon, at least in part, the CIS. For instance, when the primary system 21100′ is determining a strategy to perform the requested task (i.e., the primary task), the intelligence service is capable of performing intelligent decision-making regarding strategy for the requested task. This decision making may include decomposing the primary task into a set of subtasks, determining sub-level computing devices 21200′ that may be capable of performing the primary task, evaluating the availability of one or more sub-level computing devices 21200′, predicting an efficient use of resources to perform the primary task, and/or allocating system resources to the primary task or some portion of the primary task.

In some implementations, the first configured intelligence service CIS1 is supported by other system services. That is, at 21406′, one or more other system services may be configured to perform supporting analytics for the intelligence services of the first configured intelligence service CIS1. For example, FIG. 92B illustrates n number of CSSs CSS1-1 . . . . CSS1-n to represent the other system services that have been configured to support the first configured intelligence service CIS. As an example, when the first configured intelligence service CIS1 is evaluating the availability of sub-level computing devices 21200′, a set of supporting system services may be configured to query various systems to determine system capabilities or resource utilization. In this sense, the CSSs CSS1-n have been configured for resource management and resource reporting.

In response to performing intelligent processing, the CSS1, at 21408′, determines whether the processing has provided adequate intelligence in response to the intelligence request (i.e., has successfully fulfilled the intelligence request). In some implementations, to evaluate whether the intelligent processing is complete, the CSS determines whether the output or decision generated by the configured intelligence system CIS satisfies a threshold (e.g., a decision-making threshold). For instance, the output or decision from the configured intelligence service CIS may be bound by constraints. Here, these constraints may individually or collectively correspond to the decision-making threshold. In some examples, these constraints correspond to the set of inputs 21102′ to the primary system 21100′. For instance, the constraints are derived from or related to one or more external controls provided to the primary system 21100′ as an input 21102′.

In some configurations, the CSS1 determines whether the intelligent processing has provided adequate intelligence for the intelligence request in response to an output from the configured intelligence service CIS. In other configurations, there may be an event which triggers an evaluation of whether the intelligent processing has provided adequate intelligence in response to the intelligence request. For instance, the event may be a time-based event such as an expiration of a set duration after receiving the request or an expiration of a time period based on a set frequency for evaluating the intelligent processing.

As shown in FIG. 92B, in response to the intelligent processing failing to provide sufficient intelligence for the intelligence request or being incomplete at the time of evaluation, the CSS1 may iteratively repeat the intelligent processing at 21404′ and 21406′ in furtherance of the intelligence request. When another iteration occurs, that iteration of intelligent processing may also include another iteration of support from one or more of the other system services (e.g., shown as CSSs CSS1-n). In some examples, an iteration may require less (or more) system services than a prior iteration. In this respect, each iteration may include an operation that identifies which, if any, of the supporting system services are demanded for the present iteration. Moreover, each iteration may demand a different configuration for the supporting system service(s). When a different configuration is requested, the CSS1 can generate configuration data prior to the provision of services by the supporting system services during the present iteration. That is, although the configuration system services CSS of the primary system 21100′ may be designed for the requested functionality of the primary system 21100′, this configuration may vary to some extent during sequential intelligent processing (e.g., within some expected variance).

In response to a determination that the intelligent processing of the configured intelligence service CIS has provided adequate intelligence in response to the intelligence request, the CSS is configured to determine at 21410′ whether further action is required (e.g., from one or more sub-level computing devices 21200′). That is, the CSS of the primary system 21100′ is a system designed to perform a particular service or set of services (e.g., based on the primary task). Here, at 21410′, if the output of the configured intelligence service CIS satisfies or enables the CSS to perform its own set of services to satisfy the primary task without further input or influence, then the primary system 21100′ may complete the request without involving the sub-level computing device 21200′.

However, in some examples, the primary system 21100′ requires at least another level of services to perform the primary task. The primary system 21100′ may call on any number of sub-level computing devices 21200′ (e.g., via an output 21104′) to perform a directed set of tasks. To call on the sub-level computing device 21200′, the primary system 21100′ may generate an output 21104′ that functions as an input 21202′ to the sub-level computing device 21200′. As shown in FIG. 92B, this output 21104′ may be a directed action request or some action-configuring information such as parameters, variables, or data. Here, this output 21104′ by the primary system 21100′ may enable the sub-level computing device 21200′ to be configured to perform actions/functions in furtherance of the primary task or to perform according to the directed action request. For example, the directed action request requests that the sub-level computing device 21200′ executes or facilitates the execution of one or more subtasks associated with primary request. As an example, the directed action request includes an executable sequence of tasks for the sub-level computing device 21200′ to perform.

In response to the sub-level computing device 21200′ receiving the output 21104′ of the primary system 21100′ (as the input 21202′ to the sub-level computing device 21200′), the sub-level computing device 21200′, at 21412′, is configured to evaluate the output 21204′. That is, the sub-level computing device 21200′ may evaluate the directed action request included in the output 21104′ of the primary system 21100′. For instance, as shown in FIG. 92B, a CSS2 evaluates the output 21104′ from the primary system 21100′. In some implementations, the evaluation of the directed action request by the sub-level computing device 21200′ includes an evaluation of resource requirements and/or resource options that are available to perform the directed action request.

Similar to functionality of the primary system 21100′, the CSS2 of the sub-level computing device 21100′ includes a second configured intelligence service CIS2. In some examples, after evaluating the directed request included in the output 21104′ from the primary system 21100′, the CSS2 generates an intelligence request based on, or derived from, that directed request. For example, FIG. 92B, at 21414′, depicts the second configured intelligence service CIS2 performing CSS2-directed analysis to represent the execution of the intelligence request based on the directed request.

In some configurations, to generate the intelligence request, the CSS2 generates configuration data. In some examples, the configuration data provided by the CSSs2 configures all or some portion of the artificial intelligence service or the intelligence system controller (e.g., the analysis modules, the analysis management module, or the governance library) for an intelligence services system (e.g., shown in FIG. 76). Here, by configuring the intelligence services system with the provided configuration data, the intelligence services system may be considered a “configured intelligence service.” When generating the configuration data for the intelligence request, the CSS2 may leverage information that it receives from the directed request in order to perform intelligent processing for the CSS1.

Much like step 21408′ for the primary system 21100′, the sub-level computing device 21200′, at 21416′, is configured to determine whether the intelligent processing at 21414′ has provided adequate intelligence in response to the intelligence request (i.e., has successfully fulfilled the intelligence request). In some implementations, to evaluate whether the intelligent processing is complete, the CSS2 determines whether the output or decision generated by the second configured intelligence system CIS2 satisfies a threshold (e.g., the decision-making threshold). For instance, the output or decision from the second configured intelligence service CIS2 may be bound by constraints. Here, these constraints may individually or collectively correspond to the decision-making threshold. In some examples, these constraints correspond to the set of inputs 21202′ to the sub-level computing device 22100′.

In some configurations, the CSS2 determines whether the intelligent processing has provided adequate intelligence for the intelligence request in response to an output from the second configured intelligence service CIS2. In other configurations, there may be an event which triggers an evaluation of whether the intelligent processing has provided adequate intelligence in response to the intelligence request. For instance, the event may be a time-based event such as an expiration of a set duration after receiving the request or an expiration of a time period based on a set frequency for evaluating the intelligent processing.

As shown in FIG. 92B, in response to the intelligent processing failing to provide sufficient intelligence for the intelligence request or being incomplete at the time of evaluation, the CSS2 may iteratively repeat the intelligent processing at 21418′ and 21414′ in furtherance of the intelligence request. When another iteration occurs, that iteration of intelligent processing may also include supporting functionality at 21418′ from one or more of the other system services (e.g., shown as CSSs3, CSS4, CSS (n)). In some examples, an iteration may require less (or more) system services than a prior iteration. In this respect, each iteration may include an operation that identifies which, if any, of the supporting system services are demanded for the present iteration. Moreover, each iteration may demand a different configuration for the supporting system service(s). When a different configuration is requested, the CSS2 can generate configuration data prior to the provision of services by the supporting system services during the present iteration. That is, although the configuration system services CSS of the sub-level computing device 21200′ may be designed for the requested functionality of the sub-level computing device 21200′, this configuration may vary to some extent during sequential intelligent processing (e.g., within some expected variance).

In response to a determination at 21416′ that the intelligent processing of the second configured intelligence service CIS2 has provided adequate intelligence in response to the intelligence request, the CSS2 is configured to determine at 21420′ whether an action is available to fulfill the directed action request from the primary system 21100′. When there is an action available to fulfill the directed action request at 21420′, the CSS2 proceeds to 21424′. On the other hand, if an action is not available at 21420′ to fulfill the directed action request, the CSS2 may perform directed action process configuration and/or directed action resource analysis assistance using one or more additional system services at 21422′ (e.g., shown as CSS5, CSS6, and CSS (n)). Here, these additional system services may be another SOS or an external service.

At 21420′, when the CSS2 determines that there is an action available to fulfill the directed request, the process proceeds to 21424′. Here, at 21424′, the CSS2 initiates and/or executes a process determined by or based on the available action and/or the intelligent processing response from the second configured intelligence service CIS2.

Optionally, as shown at 21426′ and 21428′, the process that is to be initiated or executed can undergo an optimization operation. For example, at 21428′, the second configured intelligence system CIS2 determines whether the directed action process is an optimized process. In some implementations, to determine whether the directed action process is an optimized process, the CSS2 determines whether the process satisfies a set of optimization constraints. In other implementations, the CSS2, at 21428′, determines whether the process satisfies a designed objective function. In some instances, the objective function is based on the primary task (e.g., in combination with any external controls included in the primary system input 21102′). In other instances, the objective function is based on the secondary task specified by the directed action request from the sub-level computing device input 21202′.

At 21430′, the CSS2 reports a response to the directed action request as an output 21204′ of the sub-level computing device 21200′. For example, the output 21204′ is an action plan for the primary task. Additionally or alternatively, the output 21204′ of the sub-level computing device 21200′ being reported to the primary system 21100′ is that some set of actions were executed at the sub-level computing device 21200′ to support the primary task as directed by the direct action request from the primary system 21100′. When reporting the execution of some set of actions, the output 21204′ of the sub-level computing device 21200′ may include data or information related to the execution of the set of actions. In some configurations, the data or information is monitoring data that characterizes the performance of the set of actions implemented by the sub-level computing device 21200′ at some snapshot in time or over a certain period of time.

Although FIG. 92B illustrates operational details about the inputs and outputs of a single primary system 21100′ and a single sub-level computing device 21200′ (e.g., as shown in FIG. 90C), there may be any number of sub-level computing devices 21200′ managed by either the primary system 21100′ or a particular sub-level computing device 21200′. When a set of additional sub-level computing devices 21200′ are managed by the sub-level computing device 21200′, these additional sub-level computing devices 21200′ may be referred to as secondary subsystems. When there are multiple sub-level computing devices 21200′ for a control architecture 21000′ (e.g., as shown in FIG. 92B), each sub-level computing device 21200′ may follow a similar set of operations (e.g., operations referenced by 21412′-21430′) in support of the primary task for the primary system 21100′.

In some implementations, VCN process 10 may include a VCN autonomous mobile infrastructure network, which may provide modular, adaptive, and mobile resources that deliver responsive and optimized on-site production as directed by the agile demand response resource network. This network may also provide local granular data to further refine demand response modeling and production. Each of these networks comprise a unique combination of capabilities and applications that are purpose-built using a common set of constituent building block elements and generalized services such as intelligence, distributed ledger, smart contracts, analytics, data sourcing and processing, sensors, etc. Resulting sets of capabilities and applications may be collectively managed by their respective networks, while orchestration of the set of networks may be provided at the highest level by the VCN SOS.

In some implementations, VCN process 10 may include a VCN autonomous fixed infrastructure network. For instance, this network may be similar to a mobile network and may use some of the same configured system services, but it also incorporates a wider set of data and capabilities made available by greater access varied resources such as, e.g., ERP and Industry 4.0 integration, processing power, fewer energy and space limitations, the ability to optimize for location, etc. Each of these networks may include a unique combination of capabilities and applications that are purpose-built using a common set of constituent building block elements and generalized services such as intelligence, distributed ledger, smart contracts, analytics, data sourcing and processing, sensors, etc. Resulting sets of capabilities and applications may be collectively managed by their respective networks, while orchestration of the set of networks may be provided at the highest level by the VCN SOS.

In some implementations, VCN process 10 may include a VCN agile demand response resource network, which may provide configured system services and assemblies of services that simulate and visualize demand scenarios, produce synchronized planning and dynamic fulfillment, etc. One example is Peer-to-Peer (P2P) cognitive matching of supply and demand. Each of these networks may include a unique combination of capabilities and applications that are purpose-built using a common set of constituent building block elements and generalized services such as intelligence, distributed ledger, smart contracts, analytics, data sourcing and processing, sensors, etc. Resulting sets of capabilities and applications may be collectively managed by their respective networks, while orchestration of the set of networks may be provided at the highest level by the VCN SOS.

### ML/AI to Flag and Respond to Potential Disruptions in the Value Chain

As also discussed throughout and referring also at least to the example implementations of FIGS. 161-173, a VCN process, such as VCN process 10, may receive 17900, by a computing device, information associated with a set of value chain network entities (such as those discussed above) of a value chain network. For instance, as discussed throughout, a unified database (e.g., via platform 604) may (e.g., via VCN process 10) receive information associated with a set of value chain network entities of a value chain. The information may be collected in a variety of ways, including (by example only) via the unified data collections systems discussed throughout.

In some implementations, the information may be generated by a set of sensors of the set of value chain network entities. For instance, example sensors and/or a set of APIs configured to publish data relating to the set of value chain network entities may include those discussed regarding the adaptive intelligent systems and monitoring layers of platform 604. In some implementations, the information generated by a set of IoT devices configured to collect data relating to the set of value chain network entities. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 17902 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. In some implementations, the operating state of a machine may be the current condition of the machine. Some examples of operating states may include, e.g., Running—the machine is in normal operation; Idle—the machine is not in operation, but it is ready to be started; Stopped—the machine is not in operation and is not ready to be started; Malfunctioning/Faulted—the machine has malfunctioned and is not operating properly; Under maintenance—the machine is being serviced or repaired.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, VCN process 10 may determine 17904 a potential risk in the value chain based upon, at least in part, an output of the AI-based learning classification. For instance, an example of a potential risk may be a supply chain disruption. A supply chain disruption may occur when there is a break in the flow of goods or services from the supplier to the customer. This can be caused by a variety of factors, such as natural disasters, political instability, or pandemics. A value chain risk (e.g., disruption) is a broader term that refers to any disruption that affects the flow of goods or services within a company or organization. This can include disruptions to production, distribution, or sales. Therefore, VCN process 10 may utilize an AI system that can track and predict potential supply chain risks (or other types of disruptions) and generate predictive insights based upon the above-noted generated information provided to the AI-based learning models. In some implementations, the determination may be a prediction of a future potential risk, or predicted current potential risk.

In some implementations, VCN process 10 may execute 17906 an action to mitigate the potential risk in the value chain network. For instance, once a potential risk has been predicted (or determined/identified), VCN process 10 may execute an action to mitigate that potential risk. In some implementations, the action may be automatically executed without human interaction, or manually executed (e.g., approving an action suggested by VCN process 10). In some implementations, the action taken may be recorded in a log or a feed for viewing.

In some implementations, executing the action to mitigate the potential risk in the value chain network may include flagging 17908 the potential risk in the value chain network. For instance, in some implementations, VCN process 10 may use AI-based learning models to automatically draft and send communications (e.g., text, email, pop-ups, notification feed, chat, etc.) explaining what the predicted risk is, what information was used to predict the risk, and potential recommendations to mitigate the potential risk. This may allow a user to verify whether the potential risk is an actual risk, and take the appropriate action. In some implementations, the potential risk may also be flagged in an application's user interface (UI), such as the above-noted control tower UI.

In some implementations, executing the action to mitigate the potential risk in the value chain network may include responding 17910 to the potential risk in the value chain network. For example, VCN process 10 may suggest diversifying suppliers, which means having multiple suppliers for the same product or service. This can help to reduce the risk of a disruption from one supplier affecting the entire supply chain. Another example suggestion from VCN process 10 may be building inventory buffers, which means having more inventory than is normally needed. This can help to ensure that there is enough product available to meet demand even if there is a disruption. Another example suggestion from VCN process 10 may be using alternative transportation methods, which means using different modes of transportation, such as air freight or rail, if there are disruptions to road or sea transportation. Another example suggestion from VCN process 10 may be renegotiating contracts, which means negotiating with suppliers to change the terms of contracts, such as delivery dates or pricing, if there are disruptions or other risks. Another example suggestion from VCN process 10 may be using technology, meaning the use of technology to track shipments, manage inventory, and communicate with suppliers about the potential risk. This can help to improve visibility and coordination in the supply chain and make it easier to respond to disruptions or other risks. Another example suggestion from VCN process 10 may be additional innovation, such as flagging/responding in a digital twin (e.g., a value chain network digital twin as discussed throughout), where the response may involve, e.g., placing an order in an embedded marketplace of the digital twin.

In some implementations, executing the action to mitigate the potential risk in the value chain network may include resolving 17912 an out-of-stock situation. For instance, assume for example purposes only that VCN process 10 has used one or more AI-based learning models to determine that there is a potential risk in the value chain network. In the example, VCN process 10 may mitigate the potential risk in the value chain network by resolving an out-of-stock situation. As an example, VCN process may determine that a particular product (e.g., an engine part) is out-of-stock or will soon be out-of-stock based upon the AI-based learning models. In some implementations, VCN process 10 may resolve this situation by automatically executing (without human interaction) a reordering of the engine part, or providing a suggestion on a user interface to reorder the engine part, which may be manually executed (e.g., receiving a user input to approve the suggested action).

Resolving an out-of-stock situation may also be achieved by VCN process 10 monitoring inventory levels in real-time across various locations by integrating data from, e.g., IoT devices, edge devices, cameras, RFID tags, or other inventory tracking technologies. The process may utilize this real-time stock level information to predict or ascertain an out-of-stock situation and attempt to ameliorate the problem by, e.g., automatically purchasing new inventory, implementing a dynamic pricing strategy wherein real-time stock levels and customer demand are used as inputs to determine the dynamic price of a product, using drop shipping to fulfill orders by automatically identifying suppliers with stock of the item and placing an order with that supplier and having the item shipped directly to the customer, using an AI-based model to perform a root cause analysis to understand the reasons behind the occurrence of the out-of-stock situation and provide recommendations on how to prevent similar situations from happening in the future, automatically notifying customers about stock levels and the potential for delays and offer a discount, backordering option, alternative products, or other incentive, etc.

In some implementations, executing the action to mitigate the potential risk in the value chain network may include predicting 17914 when to place an order based upon, at least in part, upstream data. For instance, assume for example purposes only that VCN process 10 has used one or more AI-based learning models to determine that there is a potential risk in the value chain network. In the example, VCN process 10 may mitigate the potential risk in the value chain network by using upstream data to predict when to place an order (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands. In some implementations, VCN process 10 may resolve this situation by automatically executing (without human interaction) a reordering of the engine part, or providing a suggestion on a user interface to reorder the engine part at the optimal time, which may be manually executed (e.g., receiving a user input to approve the suggested action).

As an example, VCN process 10 may determine potential risk in the stocking of an engine part. Data obtained from suppliers, distributors, manufacturers, or other upstream value chain network entities may be analyzed by one or more AI-based learning models to generate a risk assessment for immediate or future procurement of the engine part. In some implementations, the VCN process may mitigate this risk by adjusting the timing or quantity of the part procurement. In some implementations, the VCN process may mitigate risk by automatically identifying alternate suppliers for the engine part and placing an order for the part with the identified supplier.

In some implementations, executing the action to mitigate the potential risk in the value chain network may include supply planning 17916. Generally, supply planning ensures that products, materials, and resources will have optimal availability in order to meet current and anticipated demand while minimizing costs and preventing delays in delivery. For instance, assume for example purposes only that VCN process 10 has used one or more AI-based learning models to determine that there is a potential risk in the value chain network. In the example, VCN process 10 may mitigate the potential risk in the value chain network by using upstream data for supply planning. As an example, VCN process 10 may include or interact with a supply planning application that may automatically calculate supply (supply sensing) and stock forecasts based on upstream data (e.g., sales forecasts, warehouse data, etc.). This may allow a precise view of when to place optimal orders that cover specific product supplies. In some implementations, VCN process 10 may resolve this situation by automatically executing (without human interaction) a reordering of the engine part, or providing a suggestion on a user interface to reorder the engine part at the optimal time, which may be manually executed (e.g., receiving a user input to approve the suggested action).

In another example embodiment, an automotive manufacturer may use supply planning of VCN process 10 to mitigate risks associated with component availability and anticipated demand. Consider an automotive manufacturer that anticipates an increase in demand for a specific car model in the upcoming quarter based on analysis that takes into account data including, but not limited to, historical sales, current market trends, and planned promotional initiatives. The manufacturer projects that an additional 10,000 cars will need to be manufactured during the next quarter in order to meet the predicted demand. The manufacturer assesses their current inventory and finds that they only have enough engine parts to manufacture 2,000 cars and therefore needs to order additional stock from their suppliers. A first supplier is able to commit to delivering engine parts sufficient for the manufacturing of 5,000 cars within a one month time frame. A second supplier is able to commit to delivering engine parts sufficient for the manufacturing of 3,000 cars with a two month lead time. A third supplier is able to deliver any requested volume of engine parts with a delivery time of only two weeks, but charges a premium for the expedited delivery. The automotive manufacturer uses this supplier information to plan production scheduling such that car production ramps up after 1.5 months to ensure that component availability is adequate and demand is met in time. The third supplier is used as an auxiliary supplier to mitigate risk in the event that delays are encountered with the primary suppliers. In this manner, the automotive manufacturer uses supply planning to maximize production efficiency and optimize expenses while ensuring sufficient supply to meet anticipated demand.

In some implementations, executing the action to mitigate the potential risk in the value chain network may include optimizing 17918 an inventory mix. For instance, assume for example purposes only that VCN process 10 has used one or more AI-based learning models to determine that there is a potential risk in the value chain network. In the example, VCN process 10 may mitigate the potential risk in the value chain network by using upstream data to optimize an inventory mix. Generally, an inventory mix is the composition of a company's inventory. Inventory mix may be calculated by VCN process 10 dividing the value of each product category by the total value of the inventory. For instance, assume for example purposes only that there is a local sporting goods store that learns via VCN process 10 that it needs to optimize its inventory mix. In the example, the store's sales data shows (e.g., via VCN process 10) that basketballs are the most popular product in the store. The store also knows from VCN process 10 that basketball season is coming up, so VCN process 10 recommends to increase their stock of basketballs. VCN process 10 also recommends to stock a wider variety of basketballs, including different sizes, colors, and brands. This will help to appeal to a wider range of customers. VCN process 10 may also know that baseball season is ending, so VCN process 10 may recommend reducing their stock of baseball bats and gloves. VCN process 10 may also recommend that the store sell off any remaining inventory at a discount. This will help to clear out space for new inventory and reduce the amount of obsolete inventory.

In some implementations, VCN process 10 may receive 17920 external data, and VCN process 10 may determine 17922 a strategy to reduce transportation costs based upon, at least in part, the external data. For instance, assume for example purposes only that VCN process 10 has used one or more AI-based learning models to determine that there is a potential to reduce transportation costs in the value chain network based upon received data. In the example, VCN process 10 may receive the external data to both determine that there is the potential to reduce transportation costs, and determine how to do so. As an example, VCN process 10 may include or interact with a transportation application that may automatically calculate the fastest or most optimal route and transportation method (e.g., air, boat, truck, etc.) based on external data (e.g., gas prices, traffic data, transportation time, sales forecasts, warehouse data, etc.) for past behavior over time, historical data, and/or current data. This may allow a precise view of when to ship orders, what mode of transportation to do so, and the optimal route. In some implementations, the external data may be received and analyzed in real-time or near real-time, enabling rapid time-to-value by collaborating globally with carriers to reduce transportation costs. Time-to-value here may refer to the amount of time it takes for a company to see a return on its investment in real-time data collaboration with global carriers. In some implementations, VCN process 10 may resolve this situation by automatically executing (without human interaction) a change in transportation logistics (e.g., shipping time/date, shipping mode, shipping route, etc.), or providing a suggestion on a user interface to change the transportation logistics, which may be manually executed (e.g., receiving a user input to approve the suggested action). Other examples of external data that may be used to help reduce transportation costs may include, e.g., demand forecasting data (e.g., market trends, sales data, promotional events, seasonal trends, economic indicators, mobile analytics, website analytics, etc.) that may be used to predict regional demand allowing for the consolidation of shipments or ordering of bulk shipments to reduce per-unit transportation costs; fuel price and futures data (e.g., current fuel prices, futures markets data, news media regarding geopolitical events that may affect oil prices) that may be used to provide recommendations on when to purchase fuel or to purchase futures contracts to hedge prices against predicted price increases.

As such, VCN process 10 may help a business select the optimal mode of shipment and the best carrier, based on, e.g., cost, efficiency, and distance, including optimizing multi-leg carrier routes. VCN process 10 may provide visibility into every stage of the supply chain, and together with global trade management functionality of VCN process 10, may also provide information on trade and tariffs, and if there are any potential delays that may happen because of customs and other trade regulations. In some implementations, VCN process 10 may match loads and communicating with carriers, document and track shipments, and assist with freight billing and settlement, provide track and trace services (e.g., enabling real-time information exchange among carriers, distributors, warehouses, and customers), handle complex international logistics, including providing proper import and export documentation making sure shipments are trade compliant.

In some implementations, other ways for VCN process 10 to reduce transportation costs may include, e.g., Route optimization—by tracking the location and availability of carriers in real time, companies can optimize their shipping routes to reduce fuel costs and transit times; Mode selection-companies can also use real-time data to select the most cost-effective mode of transportation for their shipments. For example, if a shipment is not urgent, the company may be able to save money by shipping it via ground transportation instead of air freight; Negotiation-companies can use real-time data to negotiate better rates with carriers. For example, if a company has a large volume of shipments, they may be able to negotiate a lower rate with a carrier; Tracking and Tracing-real-time data can also be used to track and trace shipments in real time. This can help to identify and resolve problems quickly, which can reduce costs and improve customer satisfaction. For instance, assume for example purposes only that a company is shipping a product from China to the United States. Further assume that the company uses a real-time data platform (such as VCN process 10) to track the location and availability of carriers. The platform may also provide information on fuel costs and transit times. Further assume VCN process 10 uses this information to recommend to the company to optimize its shipping route. VCN process 10 may recommend one or more carriers for the company to select (of that VCN process 10 may select automatically) that is located near the shipper and that has a good reputation for on-time delivery. VCN process 10 may recommend that the company also select a mode of transportation that is cost-effective for the shipment.

In some implementations, VCN process 10 may unify 17924 data associated with warehouse management, inventory management, order management, and analytics to optimize an omnichannel fulfillment. For instance, assume for example purposes only that VCN process 10 has used one or more AI-based learning models to determine that there is a potential to optimize an omnichannel fulfillment in the value chain network based upon received data (e.g., warehouse management, inventory management, order management, and analytics). Omnichannel may generally refer to the integration of all sales and fulfillment channels, including such examples as internet/e-commerce, physical stores, and mobile apps, such as to provide a seamless customer journey. Generally, dynamic fulfillment considers the value of inventory according to the location where it is maintained. For example, if a store is in an overstock position anticipating mark-downs to move the excess, these items can be given priority for on-line orders. The net result is higher profit and customer satisfaction. Thus, in some implementations, VCN process 10 may provide a single platform that unifies warehouse management, inventory management, order management, analytics, and more for full network visibility.

In some implementations, VCN process 10 may provide 17926 a platform with a plurality of AI-based learning models for download. For instance, VCN process 10 may be enabled as a models-as-a-service system. For instance, in the context of value chain networks, models-as-a-service may generally refer to the practice of providing access to machine learning (or other type of AI-based learning) models as a service, which may be integrated into different stages of the value chain. Value chain networks can consist of a series of interconnected activities that create value for customers, and these activities may include everything from raw material sourcing and production to marketing and distribution. By providing access to AI-based learning models as a service, businesses may enhance their ability to optimize and automate these activities, improving efficiency, reducing costs, and ultimately delivering better products or services to customers.

For example, a company may provide access to an AI-based learning model that can predict demand for a particular product. This model may be integrated into the planning stage of the value chain, allowing the company to better anticipate customer demand and adjust production accordingly. Similarly, a machine learning model that analyzes customer data may be used in the marketing stage to better understand customer preferences and tailor marketing campaigns to specific customer segments. Overall, models-as-a-service may help businesses in value chain networks to stay competitive by leveraging the power of AI-based learning to optimize and automate their operations. In some implementations, each of the AI-based learning models may be available in an AI marketplace, where users may browse, select, and download individual AI-based learning models for a fee and as needed.

In some implementations, VCN process 10 may use example systems and processes that provide logistics-as-a-service that may be configured as a platform for retail). This platform may transform unused or underutilized space within retail centers into technologically advanced micro distribution hubs. In example embodiments, this may enhance operational efficiency for both retailers and parcel carriers. This may result in cost reduction and improved service quality by reducing the time it takes to fulfill orders.

In some implementations, VCN process 10 may use an AI-based learning model to synchronize the supply chain.

In some implementations, VCN process 10 may use an AI-based learning model for allocation and order promising.

In some implementations, VCN process 10 may use an AI-based learning model for distribution planning.

In some implementations, VCN process 10 may use an AI-based learning model for sales and operations planning.

In some implementations, VCN process 10 may use an AI-based learning model to identify and/or track seasonality patterns and trends.

In some implementations, VCN process 10 may use an AI-based learning model to generate insights related to supply and/or demand.

In some implementations, VCN process 10 may use an AI-based learning model to provide product-level transparency into supply and/or demand metrics.

In some implementations, VCN process 10 may use an AI-based learning model. to provide material-level transparency into supply and/or demand metrics.

In some implementations, VCN process 10 may use an AI-based learning model to provide dynamic fulfillment. For instance, VCN process 10 may provide a platform to realize the full potential of the supply chain infrastructure in terms of maximum revenue, maximum profit, minimum cost and best in class service. VCN process 10 may provide a dynamic fulfillment network, which may generally be described as an interconnected cross-enterprise system that enhances the customer experience by getting the right product and service to the right customer or node at the right time and in the right quantity, quality and condition, while providing supply networks with the desired level of logistics visibility, responsiveness, scalability and flexibility through the application of leading practices, empowering technologies and cross-functional collaboration.

### Automated, Intelligent Procurement System for Value Chain Network Entities

As also discussed throughout and referring also at least to the example implementations of FIGS. 161-173, a VCN process, such as VCN process 10, may 18000 receive, by a computing device, information associated with a set of value chain network entities (such as those discussed above) of a value chain network. For instance, as discussed throughout, a unified database (e.g., via platform 604) may (e.g., via VCN process 10) receive information associated with a set of value chain network entities of a value chain. The information may be collected in a variety of ways, including (by example only) via the unified data collections systems discussed throughout.

In some implementations, the information may be generated by a set of sensors of the set of value chain network entities, or a set of APIs configured to publish data relating to the set of value chain network entities. For instance, example sensors and/or a set of APIs configured to publish data relating to the set of value chain network entities may include those discussed regarding the adaptive intelligent systems and monitoring layers of platform 604. In some implementations, the information generated by a set of IoT devices configured to collect data relating to the set of value chain network entities. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18003 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, and/or the like), a classification (e.g., a classification of an object in an image, a classification of a spoken utterance, a classified fault condition based on sensor data, and/or the like), and/or other suitable outputs of an AI system.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, VCN process 10 may determine 18005 a procurement action to be taken in the value chain network based upon, at least in part, an output of the set of AI-based learning models. For instance, procurement actions may generally be described as a set of one or more activities that organizations undertake (e.g., via VCN process 10) to acquire the goods and services they need to operate. In a value chain network, procurement actions may include but are not limited to: (1) identifying suppliers-finding suppliers who can provide the goods and services needed at a competitive price and with the required quality; (2) negotiating (or renegotiating) contracts-negotiating the terms of contracts with suppliers, such as price, delivery terms, and quality standards; (3) ordering goods and services-placing orders with suppliers for the goods and services needed; (4) receiving and inspecting goods and services-receiving goods and services from suppliers and inspecting them to ensure that they meet the agreed-upon specifications; (5) paying suppliers-paying suppliers for the goods and services they have provided; and (6) managing supplier relationships-building and maintaining relationships with suppliers to ensure that they are reliable and responsive to the organization's needs. Additional considerations (data points) that may be included in the analysis of VCN process 10 may include, e.g.: the cost of procurement-organizations need to find ways to procure goods and services at a competitive price without sacrificing quality; the quality of goods and services-organizations need to ensure that the goods and services they procure meet their specifications and meet the needs of their customers; the timeliness of procurement-organizations need to ensure that they procure goods and services in a timely manner to meet their production or operational needs; the risk involved-organizations may benefit from identifying and managing the risks associated with procurement, such as the risk of supply disruptions or the risk of quality problems; compliance-organizations need to comply with all applicable laws and regulations when procuring goods and services, which may include such things as laws and regulations related to labor, environmental protection, and product safety. The procurement process of VCN process 10 may also include such things as, e.g., developing standards of quality, financing purchases, creating purchase orders, negotiating price, buying goods, inventory control, inventory management, disposal of waste products (e.g., packaging), cost-benefit analysis or cost-utility analysis, finding new suppliers, locating and acquiring goods and services, overseeing sourcing activities, negotiating terms and conditions, monitoring supplier performance and inventory levels, drive cost-saving initiatives, and make buying decisions under conditions of scarcity.

Thus, intelligent procurement in a value chain network may generally refer to the use of advanced technologies and data analytics (such as those provided by VCN process 10, which may include at least a portion of intelligent procurement module 14244 and/or intelligent procurement system 14264) to optimize procurement processes and improve value chain efficiency (e.g., from the C-suite to the production lines). As intelligent procurement is built on cognitive intelligence, which is a system that learns from information (e.g., human behavior over time, historical data, current data) and then may formulate recommendations and behaviors to mirror what a human expert would do. Intelligent procurement systems (which may be included as at least a portion of VCN process 10) may be able to learn from past behavior over time, analyze historical and current data, and make a decision based on that data. As a result, instead of needing a human to identify a potential problem and then to make a change to avoid that problem, VCN process 10 may automatically implement this change and flag administrators to alert them of the decision.

Generally, in some implementations, the key components of VCN process 10's intelligent procurement abilities may include but are not limited to, e.g., data analytics—as intelligent procurement may rely on data analytics to gain insights into supplier performance, market trends, and other factors that impact procurement decisions, which may be used to identify cost savings opportunities and optimize procurement strategies; automated processes—as intelligent procurement systems may automate such things as purchase order creation and invoice processing, which not only reduces the workload for procurement teams, but also reduces errors and delays in the procurement process; contract management—as an intelligent procurement system may streamline contract management by providing easy access to contract terms and monitoring compliance, which may help to ensure that suppliers are meeting their contractual obligations and that procurement teams are getting the best possible value from their suppliers.

In some implementations, VCN process 10 may execute 18007 the procurement action to facilitate an improvement of at least one of the operating state, the fault condition, the operating flow, or the behavior of at least the one entity of the set of value chain network entities. For instance, once a procurement action (such as those discussed above) has been determined (identified), VCN process 10 may execute the procurement action an action to improve either the operating state, the fault condition, the operating flow, or the behavior of one or more value chain network entities. For instance, assume for example purposes only that VCN process 10 determines there is a risk of significant inflation of copper (a component used in semiconductor devices) for a supplier that is currently supplying semiconductor devices. In the example, VCN process 10 may execute a procurement action of proactively renegotiating with the supplier for a lower price of semiconductors or even renewing the current contract for a longer term, in anticipation of the supplier raising its prices due to inflation. In some implementations, the action may be automatically executed without human interaction, or manually executed (e.g., approving an action suggested by VCN process 10). In some implementations, the action taken may be recorded in a log or a feed for viewing.

Another example of a procurement action may include VCN process 10 determining that there is a need to select a new supplier for a quantity of product required to fulfill a contract. In the example, the product should conform to required quality standards, while also being made available at a competitive price. Additionally, the product should be supplied in sufficient quantity and within a defined timeframe. In this example, VCN process 10 may execute a procurement action of identifying suppliers by collecting and analyzing bids for products meeting the requirements of the contract. These bids should include product information relevant to the specifications set forth in the contract, such as pricing, quality metrics, available quantity, delivery timeframe, and/or other factors. VCN process 10 may also reference information documenting the supplier's history, including quantity of previous transactions, likelihood of successful fulfillment, or other data that can support the selection of a particular supplier and their offered product(s). In some Implementations, the action may be automatically executed without human interaction, or manually executed (e.g., approving an action suggested by VCN process 10). In some implementations, the action taken may be recorded in a log or a feed for viewing.

In some implementations, another example procurement action may include VCN process 10, e.g., identifying needs, researching suppliers, placing orders, receiving and inspecting goods, making payments, issuing a purchase order to a supplier for a new batch of widgets, signing a contract with a logistics provider to transport goods from its warehouse to its customers, negotiating a new pricing agreement with a supplier of raw materials, conducting a competitive bidding process to select a new vendor for its IT services, developing a new supplier onboarding process to ensure that new suppliers are meeting its standards, etc.

In some implementations, executing the procurement action may include resolving 18009 an out-of-stock situation. For instance, assume for example purposes only that VCN process 10 has used one or more AI-based learning models to determine that there is a potential risk in the value chain network. In the example, VCN process 10 may mitigate the potential risk in the value chain network by resolving an out-of-stock situation with a procurement action. As an example, VCN process may determine that a particular concern, such as a lack of semiconductor devices of a particular supplier being used by a value chain network entity is out-of-stock or will soon be out-of-stock based upon the AI-based learning models. In some implementations, VCN process 10 may resolve this situation by automatically executing (without human interaction) a negotiation of a contract with another supplier that does have semiconductor devices in stock, or providing a suggestion on a user interface to negotiate a contract with another supplier that does have semiconductor devices in stock, which may be manually executed (e.g., receiving a user input to approve the suggested action).

In some implementations, executing the procurement action may include predicting 18011 when to place an order based upon, at least in part, upstream data. For instance, assume for example purposes only that VCN process 10 has used one or more AI-based learning models to determine that there is a potential risk in the value chain network. In the example, VCN process 10 may mitigate the potential risk in the value chain network by using upstream data to predict when to place an order (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands. For instance, VCN process 10 may use upstream and/or external data to determine there is a risk of significant inflation of copper (a component used in semiconductor devices) for a supplier that is currently supplying semiconductor devices. In the example, VCN process 10 may execute a procurement action of proactively order semiconductor devices from the supplier prior to an anticipated price hike by the supplier resulting from the predicted or actual inflation. In some implementations, VCN process 10 may accomplish this by automatically executing (without human interaction) a reordering of the semiconductor devices, or providing a suggestion on a user interface to reorder the semiconductor devices at the optimal time, which may be manually executed (e.g., receiving a user input to approve the suggested action).

In some implementations, VCN process 10 may provide 18013 an alert describing the procurement action that was executed. For instance, in some implementations, VCN process 10 may use AI-based learning models to automatically draft and send communications (e.g., text, email, pop-ups, notification feed, chat, etc.) explaining what the determined procurement action(s) may be/are, what information was used to determine the procurement action, and the intended result of executing the procurement action (e.g., faster delivery, lower costs, better quality, etc.). This may allow a user to verify whether the procurement action should be confirmed, and take any additional appropriate action. In some implementations, the potential risk may also be flagged in an application's user interface (UI), such as the above-noted control tower UI.

In some implementations, VCN process 10 may provide 18015 real-time information on supplier performance. For example, in some implementations, VCN process 10 may monitor 18017 compliance of suppliers and procurement teams. For instance, VCN process 10 may include supplier management functionality, which may include an intelligent procurement system that enable effective supplier management by providing real-time information on supplier performance, including delivery times, quality metrics, and pricing. This information, as noted above, may be used to make informed decisions about supplier selection, performance management, or other procurement actions. In some implementations, the real-time information may also be flagged or otherwise displayed in an application's user interface (UI), such as the above-noted control tower UI.

For instance, assume for example purposes only that VCN process 10 has used one or more AI-based learning models to determine that there is a potential to reduce transportation costs in the value chain network based upon received data. In the example, VCN process 10 may receive the external data to both determine that there is the potential to reduce transportation costs, and determine how to do so. As an example, VCN process 10 may include or interact with a transportation application that may automatically calculate the fastest or most optimal route and transportation method (e.g., air, boat, truck, etc.) based on external data (e.g., gas prices, traffic data, transportation time, sales forecasts, warehouse data, etc.) for past behavior over time, historical data, and/or current data. This may allow a precise view of such procurement actions including, e.g., when to order, when to pay invoices, etc. In some implementations, the external data may be received and analyzed in real-time or near real-time, enabling rapid time-to-value by collaborating globally with carriers to reduce transportation costs. In some implementations, VCN process 10 may resolve this situation by automatically executing (without human interaction) a request to change contract terms (e.g., price, delivery terms, and quality standards, etc.), or providing a suggestion on a user interface to change contract terms, which may be manually executed (e.g., receiving a user input to approve the suggested action).

In some implementations, VCN process 10 may automatically generate 18019 purchase orders associated with the procurement action, and in some implementations, VCN process 10 may automatically process 18021 invoice processing associated with the procurement action. For instance, assume for example purposes only that VCN process 10 has used one or more AI-based learning models to determine that there is a potential risk in the value chain network. In the example, VCN process 10 may mitigate the potential risk in the value chain network by using upstream data to predict when to place an order (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to generate purchase orders that cover specific product demands and when to process invoice processing for the purchase orders. For instance, VCN process 10 may use upstream and/or external data to determine there is a risk of significant inflation of copper (a component used in semiconductor devices) for a supplier that is currently supplying semiconductor devices. In the example, VCN process 10 may execute a procurement action of proactively generating purchase orders for semiconductor devices from the supplier prior to an anticipated price hike by the supplier resulting from the predicted or actual inflation. In some implementations, VCN process 10 may accomplish this by automatically executing (without human interaction) a reordering of the semiconductor devices through purchase order generation and/or submission, or providing a suggestion on a user interface to reorder the semiconductor devices through purchase order generation and/or submission at the optimal time, which may be manually executed (e.g., receiving a user input to approve the suggested action).

In some implementations, VCN process 10 may unify 18023 data associated with warehouse management, inventory management, order management, analytics to optimize an omnichannel fulfillment. For instance, assume for example purposes only that VCN process 10 has used one or more AI-based learning models to determine that there is a potential to optimize an omnichannel fulfillment in the value chain network based upon received data (e.g., warehouse management, inventory management, order management, and analytics). Generally, dynamic fulfillment considers the value of inventory according to the location where it is maintained. For example, if a store is in an overstock position anticipating mark-downs to move the excess, these items can be given priority for on-line orders. The net result is higher profit and customer satisfaction. Thus, in some implementations, VCN process 10 may provide a single platform that unifies warehouse management, inventory management, order management, analytics, and more for full network visibility.

In some implementations, VCN process 10 may execute the procurement action by a value chain network digital twin. For example, VCN process 10 may suggest diversifying suppliers, which means having multiple suppliers for the same product or service. This can help to reduce the risk of a disruption from one supplier affecting the entire supply chain. Another example suggestion from VCN process 10 may be building inventory buffers, which means having more inventory than is normally needed. This can help to ensure that there is enough product available to meet demand even if there is a disruption or other issues. Another example suggestion from VCN process 10 may be identifying suppliers that use alternative transportation methods, which means using different modes of transportation, such as air freight or rail, if there are disruptions to road or sea transportation. Another example suggestion from VCN process 10 may be renegotiating contracts, which means negotiating with suppliers to change the terms of contracts, such as delivery dates or pricing, if there are disruptions or other risks. Another example suggestion from VCN process 10 may be using technology, meaning the use of technology to track shipments, manage inventory, and communicate with suppliers about the potential risk. This can help to improve visibility and coordination in the supply chain and make it easier to respond to disruptions or other risks. Another example suggestion from VCN process 10 may be additional innovation, such as flagging/responding in a digital twin (e.g., a value chain network digital twin as discussed throughout), where the response may involve, e.g., placing an order in an embedded marketplace of the digital twin.

In some implementations, the control tower UI (or other type of UI) may be considered as something of a command and control center that provides intelligent and automated control over operations, enabling more efficient risk management to cope with increasing volatility. Example control tower UI features may include, e.g.: Dashboards with interactive widgets to provide an at-a-glance view of key performance indicators (KPIs) such as stock levels, in-transit goods, and supplier performance; Notification Panel for real-time alerts for any disruptions, pending tasks, or anomalies in the supply chain; Digital twin with 3D Visualizations, such as an interactive three-dimensional representation of the entire supply chain, from suppliers to end-users, Layered Views, such as a toggle between different aspects of the supply chain (e.g., transportation, warehousing) on the digital twin to drill down into reduced dimensionality views to reveal higher levels of detail, or zoom out to lower dimensionality views, Simulation Controls for tools to run various scenarios and forecasts on the digital twin, like potential supply disruptions or demand spikes, Logistics, such as interactive maps to display real-time movement of goods, allowing users to zoom, pan, or click on specific routes or shipments for detailed information, Timeline Views for a chronological representation of the supply chain process, from order placement to delivery, Heatmaps for a visual representation of data densities, such as areas with the highest sales or locations of frequent supply disruptions, real-time data, such as Live Data Feeds for continuous updating of data as it comes in, be it from IoT devices, supplier inputs, or point-of-sale systems, a Historical Data Toggle to compare real-time data with historical data to identify trends or anomalies, a search functionality for dynamic searching to allow users to quickly locate specific products, shipments, or suppliers, customizable filters to refine views based on criteria like date range, product type, or transportation mode, an Intelligent chatbot, such as an AI Chatbot Interface to allow users to chat with the control tower in natural language utterances to obtain information related to supply chain activities or internal business processes, Reporting and Analytics, Custom Report Builder that allows users to generate detailed reports based on selected data sets, Trend Analysis for graphical tools to identify and analyze supply chain trends over time, Predictive Analytics to utilize AI algorithms to predict future supply chain scenarios based on current and historical data and present the results to the user in a visual framework, Summary Widgets for quick stats on the total number of shipments, those in-transit, delayed, received, dispatched, etc., a Notification Panel for real-time alerts for pending shipments, potential delays, or any anomalies, Interactive Shipment Map for visualizing the real-time location and status of each shipment (e.g., which may enable hovering/clicking/touching, etc. on shipment icons for detailed information), Dynamic Search for quickly locating a specific shipment using shipment ID, sender/receiver name, etc., Advanced Filters for shipments by status (e.g., in-transit, delivered), date range, carrier, destination, etc., Shipment Details for comprehensive information about a specific shipment, including items, quantity, origin, destination, carrier details, and expected vs. actual delivery times, attachments like bill of lading, invoice, or any other relevant documents, Carrier Performance Metrics for insights into the performance of various carriers based on delivery time, damages, and other relevant metrics.

As will be discussed in greater detail, VCN process 10 may be enabled with predictive sourcing capabilities, and may also include, in some implementations, a no login, no application, no hassle, seamless, one-click sourcing events in a supplier's inbox, embedded with real-time predictive data.

### Predictive Sourcing System

As also discussed throughout and referring also at least to the example implementations of FIGS. 161-173, a VCN process, such as VCN process 10, may receive 18101, by a computing device, information associated with a set of value chain network entities (such as those noted throughout) of a value chain network. For instance, as discussed throughout, a unified database (e.g., via platform 604) may (e.g., via VCN process 10) receive information associated with a set of value chain network entities of a value chain network. The information may be collected in a variety of ways, including (by example only) via the unified data collections systems discussed throughout.

In some implementations, VCN process 10 may include the ability to synchronize planning and predictive sourcing, which may be two components of supply chain management that may help improve supply chain efficiency and reduce costs. For instance, VCN process 10's synchronized planning may be generally described as the process of aligning some or all of the activities and functions within the supply (or demand) chain to work together towards a common goal. This may include, e.g., demand planning/sensing for highly accurate forecasts, production planning, inventory management, and logistics planning. By VCN process 10 coordinating these activities, companies may ensure that they are efficiently using their resources to meet customer demand while minimizing costs. As an example, as will be discussed below, if a company knows that demand for a particular product is going to increase, they can use VCN process 10's synchronized planning to ensure that they have enough inventory on hand to meet that demand, while also ensuring that production and logistics are prepared to handle the increased volume. VCN process 10's predictive sourcing may be generally described as the use of data analytics and predictive modeling to forecast future demand and identify potential supply chain disruptions. By VCN process 10 analyzing historical data and current trends, companies can use VCN process 10 to identify potential risks and take proactive measures to mitigate them. For example, if a company knows (e.g., via VCN process 10) that a particular supplier has a history of delivery delays, they can use VCN process 10's predictive sourcing to identify the likelihood of future delays and take steps to ensure that they have alternative suppliers lined up or extra inventory on hand to avoid any disruption in the supply chain.

In some implementations, the information may be generated by a set of sensors of the set of value chain network entities. For instance, example sensors and/or a set of APIs configured to publish data relating to the set of value chain network entities may include those discussed regarding the adaptive intelligent systems and monitoring layers of platform 604. In some implementations, the information generated by a set of IoT devices configured to collect data relating to the set of value chain network entities. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18103 the information to a first set of Artificial Intelligence (AI)-based learning models, wherein at least one member of the first set of AI-based learning models may be trained on a training data set of value chain network data to generate a prediction of future demand for an item in the value chain network. For instance, in embodiments, one or more intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, VCN process 10 may provide 18105 the information to a second set of AI-based learning models, wherein at least one member of the second set of AI-based learning models may be trained on a training data set of a set of value chain network entities operating data to classify at least one of: an operating state, a fault condition, an operating flow, or a behavior of at least one value chain entity of the set of value chain network entities. For instance, similar to first set of AI-based learning models noted above, one or more intelligence services (such as those discussed in the example implementation of FIG. 76, which may be from the same system or various sources) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, VCN process 10 may determine 18107 a potential risk in the value chain network associated with the at least one value chain network entity based upon, at least in part, an output of the AI-based learning models. For instance, in some implementations, VCN process 10 may information that leverages a highly accurate daily forecast for every (desired) item at every (known) location, processing hundreds of internal and external signals to arrive at unbiased predictions and deliver profitable business decisions. VCN process 10 may use automation, AI and AI-based learning models to analyze real-time supply chain data and determine the influence of new demand signals. For example, VCN process 10's predictive sourcing may allow procurement teams to be proactive to market changes and know when to source to avoid higher prices. For example, predictive sourcing may have seen a global semiconductor shortage and its impact on, e.g., the automobile industry. As there were only several dozen chip fabrication plants in operation, with a few companies dominating making semiconductors under contract for other companies, which in turn sell chips through the supply chain, VCN process 10's predictive analytics in procurement would have seen the warning signs converging based upon information such as, e.g., increased demand for high-tech products across multiple sectors; a new generation of game console launching; geopolitical tensions resulting in Chinese companies buying up microprocessor stockpiles; and chip fabrication plants starting to reach their maximum production capacity. This information may be sent to or actively retrieved by VCN process 10 using multiple example sources, and may include such things as internal data assets and external data assets. Internal data assets may include, e.g., supplier provided data-such as invoices and purchase orders; transactional (ERP) data; tactical data-such as Excel and SharePoint, and external data assets may include, e.g., Public internet data-such as supplier information, currency rates, publicity traded commodities; 3rd party proprietary data-such as supplier industry codes, risk and CSR profiles, and certain indexes, procurement benchmarking and supplier discover.

Some non-limiting examples of procurement analytics used by VCN process 10 may include, e.g., spend analytics (procurement spend data from internal or external data sources), invoice analytics (invoice data and payment cycles from internal or external data sources), purchase order analytics (purchase order (PO) coverage, maverick spend, and PO cycle times from internal or external data sources), payment term analytics (identify and act on working capital improvement opportunities), supplier analytics (individual suppliers' performance, comparison of supplier performance, analysis of supplier risk, sustainability or diversity, or analysis of supplier base), diversity analytics (social responsibility and diversity in the supply base, on category and individual supplier level), sustainability analytics (Environmental, Labor & Human Rights, Ethics, and Sustainable Procurement targets from the supply chain), supplier risk analytics (external risk factors negatively impacting the supply chain), contract analytics (supplier contracts and their meta-data, such as payment terms and expiration dates).

In some implementations, an example potential risk may be a supply chain disruption. A supply chain disruption may occur when there is a break in the flow of goods or services from the supplier to the customer. This can be caused by a variety of factors, such as natural disasters, political instability, or pandemics. A value chain risk (e.g., disruption) is a broader term that refers to any disruption that affects the flow of goods or services within a company or organization. This can include disruptions to production, distribution, or sales. Therefore, VCN process 10 may utilize an AI system that can track and predict potential supply chain risks (or other types of disruptions) and generate predictive insights based upon the above-noted generated information provided to the AI-based learning models. In some implementations, the determination may be a prediction of a future potential risk, or predicted current potential risk.

In some implementations, VCN process 10 may either output 18109 a recommendation to mitigate the potential risk in the value chain network and/or may automatically execute 18111 an action to mitigate the potential risk in the value chain network. For instance, once a potential risk has been predicted (or determined/identified), VCN process 10 may execute an action to mitigate that potential risk. In some implementations, the action may be automatically executed without human interaction, or manually executed (e.g., approving an action suggested by VCN process 10 that was output via a UI, such as the control tower UI discussed throughout). In some implementations, the action taken may be recorded in a log or a feed for viewing. In some implementations, the action may be VCN process 10 suggesting diversifying suppliers, which means having multiple suppliers for the same product or service. This may help to reduce the risk of a disruption from one supplier affecting the entire supply chain. Another example suggestion from VCN process 10 may be building inventory buffers, which means having more inventory than is normally needed. This can help to ensure that there is enough product available to meet demand even if there is a disruption or other issues. Another example suggestion from VCN process 10 may be identifying suppliers that use alternative transportation methods, which means using different modes of transportation, such as air freight or rail, if there are disruptions to road or sea transportation. Another example suggestion from VCN process 10 may be renegotiating contracts, which means negotiating with suppliers to change the terms of contracts, such as delivery dates or pricing, if there are disruptions or other risks. Another example suggestion from VCN process 10 may be using technology, meaning the use of technology to track shipments, manage inventory, and communicate with suppliers about the potential risk. This can help to improve visibility and coordination in the supply chain and make it easier to respond to disruptions or other risks. Another example suggestion from VCN process 10 may be additional innovation, such as predictive sourcing in an AI-driven digital twin (e.g., a value chain network digital twin as discussed throughout), where the response may involve, e.g., placing an order in an embedded marketplace of the digital twin.

As another example, using the above-noted synchronized planning of VCN process 10, a company may be enabled to automate the planning process and create an improved inventory mix over a widespread network (as noted throughout). In some implementations, VCN process 10 may use its AI and cluster analysis, helping to identify and track seasonality patterns and trends not easily uncovered via traditional methods.

In some implementations, executing the action to mitigate the potential risk in the value chain network associated with the item may include flagging 18113 the potential risk in the value chain network associated with the item. For instance, in some implementations, VCN process 10 may use AI-based learning models to automatically draft and send communications (e.g., text, email, pop-ups, notification feed, chat, etc.) explaining what the predicted risk is, what information was used to predict the risk, and potential recommendations to mitigate the potential risk. This may allow a user to verify whether the potential risk is an actual risk, and take the appropriate action. In some implementations, the potential risk may also be flagged in an application's user interface (UI), such as the above-noted control tower UI.

In some implementations, executing the action to mitigate the potential risk in the value chain network associated with the item may include responding 18115 to the potential risk in the value chain network associated with the item. For example, VCN process 10 may suggest diversifying suppliers, which means having multiple suppliers for the same product or service. This can help to reduce the risk of a disruption from one supplier affecting the entire supply chain. Another example suggestion from VCN process 10 may be building inventory buffers, which means having more inventory than is normally needed. This can help to ensure that there is enough product available to meet demand even if there is a disruption. Another example suggestion from VCN process 10 may be using alternative transportation methods, which means using different modes of transportation, such as air freight or rail, if there are disruptions to road or sea transportation. Another example suggestion from VCN process 10 may be renegotiating contracts, which means negotiating with suppliers to change the terms of contracts, such as delivery dates or pricing, if there are disruptions or other risks. Another example suggestion from VCN process 10 may be using technology, meaning the use of technology to track shipments, manage inventory, and communicate with suppliers about the potential risk. This can help to improve visibility and coordination in the supply chain and make it easier to respond to disruptions or other risks. Another example suggestion from VCN process 10 may be additional innovation, such as flagging/responding in a digital twin (e.g., a value chain network digital twin as discussed throughout), where the response may involve, e.g., placing an order in an embedded marketplace of the digital twin.

In some implementations, executing the action to mitigate the potential risk in the value chain network associated with the item may include resolving 18117 an out-of-stock situation. For instance, assume for example purposes only that VCN process 10 has used one or more AI-based learning models to determine that there is a potential risk in the value chain network. In the example, VCN process 10 may mitigate the potential risk in the value chain network by resolving an out-of-stock situation with a procurement action. As an example, VCN process may determine that a particular concern, such as a lack of semiconductor devices of a particular supplier being used by a value chain network entity is out-of-stock or will soon be out-of-stock based upon the AI-based learning models. In some implementations, VCN process 10 may resolve this situation by automatically executing (without human interaction) a negotiation of a contract with another supplier that does have semiconductor devices in stock, or providing a suggestion on a user interface to negotiate a contract with another supplier that does have semiconductor devices in stock, which may be manually executed (e.g., receiving a user input to approve the suggested action).

In some implementations, executing the action to mitigate the potential risk in the value chain network associated with the item may include predicting 18119 when to place an order based upon, at least in part, upstream data. For instance, assume for example purposes only that VCN process 10 has used one or more AI-based learning models to determine that there is a potential risk in the value chain network. In the example, VCN process 10 may mitigate the potential risk in the value chain network by using upstream data to predict when to place an order (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands. In some implementations, VCN process 10 may resolve this situation by automatically executing (without human interaction) a reordering of the engine part, or providing a suggestion on a user interface to reorder the engine part at the optimal time, which may be manually executed (e.g., receiving a user input to approve the suggested action).

In some implementations, VCN process 10 may unify 18121 data associated with warehouse management, inventory management, order management, analytics to optimize an omnichannel fulfillment. For instance, assume for example purposes only that VCN process 10 has used one or more AI-based learning models to determine that there is a potential to optimize an omnichannel fulfillment in the value chain network based upon received data (e.g., warehouse management, inventory management, order management, and analytics). Generally, dynamic fulfillment considers the value of inventory according to the location where it is maintained. For example, if a store is in an overstock position anticipating mark-downs to move the excess, these items can be given priority for on-line orders. The net result is higher profit and customer satisfaction. Thus, in some implementations, VCN process 10 may provide a single platform that unifies warehouse management, inventory management, order management, analytics, and more for full network visibility.

In some implementations, VCN process 10 may provide 18123 an alert describing the action to mitigate the potential risk in the value chain network associated with the item that was executed. For instance, in some implementations, VCN process 10 may use AI-based learning models to automatically draft and send communications (e.g., text, email, pop-ups, notification feed, chat, etc.) explaining what the determined procurement action(s) may be/are, what information was used to determine the procurement action, and the intended result of executing the procurement action (e.g., faster delivery, lower costs, better quality, etc.). This may allow a user to verify whether the procurement action should be confirmed, and take any additional appropriate action. In some implementations, the potential risk may also be flagged in an application's user interface (UI), such as the above-noted control tower UI.

In some implementations, the information may include past behavior over time, historical data, and current data. For instance, VCN process 10 may include supplier management functionality, which may include an intelligent procurement system that enable effective supplier management by providing real-time information on supplier performance, including delivery times, quality metrics, and pricing. This information, as noted above, may be used to make informed decisions about supplier selection, performance management, or other procurement actions. In some implementations, the real-time information may also be flagged or otherwise displayed in an application's user interface (UI), such as the above-noted control tower UI.

For instance, assume for example purposes only that VCN process 10 has used one or more AI-based learning models to determine that there is a potential to reduce transportation costs in the value chain network based upon received data. In the example, VCN process 10 may receive the external data to both determine that there is the potential to reduce transportation costs, and determine how to do so. As an example, VCN process 10 may include or interact with a transportation application that may automatically calculate the fastest or most optimal route and transportation method (e.g., air, boat, truck, etc.) based on external data (e.g., gas prices, traffic data, transportation time, sales forecasts, warehouse data, etc.) for past behavior over time, historical data, and/or current data. This may allow a precise view of such procurement actions including, e.g., when to order, when to pay invoices, etc. In some implementations, the external data may be received and analyzed in real-time or near real-time, enabling rapid time-to-value by collaborating globally with carriers to reduce transportation costs. In some implementations, VCN process 10 may resolve this situation by automatically executing (without human interaction) a request to change contract terms (e.g., price, delivery terms, and quality standards, etc.), or providing a suggestion on a user interface to change contract terms, which may be manually executed (e.g., receiving a user input to approve the suggested action).

In some implementations, VCN process 10 may render 18125 a visualization associated with at least one of inbound or outbound shipments associated with the item, which, in some implementations, may be based upon VCN process 10's AI-based learning models, may be related to the VCN, and may be related to the VCN using VCN process 10's AI-based learning models. For instance, example features/widgets/windows, etc. of the example control tower UI discussed throughout may include, e.g., Summary Widgets for quick stats on the total number of shipments, those in-transit, delayed, received, dispatched, etc., a Notification Panel for real-time alerts for pending shipments, potential delays, or any anomalies, Interactive Shipment Map for visualizing the real-time location and status of each shipment (e.g., which may enable hovering/clicking/touching, etc. on shipment icons for detailed information), Dynamic Search for quickly locating a specific shipment using shipment ID, sender/receiver name, etc., Advanced Filters for shipments by status (e.g., in-transit, delivered), date range, carrier, destination, etc., Shipment Details for comprehensive information about a specific shipment, including items, quantity, origin, destination, carrier details, and expected vs. actual delivery times, attachments like bill of lading, invoice, or any other relevant documents, Carrier Performance Metrics for insights into the performance of various carriers based on delivery time, damages, and other relevant metrics.

In some implementations, VCN process 10 may be enabled with predictive sourcing capabilities, and may also include, in some implementations, a no login, no application, no hassle, seamless, one-click sourcing events in a supplier's inbox, embedded with real-time predictive data. For instance, predictive sourcing capabilities may be used by VCN process 10 to identify potential suppliers, predict their prices, and assess their risk. This can help companies to save time and money when sourcing goods and services. In some implementations, VCN process 10 may include a no login, no application, no hassle, seamless, one-click sourcing events in a supplier's inbox, embedded with real-time predictive data, which allows suppliers to participate in sourcing events with minimal effort. Suppliers may click on a link in their inbox to participate in an event, and they may be able to see real-time predictive data about the event, such as the estimated demand for the goods or services being sourced. For instance, assume for example purposes only that a retail company is looking to source new products for its upcoming holiday season. In the example, the company uses predictive sourcing capabilities of VCN process 10 to identify a list of potential suppliers for each product category. The company may then send out (e.g., via VCN process 10) one-click sourcing event invitations to the suppliers on the list. In the invitation, the company may specify the estimated demand for each product category. The suppliers click on the link in the invitation to participate in the event. The suppliers can see real-time predictive data about the event, such as the estimated demand for each product category and the current prices of competing suppliers. The suppliers submit their bids to the company, and the company then selects the supplier with the most competitive bid for each product category.

### ML/AI for Automation of a Set of Value Chain Network Entities

As will be discussed in greater detail below, as discussed throughout and referring also at least to the example implementations of FIGS. 161-173, a VCN process, such as VCN process 10, may receive 18200, by a computing device, information associated with a value chain network. For instance, as similarly discussed throughout, a unified database (e.g., via platform 604) may (e.g., via VCN process 10) receive information associated with a set of value chain network entities of a value chain network, as well as a value chain network itself. The information may be collected in a variety of ways, including (by example only) via the unified data collections systems discussed throughout.

In some implementations, the information may be generated by a set of sensors of the set of value chain network entities (such as the example value chain network entities discussed throughout). For instance, in some implementations, the information generated by a set of IoT devices configured to collect data relating to the set of value chain network entities. As an example, unified IoT monitoring systems (such as those discussed regarding at least the example implementation of FIG. 33) may be used to generate information from a set of IoT devices. As another example, a set of APIs configured to publish data relating to the set of value chain network entities or a particular item (e.g., an engine part) may include those discussed regarding the adaptive intelligent systems and monitoring layers of platform 604. In some implementations, the information may include one or more of historical sales data and market trends associated with the item. As yet another example, some example sensors may be configured to publish data relating to the set of value chain network entities may include those discussed regarding the adaptive intelligent systems and monitoring layers of platform 604. As discussed in greater detail throughout, some example sensors associated with a particular item may also be able to monitor and gather information associated with that item. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18202 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of at least one value chain entity of the set of value chain network entities. For instance, in embodiments, one or more intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, VCN process 10 may determine 18204 a task to be completed for the value chain network based upon, at least in part, on an output of the set of AI-based learning models, and in some implementations, VCN process 10 may execute 18206 the task to facilitate an improvement in the value chain network. For instance, in some embodiments, VCN process 10 may provide automated recommendations for a set of one or more value chain process tasks involving a wide range of types of activities, such as, without limitation, product configuration activities, product selection activities for a customer, supplier selection activities, shipper selection activities, route selection activities, factory selection activities, product assortment activities, product management activities, logistics activities, reverse logistics activities, artificial intelligence configuration activities, maintenance activities, product support activities, product recommendation activities, demand prediction, defect and quality issue detection, item failure prediction, optimization identification and execution, and many others. For example, in some implementations, executing the task may include predicting 18208 future demand for an item in the value chain network. For instance, as discussed throughout, VCN process 10's AI-based learning models may be used to analyze historical sales data, market trends, and other factors to predict future demand for products (such as the engine part). This may help companies optimize inventory levels, production schedules, and pricing strategies to meet customer demand and maximize revenue.

In some implementations, executing the task may include detecting 18210 defects and quality issues in an item in the value chain network. For instance, as discussed throughout, VCN process 10's AI-based learning models may be used to detect defects and quality issues in an item. For instance, assume for example purposes only that the above-noted information includes a video and/or a photo associated with the item (as well as other data). In the example, the video/photo of the actual item may be analyzed by VCN process 10 to identify any imperfections in the item itself. An example imperfection may include an anomaly in the shape of the item, such as a crack or warped portion of the item, dimensional inconsistencies of items or their packaging, such as those resulting from crushing, impact, or other physical damage, surface blemishes such as a chip, scuff, abrasion, or other surface anomaly, defects or quality issues such as an item's exposure to potentially damaging temperatures, extreme pressures, impacts, visible or UV light, toxic materials (e.g., chemicals, pathogenic organisms, or other dangerous contaminants), or intentional product adulterations/sabotage, discoloration, mislabels or misprints, water damage as evidenced by leaks or seepage, mold, corrosion or rust, foreign object detection. The presence of these defects may be detected by sensors that are directly contacting the item or are monitoring the item's environment(s). This may help companies identify and address quality issues early in the production process (or even in use), reducing waste and improving customer satisfaction. The information may include data from one or more sensors associated with the item. For instance, a temperature sensor, magnetic sensor, pressure monitoring sensor, vibration monitoring sensor, heat flow monitoring sensor, or any other type of sensor is contemplated, which may also be used by a digital twin (or otherwise) to help detect defects and quality issues in an item.

In some implementations, executing the task may include predicting 18212 when an item in the value chain network will fail. For instance, as discussed throughout, VCN process 10's AI-based learning models may be used to predict when equipment is likely to fail. This may help companies schedule maintenance proactively, reducing downtime and maintenance costs. As an example, the above-noted platform 604 may (e.g., via VCN process 10) include the ability of performing condition monitoring, anomaly detection, failure forecasting and predictive maintenance of an item/equipment. Some examples of questions that the predictive model may answer may include, e.g., when will the item fail, what type of failure it will be, what is the probability that a failure will occur within the next X hours or other given time window, what is the remaining useful life of the item, is the item behaving in an uncharacteristic manner, which item requires maintenance most urgently and the like. In some implementations, the information associated with the predictions may be received by a digital twin.

In some implementations, executing the task may include identifying 18214 a value chain process capable of optimization based upon, at least in part, analyzing the information associated with the value chain network, and optimizing 18216 the value chain process. For instance, as discussed throughout, VCN process 10's AI-based learning models may be used to optimize supply chain processes/tasks, such as transportation routing and management, inventory management, supplier selection, scheduling production, tracking production costs, packing and shipping goods, tracking delivery status, identifying suppliers, negotiating contracts, configuring a smart contract, ordering goods and services, and receiving and inspecting goods and services. Information may be analyzed from various sources, such as inventory levels, transportation schedules, and supplier performance, to optimize supply chain operations. For instance, regarding inventory levels, assume for example purposes only that a large e-commerce company sells a wide range of products to customers worldwide. Further assume the company faces challenges in managing its inventory efficiently due to fluctuating customer demands, seasonal trends, supplier lead times, and other factors. After gathering historical data on sales, customer orders, supplier deliveries, market trends, and other relevant variables, the data can be processed and fed into an AI-based predictive analytics system of VCN process 10 that also considers historical and current inventory levels. VCN process 10 may then facilitate decision making processes concerning reorder points, safety stock levels, and order quantities by forecasting supply and demand side factors that determine optimal inventory levels. Regarding transportation schedules, assume for example purposes only that an organic produce distributor relies heavily on timely shipments to ensure freshness of their product. The distributor (e.g., via VCN process 10) may analyze historical transportation schedules and bottlenecks to choose the most reliable carriers and optimized routes to reduce transit times so that fresher products make their way onto store shelves quicker and with fewer wasted perishables. Regarding supplier performance, assume for example purposes only that a luxury fashion retailer with a reputation for quality and timely deliveries regularly assesses their supplier performance metrics, such as delivery punctuality and defect rates. When a primary fabric supplier begins showing (e.g., via VCN process 10) inconsistent delivery times and increased defects, VCN process 10 may proactively recommend sources for the fashion retailer for an alternate supplier, ensuring continuity in production and upholding their high-quality reputation. Other types of optimizations may include configuring and/or deploying robotic fleets, container fleets, additive manufacturing/3D printer fleets, loading/unloading containers, etc. This may help companies reduce costs, improve efficiency, and increase flexibility in their supply chain operations.

In some implementations, executing the task may include analyzing 18218 user data of a user from at least one source, and identifying 18220 one or more attributes of the user based upon, at least in part, the user data. For instance, as discussed throughout, VCN process 10's AI-based learning models may be used to analyze customer data, such as purchase history, social media activity, and demographic information, to gain insights into attributes such as customer behavior and preferences. This may help companies improve their product offerings, marketing strategies, and customer service.

In some implementations, the value chain process may include transportation routing. For instance, assume for example purposes only that VCN process 10 has used one or more AI-based learning models to determine that there is a potential to reduce transportation costs in the value chain network based upon received data. In the example, VCN process 10 may receive the external data to both determine that there is the potential to reduce transportation costs, and determine how to do so. As an example, VCN process 10 may include or interact with a transportation application that may automatically calculate the fastest or most optimal route and transportation method (e.g., air, boat, truck, etc.) based on external data (e.g., gas prices, traffic data, transportation time, sales forecasts, warehouse data, etc.) for past behavior over time, historical data, and/or current data. This may allow a precise view of when to ship orders, what mode of transportation to do so, and the optimal route. In some implementations, the external data may be received and analyzed in real-time or near real-time, enabling rapid time-to-value by collaborating globally with carriers to reduce transportation costs. In some implementations, VCN process 10 may resolve this situation by automatically executing (without human interaction) a change in transportation logistics (e.g., shipping time/date, shipping mode, shipping route, etc.), or providing a suggestion on a user interface to change the transportation logistics, which may be manually executed (e.g., receiving a user input to approve the suggested action).

In some implementations, the value chain process may include inventory management. For example, as discussed throughout, a supply chain or inventory management application (e.g., via VCN process 10) in the value chain management platform 604, such as one for ordering replacement parts for a machine or item of equipment, may access the same data set about what parts have been replaced for a set of machines as a predictive maintenance application that is used to predict whether a component of a ship, or facility of a port is likely to require replacement parts. Similarly, prediction may be used with respect to resupply of items.

In some implementations, the value chain process may include supplier selection. For instance, as discussed throughout, VCN process 10's AI-based learning models may be used to select the optimal supplier. Example data points that may be used for determining what makes a supplier optimal may include, e.g., Reliability-ability to consistently meet delivery schedules and fulfill orders as requested; On-time delivery rate, order fulfillment rate, number of backorders, number of late deliveries, customer satisfaction surveys; Quality-providing products and services that meet or exceed required standards; Number of product defects, number of customer returns and complaints, product inspection results, quality certifications and awards; Cost-effectiveness-offering competitive prices; Price of goods and services, volume discounts, payment terms, hidden costs shipping/handling fees, etc.); Scalability-ability to meet increased or decreased demands as necessary; Production capacity, ability to quickly add or remove resources, track record of meeting increased or decreased demand; Location-located near the purchaser or end consumer to minimize transportation costs and lead times; Distance from the purchaser or end consumer; Transportation costs; Lead times; Financial Stability—is in good financial standing and is not likely to be at risk of bankruptcy; Credit rating; Debt-to-equity ratio; Net income; Innovative-continuously offering improvements to existing solutions and develops new products that offer operational advantages; Number of new products or services developed (e.g., in the past year); Number of patents; Customer satisfaction surveys with respect to product innovation, etc.

In some implementations, the value chain process may include warehouse management. For instance, as discussed throughout, VCN process 10's AI-based learning models may be used for warehouse management.

### ML to Instruct Smart Machines for a Value Chain Network

As also discussed throughout and referring also at least to the example implementations of FIGS. 161-173, a VCN process, such as VCN process 10, may receive 18300, by a computing device, information associated with a value chain network. For instance, as similarly discussed throughout, a unified database (e.g., via platform 604) may (e.g., via VCN process 10) receive information associated with a set of value chain network entities (such as those discussed throughout) of a value chain network, as well as a value chain network itself. The information may be collected in a variety of ways, including (by example only) via the unified data collections systems discussed throughout.

In some implementations, the information may be generated by a set of sensors of the set of value chain network entities. For instance, in some implementations, the information generated by a set of IoT devices configured to collect data relating to the set of value chain network entities. As an example, unified IoT monitoring systems (such as those discussed regarding at least the example implementation of FIG. 33) may be used to generate information from a set of IoT devices. As another example, a set of APIs configured to publish data relating to the set of value chain network entities or a particular item (e.g., an engine part) may include those discussed regarding the adaptive intelligent systems and monitoring layers of platform 604. In some implementations, the information may include one or more of historical sales data and market trends associated with the item. As yet another example, some example sensors may be configured to publish data relating to the set of value chain network entities may include those discussed regarding the adaptive intelligent systems and monitoring layers of platform 604. As discussed in greater detail throughout, some example sensors associated with a particular item may also be able to monitor and gather information associated with that item. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18302 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network. For instance, in embodiments, one or more intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, at least one member of the set of AI-based learning models may be trained on the training data set to determine, upon receiving the classification, a task to be completed for the value chain network. For instance, in some embodiments, VCN process 10 may provide automated recommendations for a set of one or more value chain process tasks involving a wide range of types of activities, such as, without limitation, product configuration activities, product selection activities for a customer, supplier selection activities, shipper selection activities, route selection activities, factory selection activities, product assortment activities, product management activities, logistics activities, reverse logistics activities, artificial intelligence configuration activities, maintenance activities, product support activities, product recommendation activities, demand prediction, defect and quality issue detection, item failure prediction, optimization identification and execution, and many others such as those discussed throughout. For example, in some implementations, executing the task may include predicting future demand for an item in the value chain network. For instance, as discussed throughout, VCN process 10's AI-based learning models may be used to analyze historical sales data, market trends, and other factors to predict future demand for products (such as the engine part). This may help companies optimize inventory levels, production schedules, and pricing strategies to meet customer demand and maximize revenue.

In some implementations, VCN process 10 may provide 18304 a computer code instruction set to a (e.g., a smart) machine to execute the task to facilitate an improvement in the operation of the value chain network. A smart machine may generally be described as a device embedded with machine-to-machine (M2M) and/or cognitive computing technologies, such as AI, AI-based learning or deep learning, etc. all of which it may use to reason, problem-solve, make decisions and take action. For instance, the smart machine may include one or more of a robot, an automated guided vehicle (AGV), a smart container, a 3D printer, or a drone. As an example, machines (e.g., smart machines that may include at least a portion of VCN process 10) such as robots, AGVs, smart containers, 3D printers, and drones may be provided with computer code instructions to move materials and products throughout the supply chain. As another example, smart shop floor equipment may include fixed automations or robots on an assembly line to perform repetitive actions to speed up production. As another example, smart robots may be used for other repetitive tasks such as welding and painting, while also being more efficient and precise. Smart machines may be enabled to read barcodes or RFID tags to update inventory records, pick items up from storage and package them for shipping without human intervention, or use a self-driving vehicle to transport goods within a warehouse or distribution center, extract order information from emails or electronic documents and enter them into a processing system of VCN process 10, check invoices for accuracy and process payments, monitor inventory levels and trigger reorder requests when a threshold inventory level is reached, deliver (small) packages directly to customers, or perform inventory checks in a large warehouse or outdoor storage area, as well as any of the other tasks described throughout. Smart machines may also use the information to assign delivery drivers to specific routes to assist with last-mile delivery, scan goods and automatically send manifests to warehouses before delivery, and send delay alerts by, e.g., tracking the GPS location of vehicles, although other tracking methods may also be used (e.g., cell tower triangulation). As another example, VCN process 10 may include a Computer-Aided Design (CAD) software to help designers create product designs and prototypes more quickly and accurately. These may help companies reduce labor costs, improve safety, and increase efficiency. It will be appreciated that while examples are described as a “smart” machine, this should not be taken to exclude similar types of machines that may also be used without departing from the scope of the present disclosure.

In some implementations, providing the computer code instruction set to the smart machine to execute the task may include instructing 18308 the smart machine to detect defects and quality issues in an item in the value chain network. For instance, as discussed throughout, VCN process 10's AI-based learning models may be used to detect defects and quality issues in an item. For instance, assume for example purposes only that the above-noted information includes a video and/or a photo associated with the item (as well as other data). In the example, the video/photo of the actual item may be analyzed by VCN process 10 to identify any imperfections in the item itself. An example imperfection may include an anomaly in the shape of the item, such as a crack or warped portion of the item. This may help companies identify and address quality issues early in the production process (or even in use), reducing waste and improving customer satisfaction. The information may include data from one or more sensors associated with the item to predict when the item in the value chain network will fail. For instance, a temperature sensor, magnetic sensor, pressure monitoring sensor, vibration monitoring sensor, heat flow monitoring sensor, or any other type of sensor is contemplated, which may also be used by a digital twin (or otherwise) to help detect defects and quality issues in an item.

In some implementations, providing the computer code instruction set to the smart machine to execute the task may include instructing 18310 the smart machine to predict when an item in the value chain network will fail. For instance, as discussed throughout, VCN process 10's AI-based learning models may be used to predict when equipment is likely to fail. Information used to make the prediction may come from, e.g., smart machines equipped with sensors and other monitoring devices to predict when equipment is likely to fail or predict when to perform maintenance. For instance, rather than performing maintenance at a predetermined interval, maintenance can be performed as-needed based upon VCN process 10's determination. Thus, in this example, maintenance staff (or other user) may use VCN process 10's AI-based learning models to understand performance signals from smart devices and improve predictive maintenance. This may help companies schedule maintenance proactively, reducing downtime and maintenance costs. As an example, the above-noted platform 604 may (e.g., via VCN process 10) include the ability of performing condition monitoring, anomaly detection, failure forecasting and predictive maintenance of an item/equipment. Some examples of questions that the predictive model may answer may include, e.g., when will the item fail, what type of failure it will be, what is the probability that a failure will occur within the next X hours or other given time window, what is the remaining useful life of the item, is the item behaving in an uncharacteristic manner, which item requires maintenance most urgently and the like. In some implementations, the information associated with the predictions may be received by a digital twin.

In some implementations, providing the computer code instruction set to the smart machine to execute the task may include instructing 18312 the smart machine to identify a value chain process capable of optimization based upon, at least in part, analyzing the information associated with the value chain network, and optimize the value chain process. For instance, as discussed throughout, VCN process 10's AI-based learning models may be used to optimize supply chain processes/tasks, such as transportation routing and management, inventory management, supplier selection, scheduling production, tracking production costs, packing and shipping goods, tracking delivery status, identifying suppliers, negotiating contracts, configuring a smart contract, ordering goods and services, and receiving and inspecting goods and services. Information may be analyzed from various sources, such as inventory levels, transportation schedules, and supplier performance, to optimize supply chain operations. Other types of optimizations may include configuring and/or deploying robotic fleets, container fleets, additive manufacturing/3D printer fleets, loading/unloading containers, etc. Thus, in the examples, automated reports for management generated by VCN process 10 based upon the information may provide greater visibility and help teams course correct when issues arise. This may help companies reduce costs, improve efficiency, and increase flexibility in their supply chain operations.

In some implementations, executing the task may include analyzing user data of a user from at least one source, and identifying one or more attributes of the user based upon, at least in part, the user data. For instance, as discussed throughout, VCN process 10's AI-based learning models may be used to analyze customer data, such as purchase history, social media activity, and demographic information, to gain insights into attributes such as customer behavior and preferences. This may help companies improve their product offerings, marketing strategies, and customer service.

In some implementations, the value chain process may include transportation routing. For instance, assume for example purposes only that VCN process 10 has used one or more AI-based learning models to determine that there is a potential to reduce transportation costs in the value chain network based upon received data. In the example, VCN process 10 may receive the external data to both determine that there is the potential to reduce transportation costs, and determine how to do so. As an example, VCN process 10 may include or interact with a transportation application that may automatically calculate the fastest or most optimal route and transportation method (e.g., air, boat, truck, etc.) based on external data (e.g., gas prices, traffic data, transportation time, sales forecasts, warehouse data, etc.) for past behavior over time, historical data, and/or current data. This may allow a precise view of when to ship orders, what mode of transportation to do so, and the optimal route. In some implementations, the external data may be received and analyzed in real-time or near real-time, enabling rapid time-to-value by collaborating globally with carriers to reduce transportation costs. In some implementations, VCN process 10 may resolve this situation by automatically executing (without human interaction) a change in transportation logistics (e.g., shipping time/date, shipping mode, shipping route, etc.), or providing a suggestion on a user interface to change the transportation logistics, which may be manually executed (e.g., receiving a user input to approve the suggested action).

In some implementations, the value chain process may include inventory management. For example, as discussed throughout, a supply chain or inventory management application (e.g., via VCN process 10) in the value chain management platform 604, such as one for ordering replacement parts for a machine or item of equipment, may access the same data set about what parts have been replaced for a set of machines as a predictive maintenance application that is used to predict whether a component of a ship, or facility of a port is likely to require replacement parts. Similarly, prediction may be used with respect to resupply of items.

In some implementations, the value chain process may include supplier selection. For instance, as discussed throughout, VCN process 10's AI-based learning models may be used to select the optimal supplier.

In some implementations, the value chain process may include warehouse management. For instance, as discussed throughout, VCN process 10's AI-based learning models may be used for warehouse management.

In some implementations, providing the computer code instruction set to the smart machine to execute the task may include instructing 18306 the smart machine to move an item throughout the value chain network. For example, computer code instructions for smart machines (such as automated storage and retrieval systems (AS/RS) and warehouse management systems (WMS)) may (e.g., via VCN process 10) be used to optimize warehouse operations. This may help companies reduce labor costs, improve inventory management, and increase efficiency. As an example, smart machines (e.g., via VCN process 10) may be enabled to read barcodes or RFID tags to update inventory records, pick items up from storage and package them for shipping without human intervention, or use a self-driving vehicle to transport goods within a warehouse or distribution center, extract order information from emails or electronic documents and enter them into a processing system of VCN process 10, check invoices for accuracy and process payments, monitor inventory levels and trigger reorder requests when a threshold inventory level is reached, deliver (small) packages directly to customers, or perform inventory checks in a large warehouse or outdoor storage area, as well as any of the other tasks described throughout. As another example, intermodal smart containers may be used to transport items across the world. As another example, in warehouses and factories, robots may be used to pick and place items, palletize and de-palletize items, and transport items between different areas of the facility. As another example, in distribution centers, robots may be used to sort and pack items, and to load and unload trucks. As another example, in ports and rail terminals, robots may be used to load and unload ships and trains. As another example, in delivery fleets, robots may be used to deliver goods to customers' homes and businesses.

In some implementations, providing the computer code instruction set to the smart machine to execute the task may include instructing 18314 the smart machine to transport the item between locations. For instance, computer code instructions for smart machines (such as autonomous trucks, ships, drones, aircraft, etc.) may be used to transport goods between locations (e.g., warehouses, distribution facilities, to a customer, etc.) without the need for human drivers or operators. This may help companies reduce labor costs, improve safety, and increase efficiency.

It will be appreciated after reading the present disclosure that smart machines, rather than people, make more and more decisions about what to buy, and at what price, and complete the transactions without a middleman (which may be in conjunction with a blockchain distributed ledger.) For instance, a smart machine may be responsible for molding a specific engine component constantly monitors the wear and tear of its molding dies and predicts their lifecycle. As a die approaches the end of its lifespan, the machine's AI component (e.g., via VCN process 10) may scan one or more marketplaces for replacements. VCN process 10 may evaluate suppliers based on price, lead time, quality certifications, and past performance and identifies an optimal supplier. The machine (e.g., via VCN process 10) may then initiate a smart contract for procurement of the replacement molding dies. The terms of purchase, which may include but are not limited to the price of replacements, expected delivery date, or quality specifications, may be encoded on a blockchain distributed ledger by VCN process 10. When the terms of the smart contract are met, payment may be automatically triggered by VCN process 10 causing a release of funds from the machine or factory's digital wallet to the supplier's account in the form of tokenized currency or cryptocurrency. All transaction details may be recorded on the blockchain distributed ledger by VCN process 10.

### Robotic Process Automation

As also discussed throughout and referring also at least to the example implementations of FIGS. 161-173, a VCN process, such as VCN process 10, may receive 18400, by a computing device, information associated with a value chain network, For instance, as similarly discussed throughout, a unified database (e.g., via platform 604) may (e.g., via VCN process 10) receive information associated with a set of value chain network entities (such as those discussed throughout) of a value chain network, as well as a value chain network itself. The information may be collected in a variety of ways, including (by example only) via the unified data collections systems discussed throughout.

In some implementations, the information may be generated by a set of sensors of the set of value chain network entities. For instance, in some implementations, the information generated by a set of IoT devices configured to collect data relating to the set of value chain network entities. As an example, unified IoT monitoring systems (such as those discussed regarding at least the example implementation of FIG. 33) may be used to generate information from a set of IoT devices. As another example, a set of APIs configured to publish data relating to the set of value chain network entities or a particular item (e.g., an engine part) may include those discussed regarding the adaptive intelligent systems and monitoring layers of platform 604. In some implementations, the information may include one or more of historical sales data and market trends associated with the item. As yet another example, some example sensors may be configured to publish data relating to the set of value chain network entities may include those discussed regarding the adaptive intelligent systems and monitoring layers of platform 604. As discussed in greater detail throughout, some example sensors associated with a particular item may also be able to monitor and gather information associated with that item. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18402 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network. For instance, in embodiments, one or more intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, at least one member of the set of AI-based learning models may be trained on the training data set to determine, upon receiving the classification, a task to be completed for the value chain network. For instance, in some embodiments, VCN process 10 may provide automated recommendations for a set of one or more value chain process tasks involving a wide range of types of activities, such as, without limitation, product configuration activities, product selection activities for a customer, supplier selection activities, shipper selection activities, route selection activities, factory selection activities, product assortment activities, product management activities, logistics activities, reverse logistics activities, artificial intelligence configuration activities, maintenance activities, product support activities, product recommendation activities, demand prediction, defect and quality issue detection, item failure prediction, optimization identification and execution, and many others such as those discussed throughout. For example, in some implementations, executing the task may include predicting future demand for an item in the value chain network. For instance, as discussed throughout, VCN process 10's AI-based learning models may be used to analyze historical sales data, market trends, and other factors to predict future demand for products (such as the engine part). This may help companies optimize inventory levels, production schedules, and pricing strategies to meet customer demand and maximize revenue.

In some implementations, VCN process 10 may (e.g., via a robotic process automation (RPA) system) configure 18404 the robotic process automation system to execute the task to facilitate an improvement in the value chain network. For instance, in some implementations, the task may include automatically processing 18406 one or more orders for an item in the value chain network based upon, at least in part, the information, wherein automatically processing the one or more orders for the item in the value chain network may include extracting 18408 order data of the one or more orders from one or more sources and automatically inputting 18410 the order data extracted from the one or more sources into an order management system. For instance, a robotic process automation system (e.g., via VCN process 10) may be enabled to access communications such as emails, text, spreadsheets, Pdfs, other documents, etc. or directly communicate via an order management system (or the like) and use, e.g., natural language processing (NLP) to determine that a communication (e.g., from a customer, supplier, other stakeholder in the VCN) is an order (e.g., a purchase order) for an item in the VCN. Upon such a determination, the robotic process automation system (e.g., via VCN process 10) may extract order information from emails or other electronic documents and enter the associated data into an order management system of VCN process 10, as well as check invoices for accuracy and process payments.

In some implementations, the task may include monitoring 18412 an inventory level for an item in the value chain network and automatically generating 18414 one or more purchase orders for the item when the inventory level for the item in the value chain network falls below a threshold. For instance, assume for example purposes only that the robotic process automation system (e.g., via VCN process 10) updates inventory records based upon, e.g., reading barcodes or RFID tags and uses this and/or the above-noted information to monitor inventory levels to determine that only a threshold number of items is available in the inventory. As a result, this may automatically trigger VCN process 10 to execute reorder requests from a supplier to obtain more of that item. In some implementations, the demand sensing aspects of VCN process 10 may be used to dynamically adjust the threshold based upon changing information.

In some implementations, VCN process 10 may track 18416 a shipment of the item in real-time and the inventory level for the item in the value chain network may be automatically updated 18418 based upon, at least in part, tracking the shipment of the item in real-time. For instance, a robotic process automation system (e.g., via VCN process 10) may be enabled to track shipments in real-time using any known tracking techniques (e.g., GPS) and may automatically update an associated company's inventory and order management systems with the latest information. This may help the company quickly identify any delays or issues with shipments and take corrective action (e.g., such as recommending or automatically placing an alternative order from a different supplier).

In some implementations, the task may include VCN process 10 extracting 18420 invoice data of the one or more invoices from one or more sources and automatically inputting 18422 the invoice data extracted from the one or more sources into an accounting system. For instance, a robotic process automation system (e.g., via VCN process 10) may be enabled to access communications such as emails, text, spreadsheets, Pdfs, other documents, etc. or directly communicate via an accounting management system (or the like) and use, e.g., natural language processing (NLP) to determine that a communication (e.g., to a customer, supplier, other stakeholder in the VCN) is an invoice for an item in the VCN. Upon such a determination, the robotic process automation system (e.g., via VCN process 10) may extract the invoice information from the emails or other electronic documents and enter the associated data into an accounting management system of VCN process 10, as well as check invoices for accuracy and process payments. This may help streamline the invoicing process and reduce errors.

Similarly, a robotic process automation system (e.g., via VCN process 10) may be used for after-sales service as well. For instance, reading data from service request documents, coordinating with other systems to capture and maintain service ticket data, so that if a customer needs to make a return or request a repair, VCN process 10 may use one or more of the UIs discussed throughout to improve visibility on location, time of arrival and duration to complete work, track orders in real-time and send acknowledgement emails to customers automatically.

In some implementations, VCN process 10 may render 18424 a user interface enabling a user to visually design automation workflows. For instance, VCN process 10 may render a UI (e.g., the control tower UI discussed throughout) that enables a user to visually design automation workflows. In some implementations, this UI may be an integrated development environment that allows users to create automation processes using a drag-and-drop interface, and may include a library of pre-built activities that may be used to automate tasks. In some implementations, the UI of VCN process 10 may integrate with value chain data sources, such as ERP systems and transportation management systems. This may allow users to access the data they need to design and optimize their value chains. In some implementations, the UI may provide users with value chain analytics tools that can help users to identify areas where their value chains can be improved. In some implementations, the UI may provide users with value chain modeling tools for simulating different scenarios and to identify the best way to design their value chains. In some implementations, the UI may provide users with value chain collaboration tools that can help users to collaborate with their suppliers and customers. In some implementations, the UI may allow users to test their workflows before they implement them. Users may be able to step through their workflows and see how the different elements interact with each other. In some implementations, the UI may help users identify and correct any errors in their workflows. In some implementations, the UI may include pre-built templates that may provide users with a starting point for designing their workflows. In some implementations, the UI may enable users to modify these templates to meet their specific needs. In some implementations, the UI may include version controls, collaboration tools, and enable integrations with other systems that may allow users to automate tasks that are performed in those systems.

In some implementations, VCN process 10 may render 18426 a user interface enabling a user to manage automation processes. For instance, VCN process 10 may render a UI (e.g., the control tower UI discussed throughout) that enables a user to deploy, manage, and monitor automation processes from a central location. It may provide a dashboard for real-time monitoring of automation performance, as well as tools for managing user access, scheduling, and logging. In some implementations, the UI may be a web-based management platform. In some implementations, the UI may provide users with visibility into the entire value chain workflow and see the status of all tasks, orders, and shipments in real time. In some implementations, the UI may provide real-time updates on the status of their value chains, which may allow users to identify and respond to problems quickly. In some implementations, the UI may be able to send alerts and notifications to users when there are problems or changes in the value chain. In some implementations, the UI may provide users with collaboration tools that allow them to work with their suppliers and customers to manage the value chain. In some implementations, the UI may provide users with reporting and analytics tools that allow them to track the performance of their value chains and to identify areas where improvements can be made.

In some implementations, VCN process 10 may render 18428 a user interface enabling a user to create a plurality of AI-based learning models and select a plurality of application programming interfaces to integrate the plurality of AI models into one or more automation workflows. For instance, VCN process 10 may render a UI (e.g., the control tower UI discussed throughout) that enables a user to build, train, and deploy custom machine learning models within their automation workflows. It may provide an interface for creating and managing AI-based learning models (e.g., machine learning models), as well as a set of APIs that may be used to integrate the models into automation workflows.

In some implementations, VCN process 10 may render 18430 a user interface enabling a user to track automation performance and generate custom dashboards based upon, at least in part, the automation performance. For instance, VCN process 10 may render a UI (e.g., the control tower UI discussed throughout) that provides analytics and reporting capabilities for automation processes. It may allow users to track automation performance, identify bottlenecks and opportunities for optimization, and generate custom reports and dashboards.

In some implementations, VCN process 10 may render a UI (e.g., the control tower UI discussed throughout) that enables users to capture and document the steps of manual processes, which may then be used to automate those processes as discussed throughout. It may provide a simple and intuitive interface for creating process documentation, and may include features for collaborating with team members and tracking progress. In some implementations, any of the UI's discussed throughout may be used with various supporting infrastructures, such as IoT, intelligent document processing, chatbots, mobile applications, blockchain, etc.

### ML-Driven Digital Twins for a Value Chain Network Control Tower

As will be discussed in greater detail below, as discussed throughout and referring also at least to the example implementations of FIGS. 161-173, a VCN process, such as VCN process 10, may receive 18500, by a value chain network digital twin, information associated with a value chain network, wherein the information may include a virtual representation of a plurality of associations between physical data items of the value chain network, and wherein the information may be dynamic, real-time and time-phased. Generally, time-phased may be described as the representation showing the associations between data items over time and that the information provided may be used to track the evolution of the value chain network over time. For example, simply put, a value chain network digital twin (which may include at least a portion of VCN process 10) may be a representation of the various associations between the data objects of the physical (and often multi-enterprise) supply chain, as a basis for local and end-to-end aligned decision making. Put another way, value chain network digital twins may represent a set of value chain network entities (such as those described throughout). The digital twins may be configured to simulate properties, states, operations, behaviors and other aspects of the value chain network entities. The digital twins may have a visual user interface, e.g., in the form of 3D models, or may consist of system specifications or ontologies describing the architecture, including components and their interfaces, of the value chain network entities. The digital twins may include configuration data or condition data of the value chain network entities, including data records of the past and current state of the value chain network entities, such as captured through sensors, through user input, and/or determined by outputs of AI-based models (e.g., AI-based behavioral models) that describe the behavior of the value chain network entities. The digital twins may be updated continuously or periodically with dynamic, real-time and time-phased data to reflect the current condition of the value chain network entities, based on sensor data, test and inspection results, conducted maintenance, modifications, etc. The digital twins may also be configured to communicate with a user via multiple communication channels, such as speech, text, gestures, and the like. For example, a digital twin may receive queries from a user about the value chain network entities, generate responses for the queries, and communicate such responses to the user. Additionally and/or alternatively, digital twins may communicate with one another to learn from and identify similar operating patterns and issues in other value chain network entities, as well as steps taken to resolve those issues. The digital twins may be used for monitoring, diagnostics, simulation, management, remote control, and prognostics, such as to optimize the individual and collective performance and utilization of value chain network entities.

In some implementations, the set of value chain network digital twins may include, for example and without limitation, distribution value chain network digital twins, warehousing value chain network digital twins, port infrastructure value chain network digital twins, shipping facility value chain network digital twins, operating facility value chain network digital twins, customer value chain network digital twins, worker value chain network digital twins, wearable device value chain network digital twins, portable device value chain network digital twins, mobile device value chain network digital twins, process value chain network digital twins, machine value chain network digital twins, asset value chain network digital twins, product value chain network digital twins, point of origin value chain network digital twins, point of destination value chain network digital twins, supply factor value chain network digital twins, maritime facility value chain network digital twins, floating asset value chain network digital twins, shipyard value chain network digital twins, fulfillment value chain network digital twins, delivery system value chain network digital twins, demand factors value chain network digital twins, retailer value chain network digital twins, ecommerce value chain network digital twins, online value chain network digital twins, waterway value chain network digital twins, roadway value chain network digital twins, roadway value chain network digital twins, railway value chain network digital twins, air facility value chain network digital twins, aircraft value chain network digital twins, ship value chain network digital twins, vehicle value chain network digital twins, train value chain network digital twins, autonomous vehicle value chain network digital twins, robotic system value chain network digital twins, drone value chain network digital twins, logistics factor value chain network digital twins and many others.

In some implementations, as similarly discussed throughout, a unified database (e.g., via platform 604) may (e.g., via VCN process 10) receive information associated with one or more value chain network digital twins that represent a set of digital twin value chain network entities (such as the example value chain network entities discussed throughout) of a value chain network, as well as a value chain network itself. The information may be collected in a variety of ways, including (by example only) via the unified data collections systems discussed throughout.

For instance, in some implementations, the information generated by a set of IoT devices configured to collect data relating to the value chain network digital twins. As an example, unified IoT monitoring systems (such as those discussed regarding at least the example implementation of FIG. 33) may be used to generate information from a set of IoT devices. As another example, a set of APIs configured to publish data relating to the value chain network digital twins or a particular item (e.g., an engine part) may include those discussed regarding the adaptive intelligent systems and monitoring layers of platform 604. In some implementations, the information may include one or more of historical sales data and market trends associated with the item. As yet another example, some example sensors may be configured to publish data relating to the value chain network digital twins may include those discussed regarding the adaptive intelligent systems and monitoring layers of platform 604. As discussed in greater detail throughout, some example sensors associated with a particular item may also be able to monitor and gather information associated with that item or value chain network entity. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In some implementations, VCN process 10 may provide 18502 the information to a set of Artificial Intelligence (AI)-based learning models, wherein at least one member of the set of AI-based learning models may be trained on a training data set of a set of value chain network entities operating data to classify at least one of: an operating state, a fault condition, an operating flow, or a behavior of the value chain network. For instance, in embodiments, one or more intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted disruption or risk in the value chain network, a prediction of future demand, and/or the like), a classification (e.g., a classification of an object in an image, a classification of a spoken utterance, a classified fault condition based on sensor data, and/or the like), and/or other suitable outputs of an AI system. For instance, assume for example purposes only that VCN process 10 has used one or more AI-based learning models to determine that there is a potential risk in the value chain network. In the example, VCN process 10 may mitigate the potential risk in the value chain network by using upstream data to predict demand for a product (e.g., demand enhancement/planning). As an example, VCN process 10 may include or interact with a demand planning application that may automatically calculate demand (demand sensing) and stock forecasts based on upstream data (e.g., sales forecasts, warehouse data, etc.). This may allow a precise view of when to place optimal orders that cover specific product demands.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the set of AI-based learning models may include one of a set of objects or events that are labeled to classify the set of objects or events according to a classification taxonomy that may include at least one of the above-noted operating state, the fault condition, the operating flow, or the behavior. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, VCN process 10 may include combinations where an expert system uses one neural network for classifying an item (e.g., identifying a machine, a component, or an operational mode) and a different (or the same) neural network for predicting a state of the item (e.g., a fault state, an operational state, an anticipated state, a maintenance state, or the like).

In some implementations, at least one member of the set of AI-based learning models may be trained on the training data set to determine, upon receiving the classification, a task to be completed for the value chain network. For instance, in some embodiments, VCN process 10 may provide automated recommendations for a set of one or more value chain process tasks involving a wide range of types of activities, such as, without limitation, product configuration activities, product selection activities for a customer, supplier selection activities, shipper selection activities, route selection activities, factory selection activities, product assortment activities, product management activities, logistics activities, reverse logistics activities, artificial intelligence configuration activities, maintenance activities, product support activities, product recommendation activities, demand prediction, defect and quality issue detection, item failure prediction, optimization identification and execution, and many others such as those discussed throughout. For example, in some implementations, executing the task may include predicting future demand for an item in the value chain network. For instance, as discussed throughout, VCN process 10's AI-based learning models may be used to analyze historical sales data, market trends, and other factors to predict future demand for products (such as the engine part). This may help companies optimize inventory levels, production schedules, and pricing strategies to meet customer demand and maximize revenue.

In some implementations, VCN process 10 may provide 18504 at least one of an instruction for executing the task in the value chain network digital twin or provide 18506 a recommendation for executing the task in the value chain network digital twin may be provided. For instance, once a task has been determined, VCN process 10 may provide instructions to execute that task. In some implementations, the task may be automatically executed without human interaction, or manually executed (e.g., approving an action to execute the task as suggested by VCN process 10 that was output via a UI, such as the control tower UI discussed throughout). In some implementations, the task executed may be recorded in a log or a feed for viewing. In some implementations, the task may be VCN process 10 suggesting diversifying suppliers in the value chain network digital twin, which means having multiple suppliers for the same product or service. This may help to reduce the risk of a disruption from one supplier affecting the entire supply chain. Another example suggested task from VCN process 10 may be building inventory buffers in the value chain network digital twin, which means having more inventory than is normally needed. This may help to ensure that there are enough products available to meet demand even if there is a disruption or other issues. Another example suggested task from VCN process 10 may be identifying suppliers in the value chain network digital twin that use alternative transportation methods, which means using different modes of transportation, such as air freight or rail, if there are disruptions to road or sea transportation. Another example suggested task from VCN process 10 may be renegotiating contracts in the value chain network digital twin, which means negotiating with suppliers to change the terms of contracts, such as delivery dates or pricing, if there are disruptions or other risks. Another example suggested task from VCN process 10 may be using technology in the value chain network digital twin, meaning the use of technology to track shipments, manage inventory, and communicate with suppliers about a potential risk, which may be similarly determined as discussed throughout. This may help to improve visibility and coordination in the supply chain and make it easier to respond to disruptions or other risks. Another example suggested task from VCN process 10 may be using predictive sourcing in the AI-driven digital twin (e.g., the value chain network digital twin as discussed throughout), where the response may involve, e.g., placing an order in an embedded marketplace of the value chain network digital twin.

As another example, using the above-noted synchronized planning of VCN process 10, a company may be enabled to automate the planning process and create an improved inventory mix over a widespread network (as noted throughout). In some implementations, VCN process 10 may use its AI and cluster analysis in the value chain network digital twin, helping to identify and track seasonality patterns and trends not easily uncovered via traditional methods.

In some implementations, receiving the information associated with the value chain network may include receiving 18508 sensor data indicative of inbound and outbound shipment conditions. For instance, the value chain network digital twin may (e.g., via VCN process 10) receive information from various sources to monitor inbound/outbound shipping conditions such as temperature, condition, pressure, location, estimated time of arrival, moisture levels, power levels of any equipment used, as well as any of the other example conditions discussed throughout. As an example, the value chain network digital twin may (e.g., via VCN process 10) may monitor the condition of the truckload shipments to prevent costly spoilage and ensure the perishable products remain safe and compliant. In some implementations, this information may also be supplied (e.g., via a UI) to the driver of the vehicle, so that the driver may take any actions to mitigate any issues (e.g., failure of a refrigerator unit carrying supplies).

In some implementations, VCN process 10 may render 18510 one of a virtual reality (VR) environment, an augmented reality (AR) environment, a mixed reality (MR) environment, or a diminished reality (DR) environment for a user to interact with the sensor-based virtual representation of the plurality of associations between the physical data items of the value chain network. For instance, VCN process 10 may enable users to access the value chain network entity digital twin using VR, AR, MR, and DR. This may enable users (including customers and employees) to perceive the virtual world through an advanced experience. For instance, AR may be used to provide users with real-time information about the products they are working on. For example, users may use AR glasses to see product schematics or assembly instructions overlaid onto the physical product, reducing the need for printed instructions, and improving accuracy. In other examples, users may use an AR overlay that could be used to show information related to a smart container (e.g., financial metrics related to the contents of the smart container, destination information, temperature information, and the like), status information for a fleet of 3D printers, or performance information associated with a robot. As another example, users may use VR to simulate complex manufacturing or assembly processes, allowing users to practice and train in a virtual environment before working on the actual product. This may reduce errors, improve safety, and increase efficiency. In other examples, users may use VR to inspect items in a smart container, inspect a 3D printing process, or visualize a fleet of robots executing a job. As another example, extended reality (XR) also known as mixed reality (MR) may be used to combine elements of both AR and VR to create a mixed reality environment for users of the value chain network entity digital twin. This may be used to provide users with a more immersive and interactive training experience, allowing them to practice complex tasks in a simulated environment. In another example, MR could be used to create virtual simulations of entities in value chain networks (e.g., simulations of product usage, simulations of robotic fleet job execution, simulations of item moving through a factory, and the like). As another example, MR visualizations could be used to overlay inventory levels onto warehouse shelves. Yet another example, DR may be used to remove distracting elements from a user's field of view, allowing them to focus on the task at hand. For example, a worker may use DR glasses to remove clutter from their workspace, making it easier to focus on the assembly process. In another example, DR may be used to visualize a warehouse in a way that removes everything but warehouse robots, making it easier to focus on the movement of the robots.

In some implementations, the information may include real-time data about one of inbound prepaid shipments from suppliers linked to orders or inventory coming into a network associated with the value chain network. For instance, the value chain network entity (e.g., via VCN process 10) may receive sufficient information to provide visibility of inbound and outbound shipments. For example, VCN process 10 may receive real-time information about inbound prepaid shipments from suppliers linked to orders and inventory coming into the network. For instance, the value chain network digital twin may (e.g., via VCN process 10) receive information from various sources to monitor inbound/outbound shipping conditions such as temperature, condition, pressure, location, estimated time of arrival, moisture levels, power levels of any equipment used, as well as any of the other example conditions discussed throughout. As an example, the value chain network digital twin may (e.g., via VCN process 10) may monitor the condition of the truckload shipments to prevent costly spoilage and ensure the perishable products remain safe and compliant. In some implementations, this information may also be supplied (e.g., via a UI) to the driver of the vehicle, so that the driver may take any actions to mitigate any issues (e.g., failure of a refrigerator unit carrying supplies). As such, shippers may better manage inventory levels and carrying costs while breaking down internal silos between transportation and demand chain departments.

In some implementations, VCN process 10 may generate 18512 simulations for the value chain network digital twin, wherein the simulations for the value chain network digital twin may be generated with a graphical neural network (GNN). For instance, as will be discussed in greater detail below, VCN process 10 may use a neural network (e.g., a set GNNs) for generating simulations for value chain network digital twins and/or optimizing interactions in value chain network digital twins. For example, in some implementations, the value chain network digital twin may operate within a digital twin system having one or more sets of one or more digital twins, wherein each digital twin of the one or more sets may include an embedded marketplace for digital twin simulations. For instance, the digital twin system may be similar to the ones described throughout (e.g., at FIG. 52). VCN process 10 may be enabled as a simulation-as-a-service system. For instance, in the context of value chain network digital twin, simulation-as-a-service may generally refer to the practice of providing access to simulations (such as value chain network digital twin simulations) as a service, which may be integrated into different stages of the value chain. Value chain network digital twins may consist of a series of interconnected activities that create value for customers, and these activities may include everything from raw material sourcing and production to marketing and distribution. By providing access to AI-based simulations as a service, businesses may enhance their ability to optimize and automate these activities, improving efficiency, reducing costs, and ultimately delivering better products or services to customers.

For example, a company may provide access to a simulation that can predict demand for a particular product. This simulation may be integrated into the planning stage of the digital twin value chain, allowing the company to better anticipate customer demand and adjust production accordingly. Similarly, a simulation that analyzes customer data may be used in the marketing stage to better understand customer preferences and tailor marketing campaigns to specific customer segments. Overall, simulations-as-a-service may help businesses in value chain network digital twin to stay competitive by leveraging the power of AI-based simulations to optimize and automate their operations. In some implementations, each of the value chain network digital twins may include an AI marketplace for AI-based simulations, where users may browse, select, and download individual AI-based simulations for a fee and as needed.

In some implementations, the value chain network digital twin may operate within a digital twin system having one or more sets of one or more digital twins, wherein each digital twin of the one or more sets may include an embedded marketplace for one of artificial intelligence-based learning models or artificial intelligence-based algorithms. For instance, VCN process 10 may be enabled as a models-as-a-service system. For instance, in the context of value chain network digital twin, models-as-a-service may generally refer to the practice of providing access to machine learning/algorithms (or other type of AI-based learning/algorithm) models as a service, which may be integrated into different stages of the value chain. Value chain network digital twins may consist of a series of interconnected activities that create value for customers, and these activities may include everything from raw material sourcing and production to marketing and distribution. By providing access to AI-based learning/algorithm models as a service, businesses may enhance their ability to optimize and automate these activities, improving efficiency, reducing costs, and ultimately delivering better products or services to customers.

For example, a company may provide access to an AI-based learning model that can predict demand for a particular product. This model may be integrated into the planning stage of the digital twin value chain, allowing the company to better anticipate customer demand and adjust production accordingly. Similarly, a machine learning model that analyzes customer data may be used in the marketing stage to better understand customer preferences and tailor marketing campaigns to specific customer segments. Overall, models-as-a-service may help businesses in value chain network digital twin to stay competitive by leveraging the power of AI-based learning to optimize and automate their operations. In some implementations, each of the value chain network digital twins may include an AI marketplace for the AI-based learning models, where users may browse, select, and download individual AI-based learning models for a fee and as needed.

In some implementations, the value chain network digital twin may operate within a digital twin system having one or more sets of one or more digital twins, wherein each digital twin of the one or more sets may include an embedded marketplace for data. For instance, the digital twin system may be similar to the ones described throughout (e.g., at least the example implementation of FIG. 52). VCN process 10 may be enabled as a data-as-a-service system. For instance, in the context of value chain network digital twin, data-as-a-service may generally refer to the practice of providing access to data (such as value chain network digital twin data) as a service, which may be integrated into different stages of the value chain. Value chain network digital twins may consist of a series of interconnected activities that create value for customers, and these activities may include everything from raw material sourcing and production to marketing and distribution. By providing access to AI-based data as a service, businesses may enhance their ability to optimize and automate these activities, improving efficiency, reducing costs, and ultimately delivering better products or services to customers.

For example, a company may provide access to data that can predict demand for a particular product. This data may be integrated into the planning stage of the digital twin value chain (including the above-noted simulations/models/algorithms and vice versa), allowing the company to better anticipate customer demand and adjust production accordingly. Similarly, the digital twin value chain data that analyzes customer data may be used in the marketing stage to better understand customer preferences and tailor marketing campaigns to specific customer segments. Overall, data-as-a-service may help businesses in value chain network digital twin to stay competitive by leveraging the power of AI-based data (e.g., digital twin value chain AI-based training data) to optimize and automate their operations. In some implementations, each of the value chain network digital twins may include an AI marketplace for AI-based data, where users may browse, select, and download individual AI-based data for a fee (e.g., a one time and/or subscription fee) and as needed.

In some implementations, VCN process 10 may generate 18514 optimizations for the value chain network digital twin, wherein the simulations for the value chain network digital twin may be generated with a graphical neural network (GNN). For instance, assume for example purposes only that VCN process 10 has used one or more AI-based learning models of a value chain network digital twin to determine that there is a potential risk in the value chain network. In the example, VCN process 10 may mitigate the potential risk in the value chain network by using upstream data to optimize an inventory mix. For instance, assume for example purposes only that VCN process 10 has used one or more AI-based learning models of a value chain network digital twin to determine that there is a potential to optimize an omnichannel fulfillment in the value chain network based upon received data (e.g., warehouse management, inventory management, order management, and analytics). Generally, dynamic fulfillment considers the value of inventory according to the location where it is maintained. For example, if a store is in an overstock position anticipating mark-downs to move the excess, these items can be given priority for on-line orders. The net result is higher profit and customer satisfaction. Thus, in some implementations, VCN process 10 may provide a single platform that unifies warehouse management, inventory management, order management, analytics, and more for full network visibility, which may help optimize procurement processes and improve value chain efficiency.

In some implementations, a robotic operating system may enable the value chain network digital twin. For instance, in some implementations, the robotic operating system (e.g., which may include at least a portion of VCN process 10) may include automatically processing one or more orders for an item in the value chain network based upon, at least in part, the information, wherein automatically processing the one or more orders for the item in the value chain network may include extracting order data of the one or more orders from one or more sources and automatically inputting the order data extracted from the one or more sources into an order management system. For instance, a robotic process automation system of the value chain network digital twin (e.g., via VCN process 10) may be enabled to access communications such as emails, text, spreadsheets, Pdfs, other documents, etc. or directly communicate via an order management system (or the like) and use, e.g., natural language processing (NLP) to determine that a communication (e.g., from a customer, supplier, other stakeholder in the VCN) is an order (e.g., a purchase order) for an item in the VCN. Upon such a determination, the robotic process automation system of the value chain network digital twin (e.g., via VCN process 10) may extract order information from emails or other electronic documents and enter the associated data into an order management system of VCN process 10, as well as check invoices for accuracy and process payments.

In some implementations, the task may include monitoring an inventory level for an item in the value chain network and automatically generating one or more purchase orders for the item when the inventory level for the item in the value chain network falls below a threshold. For instance, assume for example purposes only that the robotic process automation system of the value chain network digital twin (e.g., via VCN process 10) updates inventory records based upon, e.g., reading barcodes or RFID tags and uses this and/or the above-noted information to monitor inventory levels to determine that only a threshold number of items is available in the inventory. As a result, this may automatically trigger VCN process 10 to execute reorder requests from a supplier to obtain more of that item. In some implementations, the demand sensing aspects of VCN process 10 may be used to dynamically adjust the threshold based upon changing information.

In some implementations, VCN process 10 may track a shipment of the item in real-time and the inventory level for the item in the value chain network may be automatically updated based upon, at least in part, tracking the shipment of the item in real-time. For instance, a robotic process automation system of the value chain network digital twin (e.g., via VCN process 10) may be enabled to track shipments in real-time using any known tracking techniques (e.g., GPS) and may automatically update an associated company's inventory and order management systems with the latest information. This may help the company quickly identify any delays or issues with shipments and take corrective action (e.g., such as recommending or automatically placing an alternative order from a different supplier).

In some implementations, the task may include VCN process 10 extracting invoice data of the one or more invoices from one or more sources and automatically inputting the invoice data extracted from the one or more sources into an accounting system. For instance, a robotic process automation system of the value chain network digital twin (e.g., via VCN process 10) may be enabled to access communications such as emails, text, spreadsheets, Pdfs, other documents, etc. or directly communicate via an accounting management system (or the like) and use, e.g., natural language processing (NLP) to determine that a communication (e.g., to a customer, supplier, other stakeholder in the VCN) is an invoice for an item in the VCN. Upon such a determination, the robotic process automation system of the value chain network digital twin (e.g., via VCN process 10) may extract the invoice information from the emails or other electronic documents and enter the associated data into an accounting management system of VCN process 10, as well as check invoices for accuracy and process payments. This may help streamline the invoicing process and reduce errors.

Similarly, a robotic process automation system of the value chain network digital twin (e.g., via VCN process 10) may be used for after-sales service as well. For instance, reading data from service request documents, coordinating with other systems to capture and maintain service ticket data, so that if a customer needs to make a return or request a repair, VCN process 10 may use one or more of the UIs discussed throughout to improve visibility on location, time of arrival and duration to complete work, track orders in real-time and send acknowledgement emails to customers automatically.

In some implementations, the value chain network digital twin (e.g., via VCN process 10) may include an edge computing system integrated with an edge data processing system (such as those discussed throughout). For instance, the combination of edge computing and edge data processing, delivered through networks of human resources, devices, smart machines, sensors and computing systems may allow people to make informed, reliable, secure and agile decisions at the edges of enterprises. Moreover, the edge computing system and/or the edge data processing of VCN process 10 may find and supply new sources of data, where resources at the edge computing system may be looking for applications that may make use of such data.

In some implementations, the value chain network digital twin (e.g., via VCN process 10) may include a supply chain security system. For instance, VCN process 10 may the enforcement of security spanning physical levels (e.g., devices, machines, products, operations infrastructure and assets) as well as information and digital data (e.g., customer information, intellectual property, proprietary coding, transactions and personal data).

In some implementations, the value chain network digital twin (e.g., via VCN process 10) may include a communications system. For instance, as noted above, the value chain network digital twin (e.g., via VCN process 10) may share data across partners without complex integrations into each organization's environment by using the APIs as discussed above.

In some implementations, the value chain network digital twin (e.g., via VCN process 10) may include a yard management system. For instance, yard management may generally be described as autonomous, and may include enterprise slot booking, predictive ETA, prescriptive analytics, real-time location tracking, gate and loading dock management, task management, driver management and more. Yard management is thus the process of managing the movement of trucks and trailers (or other transportation methods) in and out of a facility or yard. In a supply/demand chain context, this may refer to the management of the area where goods are stored, sorted, and loaded onto transportation vehicles for transportation to their next destination. For instance, there may be a check-in process, where, as trucks arrive at the yard, they might be checked in and assigned to a specific location for unloading or loading. This is typically done through a gate management system that verifies the truck's information, including the driver's name, the carrier, the cargo, and any special requirements As another example, for yard planning, once the trucks are checked in, the yard manager might plan the optimal layout of the yard to ensure efficient use of space and timely delivery of goods. This may involve identifying the optimal location for each truck, based on factors such as cargo type, weight, destination, and required handling equipment. As another example, equipment allocation may be used by the yard manager to ensure that the required handling of equipment, such as forklifts or cranes, are available and allocated to the appropriate trucks. This may help to ensure that loading and unloading can be completed quickly and efficiently. For yard execution, as trucks are assigned to their respective locations, yard personnel might monitor the progress of loading and unloading, and make any necessary adjustments to ensure that the process stays on track. This may involve coordinating with drivers and warehouse staff to resolve any issues that may arise. For the check-out process, once the loading or unloading is complete, the truck may be checked out of the yard, and the gate management system (e.g., via VCN process 10) may update the status of the shipment to reflect its departure. This may allow the next truck to be assigned to the appropriate location and continue the yard management process. In some implementations, IoT enabled tracking and monitoring (sensors and devices) may provide real-time tracking and monitoring of truck movements, cargo location, equipment status, etc. This may help yard managers optimize truck movements, allocate resources effectively, and reduce waiting times.

In some implementations, yard management may include VCN process 10 using predictive analytics (such as those discussed throughout), where advanced analytics are used to predict the arrival and departure of trucks, and to identify potential bottlenecks and issues. This may help yard managers plan more effectively and make proactive adjustments to minimize delays. In some implementations, robotics and automation (e.g., autonomous vehicles, drones, and other robotics) may help streamline yard operations and reduce the need for manual labor. For example, autonomous forklifts may move cargo from one location to another, while drones may be used to monitor yard operations from above.

In some implementations, the value chain network digital twin (e.g., via VCN process 10) may include blockchain-based supply chain visibility, where the use of blockchain technology may provide end-to-end visibility of the supply/demand chain, enabling yard managers to track shipments from origin to destination. This may help to improve transparency, reduce errors, and enhance security.

In some implementations, the value chain network digital twin (e.g., via VCN process 10) may include the above-noted VR, AR, MR, and DR technologies to enhance training and simulation, enabling yard personnel to learn and practice complex tasks in a safe and controlled environment. This may help to reduce errors and improve overall efficiency. In some implementations, the value chain network digital twin (e.g., via VCN process 10) may use the above-noted AI-based learning models/algorithms to optimize yard operations, predict the most efficient routes and resource allocation. This may help to reduce costs and improve overall performance.

It will be appreciated after reading the present disclosure that a value chain network digital twin may be combined for use with any of the implementations/embodiments described throughout. As such, the lack of discussion of a value chain network digital twin should not be taken as precluding the use of the value chain network digital twin.

### Generative AI

In example embodiments, a generative artificial intelligence engine (GAIE) may be combined with a machine learning system in a transaction environment. Input to the GAIE may include images, video, audio, text, programmatic code, data, and the like. Outputs from a GAIE may include structured and organized prose, images, video, audio content, software/programming source code, formatted data (e.g., arrays), algorithms, definitions, context-specific structures (e.g., smart contacts, transaction platform configuration data sets, and the like), machine language-based data (e.g., API-formatted content), and the like. For GAIE instances in which the models are designed to process text data, the GAIE may interface to other programmatic systems (such as traditional machine learning engines) to process other forms of data into text data. In example embodiments, the other programmatic systems, including systems executing machine learning algorithms, may produce textual based (optionally at volume) that may be consumed by GAIE. For example, consider such another system building a series of one thousand text-based observations on the other-formatted data; this may be a useful input for a GAIE model to learn and process (e.g., summarize) into text-formatted output information. In example embodiments, an interface between the GAIE and its combined machine learning system may be extended to include a dialogue between the systems, where the GAIE includes and/or accesses a capability to ask the machine learning system specific questions to facilitate the refining of its knowledge. For example, the dialogue capability may include a request of the machine learning system to provide an assessment of current market trading positions. In another example, the dialogue capability may encode numeric outputs from the machine learning engine into text (e.g., words, such as high, medium, low) that may be input for interpretation by the GAIE.

In example embodiments, the data processed by a GAIE may include one or more types of content. For example, a GAIE may receive, as input, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Input to the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be received as various forms of data. For example, a natural-language expression received as input by a GAIE could be encoded as one or more of: encoded text, an image of a writing, a sound recording of human speech, a video of an individual exhibiting sign language, an encoding according to a machine learning model embedding, or the like, or any combination thereof. In example embodiments, an input received and processed by the GAIE can include an internal state of the GAIE, such as a partial result of a partial processing of an input, or a set of weights and/or biases of the GAIE as a result of prior processing (e.g., an internal state of a recurrent neural network (RNN)).

In some embodiments, the data and/or content received and processed by a GAIE originates from one or more individuals, such as a person speaking a natural-language expression. In some embodiments, the data and/or content received and processed by a GAIE originates from one or more natural sources, such as patterns formed by nature. In some embodiments, the data and/or content received and processed by a GAIE originates from one or more other devices, such as another machine learning model executing on another device, or from another component of the same device executing the GAIE, such as output of another machine learning model executing on the same device executing the GAIE, or a sensor in an Internet-of-Things (IoT) and/or cloud architecture. In some embodiments, the data and/or content received and processed by a GAIE is artificially synthesized, such as synthetic data generated by an algorithm to augment a training data set. In some embodiments, the data and/or content received and processed by a GAIE is generated by the same GAIE, such as an internal state of the GAIE in response to previous and/or concurrent processing, or a previous output of the GAIE in the manner of a recurrent neural network (RNN).

In some embodiments, at least some or part of the data and/or content received and processed by a GAIE is also used to train the GAIE. For example, a variational GAIE could be trained on an input and a corresponding acceptable output, and could later receive the same input in order to output one or more variations of the acceptable output. In some embodiments, at least some or part of the data and/or content received and processed by a GAIE is different than data and/or content that was used to train the GAIE. In some such embodiments, the data and/or content received and processed by the GAIE is different than but similar to the data and/or content that was used to train the GAIE, such as new inputs that are exhibit a similar statistical distribution of features as the training data. In some such embodiments, the data and/or content received and processed by the GAIE is different than and dissimilar to the data and/or content that was used to train the GAIE, such as new inputs that exhibit a significantly different statistical distribution of features than the training data. In scenarios that involve dissimilar inputs, one or more first outputs of the GAIE in response to a new input may be compared to one or more second outputs of the GAIE in response to inputs of the training data set to determine whether the first outputs and the second outputs are consistent. The GAIE may request and/or receive additional training based on the new inputs and corresponding acceptable outputs. In scenarios that involve dissimilar inputs, the GAIE may present an alert and/or description that indicates how the new inputs and/or corresponding outputs differ from previously received inputs and/or corresponding outputs.

In example embodiments, the output of a GAIE may include one or more types of content. For example, a GAIE may generate, as output, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Output of the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be generated by the GAIE as various forms of data. For example, a natural-language expression generated as output by the GAIE could be encoded as one or more of: encoded text, an image of a writing, a sound recording of human speech, a video of an individual exhibiting sign language, an encoding according to a machine learning model embedding, or the like, or any combination thereof. In example embodiments, an output of the GAIE can include an internal state of the GAIE, such as a partial result of a partial processing of an input, or a set of weights and/or biases of the GAIE as a result of prior processing (e.g., an internal state of a recurrent neural network (RNN)).

In example embodiments, a language-based dialogue-enabled GAIE may be configured to produce (e.g., write) new machine learning models that may process various types of data to provide new and extended text input for processing by the GAIE. In example embodiments, humans may observe and interact with this ongoing dialogue between the two systems. In example embodiments, the dialogue is initiated by an expression of a conversation partner (e.g., a human or another device), and the GAIE generates one or more expressions that are responsive to the expression of the conversation partner. In example embodiments, the GAIE generates an expression to initiate the dialogue, and further responds to one or more expressions of the conversation partner in response to the initiating expression. In example embodiments, the ongoing dialogue occurs in a turn-taking manner, wherein each of the conversational partner and the GAIE generating an expression based on a previous expression of the other of the conversation partner and the GAIE. In example embodiments, the ongoing dialogue occurs extemporaneously, with each of the conversation partner and the GAIE generating expressions irrespective of a timing and/or sequential ordering of previous and/or concurrent expressions of the conversation partner and/or the GAIE.

In example embodiments, the dialogue occurs between a GAIE and a plurality of conversation partners, such as two or more humans, two or more other GAIEs, or a combination of one or more humans and one or more other GAIEs. In some such example embodiments, the GAIE and each of the other conversation partners take turns generating expressions in response to prior expressions from the GAIE and the other conversation partners. In some such embodiments, one or more sub-conversations occur among one or more subsets of the GAIE and the plurality of conversation partners. Such sub-conversations may occur concurrently (e.g., the GAIE concurrently engages in a first conversation with a first conversation partner and a second conversation with a second conversation partner) and/or consecutively (e.g., the GAIE concurrently engages in a first conversation with a first conversation partner, followed by a second conversation with a second conversation partner). Such sub-conversations may involve the same or similar topics or expressions (e.g., the GAIE may present the same or similar conversation-initiating expression to each of a plurality of conversation partners, and may concurrently engage each of the plurality of conversation partners in a separate conversation on the same or similar topic). Such sub-conversations may involve different topics or expressions (e.g., the GAIE may present different conversation-initiating expressions to each of a plurality of conversation partners, and may concurrently engage each of the plurality of conversation partners in a separate conversation on different topics). In example embodiments, a first conversation among a first subset of the GAIE and conversation partners may be related to a second conversation among a second subset of the GAIE and conversation partners (e.g., the second subset may engage in a second conversation based on content of the first conversation among a first subgroup).

In example embodiments, one or more of the GAIE and the conversation partner may embody one or more roles. For example, the GAIE may generate expressions based on a role of a conversation starter, a conversation responder, a teacher, a student, a supervisor, a peer, a subordinate, a team member, an independent observer, a researcher, a particular character in a story, an advisor, a caregiver, a therapist, an ally or enabler of a conversation partner, or a competitor or opponent of a conversation partner (e.g., a “devil's advocate” that presents opposing and/or alternative viewpoints to a belief or argument of a conversation partner). In example embodiments, at least one of the one or more conversation partner embodies one or more aforementioned roles or other rules. In example embodiments, a role of a GAIE is relative to a role of a conversation partner (e.g., the GAIE may embody a superior, peer, or subordinate role with respect to a role of a conversation partner). In example embodiments, a role of a GAIE in a first conversation among a first subset of the GAIE and a plurality of conversation partners may be the same as or similar to a role of a GAIE in a second conversation among a first subset of the GAIE and the plurality of conversation partners. In example embodiments, a role of a GAIE in a first conversation among a first subset of the GAIE and a plurality of conversation partners may differ from a role of a GAIE in a second conversation among a first subset of the GAIE and the plurality of conversation partners (e.g., the GAIE may embody a role of a teacher in a first conversation and a role of a student in a second conversation). In example embodiments, a role of a GAIE in a conversation may change over time (e.g., the GAIE may first embody a role of a student in a conversation, and may later change to a role of a teacher in the same conversation). In example embodiments, a GAIE may embody two or more roles in a conversation (e.g., the GAIE may exhibit two personalities in a conversation that respectively represent one of two characters in a story). In example embodiments, a GAIE generates expressions between two or more roles in a conversation (e.g., the GAIE may generate a dialogue between each of two characters in a story). In example embodiments, a GAIE may engage in each of multiple conversations in a same or similar modality (e.g., engaging in multiple text-based conversations concurrently). In example embodiments, a GAIE may engage in each of multiple conversations in different modalities (e.g., engaging in a first conversation via text and a second conversation via voice).

In example embodiments, a GAIE participating in a conversation is associated with an avatar (e.g., a name, color, image, two- or three-dimensional model, voice, or the like). Expressions generated by the GAIE may be presented as if originating from the GAIE (e.g., in the voice associated with the GAIE, or in a speech bubble that is displayed near a visual position of a GAIE in a virtual or augmented-reality environment). In example embodiments, an avatar of a GAIE may be based on a role of the GAIE (e.g., a GAIE embodying a role of a teacher may be associated with an avatar depicting a teacher). In example embodiments, an avatar of a GAIE may be included in a real-world actor, such as a robot in a real-world environment such as a stage performance.

In example embodiments, a GAIE may include generative pretrained transformer elements that may be configured as a language model designed to understand various types of input and produce chat commands for a chat-type interface system. These commands may include software development tasks, API calls, and the like. In example embodiments, such a language model may include input functions that support receiving images, including video, to build textual output, functions, and additional questions that may be injected into the dialogue between the two systems in the dialogue embodiment described above. In example embodiments, this multimodal support may allow for contextual analysis of images and other media formats. In an example, users/customers may upload images or other media into a GAIE enabled platform. Based on aspects of a corresponding input prompt, a multi-modal GAIE may be configured for use in a valuation workflow to identify both macro and micro attributes and their correlated effects on valuation from a plurality of perspectives. In this example, photographs/images of an old car may be input along with a valuation-related prompt. In response, the GAIE may identify one or more typical values based on detected attributes of the car, such as the make/model, etc. The GAIE may further take into account finer details in the image to suggest potential value-altering metrics. In one example, a finer detail in the image such as damaged body panels may reduce the car value below a typical value. In another example, a finer detail in the image that shows a marking consistent with a limited production run may increase the valuation.

In example embodiments, such a GAIE may facilitate workflow orchestration for a process that uses a conversational, generative AI agent and another AI-supported process in an orchestrated sequence. In example embodiments, a GAIE may generate, perform, maintain, and/or supervise one or more workflows in a robotic process automation (RPA) environment. For example, a GAIE may be trained to monitor expressions and/or actions of an individual during interaction with other individuals, and may generate similar expressions and/or perform similar actions during similar interactions between the GAIE and other individuals. In some such scenarios, the GAIE passively observes the individual during the interactions with other individuals and self-trains to behave similarly to the individual in similar interactions with other individuals. In some such scenarios, the individual actively trains and/or teaches the GAIE to generate expressions and/or actions (e.g., by creating and/or performing example or pedagogical interactions the GAIE), and based on the training and/or teaching, the GAIE behaves similarly during subsequent interactions between the GAIE and other individuals. In example embodiments, the GAIE is trained and/or taught by an individual to perform a behavior while interacting with individuals, and subsequently performs the behavior while interacting with the same individual who provided the training and/or teaching.

In example embodiments, a pretrained GAIE system may have a smart contract analysis engine that determines one or more features of a smart contract that is under consideration by a user. The GAIE may further have a conversation engine that explains the features of the smart contract to the user, including summarizing contents of smart contracts.

In example embodiments, a GAIE may be pre-trained to perform prompt generation based on a data story or a plurality of sources across systems. Example generated prompts may include instructing and/or requesting the pre-trained GAIE to tell a story about a journey of a product, a business relationship, an event, a service provider, a smart container fleet, a robotic fleet, and the like.

In example embodiments, the GAIE may receive a plot or outcome of the story, and may generate content that is content with the plot or that produces the outcome. In example embodiments, the GAIE may generate a plot or outcome of the story, and may also generate content that is consistent with the GAIE-generated plot or outcome of the story. In example embodiments, the GAIE may receive a world or environment of a story, and may generate content that occurs within the given world or environment. In example embodiments, the GAIE may generate a world or environment of a story, and may also generate content that occurs within the GAIE-generated world or environment. In example embodiments, the GAIE may receive a character or event to be included in a story, and may generate content that includes the given character or event in the story. In example embodiments, the GAIE may generate a character or event to be included in a story, and may also generate content that includes the GAIE-generated character or event in the story. In example embodiments, the GAIE may generate a world, environment, character, event, or the like “from scratch” (e.g., based on randomized inputs). In example embodiments, the GAIE may generate a world, environment, character, event, or the like based on a given world, environment, character, event, or the like (e.g., a story that is based on a real-world public figure or event).

In example embodiments, the GAIE may receive a first story and may generate a second story that is related to the first story. For example, the GAIE may generate a second story that is an alternative retelling of the first story (e.g., a second story that includes a retelling of the first story from a perspective of a different character than a narrating character of the first story). The GAIE may generate a second story that occurs in a same or similar world or environment as the first story, or a different world or environment that is related to a world or environment of the first story. The GAIE may generate a second story that features a character or event of the first story, or a different character or event that is related to a character or event of the first story.

In example embodiments, the GAIE may generate a story from the perspective of a narrator or independent observer of the story (e.g., a third-person story). In example embodiments, the GAIE may generate a story from the perspective of a character or point of view within the story (e.g., a first-person story), including a character generated and/or embodied by the GAIE. In example embodiments, the GAIE may generate a story from the perspective of a listener or audience member to whom the story is presented (e.g., a second-person story). In example embodiments, the GAIE may generate a story from multiple perspectives, such as a first part of a story generated from a perspective of a first character, a second part of the story generated from a perspective of a second character, and a third part of a story generated from a perspective of a narrator. In example embodiments, the GAIE may generate a story involving a sequence of two or more events (e.g., a story that involves two or more events observed by a character). In example embodiments, the GAIE may generate a story involving an event that is portrayed from multiple perspectives (e.g., a story that describes an event from a perspective of a first character, and that also describes the same event from a perspective of a second character).

In example embodiments, a GAIE may generate a static story that remains the same upon retelling. In example embodiments, the GAIE may generate a dynamic story that changes upon retelling (e.g., adding more detail to a story upon each retelling). In example embodiments, a GAIE may change a story based on an input of a user (e.g., based on a choice of outcomes selected by one or more receivers of the story). In example embodiments, a GAIE may generate a story based on one or more inputs received from one or more receivers of the story (e.g., based on a prompt of a user, such as a request to create a story that includes a certain event specified by the user). In example embodiments, a GAIE may receive feedback from a receiver about a story (e.g., an expression of pleasure, displeasure, approval, disapproval, delight, dissatisfaction, confusion, or the like regarding a character, event, or property of the story), and the GAIE may update the story based on the feedback (e.g., adding, removing, or clarifying an event in the story, or switching a perspective of an event from a first character in the story to a second character in the story).

In example embodiments, a GAIE may be pre-trained as a quantum-based GAIE. A quantum-based GAIE may use quantum computing when processing prompts and generating responses.

In example embodiments, a GAIE may be pre-trained for a value chain network environment, such as optimization of warehouse, port, container, and the like. A multi-modal variant of this GAIE may process text and image prompts. In a text-prompt embodiment, a user may describe to a generative AI assistant a request for how to optimize the layout or packing efficiency of a building, port, storage space, container, and the like. In a non-text (e.g., image-prompt) embodiment, the user may upload an image or other media and ask the generative AI to suggest places where efficiency may be improved. Another application may include providing contextual information for the visually or hearing impaired. In this application example, a multimodal support of GAIE may enable a new way for vision or hearing impaired persons to obtain contextual information about their surroundings by, for example, feeding image or sound into a generative AI-enabled system that provides voice or text dialogue to a speaker and/or on-screen.

In example embodiments, a GAIE may be pre-trained for making suggestions and/or predictions for robotic automation of value chain activities and the like. Such a GAIE may generate a prediction based on historical data in order to change future actions automatically responsive to a user asking for correlations among any of a plurality of value chain activities for improving costs, efficiency, and the like. The user may ask the GAIE to predict needs custom to each company, from a task level up to and including several tasks within a larger goal (e.g., particular conveyance task of products in a warehouse vs. entire distribution from beginning to end within a warehouse).

A pre-trained GAIE may be used to predict aspects, such as new technologies, energies, products, materials, etc. to be used with any value chain example based on knowledge of similar efforts and/or offerings by competitors or those new aspects not used by competitors but underutilized. This GAIE-based predictive activity may be customized to each company but may also be more specifically geared to a particular company division that is most likely being impacted based on knowledge of, for example, preferences of the particular division.

A pre-trained GAIE may be used to predict the effects on value chains based on existing and/or pending regulations or legislation. This GAIE may be configured to response to a prompt along the lines of: “If this regulation passes in this country what are some effects that might be expected with respect to freight shipping.” This GAIE may further respond to prompts regarding assignment of relevancy scores, such as: “What are the five most relevant pieces of legislation in X country within the past year, in order, as it pertains to Y.”

A pretrained GAIE may analyze value chain data in real-time in determining what changes may be made to improve overall goals for a range of value chains. In example embodiments, this GAIE capability may be used at any stage in the value chain, from manufacturing, to packaging, to distributing products. Any and all processes involved may be evaluated in real time for predictive improvements that may be suggested to a user and/or for future automatic execution. In an example, an artificial intelligence (AI) system may include: a value chain data collector for receiving historical data and real time data about a value chain process; and an AI agent for determining one or more improvements for the value chain process based on the historical data and real time data and based on a set of goals provided to the AI agent; wherein the AI agent may be configured to suggest the one or more improvements for future execution. Further, the AI agent may be configured to utilize robotic automation to execute the one or more improvements as a continuous feedback loop with the value chain process based on user permissions.

In example embodiments, a GAIE may be trained by loading data (such as structured and un-structured data that may be dominated by numerical or non-text values) to the GAIE. Examples of such training data may include one or more database schemas. Techniques for curation and integration of purpose-specific data, including curation of models as inputs to a GAIE may include curating domain-specific data, data and model discovery.

Candidate areas of innovation enabled by and/or associated with GAIE advances may include user behavior models (optionally with feedback and personalization), group clustering and similarity, personality typing, governance of inputs and process, explaining the basis of GAIE knowledge and proof points, genetic programming with feedback functions, intelligent agents, voice assistants and other user experiences, transactional agents (counterparty discovery and negotiation), agents that deal with other agents, opportunity miners, automated discovery of opportunities for agent generation and application, user interfaces that adapt to the user and context, hybrid content generation, collaboration units of humans and generative AI, purpose-specific data integration, a selected set of data sources, curation of data as models as input to generative AI, and the like.

In embodiments of a GAIE-enabled system, such as one for robotic process automation, the GAIE system may summarize a set of actions being subjected to robotic automation and describe context for the actions, such as, “I found these properties as fitting your criteria because of the following features. Which ones are most attractive?” In this way, a process automation system enabled with GAIE may solicit feedback for faster feedback-based training.

In example embodiments, emerging capabilities of GAIE technology may greatly improve upon earlier versions in terms of, for example, integration of domain-specific knowledge (e.g., math) with a chat interface. Further emerging capabilities may include being better informed about and for processing prompts of complex topics. Yet further, knowledge organization is becoming much improved as GAIE systems evolve. In example embodiments, updated GAIEs may correctly answer a prompt asking about today's date, whereas prior versions may answer that today's date (e.g., the current date) may be the date on which the GAIE was last trained.

In example embodiments, a context pretrained (e.g., subject matter focused) GAIE may provide better personalization than a base GAIE instance. In general, while a base GAIE, if explicitly informed of details of the user may attempt to personalize its responses, a subject matter focused or other pre-trained GAIE may be configured with and/or with access to structured information about users (e.g., determined based on user identification and/or prompt-based clues, and the like) to provide inherent, latent context for a dialogue that includes user personalized responses.

In example embodiments, a GAIE is configured to support interpretability and/or explainability of its outputs. In example embodiments, a GAIE provides, along with an output, a description of a basis of the output, such as an explanation of the reason for generating this particular output in response to an input. In example embodiments, a GAIE provides, along with an output, a description of an internal state of the GAIE that resulted in the output, such as a set of variational parameters of a variational encoder that were processed in combination with an input to produce an output, and/or an internal state of the GAIE due to a previous processing of the GAIE that resulted in the output (e.g., similar to a recurrent neural network (RNN)). In example embodiments, a GAIE provides, along with an output, an indication of one or more subsets of features of an input that are particularly associated with the output (e.g., in a GAIE that outputs a caption or summary of an image, the GAIE can also identify the particular portions or elements of the image that are associated with the caption or portions of the summary).

In example embodiments, an advanced GAIE, such as one pretrained for subject matter specific operation, may be trained for improved epistemology, to help determine evidence of the content that it represents as facts in responses that it provides. One example of improved epistemology may include citing sources of knowledge pertinent to facts in a response as a step toward proof of facts of a response-essentially a way of the GAIE “showing its work,” or at least where its work originates. In example embodiments, a GAIE generates output based on information received from one or more external sources (e.g., one or more messages in a message set, or one or more websites on the Internet), and the GAIE indicates one or more portions of the information that are associated with the output (e.g., one or more websites on the Internet that provided information that is included in the output of the GAIE).

An advanced GAIE as described and envisioned herein may maintain contextual awareness across chat (user-prompt/GAIE-response) interactions. Maintaining contextual awareness may help avoid the GAIE beginning each chat session from scratch, with no context as to prior chats with the same user. Maintaining contextual awareness may also enable picking up and resuming a conversation from earlier interactions between the GAIE and a user. Yet further maintaining contextual awareness and awareness of passage of time between interaction sessions may facilitate adapting responses to prompts in a later resumed chat session based on trained knowledge of the intervening passage of time and/or changing circumstances. In an example, a GAIE may determine that a deadline described in an earlier chat has expired, a consequential intervening event has occurred (your home-town team lost the big game), and the like. Further, contextual awareness across time-separate chat sessions may be highly valuable when being employed for projects that may have real-world physical constraints on time (e.g., smart contract negotiation may involve human evaluation, discussion, and decision making that may take time based, for example on other priorities seeking involvement of the human). This may determine the difference between treating each conversation as individual/compartmentalized/isolated, and treating ongoing, time-separated conversations as resumable, optionally as if (almost) no time had passed. In example embodiments, a GAIE may be configured with a contextualization module that maintains some notion of conversation sessions and interconnections that may be referred (e.g., a conversation from yesterday) for details and continuity. This contextualization may further enable avoiding repeating responses, making it more efficient to reference a previous conversation. Yet further, a contextualization module may provide context to the GAIE of other conversations between the user and the system, between other users and the system, and the like.

In such a contextually maintained instance, a context-enabled GAIE may provide a response regarding forecasted weather that references an earlier period of time. In an example, a context-enabled GAIE may provide a weather-related response such as, “On Monday, we discussed the weather, you asked if you would need an umbrella on Wednesday, and I answered ‘probably not’ based on the forecast at that time. I need to inform you that the updated weather forecast indicates that rain may be more likely on Wednesday, so you probably may need an umbrella.”

Other capabilities of emerging GAIE systems may include adapting a GAIE to the generation and operation of digital avatars. In example embodiments, digital avatars may be programmed with their own visual representations. To accomplish greater similarity between an avatar and its owner based on visual and audio interpretation of users, a GAIE training and/or pre-training data set may require information about body language and nonverbal cues, such as gaze, posture, speech pitch and volume, and the like.

Emerging GAIE systems may include determining and adapting responses with variations and nuances based on, for example, user activities. A user's physical disposition may influence content production by a GAIE (e.g., presenting different cues) based on if the user is sitting, walking, driving, exercising, and the like. Further, a GAIE system may adapt responses to prompts based on variations and nuances of real-life interactions versus voice interfaces versus virtual reality. Other aspects that may impact GAIE responding to prompts may include variations and nuances of different cultures, demographics, and the like. Yet further, in example embodiments, methods and systems for advanced GAIE training and operation may include recognition of higher-level communication features of users (humor, sarcasm, dishonesty, double entendre, etc.) and user emotional state, for example.

In example embodiments, methods and systems for enhancing GAIE platforms, such as those described herein, may include configuring a GAIE to participate in multi-user dialogue, where strict turn-taking interaction with one person might be difficult in a group setting, where the context of who may be speaking to whom matters for each expression. The more fluid multi-user conversational structure vs. turn-taking structure may indicate advances to a GAIE may include developing understanding of: social interactions and cues, such as to whom each expression may be directed; group dynamics (e.g., who may be the group leader?) and interpersonal relationships; the notion of threaded discussions with branches; concurrent discussions between various sub-groups of a group; when to chime in with input so as to avoid interrupting other users; some notion about conversational balance, to avoid dominating the conversation; tact: users' sensitivity about personal information, and when it may and cannot be shared in a group setting based on context, relationships with other users, and the like.

Independent of whether interactions are one-on-one or multi-user, it is envisioned that a GAIE may be adapted to evolve beyond a turn-taking paradigm. In an example, a GAIE may currently create media (images, music, video, and the like) based on a user prompt (that itself may be one or more types of media), and may refine the created media based on user interactions, such as changing the content in certain ways or extending the boundaries of an image with more content that may be consistent with the existing content (e.g., outpainting). A more sophisticated version of generative AI may flexibly and continuously adapt its generated content to contextual user input and interactions. In an example, generating media may be adapted by the GAIE in response user integration with the generated media content, such as in response to allowing a user to virtually walk around inside the content to interact with and/or react to content items. Such a media-adapting GAIE may generate new content or update the content based on the user input/content virtual interactions. Yet further to facilitate a user to virtually interact immersively with generated content details about the user may be considered part of the criteria for newly generating and/or updating the media.

In example embodiments, a media-output enabled GAIE without user immersive interaction and feedback may generate media (e.g., a first image) based on a prompt in which a user specifies a theme for a story. The user may then specify a series of scenes that follow, and the GAIE generates an image for each scene, leading to a storyboard series for the story.

When a media-out enabled GAIE is teamed with user immersive capabilities, the user may control, for example, an avatar that may walk around within the scene and interact with generated media objects. Based, for example, on an order and manner with which the user traverses the scene and interacts with the objects, the generative algorithm may generate new content (e.g., the user looks at a particular painting on the wall of a gallery and then opens the curtains of a window). Outside the window may be an entire world that may be consistent with the particular painting that the user viewed. If the user chooses to move the avatar into that world, the painting on the wall updates to reflect the user's interactions.

In another example of immersive user-generated media content engagement, a user may request a science fiction story. In addition to generating a story based on tropes that are generally relevant to science fiction, the GAIE may include tropes that are likely familiar to the user, such as based on the user's age, culture, other interests, etc. (such as science fiction versions of characters that are well-known in the oeuvre of myth and literature to which the user belongs). In some cases, the algorithm may even include individuals in the created story that are analogous to celebrities or public figures in the user's culture or generation, or even the user's own friends and acquaintances.

In example embodiments, a GAIE may be pretrained for a digital products network (DPN) deployment to facilitate, for example, product lifecycle management, product design, product improvement, product simulation, and the like.

In an example of a DPN-enabled GAIE generating designs for a new product, a generative AI conversational agent (e.g., GAIE as referenced herein) may be configured to respond to a prompt requesting that it generate a design for a new product by producing one or more new product designs based on the request and contextual clues derived in association with the request (e.g., other product references, product genre, product features, jurisdiction of the request, demographics of the request, and the like). In an example of a DPN-enabled GAIE generating product improvement suggestions, a generative AI conversational or otherwise user-accessible agent may be configured to respond to a prompt to generate product improvement suggestions by generating a set of existing features of the product, contextual evaluations of the features (e.g., based on product-consumer feedback), comparisons to other products with similar features, advances in technology related to the features (e.g., higher resolution imagers), and the like. In an example of a DPN-enabled GAIE generating simulations for a digital twin of a product, a generative AI user-interactive agent may be configured to generate simulations for a digital twin of a product.

In example embodiments, a superintelligence system may be based on a pre-trained GAIE that facilitates automated discovery of relevant domain-specific knowledge and examples. The superintelligence system may further leverage pre-trained advanced GAIE to leverage domain-specific examples to generate content. Yet further the superintelligence system may include a genetic programming capability to create novel variation. In example embodiments, a superintelligence system may further include feedback systems (e.g., collaborative filtering and automated outcome tracking) to prune variation to favorable outcomes (financial, personalization, group targeting, and the like).

In example embodiments, a GAIE may be pre-trained for use by and/or in cooperative operation with a digital twin engine, such as an instance of an executive digital twin and the like. In an exemplary deployment, a GAIE may interact with a digital twin to provide a narrative about a topic of the digital twin to give to a viewer. In this example, the digital twin may interact with the GAIE (e.g., through an API and the like) to generate a narrative summary for a CEO and a detailed narrative for a CFO.

Executive digital twins may be configured for a particular role or user. Therefore, a GAIE system with a digital twin interface may improve executive digital twin capabilities by curating the data for and populating content for consumption by executive digital twins for different roles. In an example a GAIE may receive information about the executive digital twin as well as about the intended human being represented by the executive digital twin (e.g., the role of the user). The GAIE may determine a degree of narrative detail for each executive digital twin. This may be based on generic executive digital twin/user role criteria and/or refined through interaction with a particular user for the executive digital twin. In example embodiments, a CEO with a tech focus may receive more “in-depth” narrative relating to tech or R&D, whereas a CEO with a financial background may end up receiving narratives that are more focused on financial analysis but less granular on tech-related features.

In example embodiments, a GAIE system that interacts with a digital twin engine (e.g. an executive digital twin instance and/or engine) may determine of the potential universe of content on which it is trained, what may be relevant and what may be noise or unrelated for the specific narrative topic, the target human consumer, and the like. Based on this relevance determination, the GAIE system may generate the output data based on the relevant data and the determined degree of detail.

Further, the GAIE system may also select real time data sources to connect to a target/requesting executive digital twin. The GAIE may further configure consumption pipelines for those sources on the spot (e.g., data source identification, data requests for identified data sources, API configuration, and the like). Therefore, in this example the GAIE system would be identifying data sources and connecting them to an executive digital twin instance/engine.

An example use case may include an executive digital twin that has access to full financial data from a previous time-frame (e.g., a previous year/quarter/month, and the like). The executive digital twin may enable access by the GAIE to all of this data. The GAIE may determine a degree of detail of the data for the intended viewer (e.g., target consumer of a narrative regarding a topic captured in the full financial data).

In the case of a target consumer/view having a role of CEO, the GAIE may determine that the narrative for the CEO will include key insights but not full details. The GAIE may then generate a narrative of the top insights for a target time-frame (e.g., a current quarter) from at least the received data.

A pre-trained GAIE may be used to generate, manage, and/or manipulate digital twins, such as by describing attributes of a digital twin, describing interactions with other digital twins or environments, describing simulations, using digital twin simulation data to generate content, enabling context-adaptive executive digital twins, facilitating development of narratives about ongoing, real time operations, tuned to the preferred conversation style of a user represented by a digital twin, and the like. In example embodiments, a context-adaptive executive digital twin integrated with a generative conversational AI system may be configured to generate a set of narratives about operations of an enterprise based on an input data set of real-time sensor data from the operations of the enterprise. The digital twin (or human user) may prompt the GAIE and/or conversational AI system to compare financials with real-time sensor data.

A GAIE may be adapted (e.g., pre-trained) to facilitate enhancement of AI training data associated with a digital twin application. In example embodiments, a method may include using an AI conversational agent to create synthetic training data.

Further in association with digital twin technology, a GAIE may be adapted for summarizing highly granular data for consumption by an executive digital twin. In this regard, an executive digital twin system may include an intelligent agent that receives a set of customization features from a user (e.g., an executive represented by the digital twin) that include a role of the user within an organization. The intelligent agent may also determine a respective granularity level of a report based on the customization features. In example embodiments, the set of customization features include granularity designations for different types of reports. Yet further, the intelligent agent determines the granularity level of a report based on the role of the user within an organization. Further, the subject matter of the report may be generated based on the role of the user within the organization.

In example embodiments, a speech-based user interface for customizing a level of specificity for generating executive digital twin reports may be operatively coupled to a customized GAIE that processes the speech into a set of report instructions (and optionally report content) based on aspects of the user(s). An example of a speech-based request that may be processed as described may include, “I'd like an executive-summary level report on predictive maintenance” or “I'd like a detailed report on competitor analysis.” The speech-based user interface may respond to such a request by directing a corresponding executive digital twin system to feed a specificity level for parameters to a generative AI engine (e.g., GAIE) as additional input along with the data. In this example, IoT data from manufacturing facilities may be used in predictive maintenance. A response to a prompt regarding preventive maintenance may be customized with a level of specificity based on target report consumer role(s), such as for an operations-based role. A level of specificity may include what are the costs, when is the maintenance needed by, what may be the predicted downtime, how to offset and/or time the maintenance activity, and the like. For a financial-based role, specificity levels may be adapted to address what may be the disruption going to do for the bottom line in the short term; how does this impact our supply; what may the disruption do to our market-share; will it impact our stock price, and the like.

When a digital twin may be used to model an individual, a fine-tuned GAIE may be used to coordinate the digital twin with the human for improved fidelity (e.g., when the human behaves or reacts differently than the digital twin predicts, a GAIE may initiate a dialogue with the user to determine why, and the results may be used to update the digital twin model for the individual). Instead of having a human expert occasionally participate in automated digital twin model training (e.g., to correct errors or provide new examples, and the like), a corresponding GAIE may be occasionally querying the user to solicit more information to update the digital twin model of the individual. As an example, a system may include a digital twin that models an individual, and may further include a conversation engine that facilitates determining an update of the digital twin based on a conversation with the individual that is associated with a difference between an action of the individual and a corresponding action prediction by the digital twin.

In example embodiments, human-to-robot interfaces may be further enabled and enriched through use of fine-tuned GAIE instances, such as for communicating to the robot fleet and/or receiving information from the robotic fleet. Another robot interface example may include parsing fleet job requests and identifying robotic tasks for establishing a set of fleet configuration parameters. In an example, a fleet management platform may include a job configuration system that interfaces with a GAIE-based intelligent agent, wherein the GAIE-based intelligent agent receives a job request from a client device and determines, for example, a structured set of tasks to be performed by a robotic fleet.

Subject matter adapted GAIE systems may facilitate providing an interactive framework by which an operator may interact with a robotic element via dialogue to perform a task related to the manufacturing or maintenance of a product. One example may include a voice-enabled control system that may include a collaborative robotic element configured to perform a task, such as lifting, cutting, tightening, and the like. The control system may further include a recommendation engine configured to provide a set of recommendations for performing a task dictated by the user. (e.g. prompt: “What are some ways in which I may reinforce this strut?” response: “Possible reinforcement mechanisms may include . . . ). Responses to such a prompt may further include describing cheaper components that may be used, ways to maximize cost effectiveness, and the like. Further a machine vision enabled combination where the intelligent agent may analyze images of the product being manufactured and then reference similar examples in response to a prompt such as, “show me five similar product component diagrams.”

In example embodiments, a GAIE system may be configured for use in an automated manufacturing environment. In one example, a user may prepare a descriptive prompt of a desired product to have it 3D printed. The GAIE system may generate a 3D printing set of instructions, such as a configuration of an automated 3D printing machine and a rendering indicative of a result of the 3D printing machine following the instructions. In another example, a user may include a photo/video of product as a prompt along with a request for instructions to 3D print an improved version, such as “I want this bike but I want different tires and I want it to be red.”

Another exemplary use of a pre-trained GAIE may include using user behavioral data to generate guiding recommendations for energy conservation, usage shifting, and the like. In particular, a recommendation system for energy conservation, usage shifting, or optimization may include an integrated generative, conversational AI system that adapts generated output based on user behavior from a user behavior data set.

In example embodiments, an adapted GAIE may facilitate management of energy resources. An energy resource management system may be enhanced to provide advanced intelligence (e.g., superintelligence) to plan, manage, and/or govern DERs and energy generation, storage, consumption, and transmission facilities. Elements of a superintelligent energy management system may include automated discovery of relevant domain-specific knowledge and examples, generative AI to leverage domain-specific examples to generate content, genetic programming to create novel variation, feedback systems (e.g., collaborative filtering and automated outcome tracking) to prune variation to favorable outcomes (financial, personalization, group targeting, etc., etc.), and the like. In an example, a superintelligent AI-enabled management system may be configured to manage a plurality of systems of an energy edge platform via automated discovery, generative AI, genetic programming, and feedback systems.

In example embodiments, a GAIE may be adapted (e.g., trained, pre-trained, and the like) for the field of patents to generate patent claims responsive to being provided a patent disclosure. An enabled GAIE may receive patent claims as a prompt and may generate a supportive patent disclosure therefrom. In example embodiments, an enabled GAIE may be trained to understand a patent structure and a claim structure for a plurality of jurisdictions.

In example embodiments, a GAIE may be pretrained (e.g., finetuned) with a private instance of an enterprise's intellectual property data (e.g., products, business goals, competitive considerations, core inventive ideas, and the like). In example embodiments, a private instance of enterprise data for patent generation may be configured (e.g., as prompt-response pairs) for finetuning the GAIE instance.

Beyond patent disclosure and figure preparation, a GAIE may be fine-tuned to generate figures, disclosure from figures, claims from figures, office action responses, evidence of use (EOU) for patent monetizing, preparing a matrix of patent claims across a portfolio, high level landscape search strings, enhancement of search strings, and the like. Finetuning may include preparation of prompt-response sets for a range of IP-related actions, such as patent claim assertion, infringement analysis and discovery, claim (term) acceptance and/or rejection, estimate of claim scope broadness, claim quality, and the like. In example embodiments, an IP-tuned GAIE may be pre-trained with information from proceedings related to infringement cases to understand the likelihood of infringement, and the like.

GAIE training and IP-integration may facilitate elaboration of broadly stated inventive concepts into disclosure that reflects robust enablement and/or support. In an example, an outline may be an input prompt for the purposes of drafting a patent application (e.g., disclosure, figures, summary, abstract, and optionally claims). A generated result may become a portion of a subsequent prompt along with a description of the general theme, category, focus area and/or other categorization or classification of innovation. In an example, one may describe a transaction environment processing platform and ask for examples of a technical implementation, system, and/or method design, such as: “In the context of a transaction environment processing platform as previously described, what types of hardware and software might be used to implement a governance engine for the transaction environment?”

Regarding an intellectual property (e.g., patent) monetization-focused development process, a GAIE may facilitate predicting, from a market development view, which domains to select and which categories within domains to emphasize based on the ability to determine where business may be shifting over a longer time (e.g., beyond short-term trends). This may include analyzing historical data and current data for one or more IP domains, optionally in near-real time. An IP-monetization-focused GAIE may tie historical and/or current data to investments and actions having occurred in the IP world for, among other things, patent sales and licensing. An IP-monetizing trained GAIE may also develop particular leads and domain categories with the highest probability of success based on previous sales and/or licensing and/or where the market may be heading. There may be risk in making these decisions but using a trained GAIE may lower this risk so that these decisions become more predictable in the future, especially with company data increasing and likely accessible through various channels.

A GAIE may be configured, trained, and/or fine-tuned for a range of functions, including, for example, ingestion of proprietary data, determination of a route, determination of an outcome, approval of release/access to data, making a prediction, pattern recognition, and the like. Yet another example application of a fine-tuned GAIE may include layering of voice and visual commands that may be graduated in sound, volume, or spacing similar to flight avionics, thereby generating scripts for voice over of data and/or presentation material. This may enable the development of synthetic speech technology that generates lifelike (AI-generated) voices for podcasts, slideshows, and professional presentations. This may mitigate needs for hiring a voice artist or using any complex recording equipment (e.g., background noise separation, dubbing, and the like).

In example embodiments, GAIE systems may be configured for facilitating news delivery from NPC-type avatars to adapt current “clickbait” content to conversationally conveyed world news/happenings. In this example, a metaverse environment may include a news-based GAIE conversation agent configured to conversationally inform users of recent events.

Further in context of metaverse technology, a generative AI conversational agent may be configured to populate the metaverse.

Yet further within a context of metaverse technology, a GAIE system may be enabled to augment training data for a customized conversational agent with real-time sensor data sets through collecting information from real-world sensors. In an example, a training data augmentation system may be configured for augmenting training of a conversational agent with data from a real-time sensor data set. Further, a metaverse-associated GAIE system may facilitate augmenting training data for a customized conversational agent with process outcome data. A training data augmentation system may be configured for augmenting training of a conversational agent with process outcome data from a process outcome data set, user behavior data, and the like. In example embodiments, a training data augmentation system based on a GAIE may be enabled (e.g., pre-trained) for augmenting training of a conversational agent with user behavior data from a user behavior data set.

In example embodiments, application of fine-tuned GAIE systems in the field of governance may facilitate advances in automation of governance, such as governing use of copyrighted material. GAIE-based governance systems may further enhance governing AI training, such as conversational AI training data sets for bias and error, governing conversational AI for contextual appropriateness and other stylistic requirements, and the like. A fine-tuned GAIE system may further improve governing secrecy, such as a progression of what elements of secret, proprietary or confidential information are allowed based on a depth of conversation. Governance may further apply to individuals. Therefore, a governance fine-tuned GAIE system may enhance and/or automate determining a measure of trustworthiness of a user that may be interacting with a generative conversational AI system. Further a governance fine-tuned GAIE system may enrich governance for a generative AI system, such as determining a measure of trustworthiness of a generative conversational AI system. In general, governance use cases may be expanded further in light of GAIE topic-targeting training capabilities.

A fine-tuned GAIE system may play a role in systematic risk identification, management, and opportunity mining. GAIE-based risk identification systems may respond to risk-related prompts, such as “What may else might we know and should be paying attention to?” by curating data sets and automating the processes of identification of systemic risks, identifying a set of likely scenarios and the risks and opportunities arising from those scenarios, identifying paths for resolution and recommending resolutions.

Yet another area of risk identification and/or management may involve security concerns with GAIE systems that are configured to generate computer executable code. At the least relying on computers to write computer code raises questions about what security measures are effective and what measures are able to be circumvented by the AI.

A further area of risk identification, management and/or opportunity harvesting may apply to copyright material. Automated computer code generation may inadvertently introduce copyrighted material, such as algorithms. A risk-finetuned copyright GAIE may assist in detecting candidate copyright violations in any programmatic code, including machine generated code.

Risk identification of visual training sets (e.g., images, graphs, and the like) may be enhanced by a fine-tuned GAIE that can process these visual training data sets for authenticity indicators that are coded as non-visual data. This may be similar to tail voltage devices providing messages on the end of sine waves. Visual training sets may be coded with non-visual indicators of authenticity that may be detectable by a fine-tuned GAIE.

Yet another risk-identification related area includes fraud detection. Integrating customer fraud reporting and questioning into pretraining data may enrich holistic scoring, which may comprise a composite score that bridges customer evidence, transactions, and environmental trends. In an example, an AI based fraud detection system may integrate customer fraud reports and questioning into a training/query data set to produce a holistic scoring system, utilizing a composite score that combines customer evidence, transaction data, and environmental trends to provide a comprehensive approach to fraud detection.

Imaging applications may benefit from fine-tuned GAIE systems. In example embodiments, optical content (e.g., screen shots and the like) may be processed by machine vision systems so that the GAIE may describe a scene in the optical content using a generative conversational AI agent. In example embodiments, a GAIE may be configured as a first AI/NN sub-system in a Dual Process Artificial Neural Network (DPANN) architecture. Such a DPANN architecture may include, as a second NN sub-system, a formal logic-based and/or fuzzy-based system. Together these DPANN systems may implement learning processes, model management, and the like. In example embodiments, a DPANN architecture may include features that describe building and managing large scale models.

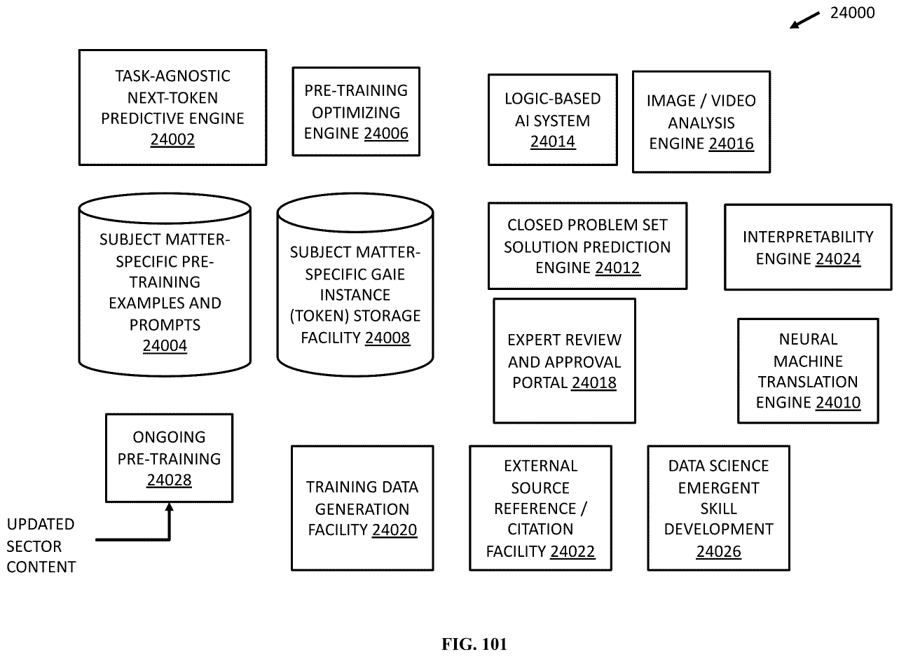

Referring to FIG. 101, a platform for the application of generative AI 24000 may include a robust task-agnostic next-token prediction artificial intelligence model 24002 that operates to predict a next token given a set of inputs encoded as embedded tokens. A robust task-agnostic next-token prediction AI engine 24002 may include deep learning models, which use multi-layered neural networks to process, analyze, and make predictions with complex data, such as language. An objective of the robust next-token prediction AI engine 24002 may include data science modeling through, among other things, use of topic-specific embeddings, attention mechanisms, and decoder-only transformer models. Capabilities of such an engine 24002 may include a pre-training capability to facilitate configuring next-token prediction for specific subject matter (e.g., marketplace item valuation), a tokenizing capability to facilitate converting complex terms into actionable tokens (e.g., converting compound chemical names into fundamental elements), access to distributed training (e.g., data-parallel training and/or model-parallel training, and the like), few-shot learning to reduce training demand for updates, such as new business intelligence data, and the like. In general the next-token prediction AI engine 24002 may combine large language modeling techniques and decoder-only transformer models to generate powerful foundation models for next-token prediction AI content generation.

In example embodiments, the next-token prediction AI engine 24002 may be structured with an machine learning (sparse Multi-Layer Perceptron) architecture configured to sparsely activate conditional computation using, for example mixture-of-experts (MoE) techniques. A machine learning architecture may be configured with expert modules that may be used to process inputs and a gating function that may facilitate assigning expert modules to process portion(s) of input tokens. A machine learning architecture may further include a combination of deterministic routing of input tokens to expert modules and learned routing that uses a portion of input tokens to predict the expert modules for a set of input tokens.

A GAIE 24000 may be trained to operate within a domain, such as written language, computer programming language, subject matter-specific domains (e.g., a software orchestrated marketplace domain), and the like to generate content (constructs) that comply with rules of the domain. In general, a GAIE may generate content for any topic for which the GAIE is trained. So, for example, a GAIE may be trained on a topic of pig farmers and may therefore generate language-based descriptions, images, contracts, breeding guidance, textual output, and the like for any of a potentially wide range of pig farmer sub-topics.

Adapting a generative AI engine for subject matter-specific applications may include pretraining a next-token prediction AI model-based system through the use of, for example, in-context (e.g., application, domain, topic-specific) examples that are responsive to a corresponding prompt. While the next-token predictive capabilities of the underlying next-token prediction AI engine may remain unaffected by this pre-training, subject matter-specific pre-trained instances may be developed/deployed.

In example embodiments, a platform for the application of generative AI 24000 may include a set of subject matter-specific pretrained examples and prompts 24004. This set 24004 may be configured by analyzing (e.g., by a human expert and/or computer-based expert and/or digital twin) information that characterizes various aspects of the domain to generate example prompts and preferred and/or correct responses. Pretraining may also include training the next-token prediction AI engine 24002 by sampling some text (e.g., prompt/response sets) from the set of subject matter-specific pretrained examples and prompts 24004 and training it to predict a next word, object, and/or term. Pretraining may also include sampling some images, contracts, architectures, and the like to predict a next token. These prompt-response sub-sets may facilitate pre-training the prediction AI engine 24002 for predicting a next token (e.g., word, object, image element, and the like) for various aspects.

When an instance is implemented for textual generation, such a GAIE instance may be referred to as a natural language generation system that constructs words (e.g., from sub-word tokens), sentences, and paragraphs for a target subject and/or domain.

In example embodiments, real-world instances of the platform 24000 may require ongoing updates to facilitate the platform 24000 being responsive as aspects of a domain (e.g., a business entity in the domain) change, such as business goals change, new products are released, competitors merge, new markets emerge, and the like. In this regard, training the platform 24000 with in-context prompts and examples may be automated and repeated as new data is released for an enterprise to prevent snapshot-in-time data aging-based errors. The platform the application of generative AI 24000 may include an ongoing pre-training module 128 that processes new and updated content into prompt and/or response sets and interactively iterates through rounds of pre-training. New and updated data and/or information may regularly be found in various subject matter specific information sets, such as: a dataset of medical records (e.g., to assist with medical diagnoses), a dataset of legal documents and court decisions (e.g., to provide legal advice), a release of a new product (e.g., images of the product), or a financial dataset such as SEC filings or analyst reports. In example embodiments, uses of the platform 24000 may include applying the pre-training and optimizing techniques to a range of different domains (e.g., medical diagnosis, business operation, marketplace operation, and the like) to produce a fine-tuned domain specific token-predictive engine including ongoing refinement through (daily) in-context pretraining.

In example embodiments, an ongoing pre-training module 24028 may work with the next-token prediction AI engine 24002 to update a set of subject matter specific tokens that may be maintained in a subject matter specific instance token storage facility 24008. This subject matter specific instance token storage facility 24008 may be referenced by a subject matter specific instance of the next-token prediction AI engine 24002 during an operational mode (e.g., when processing inputs/prompts). In example embodiments, the platform 24000 may include a plurality of sets of subject matter specific tokens that may be maintained by corresponding ongoing pre-training modules 24028.

Training, however, may not ensure that the responses to prompts are correct every time. In general, a business entity is likely to be less interested in a tool that provides answers that are probably right and may differ from time to time. A product that can provide accurate responses (e.g., including taking actions) based on what the end-user wants vastly increases the potential use cases and product value. A high level of accuracy and integration with operational systems may enable such a tool to go beyond just generating new content to be more productive; through integration with workflows, it may facilitate automating workflow actions. In this regard, the platform for the application of generative AI 24000 may also include a pre-training optimizing module 24006 that may work cooperatively with the ongoing pre-training module 24028 to further refine accuracy of responses to prompts for a domain. The pre-training optimizing circuit 24006 may facilitate improved accuracy of in-context responses, task-specific fine-tuning, and for sparse model variants of the platform 24000, enrich few-shot learning capabilities. In example embodiments, fine tuning may further benefit the platform by reducing bias that may be present in the training data. This may be essential to ensure subject matter specific jargon is adapted as training data changes (e.g., in the digital marketing/promotional space, ensure that “influencer” is replaced with “creator”). Further, a pre-training optimizing engine 24006 may provide a wider range of prompts and responses based on user preferences (e.g., speaking styles) to enrich the platform's ability to provide user-centric responses. In example embodiments, user-centric responses may include fine tuning the platform 24000 for different roles in an organization. As an example, when a user in a financial planning role inquires about a business development topic, responses may be directed toward the financial planning role (e.g., as compared to a customer/client inquiry about that topic).

A platform for the application of generative AI 24000 may be used to produce text-based content for a multinational entity with employees who speak different languages. While the platform 24000 may be trained (and pre-trained) to operate interactively in a plurality of languages, generating automated content may benefit from use of a neural machine translation module 24010. In example embodiments, a portion of the entity in a first jurisdiction may produce content in a first language and resulting recurring generated output (e.g., types of reports and the like) may be generated in the first language. However, employees who speak a second language may benefit from the type of report when translated into the employee's native language. Therefore, associating the neural machine translation module 24010 with the platform may prove valuable while reducing compute demand for the platform 24000.

Emerging next-token prediction AI systems feature increasingly adaptable next token prediction capabilities. These capabilities may be further adapted to assist in closed problem set solution prediction, such as allocation of resources, deployment of a robotic fleet and the like. To achieve greater prediction capabilities, a subject matter specific next-token prediction AI-based engine, such as the platform for the application of generative AI 24000, may include a solution-predictive engine 24012 that leverages next-token (e.g., next word) predictive capabilities to predict a most-likely solution to a closed solution-set problem. This may be accomplished optionally through use of sets of problem domain-specific pre-training prompts and examples. Such examples may be adapted for different user preferences. In example embodiments, each user in a closed problem set environment may generate prompts and responses that may enable the platform 24000 to respond to the user based on the user's inquiry style. Alternatively, the solution prediction engine 24012 may adapt a user's prompt and/or configure a prompt based on user preferences to attempt to deliver responses that are consistent with a user's preferences (e.g., engineering-based responses for an engineer role-user and legal-based responses for a lawyer).

For more complex analysis and decision making/predicting, a formal logic-based AI system 24014 may be incorporated into and/or be referenced by the subject matter specific platform 24000.

Further, the basic concepts of next-token prediction of a generative AI engine, such as the platform for subject matter based application of generative AI 24000 may be applied to analyzed expressions of images, audio (e.g., encoded text), video (e.g., sequences of related images), programmatic code (domain-specific text with readily understood rules), and the like. Therefore, a next-token prediction AI platform (e.g., platform 24000) may further include an image/video analysis engine 24016 (optionally NN-based) that adds a spatial aspect to the next-token predictive capabilities of a next-token prediction AI system. Images used for training may include 3D CAD images (for a domain that includes physical devices such as vehicles), radiologic images (for a medical analysis domain), business performance graphs, schematics, and the like. In example embodiments, aspects of the underlying task-agnostic next-token prediction AI engine 24002 may be adapted (e.g., different embeddings, neural network structures and the like) for different input formats, such as images, temporal-spatial content, and the like.

The platform 24000 may further include an expert review and approval portal 24018 through which an expert (e.g., human/digital twin, and the like) can review, edit, and approve content generated. Examples include review and adaptation by a subject matter specific data story expert; a data scientist, and the like. The expert review and approval portal 24018 may operate cooperatively with, for example, the pre-training optimizing module 24006 that may receive and analyze expert feedback (e.g., edits to the content and the like) for opportunities to further optimize the platform 24000.

The platform 24000 may further include a training data generation facility 24020 that may generate natural language prompts, such as subject matter specific prompts that may be applied by, for example, the pre-training optimizing engine 24006 to increase platform response accuracy and/or efficiency while fine tuning a subject matter specific instance.

In example embodiments, the platform 24000 may further be configured to access a corpus of domain and/or problem relevant content as a step in responding to a prompt. In example embodiments, the platform may be pre-trained on the content of the corpus. While the content of the corpus may not be directly included in the response, such as if it provides a level of detail beyond what the platform 24000 has been trained to provide in a response, it may be cited in the response to facilitate identifying and expressing sources from which a response is derived. These external source references may be handled via a citation module 24022.

Business decisions are often context-based. Understanding both the context for a decision and aspects and/or assumptions of the decision process may prove highly valuable for evaluating, for example, competing decisions and/or recommendations. Context may include both tangible and intangible factors. An intangible factor may include historical interactions between parties involved in the evaluation process, for example. A decision process may include not only assumptions on which a decision or recommendation is based, but also criteria by which tangible factors are processed, evaluated, analyzed, and the like. To provide such context for generated output of the platform 24000, an interpretability engine 24024 may be incorporated into and/or be accessible to the platform 24000. An objective of use of the interpretability engine 24024 may be to generate additional content that reflects context for, among other things, how the next-token prediction AI instance operates and/or generates a corresponding output.

In example embodiments, the next-token predictive capabilities of a next-token prediction AI engine 24002 may be utilized for developing a set of emergent data science predictive and/or interpretive skills. While such a platform may be trained directly on various data sets, context for elements and results in such data sets may be a rich source of complementary training data. By associating data elements with descriptions thereof, the platform 24000 may gain data science capabilities, such as to group by or pivot categorical sums, infer feature importance, derive correlations, predict unseen test cases, and the like. In this regard, a data science emergent skill development system 24026 may be utilized by the platform to enhance further subject matter specific applicability and utility.

In embodiments, the techniques described herein relate to a generative artificial intelligence system for a value chain network including one or more processors and one or more memories configured to perform operations including: executing, by the generative artificial intelligence system, generative artificial intelligence algorithms trained on value chain network data; receiving input data including at least one of images, video, audio, text, programmatic code, and data; processing the input data using the generative artificial intelligence algorithms to generate output content, wherein the output content includes at least one of structured prose, images, video, audio content, software source code, formatted data, algorithms, definitions, and context-specific structures; generating an internal state of the generative artificial intelligence system, including a set of weights and/or biases as a result of prior processing; and providing the generated output content to a user interface for presentation to a user.

In embodiments, the generative artificial intelligence algorithms of the GAIE may be trained on value chain network data. In embodiments, value chain network data may include, but is not limited to, demand data (e.g., historical and forecasted customer demand data, seasonal trend data, purchasing pattern data, market research data, customer behavior analytics, and the like), product data (e.g., specifications, design files, development documentation, lifecycle information, product variations, and the like), product component data (e.g., individual part specifications, sourcing details, costs, and supplier performance metrics), supplier data (e.g., supplier capability information, lead time data, quality metrics, contractual terms, and the like), manufacturing data (e.g., production schedules, process workflows, machine utilization rates, maintenance records, factory floor data, and the like), quality control data (e.g., inspection reports, quality standards, testing results, return or defect rates, and the like), inventory data (e.g., stock levels, storage conditions, turnover rates, reorder points across various locations, and the like), logistics and distribution data (e.g., shipping routes, carrier performance, delivery times, transportation costs, customs clearance details, location data, and the like), customer feedback and service data (e.g., customer reviews, service tickets, warranty claims, post-purchase support interactions, and the like), financial transactions data (e.g., cost of goods sold, operational expenses, pricing strategies, sales revenue, profitability analysis, and the like), regulatory compliance data (e.g., compliance status with local and international regulations, audit trails, certification records, and the like), environmental impact data (e.g., carbon footprint, waste management records, sustainability metrics, and the like), market and competitive analysis data (e.g., competitor strategies, market share information, industry benchmarks, and the like), technology and innovation data (e.g., research and development activities, patent filings, technology adoption rates, and the like), human resources data (e.g., workforce skills, labor costs, productivity levels, employee engagement metrics, and the like), and risk management data (risk assessments, mitigation strategies, incident reports related to supply chain disruptions, and the like).

For example, generative AI system may be configured for a logistics company that processes real-time GPS data, warehouse inventory images, and shipment tracking text to optimize delivery routes and schedules. The system generates a visual map with the most efficient paths and a structured schedule for drivers, which is then displayed on a dashboard in the logistics control center.

In some aspects, the techniques described herein relate to a generative artificial intelligence system, wherein the input data further includes natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations. For example, a generative AI system for an automotive manufacturer may receive CAD models of car parts, audio recordings from quality control checks, and video footage from the assembly line. It may process this data to identify potential manufacturing defects and suggests design modifications, which are then presented in a detailed report to the engineering team.

In embodiments, the techniques described herein relate to a generative artificial intelligence system, wherein the generative artificial intelligence system is configured to maintain contextual awareness across interactions to facilitate continuity in dialogue with users. For instance, a customer service generative AI system for an e-commerce platform may maintain a conversation history with customers, using this context to provide consistent and personalized support across multiple interactions, such as recommending products based on past purchases and queries.

In some aspects, the techniques described herein relate to a generative artificial intelligence system, wherein the generative artificial intelligence system is configured to support interpretability and explainability of its outputs by providing a description of the basis of the output. For example, A financial analysis generative AI system may generate a report on market trends and provides explanations for its predictions, such as citing economic indicators or recent news events that influenced its analysis, making the output more transparent for financial analysts.

In some embodiments, the techniques described herein relate to a generative artificial intelligence system, wherein the output includes a recommendation to improve one or more of the value chain network, an entity within the value chain network, an asset within the value chain network, and the value chain network environment. For instance, a supply chain generative AI system may analyze sales data and inventory levels across a retail network to recommend restocking certain products in specific locations, aiming to improve the overall efficiency of the inventory distribution within the value chain network.

In some embodiments, the techniques described herein relate to a generative artificial intelligence system, further including a digital twin interface for a digital twin, wherein the digital twin interface is configured to enable access to the generative artificial intelligence system, and wherein the digital twin represents at least one of the value chain network, an entity within the value chain network, an asset within the value chain network, or an environment within the value chain network. In one example, a smart factory generative AI system may be accessed via a digital twin interface that allows operators to interact with a virtual representation of the manufacturing floor, enabling them to test different production scenarios without affecting the actual operations. Continuing with the example, the operators may be able to ask the smart factory generative AI system questions about the different production scenarios.

In some aspects, the techniques described herein relate to a generative artificial intelligence system, further including a digital twin module configured to generate a digital twin representing at least one of a value chain network, an entity within the value chain network, an asset within the value chain network, and an environment within the value chain network. For instance, a generative AI system for a smart city project may generate a digital twin of the city's transportation network, simulating traffic flow and public transit operations to propose improvements for reducing congestion and enhancing commuter experience.

In some aspects, the techniques described herein relate to a generative artificial intelligence system, wherein the processor is further configured to communicate with robotic systems within the value chain network, and the memory stores instructions that enable the generative artificial intelligence system to translate human commands into robotic actions, thereby facilitating human-to-robot interaction. In one example, a warehouse management generative AI system may translate voice commands from workers into actions for robotic forklifts, coordinating the movement of goods and streamlining the loading and unloading process.

In embodiments, the techniques described herein relate to a generative artificial intelligence system, wherein the output content is further tailored based on the executive role of the user. The GAIE may be configured to tailor the output content based on the executive role of the user within an organization. The system adjusts the level of detail and complexity of the output content to match the user's role, ensuring that the information provided is directly relevant to the user's decision-making needs and responsibilities. For example, an executive dashboard generative AI system may customize financial reports for different roles within a corporation, providing high-level summaries for C-suite executives and detailed breakdowns for department heads.

In some aspects, the techniques described herein relate to a generative artificial intelligence system, wherein the generated output includes 3D printing instructions for a set of 3D printers based on input data. The system may be configured to analyze product designs and utilize the generative capabilities of the GAIE to create detailed 3D printing instructions, facilitating the physical realization of product concepts. For instance, a design generative AI system for a furniture company may process sketches and material specifications to generate precise 3D printing instructions, enabling rapid prototyping of new furniture designs.

In some aspects, the techniques described herein relate to a generative artificial intelligence system, wherein the system is part of a Dual Process Artificial Neural Network (DPANN) architecture, combining generative AI capabilities with formal logic-based systems to enhance decision-making and predictive modeling. For example, a healthcare generative AI system may be part of a DPANN architecture, where it works alongside a rule-based diagnostic system to provide both generative insights and logic-driven medical diagnoses to healthcare professionals.

In embodiments, the techniques described herein relate to a generative artificial intelligence system, further including an augmented reality (AR) interface configured to overlay the generated output content onto a user's real-world view. This AR interface may provide interactive and visual representations of the output content, enhancing user engagement and understanding of complex data. In one example, an augmented reality (AR) interface is integrated with the generative AI system. Continuing the example, as a field technician inspects a piece of heavy machinery using AR glasses, the generative AI system can overlay real-time data analytics, maintenance history, and performance metrics onto their view of the equipment. This allows the technician to see potential issues highlighted directly on the machinery, receive step-by-step repair instructions, and view predictive maintenance alerts, all superimposed within their field of vision, thereby enhancing the efficiency of on-site diagnostics and repairs.

### Graph Neural Networks and Transformer Models in Artificial Intelligence Platforms Graph Neural Networks—Introduction

In various embodiments, one or more techniques involve the processing of graph data using one or more machine learning algorithms. In some such embodiments, the one or more machine learning algorithms include one or more graph neural networks (GNNs). The following discussion provides an overview of graph data and graph neural networks.

In a graph data set, a set of nodes is interconnected by one or more edges that respectively represents a relationship among two or more connected nodes. In many graph data sets, each edge connects two nodes. In other graph data sets that represent hypergraphs, a hyperedge can connect three or more nodes. In various graph data sets, each of the one or more edges is directed or undirected. An undirected edge represents a relationship that relates two or more nodes without any particular ordering of the related nodes. A first undirected relationship that connects a first node N1 and a second node N2 may be equivalent to a second undirected relationship that also connects a first node N1 and a second node N2. In some such graphs, the relationship represents a group to which the two or more related nodes belong. In some such graphs, the relationship represents an undirected and/or omnidirectional connection between two or more nodes. For example, in a graph representing a geographic region, each node may represent a city, and each edge may represent a road that connects two or more cities and that can be traveled in either direction. By contrast, a directed edge includes a direction of the relationship between a first node and a second node. For example, in a graph representing a genealogy or lineage, each node represents a person, and each edge connects a parent to a child. A first directed edge that connects a first node N1 to a second node N2 is not equivalent to a second directed edge that connects the second node N2 to the first node N1. Some graph data sets include one or more unidirectional edges, that is, an edge with one direction among two or more connected nodes. Some graph data sets include one or more multidirectional edges, that is, an edge with two or more directions among the two or more connected nodes. Some graph data sets may include one or more undirected edges, one or more unidirectional edges, and/or one or more multidirectional edges. For example, in a graph representing a geographic region, each node may represent a city; one or more unidirectional edges may represent a one-way road that connects a first city to a second city and can only be traveled from the first city to the second city; and one or more bidirectional or undirected edges that represent a bidirectional road between the first city and the second city that can be traveled in either direction. Some graph data may include, for two or more nodes, a plurality of edges that interconnect the two or more nodes. For example, a graph data set representing a collection of devices may include nodes that respectively correspond to each device of the collection and edges that respectively correspond to an instance of communication and/or interaction among two or more of the devices. In such a graph data set, a particular subset of two or more devices may engage in a plurality, including a multitude, of instances of communication and/or interaction, and may therefore be connected by a plurality, including a multitude, of edges.

Some directed and/or undirected graph data sets may include one or more cycles. For example, in a graph representing a social network, a first edge E1 may connect a first node N1 (representing a first person) and a second node N2 (representing a second person) to represent a relationship between the first person and the second person. A second edge E2 may connect the second node N2 and a third node N3 (representing a third person) to represent a relationship between the second person and the third person. A third edge E3 may connect the third node N3 and the first node N1 to represent a relationship between the third person and the first person. Such cycles can occur in undirected graphs (e.g., edges in a social network graph that indicate mutual relationships among two or more individuals), directed graphs (e.g., edges in a social network graph that indicate that a first person is influenced by a second person, a second person is influenced by a third person, and a third person is influenced by the first person), and/or hypergraphs (e.g., cycles of relationships among three or more clusters that respectively include three or more nodes). Some cyclic graphs may include one or more cycles that are interlinked (e.g., one or more nodes and/or edges that are included in two or more cycles). Other directed and/or undirected graph data sets may be acyclic (e.g., graphs in which nodes are strictly arranged according to a top-down hierarchy). Still other directed and/or undirected graph data sets may be partially acyclic (e.g., mostly acyclic) but may include one or more cycles among one or more subsets of nodes and/or edges.

In some graph data sets, one or more nodes includes one or more node properties. For example, in a graph representing a geographic area, each node may represent a city, and each node may include one or more node properties that correspond to one or more properties of the city, such as a size, a population, or a latitude and/or longitude coordinate. Each node property may be of various types, including (without limitation) a Boolean value, an integer, a floating-point number, a set of numbers such as a vector, a string, or the like. In some graph data sets, one or more nodes does not include a node property. For example, in a graph data set representing a set of particles, each particle may be identical to each other particle, and there may be no specific data that distinguishes any particle from any other particular. Thus, the nodes of the graph data set may not include any node properties.

In some graph data sets, one or more edges includes one or more edge properties. For example, in a graph representing a geographic area, each edge may represent a road, and each edge may include one or more edge properties that correspond to one or more properties of the road, such as a distance, a number of lanes, a direction, a speed limit, a volume of traffic, a start latitude and/or longitude coordinate, and/or an ending latitude and/or longitude coordinate. In some graph data sets, a direction of an edge may be represented as an edge property. Alternatively or additionally, in some graph data sets, a direction of an edge may be represented separately from one or more edge properties. In some graph data sets, one or more edges does not include an edge property. For example, in a graph data set representing a line drawing of a set of points, each edge may represent a line connecting two points, and the edges may be significant only due to connecting two points. Thus, the edges of the graph data sets may not include any edge properties.

In some graph data sets, the graph includes one or more graph properties. Such graph properties may be global graph properties that correspond to one or more properties of the entire graph. For example, in a graph data set representing a geographic region, the graph may include graph properties such as a total number of nodes and/or cities, a two-dimensional or three-dimensional area represented by the graph, and/or a latitude and/or longitude of a center of the graph. Such graph properties may be global graph properties that correspond to one or more properties of all of the nodes of the graph. For example, in a graph data set representing a geographic region, the graph may include graph properties such as an average population size of the cities represented by the nodes and/or an average connectedness of each city to other cities included in the graph.

Some graph data sets include a single set of data that includes all nodes and all edges. For example, a graph representing a geographic region may include a set of nodes that represent all cities in the geographic region. Some other graph data sets include one or more subgraphs, wherein each subgraph includes a subset of the nodes of the graph and/or a subset of the edges of the graph. For example, a graph representing a geographic region may include a number of subgraphs, each representing a subregion of the geographic region, and the edges that interconnect the cities within each subregion. As another example, a graph representing a geographic region may include a first subgraph representing cities (e.g., groups of people over a threshold population size and/or population density) and a second subgraph representing towns (e.g., groups of people under the threshold population size and/or population density). In some graph data sets, each node and/or each edge belongs exclusively to one subgraph. In some graph data sets, at least one node and/or at least one edge can belong to two or more subgraphs. For example, in a graph representing a geographic region that includes a number of subgraphs respectively representing different geographic subregion, each node representing a city may be exclusively included in one subgraph, while each edge may interconnect two or more cities within one subgraph (i.e., within one subregion) or may interconnect a first city in a first subgraph (i.e., within a first subregion) and a second city in a second subgraph (i.e., within a second subregion).

Graph neural networks can include features and/or functionality that are the same as or similar to the features and/or functionality of other neural networks. For example, graph neural networks include one or more neurons arranged in various configurations. Each neuron receives one or more inputs from the graph data set or another neuron, evaluates the one or more inputs (e.g., via an activation function), and generates one or more outputs that are delivered to one or more other neurons and/or as an output of the graph neural network. Examples of activation functions that can be included in various neurons of the graph neural network include (without limitation) a Heaviside or unit step activation function, a linear activation function, a rectified linear unit (ReLU) activation function, a logistic activation function, a tanh activation function, a hyperbolic activation function, or the like.

As an example, some graph neural networks include only a single neuron, or only a single layer of neurons that is configured to receive graph data as input and to provide graph data as output of the graph neural network. Some graph neural networks are arranged in a series of two or more layers, wherein input is received by neurons included in a first layer. The output of one or more neurons included in the first layer is delivered, as input, to one or more neurons included in a second layer. For example, each neuron in the first layer may include one or more synapses that respectively interconnect the neuron to one or more neurons of the second layer. In many graph neural networks, each neuron N1 of a preceding layer L1 is connected to each neuron N2 of a following layer by a synapse that includes a weight W. Neuron N2 receives, as input, the output of the neuron N1 multiplied by the weight of the synapse connecting neuron N1 and neuron N2. In many neural networks, layer L1 includes a bias B, which is added to the product of the output of neuron N1 and the weight W of the synapse connecting neuron N1 and neuron N2. As a result, the input to neuron N2 includes the sum of the bias B of layer L1 and the product of the output of neuron N1 and the weight W of the synapse connecting neuron N1 and neuron N2. The output of the neurons included in the second layer can be provided as an output of the graph neural network and/or as input to one or more neurons included in a third layer. Each layer of the graph neural network may include a same number of neurons as a preceding and/or following layer of the graph neural network, or a different number of neurons as preceding and/or following layer of the graph neural network.

As another example, some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. For example, some graph neural networks (e.g., graph convolution networks) include one or more convolutional layers, each of which performs a convolution operation to an output of neurons of a preceding layer of the graph neural network.

As another example, some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells.

As another example, some graph neural networks feature recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input. As another example, some graph neural networks may include one or more skip connections, in which at least a portion of an output of a first layer is provided as input to a third layer without being processed by a second layer. That is, the output of the first layer is provided as input both to the second layer (which generates a second layer output) and to the third layer. In some such graph neural networks, the third layer receives, as input, either the output of the first layer or the output of the second layer. That is, the third layer multiplexes between the output of the first layer and the output of the second layer. Alternatively or additionally, in some such graph neural networks, the third layer receives, as input, both the output of the first layer and the output of the second layer (e.g., as a concatenation of the output vectors to generate the input vector for the third layer), and/or an aggregation of the output of the first layer and the output of the second layer (e.g., a sum or average of the output of the first layer and the output of the second layer). Examples of graph neural networks that include one or more skip connections include jump knowledge networks and highway graph neural networks (highway GNNs).

As another example, some graph neural networks include two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In these and other graph neural networks, the number of layers and the configuration of each layer of the graph neural network (e.g., the number of neurons and the activation function used by each neuron of each layer) can be referred to as hyperparameters of the graph neural network that are determined upon generation of the graph neural network. The weights of node synapses and/or the biases of the layers can be referred to as parameters of the graph neural network that are learned through a training or retraining process. Further explanation and/or examples of various concepts of other types of neural networks that can also apply to graph neural networks, and additional concepts that apply to other types of neural networks that can also be included in graph neural networks, are presented elsewhere in this disclosure and/or will be known to or appreciated by persons skilled in the art.

Unlike other types of neural networks, graph neural networks are configured to receive, process, generate, and/or transform one or more graph data sets. Some graph neural networks are configured to receive data representing and/or derived from a graph data set, such as an input vector that includes data representing one or more nodes of the graph (optionally including one or more node properties of one or more nodes), one or more edges of the graph (optionally including one or more edge properties of one or more edges), and/or one or more graph properties of the graph. Some graph neural networks are configured to receive an input vector comprising all of the data of a graph data set (e.g., all of the data representing all nodes, all edges, and the graph). Some graph neural networks are configured to receive an input vector comprising only a portion of the data of a graph data set (e.g., only a subset of the nodes of the graph and/or only a subset of the edges of the graph). For example, some graph data sets include a number of subgraphs, and the input vector to the graph neural network includes the data for all of the nodes and/or all of the edges included in one subgraph of the graph. The entire graph can be processed by processing (e.g., concurrently and/or consecutively) each subgraph and combining the output resulting from the processing of each subgraph. As another example, a graph data set representing a set of users of a social network may be processed by a graph neural network that receives, as input, a subset of nodes that correspond to the most influential users of the social network (e.g., those having more than a threshold number of social network connections) and a subset of edges that interconnect the nodes representing those users. Some graph neural networks are configured to receive, as input, data derived from a graph neural network. For example, a graph data set representing a social network may be processed by a graph neural network that receives, as input, data associated with messages exchanged among users of the social network, and provides, as output, an analysis of the messages. Some graph neural networks are configured to receive, as input, non-graph data (e.g., an input vector including coordinates of roads and/or cities in a geographic region) and generate graph data as output (e.g., a graph including odes that represent the cities, and edges that represent roads interconnecting the nodes representing the cities).

Some graph neural networks are configured to process input data as graph data. As an example, some graph neural networks are configured to receive, as input, data that represents each of one or more nodes of a graph data set and one or more edges that respectively interconnect two or more nodes of the graph data set. The graph neural network may process a state of each node and/or edge of the input graph data in order to generate an updated state of the node and/or edge. The term “message passing” refers to evaluating and updating the state of a node N or an edge E of a graph based on the states of one or more neighboring nodes N and/or connecting edges E. For example, for each node N1, the graph neural network may evaluate the state of node N1 and/or states of a set of nodes N that are connected to node N1 by at least one edge (e.g., a neighborhood of nodes that includes N1) and may determine an updated state of node N1 based on the state of the node N1 and/or the states of the neighboring nodes N. As another example, for each node N1, the graph neural network may evaluate the state of the node N1 and/or the states of a set of edges E that connect node N1 to one or more other nodes of the graph, and may determine an updated state of node N1 based on the state of the node N1 and/or the states of the edges E. As yet another example, for each edge E1 of the input graph, the graph neural network may evaluate a state of the edge E1 and/or the states of a set of nodes N of the graph that are connected to the edge E1 and may determine an updated state of edge E1 based on the state of the edge E1 and/or the states of the connected nodes N. As yet another example, for each edge E1 of the input graph that connects a set of nodes N of the graph, the graph neural network may evaluate the state of the edge E1 and the states of the set of edges E that are also connected at least one of the set of nodes N and may determine an updated state of edge E1 based on the state of the edge E1 and/or the states of the other edges. In these and other scenarios, each node N and/or each edge E is evaluated and updated based on a collection of “messages” corresponding to the states of neighboring nodes N and/or connecting edges E.

In some graph neural networks, each node N1 is updated based a neighborhood of size 1, including only on the states of the edges E that are directly connected to node N1 and/or the states of the other nodes N that are directly connected to node N1 by an edge. In some other graph neural networks, each node N1 is updated based a neighborhood of a size S greater than 1, including the states of other nodes N that are within S edge connections of node N1 and/or edges E that are connected to any such nodes N. In some graph neural networks, each edge E1 is updated based a neighborhood of size 1, including only on the states of the nodes N that edge E1 connects and/or the edges E that are also connected to the nodes N that edge E1 connects. In some other graph neural networks, each edge E1 is updated based a neighborhood of a size S greater than 1, including the states of other nodes N that are within S edge connections of node N1 and/or the set of edges E that are connected to any such nodes N. In some graph neural networks with a neighborhood of size greater than 1, one or more first layers of neurons process each node and/or edge based on the nodes and/or edges within a neighborhood of size 1; a second one or more following layers of neurons further process each node and/or edge based on the nodes and/or edges within a neighborhood of size 2; and so on. That is, the first one or more layers update the state of each node and/or edge based on the states of the directly connected nodes and/or edges, and each following one or more layers further updates the state of each node and/or edge additionally based on the states of indirectly connected nodes and/or edges that are one or more further connections.

In some graph neural networks, the states of nodes N and/or edges E are evaluated and updated concurrently (e.g., the graph neural network may evaluate the features relevant to each node N and/or each edge E to determine an update, and may do so for all nodes N and/or all edges E, before applying the updates to update the internal states of each node N and/or each edge E). In some graph neural networks, the states of nodes N and/or edges E are evaluated and updated consecutively (e.g., the graph neural network may evaluate the features relevant to a first node N1 and update the state of node N1 before evaluating the features relevant to a second node N2 and updating the state of node N2). In some graph neural networks, the states of the nodes N and/or the edges E are consecutively evaluated and updated according to a sequential order (e.g., the graph neural network first evaluates and updates a state of a first node N1 that is of a high priority, and then evaluates and updates a state of a first node N2 that is of a lower priority than N1). In some graph neural networks, a state of a node N2 is evaluated after updating a state of a node N1 and, further, based on the updated state of node N1. In some graph neural networks, a state of an edge E2 is evaluated after updating a state of an edge E1 and, further, based on the updated state of an edge E1. In some graph neural networks, the states of nodes N are concurrently evaluated and updated, and then the states of edges E are concurrently evaluated and updated concurrently. In some graph neural networks, the states of edges E are concurrently evaluated and updated, and then the states of nodes N are concurrently evaluated and updated concurrently. These variations in the order of updating the nodes N and/or edges E can be variously combined with the previously discussed variations in the processing of neighborhoods. For example, a graph neural network may include a first one or more layers that are configured to evaluate and concurrently update the states of all nodes and edges within a neighborhood of size 1, followed by a second one or more layers that are configured to evaluate and concurrently update the states of all nodes and edges within a neighborhood of size 2. Another graph neural network may a graph neural network may include a first one or more layers that are configured to evaluate and concurrently update the states of all nodes within a neighborhood of size 1, followed by a second one or more layers that are configured to evaluate and concurrently update the states of all nodes within a neighborhood of size 2, further followed by one or more layers that are configured to update the states of all edges within a neighborhood of size 1 or more.

Some graph neural networks are configured to evaluate and/or update one or more node properties of one or more nodes of a graph data set. For example, a graph representing a social network may include nodes that represent people, and a graph neural network may evaluate the nodes and/or edges of the graph to predict one or more node properties that correspond to attributes of the person, such as a type of the person, an age of the person, or an opinion of the person. Some graph neural networks are configured to evaluate and/or update one or more edge properties of one or more edges of a graph data set. Some graph neural networks are configured to evaluate and/or update one or more edge properties of one or more edges of a graph data set. For example, a graph representing a social network may include nodes that represent people and edges that represent relationships between people, and a graph neural network may evaluate the nodes and/or edges of the graph to predict one or more edge properties that correspond to attributes of a relationship among two or more people, such as a type of the relationship, a strength of a relationship, or a recency of the relationship. Some graph neural networks are configured to evaluate and/or update one or more graph properties of the graph data set. For example, a graph representing a social network may include nodes that represent people and edges that represent relationships between people, and a graph neural network may evaluate the nodes and/or edges of the graph to predict a feature of a social group to which all of the people belong, such as a common interest or a common demographic trait that is shared by at least many of the people of the social network.

Some graph neural networks are configured to generate graph data as output. The generated graph data may include one or more nodes (optionally including one or more node properties), one or more edges (optionally including one or more edge properties), and/or one or more graph properties. The generated graph data may be based on input graph data. Some graph neural networks may be configured to receive at least a portion of a graph data set as input, and may generate, as output, modified graph data. As an example, the input graph data set may include a number of nodes and a number of edges interconnecting the nodes, and in the output graph data set generated by the graph neural network, each of the nodes and/or edges of the graph may have been updated based on one or more nodes and/or one or more edges of the input graph data. For example, an input graph data set may represent a social network including a nodes representing people and edges representing relationships between people. A graph neural network may be configured to receive at least a portion of the input graph data set, and may output an adjusted graph data set, wherein a state at least one of the nodes and/or at least one of the edges is updated based on the processing of the input data set. For example, various edges representing relationships may be updated to include additional data (e.g., edge properties) to represent an updated relationship between two people represented by nodes. Various nodes may be updated with to include additional data (e.g., node properties) to represent updated information about corresponding people based on the relationships. Various graph properties of the at least a portion of the graph data set may be updated based on the updated edges and/or nodes, e.g., a new common interest that is shared among many of the people in the social network.

Some graph neural networks may be configured to output graph data that includes one or more newly discovered nodes based on the input graph data set. For example, an input graph data set representing travel events may include edges that include routes of travelers and nodes that represent locations of interest. A graph neural network may receive the input graph data set, and based on processing of the routes of the travelers, may output an updated graph data set that includes a new node that represents a new location of interest (e.g., a destination of a large number of recent travelers). The output of the graph neural network may include, for one or more new or existing nodes, one or more new or updated node properties (e.g., a classification of the location of interest based on the travel routes). Alternatively or additionally, some graph neural networks may be configured to output graph data that excludes one or more existing nodes of an input graph data set. For example, based on processing the input data set representing routes of travelers, a graph neural network may output an updated graph data set that excludes one of the nodes of the input graph data set representing a location that is no longer a location of interest (e.g., a destination that travelers no longer visit).

Some graph neural networks may be configured to output graph data that includes one or more newly discovered edges based on the input graph data set. For example, an input graph data set may represent a social network including nodes that represent people and edges that represent connections between people. A graph neural network may receive the input graph data set, and based on processing of the people and connections, may output an updated graph data set that includes a new connection between two people (e.g., a likely relationship based on shared traits and/or mutual relationships with a number of other people representing a social circle). The output of the graph neural network may include, for one or more new or existing edges, one or more new or updated edge properties (e.g., a classification of a relationship between two or more people). Alternatively or additionally, some graph neural networks may be configured to output graph data that excludes one or more existing edges of an input graph data set. For example, based on processing the input data set representing a social network, a graph neural network may output an updated graph data set that excludes one or more of the edges of the input data set representing a relationship that no longer exists (e.g., a lost connection based on a splitting of a social circle).

Some graph neural networks may output graph data that is based on data that does not represent an input graph data set. For example, a graph neural network may be configured to receive non-graph data, such as lists of travel routes of drivers, and may generate and output a graph data set including nodes that represent locations of interest and edges that interconnect the locations of interest. Conversely, some graph neural networks may receive input that includes at least a portion of a graph data set and that outputs non-graph data based on the input graph data. For example, a graph neural network may be configured to receive input including graph data, such as a graph of a social network including nodes that represent people and edges that represent connections, and to output non-graph data based on analyses of the input graph data, such as statistics about the people represented in the social network and activity occurring therein.

### Graph Neural Networks—Properties

Graph neural networks, including (without limitation) those described above, may be subject to various properties and/or considerations of design and/or operation. These considerations may affect their architecture, processing, implementation, deployment, efficiency, and/or performance.

As previously discussed, graph neural networks may include edges with varying directionality, such as undirected edges (e.g., edges that represent distances between pairs of nodes that represent cities in a graph that represents a region), unidirectional edges (e.g., edges that represent parent/child relationships among nodes that represent people in a graph that represents a genealogy or lineage), and/or multidirectional edges (e.g., bidirectional edges that represent bidirectional roads between nodes that represent cities in a graph that represents a region). In some graph data sets, all of the edges have a same directionality (e.g., all edges are undirected). A graph neural network can be configured to receive an input vector corresponding to the input data set and to process the edges according to the uniform directionality of the edges (e.g., processing undirected edges without regard to the order in which the nodes are represented as being connected to the edge). Other graph data sets may include edges with different directionality (e.g., in a graph that represents a region, edges can represent roads between nodes that represent cities, and each edge can be either unidirectional to represent a one-way road or bidirectional to represent a two-way road). A graph neural network can be configured to receive an input vector corresponding to the input data set and to process the edges according to the distinct directionality of each edge (e.g., processing a unidirectional edge in a different manner than a bidirectional edge). As one such example, the graph neural network can interpret a bidirectional edge connecting two nodes N1, N2 as a first unidirectional edge that connects node N1 to N2 and a second unidirectional edge that connected node N2 to node N1. The pair of unidirectional edges can share various edge properties and/or can be evaluated and/or updated in a same or similar manner (e.g., for a pair of unidirectional edges corresponding to a bidirectional road, the graph neural network can process data representing a weather condition in a same or similar manner to both unidirectional edges associated with the bidirectional road).

As previously discussed, some graph neural networks are configured to process nodes according to a “message passing” paradigm, in which the evaluation of each node N1 is based on the states and/or evaluations of other nodes within a neighborhood of the node N1 and/or the edges that connect the node N1 to other nodes in the neighborhood of the node N1. That is, the state of each node in the neighborhood of the node N1 and/or the state of each edge that connects N1 to other nodes of the neighborhood serves as a “message” that informs the evaluation and/or updating of the state of node N1 by the graph neural network. Alternatively or additionally, the evaluation of each edge E1 is based on the states and/or evaluations of other edges within a neighborhood of the edge E1. That is, the state of each node connected by edge E1, and, optionally, the states of other nodes connected to those nodes and/or other edges in such connections, serves as a “message” that informs the evaluation and/or updating of the state of edge E1 by the graph neural network. In each case, the size of the neighborhood can vary; for example, the graph neural network can evaluate each node according to a one-hop neighborhood or a multi-hop neighborhood. Graph neural networks that perform multi-hop neighborhood evaluation can include multiple layers, where a first one or more layers are configured to process a first hop between a node N1 and a one-hop neighborhood including its directly connected neighbors and/or directly connected edges, and a second one or more layers following the first one or more layers are configured to process a second hop between the nodes and/or edges of the one-hop neighborhood and additional nodes and/or edges that are directly connected to the nodes and/or edges of the one-hop neighborhood. In this manner, each node N1 is first evaluated and/or updated based on message passing among the one-hop neighborhood, and is then evaluated and/or updated based on additional messages within the two-hop neighborhood, etc. Other architectures of graph neural networks may perform multi-hop neighborhood evaluation in other ways, e.g., by processing individual clusters of nodes and/or edges to perform message passing among the nodes and/or edges of each cluster, and then performing additional message passing between clusters to update nodes and/or edges of each cluster based on the nodes and/or edges of one or more neighboring clusters.

In some scenarios, a graph may include nodes and/or edges that are stored, represented, and/or provided as input that is not subject to any particular order (e.g., nodes representing points in a line drawing may not have any node properties, and may therefore be represented in arbitrarily different orders in the input graph data set). In such scenarios, a multitude of semantically equivalent input graph data sets may be logically equivalent to one another. That is, a first representation of a graph may include the nodes and/or edges in a particular order, while a second representation of the same graph may include the same nodes and/or edges in a different order. While both representations of the graph are logically equivalent, the different ordering in which the nodes and/or edges are provided as input to the graph neural network may cause the graph neural network to provide different output. In other scenarios, a graph comprising a set of nodes and a set of interconnecting edges may be organized, stored, and/or represented in a particular order. For example, the nodes may be ordered according to a property of the nodes, and/or edges may be ordered according to a property of the edges (e.g., in a social network, nodes representing people may be ordered according to the alphabetical order of their names, and edges representing relationships may be ordered according to the alphabetical order of the names of the related people). In such scenarios, changes to the order and/or the selected subsets of graph data may result in different input data sets that represent the same or similar (e.g., logically equivalent) graphs. Due to the manner in which a graph neural network processes the input graph data set, logically equivalent input graph data sets may result in different and logically distinct output data.

In such scenarios, it may be undesirable for the graph neural network to generate different output for different but logically equivalent representations. That is, it may be desirable for the graph neural network to provide the same or equivalent output for different but logically equivalent representations of a graph. Graph neural networks that exhibit this property can be referred to as “permutation invariant,” that is, capable of providing output that does not vary across permutations in the representation of the input graph data set. A variety of techniques may be used to achieve, improve, and/or promote permutation invariance. Some such techniques involve changing representations of the input data set. For example, before processing an input graph data set, the graph neural network may reorder the input data set (e.g., by reordering the units of an input vector) such that nodes and edges are represented in a consistent order. As one such example, an input graph data set may include nodes that represent cities, and the input graph data set may include the nodes and/or edges in varying orders. Prior to processing the input graph data set, the graph neural network may reorder the nodes based on latitude and longitude coordinates of the cities, and the edges can similarly be reordered based on the latitude and longitude coordinates of the nodes connected by each edge. Thus, any representation of the graph including nodes that represent the same set of cities is processed in a similar manner. Similar reordering may involve various node properties and/or edge properties, including (without limitation) an alphabetic ordering of names in a graph including nodes that represent people, a chronological ordering of dates in a graph including nodes that represent events, a numeric ordering of content-based hashcodes in a graph including nodes that represent objects, and/or a numeric ordering of identifiers in a graph including nodes that possess unique numeric identifiers. Other techniques for achieving, improving, and/or promoting permutation invariance involve transforming an input graph data set into a different, permutation-invariant representation that is provided as input to and processed by the graph neural network. For example, a graph data set representing a two-dimensional image or a three-dimensional point cloud may include nodes that represent pixels and edges that represent spatial relationships (e.g., distances and/or orientations) between respective pairs of pixels of the image or respective pairs of points in the point cloud. Different orderings of the pixels and/or points may result in differently ordered, but logically equivalent, graph data sets for a particular image or point cloud. Instead of processing the graph data sets as input, a graph neural network may be configured to convert the input graph data set into a spectral representation, e.g., based on a spectral decomposition of a Laplacian L of the input graph data set. Instead of encoding information about individual pixels and/or points, the spectral representation instead encodes spectral components of the input graph data sets. The spectral components can be ordered in various ways (e.g., by frequency and/or polynomial order) to generate a permutation-invariant input vector, and the processing of the permutation-invariant input vector by a graph neural network may result in invariant (e.g., identical or at least similar) output of the graph neural network for various permutations of the input graph data set.

Alternatively or additionally, some techniques for achieving, improving, and/or promoting permutation invariance may relate to the structure of the graph neural network. For example, as an alternative or addition to reordering an input graph data set, a graph neural network may include one or more layers of neurons that process an input vector and generate permutation-invariant output. As one such example, a graph neural network may include a pooling layer that receives an input vector (e.g., an input vector corresponding to an input graph data set, and/or an input vector corresponding to an output of one or more previous layers of the graph neural network) and generates output that is pooled over the input, such as a minimum, maximum, or average of the units of the input. Because operations such as a minimum, maximum, and/or average over a data set are permutation-invariant mathematical operations, the graph neural network may therefore exhibit permutation-invariance of output based on the pooling operation for differently ordered but logically equivalent representations of a particular graph data set. As another such example, a graph neural network may include a filtering layer that receives an input vector (e.g., an input vector corresponding to an input graph data set, and/or an input vector corresponding to an output of one or more previous layers of the graph neural network) and generates output that is filtered based on certain permutation-invariant criteria. For example, in a graph representing a social network that includes nodes representing people, a layer of the graph neural network may filter the nodes to limit the input data set based on the top n nodes of the graph neural network that correspond to the most influential people in the social network. Such filtering may be based, e.g., on a count of the edges of each node (i.e., a count of the number of relationships of each person to other people of the social network), or a weighted calculation based on the influence of the nodes to which each node is related and/or the strength of each such relationship. Because such filtering operation are permutation-invariant logical operations, the graph neural network may therefore exhibit permutation-invariance of output based on the filtering operation for differently ordered but logically equivalent representations of the nodes (i.e., people) and edges (i.e., relationships) of the social network. As yet another example, some graph neural networks include an encoding or “bottleneck” layer, in which an output from N neurons of a preceding layer is received as input and processed by a following layer that includes fewer than N neurons. Due to the smaller number of neurons in the following layer, the volume of data that encodes features of the output of the preceding layer is compressed into a smaller volume of data that encodes features of the output of the following layer. This compression of features, based on learned parameters and training of the graph neural network to produce expected outputs, can cause the graph neural network to encode only more significant features of the processed data, and to discard less significant features of the processed data. The reduced-size output of the neurons of the following layer can be referred to as a latent space encoding of the input feature set. For example, whereas an input graph data set may include nodes that correspond to all pixels of an image of a cat, and an output of a previous layer of the graph neural network may include partially processed information about each node (i.e., each pixel) of the image of the cat, the output of the following layer of the graph neural network may include only features that correspond to visually significant features of the cat (e.g., features that correspond to the pixels that represent the distinctively shaped ears, eyes, nose, and mouth of the cat). Thus, the latent space encoding may reduce the processed input of the graph data set into a smaller encoding of nodes that represent significant visual features of the graph data set, and may exclude data about nodes that do not represent significant visual features of the graph data set. Many such graph neural networks include one or more “bottleneck” layers as one or more autoencoder layers, e.g., layers that automatically learn to generate latent space encodings of input data sets. As one such example, deep generative models may be used to generate output graph data that corresponds to various data types (e.g., images, text, video, scene graphs, or the like) based on an encoding, including an autoencoding, of an input such as a prompt or a random seed, Additional techniques for achieving or promoting permeation-invariance are presented elsewhere in this disclosure and/or will be known to or appreciated by persons skilled in the art.

In some scenarios, a graph data set may include a large number of nodes and/or a large number of edges. For example, a graph data set representing a social network may include thousands of nodes that represent people and millions of edges that represent relationships among the people. The size of the graph data set may result in an input vector that is very large (e.g., a very long input vector), and that might require a correspondingly large graph neural network to process (e.g., a graph neural network featuring millions of weights that connect the input graph data set to the nodes of a first layer of the graph neural network). The size of the input data set may result in large and perhaps prohibitive computational resources to receive and/or process the graph data set (e.g., large and costly storage and/or processing to store the input graph data set and/or the parameters and/or hyperparameters of the graph neural network, and/or a protracted delay in completing the processing of an input graph data set by the graph neural network). Further, the graph data set may exhibit properties of sparsity that cause a large portion of the input data set to be inconsequential. For example, a graph data set representing a social network may be encoded as a vector of N units respectively representing each node (i.e., each person) followed by a vector of N×N units that respectively represent a potential relationship between each node N1 and each node N2. Edges that represent a multidimensional mapping of connections between nodes (such as an N×N mapping of edges that represent possible connections between nodes) can be referred to as an adjacency matrix. However, in the social network, most person may have only a small number of relationships (i.e., far less than N−1 relationships with all other people of the social network). Thus, in the vector encoding of the input graph data set, a large majority of the N×N units that respectively represent potential relationships between each pair of nodes N1, N2 (i.e., the adjacency matrix) may be negative or empty (representing no relationship), and only a very small minority of the N×N units that respectively represent potential relationships between each pair of nodes N1, N2 may be positive or non-empty (representing a relationship). As another example, a graph data set representing a region may include N nodes representing cities and N×N edges representing possible roads between cities. However, if each city is only directly connected to a small number of neighboring cities, then a large majority of the N×N edges representing possible roads between cities (i.e., the adjacency matrix) may be negative or empty (representing no road connection), and only a very small minority of the N×N units that respectively represent potential roads between each pair of nodes N1, N2 may be positive or non-empty (representing an existing road). In such cases, the sparsity of an input vector representing the graph neural network may inefficiently consume computational resources (e.g., inefficiently applying storage and/or computation to large numbers of negative or empty units of the input vector) and/or may unproductively delay the completion of processing of the input graph data set.

Various techniques can be applied to reduce the sparsity of graph data sets and the processing of such graph data sets by graph neural networks. As a first example, the graph neural network can be pruned to reduce the number of nodes and/or edges included as an input data set (e.g., filtering the nodes of a graph neural network to a small cluster of densely related nodes, such as a small number of highly interrelated nodes that represent the members of a social circle in a social network). As a second example, the graph neural network can be encoded in a way that reduces sparsity. For example, rather than encoding the input graph data set as an adjacency matrix, the graph neural network may be configured to receive an encoding of the input graph data set as an adjacency list, i.e., as a list of edges that respectively connect two or more nodes of the graph. Due to encoding only information about existing edges, an adjacency list can eliminate or at least reduce the encoding of nonexistent edges. As a result, the size of the adjacency list may therefore be much smaller than a size of a corresponding adjacency matrix, and can therefore eliminate or at least reduce the sparsity of the input graph data set. The adjacency list can include edge properties of the edges of the graph data set. The adjacency list can be limited to a particular size (e.g., the top N most influential connections in a social network). The nodes of the input graph data set can be limited based on the edges included in the adjacency list (e.g., excluding any nodes that are not connected to at least one of the edges included in the adjacency list). As yet another example, rather than encoding an entire set of nodes and edges, a graph neural network can be represented as an encoding of the nodes and edges. For example, a graph data set may include nodes that represent pixels of an image and edges that represent spatial representations of the pixels. However, if large areas of the image are inconsequential (e.g., dark, empty, or not associated with any notable objects in a segmented image), then large portions of the nodes and/or edges would be inconsequential. Instead, the image can be reencoded as a frequency-domain representation as coefficients associated with respective frequencies of visual features within the image. The frequency-domain representation may present greater information density than the adjacency matrix of pixels, and therefore may present an input to the graph neural network that encodes the visual features of the input graph data set with reduced sparsity.

Other techniques for eliminating or reducing sparsity, and therefore increasing efficiency, involve the architecture of the graph neural network. For example, the input graph data set may encode edges as an adjacency matrix, and a first layer of the graph neural network may reencode the edges of the input graph data set as an adjacency list for further processing by the graph neural network. As another example, the graph neural network may include a first one or more layers that is configured to process an entirety or at least a large portion of the nodes and/or edges of an input graph data set, followed by a filtering layer that is configured to limit an output of the first one or more layers of the graph neural network. For example, in a graph data set that includes nodes that represent people and edges that represent connections, a first one or more layers may process all of the nodes and/or edges, and a filtering layer can limit the further processing of the output of the first one or more layers to the nodes and/or edges for which the outputs of the first one or more layers are above a threshold (e.g., an influence and/or relationship significance threshold). As still another example, the graph neural network may receive a sparse graph input data set but may only process a portion of the input graph data set (e.g., one or more random sampling of subsets of nodes and/or edges). In some cases, the graph neural network may compare results of the processing of subsets of the input graph data set (e.g., randomly sampled subsets of the nodes and/or edges) and may aggregate such results until the results appear to converge within a confidence threshold. In this manner, the graph neural network may generate an acceptable output within the confidence threshold while avoiding processing an entirety of the sparse input graph data set. Many such techniques for eliminating and/or reducing sparsity are presented elsewhere in this disclosure and/or will be known to or appreciated by persons skilled in the art.

### Graph Neural Networks—Input, Processing, and Output

Graph data sets may represent a variety of data types, including (without limitation) maps of geographic regions, including nodes representing cities and edges representing roads that connect two or more cities; social networks, including nodes representing people and edges representing relationships between two or more people; communication networks, including nodes representing people or devices and edges representing communication connections between the nodes or edges; economies, including nodes representing companies and edges representing transactions between two or more companies; molecules, including nodes representing atoms and edges representing bonds between two or more atoms; collections of events, including nodes representing individual events and edges representing causal relationships among two or more events; and periods of time, including nodes representing events and edges representing chronological periods among two or more events. Graph data sets may also be represent data types, such as passages of text, including nodes representing words and edges representing relationships among two or more words; images, including nodes representing pixels and edges representing spatial relationships among two or more pixels; object graphs, including nodes representing objects and edges representing dependencies among two or more objects; and three-dimensional spatial maps, including nodes representing three-dimensional objects and edges representing spatial relationships among two or more of the three-dimensional objects. Some graph data sets may include two or more subgraphs. In some such graph data sets, each node and/or each edge is exclusively included in one subgraph. In some other graph data sets, at least one node and/or at least one edge may be included in two or more subgraphs, or in zero subgraphs. Some graph data sets are associated with non-graph data that is also included as input to a graph neural network. For example, a graph neural network that evaluates traffic patterns within a geographic region may receive, as input, both an input graph data set that includes nodes that represent cities and edges that represent roads interconnecting the cities, and also non-graph data representing traffic and/or weather features within the geographic region (e.g., traffic volume estimates and current or forecasted weather conditions that affect the traffic patterns).

As another example, some graph data sets may include an indication of zero or more cycles occurring among the nodes and/or edges of the graph data set. For example, a directed and/or undirected graph data set may include an indication that a particular cycle exists within the graph and includes a particular subset of nodes and/or edges. Alternatively, a directed and/or undirected graph data set may include an indication that the graph is acyclic and does not include any cycles. A graph neural network may be configured to receive, as input, and process a graph data set that includes an indication of zero or more cycles.

As another example, some graph data sets may include nodes for which the edges provide spatial dimensions. As a first example, in a graph representing a geographic region, nodes that represent cities are related by edges that represent distances, wherein the nodes and interrelated edges can form a spatial map of the geographic region. As a second example, in a graph representing a molecule, nodes that represent atoms are related by edges that represent chemical bonds between the atoms, and the arrangement of atoms by the bonds forms a three-dimensional molecular structure. In some such scenarios, the spatial relationships are well-defined by the nodes and edges. In other such scenarios, the spatial relationships can be inferred based on semantic relationships among the nodes and/or edges of the graph data set. For example, in a graph representing a language, nodes that represent words are related by edges that represent semantic relatedness of the words within a high-dimensional language space. A language model can generate an embedding of the words of the language in a multidimensional embedding space, wherein nodes that are close together within the embedding space represent synonyms, closely related concepts, or words that frequently appear together in certain contexts, whereas nodes that are not close together within the embedding space represent unrelated concepts or words that do not commonly appear together in various contexts. A variety of graph embedding models may be applied to this task, including (without limitation) DeepWalk, node2vec, line, and/or GraphSAGE. A graph neural network can be configured to receive, as input, an embedding of a graph data set instead of representations of the nodes and/or edges of the graph data set. Alternatively, a graph neural network can be configured to receive an input graph data set including representations of the nodes and/or edges of the graph data set, generate an embedding based on the input graph data set, and apply further processing to the embedding instead of to the input graph data set. A graph neural network that is configured to process an embedding instead of an input graph data set may exhibit greater permutation invariance (e.g., due to the semantic associations represented by the embedding) and/or increased efficiency due to reduced sparsity of the input.

Some graph data sets include representations of each of one or more nodes and each of one or more edges. Some graph neural networks are configured to receive and process such representations of graph neural networks. For example, the graph neural network may be configured to receive an input vector including an array of data representing each of the one or more nodes followed by an array of data representing each of the one or more edges, either as an adjacency matrix of possible edges between pairs of nodes or an adjacency list of existing edges. The input vector may encode the nodes and/or edges in a particular order (e.g., a priority order of nodes and/or a weight order of edges) or in an unordered manner. Alternatively or additionally, the graph data set may include and/or encode other types of information about each of one or more nodes and/or each of one or more edges of the graph data set. For example, the graph may include a hierarchical organization of nodes and/or edges relative to one another and/or to a fixed reference point. The graph neural network may be configured to receive and process an input graph data set that includes an indication of the arrangement of one or more nodes and/or one or more edges in the hierarchical organization.

As another example, a graph may include an indication of a centrality of one or more nodes and/or edges within the graph (e.g., a graph of a social network including nodes that are ranked based on a centrality of each node to a cluster). The graph neural network may be configured to receive and process an input graph data set that includes an indication of a centrality of one or more nodes and/or one or more edges in the graph.

As another example, a graph may include an indication of a degree of connectivity of one or more nodes and/or edges within the graph (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). The graph neural network may be configured to receive and process an input graph data set that includes an indication of a degree of one or more nodes and/or one or more edges in the graph.

As another example, a graph may include an indication of one or more clusters occurring within the graph. For example, a graph may include a result of a clustering analysis of the graph, e.g., a determination of k clusters within the graph and an identification of the nodes and/or edges that are included in each cluster. The clusters may be determined by a k-means clustering analysis, a Gaussian mixture model of with variable numbers of clusters and variable Gaussian orders, or the like. A graph may include a clustering coefficient of one or more nodes and/or one or more edges (e.g., a measurement of a degree to which at least some of the nodes and/or edges of a subgraph of the graph are clustered based on similarity and/or activity). The graph neural network may be configured to receive and process an input graph data set that includes an indication of a clustering coefficient of one or more nodes and/or one or more edges in the graph or a subgraph thereof.

As another example, a graph may include an indication of a graphlet degree vector that indicates a graphlet that is represented one or more times in the graph. For example, in a graph representing atoms in a regular structure such as a crystal, the graph may include a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet. The graph neural network may be configured to receive and process an input graph data set that includes a graphlet degree vector, and, optionally, features of one or more occurrences of a graphlet in the graph and/or a count of the occurrences of the graphlet in the graph.

As another example, a graph may include an indication of one or more paths and/or traversals of one or more nodes and/or one or more edges of the graph, optionally including additional details associated with a path or traversal such as a popularity, frequency, length, difficulty, cost, or the like. For example, in a graph representing a spatial arrangement of nodes, the graph may include a path or traversal of edges that connect a first node to a second node through zero or more other nodes, as well as properties of the path or traversal such as a total length, distance, time, and/or cost. The graph neural network may be configured to receive and process an input graph data set that includes additional details associated with one or more paths or traversals, including an indication (e.g., a list) of the associated nodes and/or edges and a list of one or more properties of the path and/or traversal.

As another example, a graph may include an indication of metrics or properties that relate one or more nodes and/or one or more edges. For example, in a graph including a spatial arrangement of nodes, the graph may include an indication of a shortest distance between two nodes and/or an indication of a set of nodes and/or edges that are common to two nodes. As another example, a graph representing a network of communicating devices may include a routing table of one or more routes that respectively indicate, for a particular node and a particular edge connected to the node, a list of other nodes and/or edges that can be efficiently reached by traversing based on the particular edge. As yet another example, in a graph representing a social network including nodes that represent people, the graph may indicate, for at least one pair of nodes, a measurement of similarity of the nodes based on their node properties, edges, locations in the social network, connections to other nodes, or the like (e.g., a Katz index of node similarity) and/or, for at least one pair of edges, a measurement of similarity of the edges based on their edge properties, connected nodes, locations in the social network, or the like (e.g., a Katz index of edge similarity). The graph neural network may be configured to receive and process an input graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph may include an indication of various graph properties of the graph (e.g., a graph size, graph density, graph interconnectivity, graph chronological period, graph classification, a count of subgraphs within the graph, or the like). For example, in a graph including two or more subgraphs (e.g., a social network including two or more social circles), the graph data set may include a measurement of a similarity of each subset of at least two subgraphs of the graph. The measurement of the similarity may be determined based on one or more graph kernel methods (e.g., a Gaussian radial basis function that can be applied to the graph to identify one or more clusters of similar nodes that comprise a subgraph). As another example, a graph may include a measurement of similarity with respect to another graph (e.g., an indication of whether a particular social network graph resembles other social network graphs that have been classified as representing a genealogy or lineage, a set of friendships, and/or a set of professional relationships). The graph neural network may be configured to receive and process an input graph data set that includes measurements determined by one or more graph properties (e.g., one or more measurements of similarity of one or more nodes, edges, and/or subgraphs, and/or a measurement of similarity of the graph to other graphs). Further explanation and/or examples of various graph data sets that may be provided as input to graph neural networks are presented elsewhere in this disclosure and/or will be known to or appreciated by persons skilled in the art.

Graph neural networks may be configured to perform various types of processing over such graph data sets. As previously discussed, a graph neural network can be organized as a series of layers, each of which can include one or more nodes that receive input, apply an activation function, and generate output. The output of each node of a first layer can be multiplied by a weight of a connection between the node and a node of a second layer, and then added to a bias associated with the first layer, to generate an input to the node of the second layer. The graph neural network can include various additional layers that perform other types of processing, including (without limitation) pooling, filtering, and/or latent space encoding operations, memory or stateful features, and recurrent and/or reentrant processing.

Some graph neural networks may perform label propagation among the nodes and/or edges of a graph data set. For example, in an input graph data set, one or more nodes and/or one or more edges may be associated with one or more labels of a label set, while one or more other nodes and/or one or more other edges may not be associated with any labels. A graph neural network may apply a label propagation algorithm (LPA) to assign labels to one or more unlabeled nodes and/or one or more unlabeled edges. For example, the graph neural network may assign a label to an unlabeled node based on labels associated with one or more edges connected to the node, and/or with one or more other nodes that are connected to the node by the one or more edges. The graph neural network may assign a label to an unlabeled edge based on labels associated with one or more nodes connected by the edge, and/or with one or more other edges that are also connected to the nodes connected by the edge. Some graph neural networks may perform label propagation based on a voting, consensus, weighting, and/or scoring determination. For example, a graph neural network may be unable to perform a classification of an unlabeled node and/or unlabeled edge based solely on the node properties and/or edge properties, but may be able to perform the classification based on a further consideration of the labels associated with other nodes and/or edges within a neighborhood of the unlabeled node and/or unlabeled edge.

Some graph neural sets may perform a scoring and/or ranking of nodes and/or edges of a graph data set. As an example, in a graph data set that represents the World Wide Web and that includes nodes that represent web pages and directed edges that represent hyperlinks of linking web pages to linked web pages, a graph neural network may determine one or more scores of each node (i.e., each web page) based on the scores of other nodes that hyperlink to the node. Each score may further be based on the scores of the other nodes that include a directed edge to this node (e.g., the scores of other web pages that hyperlink to this page). Additionally, each score associated with a node may represent a weight of an association between the web page and a particular topic (e.g., a particular topic or keyword that is associated with the web page, hyperlinks, and/or other pages that hyperlink to this web page). In some cases, the scores may be personalized based on the activities of a particular user (e.g., based on the hyperlinks from pages that the user frequently visits). A search engine may use the scores as rankings in order to generate search results for web searches including various topics or keywords (e.g., in response to a web search for a particular search term, present search results that correspond to the nodes with the highest scores associated with the search term, and present the search results in ranked order based on the scores). As another example, for a graph data set representing a social network, a graph neural network may generate a reputation score for each node based on other nodes that are associated with the node and the reputation scores of such other nodes. The scores of the nodes may be used to recommend new connections in the social network (e.g., recommending a first person connect with a second person, based on a high reputation score of the second person by people who are closely associated with the first person).

Some graph neural networks may perform a clustering analysis of the nodes and/or edges of a graph data set. As a first example, in a graph data set representing a social network, a graph neural network may perform a clustering analysis of the nodes representing the people of the social network, based on edges representing relationships among two or more nodes, in order to identify one or more clusters that represent social circles of highly interconnected people within the social network. Based on this clustering analysis, the graph neural network may partition the social network into subgraphs that respectively represent social circles, and may perform further, finer-grained evaluation of each social circle and the people represented by the nodes in each subgraph. As a second example, in a graph data set representing a social network, a graph neural network may perform a clustering analysis of the edges representing the relationships among people of the social network, in order to identify one or more clusters that represent different types of relationships, such as familial relationships, friendships, and professional relationships. Based on this clustering analysis, the graph neural network may partition the social network into subgraphs that respectively represent different types of social networks, and may perform further analysis of relationships among two or more individuals based on the type of relationship associated with the subgraph to which the relationship belongs. In these and other scenarios, in order to perform clustering analysis, a graph neural network may utilize a variety of clustering algorithms. As one such example, a graph neural network may apply spectral clustering techniques, wherein a similarity matrix that represents similarities among nodes and/or edges is evaluated to identify eigenvalues that indicate significant similarity relationships. Based on the similarity matrix, the graph neural network may perform a dimensionality reduction of the graph data set (e.g., reducing the features of the nodes and/or edges that are evaluated to determine clusters in order to focus on features that are highly correlated with and/or indicative of significant similarities). Dimensionality reduction of the graph data set based on the similarity matrix may enable the graph neural network to determine clusters more efficiently and/or rapidly, e.g., by reducing a high-dimensionality graph data set (wherein each node and/or edge is characterized by a multitude of node properties and/or edge properties) into a lower-dimensionality graph data set of a subset of features that are highly correlated with and/or indicative of similarity and clustering.

Some graph neural networks may perform a centrality determination among nodes and/or edges of a graph data set. For example, for a graph data set representing a social network, a graph neural network may evaluate the graph data set to identify a subset of nodes based on a centrality among the edges representing the connections of the social network, e.g., people who are at the center of each of one or more social circles within the social network. Alternatively or additionally, some graph neural networks may perform a “betweenness” determination among the nodes and/or edges of the graph data set. For example, a node may be considered to be “between” two clusters of nodes, such as a member of two or more clusters representing two or more social circles. Such “between” nodes may represent a communication bridge that conducts information between clusters (e.g., a person who can convey ideas and/or influence from a first social circle to a second social circle and vice versa). Some such graph neural networks may perform “betweenness” determinations based on a betweenness centrality measurement, e.g., based on a measurement of a shortest path between all pairs of nodes in the graph data set. As another example, a graph data set may represent a collection of text documents, wherein each node represents a document and each edge represents a relationship between documents (e.g., a unidirectional or bidirectional citation between a first document and a second document). A graph neural network can perform a centrality determination and/or a betweenness determination to determine significant documents within the collection (e.g., a document that is heavily cited by one or more clusters of other documents, and/or a document that includes ideas or associations between the documents of a first cluster and the documents of a second cluster).

Some graph neural networks may perform analyses of structures occurring within a graph neural network. As an example, for a graph data set that represents a social network, a graph neural network may determine a notable sequence of relationships, such as a first relationship between node N1 and node N2 based on a shared interest, a second relationship between node N2 and node N3 based on the same shared interest, and a third relationship between node N3 and node N4 based on the same shared interest. Based on this sequence or chain of relationships, the graph neural network may recommend to a person represented by node N1 some further relationships with the people represented by nodes N3 and N4, due to the combination of shared interests and mutual relationships. In some such cases, a graph neural network may perform such structural analysis based on a traversal algorithm that traverses a sequence of nodes connected by one or more edges, and/or that traverses a sequence of edges connected by one or more nodes. As an example, a graph neural network may perform a random walk within the graph data set, such as starting with a first node (e.g., a first person of a social network) and following a limited set of edges that connect the first node to other nodes. In some cases, the traversal may be random (e.g., traversing from a node based on a random selection among the edges that connect the node to other nodes). In some other cases, the traversal may be weighted (e.g., each edge may include an edge property including a weight that represents a strength of a relationship among two or more nodes, and the traversal may be based on a weighted random selection that preferentially selects higher-weighted connections over lower-weighted connections). In some cases, the traversal can include a restart probability, e.g., a probability of retrying the traversal beginning with the original node or another node, based on a score such as a distance of the traversal with respect to the original node. In these and other cases, the results of a random walk can be used in further analyses and/or activities of the graph neural network (e.g., presenting recommendations for new social connections among the nodes of a social network).

Some graph neural networks may perform an analysis of a graph data set based on an attention model. For example, in a social network, the influence of a particular person P1 may not be determined by the connectedness of person P1 to other people in the social network, but based on a perception of person P1 by other people of the social network as being knowledgeable, skilled, influential, or the like. Thus, a graph neural network may be configured to evaluate a graph data set representing a social network in which nodes represent people and edges represent relationships, but may be unable to determine influence based only on graph concepts such as connectedness of the nodes based on the edges. Rather, the graph neural network might model influence as an attention of each node (i.e., a second person P2 of the social network) upon each other node (e.g., person P1 of the social network). Thus, a particular opinion of person P2 of the social network may depend not only on the connections of person P2 to other people of the social network (including person P1), but also upon the attention that person P2 accords to such other people of the social network (including person P1). That is, even though person P2 is closely connected to certain people of the social network by various edges, the opinion of person P2 may be heavily shaped by person P1 and other people to whom person P2 is only indirectly connected in the social network. As a second such example, in a graph data set that represents traffic flow within a region, an edge E1 (e.g., a first road) may be directly connected to other edges of the graph data set, but an edge property of the edge E1 (e.g., a traffic volume and/or congestion of the road) may be impacted more heavily by edge properties of other edges to which edge E1 is not directly connected (e.g., roads in other parts of the geographic region for which traffic volume and/or congestion is highly determinative of the traffic volume and/or congestion of this road). Thus, in order to predict and/or estimate a traffic volume and/or congestion of a particular road, a graph neural network may evaluate not only the traffic volume and/or congestion of other roads that are directly connected to the particular road, but also other roads for which traffic volume and/or congestion is highly determinative of corresponding conditions of this road. In these and other scenarios, a graph neural network may evaluate a graph data set based on an attention model, in which analyses and updates of the state of nodes and/or edges of the graph data set are based, at least in part, on an attention of each node and/or edge upon other nodes and/or edges of the graph data set. For example, the graph neural network may include an attention layer that determines, for a particular node and/or edge of an input graph data set, which other nodes and/or edges of the input graph data set are likely to be relevant to determining an updated state of the particular node and/or edge. Various attention models may be used by such graph neural networks, including multi-head attention models in which each node and/or edge is related to a plurality of other nodes and/or other edges with varying weighted attention values (e.g., by each of a plurality of attention layers). Multi-head attention models can allow a graph neural network to consider the influences upon a particular node and/or edge of a plurality of other nodes and/or edges, which may (or may not) be further related to one another by the graph structure and/or attention. Based on the attention model and the attention layers included in the graph neural network, the graph neural network can perform a more sophisticated graph analysis that is based on more than the structural relationships of the graph.

Some graph neural networks may be configured to process a graph data set in order to determine, and optionally output, various types of data (e.g., measurements, calculations, inferences, explanations, or the like) that relate to one or more nodes, one or more edges, and/or one or more subgraphs of the input graph data set and/or to the input data graph set as a whole. Some graph neural networks are configured to generate, and optionally output, various types of representations of graph neural networks. For example, the graph neural network may be configured to determine, and optionally output, an output vector including an array of data representing each of the one or more nodes followed by an array of data representing each of the one or more edges, either as an adjacency matrix of possible edges between pairs of nodes or an adjacency list of existing edges. The output vector may encode the nodes and/or edges in a particular order (e.g., a priority order of nodes and/or a weight order of edges, or corresponding to a corresponding order of the nodes and/or edges in the input graph data set) or in an unordered manner. Alternatively or additionally, the graph neural network may be configured to determine, and optionally output, other types of information about each of one or more nodes and/or each of one or more edges of the graph data set. For example, the graph neural network may be configured to determine, and optionally output, a hierarchical organization of nodes and/or edges relative to one another and/or to a fixed reference point. Alternatively or additionally, the graph neural network may be configured to determine, and optionally output, an output graph data set that includes an indication of the arrangement of one or more nodes and/or one or more edges in the hierarchical organization.

As another example, a graph neural network may be configured to determine, and optionally output, an indication of a centrality of one or more nodes and/or edges within the input graph data set (e.g., a graph of a social network including nodes that are ranked based on a centrality of each node to a cluster). Alternatively or additionally, the graph neural network may be configured to determine, and optionally output, an output graph data set that includes an indication of a centrality of one or more nodes and/or one or more edges in the graph.

As another example, a graph neural network may be configured to determine, and optionally output, an indication of a degree of connectivity of one or more nodes and/or edges of an input graph data set (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). Alternatively or additionally, the graph neural network may be configured to determine, and optionally output, an output graph data set that includes an indication of a degree of one or more nodes and/or one or more edges in the output graph data set.

As another example, a graph neural network may be configured to detect, identify, and/or analyze one or more clusters occurring within an input graph data set. For example, a graph neural network may be configured to perform a clustering analysis of an input graph data set to determine, and optionally output, a determination of k clusters within the input graph data set and an identification of the nodes and/or edges that are included in each cluster. The graph neural network may be configured to determine clusters based on a k-means clustering analysis, a Gaussian mixture model of with variable numbers of clusters and variable Gaussian orders, or the like. The graph neural network may be configured to determine, and optionally output, an indication of a clustering coefficient of one or more nodes and/or one or more edges of an input graph data set (e.g., a measurement of a degree to which at least some of the nodes and/or edges of a subgraph of the graph are clustered based on similarity and/or activity). Alternatively or additionally, the graph neural network may be configured to determine, and optionally output, an output graph data set that includes an indication of one or more clusters including one or more nodes and/or one or more edges in the output graph data set or a subgraph thereof (e.g., a result of a k^{¬}-means clustering analysis of an output graph data set, a Gaussian mixture model of an output graph data set, and/or one or more clustering coefficients of an output graph data set).

As another example, a graph neural network may be configured to determine, and optionally output, an indication of a graphlet degree vector that indicates a graphlet that is represented one or more times in an input graph data set. For example, for a graph representing atoms in a regular structure such as a crystal, the graph neural network may be configured to determine, and optionally output, a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet in the input graph data set. Alternatively or additionally, the graph neural network may be configured to determine, and optionally output, an output graph data set that includes a graphlet degree vector, and, optionally, features of one or more occurrences of a graphlet in the output graph data set and/or a count of the occurrences of the graphlet in the output graph data set.

As another example, a graph neural network may be configured to determine, and optionally output, an indication of one or more paths and/or traversals of one or more nodes and/or one or more edges of the input graph data set, optionally including additional details associated with a path or traversal such as a popularity, frequency, length, difficulty, cost, or the like. For example, for an input graph data set representing a spatial arrangement of nodes, the graph neural network may be configured to determine, and optionally output, a path or traversal of edges that connect a first node to a second node through zero or more other nodes of the input graph data set, as well as properties of the path or traversal such as a total length, distance, time, and/or cost. Alternatively or additionally, the graph neural network may be configured to determine, and optionally output, an output graph data set that includes additional details associated with one or more paths or traversals, including an indication (e.g., a list) of the associated nodes and/or edges of the output graph data set and a list of one or more properties of each such path and/or traversal.

As another example, a graph neural network may be configured to determine, and optionally output, an indication of metrics or properties that relate one or more nodes and/or one or more edges of an input graph data set. For example, for an input graph data set including a spatial arrangement of nodes, the graph neural network may be configured to determine, and optionally output, an indication of a shortest distance between two nodes and/or an indication of a set of nodes and/or edges that are common to two nodes of the input graph data set. As another example, for an input graph data set representing a network of communicating devices, the graph neural network may be configured to determine, and optionally output, a routing table of one or more routes that respectively indicate, for a particular node of the input graph data set and a particular edge connected to the node, a list of other nodes and/or edges of the input graph data set that can be efficiently reached by traversing based on the particular edge. As yet another example, for an input graph data set representing a social network including nodes that represent people, the graph neural network may be configured to determine, and optionally output, an indication for at least one pair of nodes of a measurement of similarity of the nodes of the input graph data set based on their node properties, edges, locations in the social network, connections to other nodes, or the like (e.g., a Katz index of node similarity) and/or, for at least one pair of edges of the input graph data set, a measurement of similarity of the edges based on their edge properties, connected nodes, locations in the social network, or the like (e.g., a Katz index of edge similarity). Alternatively or additionally, the graph neural network may be configured to determine, and optionally output, an output graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph neural network may be configured to determine, and optionally output, an indication of various graph properties of an input graph data set (e.g., a graph size, graph density, graph interconnectivity, graph chronological period, graph classification, a count of subgraphs within the graph, or the like). For example, for an input graph data set including two or more subgraphs (e.g., a social network including two or more social circles), the graph neural network may be configured to determine, and optionally output, a measurement of a similarity of each subset of at least two subgraphs of the input graph data set. The measurement of the similarity may be determined based on one or more graph kernel methods (e.g., a Gaussian radial basis function that can be applied to the input graph data set to identify one or more clusters of similar nodes that comprise a subgraph). As another example, a graph neural network may be configured to determine, and optionally output, a measurement of similarity of an input graph data set with respect to another graph data set (e.g., an indication of whether a particular social network graph resembles other social network graphs that have been classified as representing a genealogy or lineage, a set of friendships, and/or a set of professional relationships). Alternatively or additionally, the graph neural network may be configured to determine, and optionally output, an output graph data set that includes measurements determined by one or more graph properties of an output graph data set (e.g., one or more measurements of similarity of one or more nodes, edges, and/or subgraphs, and/or a measurement of similarity of the output graph data set to the input graph data set and/or other graph data sets). Further explanation and/or examples of various types of processing that graph neural networks can determine, and optionally output, for various input graph data sets and/or output graph data sets are presented elsewhere in this disclosure and/or will be known to or appreciated by persons skilled in the art.

Graph neural networks may be configured to generate various forms of output that correspond to various tasks. For example, graph neural networks can generate output that represents node-level predictions that relate to one or more nodes of an input graph data set. The node-level predictions can include a discovery of a new node that was not included in the input graph data set. For example, in a graph data set including edges that represent travel of individuals in a region, the nodes can represent points of interest, and the graph neural network can discover a new node that corresponds to a new point of interest. The node-level predictions can include an exclusion of a node that is included in the input graph data set. For example, in a graph data set including edges that represent travel of individuals in a region, the nodes can represent points of interest, and the graph neural network can exclude an existing node that no longer represents a point of interest. The node-level predictions can include a classification of a node that is included in the input graph data set, or of a newly discovered node that was not included in the input graph data set (e.g., a classification of the node as being of a node type selected from a set of node types, as being associated with one or more labels of a classification label set, and/or as belonging to zero or more subgraphs of the graph data set). For example, in a graph data set representing locations within a geographic region, the graph neural network can generate a prediction of a classification of a location of interest as one or more particular types of locations of interest (e.g., a source of food, a source of fuel, a lodging location, and/or a tourist destination). The node-level predictions can include an identification of a node from among the nodes of the input graph data set based on various features, or of a newly discovered node. For example, in a graph data set representing a social network and including nodes that represent people, the graph neural network can identify a particular node that corresponds to a particular person, such as an influential person of the social network. The node-level predictions can include a determination and/or updating of one or more node properties of one or more existing and/or newly discovered nodes, such as a prediction of a demographic feature, opinion, or interest of a node representing a person in a social network.

As another example, graph neural networks can generate output that represents edge-level predictions that relate to one or more edges of an input graph data set. The edge-level predictions can include a discovery of a new edge that was not included in the input graph data set. For example, in a graph data set representing a social network that includes nodes that represent people, a graph neural network can output a prediction (e.g., a recommendation) of a relationship between two nodes that correspond to two people in a small social circle of highly interconnected people. The node-level predictions can include an exclusion of a node that is included in the input graph data set. For example, in a graph data set representing a social network that includes nodes that represent people, a graph neural network can output a prediction of a no-longer-existing edge that corresponds to a relationship that no longer exists (e.g., a lost connection based on a splitting of a social circle). The edge-level predictions can include a classification of an edge that is included in the input graph data set, or of a newly discovered edge that was not included in the input graph data set (e.g., a classification of an edge as being a of an edge type selected from a set of edge types, as being associated with one or more labels of a classification label set, and/or as belonging to zero or more subgraphs of the graph data set). For example, in a graph data set representing a social network, a graph neural network can generate a predicted classification of an edge as representing a relationship between two people as of one or more relationship types (e.g., a familial relationship, a friendship, or a professional relationship). The edge-level predictions can include an identification of an edge from among the edges of the input graph data set based on various features, or of a newly discovered edge. For example, in a graph data set representing a social network and including edges that represent relationships, the graph neural network can identify a particular edge that corresponds to a potential relationship to be recommended to the associated people, such as two people of the social network who are not yet connected but who share common personal or professional interests. The edge-level predictions can include a determination and/or updating of one or more edge properties of one or more existing and/or newly discovered edges, such as a prediction of a demographic feature, opinion, or interest that serves as the basis for a relationship between two people of the social network.

As another example, graph neural networks can generate output that represents graph-level predictions that relate to one or more graph properties of the input graph data set. The graph-level predictions can include a discovery of a new graph property that was not associated with the input graph data set. For example, in a graph data set representing a social network that includes nodes that represent people and edges that represent relationships, a graph neural network can output a prediction of a demographic trait, opinion, or interest that is common or popular among the people of the social network, or a relationship behavior that is exhibited in the relationships among the people of the social network. The graph-level predictions can include an exclusion of a graph property that was associated with the input graph data set. For example, in a graph data set representing a social network that includes a graph property based on a shared interest, a graph neural network can output a prediction that the interest no longer appears to be common and/or popular among the people of the social network, or of a relationship behavior that is no longer exhibited among the relationships of the people of the social network. The graph-level predictions can include a classification of the input graph data set (e.g., a classification of the graph data set, or at least a portion thereof, as being associated with one or more labels of a classification label set). For example, in a graph data set representing a social network, a graph neural network can generate a predicted classification of the graph as representing a familial social network, a friendship social network, and/or a professional social network. The graph-level predictions can include an identification of one or more subgraphs of the graph based on common features of the nodes and/or edges included in the subgraph. For example, in a graph data set representing a social network, the graph neural network can subgraphs that correspond to various social circles of highly interconnected people. The graph-level predictions can include a determination and/or updating of one or more graph properties of the graph, such as an updating of a frequency of communication and/or a strength of relationships among the people of a social network.

As another example, graph neural networks can perform graph-to-graph translation by receiving an input graph data set and generating output that represents a different graph data set. For example, a graph neural network can receive an input graph data set and can generate an output graph data set that includes one or more newly discovered nodes and/or edges; an exclusion of one or more nodes and/or edges; a classification of one or more nodes and/or edges; an identification of one or more nodes and/or edges; and/or an update of one or more node properties, edge properties, and/or graph properties. A graph neural network can receive an input graph data set and can generate an output graph data set that shares various similarities with the input graph data set. For example, a graph neural network can receive, as input, a first graph representing a first geographic region (e.g., a real geographic region) and can generate, as output, a first graph representing a different geographic region (e.g., a fictitious geographic region) that shares similarities with the first graph and that has some dissimilarities with respect to the first graph. A graph neural network can receive, as input, an input graph data set and can generate, as output, a subgraph of the input graph data set. A graph neural network can receive, as input, an input graph data set and can generate, as output, an expanded graph including a first subgraph corresponding to the input graph data set and a second subgraph that is newly generated. A graph neural network can receive, as input, a first graph that corresponds to a first time and can generate, as output, a second graph that corresponds to a different time than the first time. For example, the graph neural network can receive, as input, a graph data set that corresponds to a state of a geographic region at a current time, and can generate, as output, a graph data set that predicts the state of the geographic region at a past time or a future time.

As another example, graph neural networks can generate graphs from non-graph input data. For example, a graph neural network can receive, as input, locations of travelers within a geographic region over a period of time, and can generate, as output, graph data that includes one or more nodes that represent points of interest among the travelers and edges that represent paths between the points of interest (e.g., roads that connect the points of interest). As another example, a graph neural network can receive, as input, a description of a graph (e.g., a natural-language description of a geographic location) and can generate, as output, graph data that corresponds to the description of the graph (e.g., a graph of a region that includes one or more nodes representing locations and one or more edges representing roads that interconnect the locations). The graph neural network may receive both graph data and non-graph data (e.g., a graph representing a social network and an indication of a particular person in the social network) and can generate, as output, graph data based on the input (e.g., a subgraph of the people who consider the identified person to be influential).

As another example, graph neural networks can receive an input graph data set and can generate, as output, non-graph data. For example, a graph neural network can receive, as input, a graph representing a social network including nodes that represent people and edges that represent relationships, and can generate, as output, one or more metrics of the social network (e.g., an average number of connections among the people of the social network, an identification of a person of high influence within the social network, or a description of a relationship behavior that commonly occurs within the social network). As another example, a graph neural network can receive, as input, a graph representing a geographic region including nodes that represent locations and edges that represent roads connecting the locations, and can generate, as output, one or more predictions and/or measurements of traffic within the geographic region. The graph neural network may receive both graph data and non-graph data (e.g., a graph representing a social network and an indication of a particular person in the social network) and can generate, as output, non-graph data based on the input (e.g., a summary and/or prediction of the social behaviors of the identified person). For example, a graph neural network that evaluates traffic patterns within a geographic region may process, and optionally output, both an output graph data set that includes nodes that represent cities and edges that represent roads interconnecting the cities, and also non-graph output data representing predictions and/or inferences of traffic and/or weather features within the geographic region (e.g., traffic volume estimates and current or forecasted weather conditions that affect the traffic patterns).

As another example, some graph neural networks may be configured to determine, and optionally output, an indication of zero or more cycles occurring among the nodes and/or edges of an input graph data set. For example, for a directed and/or undirected input graph data set, a graph neural network may determine, and optionally output, an indication that a particular cycle exists within the input graph data set and includes a particular subset of nodes and/or edges. Alternatively, for a directed and/or undirected graph data set, a graph neural network may determine, and optionally output, an indication that the graph is acyclic and does not include any cycles. A graph neural network may be configured to determine, and optionally output, an output graph data set that includes an indication of zero or more cycles.

As another example, graph neural networks can receive an input graph data set and can generate, as output, an interpretation and/or explanation of the input graph data set. For example, a graph neural network can receive, as input, a graph representing a collection of devices, including nodes that respectively represent a device and edges that respectively represent an instance of communication and/or interaction among two or more devices. The graph neural network can generate, as output, an interpretation and/or explanation of the communications and/or interactions represented in the graph, such as an explanation of a set of interactions as being part of a collective and/or collaborative effort among the two or more devices and/or a related series of interactions that are associated with a particular activity. The explanation and/or interpretation may include, for example, a classification of one or more nodes, edges, patterns of activity, and/or the graph; a natural-language summary or narrative explanation of one or more nodes, edges, patterns of activity, and/or the graph; a data set that characterizes one or more nodes, edges, patterns of activity, and/or the graph; and/or a presentation (e.g., a static or motion visualization) of one or more nodes, edges, patterns of activity, and/or the graph. As one such example, a graph neural network may identify, within an input graph data set, one or more subgraphs (e.g., one or more clusters of related nodes and/or edges), and may output an interpretation and/or explanation of the subgraph (e.g., a description of the set of features that characterize the subgraph or cluster). As another example, a graph neural network may generate a visualization of a subgraph of an input graph data set, wherein the visualization depicts, highlights, and/or illustrates a structure and/or an anomalous feature of the subgraph. Some such graph neural networks may be configured to generate interpretations and/or explanations of any input graph data set, e.g., based on an identification of features of an input data set that inform such interpretations and/or explanations, such as clusters, outliers, or determinations of apparent structure and/or data relationships. Other such graph neural networks may be configured to generate domain-specific interpretations and/or explanations of domain-specific graph data sets. For example, a graph neural network may be configured to analyze a graph data set representing a social network identify both a subset of the social network corresponding to an influential cluster of people of the social network and also an interpretation and/or explanation of why this cluster of people appears to be influential within the social network. Graph neural networks can generate interpretations and/or explanations using a variety of techniques, including “white-box” analysis techniques that can be applied to various properties of graph data sets and components thereof. Examples of graph neural networks that include instance-level explanations based on gradients and/or features include, without limitation, Guided BP, class activation mapping (CAM), and GradCAM. Examples of graph neural networks that include instance-level explanations based on perturbations include, without limitation, GNNExplainer, PGExplainer, ZORRO, and Graphmask. Examples of graph neural networks that include instance-level explanations based on decomposition include, without limitation, layer-wise relevance propagation (LRP), Excitation BP, and GNN LRP. Examples of graph neural networks that include instance-level explanations based on surrogate analysis include, without limitation, GraphLIME, RelEX, and PGMExplainer. Examples of graph neural networks that include model-level explanations include XGNN. Further explanation and/or examples of various interpretable and/or explainable features of graph data sets or components thereof that may be generated by graph neural networks are presented elsewhere in this disclosure and/or will be known to or appreciated by persons skilled in the art.

### Graph Neural Networks—Architectures and Frameworks

Graph neural networks may be designed and/or organized according to various architectures. For example, a multilayer graph neural network may include a number of layers, each layer including a number of neurons. In each layer of the graph neural network, the neurons may be configured to receive, as input, at least a portion of an input data set (e.g., an input graph data set) and/or at least a portion of an output of at least one neuron of one or more layers of the graph neural network. Additionally, in each layer of the graph neural network, the neurons may be configured to generate, as output, at least a portion of an output data set of the graph neural network (e.g., an output graph data set of graph neural network) and/or at least a portion of an input to at least one neuron of one or more layers of the graph neural network.

In some graph neural networks, an architecture of the graph neural network is based on the input to the graph neural network. For example, a fixed-size graph of N nodes and E edges interconnecting the nodes may be received and processed by a graph neural network that includes an input layer featuring N neurons respectively configured to receive input from one of the N nodes and/or E neurons respectively configured to receive input from one of the E edges. A graph including an adjacency list having a maximum of E edges may be received and processed by a graph neural network that includes an input layer featuring E neurons respectively configured to receive and process one of the E edges represented in the adjacency list. A graph including two subgraphs may be received and processed by a graph neural network that includes an input layer featuring a first set of neurons that are configured to process the nodes and/or edges of the first subgraph and a second set of neurons that are configured to process the nodes and/or edges of the second subgraph. In some graph neural networks, an architecture of the graph neural network may be based on non-graph input data that is received and processed by the graph neural network. For example, a graph neural network may be configured to receive, as input, a description of a graph (e.g., a number of nodes and/or edges and one or more properties of the graph). The graph neural network may be further configured to generate a graph corresponding to the description, and to process and optionally output the graph according to various graph neural network processing techniques.

In some graph neural networks, an architecture of the graph neural network is based on an output of the graph neural network. For example, a graph neural network may be configured to determine, and optionally output, a fixed-size output graph data set including N nodes and E edges. The graph neural network may therefore include an output layer featuring N neurons respectively configured to generate output corresponding to one of the N nodes and/or E neurons respectively configured to generate output corresponding to one of the E edges. A graph neural network may be configured to determine, and optionally output, an adjacency list having a maximum of E edges. The graph neural network may therefore include an output layer featuring E neurons that respectively generate output corresponding to one of the E edges represented in the adjacency list. A graph neural network may be configured to determine, and optionally output, an output graph data set including two subgraphs. The graph neural network may therefore include an output layer featuring a first set of neurons that are configured to generate output corresponding to the nodes and/or edges of the first subgraph and a second set of neurons that are configured to process the nodes and/or edges of the second subgraph. In some graph neural networks, an architecture of the graph neural network may be based on non-graph output data that is determined, and optionally output, by the graph neural network. For example, a graph neural network may be configured to determine, and optionally output, a description of an input graph data set and/or an output graph data set (e.g., a number of nodes and/or edges and one or more properties of the input graph data set and/or the output graph data set), according to various graph neural network processing techniques.

In some graph neural networks, an architecture of the graph neural network may be based on a directionality of one or more edges included in an input data set and/or an output data set. For example, an input graph data set including a undirected edge that connects a first node N1 and a second node N2 may be received and processed by a graph neural network including a first neuron NN1 and a second neuron NN2 that are bidirectionally connected to one another, such that message passing can occur from the first node NN1 to the second node NN 2 and, concurrently or consecutively, from the second node NN2 to the first node NN1. An input graph data set including a unidirectional edge that connects a first node N1 to a second node N2 may be received and processed by a graph neural network including a first neuron NN1 (e.g., a neuron in a first layer of a feed-forward graph neural network) that is unidirectionally connected to a second neuron NN2 (e.g., a neuron in a second layer of a feed-forward graph neural network), such that message passing can occur from the first node NN1 to the second node NN 2 but not from the second node NN2 to the first node NN1. An input graph data set including an edge that connects three or more nodes may be received and processed by a graph neural network in which three or more nodes are correspondingly connected.

Some graph neural networks may be configured to receive and process an input graph data set including a homogeneous set of nodes and/or a homogeneous set of edges. For example, a first neuron of the graph neural network that corresponds to a first node and/or edge of the input graph data set may include a same or similar number of inputs, a same or similar activation function, and/or a same or similar number of outputs as a second neuron of the graph neural network that corresponds to a second node and/or edge of the input graph data set.

Some graph neural networks may be configured to receive and process an input graph data set including a heterogeneous set of nodes and/or a heterogeneous set of edges. For example, different nodes of an input graph data set may be associated with different labels that respectively indicate different classifications of the nodes, and/or different edges of the input graph data set may be associated with different labels that respectively indicate different classifications of the edges. An architecture of the graph neural network may exhibit variations corresponding to the heterogeneity of the nodes and/or edges. For example, a first neuron of the graph neural network that corresponds to a first node and/or edge of the input graph data set that is associated with a first label or classification may include a different number of inputs, a different activation function, and/or a different number of outputs as a second neuron of the graph neural network that corresponds to a second node and/or edge of the input graph data set that is associated with a second label or classification. As another example, a graph neural network may include a first layer that receives and processes, as input, a first portion of an input data set that includes a first subset of neurons and/or edges that are associated with a first label or classification, and a second layer that receives and processes, as input, a second portion of an input data set that includes a second subset of neurons and/or edges that are associated with a second label or classification. The first layer and the second layer may be processed concurrently or consecutively. The first layer and the second layer may be processed independently (e.g., each layer providing a different portion of an output graph data set). Alternatively, the first layer and the second layer may be processed together (e.g., an output of the first layer may be additionally provided as input to the second layer, and/or an output of the second layer may be additionally provided as input to the first layer).

Some graph neural networks may include an architecture that is based on one or more node properties of one or more nodes of an input graph data set, one or more edge properties of one or more edges of the input graph data set, and/or one or more graph properties of the input graph data set. As an example, in some input graph data sets, one or more nodes may include a node property indicating a weight of the node (e.g., an indication of a centrality and/or betweenness of a node among at least a portion of the nodes of the input graph data set). The graph neural network may include a neuron that corresponds to the node, wherein one or more weights of synapses that connect the neuron to other neurons of the graph neural network is based on the weight of the node. As another example, in some input graph data sets, one or more edges may include an edge property indicating a weight of the edge (e.g., an indication of a significance and/or priority of a relationship among two or more nodes of the input graph data set). The graph neural network may include two or more nodes that are connected by a synapse, wherein a weight of the synapse connecting the two or more nodes is based on a weight of an edge of the input graph data set. Examples of node-based graph neural networks include, without limitation, GraphSAGE, PinSAGE, and VR-GCN. Examples of layer-based graph neural networks include, without limitation, FastGCN and LADIES. Examples of subgraph-based graph neural networks include, without limitation, ClusterGCN and GraphSAINT.

Some graph neural networks may be configured to receive and process fixed input graph data sets, wherein a number and arrangement of nodes and edges of an input data set that is received and processed by the graph neural network does not vary for different instances of processing the input data set. The architecture of such graph neural networks may be configured based on the invariance of the input graph data set. For example, the graph neural network may feature a fixed number and/or arrangement of neurons and/or layers, wherein the fixed architecture of the graph neural network corresponds to the fixed nature of the input graph data set.

Some graph neural networks may be configured to receive and process dynamic input graph data sets, wherein a number and arrangement of nodes and edges of an input data set that is received and processed by the graph neural network during a first instance of processing can differ from a number and arrangement of nodes and edges of an input data set that is received and processed by the graph neural network during a second instance of processing. As an example, a graph neural network may be configured to perform node and/or edge discovery of an input graph data set and to generate, as output, an output graph data set that includes at least one more node and/or at least one more edge than the input graph data set. Further, the graph neural network may be configured to receive the output graph data set from a first processing as input for a second processing, wherein a number of nodes and/or edges received as input during the second processing is greater than a corresponding number of nodes and/or edges received as input during the first processing. In such cases, an architecture of such graph neural networks may be fixed, but may be configured to receive and process a variety of different input graph data sets (e.g., input graph data sets with a variable number of nodes and/or connections). For example, the graph neural network may include an input layer featuring N input neurons, each corresponding to a node of an input graph data set. Such a graph neural network may be configured to use the fixed architecture to receive and process input graph data sets featuring a variable number of nodes up to, but not exceeding, N. For example, in order to receive and process an input graph data set featuring fewer than N nodes, the graph neural network may activate only a number of input neurons of the input layer that correspond to the number of nodes in the input graph data set, and to deactivate remaining neurons of the input layer that do not correspond to a node of the input graph data set (e.g., refraining from processing the remaining neurons, and/or processing the neurons but zeroing the weights of the synapses that connect the neurons to other neurons of the graph neural network). As another example, the graph neural network may perform a first processing of a first input graph data set including N nodes, and, accordingly, may deactivate one or more neurons of the input layer. The graph neural network may then perform a second processing of a second input graph data set including more than N nodes (e.g., an output of the first processing may include an output graph data set that includes one or more newly discovered nodes). During the second processing, the graph neural network may activate one or more of the previously deactivated neurons of the input layer in order to receive and process input from the additional nodes of the second input graph data set. For example, the graph neural network may enable or reenable the processing of one or more neurons of the input layer, and/or may reset (e.g., restore and/or initialize) the weights of one or more synapses that connect one or more neurons of the input layer to other neurons of the graph neural network. In some cases, an architecture of such graph neural networks may dynamic, and may change in correspondence with a dynamic nature of the input graph data set. For example, a graph neural network may include an input layer with a variable number of neurons, and may select, adapt, and/or change the number of neurons in the input layer based on a dynamic property of an input graph data set (e.g., a number of nodes and/or edges in the input graph data set). Such graph neural networks may generate new neurons of the input layer (e.g., initializing and/or selecting weights of the synapses of the new neurons, such as copying the weights from the synapses of other neurons of the input layer) based on a larger number of nodes and/or edges of an input graph data set to be received and processed as input. Alternatively or additionally, such graph neural networks may be configured to eliminate and/or merge neurons of the input layer (e.g., initializing and/or selecting weights of the new neurons) based on a smaller number of nodes and/or edges of an input graph data set to be received and processed as input.

In some graph neural networks, an architecture of the neural network may be selected and/or adapted based on a topology of one or more input graph data sets and/or output graph data sets. For example, a bipartite input graph data set may include two more subgraphs, and a graph neural network may include two or more distinct subsets of neurons that are respectively configured to receive and process data associated with the nodes and/or edges included in one of the subgraphs. As another example, a multigraph input graph data set may include a plurality of edges connecting two or more nodes. For example, a graph representing a social network may include various types of edges that represent various types of relationships (e.g., familial relationships, friendships, and/or professional relationships), and two or more nodes may be connected by a plurality of edges (e.g., a first edge indicating a friendship among the two or more nodes and a second edge indicating a professional relationship among the two or more nodes). An architecture of the graph neural network may correspond to the multigraph nature of the input graph data set. For example, a graph neural network may include two or more distinct subsets of neurons that are respectively configured to receive and process data associated with a subset of edges of the input graph data set that are of a particular edge type (e.g., a first subset of neurons that is configured to receive and process nodes connected by edges that represent friendships, and a second subset of neurons that is configured to receive and process nodes connected by edges representing professional relationships). As yet another example, an input hypergraph data set may include one or more hyperedges that interconnect three or more nodes. An architecture of a graph neural network that is configured to receive and process the input hypergraph data set may include one or more neurons with synapses that interconnect to two or more other neurons in correspondence with one or more hyperedges of the input hypergraph data set.

As another example, an architecture of some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. Examples of graph neural networks that include one or more direct pooling layers include, without limitation, SimplePooling, Set2Set, and SortPooling. Examples of graph neural networks that include one or more hierarchical pooling layers include, without limitation, Coarsening, ECC, DiffPool, TopK, gPool, Eigenpooling, and SAGPool.

As another example, some graph neural networks (e.g., graph convolution networks) include one or more convolutional layers, each of which performs a convolution operation to an output of neurons of a preceding layer of the graph neural network.

As another example, an architecture of some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells. In some graph neural networks, these features may be further adapted to accommodate graph processing, such as gated graph neural networks (GGRUs), tree LSTM networks, graph LSTM networks, and/or sentence LSTM networks.

As another example, an architecture of some graph neural networks includes one or more recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input.

As another example, an architecture of some graph neural networks includes two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In some cases, an architecture of a graph neural network may be designed by a user. For example, a user may choose one or more hyperparameters of a graph neural network (e.g., a number of layers, a number of neurons in each layer, an activation function used by at least some neurons, and the like) in order to process an input graph data set. In some cases, the selected one or more hyperparameters may be based on domain-specific knowledge, e.g., a specific data type, internal organization or structure, and/or task associated with an input graph data set.

Alternatively or additionally, in some cases, an architecture of a graph neural network may be selected by an automated process. For example, a hyperparameter search process may determine one or more hyperparameters of a graph neural network based on an analysis of an input graph data set to be received and processed by the graph neural network and/or an analysis of an output graph data set to be generated and provided as output by the graph neural network. The hyperparameter search process may determine various combinations of hyperparameters for variations of the graph neural network (e.g., graph neural networks with different numbers of layers, different numbers of neurons within each layer, graph neural networks including neurons with different activation functions, and/or graph neural networks with different sets of synapses interconnecting the neurons of various layers). The hyperparameter search process may process an input graph data set (e.g., a training input graph data set) using different graph neural networks that correspond to different sets of hyperparameters. The hyperparameter search process may compare the output of the different graph neural networks (e.g., determining a performance measurement for the output of each graph neural network, and comparing the performance measurements of the different graph neural networks) in order to determine and select a graph neural network that generates desirable output (e.g., output that most closely corresponds to a target output associated with the training input graph data set). The hyperparameter search process may discard the other graph neural networks and may use the selected graph neural network to process input graph data sets. In some cases, the hyperparameter search process may iteratively generate and test refined combinations of hyperparameters. For example, after selecting a graph neural network in a first hyperparameter search processing the hyperparameter search process may perform a second hyperparameter search processing by generating additional graph neural networks based on combinations of hyperparameters that are closer to the hyperparameters of the selected graph neural network, and evaluating the output of the additional graph neural networks. In some cases, the hyperparameter search process may perform a grid search over the set of valid hyperparameter combinations. Iterative refinement of the hyperparameters may enable the hyperparameter search process to determine an architecture of a graph neural network that is well-tuned to a particular task (e.g., an architecture of a graph neural network that demonstrates consistently high performance on input graph data sets within a particular domain of data and/or a particular task). In some cases, a hyperparameter search process may communicate with a user to determine combinations of hyperparameters to evaluate and/or to select for the graph neural network. For example, the hyperparameter search process may present, to a user, a result of a first hyperparameter evaluation (e.g., an output of a graph neural network that was selected through a first hyperparameter search processing). Based on an evaluation of the output by the user, the hyperparameter search process may perform a second or further hyperparameter search processing (e.g., choosing a small refinement of the hyperparameters based on a positive response of the user to the output of a selected graph neural network, and/or choosing a larger refinement of the hyperparameters based on a negative response of the user to the output of the selected graph neural network).

As another example, some graph neural networks include architectures based on graph convolutional networks (GCNs), wherein a convolutional layer applies a convolution operation to outputs of one or more filters of a previous filter layer of the graph convolutional network. Graph convolutional networks may include spectral convolutional networks that are configured to receive, as input, a spectral representation of an input graph data set, and to apply processing (including one or more convolutional operations) to various spectral components of the spectral representation of the input graph data set. Examples of spectral convolutional networks include, without limitation ChebNet and diversified graph convolutional networks (DGCNs). As another example, some graph convolutional networks include architectures based on spatial convolutional networks (SCNs) that are configured to receive, as input, spatial representations of an input graph data set (e.g., spatial information that represents one or more neighborhoods of nodes and/or edges of the input graph data set), and to apply processing (including one or more convolutional operations) to various spatial components of the spatial representation of the input graph data set. Examples of spatial convolutional networks include, without limitation, spatial convolutional neural networks (SCNNs), spatial and/or spatial-temporal GraphSAGE networks, and some deep convolutional neural networks (DCNNs).

Graph neural networks can be generated by a variety of machine learning platforms, frameworks, and/or tools, including, without limitation, PyTorch Geometroc, Deep Graph Library, TensorFlow GNN, Graph Nets, Spektral, and Jraph. Frameworks for graph convolutional networks include, without limitation, message passing neural networks (MPNNs), non-local neural networks (NLNNs), mixture model neural networks (MoNet), and Graph Networks (GN).

Further explanation and/or examples of various architectures of graph neural networks, including the design and implementation of designs and architectures of such graph neural networks, are presented elsewhere in this disclosure and/or will be known to or appreciated by persons skilled in the art.

### Graph Neural Networks—Training and Performance Evaluation

Like other types of neural networks, graph neural networks are typically generated with arbitrarily selected parameters (e.g., synaptic weights that are initially set to randomized values). Also, like other types of neural networks, an initialized graph neural network to evaluate input graph data sets through training, in which the parameters of the graph neural network are adjusted to promote desirable processing that produces expected and/or desirable outputs.

The training of graph neural networks may involve one or more training data sets. For graph neural networks that receive and process input graph data sets, the training data may include one or more training input graph data sets. Alternatively or additionally, for graph neural networks that receive and process input non-graph data, the training data may include one or more sets of training non-graph data.

The training data for a graph neural network may be based on authentic input data that was previously collected and/or analyzed, or that was collected and analyzed for the purpose of training the graph neural network. For example, in order to process graphs that represent an industrial environment, the training data may include sensor data that was previously and/or is currently received from one or more sensors associated with the industrial environment. Alternatively or additionally, the training data may include partially and/or fully synthetic data. For example, a first portion of training data may include data derived from an analysis of authentic data; authentic data that has been supplemented with synthetic data (e.g., an image of a real-world scene including an inserted artificial object); authentic data that has been modified by a suer (e.g., an image of a real-world scene that has been modified by a user); and/or data generated by one or more algorithms (e.g., other machine learning models and/or simulations of real-world processes). In some cases, the training data set may include both authentic training data and synthetic training data that is based on the authentic training data (e.g., both a real-world image and a modified version of the real-world image that has been adjusted in brightness, contrast, size, resolution, scale, shape, aspect ratio, color depth, or the like).

The training data for a graph neural network may be limited to a selected data domain. For example, training data for a graph neural network that analyzes social networks may include one or more samples of individuals from within one or more selected social networks. In other cases, the training data for a graph neural network may be generated from a variety of data domains. For example, training data for a graph neural network that analyzes geographic data may include one or more samples of locations of interest and interconnecting pathways from natural outdoor geographic regions (e.g., forests), artificial outdoor geographic regions (e.g., road networks), indoor geographic regions (e.g., caves or shopping malls), historic geographic regions (e.g., maps from ancestral eras and/or civilizations), and/or synthetic geographic regions (e.g., geographic maps from videogames).

The training data for a graph neural network may be wholly or partially unlabeled. For example, the training data set for an industrial environment may include sensor measurements collected from the industrial environment, but may not include any data indicating an analysis, classification, metadata, interpolations, extrapolations, interpretation, explanation, and/or user reaction associated with the sensor measurements. Alternatively or additionally, the training data for a graph neural network may be wholly or partially labeled. For example, the training data set for an industrial environment may include sensor measurements collected from the industrial environment, and one or more subsets of sensor measurements may be associated with one or more analyses, classification labels, metadata, interpolations, extrapolations, determinations, interpretations, explanations, and/or user reactions associated with the subset of sensor measurements. Training data may associate labels, metadata, or the like with one or more nodes and/or node properties of a training input graph data set; one or more edges and/or edge properties of a training input graph data set; one or more graph properties of the training input graph data set; and/or one or more portions of non-graph data of a training input data set. In some cases, the labels, data, metadata, or the like associated with at least a portion of a training input data set are selected by one or more users (e.g., a human classification of at least a portion of the training data set). In some cases, the labels, data, metadata, or the like associated with at least a portion of a training input data set are selected by another algorithm (e.g., a simulation or another machine learning model). In some cases, the labels, data, metadata, or the like associated with at least a portion of a training input data set are selected by a cooperation of a human and an algorithm (e.g., a determination by a simulation or another machine learning model that is verified by a reviewing human user).

Graph neural networks can be trained based on one or more training data sets and one or more learning techniques. As an example, some graph neural networks are trained through an unsupervised learning technique. For example, a training input data set may not include any labels, data, metadata, or the like associated with various portions of the training input data set. The graph neural network may be trained to identify patterns arising within the training input data sets. For example, a training input data set may include data that indicates one or more anomalies (e.g., nodes and/or edges that appear to represent outliers in a data distribution of the nodes and/or edges of the graph) and/or distinctive patterns or structures arising in the data (e.g., cycles arising in a directed and/or undirected graph). The graph neural network may be trained to detect such anomalies, patterns, and/or structure in the training input data sets. The results of unsupervised learning of a graph neural network may be evaluated based on an evaluation of the output of the graph neural network (e.g., a confusion matrix that includes determinations of true positive determinations, true negative determinations, false positive determinations, and/or false negative determinations) and/or performance scores (e.g., an F1 performance score based on ratios of true positives, false positives, true negatives, and false negatives). The weights of various parameters of the graph neural network can be automatically adjusted, corrected, refined, or the like, such that subsequent processing of the same input training data set and/or other input training data sets generates improved evaluations and/or performance scores.

As another example, some graph neural networks are trained through a supervised learning technique. For example, a training input data set may associate respective portions (e.g., respective training data samples, such as different training input graph data sets) with one or more labeled outputs that are expected and/or desirable of the trained graph neural network. As an example, a graph neural network may be trained to output a classification of a training input graph data set and/or one or more nodes and/or edges thereof. During a supervised learning process, the training input graph data set may be provided as input to the graph neural network and processed by the graph neural network to generate a predicted classification of a training input graph data set and/or one or more nodes and/or edges thereof. The predicted classifications may be compared with one or more labeled outputs associated with the training input graph data set (e.g., one or more labels associated with an expected and/or desirable classification of the training input graph data set and/or one or more nodes and/or edges thereof). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more accurate predictions of one or more labels associated with an expected and/or desirable classification of the training input graph data set and/or one or more nodes and/or edges thereof). As another example, a graph neural network may be trained to generate, as output, an output graph data set that is based on a processing of a training input graph data set. During a supervised learning process, the training input graph data set may be provided as input to the graph neural network and processed by the graph neural network to generate an output graph data set. The output graph data set generated by the graph neural network may be compared with one or more expected and/or desirable output graph data sets corresponding to the training input graph data set (e.g., one or more output graph data sets that are expected and/or desired as output when the graph neural network processes the training input graph data set). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more desirable and/or expected output graph data sets).

As another example, some graph neural networks are trained through a blended training process that includes both supervised and unsupervised learning. For example, a blended training process may evaluate the performance of a graph neural network in training based on both a comparison of predicted outputs of the graph neural network to expected and/or desirable outputs corresponding to an input training data set, and based on one or more automatically determined performance metrics, such as a confusion matrix and/or F1 scores. Some blended training processes may include a round of supervised learning following by a round of unsupervised learning, or may perform rounds of training that include both supervised and unsupervised learning techniques (e.g., optionally with different weights and/or performance thresholds associated with the evaluation of the graph neural network and the updating of the parameters).

As another example, some graph neural networks are trained through a semi-supervised learning process. For example, a training data set may include a large number of samples, of which only a small number of samples are labeled (e.g., associated with expected and/or desirable outputs) and a large remainder of the samples are unlabeled (e.g., not associated with expected and/or desirable outputs). The graph neural network may be trained based on the labeled and/or unlabeled training data, and a performance of the graph neural network may be evaluated based on the labels and/or other metrics. In particular, some unlabeled portions of the input training data may be identified as being incorrectly evaluated by the graph neural network (e.g., the graph neural network may generate incorrect outputs such as predictions or classifications, incorrect and/or malformed output graph data sets, or the like). At least a portion of such unlabeled portions of the input training data (e.g., training data samples that appear to be difficult to classify correctly and/or with high confidence) may be submitted to a human reviewer, and the semi-supervised learning process may receive, from the human reviewer, one or more labels that correspond to an expected and/or desirable output of the graph neural network for such portions of the input training data. Training or retraining of the graph neural network may involve the newly labeled portions of the input training data, as well as other portions of the input training data. Semi-supervised learning may enable graph neural networks to be trained based on a smaller degree of human involvement (e.g., a smaller number of labels associated with portions of the input training data set by human reviewers), and may therefore improve a speed, cost, and/or performance of training the graph neural network.

A training of a graph neural network may occur in one or more epochs. For example, for each epoch, the graph neural network may be provided with input comprising each portion of a training data set, a performance of the graph neural network may be determined based on the output of the graph neural network for each portion of the training data set. Based on the determined performance, and one or more parameters of the graph neural network may be updated. For example, weights of the synapses between neurons of the graph neural network may be adjusted such that a performance of the graph neural network over each portion of the training data set. During the training of a graph neural network, various techniques may be used to evaluate the performance of the graph neural network. As a first example, outputs of the graph neural network (e.g., output graph data sets and/or predictions, such as classifications of the graph, one or more nodes, and/or one or more edges) may be compared with expected and/or desirable outputs. Differences between the outputs and the expected and/or desirable outputs may be used to determine an entropy and/or loss of the output of the graph neural network as compared with corresponding expected and/or desirable outputs. In some variations, the entropy or loss of the graph neural network determined during or after a current epoch may be compared with an entropy or loss of the graph neural network determined during or after a previous epoch to determine a differential and/or marginal entropy or loss. A negative differential and/or marginal entropy or loss may indicate that the training of the graph neural network is productive (e.g., the performance of the graph neural network improved in the current epoch as compared with a previous epoch). A zero or positive differential and/or marginal entropy or loss may indicate that the training of the graph neural network is unproductive (e.g., the performance of the graph neural network did not improve, or diminished, in the current epoch as compared with a previous epoch). Training of the graph neural network may therefore continue as long as the differential and/or marginal entropy or loss remains negative and, optionally, exceeds a threshold magnitude that indicates significant training progress.

As another example, outputs of the graph neural network (e.g., output graph data sets and/or predictions, such as classifications of the graph, one or more nodes, and/or one or more edges) may be classified as one of a true positive, a false positive, a true negative, or a false negative. The performance of the graph neural network may be evaluated as a confusion matrix, e.g., based on a calculation of the performance over the incidence of true positive, false positive, true negative and false negative outputs. In some cases, the calculation may be weighted based on a risk matrix that applies different weights to each classification of the output. For example, in a graph neural network that generates classifications of graphs that correspond to diagnoses of medical conditions, it may be determined false negatives (e.g., missed diagnoses) are very harmful or costly, while false positives (e.g., misdiagnoses that can be corrected by further evaluation) may be determined to be comparatively harmless. Accordingly, the performance of the graph neural network may be determined based on a weighted calculation over the confusion matrix that more severely penalizes the performance based on false negatives than false positives.

As another example, the training of a graph neural network may involve an improvement of an objective function that serves as a basis for measuring the performance of the graph neural network. For example, the objective function may include (without limitation) a loss minimization, an entropy minimization, a precision maximization, a recall maximization, an error minimization, or a consistency maximization. The objective function may include a comparison of the performance of the graph neural network over various distributions of the input data set (e.g., a minimax optimization, such as minimizing a maximum loss over any portion of the input data set, or a maximin optimization, such as maximizing a minimum loss over any portion of the input data set). In some training scenarios that involve reinforcement learning, the output of a graph neural network may include and/or may be interpreted as a policy, e.g., a set of responses of an agent based on respective conditions. The performance of the graph neural network may be based on various objective functions that evaluate various properties of the generated and/or interpreted policy. For example, in a q-learning reinforcement learning process, the objective function applied to the policy may include a maximization of an action value of each behavior that may be performed in response to various conditions.

As another example, the training of graph neural networks may occur concurrently with the hyperparameter search and/or selection. For example, a hyperparameter search process may initially identify a first set of combinations of hyperparameters of graph neural networks to be evaluated using a training data set. Based on each such combination of hyperparameters, a graph neural network may be generated and at least partially trained to determine its performance. Based on the evaluation of the outputs of the graph neural networks corresponding to respective combinations of hyperparameters, the hyperparameter search process may identify a candidate graph neural network with the highest performance. The hyperparameter search process may then generate a second set of combinations of hyperparameters based on the hyperparameters of the candidate graph neural network, and may further (at least partially) train and evaluate the performance of additional graph neural networks based on the second set of combinations of hyperparameters. A comparison of the performance of the additional graph neural networks may cause the hyperparameter search process to retain the candidate graph neural network or to choose a new candidate graph neural network from among the additional graph neural networks. The hyperparameter search process may continue until additional improvements in the performance of candidate graph neural networks are not achievable and/or are below a threshold performance improvement. In this selection process, a variety of performance metrics may be used. As previously discussed, the performance metrics may include an evaluation of the outputs of the graph neural networks (e.g., a loss or entropy, a differential or marginal loss or entropy, a confusion matrix, an F1 score, or the like). Alternatively or additionally, the performance metrics may include other features of the output, such as a consistency of the output of the graph neural network over the distribution of data in the training data set and/or a bias in the performance the output of the graph neural network for selected data distributions of the training data set, and/or a smoothness or oversmoothness of the graph nodes represented in the graph neural network. Alternatively or additionally, the performance metrics may include one or more measurements of computational resource expenditures to perform training and/or inference of input data sets with the graph neural network (e.g., CPU and/or GPU utilization, memory usage, training time and/or complexity, processing latency between receiving input and generating output, or the like). Aggregate performance measurements may be based on a variety of such considerations, and may enable a human designer and/or a hyperparameter search process to perform a selection of a graph neural network based on various performance tradeoffs (e.g., a preference for a first graph neural network that produces high-accuracy, high-consistency, and/or high-confidence results but that requires a large amount of computational resources, time, and/or cost, vs. a preference for a second graph neural network that produces reasonable-accuracy, reasonable-consistency, and/or reasonable-confidence results using a smaller amount of computational resources, time, and/or cost). For example, a measurement of computational resource utilization by a particular graph neural network may correspond to a numeric penalty in various measurement of the performance of the graph neural network (e.g., a loss, entropy, and/or objective function output).

In various forms of graph neural network training based on these and other learning techniques, various training methods can be used to update the parameters of a graph neural network in training and/or to evaluate the performance of a graph neural network in training. For example, optimizers that may be used during the training of graph neural networks may include (without limitation) linear regression; root mean squared propagation (RMSprop); stochastic gradient descent; adaptive stochastic gradient descent (Adagrad); adaptive stochastic gradient descent with adaptive learning (Adadelta); adaptive moment estimation (Adam); Nesterov accelerated adaptive moment estimation (Nadam); Nesterov accelerated gradient and momentum (NAG); Monte Carlo simulations involving various variance reduction techniques, such as control variates; or the like, including variations and/or combinations thereof. Training techniques for particular types of graph neural networks may include optimizers that are specialized for such particular types of graph neural networks (e.g., graph convolutional networks may be trained using a FastGCN optimizer and/or receptive field control (RFC) optimizers).

As further examples, graph neural network training may include a variety of techniques that are also applicable to non-graph machine learning models, including non-graph neural networks. As a first such example, training may occur in batches and/or mini-batches of the training data set, wherein the graph neural network evaluates a batch (e.g., plurality of input data sets) of an input training data set, and the parameters of the graph neural network are updated based on an aggregation of the evaluation of the outputs of the graph neural network for the batch of input data sets. In various training techniques, batches may be selected at random from the training input data set or may be selected in an organized manner, e.g., as various subsets that are representative of one or more data distributions of the training input data set. For example, if the graph neural network in training exhibits good performance over some data distributions of the training input data and poor performance over other data distributions of the training input data, the continued training of the graph neural network may focus on, prioritize, and/or overweight the training based on batches of training input data that reflect the data distributions associated with poor performance. In various training techniques, a batch size of batches of training input data sets may be fixed, or the batch size may vary based on a progress of the training of the graph neural network.

As another example, in various training techniques for graph neural networks, an entire set of training input data may be partitioned into a training data set that is used only to train the graph neural network and update its parameters; a validation data set that is used only to evaluate a prospective and/or in-training graph neural network; and/or a test data set that is used to only evaluate a final performance of the fully trained graph neural network. The partitioning of the training input data may be based on one or more ratios (e.g., a 90/5/5 partitioning of the training input data into a training data set, a validation data set, and a test data set, or a 98/1/1 partitioning of the training input data into a training data set, a validation data set, and a test data set). For example, during an epoch, the performance of the graph neural network may be evaluated based on various portions of the training data set, and the parameters of the graph neural network may be adjusted based on the determined performance. However, continued training and updating of the graph neural network based on the training data set may result in overfitting, e.g., “memoization” of correct outputs that correspond to various portions of the training data set. Due to such overfitting, the performance of the graph neural network in evaluating previously evaluated input data sets may improve, but performance of the graph neural network on previously unevaluated input data sets may decline. Instead, at the conclusion of an epoch, the performance of the graph neural network may instead be evaluated based on various portions of the validation data set, which is not otherwise used to update the parameters of the graph neural network. Evaluation of the performance of the graph neural network on previously unseen data can indicate that the performance of the graph neural network is genuinely improving (e.g., based on learned principles of data evaluation that apply consistently to both previously seen and previously unseen input data sets), resulting in a continuation of training. Alternatively, Evaluation of the performance of the graph neural network on previously unseen data can indicate that the performance of the graph neural network is resulting in overfitting to the training data set (e.g., based on “memoization” of correct outputs for previously seen input data sets that do not inform the correct evaluation of previously unseen input data sets), resulting in a conclusion of training. Such conclusion may be referred to as “early stopping” of training to reduce overfitting of the graph neural network to the training data set and to preserve the performance of the graph neural network on previously unsee input data sets.

As another example, various training techniques for graph neural networks may include one or more regularization techniques, in which the inputs to the graph neural network and/or the processing of the input are adjusted to reduce overfitting. As a first example, the training of a graph neural network may include a dropout regularization technique, in which some neurons of the graph neural network are disabled for some instances of processing input data sets. In various regularization techniques, neurons to be disabled are selected randomly (e.g., 5% of the neurons during each epoch) and/or can be selected in a sequence (e.g., a round-robin selection of deactivated neurons). The selected neurons may be disabled by refraining from processing the inputs of the neurons and setting the outputs of the selected neurons to zero, and/or by processing the selected neurons but temporarily setting the weights of the synapses of the neurons to zero. As a second example, the training of a graph neural network may include a dropnode and/or dropedge regularization technique, in which portions of an input graph data set that include some nodes and/or some edges of the input graph data set are disabled. In various regularization techniques, nodes and/or edges to be disabled for an instance of processing are selected randomly (e.g., 5% of the nodes and/or edges during each epoch) and/or can be selected in a sequence (e.g., a round-robin selection of deactivated nodes and/or edges). The selected nodes and/or edges may be disabled by refraining from processing portions of the input data set that correspond to the selected nodes and/or edges, and/or by deactivating neurons of an input layer of the graph neural network that are configured to receive input data from the selected nodes and/or edges. As a third example, the performance of a graph neural network may be subjected to various forms of regularization, including L1 (“lasso”) regularization and/or L2 (“ridge”) regularization. These and other forms of regularization may be used, alone or in combination, to reduce overfitting of a graph neural network to an input training data set. For example, regularization may reduce an overweighting of a subset of nodes, edges, and/or neurons in the processing of various input data sets (e.g., by reducing and/or penalizing neurons having synaptic weights with magnitudes that are disproportionately large compared to the synaptic weights of other neurons of the graph neural network).

As another example, various training techniques for graph neural networks may combine a graph neural network with one or more other machine learning models, including one or more other graph neural networks and/or one or more non-graph neural networks. For example, a bootstrap aggregation (“bagging”) training technique involves a determination of a decision tree as an ensemble of machine learning models based on different bootstrap samples of the training input data set. Each machine learning model, including one or more graph neural networks, may be trained based on a random subsample of the training input data set. For a particular input data set, many of the trained machine learning models of the ensemble, including one or more graph neural networks, may present poor or only adequate performance. However, one or a few of the trained machine learning models may generate high-performance output for the particular input data set and others like it (e.g., for input data sets that share one or more properties, such as a select graph property, a select node property, and/or a select edge property). Thus, for any particular input data set, an evaluation of the specific properties of the particular input data set may enable a selection among the available models of the ensemble that may be used to evaluate the particular input data set. That is, a machine learning model (e.g., a graph neural network) that is generally a poorly performing model on most input data sets may exhibit good performance over a small neighborhood of input data sets that includes the particular data set, and may therefore be selected to evaluate the particular data set. Alternatively or additionally, the bootstrap aggregation may involve an evaluation of an input data set by a plurality of machine learning models (optionally including one or more graph neural networks of the ensemble) and a combination of the outputs of the selected machine learning models. In such scenarios, it is possible the individual outputs of the individual machine learning models exhibit poor performance (e.g., incorrect and/or low-confidence classifications of an input data set), but a determination of a consensus over the outputs of the multiple machine learning models may exhibit high performance (e.g., accurate and/or high-confidence classifications of the input data set).

As another example, various training techniques for graph neural networks may include a boosting ensemble technique, in which an output of a first trained machine learning model (e.g., a first graph neural network) is evaluated by a second trained machine learning model (e.g., a second graph neural network) to predict an accuracy and/or confidence of the prediction of the first trained machine learning model. For example, a first trained graph neural network may be evaluated to determine that it generates accurate and/or high-confidence output for a first group of input data sets (e.g., input graph data sets that include a first graph property, a first node property, and/or a first edge property), but inaccurate and/or low-confidence output for a second group of input data sets (e.g., input graph data sets that include a second graph property, a second node property, and/or a second edge property). A particular input data set may initially be processed by the first trained graph neural network to determine a first output (e.g., an output graph neural network or a prediction, such as a classification). A second trained graph neural network may evaluate the input data set and/or the output of the first graph neural network to predict an accuracy and/or confidence of the first graph neural network over input data sets that resemble the particular input data set. If the second trained graph neural network predicts that the output of the first graph neural network is likely to be of high accuracy and/or confidence, then the second trained graph neural network may provide the output of the first trained graph neural network as its output. However, if the second trained graph neural network predicts that the output of the first graph neural network is likely to be of low accuracy and/or confidence, then the second trained graph neural network may adjust, correct, and/or discard the output of the first trained graph neural network, or preferentially select an output of a different machine learning model (e.g., a third trained graph neural network) to be provided as output instead of the output of the first trained graph neural network. In such scenarios, it is possible that the individual outputs of the individual machine learning models exhibit poor performance (e.g., incorrect and/or low-confidence classifications of an input data set), but the review and validation of the output of some machine learning models by other machine learning models may enable a determination of a consensus over the outputs of the multiple machine learning models that exhibits high performance (e.g., accurate and/or high-confidence classifications of the input data set).

As another example, following conclusion of training a graph neural network, the graph neural network may be deployed for use (e.g., transferred to one or more devices, deployed into a production environment, and/or connected to a source of production input data). The performance of the graph neural network over input data sets may continue to be evaluated and monitored to verify that the graph neural network continues to perform well over various inputs. In some cases, the performance of the graph neural network may change between training and deployment. For example, a distribution of production input data processed by the graph neural network may differ from the distribution of training input data that was used to train the graph neural network. Alternatively or additionally, a distribution of production input data may change over time, e.g., between a time of deploying the graph neural network and a later time after such deployment. Such instances of changes in the performance of a fully trained and deployed graph neural network may be referred to as “drift.” In some such cases, “drift” may be reduced or eliminated by retraining or continuing training of the graph neural network, e.g., using additional training input data that corresponds to an actual or current distribution of the production input data. Alternatively or additionally, “drift” may be reduced or eliminated by training a substitute graph neural network to replace the initially deployed graph neural network. For example, the substitute graph neural network may include a different set of hyperparameters than the initially deployed graph neural network (e.g., additional layers and/or neurons to provide greater learning capacity; additional regularization techniques to reduce overfitting to the training data set; and/or the inclusion of specialized layers, such as pooling, filtering, memory, and/or attention layers). As another example, the initially deployed graph neural network may be added to an ensemble of other machine learning models, optionally including other graph neural networks, to generate improved outputs (e.g., higher-accuracy predictions) based on a consensus determined over the outputs of a number of machine learning models.

As another example, the training and/or use of graph neural networks may be susceptible to various forms of adversarial attack. For example, in an adversarial attack scenario, a particularly designed and/or selected input to a graph neural network (an “adversarial input,” such as an unusual, malformed, and/or anomalous) may cause the graph neural network to generate output that is incorrect, inconsistent with other outputs, and/or surprising. As an example, in a form of graph modification adversarial attack that may be referred to as node injection poisoning adversarial attack (NIPA), one or more nodes of an input graph data set are selected and/or altered to shift an output of the graph neural network based on the adversarial input (e.g., altering a classification and/or prediction of the input graph data set, or altering an output graph data set based on the adversarial input graph data set). As another example, in a form of graph modification adversarial attack that may be referred to as an edge perturbing adversarial attack (NIPA), one or more edges of an input graph data set are selected and/or altered to shift an output of the graph neural network based on the adversarial input (e.g., altering a classification and/or prediction of the input graph data set, or altering an output graph data set based on the adversarial input graph data set). As another example, in a training data injection attack, one or more portions of training input data on which a graph neural network is trained are designed and/or altered to alter the training of the graph neural network (e.g., a mislabeling of a particular training data input that causes the graph neural network to misclassify other inputs that correspond to the mislabeled training data input, and/or an injection of data samples into a training data set that alter a data distribution of the training data set upon which the graph neural network is trained). As another example, in a membership inference adversarial attack, properties and/or outputs of a graph data set are evaluated to identify properties of one or more training data inputs on which the graph data set was trained (e.g., an influential property of an input data set that causes the graph data set to select a particular classification for the any input data sets that include the property). As another example, in a property inference adversarial attack, properties and/or outputs of a graph data set are evaluated to identify general properties of training data inputs on which the graph data set was trained (e.g., a distribution of data included in the training data set, which may indicate particular distributions of input data over which the graph neural network was not trained, or over which the graph neural network was incompletely and/or incorrectly trained). As another example, in a model inversion adversarial attack, outputs of a graph neural network are examined to identify properties of corresponding input data sets that cause the graph neural network to generate such outputs.

Based on these and other forms of adversarial attack, the training and/or evaluation of a graph neural network may be adjusted to protect the graph neural network from such adversarial attack. For example, before an input to a graph neural network is processed, the input may be evaluated and/or classified (e.g., by another machine learning model, including another graph neural network) in order to determine whether the input is adversarial. If so, the graph neural network may refrain from processing the adversarial input, may process the adversarial input in more limited conditions (e.g., processing only a portion of the adversarial input, and/or replacing a malformed or anomalous portion of the adversarial input with a corresponding non-malformed and/or non-anomalous portion). As another example, during processing of an input data set, the internal behavior of the graph neural network may be evaluated and/or classified (e.g., by another machine learning model, including another graph neural network) to determine whether the behavior indicates a processing of adversarial input (e.g., unusual neuron activations, unusual outputs of one or more neurons, and/or updates of internal states of memory units). If so, the processing of the adversarial input may be halted and/or an internal state of the graph neural network may be restored to a time before the adversarial input was processed. As another example, before output of a graph neural network is provided in response to an input data set, the output may be examined and/or classified (e.g., by another machine learning model, including another graph neural network) to determine whether it is incorrect, inconsistent with other inputs, and/or surprising. If so, the output of the graph neural network may be discarded and/or altered before being provided in response to the input data set. Further explanation and/or examples of various techniques for training and performance evaluation of graph neural networks are presented elsewhere in this disclosure and/or will be known to or appreciated by persons skilled in the art.

### Graph Neural Networks—Applications

Graph neural networks can be applied to input data sets (including input graph data sets and/or input non-graph data sets) in various applications, and can be configured and/or trained to generate outputs (including output graph data sets and/or output predictions, such as classifications) that are relevant to various tasks within such applications.

For example, in the field of social networking, a graph data set may represent at least a portion of a social network, including nodes that represent people and that are connected by edges that represent relationships among two or more people. The graph data set representing a social network may be provided, as input, to a graph neural network that is configured to receive and process the input graph data set. The graph neural network may generate, as output, an output graph data set. For example, the output graph data set may include one or more new nodes that correspond to one or more newly discovered people within the social network, and/or one or more new edges that correspond to one or more newly discovered relationships that connect two or more people of the social network. The output graph data set may include one or more subgraphs and/or clusters that represent highly interconnected people of the social network, e.g., a social circle. The output graph data set may include a prediction of a recommendation of a relationship among two or more nodes corresponding to two or more people of the social network who share common personal traits, interests, and/or connections to other people. The output graph data set may include a prediction of a classification of a node corresponding to a person of the social network, e.g., a prediction of a personal interest of the person or a demographic trait of the person. The output graph data set may include a prediction of a classification of an edge that connects nodes representing two or more people of the social network, e.g., a prediction of a criminal association among two or more people of the social network. The output graph data set may include a determination of a relationship within the social network based on an attention model, e.g., an identification of a first node corresponding to a first person of the social network that appears to be influential to a second person of the social network represented by a second node of the graph. The output graph data set may include a prediction of a graph property of the graph, e.g., a classification of the social network as one or more types (e.g., a genealogy or familial social network, a friendship social network, and/or a professional relationship social network).

As another example, in the field of pharmaceuticals, a graph data set may represent at least a portion of a molecule (e.g., a protein or a DNA sequence), including nodes that represent atoms of the molecule and that are connected by edges that represent bonds and/or spatial relationships among two or more atoms. The graph data set representing a molecule may be provided, as input, to a graph neural network that is configured to receive and process the input graph data set. The graph neural network may generate, as output, an output graph data set. For example, the output graph data set may include one or more new nodes that correspond to one or more newly discovered atoms that may be added to the molecule, and/or one or more new edges that correspond to one or more newly discovered atoms of the molecule. The output graph data set may include one or more subgraphs and/or clusters that represent highly interconnected subregions of the molecule, such as carbon atoms that form a benzene ring or a binding site for a protein. The output graph data set may include a prediction of a classification of one or more nodes corresponding to one or more atoms of the molecule, e.g., a prediction that a subset of atoms of the molecule include a binding site for an enzyme that may active and/or deactivate a protein. The output graph data set may include a prediction of a classification of an edge that connects nodes representing atoms of the molecule, e.g., a prediction of a chemically reactive bond that can be altered to alter a property of the molecule. The output graph data set may include a prediction of a graph property of the graph, e.g., a prediction of a shape or organization of the molecule, a classification of the molecule as an enzyme, and/or a prediction of a potential side-effect of a drug due to an undesirable interaction with another drug.

As another example, in the field of software, a graph data set may represent at least a portion of a marketplace, including nodes that represent products and that are connected by edges that represent relationships between products. The graph data set representing a marketplace may be provided, as input, to a graph neural network that is configured to receive and process the input graph data set. The graph neural network may generate, as output, an output graph data set. For example, the output graph data set may include one or more new nodes that correspond to one or more newly discovered product, and/or one or more new edges that correspond to one or more newly discovered products. The output graph data set may include one or more subgraphs and/or clusters that represent highly interconnected products (e.g., two or more products that are often purchased and/or used together, or that compete in a particular market sector). The output graph data set may include a prediction of a recommendation of a relationship among two or more nodes corresponding to two or more products. The output graph data set may include a prediction of a classification of a node corresponding to a product, e.g., a prediction of an appeal, value, and/or demand of a product in a particular market segment, such as a particular subset of users. The output graph data set may include a prediction of a classification of an edge that connects nodes representing products, e.g., a prediction of a functional relationship between two or more products. The output graph data set may include a prediction of a graph property of the graph, e.g., a classification of the marketplace as increasing and/or decreasing in terms of supply, demand, size, prognosis, and/or public interest.

As another example, in the field of logistics, a graph data set may represent at least a portion of a supply chain, including nodes that represent locations where resources are generated, manufactured, stored, exchanged, and/or consumed and that are connected by edges that represent means of transport of resources between two or more locations. The graph data set representing a supply chain may be provided, as input, to a graph neural network that is configured to receive and process the input graph data set. The graph neural network may generate, as output, an output graph data set. For example, the output graph data set may include one or more new nodes that correspond to one or more newly discovered location of interest, and/or one or more new edges that correspond to one or more newly discovered locations of interest. The output graph data set may include one or more subgraphs and/or clusters that represent highly interconnected locations of interest, such as locations between which certain resources are frequently transported. The output graph data set may include a prediction of a recommendation of a relationship among two or more nodes corresponding to two or more locations of interest. The output graph data set may include a prediction of a classification of a node corresponding to a location of interest, e.g., a prediction of an availability, supply, demand, value, and/or appeal of a resource in the location of interest. The output graph data set may include a prediction of a classification of an edge that connects nodes representing locations of interest, e.g., a prediction of a volume of utilization of a mode of transport between two locations of interest. The output graph data set may include a prediction of a graph property of the graph, e.g., a classification of a stability of the supply chain based on social, economic, political, and/or environmental changes.

As another example, in the field of energy, a graph data set may represent at least a portion of an energy grid, including nodes that represent energy generators, stores, distributors, and/or consumers, and that are connected by edges that represent relationships among energy generators, stores, distributors, and/or consumers. The graph data set representing an energy grid may be provided, as input, to a graph neural network that is configured to receive and process the input graph data set. The graph neural network may generate, as output, an output graph data set. For example, the output graph data set may include one or more new nodes that correspond to one or more newly discovered energy generators, stores, distributors, and/or consumers, and/or one or more new edges that correspond to one or more newly discovered energy generators, stores, distributors, and/or consumers. The output graph data set may include one or more subgraphs and/or clusters that represent highly interconnected energy generators, stores, distributors, and/or consumers. The output graph data set may include a prediction of a recommendation of a relationship among two or more nodes corresponding to two or more energy generators, stores, distributors, and/or consumers. The output graph data set may include a prediction of a classification of a node corresponding to energy generators, stores, distributors, and/or consumers, e.g., a prediction of a current or future state or property of the energy generator, store, distributor, and/or consumer. The output graph data set may include a prediction of a classification of an edge that connects nodes representing energy generators, stores, distributors, and/or consumers, e.g., a prediction of a transaction between two or more energy generators, stores, distributors, and/or consumers. The output graph data set may include a prediction of a graph property of the graph, e.g., a classification of a stability of the energy grid to sustain energy generation and to support energy demands based on social, economic, political, and/or environmental changes.

As another example, in the field of civil engineering, a graph data set may represent at least a portion of a geographic region, including nodes that represent locations of interest and that are connected by edges that represent roads. The graph data set representing a geographic region may be provided, as input, to a graph neural network that is configured to receive and process the input graph data set. The graph neural network may generate, as output, an output graph data set. For example, the output graph data set may include one or more new nodes that correspond to one or more newly discovered locations of interest, and/or one or more new edges that correspond to one or more newly discovered locations of interest. The output graph data set may include one or more subgraphs and/or clusters that represent highly interconnected locations of interest. The output graph data set may include a prediction of a recommendation of a relationship among two or more nodes corresponding to two or more locations of interest. The output graph data set may include a prediction of a classification of a node corresponding to location of interest, e.g., a prediction of a current or future volume of visitors to a location of interest and/or a volume of traffic at or through the location of interest. The output graph data set may include a prediction of a classification of an edge that connects nodes representing locations of interest, e.g., a prediction of a volume of traffic on a road that connects two or more locations of interest. The output graph data set may include a prediction of a graph property of the graph, e.g., a classification of a sufficiency of a road network of the geographic region to support a current or future volume of traffic.

As another example, in the field of industrial systems, a graph data set may represent at least a portion of an industrial plant, including nodes that represent machines of the industrial plant and that are connected by edges that represent functional relationships among the machines. The graph data set representing the industrial plant may be provided, as input, to a graph neural network that is configured to receive and process the input graph data set. The graph neural network may generate, as output, an output graph data set. For example, the output graph data set may include one or more new nodes that correspond to one or more newly discovered machines, and/or one or more new edges that correspond to one or more newly discovered machines. The output graph data set may include one or more subgraphs and/or clusters that represent highly interconnected machines. The output graph data set may include a prediction of a recommendation of a relationship among two or more nodes corresponding to two or more machines. The output graph data set may include a prediction of a classification of a node corresponding to a machine, e.g., a prediction of a current or future maintenance state of a machine. The output graph data set may include a prediction of a classification of an edge that connects nodes representing machines, e.g., a prediction of a functional relationship between a first machine and a second machine that may significantly impact an efficiency, output, cost, or the like of the industrial plant. The output graph data set may include a prediction of a graph property of the graph, e.g., a classification of the industrial plant as belonging to a particular industry, such as raw material processing, semiconductor fabrication, tool manufacturing, vehicle manufacturing, textile manufacturing, and/or pharmaceuticals manufacturing. The output graph data set may include a prediction of a future and/or optimized state of the industrial plant, e.g., a reorganization of the machines of the industrial plant to optimize machine placement and/or floor planning.

As another example, in the field of cybersecurity, a graph data set may represent at least a portion of a device network, including nodes that represent devices and that are connected by edges that represent communication and/or interactions among two or more devices. The graph data set representing the device network may be provided, as input, to a graph neural network that is configured to receive and process the input graph data set. The graph neural network may generate, as output, an output graph data set. For example, the output graph data set may include one or more new nodes that correspond to one or more newly discovered devices, and/or one or more new edges that correspond to one or more newly discovered devices. The output graph data set may include one or more subgraphs and/or clusters that represent highly interconnected devices. The output graph data set may include a prediction of a recommendation of a relationship among two or more nodes corresponding to two or more devices. The output graph data set may include a prediction of a classification of a node corresponding to a device, e.g., a prediction of a security status of the device as being safe, vulnerable, or corrupted. The output graph data set may include a prediction of an activity occurring among the nodes of the graph data set, e.g., an occurrence of an intrusion or an attack based on anomalous activities represented by the edges of the graph data set. The output graph data set may include a prediction of a classification of an edge that connects nodes representing devices, e.g., a prediction that a particular interaction between two or more devices is associated with a security vulnerability or attack. The output graph data set may include a prediction of a graph property of the graph, e.g., a classification of the set of devices as safe from security flaws or vulnerable to one or more attack mechanisms, such as denial-of-service (DoS) attacks, distributed-denial-of-service (DDoS) attacks, social engineering attacks such as phishing, eavesdropping attacks such as man-in-the-middle attacks, or the like. The output graph data set may include a prediction of a theoretical state of the graph data set, e.g., a security state of the device network in response to a particular type of attack, and/or a security state of the device network based on the inclusion of additional devices in the future. The output graph data set may include a recommendation to modify the graph neural network based on one or more security considerations, e.g., a recommendation to reorganize the device network to reduce susceptibilities to one or more security risks. The output graph data set may include a technique to defend the graph neural network from various types of adversarial attack, e.g., training-time attacks that affect the manner in which the graph neural network learns to evaluate and/or classify the graph data set, one or more nodes, and/or one or more edges. For example, the message passing operations of the graph neural network may be modified to reduce a susceptibility of the graph neural network to adversarial perturbation during training, while preserving the learning capabilities of the graph neural network.

Examples of additional applications of various graph neural networks to various graph data sets include, without limitation: graph mining applications (e.g., graph matching and/or clustering); physics (e.g., physical systems modeling and/or evolution over time); chemistry (e.g., molecular fingerprints and/or chemical reaction predictions); biology (e.g., protein interface predictions, side effects predictions, and/or disease classification); knowledge graphs (e.g., knowledge graph completion and/or knowledge graph alignment); generation (e.g., output graph data set generation that corresponds to an expression, an image, a video, a music sample, or a scene graph); combinatorial optimization; traffic networks (e.g., traffic state prediction); recommendation systems (e.g., user-item interaction predictions and/or social recommendations); economic networks (e.g., stock markets); software and information technology (e.g., software defined networks, AMR graph-to-text tasks, and program verification); text processing (e.g., text classification, sequence labeling, machine translation, relation extraction, event extraction, fact verification, question answering, and/or relational reasoning); and image processing (e.g., social relationship understanding, image classification, visual question answering, object detection, interaction detection, region classification, and/or semantic segmentation). Further examples of applications for processing various graph data sets by various graph neural networks are presented elsewhere in this disclosure and/or will be known to or appreciated by persons skilled in the art.

### Attention

In embodiments, an artificial intelligence system, machine learning model, or the like, of any of the types disclosed herein, may comprise, integrate, link to, or include an attention feature. Attention may be generally described as a determination, among a set of inputs, of the relatedness of each input to the other inputs in the set of inputs. In “self-attention,” the input includes a sequence of elements, and attention is determined between each pair of elements in the sequence. As a first example, the set of inputs includes a sequence of words in a language, and attention is applied to determine, for each word in the sequence, the relatedness of the word to each other word in the sequence. As a second example, an input includes an image comprising a set of pixels, and attention is applied to determine, for each group of pixels in the image, the relatedness of the group of pixels to each other group of pixels in the image. Attention can also be applied between sets of input, wherein attention is determined between each element of a first set of input and each element of a second set of input. For example, the set of inputs can include a first sequence of words in a first language and a second sequence of words in a second language, and attention can be determined to indicate how each word in the first sequence is related to each word in the second sequence.

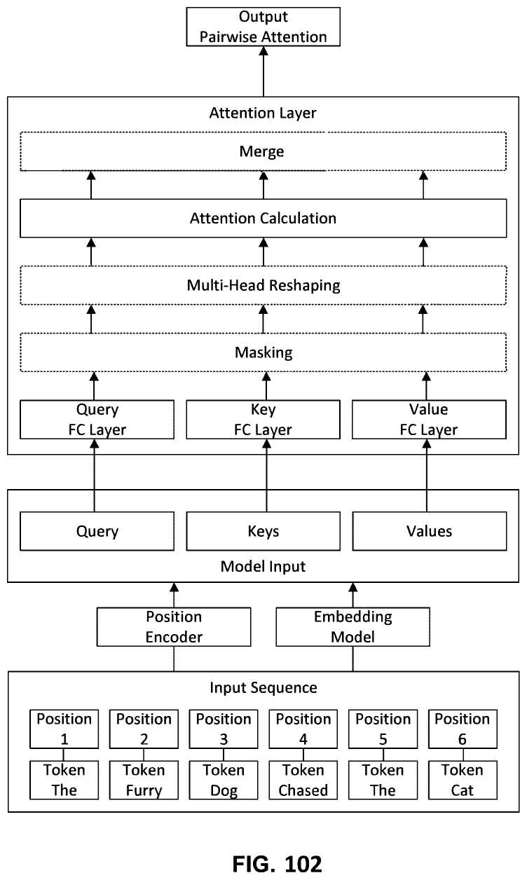

FIG. 102 presents an example of a determination of attention by a machine learning model. In the example of FIG. 102, an input sequence includes a set of tokens, each representing a word (“The”, “Furry”, “Dog”, “Chased”, “The”, “Cat”). Each token includes an indicator of a position of the token in the sequence. In various embodiments, the tokens of the input sequence may include complete words, portions of words (e.g., a first token indicating a word root and a second token indicating a modifier of the word root), punctuation, or the like. Some tokens may indicate metadata, such as a start-of-sequence token, an end-of-sequence token, or a null token indicating a padding of the sequence or a mask that hides a token of the sequence.

The input sequence is processed by a position encoder that determines, for each token, an encoding of the position. In some embodiments, the position encoding may include an ordinal numerical value that indices the ordinal position of each token in the sequence, such as an index beginning at zero or one. In some embodiments, the position encoding may include a relative numerical value that indicates a position of each token in the sequence relative to a fixed position, such as a current word (encoded position 0), an immediately preceding word (encoded position −1), or an immediately following word (encoded position 1). In some embodiments, the position encoding may include non-integer values and/or multiple values, such as a first index indicating a sine calculation (with a given frequency) of the position of each token and a second index indicating a cosine calculation (with a same or different frequency) of the position of each token.

The input sequence is also processed by an embedding model. The embedding model determines, for each token in the input sequence, a mapping of the token into a latent space representation of the input (e.g., a latent space representation of a language). The latent space may position each token along a plurality of n dimensions, wherein each dimension represents a distinct type of relationship among the elements of the language. The embedding model clusters the tokens such that related tokens are positioned closer to each other within the latent space. For example, along one dimension of the latent space, the words “Cat” and “Dog” may be positioned close together as being words that describe animals, while also being positioned apart from words that do not describe animals, such as “Baseball” and “School.” Along another dimension of the latent space, the words “Dog” and “Furry” may be positioned close together as words that commonly occur in the context of dogs, while also being positioned apart from words that do not describe dogs, including “Cat.” For each token of the input sequence, the embedding model generates one or more values that indicate the position of the token within the latent space. In some embodiments, the values are encoded as a vector, and the proximity of two tokens within the latent space may be determined based on vector proximity calculations, such as cosine similarity.

Based on the positions encoded by the position encoder and the embeddings determined by the embedding model, a model input can be generated for the input sequence. As shown in FIG. 102, the model input includes a query, a set of keys, and a set of values. As an example, the query may include an indicator of a particular token in the input sequence, such as the sixth token (“Cat”). The keys may include the position encodings of respective tokens of the input sequence, as determined by the position encoder, and a corresponding embedding of the respective token as determined by the embedding model. The values may indicate additional data features of the tokens. As an example, the values may indicate, for each token of the input sequence, a determined sentiment (e.g., a ranking between −1, indicating very negative words, and +1, indicating very positive words). In some embodiments, no additional data features are available, and the values are identical to the keys.

The model input is received and processed by an attention layer. In FIG. 102, the attention layer first includes a set of fully-connected layers: a first fully-connected layer processes the query of the model input; a second fully-connected layer processes the keys of the model input; and a third fully-connected layer processes the values of the model input. Each fully-connected layer includes a bias and a set of weights that adjust the values of the query, key, or value, respectively. The bias and weights of each fully-connected layer are model parameters that are initialized (e.g., to random values) and then incrementally adjusted during training.

Optionally, in some embodiments, the outputs of the fully-connected layers are further processed by a masking layer. The masking layer removes one or more values from the model input adjusted by the fully-connected layers. As a first example, the masking layer can reduce to zero the values of the key and/or value at a given position, such as a token at a current position to be predicted, or a token at a position following the current position that is to be hidden from the model. As a second example, the masking layer can reduce to zero the values of particular keys and/or values, such as padding values that are provided to adapt the size of the model input to a size of input that the attention layer is configured to receive and process. The masking layer can produce output for certain tokens (e.g., reduced to zero) for the indicated tokens (e.g., the current token, future tokens, and/or padding tokens) and that is the same as the input for the remaining tokens.

Optionally, in some embodiments, the outputs of the masking layer are further processed by a multi-head reshaping layer. The multi-head reshaping layer can reshape an input vector comprising the weighted and/or masked model input such that subsets of the input can be processed in parallel by different attention heads. As an example, an attention layer may include two attention heads, and the input can be reshaped such that each attention head is applied to only half of the inputs. The multi-head attention model can enable attention determinations over different subsets of the input (e.g., a first attention head can determine the relatedness of a first token to a first subset of tokens of the input sequence, and a second attention head can determine the relatedness of the same first token to a second subset of tokens of the input sequence). Alternatively or additionally, the multi-head attention model can enable different types of attention determinations among the tokens of the input sequence (e.g., a first attention head can determine a first type of relatedness of a first token to a subset of tokens of the input sequence, and a second attention head can determine a second type of relatedness of the same first token to the same or different subset of tokens of the input sequence). The multi-head attention model may enable parallel processing of the input sequence (e.g., the input for each attention head can be processed by a different processing core).

The attention layer includes an attention calculation that determines, based on the model input, the attention of a token of the input sequence with respect to other tokens of the input sequence. In some embodiments, the attention calculation includes an additive attention (“Bahdanau Attention”) calculation, in which attention is determined as a sum of weighted calculations of the distances of the tokens along each dimension of the latent space. In some embodiments, the attention calculation includes a dot product determination, as a comparison of the distances between the vectors of the tokens within the latent space. In some embodiments, the attention calculation is performed over the query, keys, and values of the model input, optionally after processing with a masking layer. In some embodiments, the attention calculation is performed for each of a plurality of attention heads, each of which processes a particular subset of the tokens of the input sequence.

In embodiments that include multi-head reshaping, the output of the attention calculation is further processed by a merge operation that merges the attention calculations for the respective attention heads. In some embodiments, the merge operation includes a concatenation and/or interleaving of the attention calculations of the attention heads. In some embodiments, the merge operation includes an arithmetic operation applied to the attention calculations of the attention heads, such as an arithmetic mean, median, min, and/or max calculation.

The attention layer outputs, for at least one token of the input sequence, a determination of attention between the token and at least one other token of the input sequence. The output of the attention calculation may include a vector that indicates, for at least one token of the input sequence, the determinations of attention between the token and a set of other tokens of the input sequence. The output of the attention calculation may include a set of vectors that indicate, for respective tokens of the input sequence, the determinations of attention between the respective token and at least one other token of the input sequence. The output of the attention calculation may indicate, for a token of a first sequence, the attention of the token to one or more tokens of a second sequence. As shown in FIG. 102, the output of the attention layer includes pairwise determinations of relatedness between pairs of tokens (e.g., each pair including a current token in an input sequence and each preceding token in the input sequence). In some embodiments, the pairwise determinations may be further processed. For example, a softmax calculation can be applied to normalize the pairwise attention determinations based on a desired range of output values (e.g., probability values between 0.0 and 1.0, with a 1.0 sum over all output values).

The attention layer may be trained by providing sets of training input sequences and comparing the outputs of the attention layer with expected outputs. Alternatively or additionally, the attention layer may be trained by incorporating the attention layer into a larger model (e.g., a transformer model) and adjusting the parameters of the attention layer (e.g., the parameters of the fully-connected layers) for a given training input sequence in order to adjust the output of the attention layer toward a desired output for the training input sequence. As an example, in a backpropagation training process, the output of the attention layer is provided as input to a succeeding layer. The output of the model including the attention layer and the succeeding layer may be compared with a desired output for the training input sequence. Based on this comparison, adjustments of the output of the succeeding layer (e.g., based on an error calculation) may inform a determination of desired adjustments of the input of the succeeding layer, which correspond to adjustments of the output of the attention layer. The adjustments of the output may be achieved by internally adjusting the parameters of the attention layer (e.g., the weights and/or biases of the fully-connected layers shown in FIG. 102) such that the attention layer subsequently generates output for the training input sequence that more closely corresponds to the desired input for the succeeding layer. Incremental training over a set of training input sequences can cause the attention layer to generate output that corresponds to the desired output for the training input sequences. As an example, if the input sequences are sentences in a language and the desired output of the model includes the probabilities of words in the language that could follow a given set of input words, the attention layer can be incrementally adjusted to indicate the attention (e.g., relatedness) between the next word in the input sequence and the preceding words in the input sequence.

It is to be appreciated that the attention layer shown in FIG. 102 presents only one example, and that attention layers may include a variety of variations with respect to the example of FIG. 102. For example, attention layers may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the attention layer shown in FIG. 102 may vary in numerous respects. For example, masking may be applied to the model input instead of to the outputs of the fully-connected layers. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in attention layers that are incorporated in a variety of machine learning models to process a variety of types of input sequences.

In some aspects, the techniques described herein relate to a system for improving a value chain networks using graph neural networks, the system including one or more processors and one or more memories configured to perform operations including: receiving an input graph data set representing a value chain network, including nodes representing entities within the value chain and edges representing transactions or relationships between entities; generating an embedding based on the input graph data set specific to the value chain context; applying a plurality of graph neural network layers to the embedding to produce an output graph data set, wherein the output graph data set includes updates to nodes and edges reflecting changes in the value chain network; performing a clustering analysis on the nodes or edges of the output graph data set to identify clusters representing highly interconnected segments of the value chain; and outputting the optimized value chain network graph data set including updated node properties, edge properties, or graph properties based on the clustering analysis and value chain optimization criteria.

In embodiments, the value chain network entities may include, but are not limited to, products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, and port infrastructure facilities.

In embodiments, changes in the value chain network may include, but are not limited to, new entities, discontinued entities, new relationships (e.g., supplier relationships), discontinued relationships, altered transactional dynamics, improved distribution routes, shifts in manufacturing sites, new storage facilities, inventory redistribution, and the like.

Input graph data for a graph neural network system, as described, can take various forms depending on the context of the value chain network being analyzed. In one example, the input graph data set could represent the entire supply chain of a manufacturing company. Nodes could represent suppliers, manufacturing plants, distribution centers, and retailers. Edges could represent the flow of materials, products, and information between these entities. In a logistics context, the input graph data could include nodes representing warehouses, ports, shipping routes, and transportation hubs. Edges could represent logistical connections such as shipping lanes, trucking routes, and rail lines, as well as the frequency and volume of shipments. For a retail business, the input graph data set could represent a network of retail stores, distribution centers, and suppliers. Nodes could represent individual stores and their inventory levels, while edges could represent supply lines and the movement of goods. For a telecommunications company, the input graph data set could represent the network infrastructure with nodes for cell towers, routing centers, and customer endpoints. Edges could represent communication links and data transfer paths. In project management, the input graph data could represent the tasks, milestones, and dependencies within a project. Nodes could represent individual tasks or work packages, and edges could represent dependencies or sequences in which tasks must be completed. For the agricultural sector, the input graph data set could include nodes representing farms, processing facilities, distributors, and retail outlets. Edges could represent the flow of agricultural products and information about demand and supply between these nodes. In a smart city context, the input graph data could represent the transportation network with nodes for intersections, public transport stops, and parking facilities. Edges could represent roads, public transport routes, and pedestrian pathways. Each of these examples of input graph data sets provides a structured representation of complex relationships and interactions within a particular value chain network, which the graph neural network system can analyze and optimize. For example, in a value chain network of a manufacturing company, nodes could represent suppliers, manufacturers, distributors, and retailers, while edges could represent the supply contracts or delivery schedules between them.

In one example, a company that manufactures electronics wants to optimize its value chain network. Using a graph neural network system, the company inputs data representing all entities in its supply chain, including raw material suppliers, component factories, assembly plants, distribution centers, retailers, and end consumers. Each entity is a node in the network, and the edges represent the flow of materials, components, and finished products, as well as information and financial transactions between these entities. The graph neural network analyzes this complex web of interactions to identify inefficiencies. For instance, it might find that certain suppliers are consistently late in delivering materials, causing bottlenecks in production. Or it might discover that some distribution routes are longer than necessary, leading to delays and increased costs. Based on these insights, the system generates recommendations such as diversifying the supplier base, opening a new distribution center to serve a high-demand region more efficiently, or reallocating inventory to different retailers based on predictive sales data. These recommendations are then presented to the company's decision-makers, who can take strategic actions to streamline operations, reduce costs, and improve the overall efficiency of the value chain network.

In embodiments, the system may perform dimensionality reduction on the graph data set based on a similarity matrix to facilitate the clustering analysis. This process simplifies the graph data set by focusing on the most relevant features that contribute to similarities between nodes or edges, which can enhance the efficiency and accuracy of the clustering analysis. In the context of a value chain network, dimensionality reduction might reveal that certain suppliers are interchangeable in terms of the materials they provide, allowing the system to simplify the network by treating these suppliers as a single entity for optimization purposes.

In embodiments, the system may be configured to apply spectral clustering techniques during the clustering analysis. Spectral clustering uses eigenvalues of a similarity matrix to identify significant relationships within the data, which can be particularly effective for complex value chain networks where traditional clustering methods may fall short. For example, spectral clustering could be used to detect communities of businesses within a value chain that frequently collaborate on joint ventures or share logistics resources.

In embodiments, the system may be configured to generate an output graph data set that includes graphlet degree vectors indicating recurring structures within the input graph data set. This feature allows the system to recognize and represent patterns that occur repeatedly within the value chain, such as common configurations of suppliers, manufacturers, and distributors that form a standard supply chain module. An example of this could be a recurring structure where a particular set of suppliers always feeds into a specific manufacturing process, which could be optimized as a unit.

In some implementations, the system may be configured to perform graph-to-graph translation to generate an output graph data set that represents a different graph data set from the input graph data set. This capability enables the system to transform the structure of the value chain network to represent different scenarios or optimizations. For instance, the system could translate a current value chain graph into a future state graph that represents the network after a planned expansion of distribution centers.

In embodiments, the system is configured to utilize instance-level explanations based on gradients, features, perturbations, or decomposition to provide interpretability of the output graph data set such that the system can explain the reasoning behind the updates made to the value chain network, such as why certain nodes were added or removed, or why specific edges were strengthened or weakened. In a value chain network example, this could help stakeholders understand why the system recommends increasing the frequency of deliveries between certain entities.

In embodiments, the system is configured to perform hyperparameter search processing to refine the graph neural network based on user feedback regarding the output graph data set. This process involves adjusting the settings of the graph neural network to improve its performance based on the outcomes observed and feedback received. For example, if users indicate that the system's recommendations for a value chain network do not adequately account for seasonal demand fluctuations, the hyperparameter search could adjust the network to better factor in these variations.

### Transformer Models

In embodiments, an artificial intelligence system, machine learning model, or the like, of any of the types disclosed herein, may comprise, integrate, link to, or include a transformer model, that is, a neural network that learns context and meaning by tracking relationships in a set of sequential data inputs. Transformer models may include one or more attention layers, including (but not limited to) the attention layer shown in FIG. 102.

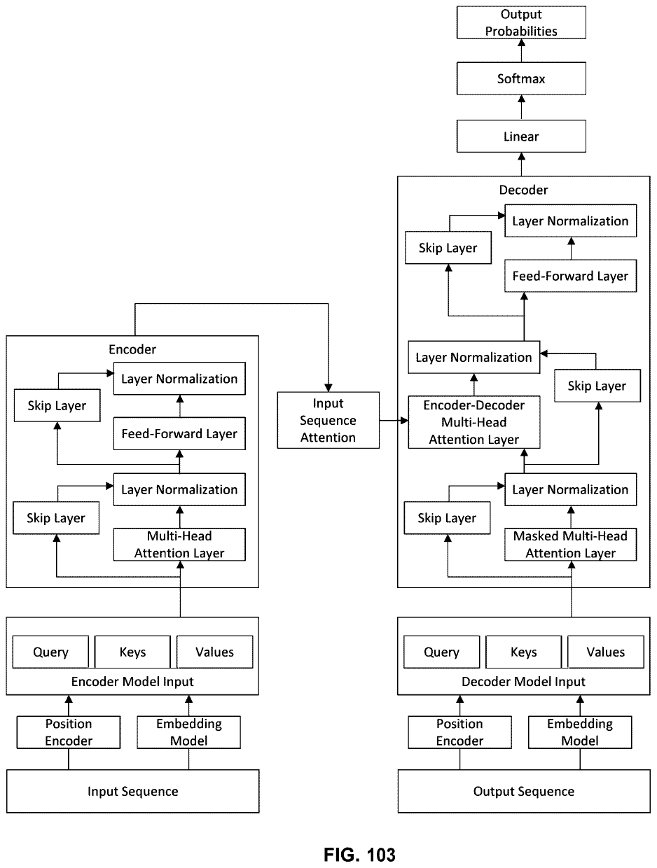

FIG. 103 presents an example of a transformer model. The transformer model of FIG. 103 is based on an encoder-decoder architecture in which an encoder processes an input sequence and a decoder processes an output sequence to generate output probabilities. As a first example, the input sequence may include a sequence of words in a first language; the output sequence may include a sequence of words in a second language corresponding to a translation of the input sequence; and the output probabilities may include the probabilities of words in the second language for a particular position in the translation. As a second example, the input sequence may include a sequence of words in a language that represent a query or prompt; the output sequence may include a sequence of words in the same language that represent a response to the query or prompt; and the output probabilities may include the probabilities of words in the second language for a particular position in the response. In some cases, the output sequence includes only the tokens up to a particular position (e.g., the first n−1 tokens of the output sequence), and the output probabilities represent the probabilities of tokens in the language of the output sequence that could follow the output sequence (e.g., the nth token in the output sequence). In some cases, the output sequence includes all of the tokens except the token a particular position (e.g., all of the tokens except the nth token of the output sequence), and the output probabilities represent the probabilities of tokens in the language of the output sequence that could represent the missing token in the output sequence (e.g., the nth token in the output sequence).

The encoder receives an input sequence comprising a set of tokens. The input sequence may be padded to a given length corresponding to a configured input size for the encoder. The input sequence is processed by a position encoder to encode the positions of the respective tokens of the input sequence. The input sequence is also processed by an embedding model to determine the embeddings of the tokens of the input sequence. The encoded positions and embeddings are used to generate an encoder model input, including a query (e.g., a position of one or more tokens in the input sequence), a set of keys (e.g., the encoded positions and embeddings for each token of the input sequence), and a set of values (e.g., additional language features of the tokens such as outputs of sentiment analysis). The set of values may be a copy of the set of keys if no additional data features are available. The encoder model input is processed by a multi-head attention layer, such as an instance of the attention layer shown in FIG. 102. The multi-head attention layer determines self-attention within the input sequence (e.g., the relatedness of a respective token of the input sequence to each other token of the input sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The encoder also includes a feed-forward layer (e.g., a fully-connected layer and/or a sparsely-connected layer) including a set of trainable parameters. The output of the feed-forward layer is provided to another layer normalization component, along with the output of the preceding layer normalization component via a skip layer. The encoder outputs an input sequence attention, which indicates, for each of one or more tokens of the input sequence, the relatedness of each other token of the input sequence.

The decoder features an architecture that is similar to the encoder, but that includes additional components to incorporate the input sequence attention generated by the encoder. The decoder receives an output sequence comprising a set of tokens. The output sequence may be padded to a given length corresponding to a configured input size for the decoder. The output sequence is processed by a position encoder to encode the positions of the respective tokens of the output sequence. The output sequence is also processed by an embedding model to determine the embeddings of the tokens of the output sequence. The encoded positions and embeddings are used to generate a decoder model input, including a query (e.g., a position of one or more tokens in the output sequence), a set of keys (e.g., the encoded positions and embeddings for each token of the output sequence), and a set of values (e.g., additional language features of the tokens such as outputs of sentiment analysis). The set of values may be a copy of the set of keys if no additional data features are available. The decoder model input is processed by a masked multi-head attention layer, such as an instance of the attention layer shown in FIG. 102. In addition to determining attention, the masked multi-head attention layer masks the input values of a current token of the output sequence and any tokens of the output sequence that follow the current token. The masked multi-head attention layer determines self-attention within the output sequence (e.g., the relatedness of a respective token of the output sequence to each preceding token of the output sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The decoder further includes an encoder-decoder multi-head attention layer that receives both the output of the preceding layer normalization component and the input sequence attention generated by the encoder. The encoder-decoder multi-head attention layer does not determine self-attention within the output sequence, but, rather, determines the attention between the tokens of the output sequence and the corresponding tokens of the input sequence. The output of the encoder-decoder multi-head attention unit is also received and processed by a second layer normalization component. Additionally, a skip layer is provided that passes the input to the encoder-decoder multi-head attention layer through to the second layer normalization component. The second layer normalization component combines the output of the multi-head attention layer with the input to the encoder-decoder multi-head attention unit (e.g., via arithmetic mean, median, min, max, addition, multiplication, or the like) and normalizes the combined output to within a desired range. The decoder also includes a feed-forward layer (e.g., a fully-connected layer and/or a sparsely-connected layer) including a set of trainable parameters. The output of the feed-forward layer is provided to a third layer normalization component, along with the output of the preceding layer normalization component via a skip layer. The output of the decoder is processed by a fully-connected layer and a softmax normalization layer based on a cross-entropy determination.

The output of the softmax normalization layer includes a set of probabilities for each possible token of a language of the output sequence for the current token. As a first example, the input sequence may include a sequence of words in a first language; the output sequence may include a sequence of words in a second language corresponding to a translation of the input sequence, up to a current (nth) word in the translation; the output probabilities may include the probabilities of words in the second language for the nth word in the translation. As a second example, the input sequence may include a sequence of words in a language that represent a query or prompt; the output sequence may include a sequence of words in the same language that represent a response to the query or prompt, up to a current (nth) word in the response; and the output probabilities may include the probabilities of words in the language for the nth word in the response.

During training, the transformer model may be provided with a set of input sequences and complete corresponding output sequences. As a first example involving language translation, the transformer model may be provided with a training data set including a first corpus of sentences in a first language and a second corpus of sentences in a second language that respectively correspond to the sentences in the first language. As a second example involving a generative model, the transformer model may be provided with a training data set including a first corpus of queries or prompts in a language and a second corpus of responses in the language that correspond to the respective queries or prompts. For each training data input, a pair of sentences of the first corpus and second corpus are selected. The encoder is provided with the first (input) sentence, and the model is processed to determine the first word in the second (output) sentence. In this case, the output sequence provided to the decoder is completely masked so that the decoder cannot make predictions based on the expected words in the second sentence. The word probabilities determined by the decoder are compared with the actual first word in the output sequence, and backpropagation is applied through the decoder and encoder to increase the likelihood of outputting the expected word. The backpropagation includes adjusting the parameters of the attention layers to increase the attention between the first word and related words of the input sequence. The encoder is then provided again with the first (input) sentence, and the model is processed to determine the second word in the second (output) sentence. In this case, the output sequence provided to the decoder includes the unmasked first word, but masks all words after the first word. The word probabilities determined by the decoder are compared with the actual second word in the output sequence, and backpropagation is applied through the decoder and encoder to increase the likelihood of outputting the expected word. The backpropagation includes adjusting the parameters of the attention layers to increase the attention between the second word, the known first word of the output sequence, and related words of the input sequence. In this manner, the transformer model performs an autoregressive prediction, wherein the output probability of each nth token of the output sequence is based on the input sequence, the previously predicted tokens of the output sequence, and the encoder-decoder attention therebetween. Training continues over the entirety of the first and second corpora to improve the output predictions.

In many cases, the training of the transformer model occurs in batches. For example, the previous (simplified) training example described an incremental training of the transformer model over each corresponding pair of sentences of the first and second corpora, wherein the parameters of the transformer model are adjusted via backpropagation after each instance of processing. In batch training, the input and output sequences are vectorized, as are the layers of the transformer model, such that predictions over each word of the output sequence are predicted in parallel. Backpropagation parameter adjustment is performed for each batch of the training data set, based on the outputs for all of the pairwise inputs of each batch of the training data set.

After training, the transformer model can be used to predict an output sequence based on an input sequence. First, the input sequence is processed by the encoder, while the decoder processes a null output sequence (e.g., an output sequence in which all outputs are initially nulled and/or masked by the masked multi-head attention layer). The output probability of the decoder is used to determine a first token of the output sequence. In some embodiments, the first token is chosen as the token having the highest probability. In other embodiments, the first token is chosen based on a random sampling over the output probabilities. In either case, the transformer is then applied to the same input sequence and an output sequence including only the determined first token of the output sequence, and the output of the decoder determines the second token of the output sequence. This process continues until reaching an output token cap and/or upon determining, as the output of the decoder, an end-of-sequence token. In this manner, the transformer model is applied over the input sequence to determine, in serial and autoregressive manner, the tokens of the output sequence.

It is to be appreciated that the transformer model shown in FIG. 103 presents only one example, and that transformer models may include a variety of variations with respect to the example of FIG. 103. For example, the architecture of the encoder and/or decoder may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the encoder and/or decoder shown in FIG. 103 may vary in numerous respects. For example, masking may be applied directly to the output sequence instead of within the multi-head attention models. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in transformer models to process a variety of types of input and output sequences.

Transformer models, including the example shown in FIG. 103, may be applied in a variety of circumstances. As an example, transformer models may be trained on and/or configured to process a variety of types of input sequences and/or output sequences. Sequential data inputs and/or outputs can include a wide variety of types described herein, such as strings of text, sequences of sensor data from or about an entity, sequences of steps in a process (e.g., chemical, physical, biological, and many others) or flow (e.g., a human workflow, information technology traffic flow, physical traffic flow, sequences of user behavior (e.g., attention to content, clickstream behavior, shopping behavior (digital and real world), and many others. Any of these, and others can be provided as inputs to train a transformer model, which may be alternatively described herein as a self-attention model, a foundation model, or the like. A range of mathematical self-attention techniques can be applied to detect how data elements in sequential data mutually affect each other (such as in feed forward, feedback, and other forms of influence and dependency). In various embodiments described herein and in the documents incorporated by reference herein, a set of transformer models may be deployed for a wide range of use cases, including for predictive text applications (e.g., generating a next token of text based on a previous set of tokens, such as for intelligent agent dialog, responses to queries, and the like); for extraction of information (such as extraction of meaningful elements from sensor data, signal data, and the like, such as analog signal data from sensors on machines, wearable devices, infrastructure sensors, edge and IoT devices, and many others); for analysis of human factors, such as emotional response, sentiment, satisfaction, opinion, and the like; for summarizing data (such as providing summaries of text, images, video, sensor data, and many other streams of data of the type collected and processed as described herein); for trend detection, prediction and forecasting (and hence also for anomaly detection, such as fraud in financial transactions), including for a wide range of trends, including health (human, animal, mental, financial, machine condition, and others), performance (wellness, financial, physical, and many others), and many others; for recognition of entities and behaviors (such as objects appearing in video or image data, objects captured in LIDAR and other point-cloud rendering systems, objects located by SLAM systems, and many others); for generation and execution of instructions (e.g., recipes, control instructions, rules, regulations, governance instructions, and many others); and for many other uses.

In embodiments, an input data set, such as an analog or digital sensor data stream, a body of text, a set of images, a set of structured data (such as data from a graph database or other form of database noted herein, a sequence of blockchain or distributed ledger entries (or other ledger data, such as accounting, financial, health or other data), a set of signals (of the various types noted herein), is provided in order to train a transformer model. In embodiments, initial training may include a step of facilitating compression of the input data, such as by constraining the size of the transformer neural network and/or its outputs, to dimensionality that is significantly smaller (or less granular, etc.) than that of the input data. By requiring the output of the constrained transformer model to match, within a required metric of fidelity, the input data, the transformer model is caused to generate an “embedding” of the input data into a more compressed, efficient format. A decoding neural network may then be trained to operate on the output of the constrained, embedding transformer model, such that it can reproduce the input data from the output of the constrained model within the required metric, thereby assuring that the data is compressed without losing critical meaning.

Once the embedding transformer model is so trained, the decoding neural network can be removed and replaced by one or more of a set of use-case driven decoding models, each of which is trained to operate on the output of the embedding model to produce a target outcome, such as performing any of the use cases noted above to a satisfactory degree. These use-case decoding models can be fine-tuned iteratively over time with feedback from users, outcomes, or the like. Thus, a trained embedding foundation/transformer model, once created, can be used across many different use cases that may benefit from understanding the meaning of the input data set.

In embodiments, one type of use-case decoder can be trained to allow the embedding transformer model to operate on lower quality data than was originally supplied to train the model. To accomplish this, both low quality and high quality data (such as high granularity sensor data and low granularity sensor data, or high dimensionality signal data and low dimensionality signal data, or noisy acoustic data and filtered acoustic data, or the like) can be simultaneously fed to a pair or more of instances of the trained, embedding transformer model, and a decoder for the instance of low quality data can be trained to generate an output that matches, within a metric of fidelity, the output of the instance of the embedding transformer model that is fed the high quality data. As an example, gap-free analog waveform data from a three-axis vibration sensor on a machine component can be captured simultaneously with less granular data from a single- or two-axis accelerometer on the same component, and a decoder, operating on the output of the instance of the embedding transformer model that takes the single- or two-axis input, can be trained to match (within a tolerance) the output of the instance of the embedding transformer model that takes the more granular data as an input. Once created, the resulting decoder, coupled with the embedding transformer model, serves as a projection transformer model, effectively projecting lower quality data into higher quality data, which can then be used by other decoders to enable use cases. This class of projecting transformer models can be applied to a wide range of use cases where high quality data can be obtained during a training phase (often at higher expense), but lower quality data can be used as an input during a deployment phase (such as where lower quality data is more widely or cheaply available, such as in the case of vibration data noted above). Among other things, these projecting transformer models allow powerful, real-time, low latency use cases for AI even when input data is sparse, noisy, of low dimensionality, or the like.

In embodiments, feedback from various decoder models can be used to improve instances of an embedding foundational or transformer model. In embodiments, a set of transformer models, a set of decoders, or both, can be arranged in a workflow, which may be directed/acyclical or with processing loops, to create higher-level use cases that benefit from multiple applications of AI. For example, one model may be used to classify a condition, another used to generate a recommendation, and another used to generate a control instruction, among a huge range of possible embodiments. This may include serial, parallel, iterative, feed forward, feedback and other configurations.

In embodiments, a set of models may be trained to generate instructions for configuration of other models.

In embodiments, transformer models may be deep learning, self-learning, self-organizing, or the like, and may be used for any of the embodiments of self-learning, self-organization, or other self-referential capabilities noted throughout this disclosure or the documents incorporated by reference herein. They may also be supervised, semi-supervised, or the like. Transformer models may be coupled with, integrated with, linked to, or the like, in series, parallel or other more complex workflows, with other AI types, such as other neural network types (e.g., CNNs, RNNs, and others). For example, in embodiments, a transformer model operating on sequential data may be coupled with a model suited to operate on non-sequential data (e.g., for pattern recognition) to achieve a use case.

In embodiments, transformer models discover patterns in large bodies of data by application of a set of mathematical functions, optionally operating in parallel processing configurations, thereby eliminating or reducing the need for human labeling (and thereby greatly expanding the set of available data that can be used to train a model).

Self-attention may be accomplished in a transformer model by introducing a set of positional encoders that tag data elements entering and exiting a neural network and inserting a set of attention units at appropriate places in the encoding and decoding framework of an AI system. The attention units generate a mathematical map of interrelationships among data elements. In embodiments multi-headed attention units are deployed, executing a matrix of equations in parallel to determine the interrelationships. Transformer models, using self-attention, have displayed strong capabilities to provide outputs that are consistent with how humans find patterns and meaning in data.

In embodiments, transformer models may be embodied with very large numbers of parameters (e.g., hundreds of millions, billions, trillions, or more) operating on very large sets of parallel processors. For example, the Megatron-Turing Natural Language Generation Model by NVIDIA and Microsoft is reported to have 530 billion parameters. As noted above, from a foundational model, various use-case specific models (decoders, projections, and the like) can be purpose-built for specific applications. Accordingly, in embodiments a set of transformer models may be deployed using advanced computational techniques and/or processing architectures, such as ones that simplify or converge processors, simplify I/O, and the like. For example, 3D chipset or chiplet architectures may facilitate much higher density, faster computation, making transformer models more cost-effective. Quantum computation may also facilitate massively parallel processing in form factors that are faster, more energy efficient, or the like. Similarly, embodiments may use a tensor-engine GPU chip with a specific transformer engine, such as the NVIDIA H100 Tensor Core GPU. Another example of a transformer model is Google's switch transformer model, a trillion-parameter model that uses sparsity and a mixture-of-experts architecture to enable gains in performance and reductions in training speed.

As noted above, in embodiments smaller or more constrained transformer models may be trained to generate embeddings, particularly for very complex data sets, such as granular analog data.

In embodiments a set of transformer models may be configured to operate on structured data processing systems, such as on results from queries that are directed to a database, results of inputs directed to a set of APIs, or the like. This may facilitate better understanding of what meaning a transformer model is recognizing in a data pattern, which can be critical to ensuring quality (e.g., where a model may, due to flaws in underlying data, generate poor conclusion, such as replicating historical racial bias, missing critical balancing information, failing to understand formal logical constructs, or the like). As noted elsewhere in this disclosure and the documents incorporated herein, governance of AI in general, is a need, and the scale and complexity of transformer models likely compounds problems recognized with other neural networks, including their “black box” nature, uncertainty about input quality, and the like. Thus, governance concepts disclosed herein and in documents incorporated by reference should be understood to apply to various embodiments that use transformer models, as with other types of AI. One example is in the training of models, where models may be trained, in embodiments, in various disciplines, optionally similar to the educational frameworks by which humans are trained not just to sense pattern meaning, but also how to test and govern those abilities with formal reasoning and logic, mathematics, probability, and frameworks of ethics and morality.

In some aspects, the techniques described herein relate to a system for optimizing and/or improving a value chain network (VCN) using transformer models including one or more memories and one or more processors configured to perform operations including: receiving an input data set representing a VCN including nodes and edges; encoding the input data set using an encoder of a transformer model to generate a contextual representation; decoding the contextual representation using a decoder of the transformer model to generate an output data set indicative of VCN improvements; and output the improved VCN data set for facilitating decision-making in the VCN.

The system for improving a value chain network (VCN) utilizes the transformer model architecture to process complex and multi-dimensional input data sets. The input data set may include a variety of data types such as production volumes, inventory levels, lead times, supplier performance metrics, transportation costs, market demand signals, customer order histories, and the like. Each data type may be represented as nodes (e.g., factories, warehouses, products) and edges (e.g., supply lines, distribution routes) within the VCN.

The system, equipped with the transformer model's encoder, is configured to transform this raw data into a high-dimensional space where relationships and patterns can be discerned through self-attention mechanisms. The encoder may use positional encodings to retain the sequential nature of the data, such as the order of events in a supply chain timeline. It may then apply multiple layers of self-attention where each layer computes attention scores that signify the importance or influence of different nodes and edges on each other. This process allows the model to contextualize each element within the entire network, taking into account both direct and indirect dependencies.

An example embodiment of this system could involve a multinational manufacturing company seeking to optimize its global supply chain. The input data set for the transformer model could include real-time data streams from IoT sensors on factory equipment, historical production data, current inventory levels across global warehouses, in-transit shipment statuses, supplier delivery records, and predictive demand forecasts generated by market analysis tools, among many others. By processing this data, the system could identify bottlenecks, predict potential disruptions, and suggest reallocations of resources such as rerouting shipments to avoid delays caused by a natural disaster or reallocating production to underutilized plants to meet a surge in demand in a specific region. The output of the system would be an optimized VCN data set that provides actionable insights, such as adjusting order quantities, reconfiguring distribution networks, or changing supplier selection criteria to improve overall network resilience and efficiency.

In some aspects, the techniques described herein relate to a system, wherein the system is further configured to apply multi-head attention mechanisms to determine relationships between nodes and edges within the VCN. The system employs multi-head attention mechanisms within the transformer model to analyze and interpret the relationships between various entities in the VCN. This approach allows the system to concurrently process different types of relationships, such as supply chain dependencies and production bottlenecks, by projecting these relationships into different representation subspaces and then integrating the information. For example, in a VCN that includes a complex logistics network, the system could use multi-head attention to simultaneously evaluate the impact of transportation delays, supplier reliability, and demand variability on overall network efficiency.

In implementations, the techniques described herein relate to a system, wherein the system is further configured to perform autoregressive prediction of VCN configurations using the output data set. The system's autoregressive prediction feature enables it to sequentially generate future states of the VCN by considering each node and edge in the context of the previously generated outputs. This is achieved through the decoder component of the transformer model, which builds the output sequence one element at a time, conditioned on the accumulated sequence thus far. In practice, this could manifest in a VCN that anticipates and adjusts to potential disruptions in the supply chain, such as a sudden increase in raw material costs or unexpected changes in consumer demand.

In some embodiments, the techniques described herein relate to a system, wherein the system is further configured to utilize positional encoding to maintain the sequence order of the VCN data within the transformer model. Positional encoding is a critical feature of the transformer model that allows the system to maintain the order of events within the VCN. This is particularly important for time-series data where the sequence of transactions or logistical events carries significant meaning. The positional encoding adds information to each node in the sequence, enabling the model to differentiate between elements based on their position in the sequence. An example embodiment could involve a VCN where the system uses positional encoding to optimize the timing of product launches across different markets.

In some aspects, the techniques described herein relate to a system, wherein the system is further configured to implement layer normalization within the transformer model to stabilize the learning process. Layer normalization is implemented within the transformer model to ensure consistent training dynamics and to help the model generalize across different inputs. By normalizing the inputs to each sub-layer within the encoder and decoder, the system can train more effectively, leading to faster convergence and improved performance. For instance, a VCN that experiences seasonal demand spikes could benefit from a system that adapts quickly to these changes, ensuring that the network remains responsive and efficient.

In embodiments, the techniques described herein relate to a system, wherein the system is further configured to adjust the transformer model parameters based on a set of training data representing historical VCN performance. The system's parameter adjustment is informed by historical VCN performance data, allowing for the refinement of the transformer model over time. This iterative training process involves adjusting weights and biases within the model to minimize loss functions that measure the discrepancy between the model's predictions and actual historical outcomes. An example embodiment might involve a VCN that refines its predictive maintenance schedules for machinery by learning from past maintenance records and operational data.

In some aspects, the techniques described herein relate to a system, wherein the system is further configured to generate predictions for VCN resource allocation based on the output data set. The system generates resource allocation predictions for the VCN based on the output data set, which may include optimized configurations and operational recommendations. These predictions may be derived from the transformer model's ability to synthesize large amounts of data and identify patterns that may not be immediately apparent to human analysts. For example, a VCN could use the system to dynamically allocate production capacity across different factories in response to shifting market trends, thereby maximizing efficiency and reducing lead times.

### VCN Converging Technology Stack

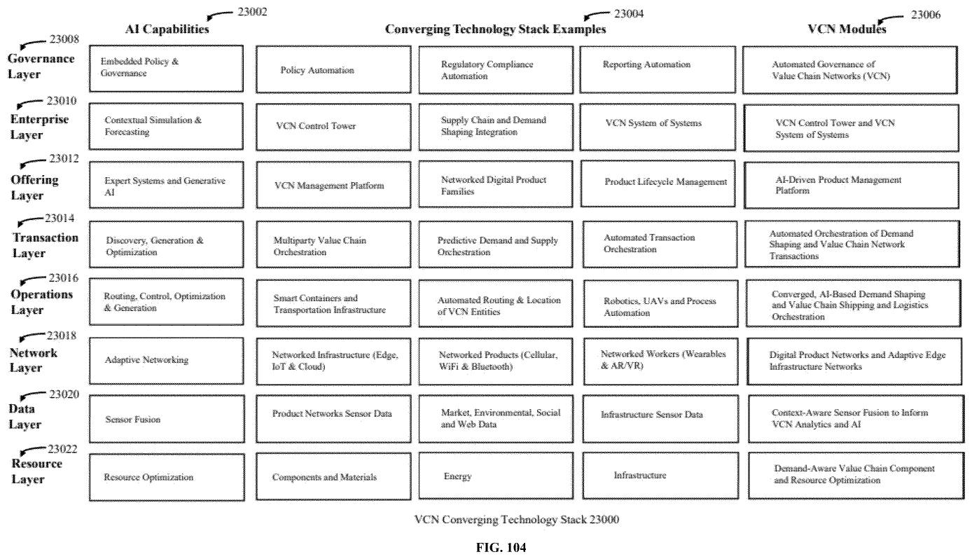

Referring to FIG. 104, a value chain network (VCN) converging technology stack 23000 is illustrated in accordance with some embodiments. A plurality of VCN modules 23006 are increasingly enabled at various layers by the convergence of AI capabilities 23002 with other technologies, impacting existing VCN operations, and some cases, enabling entirely new VCN operations. This technology convergence enables various VCN operations, which support various use cases and/or converging technology stack examples 23004 for a multitude of VCN scenarios.

In embodiments, the VCN modules 23006 may include automated governance of VCN modules at the governance layer 23008, VCN control towers and VCN system of systems modules at the enterprise layer 23010, an AI-driven product management platform modules at the offering layer 23012, automated orchestration of demand shaping and value chain network transactions modules at the transaction layer 23014, converged AI-based demand shaping and value chain shipping and logistics orchestration modules at the operations layer 23016, digital product networks and adaptive edge infrastructure networks modules at the network layer 23018, context-aware sensor fusion to inform VCN analytics and AI modules at the data layer 23020, and demand-aware value chain component and resource optimization modules at the resource layer 23022.

At the governance layer 23008, artificial intelligence (AI) capabilities 23002 for embedded policy and governance may enable an automated governance of VCNs modules. Converging technology stack examples 23004 at the governance layer 23008 may include policy automation, regulatory compliance automation, reporting automation, executive digital twins, safety automation, and the like. The automated governance of VCNs module may address how increasingly digitized and networked product networks and infrastructure operations can be governed by policy automation that keeps in step with ever-shifting regulatory frameworks that apply to operations.

In embodiments, the automated governance of VCN modules are supported by advanced embedded policy and governance AI capabilities. The automated governance of VCN modules may be configured to autonomously enforce compliance and governance standards across VCN activities, transactions, and operations by leveraging a sophisticated AI framework. The automated governance of VCN modules may be configured to interpret and apply a comprehensive array of regulatory requirements, internal control policies, and industry standards to real-time VCN data flows. In embodiments, the automated governance of VCN modules utilize AI algorithms to continuously monitor, analyze, and make determinations on the compliance status of each transaction, activity, and/or operation, thereby ensuring adherence to the pertinent legal and regulatory frameworks. The AI-driven modules may dynamically adapt to regulatory changes, thereby maintaining up-to-date compliance. Furthermore, the modules may automate the generation of detailed compliance reports and maintain an immutable audit trail for each transaction, activity, and/or operation, thereby facilitating transparency and accountability. By embedding these AI capabilities directly within the VCN infrastructure, the modules significantly enhance the efficiency, accuracy, and reliability of the governance process, while simultaneously mitigating risk and reducing the operational burden associated with manual governance and compliance checks.

At the enterprise layer 23010, AI capabilities 23002 for contextual simulation and forecasting enable VCN control tower and VCN system of systems modules. Converging technology stack examples 23004 at the enterprise layer 23010 may include the VCN control tower, VCN mini control towers, big data and analytics, executive digital twins, supply chain and demand shaping integration, VCN system of systems, and the like. The VCN control tower and VCN system of systems modules may provide centralized and decentralized control frameworks for managing disparate product, infrastructure, transportation and other intelligent and networked entities involved in supply chain and demand planning activities.

In embodiments, an AI-based VCN control tower and VCN system of systems modules are empowered by contextual simulation and forecasting capabilities. These modules may integrate a sophisticated artificial intelligence framework that utilizes contextual data analysis to simulate various VCN scenarios and forecast potential outcomes. By processing vast datasets, including historical data, demand data, supplier data, current market trends, and predictive indicators, among many others, the modules can use comprehensive models that provide deep insights into the potential ramifications of different VCN strategies, operations, transactions, activities, and the like. The forecasting engine may employ advanced algorithms to predict future demand conditions, financial performance, risk exposure, and the like, thereby enabling enterprises to make informed decisions. The contextual simulation aspect may allow for the creation of virtual environments where hypothetical VCN decisions can be tested, providing a sandbox for strategic planning without the risk of actual commitment. The AI-driven modules may be configured to assist enterprises in optimizing their workflows for VCN, aligning strategies with business objectives, and proactively managing risks, thereby enhancing the overall efficacy and strategic agility of the enterprise's VCN operations, activities, and transactions.

At the offering layer 23012, AI capabilities 23002 for expert systems and generative AI enable AI-driven product management platform modules. Converging technology stack examples 23004 at the offering layer 23012 may include, but are not limited to, a VCN management platform, networked digital product families, product lifecycle management, recommendation systems, smart products, extended reality systems (e.g., AR, VR, MR), targeted advertising, expert systems, generative AI, and the like. The AI-Driven product management platform modules may be configured to enable AI optimization of features across digital networks and families of products at all phases of the product life cycle, including design, R&D, planning and simulation, shipping and logistics, storage, retailing and customer use.

In embodiments, the AI-driven product management platform modules may leverage the combined strengths of expert systems and generative artificial intelligence (AI) to deliver product management capabilities, including product development, inventory management, marketing and sales, quality assurance, lifecycle management, and many others. Expert systems within the module may utilize various approaches to analyze customer behaviors and transaction histories, enabling the identification of customer needs, preferences, and future demand. Generative AI algorithms may synthesize this data to create and propose targeted marketing campaigns. This AI approach ensures that products are in demand by consumers and that such demand is met by available inventory in preferred distribution channels. The modules seamlessly supports digitally connected products, providing vast amounts of data around product usage, product performance, product environments, and the like. Customer interactions with the digitally connected products are continuously fed back into the modules, refining the AI models to enhance future product designs and improve customer satisfaction. These sophisticated modules thus represent a significant advancement in the customization and delivery of products, driving engagement and value for both the enterprise and its customers.

At the transaction layer 23014, AI capabilities 23002 for discovery, generation, and optimization enable automated orchestration of demand shaping and VCN transactions modules. Converging technology stack examples 23004 at the transaction layer 23014 may include multiparty value chain orchestration, predictive demand and supply orchestration, automated transaction orchestration, and the like. The automated orchestration of demand shaping and VCN transactions modules may enable automated adjustment of pricing, promotion, and other transaction parameters based on marketplace conditions and sensor data from products and infrastructure.

In embodiments, automated orchestration of demand shaping and VCN transactions modules are fundamentally enabled by AI specialization in discovery, generation, and optimization. These modules may employ AI to intelligently shape demand by adjusting pricing, marketing, providing distribution channel incentives, and the like. The modules may analyze market behaviors, customer behaviors, demand factors, transactional histories, sensor data from products, and many others to recommend optimal strategies to shift demand. The automated VCN transaction orchestration use cases may be implemented through a combination of machine learning algorithms that recommend transaction partners (e.g., suppliers, retailers, logistics partners, and the like), predict transactional outcomes, natural language processing for contract generation, and neural networks that adaptively learn from each transaction to enhance future performance. Technical solutions for the implementation may include blockchain technology for secure and transparent smart contract execution, distributed ledgers for maintaining a consistent and immutable record of transactions, and the like.

At the operations layer 23016, AI capabilities 23002 for routing, control, optimization, and generation enable converged, AI-based demand shaping and value chain shipping and logistics and orchestration modules. Converging technology stack examples 23004 at the operations layer 23016 may include smart containers and transportation infrastructure; automated routing and location of VCN entities; and robotics, UAVs and process automation. Additional converging technology stack examples may include autonomous control; supervised control; digital product networks; supply chain networks; value chain networks; smart product operations; smart asset operations; smart infrastructure operations; smart machine operations; shipping operations; human-machine cooperative operations; and the like. Converged, AI-based demand shaping and value chain shipping and logistics orchestration modules may automate demand management activities and optimize transportation routing and use of storage and warehousing infrastructure, each based on marketplace conditions and sensor data from products and infrastructure.

In embodiments, converged, AI-based demand shaping and value chain shipping and logistics and orchestration modules are enabled by sophisticated artificial intelligence (AI) capabilities in routing, control, optimization, and generation. These modules may utilize AI to automate demand management activities such as demand forecasting, demand planning, product portfolio management, customer relationship management, order management, pricing management, marketing and promotion, demand shaping, channel management, supply chain coordination, and risk management. Such automation may be driven by many types of data, including sensor data, marketplace data, customer behavior data, historical sales data, and the like. In embodiments, these modules may manage the routing and control of smart containers, trucks, ships, ports, transportation infrastructure, robotics, UAVs, and the like to enable an optimized and automated VCN. Robotic process automation (RPA) may be leveraged by this module to automatically schedule shipments, process invoices, and the like.

At the network layer 23018, AI capabilities 23002 for adaptive networking enable digital product networks and adaptive edge infrastructure networks modules. Converging technology stack examples 23004 at the network layer 23018 may include networked infrastructure (edge, IoT, and cloud), networked products (cellular, WiFi, and Bluetooth), and networked workers (wearables and AR/VR). Digital product networks and adaptive edge infrastructure networks modules may support peer-to-peer interactions among smart products or product families for data collection and automated coordination of supply chain and demand shaping activities.

In embodiments, digital product networks and adaptive edge infrastructure networks modules are enabled by adaptive networking AI capabilities. These modules may be configured to facilitate communications among smart products, their users, their manufacturers, and the like for data collection and automated supply chain optimization while also leveraging AI to dynamically adapt network configurations and optimize data flow. The integration of edge computing with cloud services ensures that data processing and operation orchestration can occur closer to the data source, reducing latency and enhancing real-time decision-making capabilities. The AI algorithms associated with these modules may be capable of intelligently routing VCN data through the most efficient network paths, whether they be cellular, WiFi, Open Radio Access Network (ORAN), Bluetooth, or other IoT communication protocols. For implementation, the modules may utilize technical features such as machine learning for predictive network traffic management, ensuring bandwidth is allocated where needed most, and cryptographic techniques for securing data at the edge. Additionally, the module may employ AI-driven anomaly detection systems to monitor network health and preemptively address potential disruptions. By integrating these technical features, the digital product networks and adaptive edge infrastructure networks modules are capable of supporting the complex requirements of modern distributed digital product networks and operations.

At the data layer 23020, AI capabilities 23002 for sensor and data fusion enable context-aware sensor fusion to inform VCN analytics and AI modules. Converging technology stack examples 23004 at the data layer 23020 may include product networks sensor data; market, environmental, social, and web data; and infrastructure sensor data; and the like. Context-aware sensor fusion to inform VCN analytics and AI modules fuse data from disparate sensor and other data sources to facilitate AI classification, prediction, and optimization for a wide range of demand shaping and supply chain operations.

In embodiments, context-aware sensor fusion to inform analytics and AI modules are facilitated by the integration of data and/or sensor fusion technology. These modules may be configured for synthesizing diverse data streams, including real-time sensor data, social media analytics, and web data, to provide a comprehensive view of VCN transactional and operational environments. By employing sensor fusion, the modules may aggregate and process data from various sources, such as IoT devices, digitally connected products, and online behavior patterns, among many others, to generate a multidimensional context for each VCN activity and operation. The use of APIs and Service-Oriented Architecture (SOA) facilitates the seamless integration and exchange of data across distributed systems, ensuring that the modules have access to the most relevant and up-to-date information. Technical features for implementation may include advanced data normalization techniques to harmonize disparate data formats, machine learning algorithms for pattern recognition and predictive analytics within the fused data sets, and robust data security protocols to protect sensitive information. The AI component of the modules may utilize the enriched data to enhance VCN analytics, providing insights into customer behavior, market trends, supply chain risks, and the like. By leveraging these technical features, the context-aware sensor fusion to inform analytics and AI modules may significantly improve the accuracy and reliability of VCN analytics, enabling businesses to make data-driven decisions with greater confidence and strategic foresight.

At the resource layer 23022, AI capabilities 23002 for resource optimization enable demand-aware value chain component and resource optimization modules. Converging technology stack examples 23004 at the resource layer 23022 include components and materials, energy, and infrastructure. Demand-aware value chain component and resource optimization modules enable automated provisioning of resources used in product production, shipping, warehousing, and retailing to improve efficiency and other outcomes at all stages of a value chain network.

In embodiments, the demand-aware value chain component and resource optimization modules are enriched by resource optimization AI. The modules may be designed to optimize the allocation and utilization of infrastructure for product production, shipping, warehousing, and retailing; components and materials resources; energy resources; advanced computation resources; and other VCN resources through the application of advanced AI algorithms. In the context of advanced computation, the module may employ AI to dynamically allocate processing power and memory resources across various VCN applications, ensuring optimal performance and cost-efficiency. For energy optimization, the AI may analyze energy efficiency ratios and metrics in real-time. Technical features enabling these implementations may include deep learning networks for complex modeling, real-time analytics engines for monitoring resource utilization, and evolutionary algorithms that adapt strategies to changing market conditions. Additionally, the module may incorporate distributed ledger technology for transparent tracking of resource allocation decisions and smart contracts for the automated execution of optimization strategies. By integrating these technical features, the resource optimization modules provide a sophisticated framework for maximizing the efficiency and effectiveness of VCN resources.

### Digital Product Network System

The digital product network system 26000 is configured to integrate and facilitate interactions among a plurality of digitally connected products, the users of the products, and other stakeholders associated with the products (e.g., manufacturers, retailers, service providers, and the like).

The digital product network system 26000 is an advanced framework designed to support and enhance the functionality of a set of digital product networks 26102. This system is engineered to facilitate seamless connectivity and interaction among a diverse array of digitally connected products across various networks. By integrating multiple digital product networks into a unified system, digital product network system 26000 ensures that data flow and device communication are optimized, leading to improved operational efficiency and enhanced user experiences across different network environments.

In embodiments, digital product network system 26000 integrates with intelligence services system 8800, which incorporates sophisticated AI capabilities. This integration allows digital product network system 26000 to leverage AI-driven analytics and machine learning algorithms to analyze data collected from the digital product networks 26102. The AI capabilities of the intelligence services system 8800 enable predictive maintenance, real-time decision-making, personalized user experiences, and the like across connected product networks. For instance, by predicting device failures before they occur, the system can prompt preemptive maintenance, thereby reducing downtime and extending the lifespan of connected devices across various networks.

Furthermore, the AI integration enhances security measures within the networks. In embodiments, the digital product network system 26000 can leverage the AI capabilities of the intelligence services system to detect unusual patterns or potential security breaches by continuously monitoring network activity across all connected networks. This proactive security approach ensures that vulnerabilities are identified and addressed promptly, safeguarding the digital product networks 26102 and their connected devices against emerging threats. Additionally, AI-driven optimization of network resources ensures that the system operates at peak efficiency, dynamically allocating bandwidth and processing power where needed across different networks.

As used herein, the term “digitally connected products” (hereinafter, sometimes, simply referred to as “products” without any limitations) may encompass a broad range of offerings. A digitally connected product may refer to a product embedded with technology such as sensors, software, connectivity, memory, processors, and the like that allow it to collect, send, and/or receive data. In embodiments, digitally connected products may be connected to the internet or other devices.

The architecture of the digital product network system 26000 is designed to support and manage digital product networks 26102 efficiently. This architecture is modular and scalable, ensuring that it can adapt to varying network sizes and complexities, from small-scale setups to extensive industrial networks. The architecture is designed to be inherently scalable, capable of expanding to accommodate additional networks or increased device connectivity without significant redesigns. This scalability is crucial for future-proofing the system as the number of connected devices and network complexity grows.

In embodiments, the digital product network system 26000 may include a network interface layer. This foundational layer serves as the gateway for all digitally connected products across various networks. In some implementations, it is configured to handle data ingress and egress, ensuring seamless communication between devices and the central system. This layer may be equipped with advanced protocols to manage connectivity, data transmission, and network security.

In embodiments, the digital product network system 26000 may include a resource management module. In embodiments, the resource management module may be configured to dynamically allocate and optimizes network resources such as bandwidth and processing power. It ensures optimal performance across all connected networks, adjusting resources based on real-time demands and predictive data insights.

A robust security framework is embedded throughout the architecture. It includes advanced encryption, intrusion detection systems, and continuous monitoring capabilities. This framework not only protects against external threats but also ensures compliance with relevant data protection regulations.

In embodiments, the digital product network system 26000 employs specialized communication bridges that facilitate inter-network interactions. These bridges allow for data and resource sharing between different digital product networks, enhancing the system's overall efficiency and capability.

In some embodiments, a dashboard provides administrators and network managers with a centralized control point. From here, they can monitor network performance, manage connected devices, and implement changes across multiple networks.

As digitally connected products continue to proliferate, systems like the digital product network system 26000 will play a crucial role in shaping the future of digital product interaction and network management across diverse digital landscapes.

### Communication System

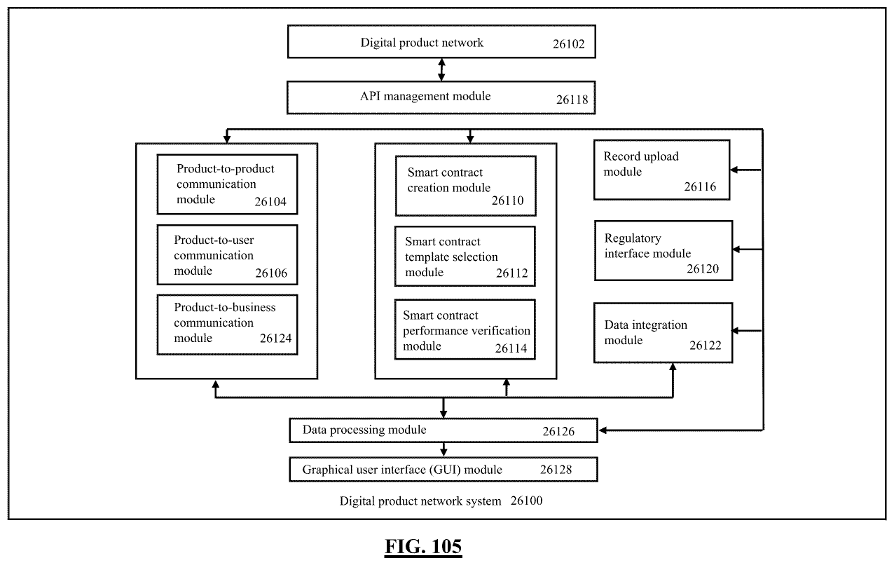

Referring to FIG. 105, a block diagram of the digital product network system 26200 embodied as a communication system is provided, according to some embodiments of the present disclosure. The digital product network system 26000 is depicted to include various modules therein. The digital product network system 26000 is capable of learning, adapting, and evolving, ensuring that it remains relevant, efficient, and user-friendly in the evolving landscape of digitally connected products.

As illustrated, the digital product network system 26000 includes a digital product network 26102 configured to interconnect a variety of digitally connected products; their corresponding users; and/or manufacturers, retailers, suppliers, service providers, and the like associated with the digitally connected products. The digital product network 26102 may provide a structured environment wherein multiple digitally connected products can coexist and interact. The digital product network 26102 enables the flow of information between various digitally connected products, their corresponding users, and other associated entities The digital product network 26102 facilitates a cohesive and synergistic integration of products, allowing for a more organized and structured interaction and communication among them. In embodiments, digitally connected products may be added and removed from the digital product network 26102.

In embodiments, the digital product network system 26000 includes a product-to-product communication module 26104 configured to exchange inter-product communications among the variety of connected digitally connected products. The product-to-product communication module 26104 facilitates a wide array of inter-product communications, including, but not limited to, status updates, device discovery, data exchange, command and control, coordination, alerts and notifications, event notifications, warnings, and feedback and responses. The product-to-product communication module 26104 may operate as the central hub for all communications between the digitally connected products within the digital product network 26102, ensuring that products can seamlessly interact with each other. This allows for the real-time exchange of vital information, commands, and data among the products, thus enhancing the overall functionality and efficiency of the digital product network. The product-to-product communication module 26104 may employ advanced communication protocols and algorithms to manage the exchange of information, ensuring that the communications are secure, reliable, and efficient. The interactions facilitated by the product-to-product communication module 26104 enable the digitally connected products to operate cohesively, share pertinent information, and respond to each other's states and commands effectively. In embodiments, the products may communicate via protocols, including Wi-Fi, Zigbee, Z-Wave, Bluetooth, industrial ethernet, IoT protocols like MQTT, and many other protocols. For example, smart thermostats and HVAC systems in a smart home environment (e.g., a digital product network) may communicate via Wi-Fi to adjust heating or cooling based on real-time weather data, occupancy, and individual preferences to optimize comfort and energy efficiency. In another example, in a smart factory environment with digitally connected products including robots and smart machines, smart machines may signal to robots that a manufactured item is ready for movement from one area of the factory to another area of the factory.

The digital product network system 26000 further includes a product-to-user communication module 26106 configured to exchange communications between the plurality of digitally connected products and their respective users. In particular, the product-to-user communication module 26106 acts as the interface between the users and the products, ensuring smooth and effective communication. The product-to-user communications facilitated by the product-to-user communication module 26106 may include a variety of interactions, including, but not limited to, user feedback, product instructions, notifications, customization, personalization, support, warnings, and community interaction. The product-to-user communication module 26106 enables the users to receive timely updates and notifications regarding the digitally connected products, customize their preferences, access support services, and interact with the community of users. Thus, the product-to-user communication module 26106 helps in enhancing user experience, allowing the users to tailor the products to their needs, receive support, and provide feedback. The product-to-user communication module 26106 ensures that the users are well-informed about the status and updates of the products, can easily customize their settings, and can interact with other users and the community efficiently. In embodiments, the communication between the products and users may be supported by various protocols, including Wi-Fi, Bluetooth, Bluetooth Low Energy (BLE), Zigbee, Z-Wave, MQTT, HTTP/HTTPS, and the like.

The digital product networks system 26000 may further include a product-to-business communication module 26124 configured to exchange communications between a plurality of digitally connected products and various enterprises, which may include product manufacturers, retailers, service providers, and similar entities. This module enables a range of communications that are essential for enhancing business operations, improving product offerings, and maintaining customer satisfaction. The types of communications facilitated by this module can include, but are not limited to, supply chain updates, inventory levels, demand surges, product performance data, maintenance alerts, customer usage statistics, and feedback for product improvement. By streamlining the flow of information between products and businesses, this module helps in optimizing product lifecycle management, enhancing product development, and enabling more effective marketing and sales strategies. This connectivity ensures that businesses remain well-informed and responsive to both market demands and product performance in real-time. In embodiments, the communication between the products and businesses may be supported by various protocols, including Wi-Fi, Bluetooth, Bluetooth Low Energy (BLE), Zigbee, Z-Wave, MQTT, HTTP/HTTPS, and the like.

The digital product network system 26000 may include a data processing module 26126 configured to process the inter-product communications, the product-to-user communications, and the product-to-business communications to determine time-sensitive alerts related to corresponding one of the plurality of digitally connected products. These time-sensitive alerts often signify situations or scenarios where immediate attention and action are important. Whether it is a potential overheating of a device, a breach in security, an inventory level alert, a critical software update that needs to be installed immediately, these alerts serve as an early warning system. The timely acknowledgment and resolution of these alerts by the users or the corresponding connected products are important to prevent potential damages, losses, or even disruptions in service.

The digital product network system 26000 may further include a graphical user interface (GUI) module 26108. The GUI module 26108 is configured to provide a set of user interfaces that display various information associated with at least one of the connected digitally connected products. Specifically, the GUI module 26108 provides a dynamic interface that allows users to interact with and manage the connected digitally connected products effectively. The GUI module 26108 may be configured to display information such as, but not limited to, product menus, product features, model name, model number, serial number, warranty information, data capacity, data available, battery percentage, charging data, Wi-Fi network information, Bluetooth information, communication protocol information, size and weight data, material and durability data, power consumption data, operating temperature and humidity range, input and output interfaces, sensors and actuators, temperature and humidity data, vibrations and shock data, wear and tear data, damage and defect data, firmware and software updates, design details, product capability data, product usage data, user demographics, product performance data, environmental data, customer feedback data, and maintenance and repair data. The interface provided by the GUI module 26108 may be configured to be intuitive and user-friendly, allowing the users to easily navigate through the various options and settings, manage the products efficiently, and access the required information as required. The displayed information is important for the users to understand the products better, manage them effectively, and optimize their usage. In embodiments, the GUI module 26108 may be provided on the digitally connected product itself or it may be accessed via an application associated with the digitally connected products, such as a mobile phone application.

In embodiments, the GUI module 26108 is configured generate one or more user interfaces specifically tailored for displaying time-sensitive alerts. These alerts pertain to a corresponding one of the vast plurality of digitally connected products. To ensure the user interface remains intuitive and adaptable to the urgency of these alerts, the GUI module 26108 may dynamically adjust the layout of a current user interface associated with the respective digitally connected product. The reason behind such a feature is the critical nature of these time-sensitive alerts. Such a proactive alert feature provided by the GUI module 26108 provides that all the digitally connected products within the network continue to operate seamlessly and without interruptions, thereby ensuring the integrity and efficiency of the digital product network system 26000.

In embodiments, the GUI module 26108 facilitates interaction through various user interfaces. For example, the communication may be facilitated by direct interaction with the product's user interface, which may include touchscreens, buttons, or voice commands. In embodiments, the communication may be facilitated by a dedicated mobile device application that allows users to control and monitor their products remotely, adjust settings, and receive notifications. In embodiments, the communication may be facilitated by a digital twin interface that provides a virtual representation of the physical products. Communication may also be facilitated to users via text, augmented reality devices, virtual reality devices, speakers, and the like.

In embodiments, the GUI module 26108 is configured to display a range of time-sensitive alerts. These alerts are designed to notify users of various conditions, situations, or changes related to the digitally connected products within the digital product network system 26000. Herein, the time-sensitive alerts may comprise at least one of a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a product safety alert, a health-related alert, a fitness-related alert, an energy-related alert, an inventory alert, a performance degradation alert, a compliance alert, a demand surge alert, a security breach alert, and a user-defined custom alert based on a specific conditions or threshold set by the user.

The low battery warning informs the user when a digitally connected product is running out of power and needs a recharge or battery replacement. The hardware failure notification comes into play when there is a malfunction or breakdown in any of the hardware components of a digitally connected product. The software update notification is crucial as it informs the user about available updates that can enhance the product's functionality or address known issues. Similarly, the connectivity issues notification is triggered when there are problems related to network or device-to-device connections. The unauthorized access warnings are vital for security, alerting the user when there's a potential breach or unauthorized attempt to access a digitally connected product. The maintenance reminders are particularly helpful in ensuring the longevity of the products, prompting users to perform routine checks or servicing. The temperature fluctuation notifications warn users if the digitally connected product is operating outside its recommended temperature range, which could affect its performance or lifespan. The performance degradation notifications inform users if the digitally connected product is not performing at its optimal level, while the storage capacity warnings come into play when the storage limit of a device is nearing its capacity. The firmware upgrade alerts notify users about essential firmware updates that may bring about new features or address security concerns. The scheduled backup reminders assist users in ensuring their data is regularly backed up, and the data breach notifications warn of any potential unauthorized access or leaks of sensitive information. The device inactivity alerts notify users if a digitally connected product hasn't been active for a predefined period, whereas the device overactivity or overheating warnings alert users if a digitally connected product is being overused or is at risk of overheating. The compatibility or synchronization issues with other devices are addressed by specific alerts, ensuring seamless integration and functionality across devices. The warranty expiration reminders and service subscription renewal alerts help users stay updated on their product's warranty status and service subscriptions, respectively. The sensor malfunction notifications inform users if any of the sensors in a digitally connected product are not working as expected. The environmental hazard alerts could be related to factors such as excessive moisture or exposure to harmful elements that could damage the product. The device location or movement alerts can notify users if their device has been moved or is outside a predefined geographical area. The user account changes or login notifications from unfamiliar locations are geared towards enhancing security, warning users of any suspicious account activity. The device lifecycle stage transition alerts inform users about the different stages in the lifecycle of their digitally connected products. The predictive alerts based on AI analysis utilize artificial intelligence to forecast potential issues or provide insights based on data patterns. The external power source disconnection warnings are crucial for devices dependent on external power, notifying users if there's an interruption. The accessory or peripheral malfunction notifications inform users if any attached accessories or peripherals are not functioning correctly. In some embodiments, the digital product network system 26000 provides users with the flexibility to define custom alerts based on specific conditions or thresholds set by the user, ensuring a tailored and personalized user experience.

In some embodiments, the GUI module 26108 is designed to generate a series of user interfaces, to display specific parameters of a digitally enabled product within the digital product network 26102. These displays navigate through a set of defined stages of the product lifecycle, offering users a comprehensive view of the product's journey within the network. Furthermore, the GUI module 26108 has the capability to showcase proximal products in the network, categorizing them based on brand, type, or capability, providing users with a holistic view of the product ecosystem.

The GUI module 26108 may employ advanced visualization techniques to represent the data and parameters in a clear and comprehensible manner. The GUI module 26108 allows the users to access and manipulate the data easily, customize the settings, and interact with the products seamlessly. Such representation of data enables users to make informed decisions regarding the usage and management of the products, enhancing their experience and ensuring optimal utilization of the products. The GUI module 26108 is a vital component of the digital product network system 26000, serving as the visual and interactive interface between the users and the products, facilitating effective management and optimal usage of the products.

In some embodiments, the GUI module 26108 is further refined to provide multiple user interfaces displaying related ones of the plurality of digitally connected products in the digital product network 26102 categorized by various parameters such as brand, type, and capability. This enhancement offers users a diversified and categorized view of the digitally connected products, thereby facilitating easy navigation and interaction with the products within the digital product network 26102.

In addition, the digital product network system 26000 further incorporates a series of smart contract modules, each configured to augment capabilities of the digital product network system 26000 in managing terms, conditions, and obligations related to the use, production, and procurement of the digitally connected products within the digital product network 26102.

In some embodiments, the digital product network system 26000 includes a smart contract creation module 26110 configured to facilitate the formulation of smart contracts. These smart contracts provide parameters of terms and conditions that apply to at least one of: the plurality of digitally connected products, a user of at least one of the plurality of digitally connected products, a manufacturer of at least one of the plurality of digitally connected products, a distributer of at least one of the plurality of digitally connected products, an insurance provider for at least one of the plurality of digitally connected products, a retailer of at least one of the plurality of digitally connected products, a service provider for at least one of the plurality of digitally connected products, and the like. The smart contracts may cover a wide variety of transactions, including a purchase, a return, a lease, a warranty, an extended warranty, a service contract, a maintenance contract, a trade-in, a product add-on, a new product feature, a contract for access to data, a purchase for access to one or more models, a software upgrade, a product upgrade, and unlocking an existing product feature. The smart contract creation module 26110 enables users to define the terms and/or conditions governing the transactions associated with the digitally connected products.

In some embodiments, the smart contract creation module 26110 is also configured to autonomously configure smart contracts based on predefined rules and conditions. This automation capability helps with the operational efficiency of the digital product network system 26000, enabling the rapid, accurate, and reliable configuration of smart contracts, thus facilitating the seamless interaction and transaction among the users, producers, and the digitally connected products within the digital product network 26102.

In some embodiments, the digital product network system 26000 also includes a smart contract template selection module 26112, designed to enable users to choose an appropriate smart contract template corresponding to the digitally connected products in question. The smart contract template selection module 26112 may impose restrictions, allowing users to select only those templates that are compatible with the digitally connected products they are associated with. This smart contract template selection module 26112 serves as a gateway for users to access, select, and utilize smart contract templates that are tailored to the specifications and requirements of the digitally connected products within the digital product network 26102. Specifically, the smart contract template selection module 26112 ensures that the users can only select and implement templates that are compatible with the digitally connected products that are the subject of the smart contracts.

In some embodiments, the smart contract template selection module 26112 is further configured to receive user inputs for parameterizing the selected template, generate a smart contract by incorporating the provided inputs into the variables within the contract, and subsequently deploy the smart contract by distributing it over the digital product network 26102 to the relevant digitally connected products. This enhances user interaction by allowing users to input specific parameters, customize the smart contract according to their requirements, and deploy it within the digital product network 26102. Further, this ensures that the generated smart contract is reflective of the user's needs and preferences and is communicated effectively to the relevant digitally connected products within the digital product network 26102.

In some embodiments, the smart contract template selection module 26112 is configured with the capability to recommend and/or suggest smart contract templates to the user based on the type of digitally connected product associated with the smart contract. In some examples, the smart contract template selection module 26112 suggests the smart contract templates to the user based on the user's past selections.

In some embodiments, the digital product network system 26000 further includes a smart contract performance verification module 26114 configured to verify the satisfaction of obligations defined within a smart contract associated with the respective digitally connected products. In embodiments, the verification of satisfaction of smart contract obligations may be performed using oracle services, which provide smart contracts with external information. The verification may also be performed using event-driven triggers, such as the verification of obligations when specific events are recorded on the blockchain. Other verification methods may include multi-signature approvals, time-locked contracts (e.g., smart contracts programmed with time locks to execute or verify obligations only after a certain time or condition is met), cryptographic techniques (e.g., zero-knowledge proofs), uploading of proof or records, consensus protocols, automated auditing and monitoring tools, and the like. The smart contract performance verification module 26114 may also be configured to automatically initiate and/or trigger actions upon successful verification of the performance of the obligations defined in the smart contract. These actions may include, but are not limited to, payments, providing notification to the user, updating the status of the smart contract, and initiating a new smart contract.

In some embodiments, the digital product network system 26000 includes a record upload module 26116 configured to enable users to upload a variety of records, including for verification purposes. The records may include, but are not limited to, photos, videos, audio recordings, device information, usage data, user preferences, troubleshooting records, upgrade records, reviews of the product, receipts for product-related costs and/or purchases, environmental data, and customer feedback. The record upload module 26116 may be configured to allow users to upload a wide range of records related to the smart contracts associated with products within the digital product network 26102. In some embodiments, the record upload module 26116 is further configured to autonomously categorize and store the uploaded records based on their respective types and the digitally connected products they are associated with. This feature ensures the seamless organization and storage of the diverse records, facilitating easy retrieval and analysis of the uploaded data and information. In embodiments, a smart contract may be deployed by broadcasting the smart contract to the at least one of the plurality of digitally connected products.

In some embodiments, the digital product network system 26000 further includes an application programming interface (API) management module 26118. The API management module 26118 may be configured to manage multiple APIs, exposing them to various related applications or third-party systems utilized by the digitally connected products within the digital product network 26102. In some embodiments, the digital product network system 26000 incorporates the API management module 26118 to oversee and manage one or more APIs integral to the system's operation. Within the digital product network system 26000, the APIs serve as the bridge between the system and external applications or third-party systems, ensuring that data and commands can be exchanged.

In some embodiments, the digital product network system 26000 further includes a regulatory interface module 26120 configured to facilitate interaction with one or more regulatory bodies. This regulatory interface module 26120 may serve as a bridge between the digital product network system 26000 and the regulatory entities, ensuring compliance with regulatory standards and facilitating communication and coordination with the regulatory bodies, thereby maintaining the regulatory compliance and integrity of operations in the digital product network system 26000. The regulatory interface module 26120 may facilitate automated reporting of necessary data to regulatory bodies, tools and/or modules that support regulatory compliance checks, and the like.

The management of digitally connected products in the digital product network system 26000 may create a complex regulatory environment. The wide range of digitally connected products, each with its unique functionalities and implications, may involve adherence to many different regulatory standards. For example, products within the system that utilize wireless communication technologies may be subject to the regulations set forth by the Federal Communications Commission (FCC). The FCC evaluates the radio frequency emissions of such products to ensure they do not interfere with other devices or pose any potential hazards. In addition, connected medical devices within the digital product network system 26000 may be subject to regulations set forth by the Food and Drug Administration (FDA). In yet another example, vehicles and transportation devices that are digitally connected and fall under the system's management may need to align with the standards and regulations imposed by the National Highway Traffic Safety Administration (NHTSA). The digital product network system 26000, through the regulatory interface module 26120, may be continuously updated and aligned with various regulatory bodies, ensuring that all digitally connected products managed by the system 26000 operate in compliance with regulatory frameworks, safeguarding both the end-users and the entities associated with the products.

In some embodiments, the digital product network system 26000 further includes a data integration module 26122. The data integration module 26122 is configured to integrate data from the plurality of digitally connected products within the digital product network 26102, creating a unified and coherent view of data associated with the digitally connected products. For this purpose, the data integration module 26122 may perform a series of operations including collecting and aggregating data, normalizing and standardizing data, cleaning and enriching data, analyzing and visualizing data, and the like. The integration of data by the data integration module 26122 may provide a consolidated view of diverse data sets such as product usage data, environmental data, product performance data, customer data, supply chain data, demand data, product location data, product customer feedback, product interaction data, product security data, product packaging data, product image data, product video data, product audio data, and product simulation data, and any other data types discussed throughout this disclosure, contributing to the complete understanding and analysis of the digitally connected products within the digital product network 26102.

Within the digital product network system 26000, the interoperability of the product-to-product communication module 26104 and the product-to-user communication module 26106 enables the digitally connected products and their users to interact in real-time, enhancing the responsiveness and functionality of the digital product network 26102. This interoperability is achieved through sophisticated synchronization algorithms and communication protocols, ensuring that the interactions are not only seamless but also secure and efficient. Thereby, each digitally connected product within the digital product network 26102 can interact with other products and users, exchanging information, status updates, and commands, thus creating a dynamic and interactive ecosystem. The advanced interoperability ensures that each product and user within the digital product network 26102 is synchronized, allowing for real-time interactions and updates, and enhancing the overall user experience and functionality of the digital product network system 26000.

The digital product network system 26000 also enables real-time data exchange among the connected digitally connected products and between the products and the users. This real-time exchange of data allows the efficient functioning of the digital product network 26102, allowing the products and users to respond swiftly to changes, updates, and commands. For this purpose, the digital product network system 26000 may employ advanced data processing and analysis techniques to handle the exchanged data, ensuring that the data is not only exchanged in real-time but is also processed and analyzed quickly. The real-time data analysis allows for instantaneous insights, enabling the users and the products to make informed decisions and responses. This real-time data exchange and analysis allows for the optimization of the digital product network 26102, allowing for dynamic interactions, instantaneous insights, and enhanced functionality. It ensures that the users are well-informed about the status and updates of the products and that the products can interact and respond to each other efficiently.

Further, in the digital product network system 26000, the product-to-user communication module 26106, along with the GUI module 26108, facilitates enhanced customization and user interaction. Users can easily customize their preferences, settings, and interactions with the products through the interface provided by the GUI module 26108. The enhanced customization allows the users to tailor the products to their needs and preferences, optimizing their experience and ensuring the optimal utilization of the products. This user-centric design of the GUI module 26108, coupled with the advanced customization options, ensures that the users can easily navigate through the various options and settings, manage the products efficiently, and access required information. In some embodiments, the GUI module 26108 is further configured to provide one or more user interfaces displaying related ones of the plurality of digitally connected products associated with a single user by at least one of brand, type, and capability.

The integration of the advanced smart contract modules within the digital product network system 26000 supports the management, verification, and enforcement of the terms and conditions related to the digitally connected products. These modules, with their configuration and sophisticated features, ensure the seamless, accurate, and reliable formulation, selection, deployment, and verification of smart contracts within the digital product network system 26000, enhancing transparency, compliance, accountability, and user experience within the digital product network 26102. Further, the incorporation of the modules within the digital product network system 26000 offers functionalities such as record uploading, advanced API management, interaction with regulatory bodies, and comprehensive data integration.

In some embodiments, the digital product network system 26000 facilitates the exchange of status updates between connected products, enabling these products to communicate their current operational states to one another. This mechanism is implemented for determining compatibility between the interconnected devices and identifying potential operational issues, serving as a preemptive measure to mitigate any disruptions in the interoperable functionalities within ecosystem of the digital product network system 26000.

In some embodiments, the digital product network system 26000 enables a device discovery mechanism, allowing connected devices within the digital product network 26102 to discover each other's capabilities and features. This mechanism may be utilized for identifying devices that can collaboratively work together, thereby enhancing the overall user experience and optimizing the interaction and cooperation between various digitally connected products within the digital product network system 26000.

In some embodiments, the digital product network system 26000 permits data exchange between digitally connected devices, allowing for the transfer of data, which can be utilized for providing personalized services, optimizing device performance, and facilitating automation of various processes.

In some embodiments, the digital product network system 26000 includes a command and control communication mechanism, allowing devices to receive commands and control signals from one another, enabling automated operations within the interconnected environment. For instance, a smart thermostat within the digital product network 26102 can receive signals from a smart home device to adjust the ambient temperature based on the user's preferences, demonstrating adaptability and responsiveness of the digital product network system 26000 to user needs.

In some embodiments, the digital product network system 26000 incorporates alerts and notifications, where connected products can send alerts and notifications regarding significant events or changes in status to each other. Furthermore, event notifications, such as low battery alerts or software updates, are communicated to users to keep them informed about the status of their devices and ensure optimal functionality within the digital product network 26102.

In some embodiments, the digital product network system 26000 provides a feedback and response mechanism, allowing connected products to exchange feedback and responses with each other. This exchange is vital for improving the functionality and enhancing the user experience, by facilitating continuous improvements and modifications based on the received feedback and responses, ensuring the refinement and enhancement of product features and services.

In some embodiments, the digital product network system 26000 supports user feedback, where users of the digital product network system 26000 can provide their feedback regarding the products, such as feature requests, bug reports, and suggestions for improvements, to product manufacturers, contributing significantly to the evolution and refinement of the products within the digital product network 26102.

In some embodiments, the digital product network system 26000 enables customization, allowing users to modify the settings of the products within the digital product network 26102 to suit their preferences and needs, including setting up personalized settings, creating custom workflows, and integrating with other services.

In some embodiments, the digital product network system 26000 provides support, offering troubleshooting help and technical assistance from product manufacturers, service providers, or other users in the digital product network 26102, ensuring the resolution of any issues encountered by the users and maintaining the integrity and reliability of the digital product network system 26000.

In some embodiments, the digital product network system 26000 facilitates community interaction, enabling users to interact with other users in the digital product network 26102, to offer opportunities for knowledge sharing, data exchange, experience exchange, and for enabling a sense of community within user base of the digital product network system 26000. This interaction enhances the user experience by creating a supportive and collaborative environment within the digital product network system 26000.

Further, in the digital product network system 26000, the GUI module 26108 may allow a user to traverse through a series of user interface displays. These displays present information associated with the digitally enabled products within a digitally enabled product network, orchestrated through a set of defined stages of the product's lifecycle within the digital product network system 26000. The information may include size and weight, material and durability power consumption, operating temperature and humidity range, and many others.

In some embodiments, the GUI module 26108 offers a comprehensive system for users to upload a diverse range of records associated with their digitally connected products. In an example, it allows users to upload device photos or videos. Such visual records can be used, especially when troubleshooting potential issues with the connected product. A clear photo or video can provide invaluable insights into any visible damages, wear and tear, or other irregularities that may be affecting the product's performance. In addition to visual records, the interface may facilitate the upload of device-specific information. Users can input details such as the product's make, model, serial number, and even the firmware version. The interface may also allow users to upload product usage data and product performance data, providing details about the frequency of product use, duration, the most commonly utilized features, and information about the product's performance in various situations. Such insights can be utilized to improve product designs, improve customer support efforts, and the like. The interface also allows users to upload their preferences, such as preferred settings, design choices, custom workflows, or integrations with other services. The interface may also support the upload of troubleshooting records. Users can detail any issues, glitches, or errors they have encountered, providing manufacturers with real-time feedback. Similarly, records of upgrades or updates can be uploaded, ensuring that all devices within the network are aware of the latest product versions and maintain compatibility. The interface also allows users to share their reviews, ratings, or customer feedback, which can be used by manufacturers for understanding product reception and making informed improvements. Additionally, the interface supports the upload of environmental data, capturing the conditions in which the product operates.

In some embodiments, the GUI module 26108 also displays information related to input and output interfaces, providing details about how the product interfaces with other devices and systems. Information detailing the product's sensors and actuators offer an understanding of how the product perceives and reacts to environmental changes or user interactions, informing decisions about functionality and performance optimization. Moreover, the digital product network system 26000 also provides parameters like temperature and humidity, vibrations and shock, and wear and tear of the product, for monitoring the environmental factors, impacts, and the gradual degradation of the product, respectively. These parameters are utilized in identifying the need for replacements, repairs, and modifications, ensuring the product's optimal performance and longevity.

In embodiments, the GUI module 26108 is configured to generate one or more user interfaces for displaying the time-sensitive alerts, wherein the one or more user interfaces are displayed by dynamically adjusting a layout of a current user interface associated with a corresponding one of the plurality of digitally connected products. By dynamically adjusting the layout of the current user interface, the module ensures that the alerts are presented in a manner that is both visually accessible and relevant to the user's current tasks. This dynamic adjustment can help in minimizing disruption while maximizing the efficiency of communication, ensuring that users receive critical information exactly when it is most needed and in a format that is immediately understandable. This capability is particularly valuable in complex systems where timely information delivery can significantly impact user decisions and actions.

Platform Interface with Embedded Marketplace

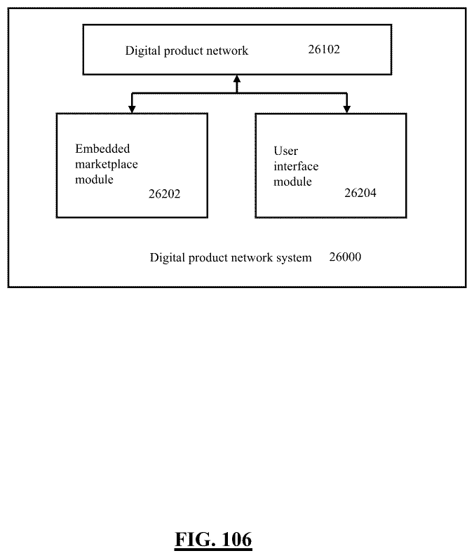

Referring to FIG. 106, a block diagram of the digital product network system 26000 embodied as a platform user interface with embedded marketplace 26000 is provided, according to some embodiments of the present disclosure. The digital product network system 26000 is configured to include various modules therein.

In embodiments, the digital product network system 26000 may include a user interface module 26204, which embeds and/or integrates with an embedded marketplace module 26202 to provide embedded marketplaces associated with the digitally connected products. The user interface module 26204 may be configured to display information associated with the set of digitally connected products, receive and process user inputs for displaying a set of marketplaces associated with the information, display the set of marketplaces, and receive and process user inputs for selecting a marketplace from the set of marketplaces. In embodiments, the information may include recommendations, reminders, warnings, alerts, maintenance schedules, status information, performance information, connectivity information, associated products, other products within the digital product network, usage patterns, advertisements, news, and the like. The user interface module 26204 may enable the user to navigate through the set of digitally connected products and information associated therewith. The module is configured to receive inputs from users, which can include selections, preferences, commands, or queries. Based on these inputs, the module processes the information to display relevant marketplaces associated with the products. This feature allows users to interact directly with the system, making decisions or changes based on the displayed information. For example, a user might input a request to see available accessories for a smart home device. The module processes this input and displays a marketplace where these accessories can be purchased. Upon processing user inputs, the module displays a set of marketplaces related to the information. In embodiments, the marketplaces may facilitate buying, selling, trading, lending, access (e.g., access to models, software applications, or data) and many other types of transactions. This could include places where products can be bought, services can be availed, additional accessories can be available for purchase, and the like. This feature is particularly useful for users looking to make purchases or upgrades related to their digitally connected products. For a user looking to upgrade their home security system, the module could display various marketplaces offering the latest security devices compatible with their existing system. In embodiments, the user interface module 26204 may be accessed via a digitally connected product, an application on a user's mobile device, a digital twin (e.g., a digital twin of a digitally connected product), or the like. In embodiments, the user interface module 26204 may be a graphical user interface. The user interface module 26204 provides a dynamic interface allowing users to interact with and manage the connected digitally connected products effectively.

Herein, the digital product network system 26000 may include an embedded marketplace module 26202. In embodiments, the embedded marketplace module may be integrated with the user interface module 26204. The embedded marketplace module 26202 may be configured to display the selected marketplace, which may include a set of offerings associated with the selected marketplace. The embedded marketplace module 26202 may receive and process user inputs for selecting one or more offerings from a set of offerings from the marketplace. These inputs can be in various forms, such as clicks, taps, voice commands, or even gestures, depending on the interface of the device. The module is designed to be responsive and intuitive, ensuring that users can easily navigate through the marketplace. In embodiments, the marketplaces may support a range of offerings, including products, services, bundled services, software, software applications, product enhancements, intelligent agents, product add-ons, data, models, digital twins, experiences (e.g., gaming experiences, augmented reality experiences, virtual reality experiences, and the like), in-game items, and betting, among many others. In embodiments, the embedded marketplace module 26202 may be configured to receive and process user inputs for completing a set of transactions associated with the one or more selected offerings. Beyond just displaying and selecting offerings, the embedded marketplace module often facilitates the entire transaction process. This includes handling the addition of items to a cart, checkout processes, payment processing, and even initiating delivery or download of the purchased items. In embodiments, the embedded marketplace module is further configured to execute the set of transactions related to the one or more selected offerings. In embodiments, the embedded marketplace module 26202 may be integrated with a distributed ledger system and/or Blockchain system to further facilitate and/or store data associated with the transactions. Given that transactions and personal data are involved, the embedded marketplace module incorporates robust security measures to protect user data and ensure secure transactions. This includes encryption, secure data storage, and compliance with relevant data protection regulations. To enhance the user experience, the embedded marketplace module can also integrate with user profiles and preferences. This allows the module to offer personalized recommendations and remember past purchases or preferences, making the shopping experience more tailored and efficient.

Herein, the integration of the user interface module 26204 with the embedded marketplace module 26202 offers many advantages. For example, a user's smart refrigerator may be a digitally connected product within the digital product network system 26000. The user may be able to access the user interface module 26204 via an application on the user's device (e.g., a smartphone, a tablet, a personal computer, an augmented reality system, a virtual reality system, or the like), on a user interface on the smart refrigerator, on a user interface associated with a digital twin of the smart refrigerator, or the like. The smart refrigerator may identify that it is running low on a specific grocery item. The smart refrigerator, being a digitally connected product within the digital product network system 26000, may send this data to the user interface module 26204, which causes the user interface module 26204 to display a warning that the grocery item is almost gone and may need to be reordered. Continuing the example, the user interface module 26204 may receive and process user inputs for displaying marketplaces associated with the grocery item. After the user indicates that they would like to view the marketplaces, the user interface module 22204 may display a set of marketplaces associated with the grocery item. In the present example, the user marketplace module 22204 may display a marketplace for the grocery item, a marketplace for recipes associated with the grocery item, a marketplace for cooking services associated with the grocery item, a marketplace for kitchen tools associated with the grocery item, a marketplace for alternatives to the grocery item, and the like. The user interface module 22204 may receive a user selection of a marketplace, such as a selection of the marketplace for the grocery item. The embedded marketplace module 26202 can then present the selected marketplace to the user, which may include a variety of offerings, showcasing prices, delivery times, reviews, images, videos, previous purchase data, and other relevant details. The embedded marketplace module 26202 may present options to reorder the item from preferred vendors. The embedded marketplace module 26202 and may receive user inputs for completing a transaction for purchasing the grocery item. The embedded marketplace module 26202 may then execute the transaction for the grocery item.

Further, as illustrated, the digital product network system 26000 includes a digital product network 26102 configured to interconnect a variety of digitally connected products and their corresponding users. The digital product network system 26000 may facilitate communication between the embedded marketplace module 26202 and the user interface module 26204.

In embodiments, the embedded marketplace module 26202 is configured to execute transactions related to product data associated with the set of digitally connected products. In embodiments, product data may include product performance data, product pricing data, product usage data, product location data, customer feedback data, product interaction data (e.g., a product's interaction with other products), product security data, product image data, product video data, product audio data, product packaging data, product maintenance data, environmental data, and product simulation data. For instance, the product performance data may provide insights into how a product is functioning in real-time and over extended periods. Product performance data may include battery life, processing speed, product temperature data, and/or responsiveness. Users may access this data to ensure their product is operating optimally, and manufacturers may use this data to identify areas for improvement in subsequent product versions. Product usage data may provide a detailed view of how end-users are interacting with the product. In one example, users can purchase product performance data from manufacturers, other users, data providers, and the like, to enrich digital twins or AI-based learning algorithms. In another example, users of digitally connected products may sell their product usage data to manufacturers via the embedded marketplace. By analyzing this data, manufacturers can optimize product features to better align with user needs and preferences. For example, if a smartwatch's fitness tracking feature is more frequently used than its email notification feature, manufacturers may prioritize advancements in the fitness tracking capabilities over email notification capabilities in future updates or models. Product data may have many other uses, including usage in populating digital twins or training machine learning models. By offering transactions related to product data, manufacturers may purchase product data from users, users may purchase product data from manufacturers or other users, and the like, resulting in a more informed product ecosystem.

In embodiments, the embedded marketplace module 26202 is configured to execute transactions related to models and/or algorithms associated with the set of digitally connected products. The models and/or algorithms may include, but are not limited to, predictive models, machine learning models, artificial intelligence models, classification models, anomaly detection models, clustering algorithms, generative models, large language models, optimization models, recommendation models, neural networks, transformer models, convolutional neural networks, deep learning models, supervised models, semi-supervised models, unsupervised models, reinforcement models, regression, mechanistic models, chemical-based models, biology-based models, and physics-based models. For example, a marketplace for models may offer subscription-based access to predictive models for forecasting product performance based on historical and real-time data or simulation models for virtual testing and validation of product functionalities under various conditions.

In some embodiments, the embedded marketplace module 26202 is configured to execute transactions related to product-related offerings. Product-related offerings may include one or more of product parts, product upgrades, product insurance, product enhancements, product add-ons, product software, product warranties, product extended warranties, product service contracts, product maintenance contracts, product trade-ins, and/or access to product features associated with the set of digitally connected products. Users may want to purchase software updates to access the latest features and security patches for the digitally connected products. In another example, a user having a smart home environment (e.g., a digital product network) with a smart air purifier (e.g., a digitally connected product) may be able to purchase a new air filter in an embedded marketplace of the user interface for managing the smart home environment, a user interface on the smart air purifier, or the like.

In embodiments, the embedded marketplace module 26202 is configured to execute transactions related to advanced services that leverage data and analytics to improve and/or optimize the performance and longevity of digitally connected products. Marketplaces enabled by the embedded marketplace module 26202 may offer services, including predictive maintenance services, which may predict when a product may fail or require maintenance, thereby preventing issues before they arise. Anomaly detection is another service that may be facilitated by marketplaces provided by the embedded marketplace module 26202. In such embodiments, an anomaly detection service may continuously monitor product performance data to identify and flag any anomalies or deviations from the expected performance metrics. The embedded marketplace module 26202 may also facilitate product energy optimization services, ensuring that products operate in the most energy-efficient manner.

In embodiments, the embedded marketplace module 26202 may also provide direct user interaction by enabling peer-to-peer transactions. Various marketplaces provided by the embedded marketplace module 26202 may provide offerings associated with user-generated content related to the digitally connected products, such as access to audiovisual content involving the digitally connected products, access to creative tools associated with the digitally connected products that may be used to enhance media content (e.g., filters, stickers, Bitmoji customizations, in-game items, and lenses), non-fungible tokens (NFTs) associated with the digitally connected products, and the like. Other peer-to-peer transactions facilitated by the embedded marketplace module 26202 may include transactions involving data, transactions involving models, transactions involving digital twins, transactions involving 3D printed product add-ons, and any of the transaction types described herein associated with digitally connected products. By enabling peer-to-peer transactions, the embedded marketplace module 26202 delivers a collaborative and innovative product ecosystem for the digitally connected products. In some embodiments, the embedded marketplace module 26202 is configured to improve the user experience by offering transaction recommendations to users. These recommendations may be generated using a set of Artificial Intelligence (AI)-based learning models trained on product data associated with the digitally connected products, user data (e.g., user location data, user behavior data, and user demographic data), and/or transaction data (e.g., a user's historical transaction data), among many others, to provide a recommendation for an offering in a marketplace provided by the embedded marketplace module 26202. In embodiments, the set of AI-based learning models may employ techniques to understand user preferences, behavior, and needs. These advanced models and algorithms may ensure the relevance of the recommendations provided to the users. The recommendation generation feature aids in personalizing user experience, ensuring the recommendations are tailored to individual user preferences and needs, enhancing user satisfaction and platform usability.

In some embodiments, the embedded marketplace module 26202 serves as a comprehensive platform for the exchange of transactions not just between individual users but also among various entities of the digital product network system 26000. These entities may play role in the digitally connected product ecosystem. For instance, the embedded marketplace module 26202 facilitates interactions and transactions between product users, product manufacturers, suppliers, retailers, service providers, data providers, data analytics providers, model providers, digital twin providers, suppliers, and NFT providers, among many others. This wide range of interactions ensures that all stakeholders in the digitally connected product ecosystem can effectively communicate, collaborate, and transact, enhancing the overall utility and functionality of the digital product network system 26000.

In some embodiments, the marketplaces provided by the embedded marketplace module 26202 are configured to be searchable for user-friendliness and ease of navigation. This means that users can easily input search queries to locate specific marketplaces and/or offerings associated with digitally connected products. The search functionality streamlines the user experience, allowing users to quickly find and engage in the transactions they are interested in, without having to navigate through potentially vast amounts of irrelevant content. This feature enhances the efficiency and user satisfaction within the digital product network system 26000.

Further, the embedded marketplace module 26202 in the digital product network system 26000 may facilitate data exchange for data associated with the digitally connected products. The exchange of such data enables monetization opportunities, collaboration, and enhanced customer experience, among many other benefits. For instance, product performance data may be valuable to manufacturers aiming to improve their product designs. In addition, service providers may be interested in user behavior data to better understand user behavior patterns and to offer tailored services or promotions based on these patterns. All stakeholders in digital product ecosystems stand to benefit from this data exchange.

The digital age has redefined the dynamics of product consumption and usage. The proliferation of connected products has increased demand for platforms that can facilitate transactions associated with add-ons, parts, software, services, data, insurance, and the like associated with the connected products. Embedded marketplaces provide dynamic environments that facilitate the provision of diverse offerings associated with digitally connected products. For example, a user with a digitally connected smart home system deciding to upgrade a home lighting system can easily browse through embedded marketplaces of the digital product network system 26000. They can view different product options, read about their features, check compatibility with other devices in their home, and even purchase additional services or warranties. Embedded marketplaces may also facilitate transactions related to software applications (e.g., purchases, subscriptions, and the like). For example, a user interested in integrating their smart refrigerator with a new diet tracking application can utilize the embedded marketplaces to not only find the application but also understand its features, check reviews, and purchase it.

### AI-Generated Recommendations Based on Real-Time Data Collection

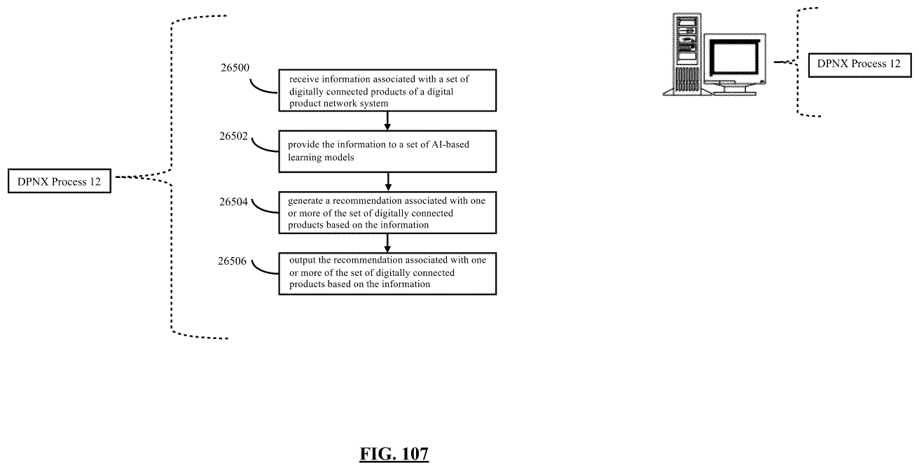

Referring to FIG. 107, a process, such as DPNX process 12 may receive 26500, by a computing device, information associated with a set of digitally connected products (such as those described above) of a digital product network system 26000 and/or a digital product network 26102. For example, a unified database may (e.g., via DPNX process 12) receive information associated with a set of digital product network entities of a digital product network system 26000. The information may be collected in a variety of ways, including (by example only) via the unified data collections systems discussed throughout.

In some implementations, the information may be generated by a set of sensors of the set of digitally connected products. The digitally connected products may have a wide range of sensors including, but not limited to, temperature sensors, motion sensors, humidity sensors, proximity sensors, light sensors, pressure sensors, chemical sensors, sound sensors, optical sensors, cameras, gyroscopes, accelerometers, magnetic sensors, force sensors, ultrasonic sensors, infrared sensors, hall effect sensors, capacitive sensors, piezoelectric sensors, color sensors, biochemical sensors, particulate matter (PM) sensors, voltage sensors, current sensors, flex sensors, load cells, thermal sensors, pulse sensors, air flow sensors, and soil moisture sensors. Example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 26502 the information to a set of Artificial Intelligence (AI)-based learning models, wherein at least one member of the set of AI-based learning models may be trained on a training data set of a set of digital product network data to generate a recommendation associated with one or more of the set of digitally connected products. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted security risk in the digital product network, a prediction of future demand, and/or the like), a classification (e.g., a classification of an object in an image, a classification of a spoken utterance, a classified fault condition based on sensor data, and/or the like), and/or other suitable outputs of an AI system.

In embodiments, the training data set for the set of AI-based learning models may include digital product network data, which may comprise digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, the recommendation may be associated with one or more of an operational parameter of one or more of the set of digitally connected products, the provision of customer support associated with the one or more of the set of digitally connected products, a price of one or more of the set of digitally connected products, a product design associated with one or more of the set of digitally connected products, product security associated with one or more of the set of digitally connected products, quality control associated with one or more of the set of digitally connected products, marketing or sales strategies associated with one or more of the set of digitally connected products, display strategies associated with one or more of the set of digitally connected products, packaging associated with one or more of the set of digitally connected products, software upgrades associated with one or more of the set of digitally connected products, inventory management associated with one or more of the set of digitally connected products, regulatory compliance associated with one or more of the set of digitally connected products, and customer behavior associated with one or more of the set of digitally connected products. For example, a smart cooking device, which may be a digitally connected product, may have a range of heat settings, and a recommendation may be directed towards an optimal heat setting (e.g., an operational parameter) for cooking a particular vegetable.

In some implementations, the set of AI-based learning models may include at least one of a transformer model, a convolutional neural network, a deep learning model trained on a set of outcomes of the digitally connected products, a supervised model, a semi-supervised model, an unsupervised model, or a reinforcement model, a generative model, a large language model, and a recommendation model. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like.

In embodiments, the training data set for the set of AI-based learning models may include digital product network data, which may comprise historical sales data, purchase history data, search query data, competitive analysis data, market data, social media data, customer data, customer demographic data, engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, supplier data, component data, quality control data, inspection data, failure data, warranty data, service record data, regulatory data, entertainment data, event data, regulatory compliance data, incident data, weather data, accident report data, date of packaging, time of packaging, location data, location of manufacturing data, location of packaging data, location of purchase data, location of consumption data, location of package opening data, time on display data (e.g., time on display shelf or other display), and consumer interaction data (e.g., with displayed products or purchased products).

DPNX process 12 may generate 26504 a recommendation associated with the set of digitally connected products using the output of the set of AI-based learning models and output 26506 the recommendation (e.g., to a user interface, a digital twin interface, or the like). For instance, an example of a recommendation associated with one or more digitally connected products may be a product design recommendation. For example, if a particular product part is causing product failures, the set of AI-based learning models may generate a recommendation to replace the product part with a similar product part from a different product part supplier. Therefore, DPNX process 12 may utilize an AI system that can generate recommendations based upon the above-noted generated information provided to the AI-based learning models.

In some implementations, the DPNX process 12 may provide information related to the date and/or time of packaging of digitally connected products of the digital product network 26102 to the set of AI-based learning models for the generation of many types of recommendations. Packaging may take various forms and may include box packaging, bottling, smart packaging, blister packaging, pouch packaging, sachet packaging, clamshell packaging, tube packaging, tin tie packaging, shrink wrap packaging, skin packaging, aseptic packaging, composite packaging, and many others. In one example, the date and/or time of packaging information may be used by the AI-based learning models to generate a recommendation related to inventory management associated with the digitally connected products. For instance, assume for example purposes only that a perishable food item with smart packaging (e.g., a digitally connected product) is received by a retail store implementing a first-in, first-out (FIFO) inventory management strategy, which ensures that older stock is sold first, minimizing the risk of selling expired or near-expiration products. In such an example, the recommendation may involve displaying the food item if its packaging date is older or holding the item in backstock if the packaging date is newer. In another example, the date and/or time of packaging information may be used by the AI-based learning models to generate a recommendation related to recall management associated with the digitally connected products. In the instance of a perishable food item with smart packaging (e.g., a digitally connected product), the packaging date and/or time may be used to identify whether the food item was part of an affected batch in the event of a product recall. In such an example, the recommendation may be to remove the food item from the shelf if it was part of the batch affected by the recall. In yet another example, the date and/or time of packaging may be used by the AI-based learning models to generate a recommendation related to a customer behavior associated with the digitally connected products. For instance, a manufacturer may make modifications to a smart toothbrush (a digitally connected product) that customers dislike. In such an example, the AI-based learning models may use the date and/or time of packaging of the smart toothbrush to generate a recommendation to the customer to hold off on a smart toothbrush purchase because it is a newer model. In another example, the date and/or time of packaging may be used by the AI-based learning models to generate a recommendation related to regulatory compliance associated with the digitally connected products. For certain products, regulatory bodies may require that items be sold within a specific timeframe after packaging. In this example, the AI-based learning models may use the date and/or time of packaging to generate a recommendation that a retailer cease offering products when such a timeframe expires.

In some implementations, the DPNX process 12 may provide information related to the location of digitally connected products of the digital product network 26102 to the set of AI-based learning models for the generation of recommendations. In one example, the location of digitally connected products may be used by the AI-based learning models to generate a recommendation related to marketing and/or sales strategies for the digitally connected products. These marketing-related and/or sales-related recommendations can account for the preferences and needs of users in specific locations, increasing the effectiveness of advertising efforts. In another example, the location of the digitally connected products may be used by the AI-based learning models to generate a recommendation associated with product security. Continuing the example, a smart bike (a digitally connected product) may require additional safety measures if location data indicates that the usage of the smart bike is prevalent in locations with high crime rate, and thus, recommendations may direct the smart bike user to ride the smart bike in safer areas (e.g., taking safer routes), download and/or install a software update (e.g., firmware enhancements, security patching, feature upgrades, improved tracking, and/or data encryption), or monitor the smart bike more closely.

In some implementations, the DPNX process 12 may provide information related to the location of manufacturing for digitally connected products of the digital product network 26102 to the set of AI-based learning models for the generation of a range of recommendations. In an example, the location of manufacturing may be used by the AI-based learning models to generate a recommendation related to quality control. For instance, different locations may have varying workforce skills or technological capabilities that influence the quality of manufactured digitally connected products. If customer feedback data indicates that some products are of poor quality, the location of manufacture may be used by the AI-based learning models to generate recommendations directing manufacturers to implement additional workforce training at specific locations, upgrade equipment at specific locations, or implement additional quality control measures at specific locations. In another example, the location of manufacturing may be used by the set of AI-based learning models to generate a recommendation related to regulatory compliance. In this example, the recommendations may relate to regulatory compliance for safety standards, environmental regulations, labor laws, and the like for various country, state, and local municipalities. The location of manufacturing may also be important for recommendations related to trade agreements and tariffs, intellectual property laws, product liability laws, certification and labeling requirements, data protection laws, customs and import/export controls, and other industry-specific regulations (e.g., automotive, pharmaceutical, food and beverage, and the like).

In some implementations, the DPNX process 12 may provide information related to the location of packaging for digitally connected products of the digital product network 26102 to the set of AI-based learning models for the generation of many different types of recommendations. In an example, the location of manufacturing may be used by the AI-based learning models to generate a recommendation related to regulatory compliance. In examples, the recommendations related to regulatory compliance may comprise recommendations associated with packaging regulations, labeling requirements, food and drug packaging standards, environmental standards, waste disposal standards, and many others. In some embodiments, the information related to location of packaging may relate to packaging material recommendations, as the cost of packaging materials can vary by location due to the availability of resources and local economic conditions. Because the cost of packaging materials and the cost of labor for packaging may vary by location, the recommendations may also be related to product pricing and/or labor (e.g., scheduling of labor).

In some implementations, the DPNX process 12 may provide information related to the location of purchase for digitally connected products of the digital product network 26102 to the set of AI-based learning models to enable the generation of a number of different recommendation types. In an example, the location of purchase information may be used by the AI-based learning models to generate a recommendation related to marketing and sales. For example, if a large percentage of purchases occur in a specific location, tailored marketing strategies may be used to further appeal to the local preferences associated with that location. Alternatively, if there was a desire to appeal to increase sales in a location where location of purchase data indicated sales were relatively lower, understanding the demographics of that location may help businesses target their marketing efforts more effectively, ensuring that they reach the intended audience. Recommendations based on location of purchase information may also relate to pricing strategies, distribution and/or retail channels, local partnerships, brand positioning, and many others.

In some implementations, the DPNX process 12 may provide information related to the location of consumption and/or location of package opening for digitally connected products of the digital product network 26102 to the set of AI-based learning models to enable the generation of recommendations. In one example, the generated recommendations may be related to the supply chain and/or distribution of the digitally connected products. Understanding where products are ultimately consumed can help optimize supply chain and distribution strategies. In another example, the recommendations may be related to product customization, as products may be customized for different markets based on where they are consumed (e.g., portion sizes, packaging types, and the like). In yet another example, the recommendations may be related to product design and/or packaging because packaging and product design should resonate with local cultural norms and preferences and withstand the climate conditions of the consumption location (e.g., humidity, temperature, sun exposure, and the like).

In implementations, the DPNX process 12 may provide information related to the time on a display shelf for digitally connected products of the digital product network 26102 to the set of AI-based learning models to enable the generation of recommendations. In one example, these recommendations may relate to aspects of inventory management such as stock rotation, shelf life, reordering schedules, and the like. In addition, the recommendations may be associated with pricing strategies, marketing and sales campaigns, product placement, packaging optimization, and many others.

In embodiments, the DPNX process 12 may provide information related to customer interactions with displayed digitally connected products of the digital product network 26102 to the set of AI-based learning models to enable the generation of different recommendations. Having information about customer interactions with displayed products in a retail environment is useful for several reasons, as it can provide actionable insights into consumer behavior, product appeal, display effectiveness, and many others. For example, recommendations based on customer interactions with displayed digitally connected products may be related to improving the effectiveness of product displays. In another example, such recommendations may be related to shelf space allocation, ensuring that enough shelf space is allocated to popular products. In yet another example, if customers frequently interact with a product but do not purchase it, price sensitivity may be indicated, and recommendations based on such data may concern lowering prices.

The DPNX process 12 may, in some embodiments, provide information related to customer interactions with purchased digitally connected products of the digital product network 26102 to the set of AI-based learning models for the generation of various recommendations. In examples, the recommendations may relate to product design. Understanding how customers use products may be used to inform future design improvements and feature development and collecting data on product performance in customer interactions can help identify potential issues or areas for enhancement. In another instance, the information related to customer interactions with purchased products may drive improvements in customer experience, such as personalization (e.g., recommendations for product settings). In yet another example, recommendations may be related to customer support, as insights into how customers use products can improve such services by anticipating needs or troubleshooting issues proactively. Other recommendations may include, but are not limited to, marketing and sales, as detailed customer usage data can enable targeted and effective marketing campaigns, and risk management, because monitoring product interactions can help in early detection of safety issues, leading to quicker recalls or fixes.

As described above, different types of information associated with digitally connected products may be used by AI-based learning models to generate many different recommendation types, resulting in improved products, sales, and customer experiences.

### Digital Twin of a Product

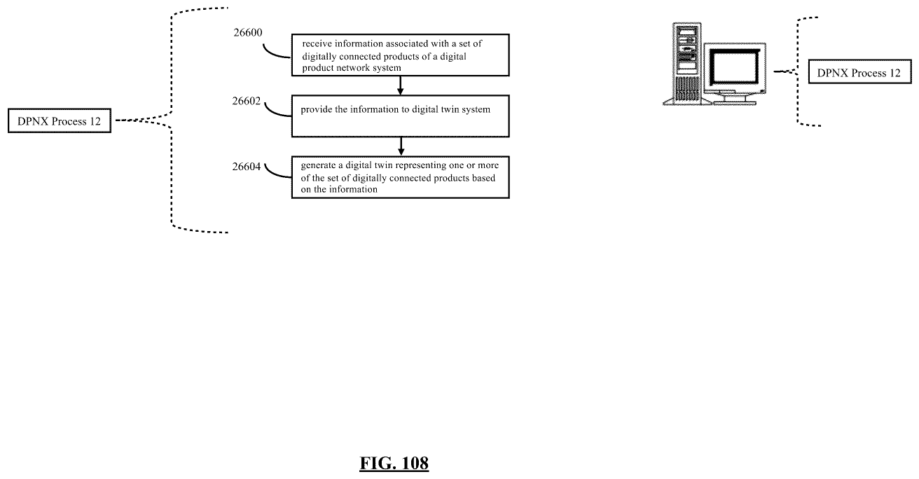

Referring to FIG. 108, a process, such as DPNX process 12 may receive 26600, by a computing device, information associated with a set of digitally connected products (such as those described above) of a digital product network system 26000 and/or a digital product network 26102. For example, a unified database may (e.g., via DPNX process 12) receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 26602 the information to a digital twin system, where the digital twin system is configured to generate 26604 a digital twin representing one or more of the set of digitally connected products based on the information. In embodiments, the digital twin of the one or more digitally connected products provides a substantially real-time representation of the corresponding digitally connected product.

The digital twin system may be further configured to generate a digital twin representing one or more of an entity, an environment, and a workflow of the digital product network. In embodiments, entities of the digital product network may include physical objects, 3D printers, manufacturers, distributors, consumers, service providers, payment providers, retailers, regulators, and any other digital product network entities described herein. In embodiments, environments of the digital product network may include warehouses, manufacturing facilities, 3D printing facilities, service provider facilities, smart containers, containers, shipping ports, transportation networks, physical retail stores, digital marketplaces, virtual reality environments, storage facilities, and digital product networks. The workflows of the digital product network may include product design workflows, product component sourcing workflows, product manufacturing workflows, product packaging workflows, product distribution workflows, product marketing and/or sales workflows, product display workflows, product interaction workflows, product usage workflows, data collection workflows, product repair workflows, product recall workflows, product lifecycle management workflows, product maintenance workflows, data processing workflows, network integration workflows, feedback loop workflows, and many others.

In embodiments, the user interface of the digital twin system and/or the user interface of the digital twin of a digitally connected product may provide an embedded marketplace for enabling transactions (e.g., buying, selling, trading, subscribing, and the like), for models (e.g., AI-based learning models, LLMs, mechanistic models, and the like), data, product updates, product upgrades, product add-ons, product-related service offerings, and/or product parts associated with the digitally connected products. For example, the owner of a digitally connected product may access the embedded marketplace of a digital twin of their digitally connected product via the user interface of the digital twin and subscribe to a specialized large language model trained on digitally connected product data. In other examples, the owner of the digitally connected product may access the embedded marketplace in the user interface of the digital twin to sell data generated by the digitally connected product. In embodiments, the embedded marketplace may be provided in the user interface of the digital twin system or in the user interface of a digital twin.

In embodiments, the digital twin system may include a simulation module configured to enable simulations using the digital twins. The simulation module may be used to simulate behaviors, performances, environments, and interactions of the digital twins. For example, the owner of an automobile (a digitally connected product) may access the corresponding digital twin and execute a simulation of the automobile's performance in a race.

In embodiments, the DPNX process 12 may generate an alert based on the information represented in the digital twin. The alert may comprise to a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a product safety alert, a health-related alert, a fitness-related alert, an energy-related alert, and a user-defined custom alert based on a specific conditions or threshold set by the user, among many others.

In embodiments, DPNX process 12 may provide hierarchical digital twins, wherein each hierarchical digital twin represents a hierarchy of entities, environments, or workflows in the digital product network. Hierarchical digital twins may refer to a structure that represents various layers of a product or system, capturing the interactions and dependencies among different components, environments, or workflows. This hierarchical structure allows for detailed analysis and simulation at multiple levels, enhancing decision-making and operational efficiency. In the example of a manufacturing facility digital twin, hierarchy levels may include a component level (e.g., sensors and actuators), a machine level (e.g., manufacturing machines), a system level (e.g., production lines), and a facility level (e.g., entire manufacturing facility).

In embodiments, DPNX process 12 may provide context-adaptive digital twins, wherein the context-adaptive digital twins are configured for adapting the corresponding representation of entities, environments, and workflows based on changes in context. A context-adaptive digital twin may refer to a dynamic digital twin that adjusts its models and simulations based on varying contextual data. This adaptability allows the digital twin to provide more accurate and timely insights, which are crucial for optimizing performance and decision-making processes. For example, a digital twin of a digital product network may add a representation of a digitally connected product if the new digitally connected product is added to the network.

In embodiments, DPNX process 12 may provide a role-based digital twin configured to represent information associated with a role associated with the one or more digitally connected products, wherein the role-based digital twin is configured for a consumer, a supplier, a manufacturer, a logistics manager, a retailer, a service provider, a product manager, a marketing and sales manager, an inventory manager, or a quality manager. For example, a role-based digital twin for a manufacturer role may present manufacturing KPI data in the digital twin of the digitally connected products while a role-based digital twin for a service provider role may present performance data and service history data for the digitally connected product.

### AI-Based Supply Chain Digital Twin for Digitally Connected Products

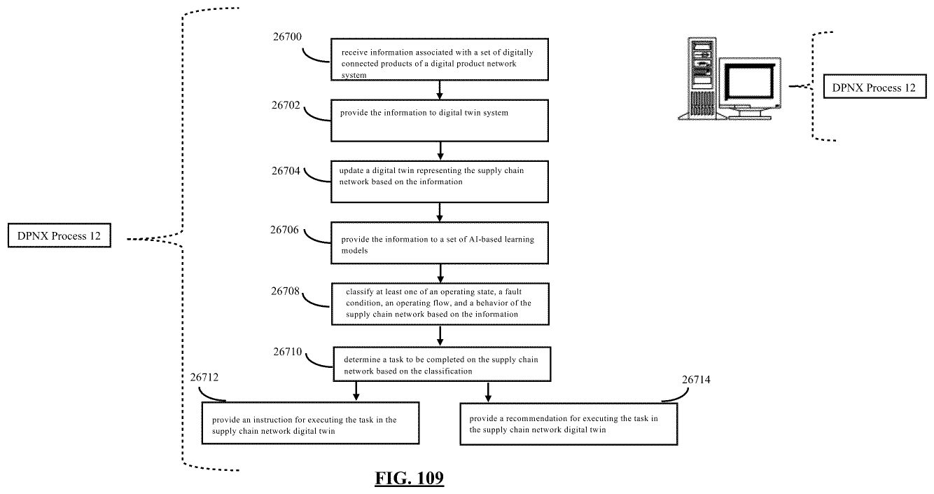

Referring to FIG. 109, a process, such as DPNX process 12 may receive 26700, by a computing device, information associated with a set of digitally connected products (such as those described above) of a digital product network system 26000 and/or a digital product network 26102. For example, a unified database may (e.g., via DPNX process 12) receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as examples only and not to otherwise limit the scope of the present disclosure.

In embodiments, the information may include digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In embodiments, the information may include inbound prepaid shipments from suppliers linked to orders and inventory coming into a network associated with the value chain network. In embodiments the information may include inbound and outbound shipment conditions.

The supply chain network entities may include digitally connected products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

In some implementations, DPNX process 12 may provide 26702 the information to a digital twin system, where the digital twin system is configured to update 26704 a digital twin representing a supply chain for the set of digitally connected products based on the information. In embodiments, the digital twin of the supply chain provides a substantially real-time representation of the set of supply chain entities of the supply chain network.

In embodiments, updating a digital twin in the context of an AI-based supply chain for digitally connected products involves a dynamic process where real-time data is continuously integrated to reflect the current state of the supply chain accurately. This data can be sourced from various inputs such as sensors embedded in products, IoT devices scattered throughout the supply chain, or APIs that aggregate and deliver pertinent data. Once this information is received, it is fed into a digital twin system, which is configured to update the digital twin representation of the supply chain network. In embodiments, updating the digital twin may including updating a property of the digital twin, a behavior of the digital twin, and the like.

In some implementations, DPNX process 12 may provide 26706 the information to a set of Artificial Intelligence (AI)-based learning models, wherein at least one member of the set of AI-based learning models may be trained on a training data set of a set of digital product network data to classify 26708 at least one of an operating state, a fault condition, an operating flow, and a behavior of the supply chain network and at least one member of the set of AI-based learning models is trained on the training data set to determine 26710, upon receiving the classification of the at least one of the: operating state, the fault condition, the operating flow, or the behavior, a task to be completed for the supply chain network based on the classification.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, a generative model, a large language model, and a recommendation model. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like.

The operating state in a supply chain network may refer to the current status of various processes and activities, such as production, warehousing, and distribution, within the network. For example, the operating state of a global electronics supply chain network might currently show that the manufacturing facilities are operating at full capacity while some distribution centers are in a restocking phase. A fault condition in a supply chain network may refer to a situation where there is a disruption or failure in one or more components of the network, such as logistics failures or supplier bankruptcies, that affects the overall functionality. A fault condition could occur in a supply chain network if a major supplier fails to deliver critical components on time, causing production delays across multiple factories. In embodiments, an operating flow in a supply chain network may refer to the detailed processes and sequences of activities that goods and information follow from suppliers through to end consumers. The operating flow of a supply chain network may include regulatory compliance checks, temperature-controlled storage and transport, and tracking of shipments to ensure timely delivery. The behavior of a supply chain network may describe the overall patterns, responses, and interactions of the network's components (such as suppliers, manufacturers, distributors, and customers) as they react to internal dynamics and external pressures. In embodiments, examples of tasks to be completed based on operating state classifications may include adjusting production levels, optimizing resource allocation, enhancing quality control measures, and the like. For example, if the supply chain is operating below capacity due to decreased demand, the task may involve using demand forecasting and capacity planning tools to better align production levels with market demand, thus reducing excess inventory and minimizing storage costs. Examples of tasks to be completed based on fault condition classifications may include rapid response and repair, root cause analysis, updating or upgrading equipment, and the like. For instance, if a critical machine in a manufacturing plant has malfunctioned, causing production delays, the task might involve deploying emergency maintenance teams to repair the machine and/or adjusting the production schedule to minimize impact on delivery timelines. Examples of tasks to be completed based on operating flow classifications may involve adjusting manufacturing speed, redesigning workflows to eliminate bottlenecks, and the like. For example, if the current operating flow is too slow to meet demand, the operating speed of robotic handling systems on an assembly line may be increased. Examples of tasks to be completed based on behavior classifications may include engaging alternative manufacturers, suppliers, and the like; deploying more robots for product handling; deploying more trucks; optimizing transportation routes; adjusting shift schedules; reallocating existing inventory; and the like.

DPNX process 12 may provide at least one of an instruction 26712 for executing the task in the supply chain network digital twin and a recommendation 26714 for executing the task in the supply chain network digital twin.

In embodiments, DPNX process 12 may generate simulations for the supply chain network digital twin, wherein the simulations for the supply chain network digital twin are generated with a graphical neural network (GNN). The use of a GNN allows for complex interdependencies and relationships within the supply chain to be modeled more accurately, capturing the dynamic interactions between different nodes and links. This advanced modeling capability enhances the predictive power of the simulations, providing deeper insights into potential outcomes and enabling more effective strategic planning. Additionally, the GNN can adapt and learn from new data, continuously improving the accuracy and relevance of the simulations over time. For example, in a supply chain involving multiple manufacturing sites and distribution centers, the GNN could simulate the impact of a disruption at one site on the entire network, helping to devise robust contingency strategies.

In embodiments, the supply chain network digital twin is enabled by a robotic operating system. The robotic operating system enhances the digital twin's functionality by enabling precise simulation and management of physical assets and workflows. This integration allows for a seamless transition between virtual planning and actual execution, ensuring that strategies developed in the digital twin can be effectively implemented in the physical supply chain environment.

In embodiments, the supply chain network digital twin operates within a digital twin system having one or more sets of one or more digital twins. In embodiments, the supply chain network digital twin may include an embedded marketplace for digital twin simulations, AI-based learning models, AI-based algorithms, data, and the like.

### ML/AI for Demand Planning/Enhancement

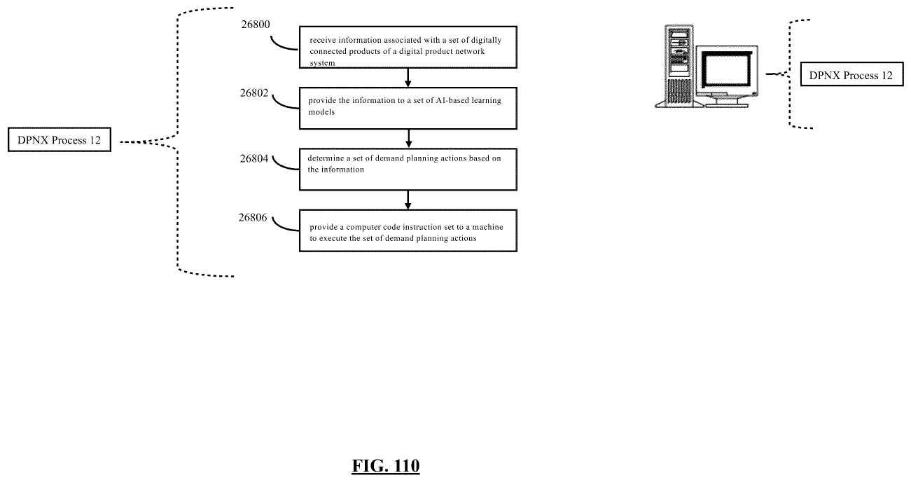

Referring to FIG. 110, a process, such as DPNX process 12 may receive 26800, by a computing device, information associated with a set of digitally connected products (such as those described above) of a digital product network system 26000 and/or a digital product network 26102. For example, a unified database may (e.g., via DPNX process 12) receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 26802 the information to a set of Artificial Intelligence (AI)-based learning models, wherein at least one member of the set of AI-based learning models may be trained on a training data set of a set of digital product network data to determine 26804 a set of demand planning actions based on the information. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted security risk in the digital product network, a prediction of future demand, and/or the like), a classification (e.g., a classification of an object in an image, a classification of a spoken utterance, a classified fault condition based on sensor data, and/or the like), and/or other suitable outputs of an AI system.

In embodiments, the training data set for the set of AI-based learning models may include digital product network data, which may comprise digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like) historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, a generative model, a large language model, and a recommendation model. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like.

In some implementations, DPNX process 12 may provide 26806 a computer code instruction set to a machine to execute a set of demand planning actions associated with a set of digitally connected products using the output of the set of AI-based learning models. A demand planning action may refer to a specific set of steps or set of initiatives taken to accurately forecast and/or manage product demand. In embodiments, demand planning actions may include forecasting a measure of demand at a future date and/or time, inventory management (e.g., ensuring the right amount of product is available at a future time to meet forecasted demand without overstocking), capacity planning (e.g., adjusting production and/or workforce capacity to meet future demand), supply chain coordination (e.g., aligning procurement, production, and/or distribution plans with the forecasted demand), customer prioritization (e.g., identifying key customers that are most valuable to the business and ensuring that their needs are met preferentially), implementing order quantity limits, implementing dynamic pricing strategies (e.g., flexible prices for products or services based on current market demands), promoting alternative products, and the like. In embodiments, demand planning actions may include demand enhancement actions, such as, but not limited to, marketing campaigns, product improvements, dynamic pricing strategies, market expansion, customer engagement, and the like. Therefore, DPNX process 12 may utilize the set of AI-based models that can execute a set of demand planning actions based upon the above-noted generated information provided to the AI-based learning models.

In embodiments, a demand planning action may comprise forecasting demand for the digitally connected products at a future date and/or time. In embodiments, the forecast may be a short-term forecast, which is typically used for inventory control and day-to-day operations management; a medium-term forecast, which is typically used for workforce planning, budgeting, and marketing campaign planning; and/or a long-term forecast typically used for strategic planning, capital investment, and long-term capacity planning. In embodiments, the forecasted measure of demand may be a measure of sales volume (e.g., units sold, sales revenue, and the like), market share, pre-orders, backorders, and the like.

In embodiments, the forecasted measure of demand may relate to a specific demographic group, a plurality of demographic groups, or the like. Understanding the demand in different demographic groups can help tailor marketing strategies that resonate with each group's preferences, increasing the effectiveness of advertising campaigns. Companies can allocate marketing resources more efficiently by focusing on demographics that show higher potential for sales. In this example, the set of demand planning actions may include a demand forecasting action and a marketing campaign action. In addition, understanding the purchasing power and price sensitivity of different demographics allows for more dynamic and effective pricing strategies. Insights into demographic preferences can also guide product development to cater to the specific needs and wants of different groups.

In embodiments, the forecasted measure of demand may relate to a specific geographic region, a plurality of geographic regions, or the like. Different regions may have varying cultural, social, and economic environments. Demand forecasting helps tailor marketing efforts that resonate locally, increasing their effectiveness. Additionally, by understanding regional demand patterns, companies can optimize their supply chains, ensuring that products are available where they are needed without excessive inventory buildup. In this example, the set of demand planning actions may include a forecasting action and an inventory management action. Different regions might exhibit different levels of price sensitivity. Demand forecasting across different geographic segments allows for dynamic pricing strategies that can maximize revenue based on regional economic conditions. In this example, the set of demand planning actions may include a demand forecasting action and a dynamic pricing action.

In embodiments, the forecasted measure of demand may relate to a specific behavioral segment, a plurality of behavioral segments, or the like, where behavioral groupings are based on customer buying patterns (e.g., frequency of purchases, brand loyalty, responsiveness to promotions, or the like), usage rate (e.g., light, medium, or heavy users of a product), customer journey stage, or the like. Knowing the buying patterns and usage rates helps in crafting personalized marketing messages that resonate with each segment. For example, frequent buyers might receive loyalty rewards, while infrequent buyers might be targeted with re-engagement campaigns. In this example, the set of demand planning actions may include a forecasting action and a marketing campaign action. Additionally, frequent buyers may be prioritized as higher value customers in the case that inventory is limited and demand is high. In this example, the demand planning actions may include a demand forecasting action and a customer prioritization action. For a lighter usage customer segment, the set of demand actions may include increasing customer engagement to attempt to increase that usage.

In embodiments, the forecasted measure of demand may relate to a specific psychographic segment, a plurality of psychographic segments, or the like, where psychographic groupings are based on customer lifestyle (e.g., lifestyle choices, interests, activities, and the like), values and/or beliefs (e.g., religious beliefs, political beliefs, attitudes, and the like), personality traits, and the like. Marketing messages can be crafted to resonate emotionally with specific psychographic segments, creating a stronger connection and increasing the effectiveness of advertising campaigns. Content can be tailored to align with the interests, activities, and lifestyles of different segments, making it more relevant and engaging to the target audience.

In some embodiments, the forecasted measure of demand may relate to specific channel preference segment, a plurality of channel preference segments, or the like, where channel preference segments are based on preferred shopping channels (e.g., in store, online, catalog, direct sales, and the like) and/or preferred communication channels (e.g., email, text, social media, phone calls, face-to-face interactions), and the like. By focusing on the channels that customers prefer for shopping, businesses can allocate resources more effectively, potentially increasing sales and reducing costs. Communications sent through preferred channels are more likely to be received positively, leading to higher engagement rates and better campaign performance.

### ML/AI for Inventory Optimization

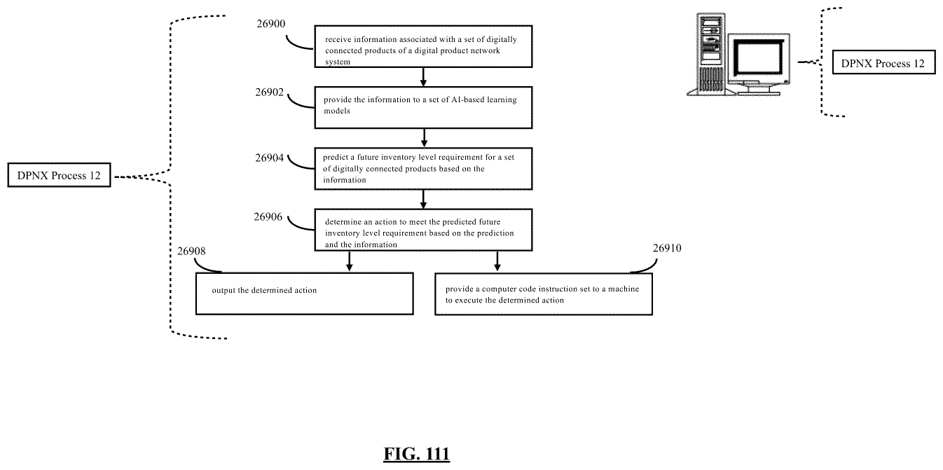

Referring to FIG. 111, a process, such as DPNX process 12 may receive 26900, by a computing device, information associated with a set of digitally connected products (such as those described above) of a digital product network system 26000 and/or a digital product network 26102. For example, a unified database may (e.g., via DPNX process 12) receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 26902 the information to a set of Artificial Intelligence (AI)-based learning models, wherein at least one member of the set of AI-based learning models may be trained on a training data set of a set of digital product network data to predict 26904 a future inventory level requirement for the set of digitally connected products and at least one member of the set of AI-based learning models is trained on the training data set to determine 26906 an action to meet the predicted future inventory level requirement based on the prediction and the information. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted security risk in the digital product network, a prediction of future demand, and/or the like), a classification (e.g., a classification of an object in an image, a classification of a spoken utterance, a classified fault condition based on sensor data, and/or the like), and/or other suitable outputs of an AI system.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, a generative model, a large language model, and a recommendation model. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like.

In embodiments, the training data set for the set of AI-based learning models may include digital product network data, which may comprise digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In embodiments, the predicted future inventory level requirement may be for a specific retail location, a plurality of specific retail locations, a geographic region, a plurality of specific geographic regions, a specific sales channel, a plurality of sales channels (e.g., retail sales channels, online sales channels, direct sales channels, social media sales channels, event sales, and the like). The future inventory level requirement may be quantified in a number of ways, including, but not limited to, a raw unit count, an economic order quantity (EOQ), days of inventory on hand (DOH), a safety stock level, weeks of supply, a carrying cost of inventory, a service level inventory measurement, or the like.

The determined action to meet the predicted future inventory level requirement may include engaging secondary manufacturers or contract manufacturers to supplement production capacity. This action involves partnering with additional manufacturing entities to increase production capabilities without the need for capital investment in new facilities. For example, a toy company anticipates a surge in demand during the holiday season for a digitally connected toy. By engaging contract manufacturers, they can double their production in the fourth quarter, ensuring they meet the increased demand without permanent overhead.

In some implementations, the determined action to meet the predicted future inventory level requirement may include implementing overtimes shifts at manufacturing facilities to temporarily increase production. This strategy temporarily boosts production capacity by extending work hours, thereby meeting short-term increases in demand. For instance, an electronics manufacturer faces a sudden spike in orders due to a new product launch. Implementing overtime shifts allows them to meet these orders on time without the delay of scaling up permanent operations.

In some embodiments, the determined action to meet the predicted future inventory level requirement may comprise redistribution of inventory. This involves moving inventory from locations with surplus stock to those with higher demand to optimize sales and reduce transportation costs. For example, a retail chain redistributes excess smart ski goggles (e.g., a digitally connected product) from stores in warmer regions to stores in colder regions as winter approaches, ensuring adequate supply where demand is highest.

In embodiments, the determined action to meet the predicted future inventory level requirement may include simplifying product designs. By reducing the complexity of product designs, production processes can be streamlined, reducing manufacturing time and resource usage. For instance, a smart product manufacturer may reduce the number of physical components required for operation, speeding up assembly lines and reducing inventory requirements for components.

The determined action to meet the predicted future inventory level requirement may include implementing strategic stockpiling. This involves accumulating reserves of critical inventory ahead of predicted demand increases or supply chain disruptions. A smart product company anticipates a global increase in demand and strategically stockpiles key components to ensure continuous production without interruption.

The determined action to meet the predicted future inventory level requirement may comprise supplementing production capacity with 3D printers, which may involve utilizing 3D printing technology to produce parts or entire products on-demand, reducing the need for large inventories and enabling faster response to market changes.

In embodiments, the determined action to meet the predicted future inventory level requirement may comprise increasing storage and/or warehouse capacity, which involves expanding physical space for storing inventory to accommodate growth or seasonal fluctuations in product demand. Using the example of the smart goggles, an online retailer may expand its warehouse capacity before the holiday shopping season to store higher volumes of inventory, ensuring they can fulfill increased customer orders.

The determined action to meet the predicted future inventory level requirement may include implementing cross-docking. This practice typically involves unloading materials from incoming trucks and loading them directly onto outbound trucks, reducing the need for storage. For example, a beverage company that implements smart bottles uses cross-docking to transfer beverages directly from suppliers to retail outlets, minimizing storage time.

In embodiments, the determined action to meet the predicted future inventory level requirement may comprise adjusting production settings and/or environments. Fine-tuning the operating parameters of machines, for example, such as speed, temperature, pressure, or voltage, can optimize performance without compromising product quality. For example, in injection molding, adjusting the temperature and pressure settings can reduce cycle times and increase the throughput of parts being produced. In another example, a robotic arm speed on an assembly line could be increased to increase the manufacturing speed of a product. In yet another example, parallel processing could be implemented in a beverage bottling plant such that multiple filling stations operate concurrently, increasing the number of smart bottles processed per hour.

In embodiments, the determined action to meet the predicted future inventory level requirement may include improving return management, enhancing the efficiency and effectiveness of processing returned goods so they can be quickly reintegrated into the inventory or disposed of appropriately. For example, an electronics retailer improves its return management system to quickly refurbish and resell returned items, thus reducing waste and recovering value from returns.

Each of these actions helps businesses adapt to changes in demand and supply conditions, ensuring that inventory levels are sufficient to meet market needs without excessive overstocking or risk of stockouts. Therefore, DPNX process 12 may utilize the set of AI-based models that can predict a future inventory level requirement and determine an action to meet the predicted inventory level requirement based upon the above-noted generated information provided to the AI-based learning models.

In some implementations, DPNX process 12 may output 26908 the determined action and/or provide 26910 a computer code instruction set to a machine to execute the determined action using the output of the set of AI-based learning models. This output can be visually represented and interacted with through a user interface, such as a digital twin interface. A digital twin interface provides a virtual representation of a physical system, allowing users to see the effects of potential actions before they are implemented in the real world. This can be particularly useful for complex systems where the impact of changes needs to be understood in a holistic context. For instance, in a manufacturing setting, the AI-based learning models might determine that the optimal action to meet predicted future inventory requirements is to redistribute inventory across facilities. The digital twin interface could then visually simulate how this redistribution would affect inventory levels, production rates, and delivery times across different locations. Users can interact with this simulation, experimenting with different scenarios to see how slight adjustments in the action affect outcomes. This capability not only aids in decision-making but also enhances understanding of the system's dynamics. Moreover, the digital twin interface can serve as a communication tool between different stakeholders, such as production managers, logistics coordinators, and upper management. Each stakeholder can view customized data relevant to their specific needs and responsibilities, improving collaboration and alignment on the determined actions.

Additionally, if the DPNX process 12 outputs a computer code instruction set to a machine, the digital twin interface can monitor and display the machine's performance in real-time as it executes the actions. This allows for immediate feedback and rapid adjustment if the machine's performance does not align with the predicted outcomes. For example, if a robotic arm in an assembly line is instructed to increase its speed to boost production, the digital twin can show the real-time impact on the assembly line's efficiency and the quality of the output products.

### ML/AI to Optimize Product Design (Using Product Data, Customer Feedback Data, Social Media Data, Etc.)

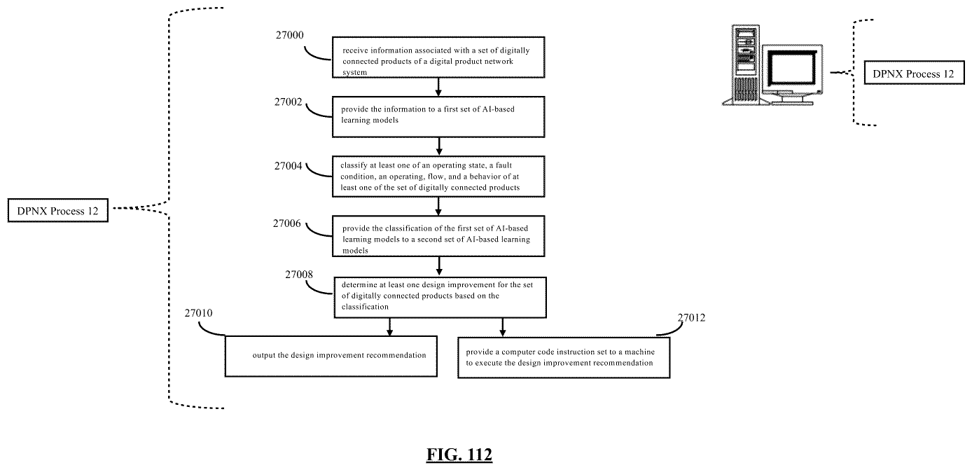

Referring to FIG. 112, a process, such as DPNX process 12 may receive 27000, by a computing device, information associated with a set of digitally connected products (such as those described above) of a digital product network system 26000 and/or a digital product network 26102. For example, a unified database may (e.g., via DPNX process 12) receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 27002 the information to a first set of Artificial Intelligence (AI)-based learning models, wherein at least one member of the first set of AI-based learning models may be trained on a training data set of a set of digital product network data to classify 27004 at least one of an operating state, a fault condition, an operating flow, and a behavior of at least one of the set of digitally connected products.

For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted security risk in the digital product network, a prediction of future demand, and/or the like), a classification (e.g., a classification of an object in an image, a classification of a spoken utterance, a classified fault condition based on sensor data, and/or the like), and/or other suitable outputs of an AI system.

In embodiments, an operating state may refer to the current status or mode in which a digitally connected product is functioning, which may include various modes of operation depending on what the product is doing or is set to do. In the example of a smart thermostat, the operating state may be a heating mode, a cooling mode, an economical (ECO) mode, or the like. A fault condition may refer to a problem or error in the product's operation. This could be a hardware malfunction, software error, or connectivity issue that prevents the product from functioning as intended. In the example of a smart security camera, a fault condition could be a low battery warning or a connectivity loss. In embodiments, an operating flow may refer to the sequence of operations or processes that a digitally connected product follows to perform its functions, which might involve interactions between different components of the product or with external systems. In the example of a smart washing machine, an operating flow may be a start-up sequence where the machine checks all sensors and setups, loads the default or last-used washing settings, and prepares to start the cycle once the smart button is pressed. In another example involving the smart washing machine, an operating flow may be the washing cycle where the machine pre-washes, washes, rinses, and spins clothes according to the selected program, adjusting water and energy use based on the load detection. A behavior of a digitally connected product may refer to the responses or actions of the product in reaction to user inputs or environmental conditions. In the example of a smart home assistant, a voice command response where the assistant wakes up upon hearing the wake word, processes spoken commands, and performs actions such as setting reminders or playing music may be different types of behaviors. In another example involving the smart home assistant, the learning of user preferences for temperature settings, music, lighting, and the like may be different types of behaviors.

In some implementations, DPNX process 12 may provide 27006 the classification and/or output of the first set of AI-based learning models to a second set of (AI)-based learning models, wherein at least one member of the second set of AI-based learning models may be trained on a training data set of a set of digital product network data to determine 27008 at least one design improvement recommendation for the set of digitally connected products based on the classification and/or output of the first set of AI-based learning models.

In embodiments, the training data set for each set of AI-based learning models may include digital product network data, which may comprise digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In embodiments, the design improvement may comprise modifying one or more of existing product features. For example, if a smart ice maker frequently jams, causing the first set of AI-based learning models to classify a fault condition, the second set of AI-based learning models may recommend a design improvement to modify the ice making mechanism to include a more robust motor and redesigned ice tray to prevent blockage and ensure more consistent operation. In embodiments, the design improvement might involve adding a new product feature. In this example, if a smart refrigerator produces a loud noise when the compressor starts, causing the first set of AI-based learning models to classify it as an undesired behavior, the second set of AI-based learning models may recommend adding a noise-dampening feature or a more advanced compressor technology that operates more quietly. In embodiments, the design improvement may involve removing a product feature. For instance, if a touch screen interface on a digitally connected product frequently malfunctions during humidity changes, causing the first set of AI-based learning models to classify a fault condition, the second set of AI-based learning models may recommend a design improvement of removing the touch screen and replacing it with more reliable physical buttons. In embodiments, the design improvement may include replacing a product material. For example, if the seal on a smart refrigerator door degrades quickly and stops functioning (e.g., a fault condition), the recommended design improvement may include replacing the sealing material with a more durable and resilient material. In implementations, the design improvement may relate to modifying the size of the product. For instance, if the water filter compartment on a smart refrigerator is too small and causes clogs and reduced water flow (e.g., a fault condition), the design improvement recommendation may involve enlarging the compartment and/or water filter to improve water quality and flow. In embodiments, the design improvement may relate to replacing a product part. In the example of a LED lighting system consistently failing in a smart appliance (e.g., a fault condition), the recommended design improvement may be to replace it with a more reliable lighting technology that has a longer lifespan and/or better performance. The design improvement may also relate to modifying a product color, modifying a product style, rearranging the components of the product, and many others.

In embodiments, DPNX process 12 may output 27010 the design improvement recommendation output by the second set of AI-based learning models or provide 27012 a computer code instruction set to a machine to execute the design improvement recommendation generated by the second set of AI-based learning models. The output recommendation can be visually presented to a user, such as by user interfaces or digital twin user interfaces, where the recommendations can be interacted with by users. In embodiments, DPNX process 12 may further generate a virtual prototype of the improved product design. DPNX process 12 may also determine a per-unit cost for the design improvement. This allows for a more intuitive understanding and assessment of the proposed improvements. Furthermore, the DPNX process 12 is capable of providing a computer code instruction set directly to machinery. This set of instructions enables machines to autonomously execute the recommendations generated by the second set of AI-based learning models. For instance, the set of instructions could be provided to a 3D printer that prints components of the digitally connected product to modify the component design.

In embodiments, the recommended design improvement, or the output of the second set of AI-based learning models, may be provided to a third set of AI-based learning models, wherein at least one member of the third set of AI-based learning models is trained on a training data set of digital product network data to predict an impact of the design improvement. In embodiments, the prediction may be a performance prediction (e.g., speed, efficiency, battery life, and the like), a user experience prediction (e.g., usability, engagement, and the like), an economic impact condition (e.g., cost reduction, revenue impact, and the like), a reliability and/or durability prediction (e.g., failure rate, wear and tear, and the like), market adoption prediction (market penetration, customer acquisition, and the like), a compliance and/or safety prediction (e.g., regulatory compliance, safety metrics, and the like), an environmental impact prediction (e.g., energy efficiency, carbon footprint, and the like), and many others.

In embodiments, the recommended design improvement, or the output of the second set of AI-based learning models, may be provided to a third set of AI-based learning models, wherein at least one member of the third set of AI-based learning models is trained on a training data set of digital product network data to identify potential risks associated with the design improvement. The potential risks may include technical risks (e.g., integration issues, scalability limitations, and the like), operational risks (e.g., production delays, increased maintenance requirements, and the like), financial risks (e.g., cost overruns, ROI uncertainty, and the like), market risks (e.g., user adoption, competitive response, and the like), regulatory and/or compliance risks (e.g., non-compliance with standards, data privacy issues, and the like), security risks (e.g., vulnerabilities, data breaches, and the like), reputational risks (e.g., brand damage, public perception, and the like), and environmental risks (e.g., increased environmental impact, regulatory penalties, and the like), among many others.

In embodiments, the recommended design improvement, or the output of the second set of AI-based learning models, may be provided to a third set of AI-based learning models, wherein at least one member of the third set of AI-based learning models is trained on a training data set of digital product network data to generate a plan for validating the improved product design, including one or more of defining testing parameters, identifying testing resources, and setting up testing environments.

In embodiments, the recommended design improvement, or the output of the second set of AI-based learning models, may be provided to a third set of AI-based learning models, wherein at least one member of the third set of AI-based learning models is trained on a training data set of digital product network data to generate a plan for launching and marketing the improved product design, including one or more of identifying target markets, developing marketing strategies, and planning marketing campaigns.

### ML/AI to Determine Location-Based Product Feature Preferences

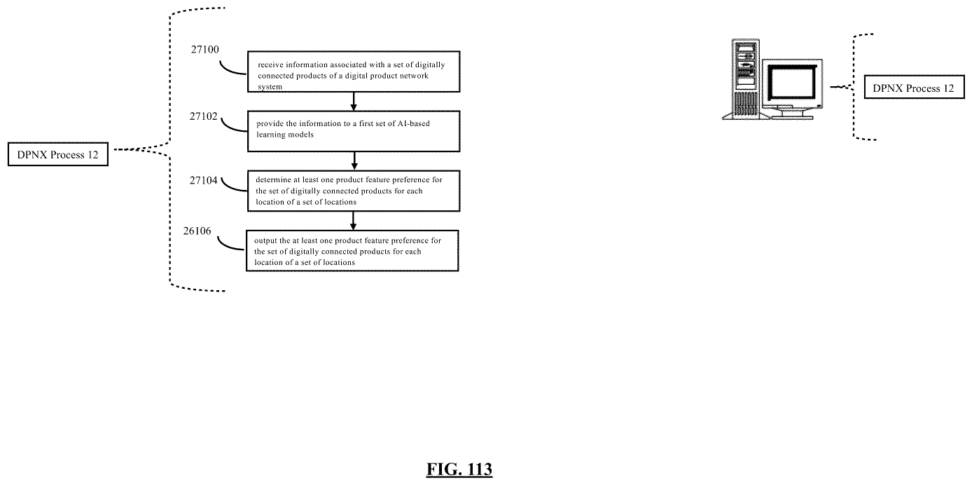

Referring to FIG. 113, a process, such as DPNX process 12 may receive 27100, by a computing device, information associated with a set of digitally connected products (such as those described above) of a digital product network system 26000 and/or a digital product network 26102. For example, a unified database (e.g., via DPNX process 12) may receive information associated with a set of digitally connected products of a digital product network system 26000. The information may be collected in a variety of ways, including (by example only) via the unified data collections systems discussed throughout.

In some implementations, the information may be generated by a set of sensors of the set of digitally connected products. For instance, example sensors and/or a set of APIs configured to publish data relating to the set of digitally connected products may include those discussed regarding the adaptive intelligent systems and monitoring layers of platform 604. In some implementations, the information generated by a set of IoT devices configured to collect data relating to the set of digitally connected products. For instance, unified IoT monitoring systems (such as those discussed regarding at least the example implementation of FIG. 33) may be used to generate information from a set of IoT devices. It will be appreciated after reading the present disclosure that various other types of methods may be used for information generation without departing from the scope of the present disclosure. As such, the example use of the techniques and methods of information generation described throughout should be taken as example only and not to otherwise limit the scope of the present disclosure.

In embodiments, the information may include digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like), historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may provide 27102 the information to a set of Artificial Intelligence (AI)-based learning models, wherein at least one member of the set of AI-based learning models may be trained on a training data set of a set of digital product network data to determine 27104 at least one product feature preference for the set of digitally connected products for each location of a set of locations. For instance, in embodiments, an intelligence services (such as those discussed in the example implementation of FIG. 76) may include an intelligence service controller and AI modules. In embodiments, an artificial intelligence services receives an intelligence request from an intelligence service client and any required data to process the request from the intelligence service client. In response to the request and the specific data, one or more implicated artificial intelligence modules perform the intelligence task and output an “intelligence response”. Examples of intelligence modules responses may include a decision (e.g., a control instruction, a proposed action, machine-generated text, and/or the like), a prediction (e.g., a predicted meaning of a text snippet, a predicted outcome associated with a proposed action, a predicted fault condition, a predicted security risk in the digital product network, a prediction of future demand, and/or the like), a classification (e.g., a classification of an object in an image, a classification of a spoken utterance, a classified fault condition based on sensor data, and/or the like), and/or other suitable outputs of an AI system.

In some implementations, the set of AI-based learning models may include at least one of a transformer model, a convolutional neural network, a deep learning model trained on a set of outcomes of the value chain network entity, a supervised model, a semi-supervised model, an unsupervised model, or a reinforcement model, a generative model, a large language model, and a recommendation model. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like.

In embodiments, the training data set for the set of AI-based learning models may include digital product network data, which may comprise digital product network connectivity data, data associated with digitally connected products of the digital product network, device status data, device health and diagnostic data, energy consumption data, error and alert logs, consumer preference data (e.g., consumer preferences associated with temperature settings, energy consumption settings, lighting settings, and the like) historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), pricing data, and product interaction data.

In some implementations, DPNX process 12 may determine 27104 at least one product feature preference for the set of digitally connected products for each location of a set of locations using the set of AI-based learning models and output 27106 the at least one product feature preference for each location of a set of locations (e.g., to a user interface, a digital twin interface, or the like). For example, consumers in different locations have different preferences for automobiles, as consumers in California generally prefer electric and hybrid vehicles due to environmental concerns and state incentives, while consumers in Texas generally prefer trucks and sports utility vehicles (SUVs) for their utility in both rural and urban settings and for their ability to handle rough terrains. In another example, consumers in Florida generally prefer appliances with high efficiency and durability in humid and hot climates while consumers in Minnesota generally prefer appliances that are optimized for energy efficiency in cold climates. In yet another example, consumers in Colorado generally prefer outdoor gear that is durable for hiking, skiing, and mountain sports, while consumers in Florida generally prefer water sports equipment like surfboards and diving gear. Product features may include colors, sizes and measurements, materials, technical specifications (e.g., voltage and plug types), components, languages (e.g., user interfaces in software and electronics), packaging, functionalities, and many others. For example, automobiles in colder regions like Canada may be equipped with engine block heater components to help start the engine in freezing temperatures, while automobiles in desert climates may come equipped with advanced air filtration systems to handle sand and dust.

Therefore, DPNX process 12 may utilize the set of AI-based models that can determine 26104 at least one product feature preference for the set of digitally connected products for each location of a set of locations based upon the above-noted generated information provided to the AI-based learning models.

In embodiments, the set of AI-based learning models are configured to determine at least one product feature preference for the set of digitally connected products for a plurality of geographic segments. By understanding and integrating specific feature preferences unique to each geographic segment, companies can provide a more relevant and engaging user experience. This customization makes the product feel more intuitive and useful to local users. Products that cater to the specific tastes and needs of a local market are more likely to be adopted. For example, integrating popular local payment methods into a digital product can remove barriers to entry for customers. Knowing the feature preferences of different geographic segments allows for more targeted and effective marketing campaigns. Marketing messages can highlight specific features that are most appealing to each segment, improving engagement and conversion rates.

In embodiments, the DPNX process 12 may determine a sales measure associated with each of the plurality of geographic segments. Sales measures provide quantitative feedback on the success of the implemented features. This data helps in understanding which features are driving sales and which are not, allowing companies to iterate and improve their products based on solid evidence. Sales data linked with product features allows for more accurate financial forecasting. Companies can predict revenue more reliably by understanding how different features perform in various markets.

In embodiments, at least one member of the set of AI-based learning models is trained on a training data set of digital product network data to determine at least one product feature preference for a plurality of demographic segments for the set of digitally connected products. By understanding the preferences of different demographic groups (such as age, gender, income level, education, etc.), companies can tailor their digital products to better meet the specific needs and expectations of these groups. This personalization can significantly enhance user engagement and satisfaction. Identifying feature preferences allows companies to segment the market more effectively. This segmentation enables the development of specialized products or versions of products that cater to the unique preferences of each demographic, maximizing appeal and utility. In embodiments, DPNX process 12 may determine a sales measure associated with each of the plurality of demographic segments. Sales data broken down by demographic segments provides clear insights into which segments are performing well and which are not. This allows companies to identify successful strategies and areas needing improvement. Understanding which demographic segments generate the most revenue helps in allocating marketing, sales, and development resources more effectively. Resources can be focused on the most profitable segments or used to develop underperforming segments.

In embodiments, at least one member of the set of AI-based learning models is trained on a training data set of digital product network data to determine at least one product feature preference for a plurality of consumer behavioral segments for the set of digitally connected products. In embodiments, consumer behavioral segments may include, but are not limited to, usage rate (e.g., heavy users, moderate users, and light users), purchasing behavior (e.g., loyal customers, discount seekers, and the like), user status (e.g., new users, regular users, and former users), engagement level, occasion or timing (e.g., customers that use the product as part of a regular routine, customers who use the product for special events or occasions, seasonal users, and the like), payment method preference (e.g., credit/debit card users, digital wallet users, and the like), shopping channel preferences (e.g., social media channel preferences, online shopping preferences, retail store preferences, and the like), and many others. By understanding the behaviors of different customer segments, companies can design features that directly cater to how these users interact with the product. For example, if a segment frequently uses voice commands, enhancing voice recognition features could lead to better engagement. Understanding how different segments use and value various features can guide more effective pricing strategies. Features that are highly valued by certain segments might warrant premium pricing, while other features might be positioned differently. In embodiments, DPNX process 12 may determine a sales measure associated with each of the plurality of behavioral segments. Determining product feature preferences and associated sales measures for different customer behavioral segments is essential for creating products that are not only technically advanced but also closely aligned with the market's diverse needs. This strategic approach drives better business outcomes through increased customer satisfaction, loyalty, and profitability.

Gathering data on feature preferences across different locations, demographic segments, behavioral segments, and the like can provide valuable insights that drive future product development. This approach ensures that features are based on actual user needs and trends rather than assumptions. In embodiments, DPNX process 12 may generate a recommendation for product development based on the output of the set of AI-based learning models. In embodiments, the recommendation may comprise modifying one or more of existing product features. In an example, for a smart thermostat sold in colder regions, the recommendation may be to modify the existing temperature adjustment feature to include a more aggressive heating algorithm, catering to the higher demand for warmth in these areas. In embodiments, the recommendation involve adding a new product feature. For example, considering the high activity levels of the younger demographic using the fitness tracking smartwatch, the recommendation may comprise adding a new feature for anaerobic exercise tracking to appeal to this fitness-conscious segment. In embodiments, the recommendation involves removing a product feature. For instance, for a smart refrigerator used in urban areas where space is a premium, the recommendation may comprise removing the ice dispenser feature, which is seldom used and occupies valuable space. In embodiments, the recommendation may include replacing a product material. For example, in response to the preferences of environmentally conscious users in a state like Oregon, the recommendation may involve to replacing the plastic casing of the wireless earbuds with a recycled material to enhance the product's appeal to this segment. The recommendation may relate to modifying the size of the product. For instance, for a smart home security camera marketed in European countries where homes are generally smaller, reducing the size of the device may be recommended to better fit the space constraints and aesthetics of these markets. In embodiments, the recommendation may relate to replacing a product part. In this example, for an electric scooter marketed in hilly cities, replacing the standard motor with a more powerful version may be recommended to better handle inclines and enhance user satisfaction. In some implementations, the recommendation may relate to modifying a product color. For example, to cater to the fashion-forward users in metropolitan areas, introducing trendier, vibrant color options for the smart light bulbs may be recommended to complement modern urban interiors. The recommendation may involve modifying the product style. For a smart door lock used in historic district homes, modifying the product style to a more classic, less modern look may be recommended to fit the more traditional aesthetic of these areas. In embodiments, the recommendation may involve rearranging the components of the product. For example, for the portable smart speakers marketed to young adults who frequently host social gatherings, it may be recommended to rearrange the components to include detachable satellite speakers. This design allows users to distribute sound more evenly throughout larger spaces or outdoor areas, enhancing the audio experience during social events. Each recommendation may be specifically tailored to address the unique preferences and needs of users based on their geographic location, demographic characteristics, and/or behavioral patterns, ensuring that the product development is closely aligned with user expectations and market demands.

### Generative AI for Digital Product Networks

In embodiments, the techniques described herein relate to a generative artificial intelligence system for a digital product network including one or more processors and one or more memories configured to perform operations including: executing, by the generative artificial intelligence system, generative artificial intelligence algorithms trained on digital product network data; receiving input data including at least one of images, video, audio, text, programmatic code, and data; processing the input data using the generative artificial intelligence algorithms to generate output content, wherein the output content includes at least one of structured prose, images, video, audio content, software source code, formatted data, algorithms, definitions, and context-specific structures; generating an internal state of the generative artificial intelligence system, including a set of weights and/or biases as a result of prior processing; and providing the generated output content to a user interface for presentation to a user.

In embodiments, the generative artificial intelligence algorithms of the GAIE may be trained on digital product network data. In embodiments, the training data set for the set of AI-based learning models may include digital product network data, which may comprise historical sales data, purchase history data, search query data, competitive analysis data, market data, social media data, customer data, customer demographic data, customer engagement data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, product component data, inspection data, failure data, warranty data, service record data, regulatory data, insurance data, entertainment data, event data, incident data, weather data, accident report data, date of packaging, time of packaging, product location data, location of manufacturing data, location of packaging data, location of purchase data, location of consumption data, location of package opening data, time on display data (e.g., time on display shelf or other display), consumer interaction data (e.g., with displayed products or purchased products), product performance data, product usage data, product marketing data, product packaging data, labor data, labor scheduling data, labor cost data, product image data, product video data, product audio data, environmental data (e.g., temperature, humidity, air quality, or other environmental factors that could affect the product's performance), product security data (e.g., data on access controls, breach attempts, or any security incidents), and product interaction data.

For example, generative AI system may be configured for a manufacturer of digitally connected products that processes product usage data, product location data, and product performance data to generate an improved product design. The system generates a visual of the improved product design with information about the design, including dimensions, technical specifications, and the like, which is then displayed on a user interface for the manufacturer.

In some aspects, the techniques described herein relate to a generative artificial intelligence system, wherein the input data further includes natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations.

In an example, a smart home environment has various digitally connected products such as smart thermostats, security cameras, and lighting systems connected in a digital product network where each of the products is equipped with sensors that continuously gather data. A generative AI system may be trained on the digital product network data of the smart home environment. Sensors in the smart home devices continuously transmit data to the generative AI system. This may include temperature fluctuations, motion activity recorded by cameras, and light levels detected by smart bulbs. The generative AI system executes algorithms that have been trained to understand and predict homeowner preferences and patterns based on the collected sensor data and natural-language inputs. The system processes this real-time data along with historical data patterns to generate predictive models and control commands. For example, if the temperature data and homeowner preferences suggest that the homeowner likes a warmer temperature in the evening, the system can automatically adjust the thermostat. The AI system generates output commands to control the connected devices. For example, it might adjust the thermostat settings, dim the lights, or activate security protocols based on the time of day, detected motion, or specific user commands. The generated outputs (e.g., adjusted temperature settings, security alerts) are communicated to the user through a user interface, which can be an app or voice-activated system. The interface allows users to see what adjustments have been made and provides recommendations, such as energy-saving tips or security alerts.

In embodiments, the techniques described herein relate to a generative artificial intelligence system, wherein the generative artificial intelligence system is configured to maintain contextual awareness across interactions to facilitate continuity in dialogue with users. For instance, a generative AI system the smart home environment (e.g., digital product network) may maintain a conversation history with the homeowners, using this context to provide consistent and personalized support across multiple interactions, such as recommending additional products based on past queries.

In some aspects, the techniques described herein relate to a generative artificial intelligence system, wherein the generative artificial intelligence system is configured to support interpretability and explainability of its outputs by providing a description of the basis of the output. For example, a generative AI system for a manufacturer of digitally connected products may generate a report on predicted product usage and provide explanations for its predictions, such as citing historical product usage data or recent news events that influenced its analysis, making the output more transparent.

In some embodiments, the techniques described herein relate to a generative artificial intelligence system, wherein the output includes a recommendation to improve one or more of the digital product networks and a digitally connected product. For instance, a supply chain generative AI system may analyze sales data and inventory levels across a retail network to recommend restocking certain products in specific locations, aiming to improve the overall efficiency of the inventory distribution within the value chain network.

In some embodiments, the techniques described herein relate to a generative artificial intelligence system, further including a digital twin interface for a digital twin, wherein the digital twin interface is configured to enable access to the generative artificial intelligence system, and wherein the digital twin represents at least one of the digital product network and a digitally connected product. In one example, a smart refrigerator manufacturer's generative AI system may be accessed via a digital twin interface that allows product designers to interact with a virtual representation of the smart refrigerator, enabling them to test different refrigerator parts or components without affecting the actual smart refrigerator design. Continuing with the example, the operators may be able to ask the smart factory generative AI system questions about the different design scenarios.

In some aspects, the techniques described herein relate to a generative artificial intelligence system, further including a digital twin module configured to generate a digital twin representing at least one of a digital product network and a digitally connected product. For instance, a generative AI system for a smart manufacturing environment may generate a digital twin of the smart manufacturing environment's digital product network, simulating robotic traffic flow and operations to propose improvements for reducing congestion and increasing efficiency.

In some aspects, the techniques described herein relate to a generative artificial intelligence system, wherein the processor is further configured to communicate with robotic systems within the digital product network, and the memory stores instructions that enable the generative artificial intelligence system to translate human commands into robotic actions, thereby facilitating human-to-robot interaction. In one example, a smart home environment generative AI system may translate voice commands from homeowners into actions for personal robots, coordinating the robotic tasks for the home environment.

In embodiments, the techniques described herein relate to a generative artificial intelligence system, wherein the output content is further tailored based on the executive role of the user. The GAIE may be configured to tailor the output content based on the executive role of the user within an organization. The system adjusts the level of detail and complexity of the output content to match the user's role, ensuring that the information provided is directly relevant to the user's decision-making needs and responsibilities. For example, an executive dashboard generative AI system may customize financial reports for different roles within a corporation, providing high-level summaries for C-suite executives and detailed breakdowns for department heads.

In some aspects, the techniques described herein relate to a generative artificial intelligence system, wherein the generated output includes 3D printing instructions for a set of 3D printers based on input data. The system may be configured to analyze product designs and utilize the generative capabilities of the GAIE to create detailed 3D printing instructions, facilitating the physical realization of product concepts. For instance, a design generative AI system for a smart bottle company may process sketches and material specifications to generate precise 3D printing instructions, enabling rapid prototyping of new smart bottle designs.

In some aspects, the techniques described herein relate to a generative artificial intelligence system, wherein the system is part of a Dual Process Artificial Neural Network (DPANN) architecture, combining generative AI capabilities with formal logic-based systems to enhance decision-making and predictive modeling. For example, in a smart factory setting, where the smart factory is equipped with a network of digitally connected products (e.g., assembly robots, conveyor belts, environmental sensors, monitoring cameras, and the like), the formal logic-based component of the DPANN architecture uses predefined rules and logic to make decisions based on the outputs from the generative AI. For example, if the AI predicts a potential machine failure, the logic system can decide the best course of action based on safety protocols and production schedules.

In embodiments, the techniques described herein relate to a generative artificial intelligence system, further including an augmented reality (AR) interface configured to overlay the generated output content onto a user's real-world view. This AR interface may provide interactive and visual representations of the output content, enhancing user engagement and understanding of complex data. In one example, an augmented reality (AR) interface is integrated with the generative AI system. Continuing the example, as a field technician inspects a piece of smart machinery using AR glasses, the generative AI system can overlay real-time data analytics, maintenance history, and performance metrics onto their view of the equipment. This allows the technician to see potential issues highlighted directly on the machinery, receive step-by-step repair instructions, and view predictive maintenance alerts, all superimposed within their field of vision, thereby enhancing the efficiency of on-site diagnostics and repairs.

### Further ML/AI Embodiments for Digital Product Network System

In some embodiments, the digital product network system 26000 employs the AI modules of the artificial intelligence services for optimizing various facets of product management, ranging from demand planning and enhancement to supply chain and inventory optimization. For instance, by analyzing historical sales data, market trends, and real-time demand metrics, AI-based learning models can forecast product demand, enabling businesses to strategize production and distribution accordingly. Additionally, by processing data from the entire supply chain, the AI-based learning models may identify inefficiencies and optimizes routes, suppliers, and inventory levels, ensuring a seamless flow of products from manufacturers to end-users. Further, by processing feedback, market trends, and technological advancements, the AI-based learning models may suggest design modifications that align with consumer preferences, technological feasibility, and market demand, ensuring that the product design remains both innovative and market friendly. Furthermore, by analyzing reviews, feedback, and market trends, the AI-based learning models may suggest which features of a product resonate most with the consumers.

In some embodiments, the digital product network system 26000 integrates a models-as-a-service (MaaS) system, enhancing its capability to deliver machine learning and other modeling solutions. The MaaS system represents a shift in model deployment, where organizations can access these models in a service-oriented manner. The MaaS system in the digital product network system 26000 may provide models (e.g., AI-based learning models, mechanistic models, physics-based models, biology-based models, financial models, and the like) through APIs or cloud-based services, ensuring scalability, easy integration, and consistent model updates. Herein, the MaaS integration supports pre-configured models. Organizations can bypass the resource-intensive stages of data collection, pre-processing, model training, and validation. Instead, they can directly access models that have been optimized for specific tasks or industries. This not only accelerates the deployment of modeling solutions but also democratizes access, enabling even smaller organizations or those without extensive modeling expertise to harness the power of advanced algorithms. In an implementation, the MaaS system in the digital product network system 26000 operates on a subscription-based model, ensuring cost-effectiveness. Organizations can choose the models they need, for the duration they require, without incurring significant upfront costs associated with traditional model development. This subscription model also ensures that organizations always have access to the latest versions of models, benefiting from continuous improvements and updates. In addition, the integration of the MaaS system promotes interoperability. Since the models may be delivered through standardized APIs, they can seamlessly integrate with various applications, systems, or platforms within the digital product network system 26000, ensuring that model-based insights are ubiquitously available across the network, driving data-driven decision-making at every touchpoint.

In some embodiments, the digital product network system 26000 employs the artificial intelligence services to configure smart contracts. Smart contracts, inherently digital and automated, thrive on precision and clarity in terms. The artificial intelligence services, through its analytical capabilities, reviews vast datasets, historical contract performances, and current market dynamics to determine the most favorable terms that would be beneficial for all parties involved, ensuring transparent, efficient, and equitable contract implementations.

In some embodiments, the digital product network system 26000 employs various capabilities of the artificial intelligence services, which includes natural language processing capabilities, to read and interpret contracts, identifies and creates alerts related to payment dates, contract obligations, contract expiration dates, and other critical terms, ensuring that obligations are met, and any potential breaches or upcoming deadlines are promptly addressed.

In some embodiments, the digital product network system 26000 utilizes various capabilities of the artificial intelligence services, which includes natural language processing capabilities, to carry out automated analysis of product reviews. This configuration allows for a deeper understanding of customer feedback, highlighting areas of improvement and accentuating product strengths based on genuine customer interactions.

In some embodiments, the digital product network system 26000 employs the capabilities of the artificial intelligence services to reinforce the security mechanisms surrounding products, particularly in the context of supply chain management. The AI modules of the artificial intelligence services assess potential threats, historical security breaches, and current security protocols to devise robust security strategies, ensuring that products are protected from inception to delivery, maintaining the integrity and authenticity of the product throughout its supply chain journey.

In some embodiments, the digital product network system 26000 utilizes the AI modules of the artificial intelligence services to refine and enhance product repair methodologies by processing vast amounts of repair data, historical records, user feedback, and the like. Through this analysis, the AI modules identify best practices, efficient repair techniques, and tools that can lead to faster and more reliable repair outcomes, thereby enhancing the product lifespan and user satisfaction.

In some embodiments, the digital product network system 26000 leverages the AI modules of the artificial intelligence services to optimize product and/or product component recycling methods. In the context of growing environmental concerns and sustainability goals, the AI modules may be configured to process information related to the materials of the product, their recyclability, and existing recycling methods. By doing so, the AI modules devise strategies that maximize material recovery, reduce waste, and support circular economy initiatives.

In some embodiments, the digital product network system 26000 utilizes the AI modules of the artificial intelligence services to optimize product and/or product component disposal methods. The AI modules may suggest dismissal methods that are environmentally responsible, compliant with regulations, and cost-effective.

In some embodiments, the digital product network system 26000 employs the AI modules of the artificial intelligence services to optimize resource consumption during product development and usage. Using data on resource availability, consumption patterns, and best practices, the AI modules propose strategies that minimize waste and optimize resource utilization across the product's life cycle.

In some embodiments, the digital product network system 26000 leverages the AI modules of the artificial intelligence services to optimize energy consumption in product operation. With rising energy costs and environmental concerns, energy-efficient products are in demand. The AI modules may process data on product energy consumption patterns, energy sources, and/or efficiency benchmarks and recommend design changes, operational tweaks, or alternative energy sources that can make the product more energy-efficient, thereby offering economic and environmental benefits.

In some embodiments, the digital product network system 26000 utilizes the AI modules of the artificial intelligence services to optimize collaboration amongst stakeholders. Recognizing that cohesive collaboration is important for product development and deployment, the AI modules may process communication data, project timelines, and/or stakeholder roles to identify collaboration bottlenecks and suggests tools or methodologies that can streamline communication and enhance collaborative efforts.

In some embodiments, the digital product network system 26000 employs the AI modules of the artificial intelligence services to optimize the pricing of the digitally connected products. The AI modules may analyze market trends, competitor pricing, production costs, and/or customer feedback to suggest a pricing structure that ensures profitability while remaining attractive to consumers.

In some embodiments, the digital product network system 26000 utilizes AI modules of the artificial intelligence services to prevent product recalls. Product recalls can be detrimental both financially and reputationally. By processing product performance data, user feedback, and/or historical recall data, the AI modules may be configured to identify potential product vulnerabilities and/or recommend preemptive actions or modifications to avoid possible recalls, safeguarding brand reputation and consumer trust.

In some embodiments, the digital product network system 26000 leverages the AI modules of the artificial intelligence services to improve the collection of consumer feedback. Consumer feedback is invaluable for product evolution. The AI modules may process existing feedback collection mechanisms and/or customer engagement rates to suggest improved methods or platforms for gathering more representative and comprehensive feedback, ensuring products evolve in line with consumer preferences.

In some embodiments, the digital product network system 26000 employs the AI modules of the artificial intelligence services to determine the post-launch performance of a product. Post-launch performance metrics are essential indicators of product success. The AI modules may be configured to process sales data, user feedback, and/or market trends to provide insights into how the product is performing in the real world, enabling stakeholders to make informed decisions about product iterations or marketing strategies.

In some embodiments, the digital product network system 26000 utilizes AI modules of the artificial intelligence services to rank user input/ideas. With numerous ideas and inputs pouring in, prioritization becomes important. The AI modules evaluate user inputs based on feasibility, potential impact, and alignment with product goals, subsequently ranking them to help stakeholders focus on the most promising suggestions.

In some embodiments, the digital product network system 26000 leverages the AI modules of the artificial intelligence services to solicit users for feedback related to a product. To ensure feedback is representative, the AI modules may process user demographics, product usage patterns, and/or past feedback history to identify a diverse and relevant group of users best positioned to provide insightful feedback.

In some embodiments, the digital product network system 26000 employs the AI modules of the artificial intelligence services to optimize shipment sizes, frequencies, and/or timing. Efficient shipment practices can reduce costs and improve customer satisfaction. The AI modules may be configured to process order data, inventory levels, and/or transportation metrics to suggest optimal shipment strategies, ensuring timely deliveries while minimizing costs.

In some embodiments, the digital product network system 26000 uses the AI modules of the artificial intelligence services to categorize product features. The AI modules may be configured to process product specifications, user feedback, and/or usage data to categorize product features into groups such as essential, luxury, performance-enhancing, or aesthetic, aiding in product development and marketing strategies.

In some embodiments, the digital product network system 26000 leverages the AI modules of the artificial intelligence services to categorize products. The AI modules may be configured to processes product attributes, intended use, and market positioning to organize products into relevant categories (e.g., luxury, budget, eco-friendly, or premium), enabling stakeholders to better understand market segmentation and direct marketing efforts appropriately.

In some embodiments, the digital product network system 26000 utilizes the AI modules of the artificial intelligence services to categorize competitors. With a dynamic business environment, understanding competitors is important. The AI modules may be configured to process competitor products, market share, and/or branding strategies and categorize the competitors into groups such as direct competitors, indirect competitors, or potential entrants.

In some embodiments, the digital product network system 26000 leverages the AI modules of the artificial intelligence services to categorize consumers. The AI modules may be configured to receive purchase history, feedback, and/or demographic data and then segment consumers into categories such as loyal customers, occasional buyers, potential leads, or lapsed customers, providing insights for targeted marketing and engagement strategies.

In some embodiments, the digital product network system 26000 leverages the AI modules of the artificial intelligence services to categorize consumer feedback. The AI modules may be configured to process the content, sentiment, and/or context of the customer feedback and then categorize the feedback into groups such as product features, pricing, usability, or customer service, enabling businesses to address specific areas of concern or opportunity effectively.

In some embodiments, the digital product network system 26000 utilizes the AI modules of the artificial intelligence services to increase the efficiency of a product development cycle. Recognizing the complexities in product development, the AI modules may be configured to receive project timelines and/or resource allocation to identify potential bottlenecks and streamline processes, enabling a faster and more efficient journey from product ideation to market launch.

In some embodiments, the digital product network system 26000 uses the AI modules of the artificial intelligence services for detecting and implementing regulatory rules directly into a product. The AI modules may be configured to continuously scan regulatory databases. Upon detecting relevant rules or changes, the AI modules may be configured to automatically integrate these regulations into the product specifications or features, ensuring that the product remains compliant throughout its lifecycle.

In some embodiments, the digital product network system 26000 employs the AI modules of the artificial intelligence services for performing quality management control. The AI modules may be configured to process production data, defect rates, and/or consumer feedback. The AI modules then identify quality deviations and recommends corrective measures, ensuring that products consistently meet or exceed quality standards.

In some embodiments, the digital product network system 26000 uses the AI modules of the artificial intelligence services to build and maintain blockchains. The AI modules may design blockchain architectures, process transactions, and manage nodes using analyzing transaction patterns and network health data.

In some embodiments, the digital product network system 26000 employs the AI modules of the artificial intelligence services for customizing a product for a particular consumer. Acknowledging the unique preferences and needs of each consumer, the AI modules may receive consumer data, purchase histories, and/or customer feedback. Based on this data, the AI modules may personalize product features, aesthetics, and/or functionalities, offering consumers a tailored product experience that resonates with their specific preferences and requirements.

Integrating Other Systems with Digital Product Network System

In some embodiments, the digital product network system 26000 may be integrated with a product data management (PDM) system. PDM may refer to software solution that centralizes the management of product data and associated processes, which may comprise computer-aided design (CAD) details, component specifications, manufacturing directives, supplementary documentation, and the like. The PDM system may be utilized for secure data management, process enablement, configuration management, and the like. For secure data management, the PDM system captures, governs, and disseminates product-related information, ensuring timely and relevant delivery throughout the product's lifecycle. For process enablement, the PDM system amplifies the involvement of key stakeholders in the product lifecycle. For configuration management, the PDM system provides visibility for comprehensive bill of materials (BOM) management, and ensures alignment and synchronization across diverse BOM data sources and lifecycle stages. The digital product network system 26000, when integrated with a PDM system, offers a holistic solution for product lifecycle management, streamlining processes, reducing costs, and enhancing collaboration.

In some embodiments, the digital product network system 26000 may be integrated with an enterprise resource planning (ERP) system. An ERP system may refer to a software solution that centralizes business processes and operations, bridging the gap between different functional departments of an organization. By forecasting consumer demands, the system aids in determining the appropriate marketing channels, promotional strategies, and inventory quantities. Manufacturers leveraging an ERP system possess a comprehensive view of their inventory, irrespective of its location within the supply chain. With such data on inventory levels, purchasing trends, and production performance, manufacturers can define well-informed production strategies, ensuring optimal resource allocation.

In some embodiments, the digital product network system 26000 may be integrated with a product portfolio management (PPM) system. This integration helps in distributing risks across the product lifecycle. When synergized with effective modularization strategies, the PPM system can amplify scale effects for components, offering customers a diverse range of choices.

In some embodiments, the digital product network system 26000 may be integrated with a social media system. This integration facilitates real-time feedback, engagement, and insights from the user community, thereby enhancing product strategies and market responsiveness.

In some embodiments, the digital product network system 26000 may be integrated with a CAD/CAM/CAE system. This integration ensures a cohesive alignment between product design, manufacturing processes, and engineering evaluations, driving both efficiency and innovation throughout the product lifecycle.

In some embodiments, the digital product network system 26000 may be integrated with a closed loop lifecycle management (CL2M) system. Through this integration, the system ensures continuous feedback loops between various stages of the product lifecycle, fostering consistent improvements and adaptability to changing requirements.

In some embodiments, the digital product network system 26000 may be integrated with a model-based definition (MBD) system. This integration provides a unified representation of product data, streamlining design-to-manufacturing processes and enhancing accuracy and collaboration across teams.

In some embodiments, the digital product network system 26000 may be integrated with an IoT system. This synergy enables real-time data collection, monitoring, and analysis from connected devices, offering invaluable insights into product usage and performance metrics.

In some embodiments, the digital product network system 26000 may be integrated with a mechanical computer-aided design (MCAD) system, an enterprise asset management system, a supplier management system, a product lifecycle management (PLM) system, and the like.

### Hardware, Software, and Special-Purpose Systems

Special-purpose systems include hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

In this application, including the claims, the term module refers to a special-purpose system. The module may be implemented by one or more special-purpose systems. The one or more special-purpose systems may also implement some or all of the other modules. In this application, including the claims, the term module may be replaced with the terms “controller” or “circuit.” In this application, including the claims, the term platform refers to one or more modules that offer a set of functions. In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In example embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In example embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption, or other type of processor. Examples of co-processors include a math co-processor, a graphics co-processor, a communication co-processor, a video co-processor, and an artificial intelligence (AI) co-processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code.

The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like. The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

A processor may include one or more cores that may enhance speed and performance of a multiprocessor. In example embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application. A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network. Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN include IEEE Standard 802.15.4, including the ZIGBEE standard from the ZigBee Alliance. Further examples of a WPAN include the BLUETOOTH™ wireless networking standard, including Core Specification versions 3.0, 4.0, 4.1, 4.2, 5.0, and 5.1 from the Bluetooth Special Interest Group (SIG). A WAN may also be referred to as a distributed communications system (DCS). One example of a WAN is the internet.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Examples of storage implemented by the storage hardware include a database (such as a relational database or a NoSQL database), a data store, a data lake, a column store, and a data warehouse. Examples of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable.

Examples of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM). Examples of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM). Examples of magnetic storage media include analog magnetic tape, digital magnetic tape, and rotating hard disk drive (HDDs). Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities. In example embodiments, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

The elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

### Further Information and Use of Terms

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law. While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

Each publication referenced in this disclosure, including foreign and domestic patent applications and patents, is hereby incorporated by reference in its entirety as if fully set forth herein.

The terms “comprising,” “with,” “including,” and “containing” are to be construed as open-ended terms (i.e., meaning “including, but not limited to”) unless otherwise noted. Unless otherwise specified, the terms “comprising,” “having,” “with,” “including,” and “containing,” and their variants, are open-ended terms, meaning “including, but not limited to.”

The term “exemplary” simply means “example” and does not indicate a best or preferred example. The use of any and all examples, or exemplary language (e.g., “such as”) provided herein, is intended merely to better illuminate the disclosure and does not pose a limitation on the scope of the disclosure unless otherwise claimed.

The use of the terms “a,” “an,” “the,” and similar referents in the context of describing the disclosure (especially in the context of the following claims) is to be construed to cover both the singular and the plural, unless otherwise indicated herein or clearly contradicted by context.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The phrase “at least one of A, B, and C” should be construed to mean a logical (A OR B OR C), using a non-exclusive logical OR, and should not be construed to mean “at least one of A, at least one of B, and at least one of C.”

The term “set” may include a set with a single member. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.”

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited.

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As one example, for information sent from element A to element B, element B may send requests and/or acknowledgements to element A.

1. A digital product network system comprising:
a product-to-product communication module configured to exchange inter-product communications for a plurality of digitally connected products;
a product-to-user communication module configured to exchange product-to-user communications between the plurality of digitally connected products and their respective users;
a product-to-business communication module configured to exchange product-to-user communications between the plurality of digitally connected products and their associated enterprises;
a data processing module configured to process the inter-product communications, product-to-user communications, and the product-to-business communications to determine time-sensitive alerts related to corresponding one of the plurality of digitally connected products; and
a graphical user interface (GUI) module configured to generate one or more user interfaces for displaying a time-sensitive alerts.

2. The digital product network system of claim 1, wherein the time-sensitive alerts comprise at least one of a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or device overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a health-related alert, a fitness-related alert, an energy-related alert, an inventory alert, a performance degradation alert, a compliance alert, a demand surge alert, a security breach alert, and a user-defined custom alert based on a specific conditions or threshold set by the user.

3. The digital product network system of claim 1 further comprising a smart contract creation module configured for creation of a smart contract providing terms and conditions that apply to at least one of: the plurality of digitally connected products, a user of at least one of the plurality of digitally connected products, a manufacturer of at least one of the plurality of digitally connected products, a distributer of at least one of the plurality of digitally connected products, an insurance provider for at least one of the plurality of digitally connected products, a retailer of at least one of the plurality of digitally connected products, and a service provider for at least one of the plurality of digitally connected products, wherein the smart contract relates to one or more of a purchase, a return, a lease, a warranty, an extended warranty, a service contract, a maintenance contract, a trade-in, a product add-on, a new product feature, a contract for access to data, a contract for access to one or more models, a software upgrade, a product upgrade, and a contract for access to a product feature.

4. The digital product network system of claim 3, wherein the smart contract creation module is further configured to automatically create smart contracts based on predefined rules.

5. The digital product network system of claim 3 further comprising a smart contract template selection module configured to enable selection of a smart contract template, while restricting the selection to one or more smart contract templates that are associated with the at least one of the plurality of digitally connected products.

6. The digital product network system of claim 5, wherein the smart contract template selection module is further configured to:
receive input for parameterizing the selected smart contract template;
generate a smart contract by parameterizing one or more variables in the smart contract with the input; and
deploy the smart contract by broadcasting the smart contract to the at least one of the plurality of digitally connected products.

7. The digital product network system of claim 5, wherein the smart contract template selection module is further configured to suggest smart contract templates to a user based on at least one of: a type of the digitally connected product to be subject to the smart contract, one or more past selections of the user.

8. The digital product network system of claim 3 further comprising a smart contract performance verification module configured to verify the performance of an obligation defined in the smart contract.

9. The digital product network system of claim 8, wherein the smart contract performance verification module is further configured to automatically trigger an action upon successful verification of the performance of the obligation defined in the smart contract, and wherein the action comprises one or more of providing a notification, updating a status of the smart contract, and initiating a new smart contract.

10. The digital product network system of claim 1 further comprising a record upload module configured for enabling a user to upload records, wherein the records comprise one or more of photos, videos, audio recordings, device information, usage data, user preferences, troubleshooting records, upgrade records, reviews of product, receipts for product-related costs, receipts for product-related purchases, environmental data, and customer feedback.

11. The digital product network system of claim 10, wherein the record upload module is further configured to automatically categorize and store the uploaded records based on respective types of associated digitally connected products.

12. The digital product network system of claim 1 further comprising an application programming interface (API) management module configured to manage one or more APIs, so as to expose the APIs to one or more related applications or third-party systems used by the plurality of digitally connected products.

13. The digital product network system of claim 1 further comprising a regulatory interface module configured to interact with one or more regulatory systems.

14. The digital product network system of claim 1 further comprising a data integration module configured to integrate data from the plurality of digitally connected products to create a unified view of data associated with the digitally connected products, by performing one or more operations, wherein the one or more operations comprise collecting data, aggregating data, normalizing data, standardizing data, cleaning data, enriching data, analyzing data, visualizing data, and integrating with other systems, and wherein the data integrated by the data integration module comprises one or more of product usage data, environmental data, product performance data, customer data, supply chain data, demand data, product location data, product customer feedback, product interaction data, product security data, product packaging data, product image data, product video data, product audio data, and product simulation data.

15. The digital product network system of claim 1, wherein the GUI module is further configured to provide one or more user interfaces displaying related ones of the plurality of digitally connected products associated with a single user by at least one of brand, type, and capability.

16. A method for operating a digital product network system, the method comprising:
exchanging inter-product communications for a plurality of digitally connected products;
exchanging product-to-user communications between the plurality of digitally connected products and their respective users;
exchanging product-to-business communications between the plurality of digitally connected products and their associated enterprises;
processing the inter-product communications, the product-to-user communications, and the product-to-business communications to determine time-sensitive alerts related to corresponding one of the plurality of digitally connected products; and
generating one or more user interfaces for displaying the time-sensitive alerts.

17. The method of claim 16, wherein the time-sensitive alerts comprise at least one of a low battery warning, a hardware failure notification, a software update notification, a connectivity issue notification, an unauthorized access warning, a maintenance reminder, a temperature fluctuation notification, a performance degradation notification, a storage capacity warning, a firmware upgrade alert, a scheduled backup reminder, a data breach notification, a device inactivity alert, a device overactivity or device overheating warning, a compatibility or synchronization issue with other devices, a warranty expiration reminder, a service subscription renewal alert, a sensor malfunction notification, an environmental hazard alert, a device location or movement alert, a user account change, a login notification from an unfamiliar location, a device lifecycle stage transition alert, a predictive alert based on AI analysis, an external power source disconnection warning, an accessory or peripheral malfunction notification, a safety alert, a status alert, a usage alert, a maintenance alert, a promotional alert, a product expiration alert, a health-related alert, a fitness-related alert, an energy-related alert, an inventory alert, a performance degradation alert, a compliance alert, a demand surge alert, a security breach alert, and a user-defined custom alert based on a specific conditions or threshold set by the user.

18. The method of claim 16 further comprising creation of a smart contract, the smart contract providing terms and conditions that apply to at least one of: the plurality of digitally connected products, a user of at least one of the plurality of digitally connected products, a manufacturer of at least one of the plurality of digitally connected products, a distributer of at least one of the plurality of digitally connected products, an insurance provider for at least one of the plurality of digitally connected products, a retailer of at least one of the plurality of digitally connected products, and a service provider for at least one of the plurality of digitally connected products, wherein the terms and conditions comprise one or more of a purchase, a return, a lease, a warranty, an extended warranty, a service contract, a maintenance contract, a trade-in, a product add-on, a new product feature, a contract for access to data, a purchase for access to one or more models, a software upgrade, a product upgrade, and unlocking an existing product feature.

19. The method of claim 18 further comprising automatically creating smart contracts based on predefined rules.

20. The method of claim 18 further comprising enabling selection of a smart contract template, while restricting the selection to one or more smart contract templates that are associated with the at least one of the plurality of digitally connected products.

21. The method of claim 20 further comprising:
receiving input for parameterizing the selected smart contract template;
generating a smart contract by parameterizing one or more variables in the smart contract with the input; and
deploying the smart contract by broadcasting the smart contract to the at least one of the plurality of digitally connected products.

22. The method of claim 20 further comprising suggesting smart contract templates to a user based on at least one of: a type of the digitally connected product to be subject to the smart contract, one or more past selections of the user.

23. The method of claim 18 further comprising verification of performance of an obligation defined in the smart contract.

24. The method of claim 23 further comprising automatically triggering an action upon successful verification of the performance of the obligation defined in the smart contract, wherein the action comprises one or more of providing a notification, updating status of the smart contract, and initiating a new smart contract.

25. The method of claim 16 further comprising enabling a user to upload records, wherein the records comprise one or more of photos, videos, audio recordings, device information, usage data, user preferences, troubleshooting records, upgrade records, reviews of product, receipts for product-related costs or purchases, environmental data, and customer feedback.

26. The method of claim 25 further comprising automatically categorizing and storing the uploaded records based on respective types and associated digitally connected products.

27. The method of claim 16 further comprising managing one or more application programming interfaces (APIs), so as to expose the APIs to one or more related applications or third-party systems used by the plurality of digitally connected products.

28. The method of claim 16 further comprising interacting with one or more regulatory systems.

29. The method of claim 16 further comprising integrating data from the plurality of digitally connected products to create a unified view of digitally connected products, by performing one or more operations, wherein the one or more operations comprise collecting data, aggregating data, normalizing data, standardizing data, cleaning data, enriching data, analyzing data, visualizing data, and integrating with other systems, and wherein the data integrated comprises one or more of product usage data, environmental data, product performance data, customer data, supply chain data, demand data, product location data, product customer feedback, product interaction data, product security data, product packaging data, product image data, product video data, product audio data, and product simulation data.

30. The method of claim 16 further comprising providing one or more user interfaces to display related ones of the plurality of digitally connected products associated with a single user by at least one of brand, type, and capability.

31. A digital product network system comprising:
a user interface module configured to:
display information associated with a set of digitally connected products; and
receive and process user inputs for displaying a set of marketplaces associated with the information;
display the set of marketplaces; and
receive and process user inputs for selecting a marketplace from the set of marketplaces; and
an embedded marketplace module integrated with the user interface module, the embedded marketplace configured to:
display the selected marketplace;
receive and process user inputs for selecting one or more offerings from a set of offerings from the selected marketplace;
receive and process user inputs for completing a set of transactions associated with the one or more selected offerings; and
execute the set of transactions.

32. The digital product network system of claim 31, wherein the embedded marketplace module is configured to execute transactions for product data associated with at least one of the digitally connected products from the set of digitally connected products, wherein the product data comprises one or more of product performance data, product pricing data, product usage data, product location data, product customer feedback data, product interaction data, product security data, product image data, product video data, product audio data, product packaging data, product maintenance data, environmental data, and product simulation data.

33. The digital product network system of claim 31, wherein the embedded marketplace module is configured to execute transactions related to models and/or algorithms associated with at least one digitally connected product from the set of digitally connected products, wherein the models and/or algorithms comprise one or more of predictive models, machine learning models, artificial intelligence models, classification models, anomaly detection models, clustering algorithms, generative models, large language models, optimization models, recommendation models, neural networks, transformer models, convolutional neural networks, deep learning models, supervised models, semi-supervised models, unsupervised models, reinforcement models, and regression models.

34. The digital product network system of claim 31, wherein the embedded marketplace module is configured to execute transactions related to one or more of product parts, product upgrades, product insurance, product enhancements, product add-ons, product software, product warranties, extended product warranties, product service contracts, product maintenance contracts, product trade-ins, and access to product features for at least one digitally connected product from the set of digitally connected products.

35. The digital product network system of claim 31, wherein the embedded marketplace module is further configured to execute a peer-to-peer transaction associated with one or more of the digitally connected products.

36. The digital product network system of claim 31, wherein the embedded marketplace module is configured to provide a recommendation for an offering associated with at least one digitally connected product using a set of Artificial Intelligence (AI)-based learning models, wherein at least one of the set of AI-based learning models is trained on a training data set of embedded marketplace transaction data.

37. The digital product network system of claim 31, wherein the embedded marketplace module is configured to execute transactions between different entities comprising two or more of users, manufacturers, suppliers, service providers, software providers, data providers, data analytics providers, model providers, digital twin providers, and NFT providers.

38. The digital product network system of claim 31, wherein the marketplaces provided by the embedded marketplace module are configured to be searchable.

39. The digital product network system of claim 31, wherein at least one marketplace of the set of marketplaces provides digital twin offerings.

40. A method for executing transactions in a digital product network system, the method comprising:
displaying information associated with a set of digitally connected products;
receiving and processing user inputs for displaying a set of marketplaces associated with the information;
displaying the set of marketplaces;
receiving and processing user inputs for selecting a marketplace from the set of marketplaces;
displaying the selected marketplace;
receiving and processing user inputs for selecting one or more offerings from a set of offerings from the selected marketplace;
receiving and processing user inputs for completing a set of transactions associated with the one or more selected offerings; and
executing the set of transactions.

41. The method of claim 40 further comprising executing transactions related to product data associated with at least one of the digitally connected products from the set of digitally connected products, wherein the product data comprises one or more of product performance data, product pricing data, product usage data, product location data, product customer feedback data, product interaction data, product security data, product image data, product video data, product audio data, product packaging data, product maintenance data, environmental data, and product simulation data.

42. The method of claim 40 further comprising executing transactions related to models and/or algorithms associated with at least one digitally connected product from the set of digitally connected products, wherein the models and/or algorithms comprise one or more of predictive models, machine learning models, artificial intelligence models, classification models, anomaly detection models, clustering algorithms, generative models, large language models, optimization models, recommendation models, neural networks, transformer models, convolutional neural networks, deep learning models, supervised models, semi-supervised models, unsupervised models, reinforcement models, and regression models.

43. The method of claim 40 further comprising executing transactions related to one or more of product parts, product upgrades, product insurance, product enhancements, product add-ons, product software, product warranties, extended product warranties, product service contracts, product maintenance contracts, product trade-ins, and access to new product features for at least one digitally connected product from the set of digitally connected products.

44. The method of claim 40 further comprising executing a peer-to-peer transaction associated with one or more of the digitally connected products.

45. The method of claim 40 further comprising providing a recommendation for an offering associated with at least one digitally connected product using a set of Artificial Intelligence (AI)-based learning models, wherein at least one of the set of AI-based learning models is trained on a training data set of embedded marketplace transaction data.

46. The method of claim 40 further comprising executing transactions between different entities comprising two or more of users, manufacturers, suppliers, service providers, data providers, data analytics providers, software application providers, model providers, digital twin providers, and NFT providers.

47. The method of claim 40 further comprising providing at least one searchable marketplace.

48. The method of claim 40, further comprising providing at least one marketplace that provides digital twin offerings.

49. A digital product network system including one or more processors and one or more memories configured to perform operations comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to generate a recommendation associated with one or more of the set of digitally connected products; and
outputting the recommendation.

50. The digital product network system of claim 49, wherein the information is related to a date or time of packaging of the set of digitally connected products.

51. The digital product network system of claim 49, wherein the information is related to a location of the set of digitally connected products.

52. The digital product network system of claim 49, wherein the information is related to a location of manufacturing for the set of digitally connected products.

53. The digital product network system of claim 49, wherein the information is related to a location of packaging for the set of digitally connected products.

54. The digital product network system of claim 49, wherein the information is related to a location of purchase for the set of digitally connected products.

55. The digital product network system of claim 49, wherein the information is related to a location of opening of packaging or the location of consumption of the set of digitally connected products.

56. The digital product network system of claim 49, wherein the information is related to a time on a display shelf or time on other display for the set of digitally connected products.

57. The digital product network system of claim 49, wherein the information is related to customer interaction with a set of displayed digitally connected products of the set of digitally connected products.

58. The digital product network system of claim 49, wherein the information is related to customer interaction with purchased digitally connected products of the set of digitally connected products.

59. The digital product network system of claim 49, wherein the wherein the set of AI-based learning models includes at least one of: a transformer model, a convolutional neural network, a deep learning model, a supervised model, a semi-supervised model, an unsupervised model, a generative model, a large language model, a recommendation model, or a reinforcement model.

60. The digital product network system of claim 49, wherein the recommendation is associated with one or more of an operational parameter of one or more of the set of digitally connected products, a provisioning of customer support associated with the one or more of the set of digitally connected products, a price of one or more of the set of digitally connected products, a product design associated with one or more of the set of digitally connected products, product security associated with one or more of the set of digitally connected products, quality control associated with one or more of the set of digitally connected products, marketing or sales strategies associated with one or more of the set of digitally connected products, display strategies associated with one or more of the set of digitally connected products, packaging associated with one or more of the set of digitally connected products, software upgrades associated with one or more of the set of digitally connected products, inventory management associated with one or more of the set of digitally connected products, regulatory compliance associated with one or more of the set of digitally connected products, and customer behavior associated with one or more of the set of digitally connected products.

61. A method for generating a recommendation in a digital product network system, the method comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to generate a recommendation associated with one or more of the set of digitally connected products; and
outputting the recommendation.

62. The method of claim 61, wherein the information relates to a date or time of packaging the set of digitally connected products.

63. The method of claim 61, wherein the information relates to a location of the set of digitally connected products.

64. The method of claim 61, wherein the information relates to a location of manufacturing of the set of digitally connected products.

65. The method of claim 61, wherein the information relates to a location of packaging of the set of digitally connected products.

66. The method of claim 61, wherein the information relates to a location of purchase of the set of digitally connected products.

67. The method of claim 61, wherein the information relates to a location of opening of packaging or the location of consumption of the set of digitally connected products.

68. The method of claim 61, wherein the information relates to a time on a display shelf or time on other display for the set of digitally connected products.

69. The method of claim 61, wherein the information relates to customer interaction with displayed digitally connected products of the set of digitally connected products.

70. The method of claim 61, wherein the information relates to customer interaction with purchased digitally connected products of the set of digitally connected products.

71. The method of claim 61, wherein the wherein the set of AI-based learning models includes at least one of: a transformer model, a convolutional neural network, a deep learning model, a supervised model, a semi-supervised model, an unsupervised model, a generative model, a large language model, a recommendation model, or a reinforcement model.

72. The method of claim 61, wherein the recommendation is associated with one or more of an operational parameter of one or more of the set of digitally connected products, a provisioning of customer support associated with the one or more of the set of digitally connected products, a price of one or more of the set of digitally connected products, a product design associated with one or more of the set of digitally connected products, product security associated with one or more of the set of digitally connected products, quality control associated with one or more of the set of digitally connected products, marketing or sales strategies associated with one or more of the set of digitally connected products, display strategies associated with one or more of the set of digitally connected products, packaging associated with one or more of the set of digitally connected products, software upgrades associated with one or more of the set of digitally connected products, inventory management associated with one or more of the set of digitally connected products, regulatory compliance associated with one or more of the set of digitally connected products, and customer behavior associated with one or more of the set of digitally connected products.

73. A digital product network system including one or more processors and one or more memories configured to perform operations comprising:
receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and
providing the information to a digital twin system, wherein the digital twin system is configured to generate a digital twin representing one or more digitally connected products of the set of digitally connected products based on the information, wherein each digital twin provides a substantially real-time representation of the one or more digitally connected products of the set of digitally connected products.

74. The digital product network system of claim 73, wherein the digital twin system is further configured to generate a digital twin representing one or more of an entity, an environment, and a workflow of the digital product network.

75. The digital product network system of claim 74, wherein the entity comprises one or more of an additional connected product, a physical object, a 3D printer, a manufacturer, a distributor, a consumer, a service provider, a retailer, a payment provider, and a regulator.

76. The digital product network system of claim 74, wherein the environment comprises one or more of a warehouse, a manufacturing facility, a 3D printing facility, a service provider facility, a smart container, a container, a shipping port, a truck, a transportation network, a physical retail store, a digital marketplace, a virtual reality environment, a storage facility, and a digital product network.

77. The digital product network system of claim 74, wherein the workflow comprises one or more of a product design workflow, a product component sourcing workflow, a product manufacturing workflow, a product packaging workflow, a product distribution workflow, a product marketing and sales workflow, a product display workflow, a product interaction workflow, a product usage workflow, a data collection workflow, a product repair workflow, a product recall workflow, a product lifecycle management workflow, a product maintenance workflow, a data processing workflow, a network integration workflow, and a feedback loop workflow.

78. The digital product network system of claim 73, wherein the information relates to one or more of product design data, product status data, product usage data, product error data, product diagnostic data, product location data, product maintenance data, user interaction data, network data, event data, product performance data, and environmental data.

79. The digital product network system of claim 73 further comprising providing an embedded marketplace in the digital twin of the digitally connected product for enabling transactions related to of one or more of a model, data, a product update, a product upgrade, a product add-on, a product-related service offering, and a product part related to the one or more digitally connected products.

80. The digital product network system of claim 73 further comprising simulating at least one of a behavior, a performance, an environment, and an interaction of the digital twin using CAD-based models.

81. The digital product network system of claim 73, further comprising generating an alert based on information represented in the digital twin.

82. The digital product network system of claim 74, further comprising providing hierarchical digital twins, wherein each hierarchical digital twin represents a hierarchy of the at least one of an entity, an environment, or a workflow in the digital product network.

83. The digital product network system of claim 74, further comprising providing context-adaptive digital twins, wherein the context-adaptive digital twin is configured for adapting the representation of the at least one of an entity, an environment, and a workflow based on changes in context.

84. The digital product network system of claim 73, further comprising providing a role-based digital twin configured to represent information associated with a role associated with the one or more digitally connected products, wherein the role-based digital twin is configured for a consumer, a supplier, a manufacturer, a logistics manager, a retailer, a service provider, a product manager, a marketing and sales manager, an inventory manager, or a quality manager.

85. A method for providing a digital twin in a digital product network system, the method comprising:
receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and
providing the information to a digital twin system, wherein the digital twin system is configured to generate a digital twin of one or more digitally connected products of the set of digitally connected products based on the information, wherein each digital twin provides a substantially real-time representation of the one or more digitally connected products of the set of digitally connected products.

86. The method of claim 85 further comprising generating a digital twin representing one or more of an entity, an environment, and a workflow of the digital product network.

87. The method of claim 86, wherein the entity comprises one or more of an additional connected product, a physical object, a 3D printer, a manufacturer, a distributor, a consumer, a service provider, a payment provider, and a regulator.

88. The method of claim 86, wherein the environment comprises one or more of a warehouse, a manufacturing facility, a 3D printing facility, a service provider facility, a smart container, a container, a truck, a transportation network, a physical retail store, a digital marketplace, a virtual reality environment, a storage facility, and a connected product network.

89. The method of claim 86, wherein the workflow comprises one or more of a product design workflow, a product component sourcing workflow, a product manufacturing workflow, a product packaging workflow, a product distribution workflow, a product marketing and sales workflow, a product display workflow, a product interaction workflow, a product usage workflow, a data collection workflow, a product repair workflow, a product recall workflow, a product lifecycle management workflow, a product maintenance workflow, a data processing workflow, a network integration workflow, and a feedback loop workflow.

90. The method of claim 85, wherein the information relates to one or more of product status data, product usage data, product error data, product diagnostic data, product location data, product maintenance data, user interaction data, network data, event data, product performance data, and environmental data.

91. The method of claim 85 further comprising providing an embedded marketplace in the digital twin of the digitally connected product for purchase, sale, and exchange of one or more of a model, data, a product update, a product upgrade, a product add-on, a product-related service offering, and a product part related to the one or more digitally connected products.

92. The method of claim 85 further comprising simulating at least one of a behavior, a performance, an environment, and an interaction of the digital twin utilizing CAD-based models.

93. The method of claim 85 further comprising generating an alert based on data represented in the digital twin.

94. The method of claim 86 further comprising providing hierarchical digital twins, wherein each hierarchical digital twin represents a hierarchy of the at least one of an entity, an environment, or a workflow in the digital product network.

95. The method of claim 86 further comprising providing context-adaptive digital twin, wherein each context-adaptive digital twin is configured for adapting the representation of the at least one of an entity, an environment, and a workflow based on changes in context.

96. The method of claim 85 further comprising providing a role-based digital twin configured to represent a role associated with the digital product network, and wherein the role-based digital twin is configured for a consumer, a supplier, a manufacturer, a logistics manager, a retailer, a service provider, a product manager, a marketing and sales manager, an inventory manager, and a quality manager.

97. A method for providing an Artificial Intelligence (AI)-based supply chain digital twin for digitally connected products, the method comprising:
receiving, by a computing device, information associated with a set of digitally connected products of a digital product network system, the information generated by at least one of: a set of sensors of the set of digitally connected products, a set of IoT devices configured to collect data relating to the set of digitally connected products, or a set of APIs configured to publish data relating to the set of digitally connected products; and
providing the information to a digital twin system, wherein the digital twin system is configured to update a digital twin representing a supply chain network for the set of digitally connected products based on the information, wherein the digital twin provides a substantially real-time representation of a set of supply chain entities of the supply chain network;
providing the information to a set of Artificial Intelligence (AI)-based learning models, wherein at least one member of the set of AI-based learning models is trained on a training data set of a set of digital product network data to determine a classification of at least one of: an operating state, a fault condition, an operating flow, or a behavior of the supply chain network and at least one member of the set of AI-based learning models is trained on the training data set to determine, upon receiving the classification of the at least one of the: operating state, the fault condition, the operating flow, or the behavior, a task to be completed for the supply chain network; and
providing at least one of an instruction for executing the task in the supply chain network digital twin and a recommendation for executing the task in the supply chain network digital twin.

98. The method of claim 97, wherein the information includes real-time data about one of: inbound prepaid shipments from suppliers linked to orders; or inventory coming into a network associated with the supply chain network.

99. The method of claim 97 wherein receiving the information associated with the supply chain network includes receiving sensor data indicative of inbound and outbound shipment conditions.

100. The method of claim 97 further comprising generating simulations for the supply chain network digital twin, wherein the simulations for the supply chain network digital twin are generated with a graphical neural network (GNN).

101. The method of claim 97, wherein a robotic operating system enables the supply chain network digital twin.

102. The method of claim 97, wherein the supply chain network digital twin operates within a digital twin system having one or more sets of one or more digital twins, wherein each digital twin of the one or more sets includes an embedded marketplace for digital twin simulations.

103. The method of claim 97, wherein the supply chain network digital twin operates within a digital twin system having one or more sets of one or more digital twins, wherein each digital twin of the one or more sets includes an embedded marketplace for one of artificial intelligence-based learning models or artificial intelligence-based algorithms.

104. The method of claim 97, wherein the supply chain network digital twin operates within a digital twin system having one or more sets of one or more digital twins, wherein each digital twin of the one or more sets includes an embedded marketplace for data.

105. The method of claim 97, wherein the set of the supply chain network entities includes at least one of: digitally connected products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

106. The method of claim 97, wherein the set of AI-based learning models includes at least one of: a transformer model, a convolutional neural network, a deep learning model, a supervised model, a semi-supervised model, an unsupervised model, or a reinforcement model.

107. A computing system including one or more processors and one or more memories configured to perform operations comprising:
receiving, by a computing device, information associated with a set of digitally connected products of the digital product network system, the information generated by at least one of: a set of sensors of the set of digitally connected products, a set of IoT devices configured to collect data relating to the set of digitally connected products, or a set of APIs configured to publish data relating to the set of digitally connected products; and
providing the information to a digital twin system, wherein the digital twin system is configured to update a digital twin representing a supply chain network for the set of digitally connected products based on the information, wherein the digital twin provides a substantially real-time representation of a set of supply chain entities of the supply chain network;
providing the information to a set of Artificial Intelligence (AI)-based learning models, wherein at least one member of the set of AI-based learning models is trained on a training data set of a set of digital product network data to determine a classification of at least one of: an operating state, a fault condition, an operating flow, or a behavior of the supply chain network and at least one member of the set of AI-based learning models is trained on the training data set to determine, upon receiving the classification of the at least one of the: operating state, the fault condition, the operating flow, or the behavior, a task to be completed for the supply chain network; and
providing at least one of an instruction for executing the task in the supply chain network digital twin and a recommendation for executing the task in the supply chain network digital twin.

108. The computing system of claim 107, wherein the information includes real-time data about one of: inbound prepaid shipments from suppliers linked to orders; or inventory coming into a network associated with the supply chain network.

109. The computing system of claim 107, wherein receiving the information associated with the supply chain network includes receiving sensor data indicative of inbound and outbound shipment conditions.

110. The computing system of claim 107, wherein the operations further comprise generating simulations for the supply chain network digital twin, wherein the simulations for the supply chain network digital twin are generated with a graphical neural network (GNN).

111. The computing system of claim 107, wherein a robotic operating system enables the supply chain network digital twin.

112. The computing system of claim 107, wherein the supply chain network digital twin operates within a digital twin system having one or more sets of one or more digital twins, wherein each digital twin of the one or more sets includes an embedded marketplace for digital twin simulations.

113. The computing system of claim 107, wherein the supply chain network digital twin operates within a digital twin system having one or more sets of one or more digital twins, wherein each digital twin of the one or more sets includes an embedded marketplace for one of artificial intelligence-based learning models or artificial intelligence-based algorithms.

114. The computing system of claim 107, wherein the supply chain network digital twin operates within a digital twin system having one or more sets of one or more digital twins, wherein each digital twin of the one or more sets includes an embedded marketplace for data.

115. The computing system of claim 107, wherein the set of the supply chain network entities includes at least one of: digitally connected products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, robotic handling systems, 3D printers, vehicles, autonomous vehicles, hauling facilities, waterways, or port infrastructure facilities.

116. The computing system of claim 107, wherein the set of AI-based learning models includes at least one of: a transformer model, a convolutional neural network, a deep learning model, a supervised model, a semi-supervised model, an unsupervised model, or a reinforcement model.

117. A digital product network system including one or more processors and one or more memories configured to perform operations comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to determine a set of demand planning actions; and
providing a computer code instruction set to a machine to execute the set of demand planning actions.

118. The digital product network system of claim 117, wherein the set of demand planning actions includes at least one of forecasting a measure of demand, inventory management, capacity planning, supply chain coordination, customer prioritization, order quantity limits, dynamic pricing, alternative product promotions, marketing campaigns, product improvements, market expansion, and customer engagement.

119. The digital product network system of claim 117, wherein the information comprises at least one of historical sales data, market data, social media data, customer data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, supplier data, component data, quality control data, inspection data, failure data, warranty data, service record data, regulatory data, entertainment data, event data, regulatory compliance data, incident data, weather data, and accident report data.

120. The digital product network system of claim 117, wherein the set of AI-based learning models includes at least one of: a transformer model, a convolutional neural network, a deep learning model, a supervised model, a semi-supervised model, a generative model, a large language model, a recommendation model, an unsupervised model, a reinforcement model, and a regression model.

121. The digital product network system of claim 117, wherein the set of demand planning action comprises forecasting a measure of demand for each of a plurality of demographic groups at a future date and/or time.

122. The digital product network system of claim 121, wherein the set of demand planning actions further comprise generating and distributing a marketing message associated with the set of digitally connected products for a specific demographic group based on the forecasted measure of demand.

123. The digital product network system of claim 117, wherein the set of demand planning actions comprises forecasting a measure of demand for each of a plurality of geographic regions at a future date and/or time.

124. The digital product network system of claim 123, wherein the set of demand planning actions further comprise generating and distributing a marketing message associated with the set of digitally connected products for a specific geographic region based on the forecasted measure of demand.

125. The digital product network system of claim 117, wherein the set of demand planning actions comprises forecasting a measure of demand for each of a plurality of channel preference segments at a future date and/or time.

126. A method for demand planning in a digital product network system, the method comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models,
wherein at least one member of the set of AI-based learning models is trained on a training data set of digital product network data to determine a set of demand planning actions for the set of digitally connected products; and
providing a computer code instruction set to a machine to execute the set of demand planning actions.

127. The method of claim 126, wherein the set of demand planning action relates to at least one of forecasting a measure of demand, inventory management, capacity planning, supply chain coordination, customer prioritization, order quantity limits, dynamic pricing, alternative product promotions, marketing campaigns, product improvements, market expansion, and customer engagement.

128. The method of claim 126, wherein the information comprises at least one of historical sales data, market data, social media data, customer data, economic sentiment data, economic data, supply chain data, sensor data, market research data, competitive analysis data, economic indicator data, industry trends data, customer feedback data, historical product development data, project management data, resource availability data, supplier data, manufacturing data, quality control data, testing data, regulatory data, compliance data, historical recall data, manufacturing data, supplier data, component data, quality control data, inspection data, failure data, warranty data, service record data, regulatory data, entertainment data, event data, regulatory compliance data, incident data, weather data, and accident report data.

129. The method of claim 126, wherein each set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, a recommendation model, and a regression model.

130. The method of claim 126, wherein the set of demand planning action comprises forecasting a measure of demand for each of a plurality of demographic groups at a future date and/or time.

131. The method of claim 130, wherein the set of demand planning actions further comprise generating and distributing a marketing message associated with the set of digitally connected products for a specific demographic group based on the forecasted measure of demand.

132. The method of claim 126, wherein the set of demand planning actions comprises forecasting a measure of demand for each of a plurality of geographic regions at a future date and/or time.

133. The method of claim 132, wherein the set of demand planning actions further comprise generating and distributing a marketing message associated with the set of digitally connected products for a specific geographic region based on the forecasted measure of demand.

134. The method of claim 126, wherein the set of demand planning actions comprises forecasting a measure of demand for each of a plurality of channel preference segments at a future date and/or time.

135. A digital product network system including one or more processors and one or more memories configured to perform operations comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to predict a future inventory level requirement for the set of digitally connected products based on the information and at least one member of the set of AI-based learning models is trained on the training data set to determine an action to meet the predicted inventory level requirement based on the prediction and the information; and
at least one of outputting the determined action and providing a computer code instruction set to a machine to execute the determined action.

136. The digital product network system of claim 135, wherein the information comprises at least one of historical sales data, market data, social media data, customer data, economic sentiment data, economic data, supply chain data, inventory data, lead time data, sensor data, market research data, competitive analysis data, economic indicator data, industry trends data, customer feedback data, historical product development data, project management data, resource availability data, supplier data, supplier performance data, supplier pricing data, manufacturing data, quality control and testing data, regulatory and compliance data, historical recall data, manufacturing data, supplier data, component data, quality control data, inspection data, failure data, warranty and service records, regulatory data, entertainment data, event data, regulatory compliance data, incident data, weather data, and accident report data.

137. The digital product network system of claim 135, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

138. The digital product network system of claim 135, wherein the determined action relates to at least one of: engaging secondary manufacturers or contract manufacturers to supplement production capacity, implementing overtime shifts at manufacturing facilities to temporarily increase production, redistributing inventory, simplifying product designs, implementing strategic stockpiling, supplementing production capacity with 3D printers, increasing storage and/or warehouse capacity, implementing cross-docking, adjusting production settings, and improving return management.

139. The digital product network system of claim 135, wherein at least one member of the set of AI-based learning models is trained on a training data set of digital product network data to generate a prediction of future inventory level requirement for each of a plurality of retail locations.

140. The digital product network system of claim 135, wherein at least one member of the set of AI-based learning models is trained on a training data set of digital product network data to generate a prediction of future inventory level requirement for each of a plurality of geographic regions.

141. The digital product network system of claim 135, wherein at least one member of the set of AI-based learning models is trained on a training data set of digital product network data to generate a prediction of future inventory level requirement for each of a plurality of sales channels.

142. The digital product network system of claim 135, wherein the operations further comprise providing at least one of real-time updates on the inventory level and alerts when the inventory level reaches a certain threshold.

143. The digital product network system of claim 135, wherein the determined action is output to a digital twin user interface.

144. A method for inventory optimization in a digital product network system, the method comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to predict a future inventory level requirement for a set of digitally connected products and at least one member of the set of AI-based learning models is trained on the training data set to determine an action to meet the predicted inventory level requirement; and
at least one of outputting the determined action and providing a computer code instruction set to a machine to execute the determined action.

145. The method of claim 144, wherein the information comprises at least one of historical sales data, market data, social media data, customer data, economic sentiment data, economic data, supply chain data, inventory data, lead time data, sensor data, market research data, competitive analysis data, economic indicator data, industry trends data, customer feedback data, historical product development data, project management data, resource availability data, supplier data, supplier performance data, supplier pricing data, manufacturing data, quality control and testing data, regulatory and compliance data, historical recall data, manufacturing data, supplier data, component data, quality control data, inspection data, failure data, warranty and service records, regulatory data, entertainment data, event data, regulatory compliance data, incident data, weather data, and accident report data.

146. The method of claim 144, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

147. The method of claim 144, wherein the determined action relates to at least one of: engaging secondary manufacturers or contract manufacturers to supplement production capacity, implementing overtime shifts at manufacturing facilities to temporarily increase production, redistributing inventory, simplifying product designs, implementing strategic stockpiling, supplementing production capacity with 3D printers, increasing storage and/or warehouse capacity, implementing cross-docking, improving return management, adjusting production settings, and implementing dynamic pricing strategies.

148. The method of claim 144, wherein at least one member of the set of AI-based learning models is trained on a training data set of digital product network data to generate a prediction of future inventory level requirement for each of a plurality of retail locations.

149. The method of claim 144, wherein at least one member of the set of AI-based learning models is trained on a training data set of digital product network data to generate a prediction of future inventory level requirement for each of a plurality of geographic regions.

150. The method of claim 144, wherein at least one member of the set of AI-based learning models is trained on a training data set of digital product network data to generate a prediction of future inventory level requirement for each of a plurality of sales channels.

151. The method of claim 144 further comprising providing at least one of real-time updates on the inventory level and alerts when the inventory level reaches a certain threshold.

152. The method of claim 144, wherein the determined action is output to a digital twin user interface.

153. A digital product network system including one or more processors and one or more memories configured to perform operations comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a first set of Artificial Intelligence (AI)-based learning models, wherein at least one member of the first set of AI-based learning models is trained on a training data set of digital product network data to determine a classification of at least one of an operating state, a fault condition, an operating flow, and a behavior of at least one of the set of digitally connected products;
providing the information to a second set of Artificial Intelligence (AI)-based learning models, wherein at least one member of the second set of AI-based learning models is trained on a training data set of digital product network data to recommend at least one design improvement for the set of digitally connected products based on the classification; and
at least one of outputting the design improvement recommendation and providing a computer code instruction set to a machine to implement the design improvement associated with the set of digitally connected products based on the output of the AI-based learning models.

154. The digital product network system of claim 153, wherein the design improvement comprises at least one of modifying an existing product features, adding a new product feature, removing a product feature, replacing a product material, modifying a size of a product, modifying a size of a product part, replacing a product part, modifying a product color, modifying a product style, and rearranging a set of components of the product.

155. The digital product network system of claim 153, wherein the information comprises at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, order data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

156. The digital product network system of claim 153, wherein each set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

157. The digital product network system of claim 153, wherein at least one member of a third set of AI-based learning models is trained on a training data set of digital product network data to predict an impact of the at least one design improvement.

158. The digital product network system of claim 153, wherein the operations further comprise generating a virtual prototype of the improved product design.

159. The digital product network system of claim 153, wherein at least one member of a third set of AI-based learning models is trained on a training data set of digital product network data to identify potential risks associated with implementing the at least one design improvement.

160. The digital product network system of claim 153, wherein at least one member of a third set of AI-based learning models is trained on a training data set of digital product network data to generate a plan for validating the improved product design, including one or more of defining testing parameters, identifying testing resources, and setting up testing environments.

161. The digital product network system of claim 153, wherein at least one member of a third set of AI-based learning models is trained on a training data set of digital product network data to generate a plan for launching and marketing the improved product design, including one or more of identifying target markets, developing marketing strategies, and planning marketing campaigns.

162. The digital product network system of claim 153, wherein the operations further comprise determining a per-unit cost for the at least one design improvement.

163. A method for improving product design in a digital product network system, the method comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a first set of Artificial Intelligence (AI)-based learning models, wherein at least one member of the first set of AI-based learning models is trained on a training data set of digital product network data to determine a classification of at least one of an operating state, a fault condition, an operating flow, and a behavior of at least one of the set of digitally connected products;
providing the information to a second set of Artificial Intelligence (AI)-based learning models, wherein at least one member of the second set of AI-based learning models is trained on a training data set of digital product network data to determine at least one design improvement for the set of digitally connected products based on the classification; and
at least one of outputting the design improvement recommendation and providing a computer code instruction set to a machine to implement the design improvement associated with the digitally connected products based on the output of the AI-based learning models.

164. The method of claim 163, wherein the design improvement comprises one or more of modifying an existing product feature, adding a new product feature, removing a product feature, replacing a product material, modifying a size of a product, modifying a size of a product part, replacing a product part, modifying a product color, modifying a product style, and rearranging a set of components of the product.

165. The method of claim 163, wherein the information comprises at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, order data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

166. The method of claim 163, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

167. The method of claim 163, wherein at least one member of a third set of AI-based learning models is trained on a training data set of digital product network data to predict an impact of the at least one design improvement.

168. The method of claim 163, wherein the operations further comprise generating a virtual prototype of the improved product design.

169. The method of claim 163, wherein at least one member of a third set of AI-based learning models is trained on a training data set of digital product network data to identify potential risks associated with implementing the at least one design improvement.

170. The method of claim 163, wherein at least one member of a third set of AI-based learning models is trained on a training data set of digital product network data to generate a plan for validating the improved product design, including one or more of defining testing parameters, identifying testing resources, and setting up testing environments.

171. The method of claim 163, wherein at least one member of a third set of AI-based learning models is trained on a training data set of digital product network data to generate a plan for launching and marketing the improved product design, including one or more of identifying target markets, developing marketing strategies, and planning marketing campaigns.

172. The method of claim 163, wherein the operations further comprise determining a per-unit cost for the at least one design improvement.

173. A digital product network system including one or more processors and one or more memories configured to perform operations comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to determine at least one product feature preference for the set of digitally connected products for each location of a set of locations; and
outputting the at least one product feature preference for the set of digitally connected products for each location of a set of locations.

174. The digital product network system of claim 173, wherein the information comprises at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, sales data, geographic data, demographic data, customer behavior data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

175. The digital product network system of claim 173, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

176. The digital product network system of claim 173, wherein the at least one member of the set of AI-based learning models is trained on a training data set of digital product network data to determine at least one product feature preference for the set of digitally connected products for a plurality of geographic segments.

177. The digital product network system of claim 176, wherein the operations further comprise determining a sales measure associated with each of the plurality of geographic segments.

178. The digital product network system of claim 173, wherein the at least one member of the set of AI-based learning models is trained on a training data set of digital product network data to determine at least one product feature preference for a plurality of demographic segments for the set of digitally connected products.

179. The digital product network system of claim 178, wherein the operations further comprise determining a sales measure associated with each of the plurality of demographic segments.

180. The digital product network system of claim 173, wherein the at least one member of the set of AI-based learning models is trained on a training data set of digital product network data to determine at least one product feature preference for a plurality of consumer behavioral segments for the set of digitally connected products.

181. The digital product network system of claim 180, wherein the operations further comprise determining a sales measure associated with each of the plurality of consumer behavioral segments.

182. The digital product network system of claim 173, wherein the operations further comprise providing a recommendation for product development for the set of digitally connected products based on the determined at least one product feature preference, wherein the recommendation comprises: modifying one or more of existing product features, adding a new product feature, removing a product feature, replacing a product material, modifying a size of a product, modifying a size of a product part, replacing a product part, modifying a product color, modifying a product style, or rearranging a set of components of the product.

183. A method for determining product feature preferences in a digital product network system, the method comprising:
receiving, by a computing device, information associated with a set of digitally connected products of a digital product network, the information generated by at least one of: a set of sensors of the set of digitally connected products, a set of IoT devices configured to collect data relating to the set of digitally connected products, or a set of APIs configured to publish data relating to the set of digitally connected products;
providing the information to a set of Artificial Intelligence (AI)-based learning models, wherein at least one member of the set of AI-based learning models is trained on a training data set of digital product network data to determine at least one product feature preference for the set of digitally connected products for each of a set of locations; and
outputting the at least one product feature preference for the set of digitally connected products for each location of a set of locations.

184. The method of claim 183, wherein the information comprises at least one of historical sales data, market data, social media data, customer data, economic sentiment data, economic data, supply chain data, inventory data, influencer data, lead time data, sensor data, product performance data, product feature data, product design data, product component data, market research data, competitive analysis data, economic indicator data, industry trend data, customer feedback data, customer service interaction data, sales data, geographic data, demographic data, customer behavior data, historical product development data, project management data, resource availability data, supplier data, supplier performance data, supplier pricing data, manufacturing data, quality control and testing data, regulatory and compliance data, historical recall data, supplier data, component data, quality control data, inspection data, failure data, warranty and service records, regulatory data, entertainment data, event data, regulatory compliance data, incident data, weather data, and accident report data.

185. The method of claim 183, wherein the set of AI-based learning models includes at least one of: a transformer model, a convolutional neural network, a deep learning model trained on a set of outcomes of the digital product network, a supervised model, a semi-supervised model, an unsupervised model, a reinforcement model, a generative model, a large language model, and a regression model.

186. The method of claim 183, wherein the at least one member of the set of AI-based learning models is trained on a training data set of digital product network data to determine at least one product feature preference for a plurality of geographic segments for the set of digitally connected products.

187. The method of 186 further comprising determining a sales measure associated with each of the plurality of geographic segments.

188. The method of claim 183, wherein the at least one member of the set of AI-based learning models is trained on a training data set of digital product network data to determine at least one product feature preference for a plurality of demographic segments for the set of digitally connected products.

189. The method of claim 188 further comprising determining a sales measure associated with each of the plurality of demographic segments.

190. The method of claim 183, wherein the at least one member of the set of AI-based learning models is trained on a training data set of digital product network data to determine at least one product feature preference for a plurality of behavioral segments for the set of digitally connected products.

191. The method of claim 190 further comprising determining a sales measure associated with each of the plurality of behavioral segments.

192. The method of claim 183 further comprising providing a recommendation for product development for the set of digitally connected products based on the at least one product feature preference, wherein the recommendation comprises: modifying one or more of existing product features, adding a new product feature, removing a product feature, replacing a product material, modifying a size of a product, modifying a size of a product part, replacing a product part, modifying a product color, modifying a product style, or rearranging a set of components of the product.

193. A generative artificial intelligence system for a digital product network, the system including one or more processors and one or more memories configured to perform operations comprising:
executing, by the generative artificial intelligence system, generative artificial intelligence algorithms trained on digital product network data;
receiving input data including at least one of images, video, audio, text, programmatic code, and data;
processing the input data using the generative artificial intelligence algorithms to generate output content, wherein the output content includes at least one of structured prose, images, video, audio content, software source code, formatted data, algorithms, definitions, and context-specific structures;
generating an internal state of the generative artificial intelligence system, including a set of weights and/or biases as a result of prior processing; and
providing the generated output content to a user interface for presentation to a user.

194. The generative artificial intelligence system of claim 193, wherein the input data further includes natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations.

195. The generative artificial intelligence system of claim 193, wherein the generative artificial intelligence system is configured to maintain contextual awareness across interactions to facilitate continuity in dialogue with users.

196. The generative artificial intelligence system of claim 193, wherein the generative artificial intelligence system is configured to support interpretability and explainability of its outputs by providing a description of a basis of the output.

197. The generative artificial intelligence system of claim 193, wherein the output includes a recommendation to improve at least one of the digital product network and a digitally connected product within the digital product network.

198. The generative artificial intelligence system of claim 193, further comprising a digital twin interface for a digital twin, wherein the digital twin interface is configured to enable access to the generative artificial intelligence system, and wherein the digital twin represents at least one of the digital product network and a digitally connected product within the digital product network.

199. The generative artificial intelligence system of claim 193, further comprising a digital twin module configured to generate a digital twin representing at least one of a digital product network and a digitally connected product within the digital product network.

200. The generative artificial intelligence system of claim 193, wherein the processor is further configured to communicate with robotic systems within the digital product network, and the memory stores instructions that enable the generative artificial intelligence system to translate human commands into robotic actions, thereby facilitating human-to-robot interaction.

201. The generative artificial intelligence system of claim 193, wherein the output content is further tailored based on an executive role of the user.

202. The generative artificial intelligence system of claim 193, wherein the generated output includes 3D printing instructions for a set of 3D printers.

203. The generative artificial intelligence system of claim 193, wherein the system is part of a Dual Process Artificial Neural Network (DPANN) architecture.

204. The generative artificial intelligence system of claim 193, further comprising an augmented reality (AR) interface configured to overlay the generated output content onto a user's real-world view.

205. A method for operating a generative artificial intelligence system within a value chain network, the method comprising:
executing, by the generative artificial intelligence system, generative artificial intelligence algorithms trained on value chain network data;
receiving input data including at least one of images, video, audio, text, programmatic code, and data;
processing the input data using the generative artificial intelligence system to generate output content, wherein the output content includes at least one of structured prose, images, video, audio content, software source code, formatted data, algorithms, definitions, and context-specific structures;
generating an internal state of the generative artificial intelligence system, including a set of weights and/or biases as a result of prior processing; and
providing the generated output content to a user interface for presentation to a user.

206. The method of claim 205, further comprising receiving additional input data including natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives, and device configurations.

207. The method of claim 205, further comprising maintaining contextual awareness across interactions to facilitate continuity in dialogue with users.

208. The method of claim 205, further comprising supporting interpretability and explainability of its outputs by providing a description of a basis of the output.

209. The method of claim 205, wherein the generated output includes a recommendation to improve one or more of a digital product network and a digitally connected product within the digital product network.

210. The method of claim 205, further comprising:
interfacing with a digital twin via a digital twin interface, wherein the digital twin interface is configured to facilitate access to the generative artificial intelligence system; and
representing, by the digital twin, one or more of a digital product network and a digitally connected product within the digital product network.

211. The method of claim 205, further comprising: generating, through a digital twin module, a digital twin that represents at least one or more of a digital product network and a digitally connected product within the digital product network.

212. The method of claim 205, further comprising:
communicating with one or more robotic systems within the value chain network;
translating human commands into robotic actions; and
facilitating human-to-robot interaction within the value chain network, thereby enabling the robotic systems to perform tasks in response to the human commands derived from the generated output content.

213. The method of claim 205, further comprising: tailoring the output content based on an executive role of the user within an organization.

214. The method of claim 205, wherein the generated output includes 3D printing instructions for a set of 3D printers.

215. The method of claim 205, wherein the generative artificial intelligence system operates as part of a Dual Process Artificial Neural Network (DPANN) architecture.

216. The method of claim 205, further comprising: interfacing with an augmented reality (AR) interface; and overlaying, by the AR interface, the generated output content onto a user's real-world view.
